(19) United States
(12) Patent Application Publication
(10) Pub. No.: US 2025/0193366 A1
(43) Pub. Date: Jun. 12, 2025

(54) THREE-DIMENSIONAL PROJECTIVE TRANSFORMATION METHOD, THREE-DIMENSIONAL PROJECTIVE REVERSE TRANSFORMATION METHOD, OPTICAL DEVICE, SYNTHESIZED LIGHT APPLYING METHOD, MEASUREMENT METHOD, IMAGING METHOD, SIGNAL PROCESSING METHOD, DATA ANALYSIS METHOD, THREE-DIMENSIONAL DISPLAY METHOD, SERVICE PROVIDING METHOD, MEASUREMENT DEVICE, AND SERVICE PROVIDING SYSTEM

(71) Applicant: Japan Cell Co., Ltd., Tokyo (JP)

(72) Inventors: Hideo ANDO, Machida-shi (JP); Yuki ENDO, Machida-shi (JP); Satoshi HAYATA, Machida-shi (JP); Sueo UENO, Machida-shi (JP); Yuta HIRAIDE, Machida-shi (JP)

(73) Assignee: Japan Cell Co., Ltd., Tokyo (JP)

(21) Appl. No.: 19/053,752

(22) Filed: Feb. 14, 2025

Related U.S. Application Data
(63) Continuation-in-part of application No. PCT/JP2022/031122, filed on Aug. 17, 2022.

(30) Foreign Application Priority Data
Sep. 10, 2024 (JP) 2024-156590

(51) Int. Cl. H04N 13/363; H04N 5/74; H04N 13/383

(52) U.S. Cl. CPC H04N 13/363; H04N 5/74; H04N 13/383

(57) ABSTRACT

In three-dimensional projective reverse transformation, a distance to a measured object is measured, and three-dimensional coordinate values of each point in the measured object corresponding to each of a plurality of pixels configuring an imaging sensor are calculated. In three-dimensional projective transformation, a three-dimensional shape of is a display object is set. Further, positions of a right side eye and a left side eye of a user with respect to a position of the display object are measured. A projected image or a projected movie corresponding to both eyes of the user is formed.

### CROSS-REFERENCE TO RELATED APPLICATIONS

This application is a Continuation-in-Part Application of PCT Application No. PCT/JP2022/031122, filed Aug. 17, 2022 and based upon and claiming the benefit of priority from Japanese Patent Application No. 2024-156590, filed Sep. 10, 2024, the entire contents of all of which are incorporated herein by reference.

### BACKGROUND OF THE INVENTION

### 1. Field of the Invention

Embodiments described herein relate generally to a technical field of controlling characteristics of light itself, an optical measurement method, an application field using a light, or a service applying light.

### 2. Description of the Related Art

Currently, movies, still images, written material, speech, and the like are mainly used as information transmission media. Among these, detailed content can be most accurately transmitted when text characters are used. Recently, with the spread of personal computers and information portable terminals (removable data processing devices 9), various text character expression forms have appeared. However, under the present circumstances, none of them goes beyond the scope of “text characters written on a two-dimensional plane”.

In particular, when information with complicated content is transmitted, it takes time and effort to read and understand “text characters written on a two-dimensional plane”. Therefore, a great burden is placed on a user who receives the transmitted information. This burden causes the user to be less interested in the transmitted information.

In the same manner as listening to the speech of written material being read aloud on the radio, the above-described “operation of reading text characters” also undergoes a time-series information transmission process. The “relatively small amount of information simultaneously transmitted” at the time of reading the text characters contributes to the above burden on the user.

In contrast to this, in visually appealing image expression, “an amount of information simultaneously transmitted is large”. Therefore, image transmission not only reduces the burden on a user to collect information, but also prevents a decrease in the user's interest in the transmitted information.

“Light” is used to transmit this image information. When optical interference noise occurs in the middle of a light propagation path, accuracy and reliability of transmitted information deteriorate. Therefore, in order to ensure the accuracy and reliability of information in the information transmission field using the above-described light, propagation of light having low optical coherence (low coherent light) is desirable. In addition, not only the above-described information transmission field using light, but also every optical application field requires desirable optical characteristics.

As application fields using light, there are various application fields such as an optical characteristic converting technology, an optical characteristic converting technology, an optical display technology, an optical recording technology, a light processing technology, and an optical communication technology. Other known application fields include an imaging technology corresponding to the object, a technology for measuring spectral profile of the object to be measured, a length measurement technology, and a display technology. Furthermore, application fields such as 3D measurement combining the imaging technology and the length measurement technology have recently been developed. In addition, there are also application fields using measurement results such as the light reflection amount, transmission amount, absorption amount, and scattering amount or time-dependent changes thereof. Then, optimum characteristics and attributes of light are individually determined for each of these application fields. When the characteristics and attributes of light are optimized in this manner, maximum functionality can be achieved for each application field.

In recent years, in the optical display field, three-dimensional display of an image has become possible. In addition, in an optical measurement field and an optical length measurement field, a distance measurement technique using a time of flight of light is in the middle of development.

A method for providing an optimal service to users by utilizing various types of information obtained in the optical application field (including measured information) is known. Specific examples of method of providing services to users include the provision of proper information to users, optimization of user environments, and various controls corresponding to user requests. Other examples include the provision of interactive services between users and servers or between users, and the provision of services using activities on virtual spaces formed on a network.

In all application fields using light, not limited in the above technical field, it is necessary to maximize the implementation effect in each field of optical application or in each field of service provision using light. For this purpose, it is necessary to realize appropriate characteristics and attributes of light or to acquire various types of information (including measured information) with high accuracy and reliability for each optical application field or service provision field, and provision of convenience, high added value, and high expressive power to the user is required.

It is desirable to provide a three-dimensional projective transformation method or a three-dimensional projective reverse transformation method, an optical device, a synthesized light applying method, a measurement method, an imaging method, a signal processing method, a data analysis method, a three-dimensional display method, a service providing method, a measurement device, or a service providing system capable of embodying the above technique.

For example, in each field such as a display technology, a light measurement technology, an imaging technology, a light control technology, an optical recording technology, a light processing technology, and an optical communication technology, it is important to ensure high quality optical characteristics or electrical high quality. The “quality” mentioned here is greatly related to an optical or electrical signal to noise ratio (S/N ratio). On the other hand, if light with less optical interference noise can be provided to the optical communication technology, the accumulation density of spatial signals is improved, and large data transmission and data processing can be performed. Moreover, user can easily obtain highly accurate and reliable information when new technology provides appropriate signal processing method for a photoelectric signal.

Furthermore, as an expression having a high realistic feeling in the display field or the image processing field, 3D expression, or clear image expression is desired in recent years. In order to realize them, provision of light with less optical noise, provision of high-quality electrical signals with reduced electrical noise, and the like are required.

In each field of the display technology, the light control technology, and the optical communication technology and any field of the detection or measurement, imaging, and service provision, a signal processing and/or data analysis method using measured signals may be provided. The provision form of the data analysis method may be a hardware form, a software form, or a combination form of both. That is, a data analysis program for performing the signal processing and/or data analysis may be provided. As a result, the amount of noise in the measured signal is reduced, and a clear signal with high accuracy is increased.

As a method for reducing optical noise, the techniques of JP 2014-222239 A and JP 2000-206449 A described above are disclosed. In JP 2014-222239 A, the inclination angle of irradiation is changed for each emitting light from plural light sources. When plural light sources are used, the device tends to be complicated and large. On the other hand, when a single light source is used, the phase difference between irradiated lights at inclination angles is always fixed, so that the problem of increased optical noise occurs.

JP 2000-206449 A describes a method for reducing optical interference noise. However, in order to realize highly accurate detection, measurement, or imaging, further reduction of optical interference noise is desired.

In JP 4657379 B, a pixel memory is provided in a solid-state imaging sensor, and a detection time for each pixel can be independently set, so that ultrahigh-speed imaging can be performed. However, when optical interference noise is mixed into irradiated light to a measured object on which ultra-high speed imaging is performed or reflected light from the measured object, the quality of a captured image greatly deteriorates.

JP 6536984 B calculates sizes of a measured object using distance information to the measured object. However, JP 6536984 B does not disclose specific technical content related to a method of extracting distance information and a method of calculating sizes of a measured object.

So far, the present technical problems have been mainly described from the viewpoint of optical characteristics required for each optical application field. From now on, turning the viewpoint, the current technical problems are examined from the viewpoint of services to be provided to users.

Currently, a method of displaying information including complicated content focuses on “a list of text characters written on a two-dimensional plane”. Therefore, the current “list of text characters written on the two-dimensional plane” puts a great burden (time and effort) on a user, and causes a decrease in interest in the transmitted information. Therefore, it is desirable to provide an information transmission method or a display method capable of expressing complicated information content in an easily understandable manner. Furthermore, it is also desired to provide a method of improving convenience when a user uses provided information.

In addition, the present invention is not limited thereto, and it is also desired to provide a work environment in which the work efficiency of a user is improved, provide a business support environment in which the intellectual business support is enabled, or provide an environment in which a user can enjoy work and business.

Transmission of an image in which “the amount of information simultaneously transmitted is large” reduces the burden on a user to collect information and prevents a decrease in the user's interest. However, the current image expression focuses on “layout of images (or planar movies) on a two-dimensional plane”. This two-dimensional image expression lacks a presence feeling. An image concealed by a shadow of an image disposed in front thereof cannot be visually recognized. As described above, in the current two-dimensional image expression, great inconvenience (discomfort) is given to a user.

Therefore, it is desirable to provide information transmission means, information expression means, and display means capable of not only giving a presence feeling and convenience to a user but also accurately transmitting information at a high speed in a short period of time. Furthermore, convenience that cannot be realized by human vision may be provided to a user.

As an example of improving two-dimensional image expression having a poor presence feeling, a “three-dimensional image expression method” is examined. When a human sees a three-dimensional shape from a single direction, a back side of the three-dimensional shape cannot be seen in this direction, and information regarding the back side of the three-dimensional shape cannot be obtained. In addition, when this three-dimensional shape is imaged from only one direction (imaging view line) by an imaging device, the back side of the three-dimensional shape cannot be similarly imaged. Therefore, similarly, information regarding the back side of the three-dimensional shape cannot be obtained. It is also desired to provide a technique for improving visual field defects for such a three-dimensional shape (or three-dimensional information).

Furthermore, examples of the human visual limits include those for increases in a “focus depth range”, a “visible illuminance range”, and a “visible wavelength range”. For example, when the human eye focuses on one of a near object and a distant object, focus on the other is blurred. Therefore, user convenience is improved when images (or movies) in focus at all distances can be simultaneously displayed. Furthermore, when “a location that is too bright or dark to be seen by human eyes” can be displayed, user's convenience is improved.

### BRIEF SUMMARY OF THE INVENTION

In the three-dimensional projective reverse transformation, a distance to the measured object is measured, and 3D coordinate values of each point in the measured object corresponding to each of a plurality of pixels configuring the imaging sensor is calculated. In the three-dimensional projective transformation, a three-dimensional shape of the display object is set. Positions of both eyes of a user with respect to the position of the display object are measured. A plurality of projected images or projected movies individually visible to the right side eye and the left side eye are formed. The optical device described in the present embodiment example generates synthesized light or collects and analyzes a periodic signal waveform. The results of the synthesized light generation and the collection and analysis of the periodic signal waveform may be used for the three-dimensional projective transformation or the three-dimensional projective reverse transformation. Furthermore, service provision may be performed using either the three-dimensional projective transformation or the three-dimensional projective reverse transformation.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1A is a configuration diagram showing an example of an overview of the entire system.

FIG. 1B also is the configuration diagram showing an example of an overview of the entire system.

FIG. 2 is an explanatory diagram of the relationship of (desirable) optical characteristics required in various application fields.

FIG. 3 illustrates an embodiment example of an optical device using a combination of a light source and a measurer.

FIG. 4 illustrates another embodiment example of an optical device in which a light source and a measurer are combined.

FIG. 5 illustrates an embodiment example of an optical device in which a light source, a measurer, and a display are combined.

FIG. 6 illustrates another embodiment example of an optical device in which a light source, a measurer, and a display are combined.

FIG. 7 is explanatory diagram of an application example to a display device.

FIG. 8 is an explanatory diagram of an internal structure example and a specific processing content example of a signal receptor, a signal processor, and a signal/information converter.

FIG. 9 is an explanatory diagram of a hierarchical structure example related to information processing inside an optical device mainly including a system controller and an adjuster group to each optical application.

FIG. 10 is an explanatory diagram of an example of a function-sharing configuration for each area in a real size construction application software providing kinds of services operating on a virtual four-dimensional (time-space) platform.

FIG. 11 is a diagram for describing a schematic role example for each area in the system controller and the adjuster group to each optical application corresponding to FIG. 10.

FIG. 12 is an explanatory diagram of a layout state example in a virtual four-dimensional time-space in which a real object image having real sizes and a 3D model created using CG are combined.

FIG. 13 is an explanatory diagram of an example of a 3D model creation procedure performed by a 3D model creation and modification area in the present embodiment.

FIG. 14 is an explanatory diagram of an example of setting sizes to a 3D model created using CG.

FIG. 15 illustrates a real space layout example in a case where there is a light shield object near a user.

FIG. 16 is a diagram illustrating a change of a position in both eyes when a user looks at a distant measured object while avoiding a light shield object.

FIG. 17 illustrates a difference in appearance of a rear picture depending on the presence or absence of a light shield object near a user.

FIG. 18 illustrates necessity of 2D projective transformation corresponding to a position change of the user's eye.

FIG. 19 is a diagram for describing the importance of a newly proposed three-dimensional projective transformation method example.

FIG. 20 is an explanatory diagram of a procedure example of a three-dimensional projective transformation method using a measurement size (real size) acquired from a real object (measured object) in the present embodiment.

FIG. 21 is an explanatory diagram of a specific three-dimensional projective transformation method example in the present embodiment.

FIG. 22 illustrates an example of a three-dimensional shape emphasizing method as an application example of three-dimensional projective transformation.

FIG. 23 illustrates a basic concept of a three-dimensional projective reverse transformation method proposed in the present embodiment example.

FIG. 24 is an explanatory diagram illustrating a detailed procedure example of three-dimensional projective reverse transformation.

FIG. 25 is an explanatory diagram of an example of a method of designating an area where three-dimensional projective reverse transformation is to be performed.

FIG. 26 is an explanatory diagram of a focus adjustment mechanism for a measured object based on human eyes.

FIG. 27 is an explanatory diagram of a method of adjusting a focus on a measured object using a measurer.

FIG. 28 is an explanatory diagram of an example of a 3D coordinate value calculation method based on an image forming lens position.

FIG. 29 is an explanatory diagram of a relationship between different point sets having 3D coordinate values collected at different imaging view lines.

FIG. 30 is an explanatory diagram of an example of a combination procedure between different point sets having 3D coordinate values.

FIG. 31 illustrates an example of a notation method related to a three-dimensional coordinate position of each three-dimensional coordinate point including color information.

FIG. 32 illustrates an embodiment example of a three-dimensional shape processing area, and illustrates a series of processing procedure examples from “a point set having 3D coordinate values after registration” to “separation/identification into constituent elements in a specific object”.

FIG. 33 illustrates an example of a method of forming a curved surface or a flat surface by connecting three or four adjacent three-dimensional coordinate points.

FIG. 34 illustrates an embodiment example of a separation method between different objects performed using characteristics of a curved surface or a flat surface formed by connecting adjacent three-dimensional coordinate points.

FIG. 35 is an explanatory diagram of a four-dimensional mesh structure that captures a change in surface shape of a measured object in the present embodiment.

FIG. 36 is an explanatory diagram of a data structure of a four-dimensional mesh in the present embodiment.

FIG. 37 illustrates an embodiment example in which only sizes of a prescribed constituent element in an imaged real object are changed.

FIG. 38 illustrates a processing procedure example in the present embodiment related to motion detection.

FIG. 39 is an explanatory diagram of an application example (including size matching between a real space and the in-cyberspace display content) of a motion detection result in the present embodiment.

FIG. 40 is explanatory diagram of a basic concept related to distance measurement.

FIG. 41 is an enlarged view of an inside of an imaging sensor used in the present embodiment.

FIG. 42 is a partial explanatory diagram of a drive circuit in the imaging sensor used in the present embodiment.

FIG. 43 illustrates operation timings in the drive circuit described with reference to FIG. 41.

FIG. 44 illustrates an example of a structure in an optical device when a 3D color imaging sensor is used in a measurer.

FIG. 45 is an explanatory diagram of a 3D color image (movie) collection procedure.

FIG. 46 is an explanatory diagram of a reflected light pattern imaging method with light source wavelength light in the entire measured distance area.

FIG. 47 is an explanatory diagram of a reflected light pattern imaging method with light source wavelength light for each measured distance area.

FIG. 48 is an explanatory timing diagram of light source light emission and measurer detection at the time of detailed distance measurement.

FIG. 49 is an explanatory diagram of a distance measurement method in which plural pixels are combined.

FIG. 50 illustrates a method of combining light emission and detection for reducing the influence of speckle noise.

FIG. 51 is an explanatory diagram of a signal detection state in a measurer that monitors a speckle noise amount.

FIG. 52 is an explanatory diagram of a signal detection state in a measurer that reduces an influence of speckle noise.

FIG. 53 is explanatory diagram of an optical device convenient for 3D projective reverse transformation.

FIG. 54 shows an optical device embodiment convenient for 3D projective reverse transformation.

FIG. 55 illustrates another application example related to an optical device that enables three-dimensional projective reverse transformation.

FIG. 56A illustrates an example of a distance measurement procedure in the present embodiment.

FIG. 56B also illustrates the example of the distance measurement procedure in the present embodiment.

FIG. 57 is an explanatory diagram of a distance measurement method in which a detection phase is changed.

FIG. 58 illustrates a distance measurement method in which a detection phase is changed by effectively using a charge accumulation amount.

FIG. 59 is an explanatory diagram of a distance measurement method in which a light emission phase is changed.

FIG. 60 illustrates an example of a measurement method in which both a light emission phase and a detection phase are changed.

FIG. 61 is an explanatory diagram of a rough distance measurement method in the present embodiment.

FIG. 62 is an explanatory diagram of a high-accuracy distance measurement method in the present embodiment.

FIG. 63 illustrates examples of a detection phase profile or light emission phase profile corresponding to charge accumulation values obtained as a result of measurement.

FIG. 64 illustrates an example of a distance information calculation method of each pixel included in an imaging sensor relating to a depth (distance) signal in the present embodiment.

FIG. 65 is an explanatory diagram of a change in a detection signal in a case where different plural pieces of distance information are input to a pixel included in the imaging sensor relating to a depth (distance) signal.

FIG. 66 is a diagram for describing a difference in an image pattern projected for each pixel between an imaging sensor relating to a depth (distance) signal and an imaging sensor detecting color signals of which pixel sizes are different.

FIG. 67 illustrates a correction example of 3D coordinate values in the present embodiment in a case where a color image obtained from an imaging sensor detecting color signals is used.

FIG. 68 illustrates an example of the present embodiment example of a distance information correction method procedure using a color image obtained from an imaging sensor detecting color signals.

FIG. 69 illustrates a circuit configuration example in which charge can be repeatedly accumulated a plurality of times within the same measuring period in the present embodiment.

FIG. 70 illustrates a detection phase profile or light emission phase profile corresponding to charge accumulation values within measuring periods obtained as a result of measurement using the present embodiment.

FIG. 71 is an explanatory diagram of an example of a repeated current driving method of improving rising characteristics of repeated light emission in the present embodiment in a case where a VCSEL is used for a light emitter.

FIG. 72 is an explanatory diagram of an example of a structure of a light impulse control circuit in a light source.

FIG. 73 is an explanatory diagram showing the temperature profile of the VCSEL light emission intensity.

FIG. 74 is an explanatory diagram of an example of a method for fixing a 2D light emitter (VCSEL).

FIG. 75 is an explanatory diagram of an optical noise based on Spatial Coherence.

FIG. 76 is an explanatory diagram of an optical noise based on Temporal Coherence.

FIG. 77 is an explanatory diagram of a mechanism by which a set of different wavelength constitutes Wave Train.

FIG. 78 is an explanatory diagram of a Wave Train profile measurement experimental system using an optical interference phenomenon.

FIG. 79 shows an interference characteristic between a part of Wave Train and another part of the Wave Train that is delayed to the part of Wave Train.

FIG. 80 shows an experimental result of measuring the Wave Train profile.

FIG. 81 shows a relationship between successive Wave Trains predicted based on the experimental result in FIG. 79.

FIG. 82 illustrates characteristics obtained by dividing light into wavelength light beams configuring wave trains between front and rear wave trains.

FIG. 83 is an explanatory diagram of the fundamental principle for using the optical phase unsynchronized characteristic between front and rear Wave Trains in the present embodiment.

FIG. 84 is an explanatory diagram showing a specific optical arrangement example when the optical phase unsynchronized characteristic is used,

FIG. 85 is a configuration explanatory diagram of an optical experimental system for confirming an effect of an optical path length varying component for a spectral profile.

FIG. 86 is an explanatory diagram illustrating an effect that the optical path length varying component reduces noise in the spectral profile.

FIG. 87 shows another embodiment related to the specific structure of the optical characteristic converting component.

FIG. 88 shows an application example related to the specific structure of the optical characteristic converting component.

FIG. 89 shows an exemplary structure of the optical characteristic converting component having a hollow area.

FIG. 90 is an explanatory diagram of the present embodiment example in a case of measuring a spectral profile of a measured object using transmitted light.

FIG. 91 is an explanatory diagram of a relation between constituents included in a biological system and corresponding absorption wavelength.

FIG. 92 is an explanatory diagram of an experimental optical system used in an experiment for signal processing/data analysis.

FIG. 93 shows spectral profiles of irradiated light and detection light with respect to the measured object.

FIG. 94 shows an example of signal processing/data analysis results in the present embodiment.

FIG. 95 illustrates an explanatory example of a measurement state for measuring characteristics of a subject.

FIG. 96 is an enlarged view of a measurement area when subject characteristics are measured.

FIG. 97 is an explanatory diagram illustrating a cross-sectional structure example of VCSEL.

FIG. 98 is an explanatory diagram of an arrangement location of the optical characteristic converting component in the optical system using the optical phase unsynchronized characteristic.

FIG. 99 is an explanatory diagram of an example in which a transmissive optical characteristic converting component is arranged in a near-field area.

FIG. 100 is an explanatory diagram of a method of selecting different Wave Trains between different optical paths.

FIG. 101 is an explanatory diagram of a discontinuous portion existing in the diffraction generation component.

FIG. 102 is an explanatory diagram of an influence of a difference in a state immediately before a light reflection face in the optical characteristic converting component.

FIG. 103 is an explanatory diagram of an embodiment example related to the reflective optical characteristic converting component.

FIG. 104 is an explanatory diagram of an embodiment example related to a method for manufacturing an exemplary reflective optical characteristic converting component.

FIG. 105 shows another embodiment example related to a method for manufacturing an exemplary reflective optical characteristic converting component.

FIG. 106 illustrates an embodiment application example of an optical system in a light source using an optical characteristic converting component based on light reflection.

FIG. 107 is an explanatory diagram illustrating an influence of a light reflection location in the optical characteristic converting component on the optical system.

FIG. 108 is an explanatory diagram of an effect of a concave lens disposed immediately after an image pattern forming plane of a multipoint light emitter.

FIG. 109 illustrates experimental results regarding numeral information on a total number of divided areas included in an optical characteristic converting component based on light reflection and the speckle noise reduction effect.

FIG. 110 is an explanatory diagram of an embodiment in a case where optical characteristic converting components are disposed in both a near field area and a far field area.

FIG. 111 is an explanatory diagram of an embodiment example of a light source in which a multipoint light emitter and a partial discontinuous surface are combined.

FIG. 112 is an explanatory diagram of a cause of speckle noise generation.

FIG. 113 is an explanatory diagram of a mode of light passing through a core area of an optical fiber.

FIG. 114 is an explanatory diagram of generation of an intensity gravity center deviation using mode addition in the optical fiber.

FIG. 115 illustrates a speckle noise reduction method using the intensity gravity center deviation.

FIG. 116 is an explanatory diagram of an embodiment example in which the three-dimensional projective reverse transformation technology is applied.

FIG. 117 illustrates another embodiment example in which the three-dimensional projective reverse transformation technology is applied to another field.

FIG. 118 illustrates an embodiment example of an information input method using motion detection under the environment in FIG. 117.

FIG. 119 illustrates an embodiment example of a three-dimensional stamping method.

FIG. 120 illustrates an embodiment example of converting a literature on a flat paper into three-dimensional evidence.

FIG. 121 illustrates an embodiment example of automatically generating a literature from path designation in the three-dimensional evidence.

FIG. 122 is an explanatory diagram of an example of a three-dimensional display based on three-dimensional projective transformation.

FIG. 123 illustrates an embodiment example regarding a supporting device corresponding to an avatar appearing in a three-dimensional display space.

FIG. 124 is an explanatory diagram of a series of processing procedures related to a meeting setting task, which is an example of a task for which an end user requests deputy action.

FIG. 125 is an explanatory diagram of a processing procedure corresponding to adjustment of a schedule of a meeting.

FIG. 126 illustrates a method of efficiently measuring a three-dimensional shape by defining a measuring area of three-dimensional shapes in the present embodiment example.

FIG. 127 illustrates a state of a measured object within a measuring area of three-dimensional shapes.

FIG. 128 is an explanatory diagram of a specific method example of defining a measuring area of three-dimensional shapes in optical distance measurement of the present embodiment example.

FIG. 129 is an explanatory diagram of a relationship between an input device and an output device with respect to a prescribed service providing domain in a cyberspace.

FIG. 130 illustrates an embodiment example used in a different application field to which the three-dimensional projective reverse transformation technology is adapted.

FIG. 131 illustrates another embodiment application example using the three-dimensional projective reverse transformation technology.

FIG. 132 is an explanatory diagram of a mapping concept used in a service providing domain in which a user easily controls the passing time in a cyberspace.

FIG. 133 is a procedure explanatory diagram up to generation of a four-dimensional image (movie) to be displayed to the user using a mapping technology.

FIG. 134 illustrates an example of a method of rendering an individual four-dimensional mesh structure on a map and a coordinate conversion method.

FIG. 135 is an explanatory diagram of a color intensity adjustment method according to a lighting condition in a corresponding map.

FIG. 136 is an explanatory diagram of a three-dimensional display-compatible coordinate conversion method for a user.

FIG. 137 illustrates a model for calculating a distance to a measured object at the time of irradiation with parallel light.

### DETAILED DESCRIPTION OF THE INVENTION

A three-dimensional projective transformation method, a three-dimensional projective reverse transformation method, an optical device, a synthesized light applying method, a measurement method, an imaging method, a signal processing method, a service providing method, a measurement device, and a service providing system according to the present embodiment are described in the following procedure with reference to the drawings.
Chapter 1 System overview used in present embodiment
Chapter 2 Content of three-dimensional projective transformation method and three-dimensional projective reverse transformation method in present embodiment
Chapter 3 Description of example of optical distance measurement method that can be used for three-dimensional projective reverse transformation as present embodiment
Chapter 4 Description of optical noise generated due to interference phenomenon of light and proposal of method of reducing optical noise
Chapter 5 Service provision application example using three-dimensional projective reverse transformation technique

### Chapter 1 System Overview Used in Present Embodiment

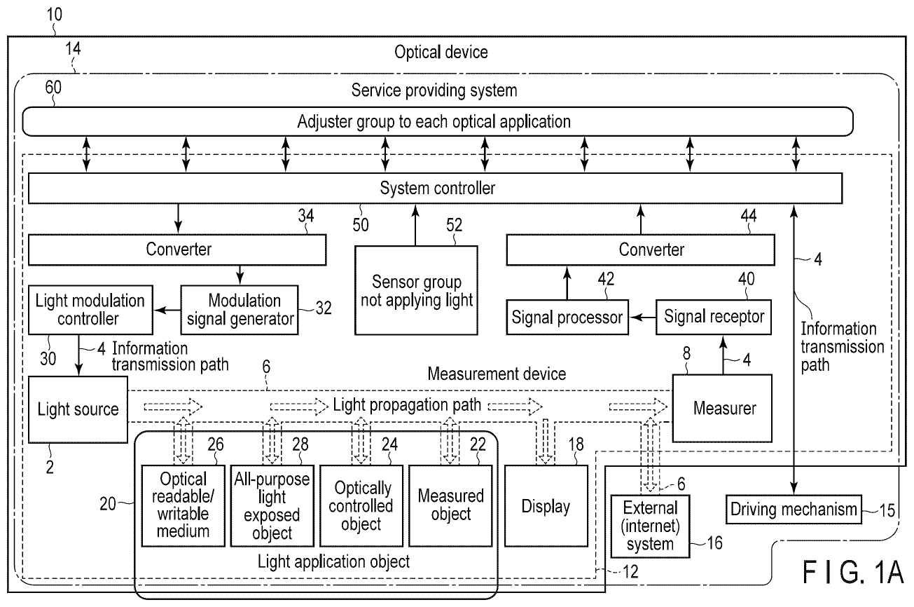

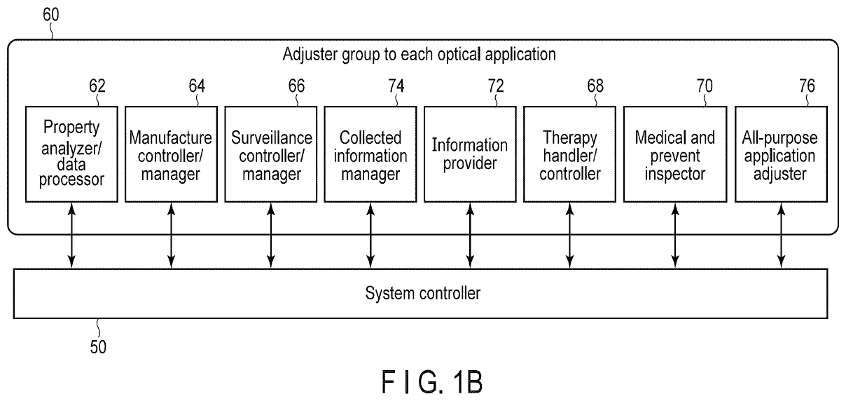

FIGS. 1A and 1B show a system used in the present embodiment. Light emitted from a light source 2 is irradiated on a measured object 22 via a light propagation path 6. The light obtained from this measured object 22 is incident on a measurer 8, again, via the light propagation path 6. In addition, not limited to this, the light emitted from the light source 2 may also be directly incident on the measurer 8 via the light propagation path 6. As another embodiment, the light emitted from the light source 2 may reach a display 18 via the light propagation path 6 and display predetermined information on the display 18.

A measurement device 12 in the present embodiment comprises the light source 2, the measurer 8, and a system controller 50. In addition, an adjuster group to each optical application 60 exists outside the measurement device 12. Each part 62 to 76 in the adjuster group to each optical application 60 can individually exchange information with the system controller 50.

For example, information obtained as a result of measurement by the measurer 8 and the parts 62 to 76 in the adjuster group to each optical application 60 are utilized in cooperation to provide services to the user.

A service providing system 14 in the present embodiment comprises the above measurement device 12, the above adjuster group to each optical application 60, and an external (internet) system 16 and is configured to provide all kinds of services to users. Here, the part remaining after removing the external (internet) system 16 from the above service providing system 14 functions independently as an optical device 10.

A system controller 50 creates original information of a modulated signal of light emitted from a light source 2. First, the original information is transmitted to an information/signal converter (including encryption/signal modulation) 34 from the system controller 50. The information/signal converter (including encryption and signal modulation) 34 encodes the original information and then performs signal modulation. In this process, the original information may be scrambled. The modulated signal is transmitted to the light source 2 via a modulation signal generator 32 and a light modulation controller 30.

The modulated signal of the light emitted from the light source 2 basically takes a form in which “an emission light intensity changes in time series”. The light modulation controller 30 controls this “time-series change in emission light intensity”. Here, a modulated signal form of light may be “repetition of time-series light emission intensity change patterns in a prescribed cycle”. Alternatively, any method such as amplitude modulation, frequency modulation, or phase modulation may be used.

The measurer 8 receives light from the outside. In the present embodiment example, light obtained from the measured object 22 is often received. However, the present invention is not limited thereto, and light emitted from the light source 2 may be directly received. The signal receptor 40 converts (photoelectrically converts) the light received by the measurer 8 into an electrical signal.

The signal processor 42 performs “signal processing” on the electrical signal after conversion in the signal receptor 40. The electrical signal after conversion in the signal receptor 40 includes a large amount of influence of the measurement environment due to not only optical noise and electrical noise but also stray light and external light. The signal processor 42 may not only perform processes such as noise component removal, removal of the influence of stray light/external light, and the like, but also improve measured signal accuracy and measured signal stability (reproducibility) using a unique signal processing method.

The signal processed by the signal processor 42 is transferred to a signal/information converter (including decryption/signal demodulation) 44. The signal/information converter (including decryption/signal demodulation) 44 performs demodulation on the signal. Thereafter, the signal is decoded or descrambled as necessary, and is then transmitted to the system controller 50. By performing these series of processes, the accuracy and reliability of the information obtained through the measurer 8 are improved.

Furthermore, in the present embodiment example, a driving mechanism 15 present outside the optical device 10 may be directly moved. To do so, it is necessary to appropriately operate the driving mechanism 15 in accordance with an external environment in which the driving mechanism 15 is present and an external situation. In this case, the system controller 50 determines the external environment and the external situation of the driving mechanism 15 using the measured signal from the measurer 8 and sensor signals from a sensor group 52 not applying light, obtained via an information transmission path 4. Based on the determination result, the system controller 50 appropriately operates the driving mechanism 15.

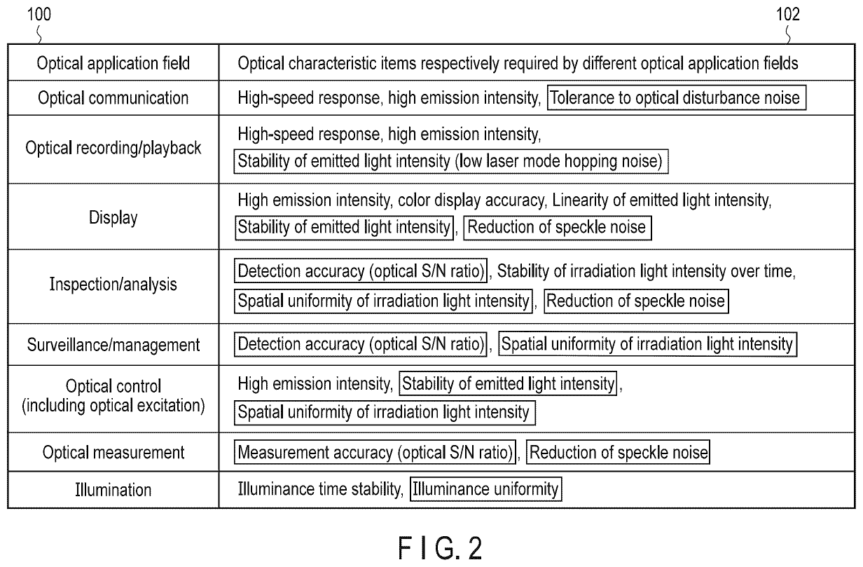

An optical application field 100 applied as the present embodiment is illustrated in FIG. 2. The present embodiment is not limited to a light measurement field and a display field using light, and can be applied to various technical fields such as an optical communication field, a recording or reproducing field using light, an inspection and analysis field using light, a monitoring and situation management field, a light control field including light excitation, and a lighting field. However, the present embodiment is not limited thereto, and can be applied to all application fields 100 related to light in any form.

FIG. 2 illustrates a list of optical characteristic items 102 respectively required by different optical application fields 100. In particular, technical content conforming to the required optical characteristic items 102 surrounded by a square frame is described in the present embodiment example described in the next and subsequent chapters.

That is, in the technical field of optical measurement, measurement accuracy, measurement stability, and measurement reproducibility are strongly required, and here, in order to ensure high measurement accuracy, a high signal to noise ratio (S/N ratio) with respect to an optically obtained signal is required. In particular, when laser light is used as a light source for optical measurement, generation of speckle noise causes a decrease in measurement accuracy. Therefore, in this case, reduction of speckle noise is strongly required.

In the display field, not only a high light emission intensity and linearity between a drive current and an emitted light intensity but also a color tone display system and the like are required. However, in order to perform accurate and beautiful display, it is important to stabilize an emitted light intensity and to reduce speckle noise.

As far as the optical characteristic items 102 respectively required by the different optical application fields 100 in FIG. 2 are viewed, the content surrounded by the square frame is commonly important in any technical field. That is, “high detection accuracy (improvement of optical S/N ratio)”, “emitted light intensity stability”, “spatial uniformity of an irradiated light intensity”, and “durability against optical disturbance”, and the like are desirable elements. This embodiment example for achieving these important optical characteristics is described focusing on Chapter 4.

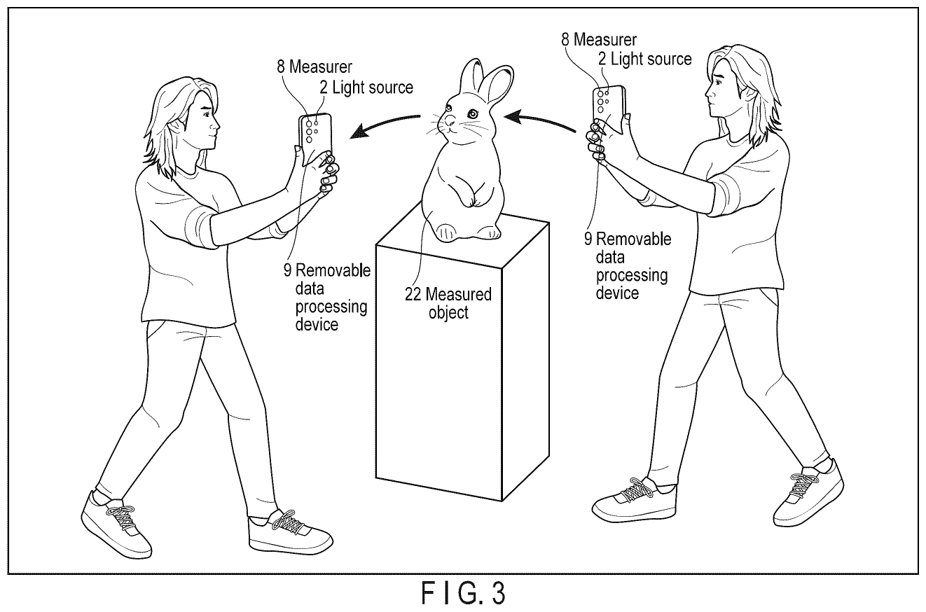

FIGS. 1A and 1B illustrate a relationship between components in the optical device 10 or the service providing system 14 according to the present embodiment. Examples of applications (usage situations) of the optical device 10 or the service providing system 14 are illustrated in FIGS. 3 to 7. In the embodiment examples illustrated in FIGS. 3 to 7, three-dimensional information or a three-dimensional shape can be handled in common.

The embodiment example illustrated in FIG. 3 represents an information portable terminal (removable data processing device 9) including the light source 2 and the measurer 8. The measured object 22 is irradiated with the light emitted from the light source 2. A part of the light reflected by the measured object 22 enters the measurer 8. The measurer 8 measures the “time required for light to be emitted from light source 2, be reflected by measured object 22, and return to the measurer 8”. The inside of the information portable terminal (removable data processing device 9) calculates a distance from the information portable terminal (removable data processing device 9) to the measured object 22 using the above “required time”.

The measurer 8 of the present embodiment example includes an imaging sensor including a plurality of pixels. The information portable terminal (removable data processing device 9) predicts a three-dimensional shape of the measured object 22 using the light incident to each pixel. The measured object 22 existing in the real world has a three-dimensional shape. Therefore, in order to ascertain a three-dimensional shape of the entire measured object 22, it is necessary to observe the three-dimensional shape of the measured object 22 from a plurality of different view lines.

First, a case where a photographer holding the information portable terminal (removable data processing device 9) stands on the right side of the measured object 22 is considered. Three-dimensional shape information of the measured object 22 viewed from the right side is acquired through imaging from the right side view line of the measured object 22. In FIG. 3, the photographer next stands on the left side of the measured object 22. Three-dimensional shape information of the measured object 22 viewed from the left side is acquired by imaging from the left side view line of the measured object 22.

Thereafter, the information portable terminal (removable data processing device 9) performs registration between the three-dimensional shape information viewed from the right side and the three-dimensional shape information viewed from the left side. Through this registration, the three-dimensional shape information of the entire measured object 22 can be acquired. When the same measurer 8 is moved as described above, the three-dimensional shape information of the measured object 22 viewed from different view lines can be acquired at different times. When a plurality of pieces of three-dimensional shape information imaged by moving the same measurer 8 (the information portable terminal or the removable data processing device 9) are registered, the three-dimensional shape information of the entire measured object 22 can be easily and inexpensively acquired.

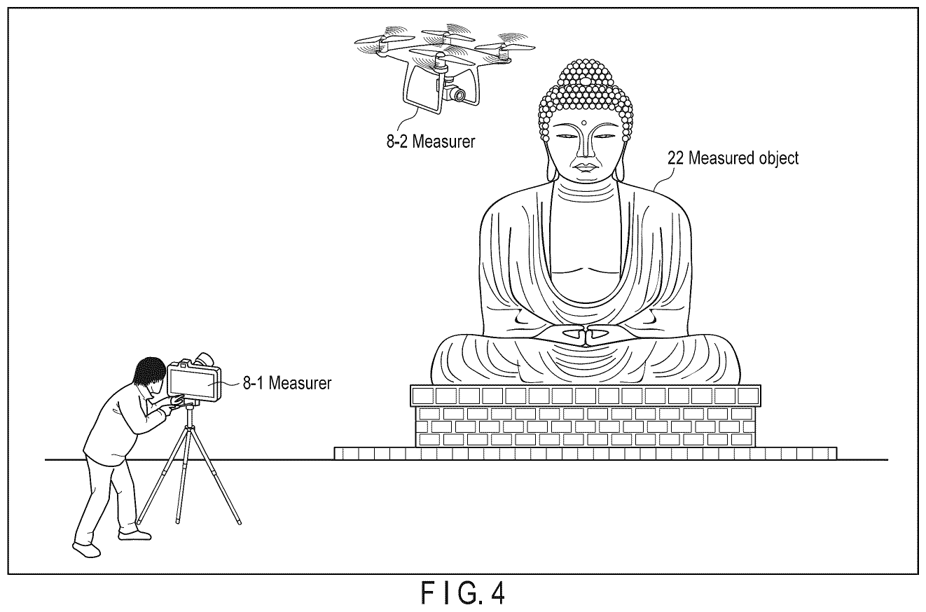

FIG. 4 illustrates a method of acquiring three-dimensional shape information of the entire measured object 22 by simultaneously using a plurality of different measurers 8-1 and 8-2. Among the plurality of measurers 8-1 and 8-2, a measurer 8-1 may be disposed in a fixed portion. The light source 2 may be installed in the fixed portion. The plurality of different measurers 8-1 and 8-2 can simultaneously receive the light emitted from the light source 2 and reflected by the measured object 22. As a method of acquiring the three-dimensional shape information in this case, the same method as that described in FIG. 3 may be used.

Among the plurality of different measurers 8-1 and 8-2, at least one measurer 8-2 may be movable. Furthermore, control may be performed such that a position of the movable measurer 8-2 always falls within the visual field of the measurer 8-1 disposed at the fixed portion. The three-dimensional shape information captured (the three-dimensional shape acquired) by the measurer 8-1 includes the position information of the measurer 8-2 that is always movable. As a result, registration (alignment) between pieces of three-dimensional shape information (the three-dimensional shape information acquired by the measurer 8-1 and the three-dimensional shape information acquired by the measurer 8-2) from different view lines can be easily performed.

In order to acquire the three-dimensional shape information of the entire measured object 22 having a large size, use of a plurality of different measurers 8-1 and 8-2 at the same time increases the efficiency. Specifically, when a size of the measured object is 50 cm or more (1 m or more), the imaging efficiency is improved. On the other hand, when a size of the measured object 22 is larger than 100 m (or 1 km), an irradiated light intensity from the light source 2 decreases. Therefore, in a case where the length of the longest location in the measured object 22 is 50 cm or more (desirably 1 m or more) and 1 km or less (desirably 100 m or less), the use of the plurality of different measurers 8-1 and 8-2 simultaneously increases the imaging efficiency.

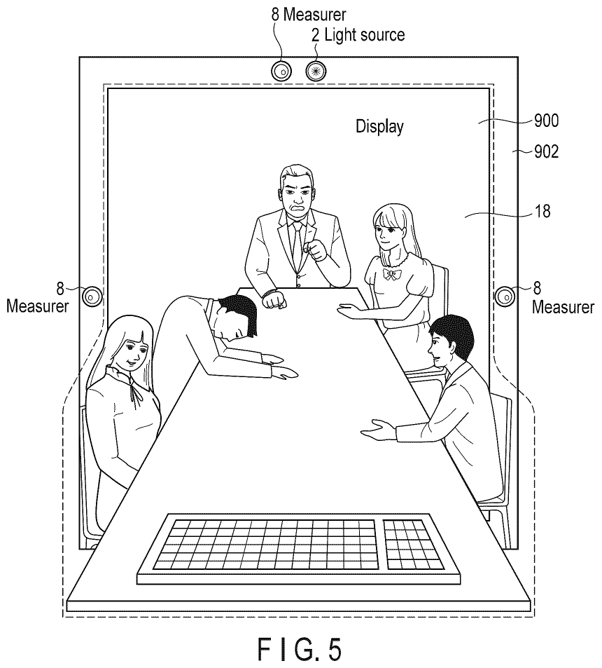

FIG. 5 illustrates an embodiment example of the display 18 including layouts of the light source 2 and the measurer 8. In FIG. 5, a thin stand-alone display (a three-dimensional display of a computer system or wall hanging) 900 is used as an embodiment example of the display 18. A part of the thin stand-alone display 900 or a part of the outer side thereof (an outer frame of the three-dimensional display of a computer system or wall hanging) 902 includes a light source 2 and a plurality of measurers 8.

An end user is located in front of the thin stand-alone display (the three-dimensional display of a computer system or wall hanging) 900 (that is, on the front side of the drawing surface illustrated in FIG. 5). Similarly to the method described with reference to FIG. 3, three-dimensional shape information of the measured object 22 is acquired through a combination of the light source 2 and the measurers 8. However, the measured object 22 in the embodiment example illustrated in FIG. 5 corresponds to the end user in front of the thin stand-alone display (the three-dimensional display of a computer system or wall hanging) 900. Three-dimensional shape information of the end user is analyzed to detect positions of the right and left side eyeball, an orientation of the face, and positions of the hands and the fingers of the end user. In particular, by disposing a plurality of measurers 8 at different positions, three-dimensional images (three-dimensional movies) can be collected in a polygonal manner. That is, positions of individual parts (the left and right side eyeballs, the face, the hand, the fingers, and the like) in the end user can be accurately measured using the positions where the individual measurers 8 are disposed.

Lenticular lenses (fine cylindrical lenses) are arranged in the lateral direction on the surface of the thin stand-alone display (the three-dimensional display of a computer system or wall hanging) 900. The measurers 8 measure the three-dimensional positions of the eyeballs of the end user in real time. In accordance with the eyeball position of the end user (through eye tracking), a right side eye image and a left side eye image of the end user are created individually for each pixel in the thin stand-alone display (the three-dimensional display of a computer system or wall hanging) 900. In addition, the lenticular lens controls the light propagation direction to irradiate the right side eye of the end user with the right side eye image and direct the left side eye image toward the left side eye. A virtual position (quasi-position) in the front-rear direction captured by the right side eye and the left side eye is changed using a difference in a convergence angle for each image. As a result, different quasi-three-dimensional images can be displayed to the end user.

The virtual keyboard seen on the foremost side in FIG. 5 is an example of a display. Through the combined action of the light source 2 and the measurers 8, a three-dimensional position of each of the ten fingertips of the end user can be measured in real time. For example, when the end user places both hands on the three-dimensionally displayed virtual keyboard and moves the ten fingers, a virtual typing operation can be performed.

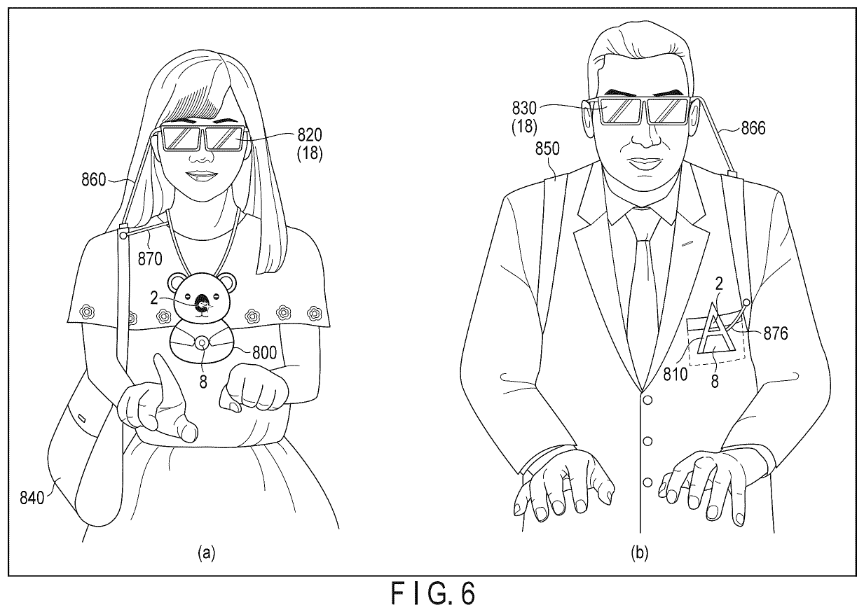

FIG. 6 illustrates another different embodiment example related to the display 18. Similarly to FIG. 5, the embodiment example in FIG. 6 also includes a light source 2 and a measurer 8. As another embodiment example of the display 18, augmented reality (AR) glasses 820 and 830 capable of three-dimensional display are used. The AR glasses 820 and 830 separately display a right side eye image (movie) and a left side eye image (movie), and three-dimensionally display the images using the difference in the convergence angle described above. Note that VR (virtual reality) glasses or MR (mixed reality) glasses may be used instead of the AR glasses 820 and 830.

FIG. 6 (b) illustrates an example in which a virtual keyboard disposed at a position away from the end user by a prescribed distance is displayed as a three-dimensional display (movie). The end user sees the virtual keyboard and types the virtual keyboard while moving the ten fingers. A broach fixed to a breast pocket of the end user has the light source 2 and the measurer 8, and the fingertips of the end user reflects light emitted from the light source 2. The measurer 8 uses the reflected light from the fingertips to measure three-dimensional position information of the ten fingertips in real time.

The end user carries a knapsack 850 including a power supplier, a system controller 50, and a network communicator for the outside. The knapsack 850 supplies power to the AR glasses 830 (display 18) via a connection cable 866. Furthermore, the system controller 50 included in the knapsack 850 generates a right side eye image (movie) and a left side eye image (movie), and transmits the images to the AR glasses 830 via the connection cable 866.

At the same time, the knapsack 850 supplies power to the broach 810 via the connection cable 866. The measurer 8 is connected to the knapsack 850 via a connection cable 876. The measurer 8 transmits collected three-dimensional images or three-dimensional movies (three-dimensional information). The signal processor 42 (FIG. 1) in the knapsack 850 analyzes the three-dimensional images or the three-dimensional movies (three-dimensional information) to estimate tip motions of the ten fingers of the end user. A position in the virtual keyboard typed by the end user is determined using the estimation result. As described above, the three-dimensional measurement can be performed in real time. As described above, when the motion (motion detection) of an end user is used, various types of information generated as three-dimensional information can be input. In addition, since information can be input simply by a finger action, the burden on an end user is greatly reduced. When the input device has the three-dimensional measurement function as described above, an effect of greatly improving the convenience for the end user is achieved.

In the embodiment example in FIG. 6 (b), the knapsack 850 including the system controller 50, the broach 810 (including the light source 2 and the measurer 8), and the entire AR glasses 830 corresponding to the display 18 configure the optical device 10 (FIG. 1A).

Furthermore, in the embodiment example in FIG. 6 (a), a shoulder bag 840 including the system controller 50, a pendant or a necklace 800 (including the light source 2 and the measurer 8), and the entire AR glasses 820 corresponding to the display 18 configure the optical device 10 (FIG. 1A). A function of each device and data content transferred between the devices in FIG. 6 (a) correspond to those in FIG. 6 (b). Here, in FIG. 6 (a), the light source 2 and the measurer 8 are included in the pendant or the necklace 800, and have the function of the measurer 8.

Due to the action of the convergence angle created by the right side eye image and the left side eye image of the AR glasses 830 (display 18), a virtual keyboard or the like is displayed at a position away from the end user by a prescribed distance. This virtual image (3D model) in the virtual world has a three-dimensional structure (or a three-dimensional shape), and its position and shape change with passing time (that is, a virtual four-dimensional structure is obtained). In the present embodiment example, the virtual image (3D model) in the virtual world and a real object 1410 located in the real world such as the finger of the end user operate in interlocking with high accuracy.

In order to realize highly accurate interlocking operation, it is important to align a virtual image in the virtual world and a real object in the real world in a three-dimensional direction. As a specific method of the alignment, for example, “alignment of a virtual image in the virtual world with reference to a real object in the real world” may be performed. Specifically, there is a method of adjusting a position and a size of a virtual image in the virtual world to each position of a real object in the three-dimensional direction in the real world.

FIG. 6 (a) illustrates a scene example in which the end user performs alignment in the three-dimensional direction. Specifically, a position and a display size of the virtual image in the virtual world are adjusted with the left hand (real object 1410) of the end user as a reference. A motion of the index finger of the right hand of the end user may be used for this alignment.

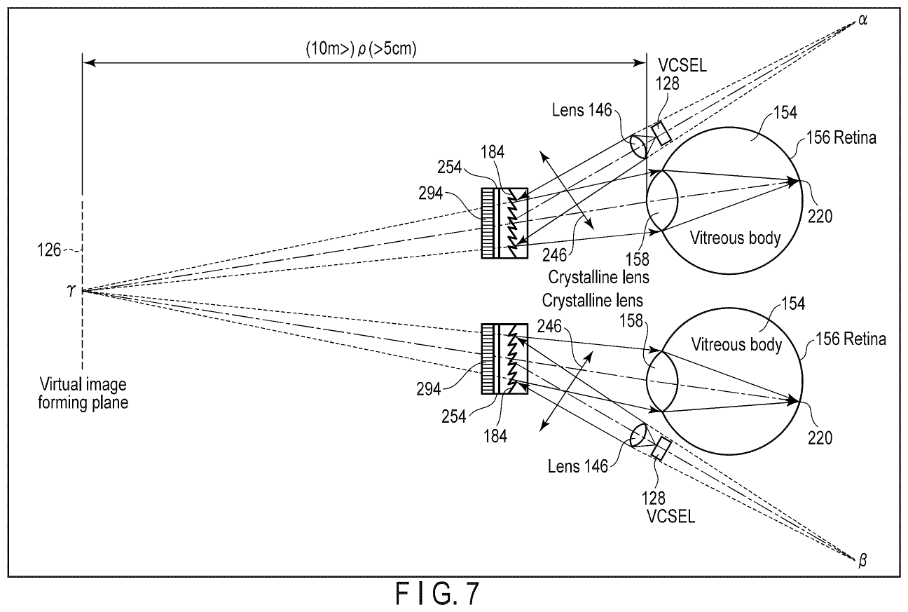

FIG. 7 illustrates an embodiment example of a display method (portable display device). VCSEL (Vertical Cavity Surface Emitting Laser) is well known as a multipoint light emitter or 2D wide area emitting laser diode. A virtual image forming lens 146 reduces the divergence angle of the divergent emitting light from the VCSEL 128. In this case, the optical synthesizing area 220 is located on the retina 156 of the user.

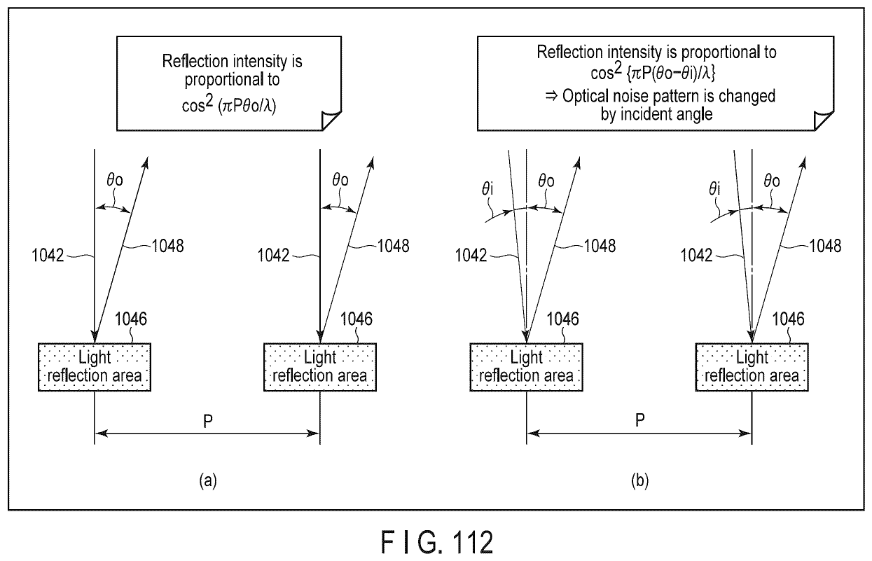

In the embodiment example of FIG. 112, half mirror surface 184 having the partially discontinuous surface (curved or plane surface) is arranged in the middle of the optical path of the emitting light. This greatly reduces optical interference noise from the emitting light. (Captor 4 is going to describe the noise reduction mechanism lately.) A Fresnel type half mirror surface may be used as the partially discontinuous surface (curved or plane surface) in the half mirror surface 184. Not limited to that, a half mirror surface of hologram type may be used.

In the embodiment example in FIG. 7, the distance “ρ” from the virtual image forming plane 126 to the crystalline lens 158 of the user is set to “5 cm” or more and “10 m” or less. When the distance “ρ” is narrower than “5 cm”, a burden is arranged on the eyes of the user. On the other hand, when the distance “ρ” is “10 m” or more, it becomes difficult to create a stereoscopic display image using a change in the convergence angle with respect to the “position γ” viewed by the user.

When the polarization direction of the emitting light 246 from the VCSEL is controlled, formation of a virtual image outside can be suppressed. For example, the polarization direction of the emitting light 246 from the VCSEL is aligned with the direction parallel to the paper surface. Then, a polarizer surface 254 is arranged outside the half mirror surface 184. The polarizer surface 254 has a characteristic of “transmitting light whose polarization direction is in a direction perpendicular to the paper surface” and “absorbing light whose polarization direction is in a direction parallel to the paper surface”. Then, according to the principle of crossed Nichol, the emitting light from the VCSEL does not leak to the outside, and formation of a virtual image outside can be suppressed.

Conversely, light from the outside passes through the polarizer surface 254. The orientation of the polarizer surface 254 coincides with “polarizable goggles used on ski slopes”. Ski slopes reflect a large amount of “sunlight having polarization characteristics in a direction parallel to the snow surface”, which is a burden on the eyes of ski user. Then, the polarization direction of the polarizer surface 254 in the polarizable goggles is aligned with the above. Then, “sunlight having polarization characteristics in a direction parallel to the snow surface” does not reach the eyes of the user. On the other hand, since “sunlight having a polarization characteristic in a direction perpendicular to the snow surface” is visible, the activities of the user are not hindered.

Here, the polarization characteristic of the emitting light 462 from the VCSEL is controlled. Not limited to that, another polarizer may be arranged in the middle of the optical path of the emitting light 462 (for example, immediately after the virtual image forming lens 146) to control the polarization characteristic of the emitting light 462.

With only the structure in which the polarizer surface 254 is arranged outside the half mirror surface 184, a part of the external light enters the eyes of the user. As a result, the outside view overlaps with the virtual image, and hinders the “virtual image gaze” of the user. Therefore, in the present embodiment, a liquid crystal shutter 294 is further arranged outside the polarizer surface 254. When the liquid crystal shutter 294 is released, the user can see the outside view. On the other hand, when the liquid crystal shutter 294 is closed, external light is shielded. Then, the user can focus only on the virtual image.

In the embodiment example of FIG. 7, the half mirror surface 184 having the partially discontinuous surface (curved or plane surface) 98 can be used to display the virtual image with less optical interference noise. The liquid crystal shutter 294 can also be used to provide an environment in which the user can easily gaze at the virtual image with less optical interference noise. Further, when the polarization direction of the emitting light 246 from the VCSEL is controlled, it is difficult to see the virtual image from the outside, so that the external person is not disturbed and the security of the user is ensured.

As an embodiment example of the display 18, an augmented reality (AR) method is employed in FIG. 6 or FIG. 7. However, the present invention is not limited thereto, and a virtual reality (VR) system or a mixed reality (MR) system may be used as an embodiment example of the display 18.

As described above, the current user interface using a personal computer or an information portable terminal (removable data processing device 9) is centered on “information disposed on a two-dimensional plane”. That is, a user inputs information or selects information (selects a menu) by operating a keyboard or a touch panel disposed two-dimensionally. The user checks the input information content by viewing a two-dimensional screen. Processing results of the personal computer and the information portable terminal (removable data processing device 9) are displayed on the two-dimensional screen. Alternatively, the processing results are printed out on a two-dimensional sheet.

In comparison, in the user interface illustrated in FIGS. 3 to 7, a three-dimensional shape in the real world can be directly input via the measurer 8 in the optical device 10. The display 18 can three-dimensionally display the processing results in the system controller 50. Furthermore, the optical device 10 (or the service providing system 14) can communicate with an external (Internet) system 16 via the information transmission path 4 (see FIG. 1). That is, three-dimensional information (or a three-dimensional shape in the real world) can be transferred in real time via the information transmission path 4. As a result, the present embodiment example gives a user a presence feeling as if “a distant person or object exists near the user”. This presence feeling can provide the user with a sense of “exceeding a space”.

Furthermore, in the optical device 10 (or the service providing system 14) described in the present embodiment example, the input/output time of the three-dimensional information (or the three-dimensional shape) may be freely changed. As a result, a presence feeling shifted in time is provided to the user. This presence feeling can provide the user with a sense of “exceeding time”.

In the expression (display) of the three-dimensional shape and the three-dimensional information in the present embodiment example, “control of the convergence angle that can be recognized by the left and right side eyes of the user” may be performed. Furthermore, when the three-dimensional projective reverse transformation proposed later in Chapter 2 is used, it is possible to acquire a three-dimensional shape and a three-dimensional size of a real object in the real world or to collect three-dimensional information from the real world.

When a measured object (real object) 22 existing in the real world is measured in the present embodiment example, a three-dimensional size of each portion in the measured object (real object) 22 can be measured as a “real size”. The measured object 22 separately measured at “different locations” and “different times” is simultaneously recorded together with the real size information of each portion. Therefore, with the “real size” as a reference, a plurality of measured objects 22 measured at “different locations” and “different times” can be disposed in a coexisting manner in the virtual world. The state of coexistence and disposition in the virtual world gives the user a sense of “exceeding time and a space”.

In addition, the present embodiment is not limited it, an “artificially movable three-dimensional shape (3D model)” in the virtual world can be created using sensor group 52 not applying light. In this case, an author of the 3D model may set a size of a specific part in the 3D model. The system controller 50 can freely combine the 3D model with the above-described three-dimensional shape in the real world.

Here, the size of the specific part in the 3D model may be adapted to a real size in the measured object (real object) 22. A three-dimensional image in the virtual world obtained by adapting the sizes may be displayed (expressed) three-dimensionally using the “convergence angle”. When the optical device 10 (or the service providing system 14) achieves the “size adjustment in the three-dimensional space” between the measured object 22 measured as described above and the 3D model, a result of “combination between the real world and the virtual world” can be displayed (expressed) more realistically (with presence feeling). As described above, the extension from the conventional “layout information on the two-dimensional plane” to the three-dimensional world can provide a new work environment or business environment to a user. As a result, the user can not only perform “more pleasant business or work” but also contribute to improvement of work efficiency or business efficiency.

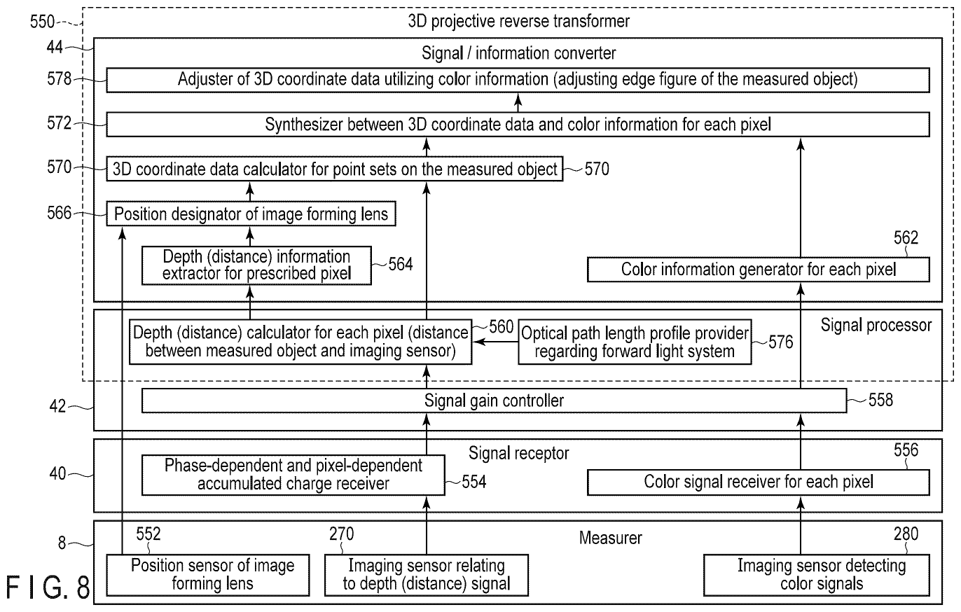

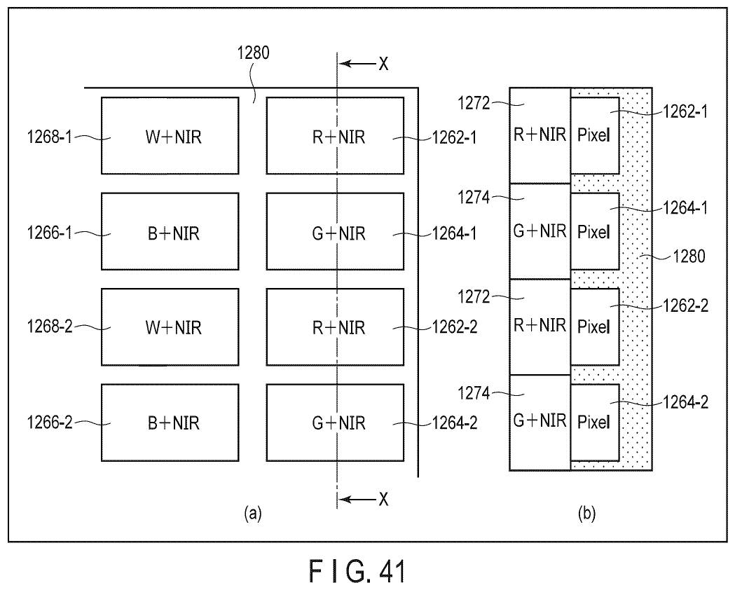

FIG. 8 illustrates the present embodiment example in which three-dimensional information, a three-dimensional shape, and a three-dimensional size can be obtained using a light measurement technique. A 3D projective reverse transformer 550 is responsible for the central signal processing leading to the acquisition of the three-dimensional information, the three-dimensional shape, and the three-dimensional size. In particular, here, a relationship with the overall schematic system configuration diagram described in FIGS. 1A and 1B is mainly described. FIG. 8 presumes that the measurer 8 has both an imaging sensor 270 relating to a depth (distance) signal and an imaging sensor 280 detecting color signals and that each of locations of the imaging sensor 270 relating to a depth (distance) signal and the imaging sensor 280 detecting color signals is different. However, the present embodiment is not limited thereto, and as illustrated in FIG. 41, the present embodiment may be applied to an optical system that independently performs distance measurement and color image collection with a pixel.

The measurer 8 in FIG. 8 includes the imaging sensor 280 detecting color signals. The inside of the imaging sensor 280 detecting color signals is divided into a plurality of color pixels. For each color pixel, a color signal corresponding to an incident light intensity is output. Therefore, each color pixel configuring the imaging sensor 280 detecting color signals corresponds to a color (RGB: Red, Green, and Blue) signal receiver 556 for each pixel in the signal receptor 40.

A signal gain controller 558 in the signal processor 42 amplifies the color signal transmitted from the color (RGB: Red, Green and Blue) signal receiver 556 for each pixel with an appropriate gain. For example, in a case where imaging is performed in a dark environment, the signal gain here is increased. The greatly amplified color signal is transmitted to the signal/information converter 44. On the other hand, in a case where imaging is performed in an excessively bright environment, a color signal gain is lowered so that the color signal is not saturated.

For example, an imaged object (measured object 22) may comprise both a metal area and a black area. Herein, the metal area directly reflects sunlight, and the black area absorbs visible light in the entire wavelength range. In this case, the color signal from the color (RGB: Red, Green, and Blue) signal receiver 556 for each pixel in this case includes both “a pixel in which a color signal is saturated” and “a pixel in which a color signal is not obtained at all (being too black)”.

When this situation occurs, the signal gain controller 558 may instruct the measurer 8 to perform “a plurality of times of imaging in which the detection time (or an exposure time) is changed”. That is, the detection time of the measurer 8 is reduced to prevent saturation of a color signal from a color pixel corresponding to the “metal area that directly reflects sunlight” in the imaged object (measured object 22). On the other hand, the detection time (or the exposure time) of the measurer 8 is increased, and a large color signal is acquired from a color pixel corresponding to the “black area that absorbs visible light in the entire wavelength range” in the imaged object (measured object 22). As described above, a color image (or a color movie) with high color reproducibility can be obtained by the function of the signal gain controller 558 in the signal processor 42.

A color information generator 562 for each pixel in the signal/information converter 44 integrates color signals for each color pixel. As a result of the integration, a color image (or a color movie) in the entire imaging screen is constructed.

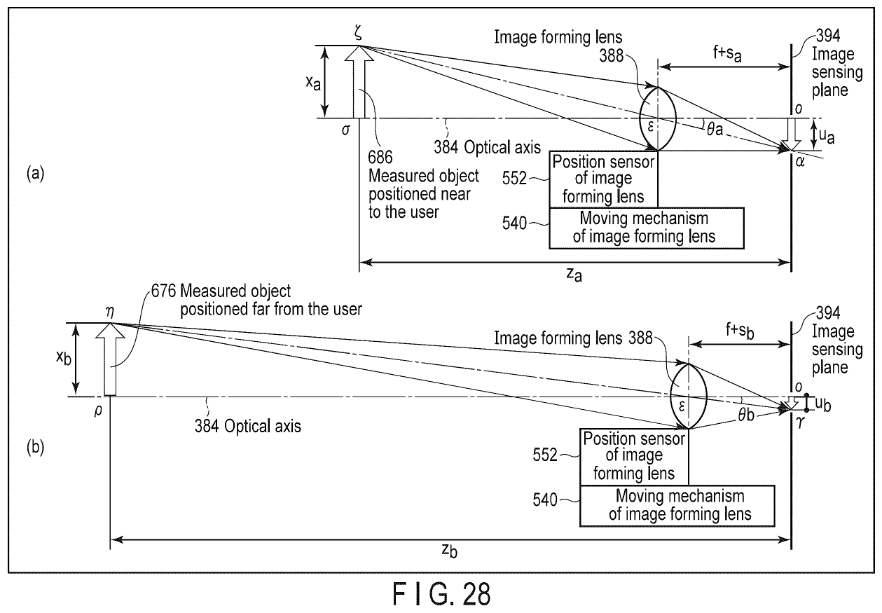

As described later with reference to FIG. 28, an embodiment example in which the measurer 8 includes a position sensor 552 of an image forming lens 388. In this case, as illustrated in FIG. 8, the measurer 8 includes both the imaging sensor 270 relating to a depth (distance) signal and the position sensor 552 of the image forming lens 388. A signal related to a measured distance (measured length distance) is obtained from the imaging sensor 270 relating to a depth (distance) signal. Specifically, detailed embodiment examples are in Chapter 3. Then, in the signal receptor 40, the “phase-dependent and pixel-dependent accumulated charge receiver 554” receives each of “detection phase profiles or light emission phase profiles” from each of pixels included in the imaging sensor 270 relating to a depth (distance) signal.

According to the present embodiment example, the same pixel relating to a depth (distance) signal (the same pixel included in the imaging sensor 270 relating to a depth (distance) signal) receives the detection light (second light) 19 at a plurality of different detection timings. The different detection timings represent “detection phases” or “light emission phases”. Therefore, in the present embodiment example, each of a plurality of different detection phase values (or a plurality of different light emission phase values) is defined. That is, an individual detection phase is set for each of the different detection phase values, and an individual light emission phase is set for each of the different light emission phase values. And the same pixel outputs each of accumulated charge values at each of different detection timings corresponding to different detection phase values, or the same pixel outputs each of accumulated charge values at each of different detection timings corresponding to different light emission phase values.

One light receiving period of a pixel relating to a depth (distance) signal (the pixel included in the imaging sensor 270 relating to depth (distance) signal) that receives the detection light (second light) 19 may be fixed. When the light receiving period is fixed for each time, signal processing for calculating a distance can be simplified. Within the same detection phase (or the same light emission phase), the pixel relating to a depth (distance) signal (the pixel included in the imaging sensor 270 relating to depth (distance) signal) may repeat light reception a plurality of times. In addition, a light receiving cycle T repeated a plurality of times may be constantly fixed. When a ratio of each light receiving period to the cycle T is set to 20% or more and 80% or less (desirably 35% or more and 65% or less), high measured distance accuracy (length measurement accuracy) can be obtained.

When the number of repetitions of light reception in the pixel relating to a depth (distance) signal (the pixel included in the imaging sensor 270 relating to depth (distance) signal) is N, the value of NT is referred to as an “integration time”. When the number of repetitions N of light reception is set to 10 or more (desirably 100 or more or 1000 or more), high distance measurement accuracy (length measurement accuracy) can be obtained. On the other hand, when the “integration time” is longer than 10 seconds, the distance measurement accuracy (length measurement accuracy) decreases due to “camera shaking at the time of imaging” or the like. In addition, due to characteristics of the current electronic circuit, one light receiving period is desirably 1 nS or more. Therefore, it is more desirable that “integration time” is longer than 1 nS and is shorter than 10 seconds. And the number of repetitions N of light reception is desirably “10 billion times” (10÷(1×10-9)) or less.

In the present embodiment example, each pixel relating to a depth (distance) signal

(each pixel included in the imaging sensor 270 relating to depth (distance) signal) repeatedly receives light N times for each detection phase set to each of the detection phase values (or for each light emission phase set to each of the light emission phase values). A charge value (accumulated charge value) accumulated during the integration time corresponding to N times differs for each detection phase (or for each light emission phase) and for each pixel. The accumulated charge value that changes for each detection phase represents the “detection phase profile”. And the accumulated charge value that changes for each light emission phase represents a “light emission phase profile”. Therefore, each pixel relating to a depth (distance) signal (each pixel included in the imaging sensor 270 relating to depth (distance) signal) may a unique (different) “detection phase profile” or a unique (different) “light emission phase profile”. The “phase-dependent and pixel-dependent accumulated charge receiver 554” in the signal receptor 40 transmits a signal indicating the “detection phase profile” or the “light emission phase profile” for each pixel relating to a depth (distance) signal (for each pixel included in the imaging sensor 270 relating to depth (distance) signal) to the “signal gain controller 558” in the signal processor 42.

A signal value of the signal indicating the “detection phase profile or the light emission phase profile” affects the measured distance accuracy (length measurement accuracy). Therefore, the signal gain controller 558 optimizes the signal value (signal amplitude) of the signal indicating the “detection phase profile or the light emission phase profile”. For example, in a case where the signal value of the “detection phase profile or the light emission phase profile” obtained from a specific pixel relating to a depth (distance) signal (a specific pixel included in the imaging sensor 270 relating to depth (distance) signal) is small, the signal gain controller 558 increases a gain of the signal. On the other hand, in a case where the signal value of the “detection phase profile or the light emission phase profile” obtained from another pixel relating to a depth (distance) signal (another specific pixel included in the imaging sensor 270 relating to depth (distance) signal) is too large and close to saturation, the signal gain controller 558 decreases a gain of the signal.

The detection time of the imaging sensor 280 detecting color signals described above corresponds to the “integration time” in the imaging sensor 270 relating to a depth (distance) signal. Therefore, similarly to the detection time control for the imaging sensor 280 detecting color signals described above, the signal gain controller 558 may perform control of “integration time” for the imaging sensor 270 relating to depth (distance) signal.

For example, an imaged object (measured object 22) may be “configured by both of metal area having extremely high reflectivity to irradiated light (first light) 13 and a black area absorbing irradiated light (first light) 13”. In this case, a plurality of times of imaging in which either a light intensity of the irradiated light (first light) 13 or an “integration time” is changed may be repeated.

That is, for the “metal area having extremely high reflectivity”, the light intensity of the irradiated light (first light) 13 is reduced or the “integration time” is reduced. As a result, saturation of a signal of the “detection phase profile” or the “light emission phase profile” can be prevented. On the other hand, for the “light absorption area”, the light intensity of the irradiated light (first light) 13 is increased or the “integration time” is increased. As a result, a signal value of the “detection phase profile” or the “light emission phase profile” can be optimized.

A depth (distance) calculator 560 for each pixel in the signal processor 42 calculates a distance between each pixel in the imaging sensor 270 relating to a depth (distance) signal and the measured object 22, and the method of calculation is described in detail later in Chapter 3. Here, in a case where an optical path of the irradiated light (first light) 13 and an optical path of the detection light (second light) 19 are different, or in a case where the measured object 22 is irradiated with the irradiated light (first light) 13 in a “divergent light” state, it is necessary to adapt a distance calculation method. An optical path length profile provider 576 regarding forward light system (a provider providing information on optical path of the irradiated light (first light) 13) provides information necessary for this adaptation.

Only after a position of the image forming lens 388 is optimized in accordance with a position of the measured object 22, an accurate image pattern for the measured object 22 can be generated on an image sensing plane of the imaging sensor 270 relating to a depth (distance) signal. Furthermore, the optimum position of the image forming lens 388 may be different between different positions on the surface of the measured object 22 when the measured object 22 is big and the surface structure on the measured object 22 is complex. Therefore, in the present embodiment example, first, the image forming lens 388 is moved to a position optimum for a prescribed position on the surface of the measured object 22 (and a prescribed pixel corresponding to the prescribed position in the imaging sensor 270 relating to a depth (distance) signal). In the present embodiment example, any pixel in the imaging sensor 270 relating to a depth (distance) signal may be set as a prescribed pixel. In other words, the present embodiment may set a prescribed pixel among all pixels included in the imaging sensor 270 relating to a depth (distance) signal. The present invention is not limited thereto, and a pixel disposed on an optical axis extension line of the image forming lens 388 may be set as a prescribed pixel.

3D projective reverse transformer 550 comprises the “depth (distance) calculator 560 for each pixel (distance between measured object and imaging sensor)” and the “optical path length profile provider 576 regarding forward light system” included in the signal processor 42. Moreover, the 3D projective reverse transformer 550 comprises a plurality of functional parts 562 to 578 included in the signal/information converter 44.

When a position of the image forming lens 388 is optimized as described above, an accurate image pattern for a prescribed position on the surface of the measured object 22 is generated at a position of the corresponding prescribed pixel in the imaging sensor 270 relating to a depth (distance) signal. Thereafter, a depth (distance) information extractor 564 for the corresponding prescribed pixel calculates a distance from the prescribed position on the surface of the measured object 22 to the corresponding prescribed pixel in the imaging sensor 270 relating to a depth (distance) signal.

Using Equation 2, the depth (distance) information extractor 564 for the corresponding prescribed pixel may calculate a position of the image forming lens 388 after optimization. And when a position signal of the image forming lens 388 obtained from the position sensor 552 of the image forming lens is used together in this case, the position of the image forming lens 388 can be calculated more accurately.

A 3D coordinate values calculator 570 for point sets on the measured object calculates 3D coordinate values of the measured object using the position information of the image forming lens 388. Herein, the 3D coordinate values calculator 570 for point sets on the measured object may use Equation 4. A synthesizer 572 between 3D coordinate values and color information for each pixel synthesizes the 3D coordinate values for point sets on the measured object and the color information at the corresponding position.

In many cases, a pixel size in the imaging sensor 270 relating to a depth (distance) signal is larger than a pixel size in the imaging sensor 280 detecting color signals. Therefore, a size corresponding to a point on the measured object 22 for which the 3D coordinate values is calculated becomes relatively large. In the present embodiment example, an “adjuster 578 of 3D coordinate values utilizing color information (adjusting edge figure of the measured object)” is provided to increase a spatial resolution related to the 3D coordinate values.

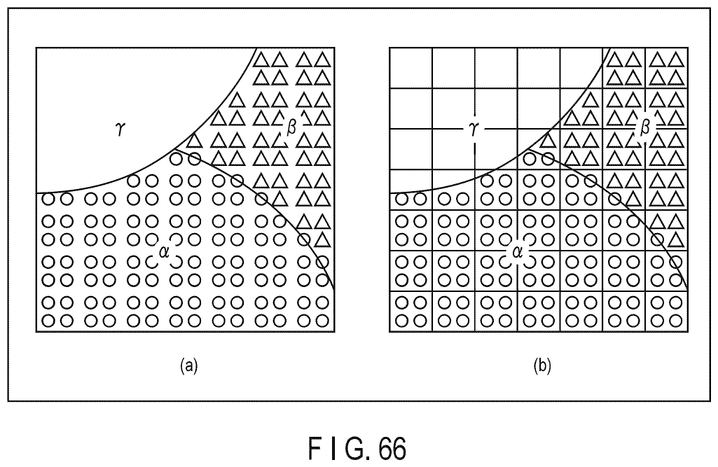

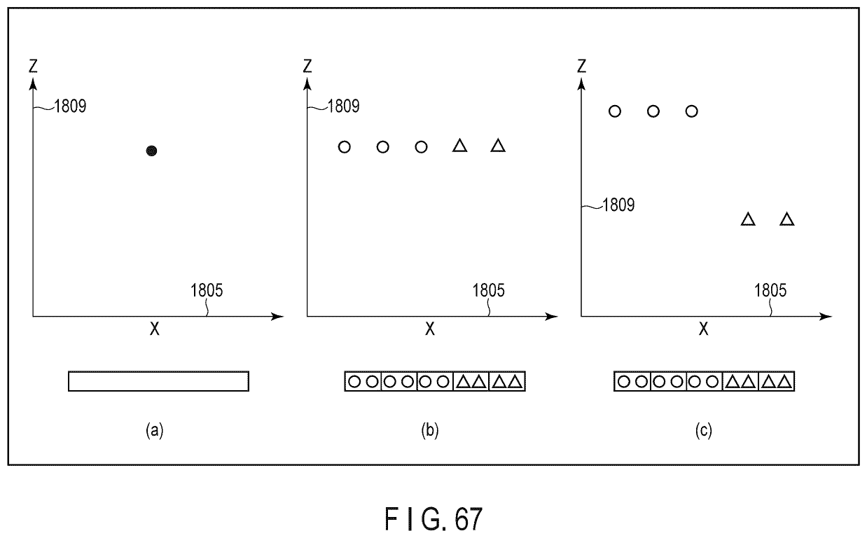

That is, as shown FIG. 66 and FIG. 67, the “adjuster 578 of 3D coordinate values utilizing color information (adjusting edge figure of the measured object)” uses the color information obtained from the “color information generator 562 for each pixel” to correct and adjust the 3D coordinate values for point sets on the measured object obtained from the “3D coordinate values calculator 570 for point sets on the measured object”. A spatial resolution of point sets on the measured object corresponding to the 3D coordinate values obtained from the “3D coordinate values calculator 570 for point sets on the measured object” is limited by a total number of pixels (and a spatial resolution corresponding thereto) of the imaging sensor 270 relating to a depth (distance) signal. On the other hand, as an effect obtained by correcting and adjusting the 3D coordinate values for point sets on the measured object in the “adjuster 578 of 3D coordinate values utilizing color information (adjusting edge figure of the measured object)”, the spatial resolution of point sets on the measured object corresponding to the 3D coordinate values is improved to the total number of pixels (and a spatial resolution corresponding thereto) in the imaging sensor 280 detecting color signals.

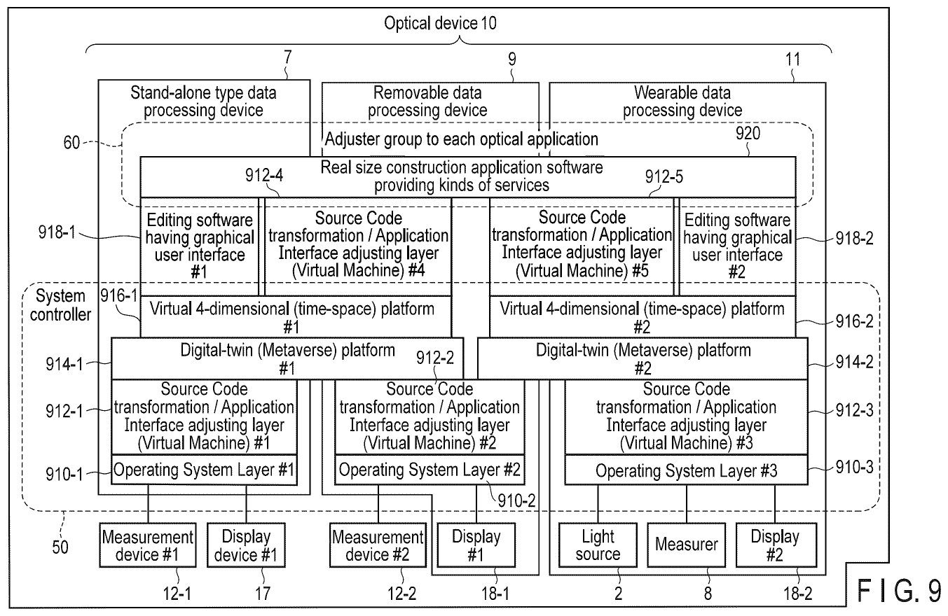

FIG. 9 illustrates various specific forms that can be taken by the optical device 10, a hardware configuration example corresponding thereto, and a hierarchical structure example of software. FIG. 9 illustrates embodiment examples of a stand-alone type data processing device 7, the removable data processing device 9 (information portable terminal), a wearable data processing device 11, and the like as specific form examples of the optical device 10. However, the present embodiment is not limited thereto, and any form can be employed as long as a part of the internal structure illustrated in FIGS. 1A and 1B is included. Specific examples of the wearable data processing device 11 include the wearable devices illustrated in FIGS. 6 and 7. In this case, the light source 2 and the measurer 8 are incorporated together with a display (#2) 18-2.

As a specific example of the stand-alone type data processing device 7, a form of a general personal computer system including a main body, an external display device (#1) 17, a keyboard, and the like may be employed. In this case, a measurement device (#1) 12-1 having the function of the measurer 8 illustrated in FIG. 1A may be added in the form of an external device.

A specific example of the removable data processing device 9 (information portable terminal) includes a portable device including the light source 2 and the measurer 8 held by the photographer in FIG. 3. In the removable data processing device 9 (information portable terminal), a display (#1) 18-1 is generally included (as standard equipment). Many of the removable data processing devices 9 (information portable terminals) have a wireless communication function. It is possible to receive a three-dimensional image (or movie) from the movable measurer 8-2 illustrated in FIG. 4 via wireless communication. In this case, the “movable measurer 8-2” corresponds to the externally-attached measurement device (#2) 12-2.

Unique operation system (OS) layers 910-1 to 910-3 installed in the stand-alone type data processing device 7, the removable data processing device 9 (information portable terminal), and the wearable data processing device 11 directly control the display device 12, the display 18, the measurement device 12, and the measurer 8.

In the present embodiment example, digital twin (Metaverse) platforms 914-1 and 914-2 are disposed in the upper layer of the OS layers 910-1 to 910-3, and the virtual four-dimensional (time-space) platforms 916-1 and 916-2 can be disposed in the upper layer. Software having a hierarchical structure from the OS layers 910-1 to 910-3 to the virtual four-dimensional (time-space) platforms 916-1 and 916-2 is installed in advance in the system controller 50. Since the above-described “common platform for forming a combination between three-dimensional shapes exceeding time and space in the real space on a virtual world” can be provided in the present embodiment example, it is referred to as the above-described “virtual four-dimensional (time-space)”.

The digital twin platforms 914-1 and 914-2 are operable (independent of the type of OS) in an upper layer of any of the OS layers 910-1 to 910-3. In order to enable this, in the present embodiment example, source code transformation/application interface adjusting layers (virtual machines) 912-1 to 912-3 corresponding to different OS layers 910-1 to 910-3 are provided as standard.

In the present embodiment example, “real size construction application software 920 providing kinds of services (bundle form)” is bundled (installed) in the upper layer of the virtual four-dimensional (time-space) platforms 916-1 and 916-2. The program processing of the “real size construction application software 920 providing kinds of services (bundle form)” proceeds while operating the virtual four-dimensional (time-space) platforms 916-1 and 916-2 with an application interface (API) command issued by the “real size construction application software providing kinds of services (bundle form)”. As described above, in the present embodiment example, a spatial combination (real size construction) between different measured objects 22 is performed based on the “real size” of each portion in the measured object 22 acquired at the time of measurement. This function is referred to as the “real size construction application software 920 providing kinds of services (bundle form)” as means for realizing the function in a software manner.

Software editing software (graphical user interface (GUI)) editing software 918-1 and 918-2) is prepared for each of the virtual four-dimensional (time-space) platforms 916-1 and 916-2 so that a user can easily create the “real size construction application software 920 providing kinds of services (bundle form)”. Here, the above-described “real size construction application software 920 providing kinds of services (bundle form)” is installed as a part of an adjuster group to each optical application 60 shown in FIG. 1B.

Note that the “real size construction application software providing kinds of services (bundle form)” can operate on any virtual four-dimensional (time-space) platforms 916-1 and 916-2. In order to enable this, the source code transformation/API adjusting layers 912-4 and 912-5 for each of the various virtual four-dimensional (time-space) platforms 916-1 and 916-2 are also provided as standard.

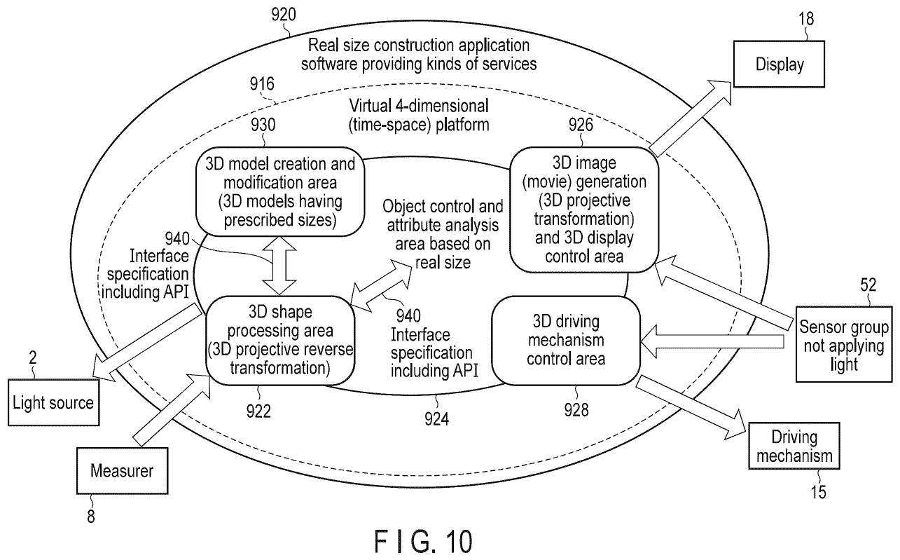

FIG. 10 illustrates an example of software architecture in the virtual four-dimensional (time-space) platform 916. Examples of service provision to a user using the “real size construction application software 920 providing kinds of services (bundle form)” includes
1. layout consideration service in a virtual world using sizes (real sizes) of a real object in the real world
   for example, an optimal layout simulation of a plurality of real objects in the real world, a pre-discovery service of an interference location (collision location) between different real objects, or the like.
2. combining a 3D model in a virtual world with sizes (real sizes) of a real object in the real world, and
3. operating a cursor position in the display 16 and a display area according to motion of a user.

Common processing content among the services provided to users may be packaged and made into a common program module in the virtual four-dimensional (time-space) platform 916. When the common program module in the virtual four-dimensional (time-space) platform 916 is used, the burden on the “real size construction application software 920 providing kinds of services (bundle form)” can be greatly reduced. As described above, (as shown in FIG. 9,) in terms of software function, the “real size construction application software 920 providing kinds of services (bundle form)” independently works on the different types of the “virtual four-dimensional (time-space) platforms 916-1 and 916-2”.

The inside of the virtual four-dimensional (time-space) platform 916 is functionally roughly divided into an “object control and attribute analysis area 924 based on a real size”, a “3D shape processing area (3D projective reverse transformation) 922”, a “3D model creation and modification area (3D models having prescribed sizes) 930”, a “3D image (movie) generation (3D projective transformation) and 3D display control area 926”, and a “3D driving mechanism control area 928”.

The concept of a fundamental function of each area will be described. In the “3D shape processing area (3D projective reverse transformation) 922”, the measured object (real object) 22 in the real world is measured, and control related to size extraction of each part in the measured object 22 is performed. Therefore, light emission control for the light source 2 and measurement control for the measurer 8 are performed. This area is also partially related to “three-dimensional projective reverse transformation” described later in Chapter 2.

The “3D model creation and modification area (3D models having prescribed sizes) 930” controls creation and editing/processing of a 3D model (three-dimensional shape of a specific individual) in the virtual world. The size change of a specific part is also performed as necessary on the three-dimensional shape information of the measured object 22 acquired by the “3D shape processing area (3D projective reverse transformation) 922”.

The “3D image (movie) generation (3D projective transformation) and 3D display control area 926” directly controls the display 18. Herein, according to the display 18, a user may usually see a three-dimensional image (or a movie). As a three-dimensional display (expression) method for a user, in the present embodiment example, in order to control a convergence angle when viewed by the user, images (movies) to be displayed on the right side eye and the left side eye are slightly changed. Note that this area is deeply involved in “three-dimensional projective transformation” described later in Chapter 2.

In the “three-dimensional projective transformation”, as proposed in detail in Chapter 2, it is necessary to change images (movies) displayed on the right side eye and the left side eye according to positional changes of the user's eyes. The positional changes of the user's eyes may be input from the sensor group 52 not applying light. The present embodiment is not limited thereto, and a position in both eyes of a user (three-dimensional coordinate positions of right and left pupils) obtained from the “3D shape processing area (3D projective reverse transformation) 922” may be used.

In the optical device 10 (see FIG. 1) of the present embodiment example, an external driving mechanism 15 (independent robot or the like) can be remotely operated via the information transmission path 4. The “3D driving mechanism control area 928” performs the remote operation control of the external driving mechanism 15. As a method in which a user remotely operates the external driving mechanism 15, in the present embodiment example, the user may operate the sensor group 52 not applying light. The present embodiment is not limited thereto, motion detection information of a user obtained from “3D shape processing area (3D projective reverse transformation) 922” may be used.

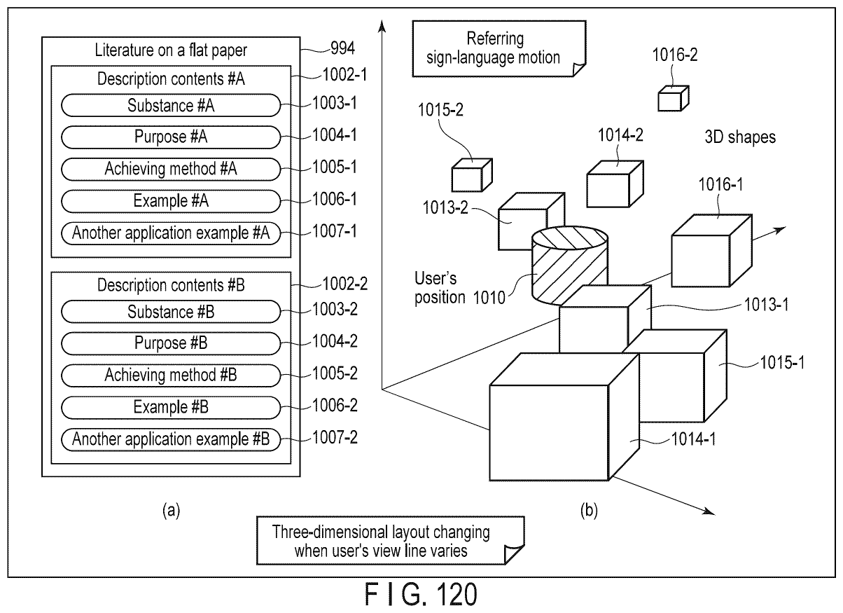

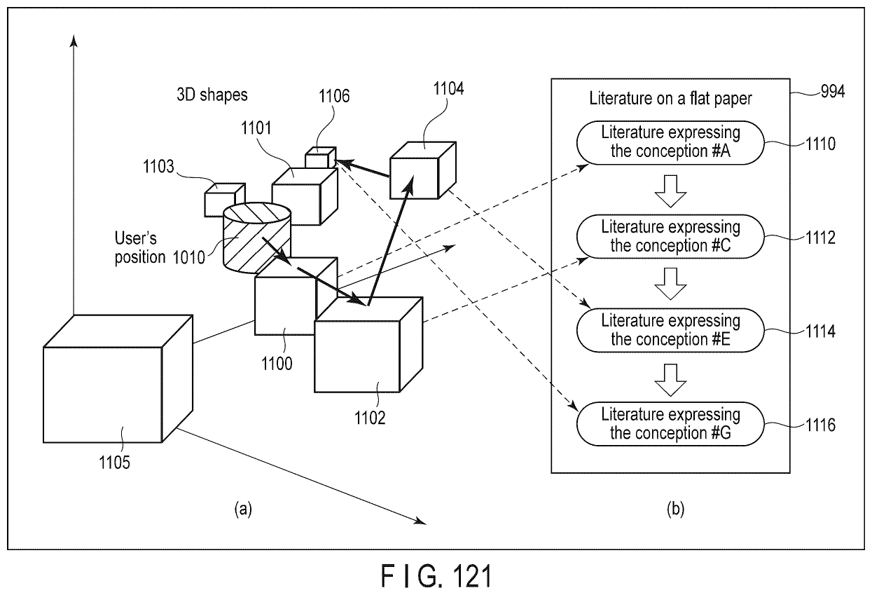

The “object control and attribute analysis area 924 based on a real size” mainly performs any control related to integrated control between the areas. For example, this area also performs integrated layout (including layout optimization control) between a plurality of objects in the virtual world, motion control of each object, and the like. Furthermore, the present embodiment is not limited thereto, this area also executes “conversion between literatures (text literatures) and three-dimensional images disposed multidimensionally” that is described later with reference to FIGS. 120 and 121.

In FIG. 10, the “real size construction application software 920 providing kinds of services (bundle form)” appears to include the “virtual four-dimensional (time-space) platform 916”. However, the actual “real size construction application software 920 providing kinds of services (bundle form)” does not need to be one type, and may take any of a plurality of forms. A type (within a form) of the plurality of forms may be software that provides only small-scale services specialized in a specific field in the adjuster group to each optical application 60 illustrated in FIG. 1.

Furthermore, since the general-purpose function of the “virtual four-dimensional (time-space) platform 916” can be used for a type of the “real size construction application software 920 providing kinds of services (bundle form)” in the single form, the type may be configured by small-scale application software.

On the other hand, each of the areas 922 to 930 is required to use various functions from a wide variety of “real size construction application software 920 providing kinds of services (bundle form)”. Therefore, the scale of the “virtual four-dimensional (time-space) platform 916” is enormous when the “real size construction application software 920 providing kinds of services (bundle form)” uses the virtual 4-dimensional (time-space) platform 916. Furthermore, in order to construct this enormous scale, enormous resources regarding people and time are required.

In order to solve this enormous load, in the present embodiment example, an interface specification 940 including application information (API) between the respective areas 922 to 930 in the “virtual four-dimensional (time-space) platform 916” and a verification specification for verifying the interface function may be disclosed to the world.

As an effect thereof, an individual or a small-scale organization can easily create a specific area in each area 922 to 930 independently. Furthermore, compatibility between the areas 922 to 930 can be secured. Development in the “virtual four-dimensional (time-space) platform 916” can be promoted.

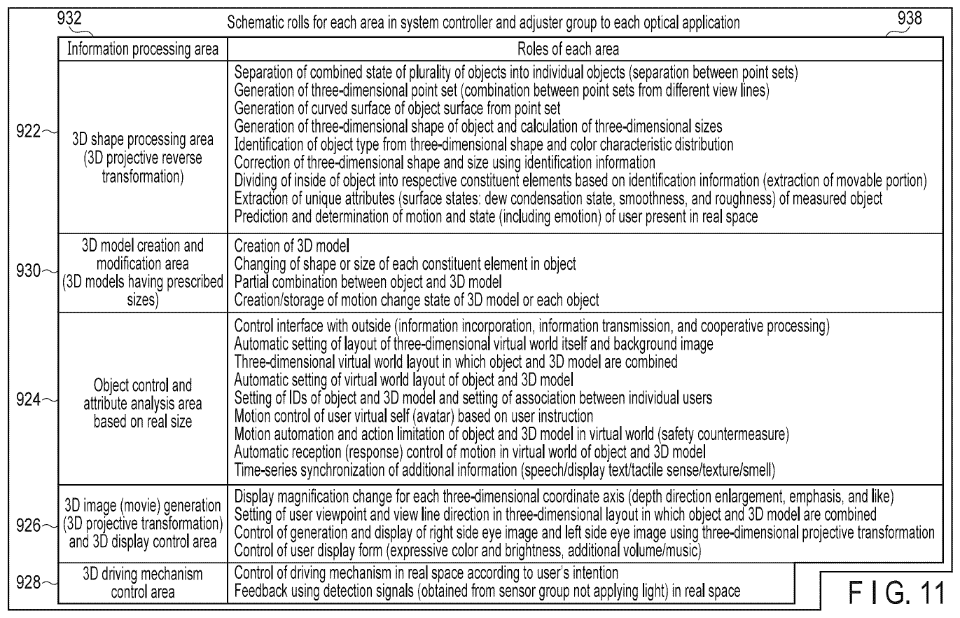

FIG. 11 illustrates a specific example of role 938 for information processing area 932 illustrated in FIG. 10. A specific role example of the “3D driving mechanism control area 928” includes driving mechanism control in the real space according to the intention of a user. Here, the user may operate the sensor group 52 not applying light to control a driving mechanism in the real space.

In addition, the present invention is not limited thereto, the “3D shape processing area (3D projective reverse transformation) 922” may analyze the content of motion (user motion) of the user's finger or the like, and operate the driving mechanism 15 based on the analysis result. However, in this case, the motion amount of the user and the motion amount of the driving mechanism 15 may not mesh with each other. For example, when the user moves the finger to slightly move the driving mechanism 15 (for example, a specific robot), the driving mechanism 15 may move significantly unexpectedly. Using detection signals obtained from the sensor group 52 not applying light in the real space, the “3D driving mechanism control area 928” may apply feedback (negative feedback) to the motion of the driving mechanism 15. By utilizing this role, the driving mechanism 15 can be stably controlled in accordance with the will of the user.

From the “3D coordinate values calculator 570 for point sets on the measured object” in FIG. 8, only a set of points (point set) on the measured object 22 within a range visible from only one view line can be obtained. Therefore, information regarding a three-dimensional shape of the entire measured object 22 can be obtained only after registration of point sets viewed from different view lines is performed. The three-dimensional point set generation corresponding to the registration between the point sets from the different view lines also corresponds to the role example of the “3D shape processing area (3D projective reverse transformation) 922”.

In the “3D shape processing area (3D projective reverse transformation) 922”, a curved surface of the object surface is generated from the point set. In addition, generation of a three-dimensional shape of an object based on the curved surface, calculation of three-dimensional sizes, and the like are performed. In addition, in a case where the measurer 8 captures an image of a state in which a plurality of measured objects 22 overlap each other, separation into individual objects related to the overlapping state is performed.

The “3D shape processing area (3D projective reverse transformation) 922” is not limited to simple three-dimensional shape measurement, and may identify the type of an object (a type such as human, animal, chair, or desk) from the characteristics of the three-dimensional shape and color. Furthermore, correction of the three-dimensional shape and sizes using the identification information, extraction of a unique attribute of the object (a surface state such as a dew condensation state, a smoothness, or a roughness), and the like may be performed. Furthermore, the above-described motion detection of the user and prediction and determination of a motion and a condition (including a user emotion) of the user may be performed.

Regarding a role example of the “separation of the inside of an object into respective constituent elements based on identification information (extraction of a movable portion)”, a specific example is described. It is assumed that identification information related to the type of the object corresponds to “human”. In this case, a “head”, a “face”, “eyes”, a “hand”, a “finger”, a “foot”, a “torso”, and the like correspond to the respective constituent elements. The “hand” and the “finger” separated as constituent elements are separated into a “joint part” that is movable and a “skeleton portion (portion with bone)” that does not bend. That is, “separation of each constituent element and extraction of movable portion” is performed in this area. As a result, the “3D model creation and modification area (3D models having prescribed sizes) 930” can create a three-dimensional shape of an object whose three-dimensional shape has been changed (for example, a posture of a walking or a posture of a person sitting).

As described above, a specific main role of the “3D model creation and modification area (3D models having prescribed sizes) 930” includes creation of a three-dimensional model (3D model) in the virtual world. It also plays a role of changing a shape and a size of a specific constituent element of the object based on the three-dimensional shape of the object in the real world obtained from the “3D shape processing area (3D projective reverse transformation) 922”. A specific example of changing a shape and a size of this specific constituent element includes processing such as “lengthening only an imaged human's foot”.

A specific example of the “partial combination between an object and a 3D model” described in FIG. 11 includes synthesizing a part (for example, from the neck to the bottom) in the three-dimensional shape of the object in the real world and a part (head) in the 3D model obtained from the “3D shape processing area (3D projective reverse transformation) 922”.

As the measured object 22, an example in which the measurer 8 captures an image of a three-dimensional shape of a “standing person” is assumed. From the “3D shape processing area (3D projective reverse transformation) 922”, only the three-dimensional shape and the detailed size of each portion related to the “standing posture” of the object (human) in the real world can be obtained. A case where a user wants to move the object (human) in the virtual world is assumed. In response to this situation, the “3D model creation and modification area (3D models having prescribed sizes) 930” can perform the “creation/storage of a motion change state for each 3D model or object”.

The “3D shape processing area (3D projective reverse transformation) 922” generates results of “separation of the inside of an object into respective constituent elements (for example, a head, a hand, a foot, and a torso) based on identification information (extraction of a movable portion)” and “extraction results of a movable portion (joint location or the like)”. Three-dimensional shape information indicating “a motion change state for each 3D model or object (such as a posture of a human walking or a posture of a human sitting)” can be generated using the information.

“Setting a position and a view line direction of user's eyes in a three-dimensional layout in which an object and a three-dimensional model (3D model) are combined” which is a specific role example of the “3D image (movie) generation (3D projective transformation) and 3D display control area 926” is described. In the present embodiment example, in the virtual world, a three-dimensional shape of a real object (measured object 22) in the real world and a three-dimensional shape of a 3D model created in the virtual world can be combined. In the virtual world, 3D coordinate values of each point in this combined state is determined.

Furthermore, in the present embodiment example, a user can three-dimensionally view the combined state in a state of virtually falling within the virtual world. Specifically, in this virtual world, 3D coordinate values of the user's right side eye (the center point of the pupil of the right side eye) and 3D coordinate values of the user's left side eye (the center point of the pupil of the left side eye) may be individually set. When the 3D coordinate values of the right side eye (the center point of the pupil of the right side eye) and the left side eye (the center point of the pupil of the left side eye) is changed, a change in the convergence angle seen from the left and right side eyes appears, and the user experiences a quasi-three-dimensional view. When “generation and display control of a right side eye image and a left side eye image using three-dimensional projective transformation” is further performed, a further presence feeling is given to the user.

In the present embodiment example, 3D coordinate values of each point in the virtual world can be set. It is not always necessary to faithfully display the 3D coordinate values in the virtual world to a user. For example, by enlarging and displaying coordinate values only in the front-rear direction as viewed from the user, it is possible to display an impressive image in which “only a depth is enlarged” to the user. This role example corresponds to “display magnification change for each three-dimensional coordinate axis (depth direction enlargement, emphasis, etc.)”. Further performing “control of a user display form (expressive color and brightness, additional volume/music)” gives the user a deep presence feeling.

The “object control and attribute analysis area 924 based on a real size” is not limited to “control of interface with outside (information incorporation, information transmission, and cooperative processing)”, and may have roles such as “automatic setting of a layout of a three-dimensional virtual world itself and a background image”, “a three-dimensional virtual world layout in which an object and a 3D model are combined”, “automatic setting of a virtual world layout of an object and a 3D model”, “setting of IDs of an object and a 3D model and setting of association between individual users”, “motion control of a user virtual self (avatar) based on a user instruction”, “motion automation and action limitation of an object and a 3D model in a virtual world (safety countermeasure)”, “automatic reception (response) control of motion in a virtual world of an object and a 3D model”, and “time-series synchronization of additional information (speech/display text/tactile sense/texture/smell)”.

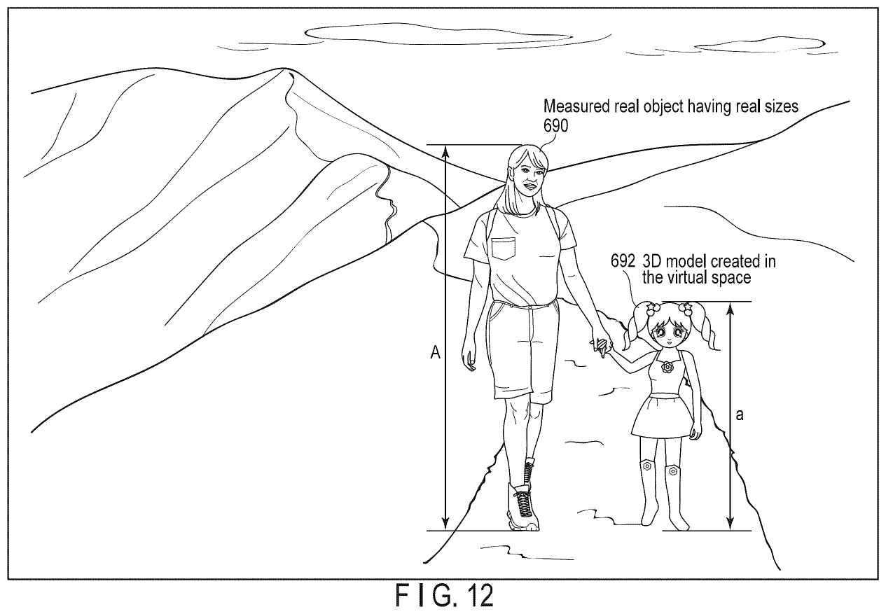

FIG. 12 illustrates a three-dimensional display example in which a three-dimensional shape (three-dimensional movie) obtained by combining a real object (measured object 22) in the real world and a 3D model created in the virtual world is created. The left side of FIG. 12 illustrates a measured real object 690 having real sizes. As described with reference to FIG. 8, the measurer 8 captures an image of a real object (measured object 22).

According to FIG. 8, the signal/information converter 44 in the 3D projective reverse transformer 550 calculates 3D coordinate values of each point (point set) on the real object (measured object 22). As described with reference to FIG. 11, the 3D shape processing area (3D projective reverse transformation) 922 performs registration between point sets acquired for respective different view lines, and then forms a three-dimensional shape of the entire real object (measured object 22). A height “A” of the measured real object 690 having real sizes is calculated.

A case where the measurer 8 captures an image of only a standing posture of the real object (measured object 22) in a stationary state is considered. In this case, the 3D shape processing area (3D projective reverse transformation) 922 identifies that “the real object (measured object 22) is a human”, and extracts a movable portion (joint portion) therein. The 3D model creation and modification area (3D models having prescribed sizes) 930 generates a three-dimensional image (three-dimensional movie) when the real object (measured object 22) walks.

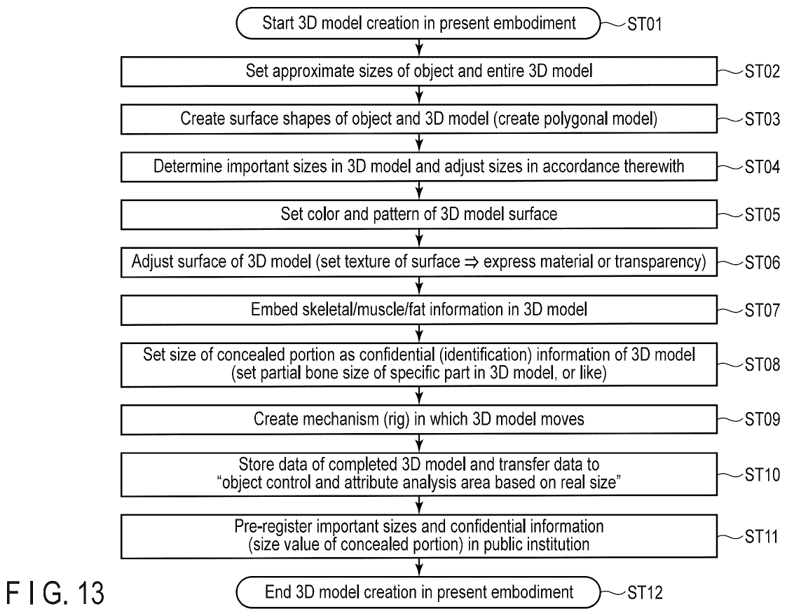

The right side of FIG. 12 represents a 3D model 692 created in the virtual space. A method of creating the 3D model 692 is described later in detail with reference to FIG. 13. The object control and attribute analysis area 924 based on a real size performs layout in which the object (a real object, that is, the measured object 22) and the 3D model (three-dimensional model) in the three-dimensional virtual space are combined.

The 3D model creation and modification area (3D models having prescribed sizes) 930 described in the present embodiment example sets a height “a” of the 3D model (three-dimensional model) in advance. Both are combined in a size corresponding to the height “A” of the real object (measured object 22). When “size matching” between the object (a real object, that is, the measured object 22) and the 3D model (three-dimensional model) is performed, an effect of increasing the presence feeling of the 3D model for the user is generated.

At the same time, the object control and attribute analysis area 924 based on a real size also set a three-dimensional background image. The object control and attribute analysis area 924 based on a real size also performs motion control of the object and the 3D model in the three-dimensional virtual world.

In a case where the three-dimensional movie is displayed to the user, the three-dimensional movie is expressed as “a state in which the user has entered the virtual world”. That is, in the virtual world in which the four-dimensional coordinates including the time axis are defined, a coordinate value of the user's right side eye (the center point of the pupil of the right side eye), a coordinate value of the user's left side eye (the center point of the pupil of the left side eye), and a view line direction can be set. Based on the set coordinate values and view line direction, the 3D image (movie) generation (3D projective transformation) and 3D display control area 926 generates an image (movie) viewed from the right side eye of the user and an image (movie) viewed from the left side eye of the user.

In a case where the user changes positions of the left and right side eyes, the 3D image (movie) generation (3D projective transformation) and 3D display control area 926 changes the image (movie) viewed from the right side eye and the image (movie) viewed from the left side eye accordingly. A method of inputting a change of a position in both eyes of the user uses the sensor group 52 not applying light or a position detection result of the eyes of the user.

For example, in a case where the display 18 illustrated in FIGS. 6 and 7 is used, a change of a position of the user's head can be detected by the sensor group 52 not applying light such as an acceleration sensor and a gyro sensor built into the display 18. On the other hand, the display 18 illustrated in FIG. 5 can detect a change of a position of the user's eye via the built-in measurer 8.

FIG. 13 illustrates an example of a method of creating a 3D model (three-dimensional model) performed by the 3D model creation and modification area (3D models having prescribed sizes) 930. In step 01, a user starts creation of a 3D model in the present embodiment example. In the present embodiment example, approximate size setting (ST02) of the entire target 3D model is performed at an initial stage of starting creation of the 3D model. The approximate size of the height “a” of the 3D model 692 illustrated in FIG. 12 is set at this stage.

“Creation of a surface shape of the target 3D model (creation of a polygonal model)” performed in step 03 is described. A curved surface or a flat surface of a 3D model (three-dimensional model) surface is generated using “combination of planes including three or four different points”. Prior to that, a “point set” including a set of a plurality of points is disposed in the three-dimensional virtual world. Then, “three or four points close to each other” included in the point set are extracted, and a flat surface is generated from the extracted three or four points.

A surface generated from the extracted three points or four points is a “flat surface”. When an inclination occurs between “adjacent flat surface” adjacent to the flat surface, a “macroscopically curved surface” is generated. The surface of the 3D model (three-dimensional model) comprises the curved surfaces and the flat surfaces generated as described above.

The above point set is generated in the virtual world by the 3D model creation and modification area (3D models having prescribed sizes) 930. On the other hand, the 3D projective reverse transformer 550 (FIG. 8) generates the point set from the imaging result of the real object (measured object 22) in the real world. The 3D shape processing area (3D projective reverse transformation) 922 generates a three-dimensional shape of the measured object 22 using the point set output from the 3D projective reverse transformer 550. In both the real object (measured object 22) in the real world and the 3D model created in the virtual world, the 3D coordinate values of each point configuring the point set is a start point of information processing. Information processing methods using the 3D coordinate values of each point are similar between the two. Therefore, from the viewpoint of information processing, there is a technical effect that congeniality between the real object (measured object 22) in the real world and the 3D model created in the virtual world is good, and information processing of combining the two can be simplified.

“Determination of important sizes in the 3D model and adjustment of sizes according to the determination” performed in next step 04 are described. The 3D model created in the virtual world can take a free three-dimensional shape alone. However, as illustrated in FIG. 12, when the 3D model is arranged with the real object (measured object 22) in the real world, there is a possibility that a large sense of discomfort is given to the user. As an example of giving a sense of discomfort, there is a risk of giving an impression such as “the head of the 3D model is excessively large” or “the hand of the 3D model is excessively long”.

In order to reduce the sense of discomfort given to the user, processing of correcting a shape and sizes of each constituent element in the 3D model in accordance with the real object (measured object 22) in the real world may be performed. This processing corresponds to step 04. In this step, the value of the height “a” of the 3D model illustrated in FIG. 12 may be corrected (finely adjusted).

Next, setting of a color and a pattern of the 3D model surface (ST05) are performed, and in step 06, surface adjustment of the 3D model (texture setting of the surface to create expression of the material and transparency) is performed. Further, after the skeletal/muscle/fat information is embedded in the 3D model (ST07), a mechanism (rig) in which the 3D model moves is created (ST09). At the final stage of step 10, data storage of the completed 3D model or data transfer to the “object control and attribute analysis area 924 based on a real size” is performed. Finally, the 3D model creation is ended (ST12).

Since the 3D model created in the above procedure is digital data, copying and diversion are easy. Under this situation, “insertion of confidential information into the 3D model” may be performed in the present embodiment example for the purpose of “copyright protection of the author”. A user or a 3D model creator easily insists on the copyright when the user or the 3D model creator pre-registers the copyright in a public institution. As a specific method example, in step 08, setting of sizes of a concealed portion (setting of a partial bone size of a specific part in the 3D model, or the like) as confidential (identification) information of the 3D model may be performed.

In step 11, important sizes and confidential information (size values of concealed portions) may be pre-registered in a public institution. In Japan, there is the “notary public's office” as a public institution that secures copyright. That is, by performing the registration procedure in the notary public's office, the copyright of the 3D model created here can be determined.

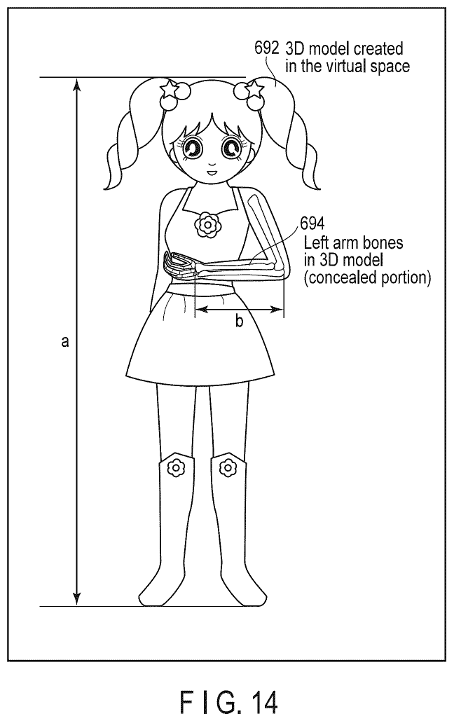

FIG. 14 illustrates an embodiment of the “size setting of a concealed portion as confidential (identification) information of the 3D model” corresponding to step 08. Here, an example in which the bone size of the arm of the 3D model as the “concealed portion” of which a size is set is designated is described.

In step 07 in FIG. 13, skeletal/muscle/fat information has been embedded in the 3D model. Thereafter, a detailed size “b” of left arm bones 694 in the 3D model may be defined, and this detailed size may be pre-registered in a public institution as the confidential information (a size value of the concealed portion). By using this method, the copyright of the 3D model author can be determined relatively easily.

The detailed sizes “b” of the left arm bones 694 in the 3D model are difficult to recognize at a glance from the outside. However, by moving the 3D model, the value of the detailed size “b” can be extracted. In FIG. 14, the detailed size “b” of the left arm bones 694 in the 3D model is defined. However, the present embodiment is not limited thereto, and the “confidential (identification) information of the 3D model” may be embedded using any method. For example, a “water mark” may be set in a prescribed area in the 3D model.

Chapter 2 Content of three-dimensional projective transformation method and three-dimensional projective reverse transformation method in present embodiment

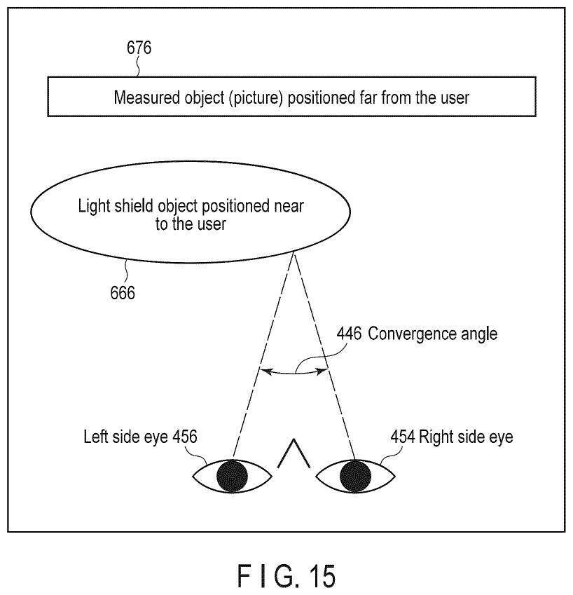

FIG. 15 is an explanatory diagram of a view line of a user viewing a plurality of real objects disposed three-dimensionally in the real world. As a three-dimensional layout example, in FIG. 15, a “measured object (picture) 676 positioned far from the user” is disposed on the rear side. In addition, a “light shield object 666 positioned near to the user” is disposed on the front side. The user is looking at the light shield object 666 positioned near to the user.

When the light shield object 666 positioned near to the user is viewed, there is a slight inclination between the view line direction in which the right side eye 454 is directed and the view line direction in which the left side eye 456 is directed. An angle between the left and right view lines represents a “convergence angle 446”. When a human sees a nearby object, this convergence angle widens. Conversely, when a human sees a distant object, this convergence angle narrows. A human uses this relationship to measure a perspective distance of an object.

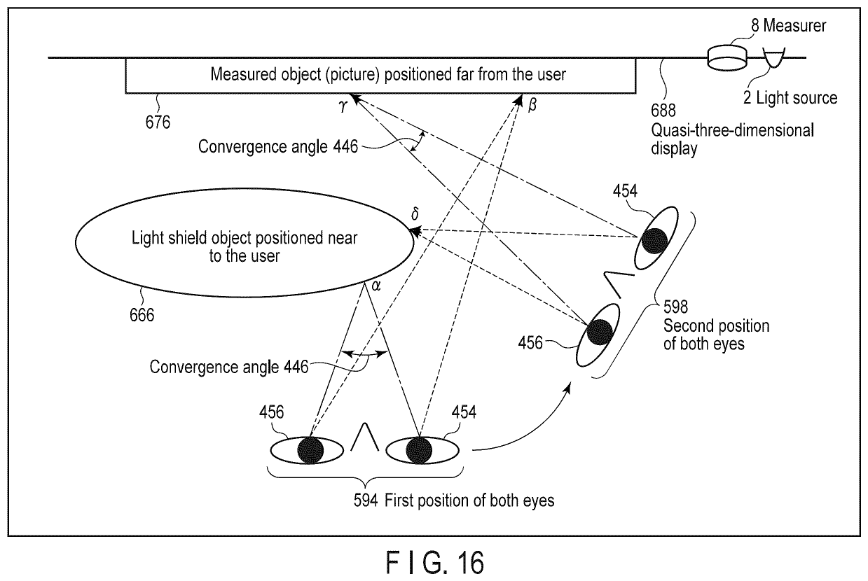

FIG. 16 is an explanatory view of a difference in appearance when a position in both eyes is changed with respect to the three-dimensional layout in FIG. 15. In a case where a position of both eyes of the user is a first position of both eyes 594 similar to FIG. 15, an “α point” on the surface of the light shield object 666 positioned near to the user falls within the visual field of the user. At the same time, a “β point” on the measured object (picture) 676 positioned far from the user also falls within the visual field of the user.

However, a γ point on the measured object (picture) 676 positioned far from the user is concealed behind the light shield object 666 positioned near to the user. Therefore, the γ point on the measured object (picture) 676 positioned far from the user does not fall within the visual field of the user but is included in a blind spot. A “δ point” on the surface of the light shield object 666 positioned near to the user also falls within the blind spot of the user. As far as viewed from the only view line as described above, a part of the three-dimensional shape is included in the blind spot (that is, a partial visual field defect for the three-dimensional shape or the three-dimensional information occurs).

However, changing a location at which the user sees an object significantly improves this visual field defect (the occurrence of a blind spot). For example, as the user moves to change the position of the user's eyes from the first position of both eyes 594 to a second position of both eyes 598, both positions of the “γ point” and the “δ point” are within the visual field of the user. In addition, from the second position of both eyes 598, the position of the “α point” and the position of the “β point” also fall within the visual field. When many imaging view lines are used for a three-dimensional shape (or three-dimensional information) as described above, a visual field defect (the occurrence of a blind spot) is greatly improved.

Furthermore, since the γ point exists farther than the distance from the user to the α point, the convergence angle 446 of the user when gazing at the γ point is narrowed. By using this difference in the convergence angle 446, a human can identify perspective to an object to be gazed.

In the above description, it has been assumed that the light shield object 666 positioned near to the user and the measured object positioned far from the user (for example, a picture) are three-dimensionally disposed in the real world as a real object. However, the present embodiment is not limited thereto, and can also be applied to a case where the user three-dimensionally views an image (or a movie) quasi-three-dimensionally disposed in the virtual world. In this case, the structure of the display 18 from FIGS. 5 to 7 may be used. A change in the convergence angle 446 when viewed by the user can be expressed to provide the user with a perspective interval.

For example, in a case where the user is at the first position of both eyes 594, a right side eye corresponding image (or a right side eye movie) falling within the right side eye 454 and a left side eye corresponding image (or a left side eye movie) falling within the left side eye 456 are displayed on the display 18 in correspondence with the first position of both eyes 594. In a case where the user moves to the second position of both eyes 598, a right side eye corresponding image (or a right side eye movie) falling within the right side eye 454 and a left side eye corresponding image (or a left side eye movie) falling within the left side eye 456 are displayed on the display 18 in correspondence with the second position of both eyes 598.

In the present embodiment example, information regarding a position of both eyes to be viewed by the user can be input to the optical device 10 so that the user can view this three-dimensional shape (combination thereof) from any position. For example, in a case where the display 18 described with reference to FIG. 5 is used, the light source 2 and the measurer 8 may be provided in a part of the display 18. The measurer 8 may measure the position of the user's right side eye 454 (exactly the center position of the right pupil (crystalline lens)) and the position of the left side eye 456 (exactly the center position of the left pupil (crystalline lens)).

Furthermore, it is desirable to be able to cope with the user viewing this three-dimensional shape from any position (combination thereof). In order to respond to this request, in the present embodiment example, the optical device 10 may store in advance the three-dimensional shape information viewed from all directions with respect to the light shield object 666 positioned near to the user and the measured object 676 positioned far from the user (such as a picture) and color image (movie) information thereof. When the right side eye corresponding image (or the right movie) falling within the right side eye 454 and the left side eye corresponding image (or the left movie) falling within the left side eye 456 are displayed on the display 18 in accordance with the position to be viewed by the user, an image (movie) having a high presence feeling can be presented to the user.

The above descriptions are summarized below. In order to reduce a visual field defect (occurrence of a blind spot) for a three-dimensional shape (and a three-dimensional combination thereof), in the present embodiment example, the following support may be provided:

1. Acquisition (imaging) of information regarding a three-dimensional shape from a plurality of different view lines for the three-dimensional shape (and a three-dimensional combination thereof);

2. Generation of three-dimensional shape information viewed from all directions for a three-dimensional shape (and a three-dimensional combination thereof) and color image (movie) information thereof, and

3. Enabling a display area (or a movie) when viewed from a plurality of different view lines by a user to be expressed (displayed).

As a method of reducing a visual field defect (occurrence of a blind spot) with respect to a three-dimensional shape (and a three-dimensional combination thereof), a method of shifting a position in both eyes of a user has been described above. However, in this method, an appearance of an object also changes according to changes in both-eyes positions. The influence of the appearance change in a case where a picture is taken as an example of the measured object 676 positioned far from a user is described.

For a user who wants to view a picture from the front, the impression when the picture is viewed from an oblique direction may deteriorate. In order to reduce a visual field defect (occurrence of a blind spot) for the user, it is desirable to make the light shield object 666 positioned near to the user transparent.

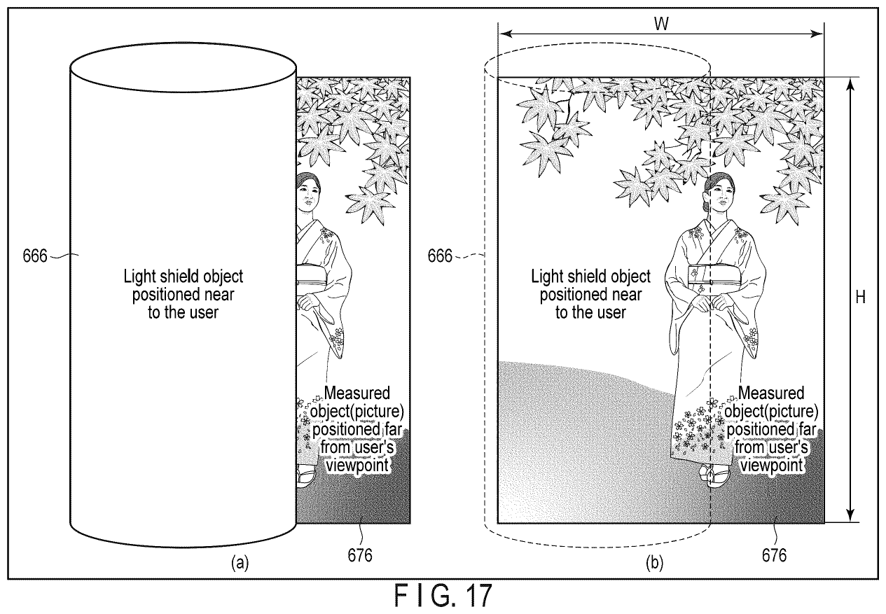

FIG. 17 illustrates an appearance of a light shield object in front when the light shield object is made transparent. FIG. 17 (a) illustrates an appearance of the three-dimensional layout illustrated in FIG. 16 viewed from the first position of both eyes 594. Only a part of the measured object (picture) 676 positioned far from the user can be seen while being blocked by the light shield object 666 positioned near to the user.

When the light shield object 666 in front is made transparent as illustrated in FIG. 17 (b), the measured object (picture) 676 positioned far from the user is seen from the front. A width of the measured object (picture) 676 positioned far from the user represents “W”. And a height of the measured object (picture) represents “H”.

In FIG. 16, when the user moves to the second position of both eyes 598, the entire measured object (picture) 676 positioned far from the user is visible. However, from the second position of both eyes 598 in the oblique direction, the outer frame of the measured object (picture) 676 positioned far from the user does not appear rectangular. Within the outer frame, it appears longer “trapezoidal” closer to the second position of both eyes 598 and shorter “trapezoidal” farther from the second position of both eyes 598. In accordance therewith, the picture that is the measured object 676 positioned far from the user appears distorted. Therefore, the impression when the user views the picture 676 from the oblique direction is greatly different from the impression when the user views the picture 676 from the front.

The reason why the picture appears distorted when the picture 676 is viewed from the oblique direction is described below. As illustrated in FIG. 7, an eye (monocular) of a human schematically includes a crystalline lens 158, a vitreous body 154, and a retina 156. By the lens action of the crystalline lens 158, an image of an external object is formed on the retina 156. The retina 156 has a two-dimensional curved surface. Therefore, a human recognizes the external object as a two-dimensional image.

The retina 156 is disposed in a direction substantially perpendicular line to the optical axis of the crystalline lens 158. As a result, the human recognizes a two-dimensional image “projected” on a plane perpendicular to the optical axis of the crystalline lens 158 (a microscopic plane in which the retina 156 spreads), that is, a projected image. When a human sees the picture 676 from the oblique direction, the optical axis of the crystalline lens 158 is inclined with respect to the perpendicular line to the picture 676. Therefore, the projected image for the picture 676 projected on the retina 156 appears distorted.

The crystalline lens 158 having the lens function can be regarded as an image forming lens 388. All light beams passing through the center (principal point) of the crystalline lens 158 (image forming lens 388) travels straight regardless of passing directions. Therefore, in the description of the present embodiment example, the center position (principal point position) of the crystalline lens 158 is regarded as a “position of an eye (monocular) of a human”.

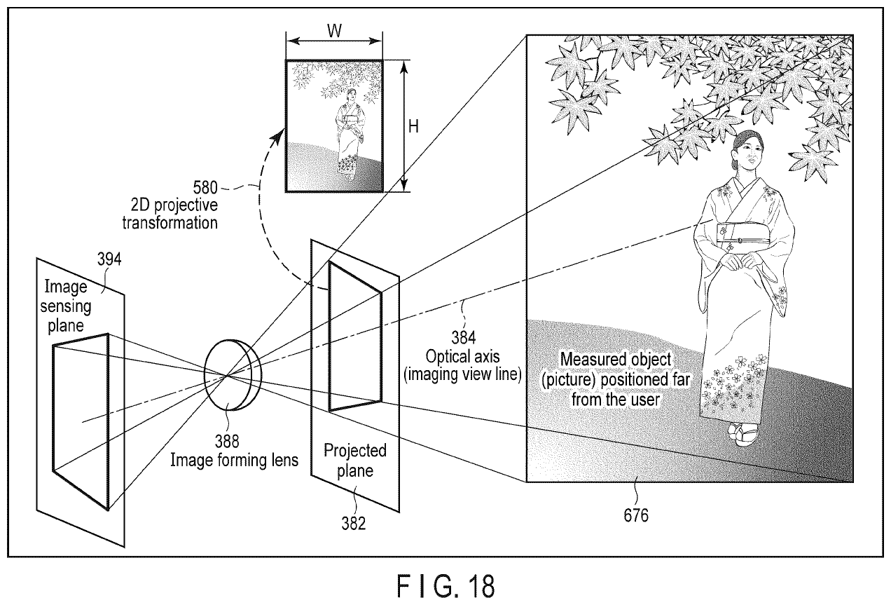

FIG. 18 illustrates a basic concept of 2D projective transformation 580. In the spatial layout in FIG. 16, the entire “measured object (picture) 676 positioned far from the user” is visible only from the oblique direction (second position of both eyes 598). However, when the method of the 2D projective transformation 580 described here is used, the entire “measured object (picture) 676 positioned far from the user” can be viewed from the front as illustrated in FIG. 17 (b).

According to the 2D projective transformation 580, first, information regarding the entire “measured object (picture) 676 positioned far from the user” is collected. As shown FIG. 16, the entire “measured object (picture) 676 positioned far from the user” is collected when the user stands at the second position of both eyes 598. Next, a view line direction desired by the user with respect to the “measured object (picture) 676 positioned far from the user” is set. A projected image (a projected screen or a projected movie) from the “measured object (picture) 676 positioned far from the user” when viewed from the installed user view line direction is projected onto a projected plane 382. The projected screen (projected movie) that is projected on the projected plane 382 is displayed to the user. For example, the projected plane 382 shows the trapezoidal picture frame when the user wants to sand at the second position of both eyes 598 in FIG. 16. And the projected plane 382 shows the rectangular picture frame having the width “W” and the height “H” when the user wants to sand at the first position of both eyes 594 in FIG. 16.

An image (movie) developed on a two-dimensional plane such as a picture is targeted as an image (movie) before transformation (before projection) in the 2D projective transformation 580. In other words, the target of the 2D projective transformation 580 is limited to the two-dimensional plane (images or movies) located in the three-dimensional space. And the 2D projective transformation 580 changes the display pattern of the two-dimensional image or movie based on the user's view line in the three-dimensional space. Therefore, hereinafter, the “measured object (picture) 676 positioned far from the user” is expressed as an “object 676 (such as a picture) on a plane” for convenience.

In FIG. 18, the projected plane 382 is defined instead of the human retina 156. The center view line from a position of an eye (monocular) of the user (a principal point position of the image forming lens 388) toward the central portion of the object (such as a picture) 676 on a plane is made to correspond to the optical axis 384 of the image forming lens. As described above, the perpendicular line to the plane near the center in the retina 156 is parallel to the optical axis of the crystalline lens 158. Correspondingly, the projected plane 382 is disposed in a plane perpendicular to the center view line of the user (the optical axis 384 of the image forming lens).

In the 2D projective transformation 580, a method of forming a projected image on the projected plane 382 is described below. The object (such as a picture) 676 on a plane is projected at each intersection position between the “a straight line (individual view lines) from the position of an eye (monocular) of the user (a principal point position of the image forming lens 388) toward each point in the object (such as a picture) 676 on a plane” and the projected plane 382.

In the projected plane 382 in FIG. 18, an image projected onto only a rectangular frame outside the object (such as a picture) 676 on a plane is provisionally drawn. The user in FIG. 18 views the object (such as a picture) 676 on a plane in the oblique direction. In this situation, the user's center view line (the optical axis 384 of the image forming lens) is greatly inclined with respect to the perpendicular line to the object (such as a picture) 676 on a plane. Therefore, the projected image in which the outer rectangular frame is projected on the projected plane 382 has a trapezoidal shape. Here, one side closest to the user's eye (image forming lens 388) in the outer rectangular frame forms the longer line of the trapezoidal shape.

So far, “a projected image transferred to the human retina 156” has been mainly described. The present embodiment is not limited thereto, and a similar projected image is also projected onto the image sensing plane 394 of the imaging sensor 270 or 280 disposed in the measurement device 12 (or in the measurer 8). The measurement device 12 (or the measurer 8) includes the image forming lens 388. In addition, the image sensing plane 394 is present behind the image forming lens 388 and is located on a plane perpendicular to the optical axis of the image forming lens 388. Therefore, a projected screen (or a projected movie) in which the vertical and horizontal directions of the projected image projected on the projected plane 382 are inverted is formed on the image sensing plane 394.

Furthermore, a view line indicating an imaging direction of the measurement device 12 (or the measurer 8) may be referred to as an “imaging view line” corresponding to the above-described “user's view line”. A direction of the imaging view line coincides with the direction of the optical axis 384 of the image forming lens 388. For the same reason as described above, a pattern of the projected image (or the projected movie) projected on the image sensing plane 394 changes depending on an inclination amount of the optical axis (imaging view line) 384 of the image forming lens 388 toward the object (such as a picture) 676 on a plane. Therefore, the 2D projective transformation technology can be applied to the projected image (imaged movie) on the image sensing plane 394.

In the spatial layout illustrated in FIG. 18, the projected image (or projected movie) projected on the image sensing plane 394 is greatly distorted with respect to the original object (such as a picture) 676 on a plane. Although greatly distorted as described above, all the detailed image information (or movie information) of the original object (such as a picture) 676 on a plane is included in the projected image (or the projected movie). Therefore, when pixel complementation (2D projective transformation) with respect to the projected image (or projected movie) obtained here is used, a projected image (or a projected movie) corresponding to any imaging view line 384 is obtained.

A method of performing the 2D projective transformation 580 along the imaging view line 384 of the original object (such as a picture) 676 on a plane viewed from the front is described. In this case, a direction of the imaging view line (the optical axis of the image forming lens) 384 is parallel to the perpendicular line to the picture (measured object) 676 on a plane. The projected plane 382 has a parallel relationship with the picture (measured object) 676 on a plane.

In this case, a straight line (imaging view line 384) from each point in the object (such as a picture) 676 on a plane toward the image forming lens 388 intersects with the projected plane 382. Pixel complementation (transformation between two-dimensional images (movies)) is performed such that each point in the object (such as a picture) 676 on a plane is projected onto each intersection position. A ratio “H/W” between the height “H” and the width “W” of the outer frame of the obtained projected image (projected movie) is the same as the outer frame ratio of the original picture (measured object) 676 on a plane. That is, when the user views the picture (measured object) 676 on a plane from the front, the user can appreciate the picture without distortion. Therefore, the projected image (or the projected movie) illustrated in FIG. 17 (b) is obtained.

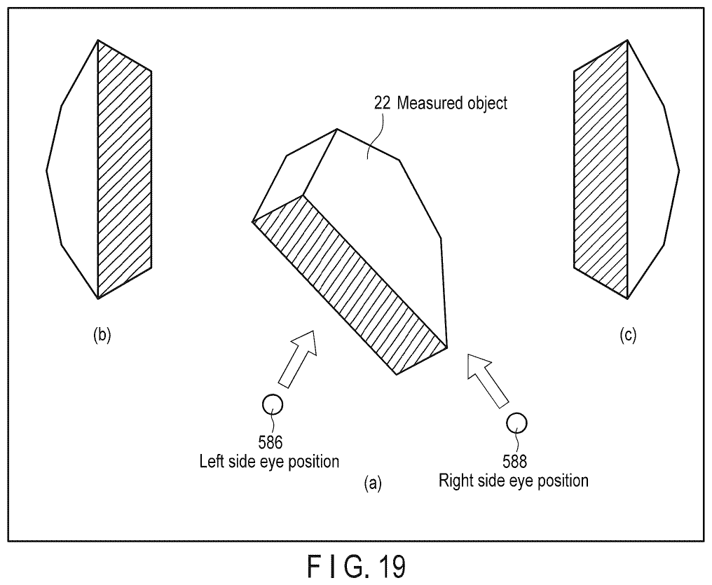

FIG. 19 is an explanatory diagram of a concept of “three-dimensional projective transformation” proposed in the present embodiment example. The “three-dimensional projective transformation” indicates “transformation of simultaneously projecting a three-dimensional shape onto a plurality of planar images (or planar movies)”. The “2D projective transformation 580” has been described with reference to FIG. 18. This 2D projective transformation is centered on transformation (transformation from a planar image (or a planar movie) to a planar image (or a planar movie) between planar projected images (projected images/projected movies) for the “object 676 on a two-dimensional plane” such as a picture disposed in a three-dimensional space. In contrast, the three-dimensional projective transformation described here is centered on transformation from a “three-dimensional shape” to a plurality of planar images (planar movies) (so that a user can perform three-dimensional viewing).

Incidentally, the 2D projective transformation 580 described in FIG. 18 can also be performed on a projected image (projected image or projected movie) acquired from a view line. In comparison, in the “three-dimensional projective transformation” newly proposed here, the simultaneous transformations to a plurality of projected images (or projected movies) corresponding to a plurality of respective view lines are performed.

A “plurality of eye positions (plurality of respective view lines)” mentioned here may correspond to a left side eye position 586 of a user and a right side eye position 588 of the user. The generated individual projected images (or projected movies) may be displayed at the individual eye positions 586 and 588. That is, a projected image for the left side eye is displayed on the left side eye. A projected image for the right side eye is displayed on the right side eye.

However, the present invention is not limited thereto, and positions of respective eyes of a plurality of persons may be made to correspond to each other. For example, a case where three users each observe a prescribed object (a measured object 22) having a specific three-dimensional shape from different directions is considered. In this case, there are “corresponding six eyes at different positions”. In the three-dimensional projective transformation defined here, the prescribed object (the measured object 22) is projected in six different view line directions. Six types of planar images corresponding to different imaging view lines 384 may be generated. Accordingly, the three users can simultaneously view three-dimensional images of the prescribed object (the measured object 22) from the respective directions.

The prescribed object (the measured object 22) having the specific three-dimensional shape does not need to stand still. In a case where the prescribed object (the measured object 22) moves or moves (changes in shape with passing time), six types of planar movies may be generated.

In the present embodiment example, a difference in convergence angle 446 between a view line (first view line) 582 from the left side eye position 586 and a view line (second view line) 584 from the right side eye position 588 can be used to express the difference in perspective for the user. Therefore, in the present embodiment example, on the premise of “user's three-dimensional view”, the three-dimensional shape may be simultaneously transformed into projected images (or projected movies) individually displayed at the left side eye position 586 and the right side eye position 588.

Furthermore, in the 2D projective transformation 580, the content of the projective image (or the projected movie) after transformation has changed due to the change in the view line direction (the direction of the imaging view line 384) toward the planar image or the planar movie (the original object (such as a picture) 676 on a plane) before the transformation. In comparison, in the three-dimensional projective transformation, the content of the projected image (or the projected movie) after the transformation changes due to a position change of the both-eyes positions 586 and 588 (or the image forming lens 388) with respect to the target three-dimensional shape before the transformation.

FIG. 19 (a) illustrates an example of view line directions (two outlined arrows) from the both-eyes positions 586 and 588 set at different positions with respect to the measured object 22 having a three-dimensional shape. The three-dimensional shape example of the measured object 22 configures a heptahedron formed of seven planes. The front surface and the back surface each have a pentagonal shape. Each of the side surface and the bottom surface has a quadrangular shape. Note that the bottom surface of the measured object 22 (heptahedron) is clearly indicated as a shaded area so that the three-dimensional shape can be easily identified.

FIG. 19 (b) illustrates an appearance (projected image) of the three-dimensional shape of the measured object 22 when viewed from the left side eye position 586. Furthermore, FIG. 19 (c) illustrates an appearance (projected image) when viewed from the right side eye position 588. FIGS. 19 (b) and 19 (c) represent “plan views” obtained by “three-dimensional projective transformation” from the measured object 22 having a three-dimensional shape.

The original shape of the bottom surface (shaded area) of the measured object 22 is a rectangular shape. The projected images of the bottom surface (shaded area) in FIGS. 19 (b) and 19 (c) each have a trapezoidal shape. Each of the longer lines of the trapezoidal shape corresponds to a “side line” in the bottom surface (shaded area) existing at the position closest to both-eyes positions 586 and 588. The shape change of the bottom surface (shaded area) before and after the “three-dimensional projective transformation” is equivalent to the 2D projective transformation.

Incidentally, in FIG. 19 (b), the upper shape of the measured object 22 appears on the left side of the bottom surface (shaded area). In contrast, in FIG. 19 (c), the upper shape appears on the right side of the bottom surface (shaded area). The difference in appearance of the inner upper shape of the measured object 22 cannot be obtained in the 2D projective transformation. This difference results from the following two factors:

A) The left side eye position 586 and the right side eye position 588 exist at spatially different positions;

B) The object (measured object 22) before transformation has a three-dimensional shape.

The projected image obtained in FIG. 19 (b) may be displayed as a projected image (or a projected movie) to be displayed on the left side eye of the user. Furthermore, the projected image obtained in FIG. 19 (c) may be displayed as a projected image (or a projected movie) to be displayed on the right side eye of the user. The projected image (or projected movie) obtained after the 2D projective transformation may be displayed as a projected image (or projected movie) to be provided to the user. However, more presence feeling can be provided to the user by displaying the projected image (or the projected movie) obtained after the three-dimensional projective transformation.

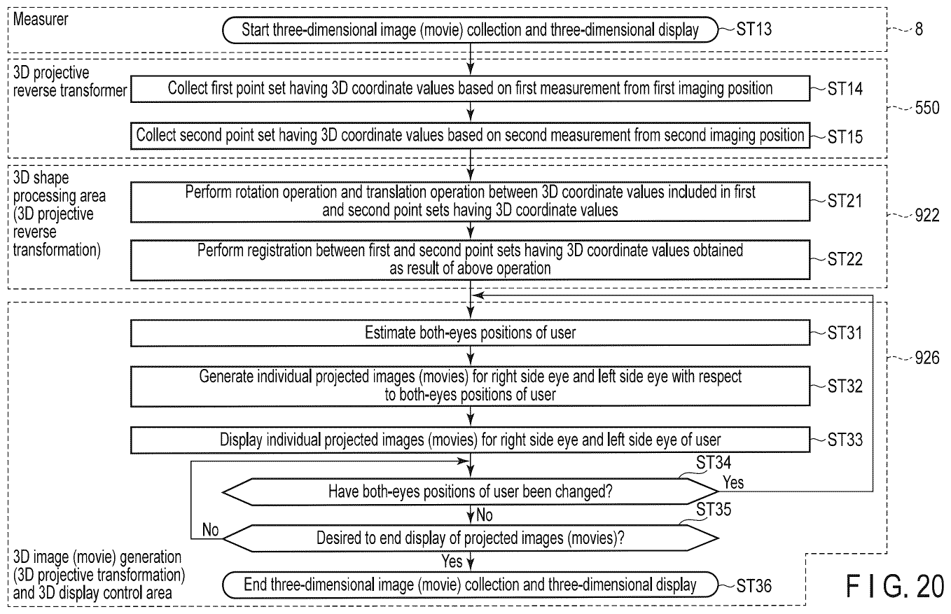

FIG. 20 illustrates a specific procedure example of three-dimensional projective transformation of a three-dimensional shape of a real object (measured object 22) in the real world. As explained above in FIG. 8, a series of processes achieved in the measurer 8, the signal receptor 40, and the 3D projective reverse transformer 550 generates a corresponding point set by imaging a real object (measured object 22) in the real world. And the 3D shape processing area (3D projective reverse transformation) 922 performs registration of the point sets collected from different view lines (imaging view lines) to configure the entire three-dimensional shape. Furthermore, the 3D image (movie) generation (3D projective transformation) and 3D display control area 926 performs three-dimensional projective transformation to generate a display image (or display movie) for the user.

At the start stage of the collection of the three-dimensional image (movie) and the three-dimensional display in step 13, the measurer 8 starts imaging the real object (measured object 22) in the real space. It is difficult for a measurer 8 to obtain accurate information regarding the entire three-dimensional shape in the three-dimensional space through imaging performed only once. Therefore, it is necessary to perform measurement a plurality of times from a plurality of different imaging view lines.

In a case where only a measurer 8 is used, the user may repeat measurement with different measurement timings. Herein, as illustrated in FIG. 3, imaging positions of the removable data processing device 9 including the light source 2 and the measurer 8 may be shifted with different measurement timings.

On the other hand, in a case where it is desired to perform imaging from a plurality of view lines at the same time, a plurality of measurers 8 installed at different locations may be used. As a specific example thereof, as illustrated in FIG. 4, a plurality of measurers 8-1 and 8-2 may be disposed at different locations and may simultaneously perform imaging.

The 3D projective reverse transformer 550 acquires the 3D coordinate values and the color information of each point in the point set obtained from the measurer 8 and the signal receptor 40. And the 3D projective reverse transformer 550 achieves the collection of the first three-dimensional shape information based on the first measurement from the first imaging position (ST14) and the collection of the second three-dimensional shape information based on the second measurement from the second imaging position (ST15).

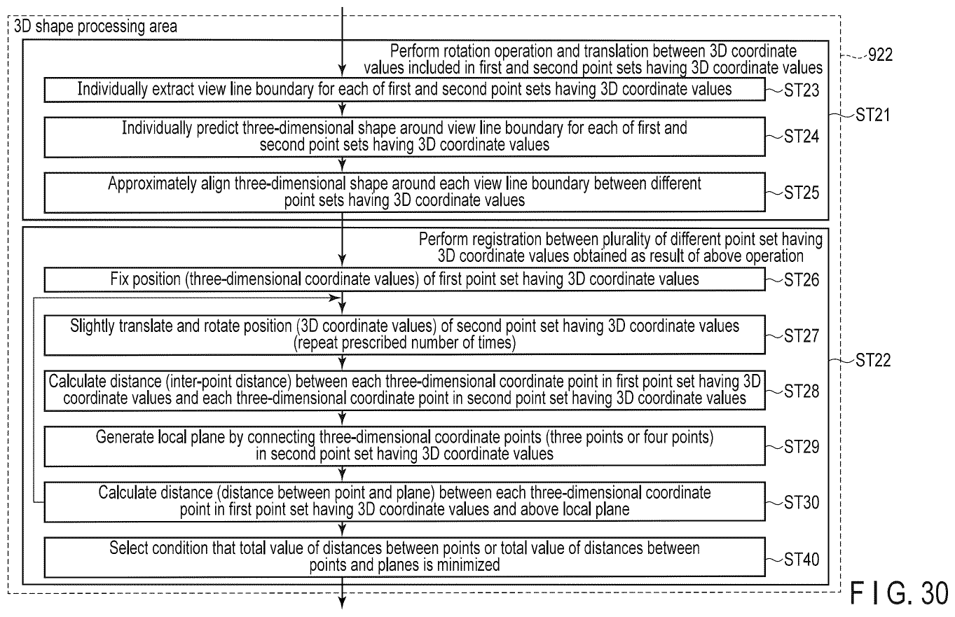

The individual pieces of three-dimensional shape information obtained from the individual imaging view lines are limited to a part of the three-dimensional shape information of the entire measured object 22. Therefore, in the virtual world, the 3D shape processing area (3D projective reverse transformation) 922 performs a rotation operation or a translation operation (ST21) between pieces of 3D coordinate values included in the first three-dimensional shape information and the second three-dimensional shape information. The three-dimensional shape information of the entire measured object 22 is obtained only after performing registration (ST22) between the first three-dimensional shape information and the second three-dimensional shape information obtained as a result. Here, the rotation operation or the translation operation (ST21) between the pieces of 3D coordinate values included in the first three-dimensional shape information and the second three-dimensional shape information are performed in a prescribed coordinate system. Moreover, the registration (ST22) between the first three-dimensional shape information and the second three-dimensional shape information are also performed in the prescribed coordinate system. The prescribed coordinate system may be formed in the virtual world. Note that a specific method example related to this processing will be described later with reference to FIG. 30.

The three-dimensional shape information of the entire measured object 22 generated by the “3D shape processing area (3D projective reverse transformation) 922” as described above is transferred from the “3D shape processing area (3D projective reverse transformation) 922” to the “3D image (movie) generation (3D projective transformation) and 3D display control area 926”. The three-dimensional shape information of the entire measured object 22 includes time-axis coordinate values corresponding to 3D coordinate values of main points configuring the three-dimensional shape of the entire measured object 22, color information, and the like. Note that the “prescribed coordinate system (which may be a coordinate system set in a virtual world) that defines 3D coordinate values of main points configuring the three-dimensional shape of the entire measured object 22” is also taken over from the “3D shape processing area (3D projective reverse transformation) 922” to the “3D image (movie) generation (3D projective transformation) and 3D display control area 926”.

In step 31, the “3D image (movie) generation (3D projective transformation) and 3D display control area 926” sets both-eyes positions 586 and 588 of the user in the prescribed coordinate system (which may be set in the virtual world). The both-eyes positions 586 and 588 of the user may be set as “relative positions” with respect to the measured object 22 having the entire three-dimensional shape information. For example, the both-eyes positions 586 and 588 of the user may be set using relative position information (each coordinate value expressed as the prescribed coordinate system) in the prescribed coordinate system (which may be the coordinate system set in the virtual world) taken over to the “3D image (movie) generation (3D projective transformation) and 3D display control area 926”.

Note that, methods of setting the both-eyes positions 586 and 588 of the user in the present embodiment example may employ the following methods or other methods:

A) A user directly inputs the both-eyes positions 586 and 588 using the sensor group (including a touch pad and a mouse) not applying light 52; and

B) The both-eyes positions 586 and 588 are estimated from user's head motion and eye motion.

Here, the expression “estimation of both-eyes positions of a user” is used on the assumption that the above (B) is provisionally employed. And the both-eyes positions 586 and 588 of the user, the direction of the view line (first view line) 582 from the left side eye position 586, and the direction of the view line (second view line) 584 from the right side eye position 588 change in the prescribed coordinate system depending on a portion that the user wants to see the three-dimensional shape of the entire measured object 22. For example, in a case where a user enters a room in a building and wants to see the inside of the room from the inside, the user wants to see “the inside of a three-dimensional shape”. In this case, it is desirable to set the both-eyes positions 586 and 588 of the user in a “layout location of the three-dimensional shape” in the prescribed coordinate system.

On the contrary, for example, a case where the user wants to view the appearance of the building from the outside of the building or a case where the user wants to view a relatively small three-dimensional shape from the outside is assumed. In this case, it is desirable to set the both-eyes positions 586 and 588 of the user outside the “layout location of the three-dimensional shape” in the prescribed coordinate system. Further, it is desirable that the direction of the view line (first view line) 582 from the left side eye position 586 and the direction of the view line (second view line) 584 from the right side eye position 588 are directed toward the “layout location of the three-dimensional shape”.

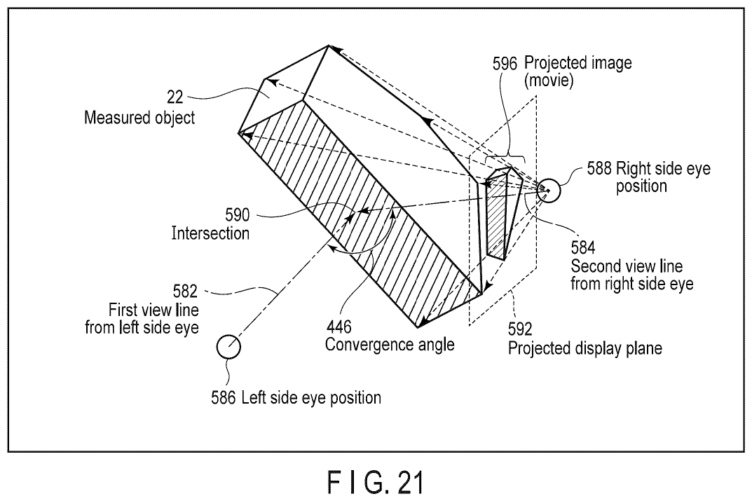

In step 32, individual projected images (or movies) for the right side eye and the left side eye with respect to the user's both-eyes view lines are generated using information regarding the user's both-eyes positions set in the prescribed coordinate system. A detailed embodiment example of this step will be described later with reference to FIG. 21. The individual projected images (or movies) for the right side eye and the left side eye are displayed to the user (ST33).

During the display of the individual projected images (or movies) to the user, the user may change the both-eyes positions 586 and 588. Therefore, as illustrated in step 34, it is necessary to constantly check “has the user changed the both-eyes positions 586 and 588?”. In a case where the user has changed the both-eyes positions 586 and 588, the adaptation is appropriately performed from step 31. Finally, in a case where it is desired to end the display of the projected image (movie) (ST35), the collection of the three-dimensional image (movie) and the three-dimensional display are ended (ST36).

As described above, in a case where the three-dimensional projective transformation using the real object (measured object 22) existing in the real world is performed, it is necessary to perform the configuration (assembly: registration) of the entire three-dimensional shape in the prescribed coordinate system (or in the virtual world). At this stage, a size value of each portion configuring the three-dimensional shape needs to match a scale in the prescribed coordinate system. Therefore the “3D image (movie) generation (3D projective transformation) and 3D display control area 926” estimates (sets) the both-eyes positions (the left side eye position 586 and the right side eye position 588 of the user) in the prescribed coordinate system. Here, according to a location that the user wants to see in the three-dimensional shape, the “3D image (movie) generation (3D projective transformation) and 3D display control area 926” optimizes a “positional relationship between the three-dimensional shape and the both-eyes positions 586 and 588”. Accordingly, the directions of the view lines 582 and 584 from the both-eyes positions 586 and 588 are optimized. A plurality of projected images (or projected movies) are generated based on the “Positional relationship between three-dimensional shape and both-eyes positions 586 and 588”.

The three-dimensional projective transformation method using the real object (measured object 22) existing in the real world has been mainly described. However, the present embodiment is not limited thereto, and the 3D model creation and modification area (3D models having prescribed sizes) 930 may generate the entire three-dimensional shape in the virtual world. The three-dimensional shape in the virtual world in this case corresponds to a 3D model. After the 3D model is created, the process proceeds to step 31, and the three-dimensional projective transformation can be executed.

FIG. 21 illustrates an example of a method of creating a projected image or a projected movie in three-dimensional projective transformation according to the present embodiment. The measured object 22 has a heptahedral structure similar to that in FIG. 19. A state in which the user gazes at the central portion of the bottom surface (shaded area) of the measured object 22 is exemplified. The left side eye position 586 and the right side eye position 588 are disposed at positions slightly away from each other. The both-eyes positions 586 and 588 are disposed outside the position where the measured object 22 having a three-dimensional shape exists.

The first view line 582 corresponding to the view line from the left side eye generated from the left side eye position 586 is directed toward the central portion of the bottom surface (shaded area) of the measured object 22. Similarly, the second view line 584 corresponding to the view line from the right side eye generated from the right side eye position 588 is directed toward the central portion of the bottom surface (shaded area) of the measured object 22.

A position of an intersection 590 between the view lines 582 and 584 of the right and left eyes comes to the central portion of the bottom surface (shaded area) of the measured object 22. At the position of the intersection 590, the convergence angle 446 is formed between the “first view line 582 corresponding to the view line from the left side eye position 586” and the “second view line 584 corresponding to the view line from the right side eye position 588”.

FIG. 21 shows an example of a method of generating a projected image (or a projected movie) 596 at which the user's right side eye looks. A projected display plane 592 is disposed in a plane perpendicular to the second view line (view line from the right side eye position 588) 584. At the same time, the projected display plane 592 is disposed between the right side eye position 588 and the measured object 22. Herein, the position and the direction of the projected display plane 592 are fixed when the user continues to look at the same gazing point (intersection 590 between view lines of right and left eyes).

The projected image (or the projected movie) 596 is formed on the projected display plane 592. The projected display plane 592 forms a flat plane. Therefore, the projected image (or the projected movie) 596 is displayed as a planar image (or a planar movie). The “3D image (movie) generation (3D projective transformation) and 3D display control area 926” may draw each of straight lines from the same right side eye position 588 toward all points on the measured object 22. And then, the “3D image (movie) generation (3D projective transformation) and 3D display control area 926” may extract each of intersection points between the fixed projected display plane 592 and all the straight lines. As a result of extracting the intersection points, a series of the intersection points on the projected display plane forms the projected image (movie) 596. Furthermore, a projected image (or projected movie) 596 corresponding to the layout position of the left side eye position 586 is also created using a method similar to the above.

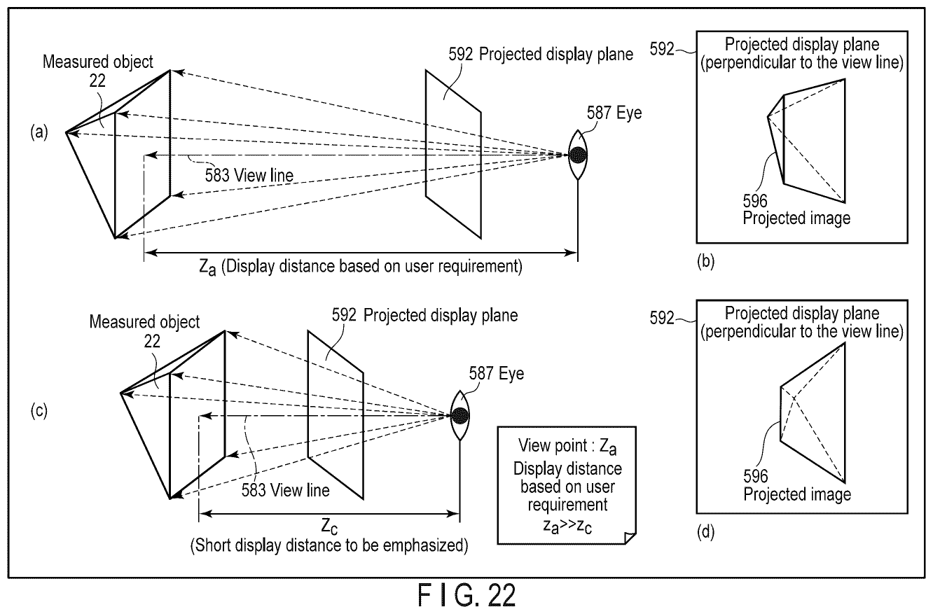

FIG. 22 illustrates an application example of three-dimensional projective transformation. FIG. 22 illustrates a quadrangular pyramid shape as a three-dimensional shape of the measured object 22, and a case where an eye 587 of one user is disposed behind a bottom surface of the quadrangular pyramid is considered. FIG. 22 (a) illustrates a state in which the eye 587 of one user is disposed at a position of a display distance “Za” based on user requirement.

The projected display plane 592 is disposed in a plane perpendicular to the view line 583 from the position of the user's eye 587 toward the central portion of the bottom surface. FIG. 22 (b) illustrates a projected image (or a projected movie) 596 projected onto the projected display plane 592 in this case. Since the display distance “Za” based on user requirement is relatively long, the bottom surface size in the user visual field is relatively small. As a result, the apex of the quadrangular pyramid tip is visible in the projected image (or projected movie) 596.

In order to emphasize the three-dimensional projective transformation, FIG. 22 (c) illustrates a state in which the distance “Zc” between the user's eye 587 and the bottom surface is greatly reduced (Za>>Zc). Furthermore, FIG. 22 (d) illustrates a projected image (or a projected movie) 596 projected onto the projected display plane 592 in this case. The distance between the user's eye 587 and the bottom surface is reduced to a short display distance “Zc” to be emphasized. As a result, the bottom surface size in the user visual field becomes relatively large. In the resulting projected image (or projected movie) 596, the apex of the quadrangular pyramid tip is concealed by the bottom surface.

Consequently, when the set distance between the user's eye 587 and the measured object 22 is changed as described above, the pattern content of the projected image (or the projected movie) 596 is changed. The projected image (or projected movie) 596 after the three-dimensional projective transformation may be emphasized using this phenomenon. Specifically, for example, the projected image (or the projected movie) 596 may be displayed to the user by reducing the set distance between the user's eye 587 and the measured object 22 to be shorter than the display distance “Za” based on user requirement. As an effect thereof, it is possible to enhance the presence feeling and enhance the impression for the user.

In connection with the description of the present embodiment examples, a novel term “three-dimensional projective transformation” has been used. The “three-dimensional projective transformation” is “transformation of projecting a three-dimensional shape onto a plurality of planar images (or planar movies)”. Incidentally, a human determines perspective based on a difference in convergence angle occurring at an intersection between the left and right view lines 582 and 584. Therefore, when a difference in convergence angle occurs in the plurality of (left and right) planar images (or planar movies of the user), the user can view the images (movies) in a quasi-three-dimensional manner.

Here, the term of “three-dimensional projective reverse transformation” corresponding to reverse transformation of the “three-dimensional projective transformation” is defined. The “three-dimensional projective reverse transformation” as defined herein is “transformation from an image (or a movie) developed on a plane to a three-dimensional shape”. The “image (or the movie) developed on the plane” on which the “three-dimensional projective reverse transformation” is based is acquired using an “imaging sensor having a plurality of pixels”. In particular, in the present embodiment example, “construction of a three-dimensional shape using a distance between the measured object 22 and a prescribed pixel in an imaging sensor relating to depth (distance) signal” may be performed. In this transformation, a result of “optical distance measurement” is used. An “optical distance measurement method” described in detail in Chapter 3 has an effect of enabling distance measurement in any distance range.

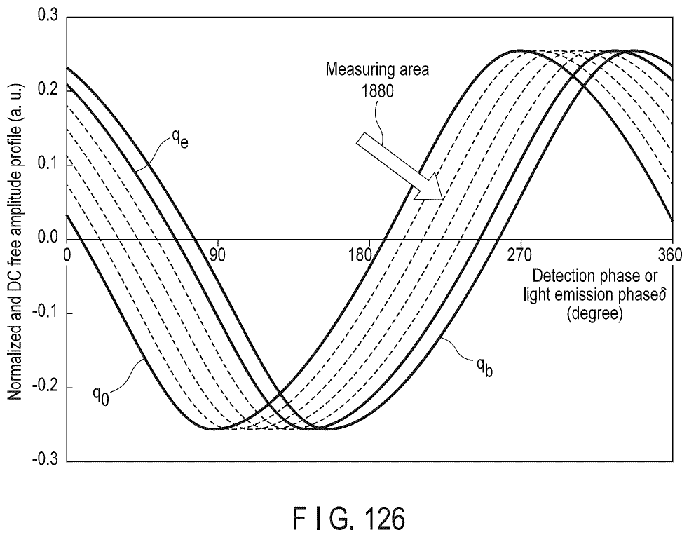

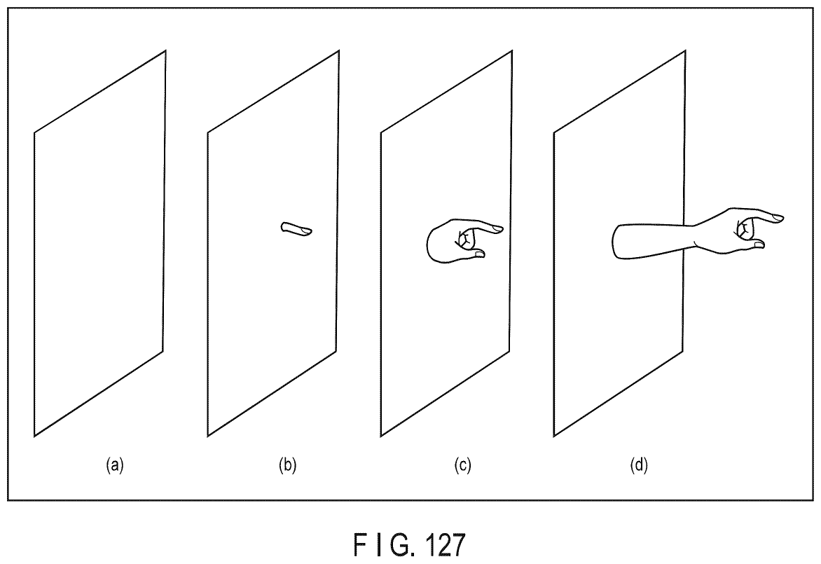

Compared with the “stereo method” in which a three-dimensional shape of a three-dimensional object is calculated using the “trigonometry” between specific areas in a plurality of planar images, the “three-dimensional projective reverse transformation method” has an advantage that “a distance to a three-dimensional object that is far away can be measured”. Moreover, the “stereo method” has a fundamental problem to reduce distance measurement accuracy because reflected light obtained from the background objects located behind the measured object 22 obstruct the three-dimensional measurement when the user tries to achieve the three-dimensional measurement of the measured object 22. On the contrary, as explained later in FIGS. 126 and 127, the present embodiment easily prevents the disturbance light reflected by the background objects and guarantees the accurate three-dimensional measurement. In addition, compared with the laser light distance measurement method in which an arrival time difference of light is detected by a photodetector, the above “three-dimensional projective reverse transformation method” (the present embodiment) has an advantage that “short-time measurement” and “providing high temporal/spatial resolution” can be performed.

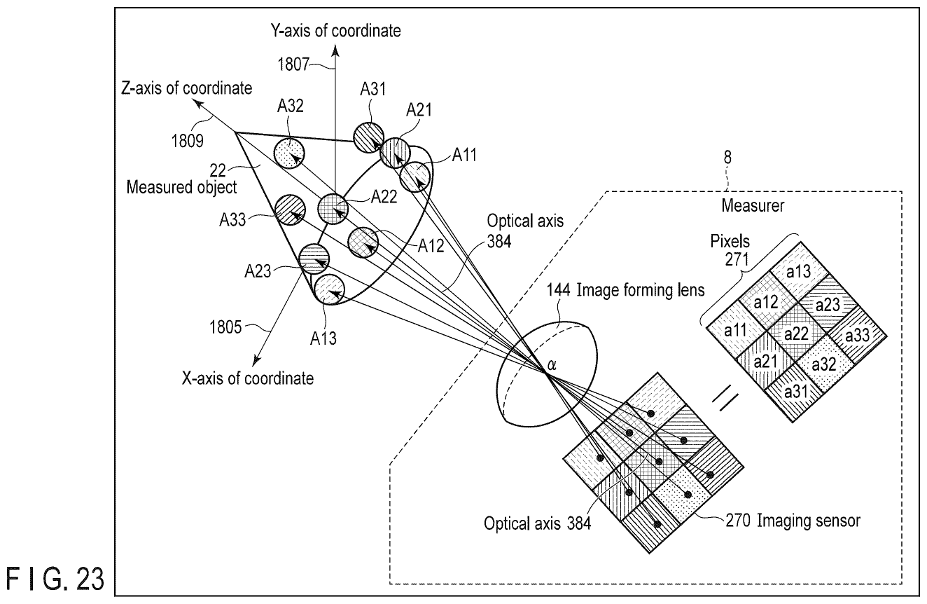

FIG. 23 is an explanatory diagram of a concept of the “three-dimensional projective reverse transformation”. Herein, the “three-dimensional projective reverse transformation” achieves based on “optical distance measurement”. Key elements of the “three-dimensional projective reverse transformation” are an image forming lens 144 and an imaging sensor 270 relating to a depth (distance) signal that are included in the measurer 8 of the present embodiment. Many pixels 271 divided are disposed on an image sensing plane of the imaging sensor 270 relating to a depth (distance) signal. Each pixel 271 in the imaging sensor 270 individually has a photoelectric conversion function. Therefore, a difference in the irradiated light intensity to each pixel 271 in the imaging sensor forms a planar image (or a planar movie). In order to identify each pixel 271 in the imaging sensor, identification codes from “a11” to “a33” are assigned to the respective pixels 271 for convenience in

FIG. 23.

In the present embodiment example, three-dimensional coordinate axes 1805, 1807, and 1809 may be set in accordance with the arrangement status of the respective pixels 271 in the imaging sensor 270. As a method of setting the three-dimensional coordinate axes 1805, 1807, and 1809, for example, the Z-axis of coordinate 1809 may be set in a direction parallel to “a perpendicular line to the image sensing plane on which the pixels 271 in the imaging sensor 270 are arranged”. Directions of the X-axis of coordinate 1805 and the Y-axis of coordinate 1807 may be set in correspondence with “an arrangement direction of the pixels 271 in the imaging sensor 270” (for example, a vertical arrangement direction and a horizontal arrangement direction of the respective pixels 271 in the imaging sensor).

Here, the “vertical arrangement direction and horizontal arrangement direction of the respective pixels 271 in the imaging sensor 270” and the “directions of the X-axis of coordinate 1805 and the Y-axis of coordinate 1807” do not necessarily have to be in a parallel relationship. A “twisting relationship” inclined by a prescribed angle may be held.

The present invention is not limited thereto, and a spatial coordinate axis may be set in accordance with a layout position of the image forming lens 144 or a direction of the optical axis (imaging view line) 384 of the image forming lens 144. For example, as illustrated in FIG. 23, the Z-axis of coordinate 1809 may be set in the direction of the optical axis (imaging view line) 384 of the image forming lens 144. When the “perpendicular line to the image sensing plane in the imaging sensor 270 are arranged” and the direction of the optical axis (imaging view line) 384 of the image forming lens 144 are made parallel as described above, the aberration at the time of forming an image pattern in the image forming lens 144 is reduced.

In addition, an intersection position between the optical axis (imaging view line) 384 of the image forming lens 384 and the image sensing plane may coincide with the central portion in the arrangement area of the respective pixels 271 in the imaging sensor 270. This disposition shows that the optical axis (imaging view line) 384 of the image forming lens 144 passes through the pixel 271 of “a22” located at the center of the imaging sensor 270. When each pixel 271 and the image forming lens 144 are disposed as described above, the image height aberration at the time of forming an image pattern in the image forming lens 144 is reduced.

When a coordinate system (spatial coordinate axis 1805 to 1809) based on the measurer 8 is used, it is easy to set positions of point sets on the measured object 22 (a coordinate value in the spatial coordinate axes 1805 to 1809). As shown in FIG. 23, the spatial coordinate axes 1805 to 1809 regarding the measured object 22 relate to the arrangement status of the pixels 271 in the imaging sensor 270 and the optical axis direction of the image forming lens 144.

The position of the image forming lens 144 may be optimized in the direction of the optical axis (imaging view line) 384 when the present embodiment disposes the measured object 22 at a position away from the measurer 8. And then, the image forming lens 144 may establish a confocal relation between a point “A22” on the measured object 22 and the pixel 271 of “a22”. Therefore, light from the point “A22” on the measured object 22 forms an image pattern on the pixel 271 of “a22”. Similarly, light beams from respective points “A11” to “A33” also form image patterns on the pixels of “a11” to “a33” (a confocal relation is established).

From the optical characteristics of a convex lens configuring the image forming lens 144, all of lights passing through the center point (principal point) “α” of the image forming lens 144 travels straight. Therefore, a positional relationship between the point “A22” and the pixel 271 of “a22” having an image forming (confocal) relationship with each other is a “similarity relationship (symmetry relationship)” centered on the position “α”. Similarly, a positional relationship between each of the points “A11” to “A33” and the corresponding pixels 271 of “all” to “a33” is also a “similarity relationship (symmetry relationship)” centered on the position “α”. And in advance, the present embodiment may decide a distance between the image forming lens 144 and the image sensing plane on which the pixels 271 of “all” to “a33” are arranged. Moreover, the present embodiment may also decide a distance between neighbor pixels 271.

Therefore, when a distance between the two points having the similarity relationship (symmetry relationship) is known, 3D coordinate values of the points “A11” to “A33” on the measured object 22 can be calculated. That is, as the prescribed pixels 271 in the imaging sensor 270 relating to a depth (distance) signal, for example, the present embodiment disposes the pixel 271 of “a22” on the optical axis (imaging view line) 334 of the image forming lens 144. From the above similarity relationship (symmetry relationship), the corresponding point “A22” on the measured object 22 having the image forming relationship (confocal relation) is also located on the optical axis (imaging view line) 334 of the image forming lens 144. And then, the location value on the X-coordinate 1805 and the location value on the Y-coordinate 1807 of the corresponding point “A22” in this case are both “0”. When the distance between the pixel 271 of “a22” and the corresponding point “A22” is known, the location value on the Z-coordinate 1809 of the corresponding point “A22” is determined.

As a method of measuring a distance between two points having a similarity relationship (symmetry relationship), for example, an optical distance measurement method that describes later in Chapter 3 may be used. In addition, the present embodiment is not limited thereto, and measurement may be performed using any method in the present embodiment example. Therefore, for example, the present embodiment may use the above-described “stereo method” or the above-described “laser light distance measurement method” to measure the distance between the measured object 22 and the image sensing plane included in the imaging sensor 270 relating to depth (distance) signal.

In the present embodiment example, the “three-dimensional projective reverse transformation method” has the following procedure:
(α) an imaging sensor 270 relating to a depth (distance) signal having a plurality of pixels 271 is used;
(β) the image forming lens 144 is disposed between an object (measured object 22) having a three-dimensional shape and the imaging sensor 270 relating to a depth (distance) signal;
(γ) by using distance information between a prescribed pixel in the imaging sensor 270 relating to a depth (distance) signal and a corresponding point of the object (measured object 22);
(δ) three-dimensional position information of the corresponding point of the object (measured object 22) is generated; and
(ε) a three-dimensional shape viewed from all directions of the object is generated using the three-dimensional position information of each of a plurality of points.

According to the above (γ), for example, the prescribed pixel in the imaging sensor 270 relating to a depth (distance) signal may be selected as the pixel 271 of “a22” shown in FIG. 23. And then, the corresponding point of the object (measured object 22) equals to the corresponding point “A22”. A distance information collection method in the above (γ) will be described in detail later in Chapter 3. And for the “generation of position information of the corresponding point” in the above (δ), the present embodiment may define the coordinate system (X-axis 1805, Y-axis 1807, and Z-axis 1809) based on the position and the direction (the orientation) of the measurer 8. In other words, the coordinate system (X-axis 1805, Y-axis 1807, and Z-axis 1809) may relate to a position and an orientation of the image forming lens 144 or relate to pixels 271 in the imaging sensor 270 relating to depth (distance) signal.

Note that a three-dimensional shape of an object (measured object 22) as a target in the “three-dimensional projective reverse transformation method” described in the present embodiment example does not necessarily need to be stand still. The object (measured object 22) may move while the three-dimensional shape is fixed. Furthermore, the three-dimensional shape may change over time. For example, the imaging sensor relating to a depth (distance) signal may capture an image of an animal including a human as a “movie” and sequentially generate a three-dimensional shape for each motion.

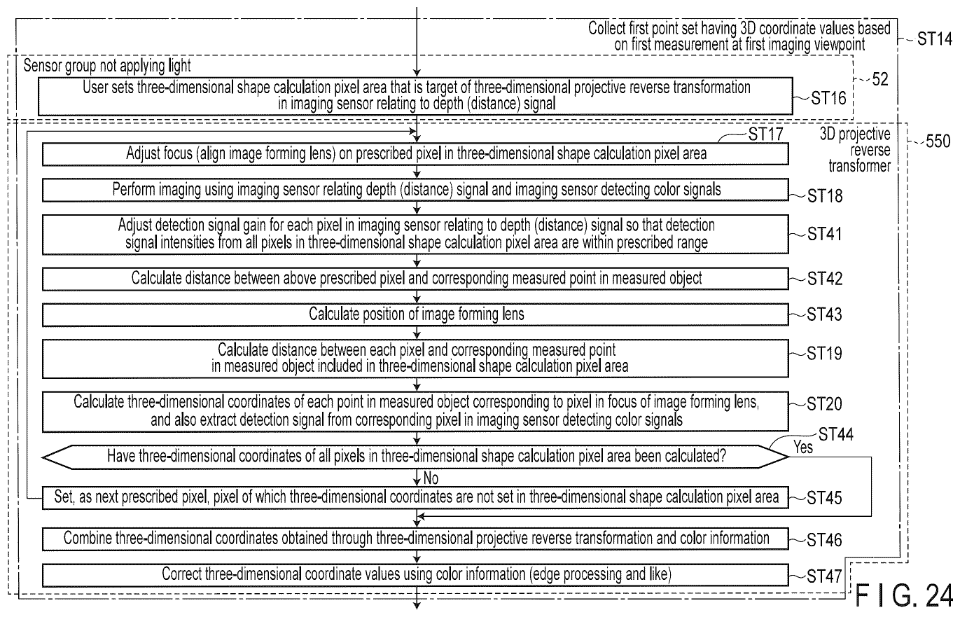

FIG. 24 illustrates a specific procedure example relating to the three-dimensional projective reverse transformation in the present embodiment. FIG. 23 showed the fundamental concept of the “three-dimensional projective reverse transformation”. Moreover, as shown in FIG. 8, the 3D projective reverse transformer 550 may achieve a series of operations regarding the “three-dimensional projective reverse transformation”. The present embodiment may display two planar images (user's left eye image and user's right eye image) obtained from the “three-dimensional projective transformation” after the 3D projective reverse transformer 550 forms three-dimensional shapes (or three-dimensional movie). In this case, FIG. 20 includes the “three-dimensional projective reverse transformation” in earlier operations. Therefore, the procedure example relating to the three-dimensional projective reverse transformation shows below while describing a relationship with the procedure of the three-dimensional projective transformation already described in FIG. 20.

In steps 14 and 15 in FIG. 20, the 3D projective reverse transformer 550 performs “first and second point sets having 3D coordinate values based on first and second measurements at first and second imaging positions”. As illustrated in FIG. 8, the 3D projective reverse transformer 550 executes a specific procedure example related to the three-dimensional projective reverse transformation. Therefore, the output result of “starting of three-dimensional image (movie) collection and three-dimensional display” in step 13 performed by the measurer 8 in FIG. 20 is a starting point of the arrow toward step 16 in FIG. 24.

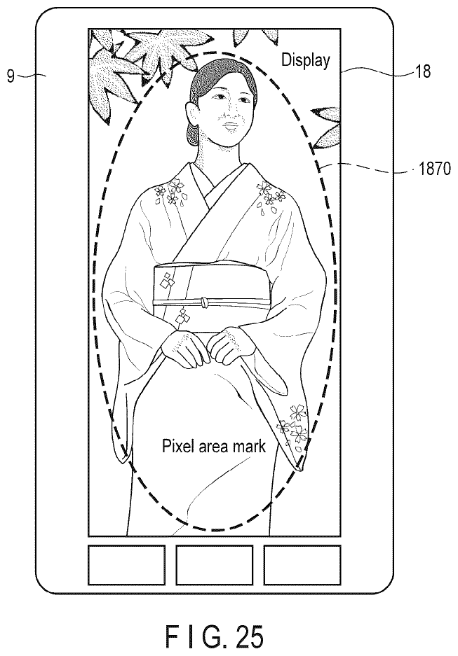

As a specific procedure example related to the three-dimensional projective reverse transformation in the present embodiment, first, as illustrated in step 16, the user sets a three-dimensional shape calculation pixel area that is a target of the three-dimensional projective reverse transformation in the imaging sensor 270 relating to a depth (distance) signal. As will be described later with reference to FIG. 25, the user can set the three-dimensional shape calculation pixel area using a very simple method. In the description using FIG. 23, the method of performing the three-dimensional projective reverse transformation on all the pixels 271 in the imaging sensor 270 relating to a depth (distance) signal has been exemplified. However, when the pixel 271 in the imaging sensor that is a target of the three-dimensional projective reverse transformation is selected from among all the pixels 271 in the imaging sensor 270 relating to a depth (distance) signal, the processing can be simplified and the processing time can be shortened.

For example, there is a case where it is desired to extract only a three-dimensional shape of an object at the time of imaging the object (measured object 22). As the present embodiment, the user may designate “three-dimensional shape calculation limited to the object”. In this case, it may be determined whether or not a result of “calculation of a distance to the imaged object performed for each pixel 271 in the imaging sensor 270 relating to a depth (distance) signal” that will be described later in step 19 is used to be suitable for “the pixels 271 involved in calculation of a three-dimensional shape of the object in the imaging sensor 270 relating to a depth (distance) signal”. When the three-dimensional shape is calculated only for the necessary pixel 271 using the determination result, the processing can be simplified and the entire processing time can be shortened.

In the next step 17, the image forming lens 144 is moved in the direction of its optical axis (imaging view line) 384 to perform focus adjustment on a prescribed pixel in the three-dimensional shape calculation pixel area. For example, the location value on the Z-coordinate greatly differs between two different points “A32” and “A12” on the measured object 22. As described above, it is difficult to simultaneously focus on two points between which the location value on the Z-coordinate greatly differs with respect to the image sensing plane of the imaging sensor 270 relating to a depth (distance) signal. Therefore, the 3D projective reverse transformer 550 controls the measurer 8 so that only the specific pixel (prescribed pixel) 271 in the three-dimensional shape calculation pixel area is in focus. For example, according to FIG. 23, the 3D projective reverse transformer 550 may control the image forming lens 144 to focus on the pixel 271 of “a22” that is located on the optical axis 384 of the image forming lens 144. And the 3D projective reverse transformer 550 controls the measurer 8 such that the imaging sensor 270 relating to a depth (distance) signal and the imaging sensor 280 detecting color signals perform imaging (ST18).

The content of “adjustment of a detection signal gain for each pixel in the imaging sensor 270 relating to a depth (distance) signal so that detection signal intensities from all pixels in the three-dimensional shape calculation pixel area are within a prescribed range” performed in the subsequent step 41.

As described above, in the present embodiment example, each pixel 271 in the imaging sensor 270 relating to a depth (distance) signal repeatedly receives light N times for each different detection phase (or for each different light emission phase). A charge value (charge accumulation value) accumulated during the integration time corresponding to N times differs for each detection phase (or for each different light emission phase) and each pixel 271. The signal gain controller 558 (FIG. 8) monitors a change in the charge accumulation values different for each detection phase (or for each different light emission phase) and for each pixel 271 to optimize the charge accumulation values.

For example, in a case where the “charge accumulation value” obtained from the specific pixel 271 in the imaging sensor 270 relating to a depth (distance) signal is too small, the signal gain controller 558 increases the gain of the signal. On the other hand, in a case where the “charge accumulation value” obtained from another pixel 271 is too large and nearly saturated, the signal gain controller 558 decreases the gain of the signal.

For example, a situation in which the imaged object (measured object 22) is “configured with both of a metal area having extremely high reflectivity to irradiated light (first light) 13 and a black area absorbing the irradiated light (first light) 13” also occurs. In this case, a plurality of times of imaging in which either a “light intensity of the irradiated light (first light) 13” or an “integration time” is changed may be repeated.

That is, for the “metal area having extremely high reflectivity”, the light intensity of the irradiated light (first light) 13 is reduced or the “integration time” is reduced. As a result, signal saturation related to “charge accumulation values” can be prevented. On the other hand, for the “light absorption area”, the light intensity of the irradiated light (first light) 13 is increased or the “integration time” is increased. As a result, a signal value related to the “charge accumulation values” can be optimized.

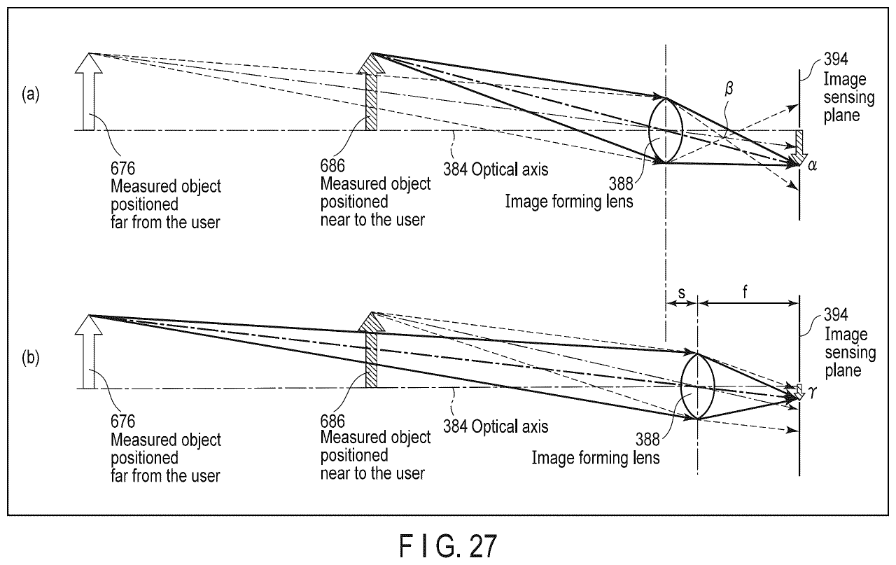

At the stage at which the charge accumulation values are optimized, a distance to the measured point on the measured object (the corresponding point “A22” or the like) corresponding to the prescribed pixel (for example, the pixel 271 of “a22” disposed on the optical axis 384 of the image forming lens 144) is calculated (ST42). And then, a position of the image forming lens 144 is calculated using the calculated distance information (ST43). Note that a method of calculating a position of the image forming lens 144 is described later with reference to FIG. 27.

As the prescribed pixel 271 used to calculate a position of the image forming lens 144, any pixel 271 in the three-dimensional shape calculation pixel area may be selected. However, the spherical aberration of the image forming lens 144 is the smallest at the pixel position “a22” on the optical axis 384 of the image forming lens 144. Therefore, when the pixel 271 of “a22” located on the optical axis 384 of the image forming lens 144 is used, not only the position calculation of the image forming lens 144 is easy, but also the calculation accuracy is improved.

In step 19, “individual distances between all the pixels (for example, from “all” to “a33”) in the three-dimensional shape calculation pixel area and corresponding points on the measured object 22 (for example, from “A11” to “A33”)” are calculated using the calculated position information of the image forming lens 144. Next, “three-dimensional coordinates of points on the measured object (for example, from “A11” to “A33”) are calculated” using the distance information, and “extraction of color information of “a pixel in the imaging sensor 280 detecting color signals” disposed at a position corresponding to the “position of the pixel 271 in focus in the imaging sensor 270 relating to a depth (distance) signal”” is performed (ST20).

In other words regarding a series of operations mentioned above, the three-dimensional projective reverse transformation method may comprise the following operations:
a) obtaining a series of measured signals from a series of pixels included in an imaging sensor 270;
b) estimating first distance between a first pixel (for example, the prescribed pixel 271 of “a22” located on the optical axis 384 of the image forming lens 144) in the plural pixels 271 in the imaging sensor 270 and a first corresponding measured point (for example, the corresponding point “A22” located on the optical axis 384 of the image forming lens 144) included in the measured object 22;
c) based on the first distance estimated above, estimating second distance between a second pixel 271 included in the plural pixels in the imaging sensor 270 and a second corresponding measured point included in the measured object 22; and
d) forming three-dimensional position information on the second measured point.

In step 20, the 3D projective reverse transformer 550 may select the pixel 271 in the three-dimensional shape calculation pixel area in focus. As a result of step 19, the individual distances to the corresponding points in the measured object 22 with respect to all the pixels in the three-dimensional shape calculation pixel area are already known. The position of the image forming lens 144 is known from the calculation result in step 43. In comparison each of the distances between the pixels 271 and the corresponding points in the measured object 22 with the position information of the image forming lens 144, the 3D projective reverse transformer 550 distinguishes whether or not each of the pixels 271 included in the three-dimensional shape calculation pixel area is in focus. And then, the 3D projective reverse transformer 550 may perform the “calculation of three-dimensional coordinates of the corresponding points on the measured object 22” only on the pixel 271 in focus of the image forming lens 144.

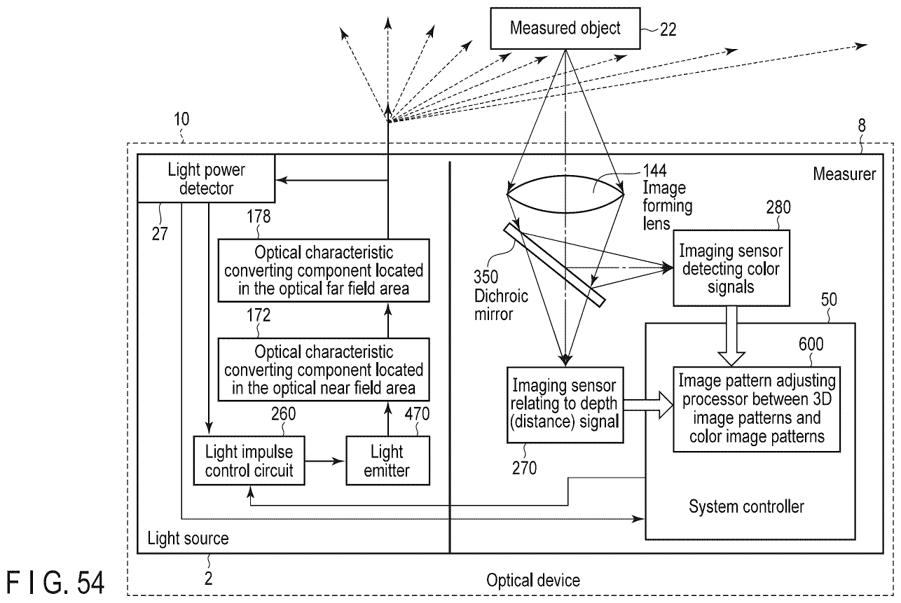

As shown later in FIGS. 54, 55, and 137, in the measurer 8, the present embodiment may take an optical system example in which the same image forming lens 144 is used to form an image pattern on each image sensing plane of the imaging sensor 270 relating to a depth (distance) signal and the imaging sensor 280 detecting color signals. And using the optical system example, the processing in step 20 is described below. In a case where the optical system example is employed inside the measurer 8, a positional relationship of each pixel 271 in the imaging sensor 270 relating to a depth (distance) signal corresponds to a positional relationship of each pixel in the imaging sensor 280 detecting color signals.

Therefore, when the pixel 271 in focus in the imaging sensor 270 relating to a depth (distance) signal is known, a pixel in focus in the imaging sensor 280 detecting color signals can be selected accordingly. Only a detection signal (color information) obtained from the selected pixel in the imaging sensor 280 detecting color signals is selected and extracted. When the processing limited to the pixel 271 in focus is performed as described above, unnecessary processing can be omitted, so that the overall processing time can be shortened.

For example, there is a case where it is desired to extract only a three-dimensional shape of a prescribed object (the measured object 22). When the three-dimensional shape of only the object (the measured object 22) is extracted as described above, the user easily creates combination shapes with another background shape (the combination between the extracted three-dimensional shape and another background shape). Alternatively, in a case where it is desired to move the object (the measured object 22) in combination with the 3D model created by the “3D model creation and modification area (3D models having prescribed sizes) 930”, post-processing becomes easy.

As an example of a method of extracting only the three-dimensional shape of the object, in the present embodiment, the background area of the object (the measured object 22) may be excluded from the three-dimensional shape calculation pixel area. Using the result of the calculation of the distance to the imaged object (ST19) performed for each pixel 271 in the imaging sensor 270 relating to a depth (distance) signal, it is possible to distinguish between the pixel 271 on which an image pattern (the three-dimensional shape) of a part of the object (measured object 22) is formed (in a confocal relation) and the other pixels (such as the background and a light shield object near the imaging sensor 270 relating to a depth (distance) signal).

Using the classification result, the 3D projective reverse transformer 550 may set and add identification information in the distance information or the three-dimensional coordinate information regarding the measured object 22. For example of the identification information, the 3D projective reverse transformer 550 may set and add “0” to a value of the calculated distance for the corresponding pixel 271 that is not involved in the three-dimensional shape. If the correspondence processing is performed on only the pixels 271 that are not involved in the calculation of the three-dimensional shape of the object, unnecessary processing can be omitted. As a result, the overall processing time can be shortened.

In step 44, the 3D projective reverse transformer 550 may determine “whether or not three-dimensional coordinates are calculated in all the pixels in the three-dimensional shape calculation pixel area” after the processing of step 20. As described above, three-dimensional coordinates are calculated only for the pixel 271 in focus by the image forming lens 144. Therefore, when the above determination in step 44 is performed, it is possible to determine the presence or absence of a pixel out of focus.

In a case where it is difficult to simultaneously focus on all the positions on the surface of the measured object 22, only a specific position is focused as described above. From the determination result in step 44, the pixels 271 out of focus by the image forming lens 144 are extracted (ST45).

It is necessary to further move the image forming lens 144 to bring the pixel 271 out of focus by the image forming lens 144 into focus. This processing corresponds to a combination of the processing of “setting the pixel 271 out of focus to the next prescribed pixel” in step 45 and the “realignment of the image forming lens 144” in step 17.

In the description of [Technical Problem] in the first part of the present patent specification, the description said “it is difficult for a human to focus on a near object and a distant object at the same time”. Therefore, a user desires that “beyond the function of human eyes, three-dimensional display is able to show a clear image in focus on both a near object and a distant object”. On the other hand, as described above, alignment (focus adjustment) of the image forming lens 144 may be performed a plurality of times, and only a clear image in focus may be selected. As a result, it is possible to provide a clear image in focus on both a near object and a distant object to a user at the same time. Furthermore, if two types of clear images are prepared for the left side eye and the right side eye, perspective using the convergence angle can be provided to the user.

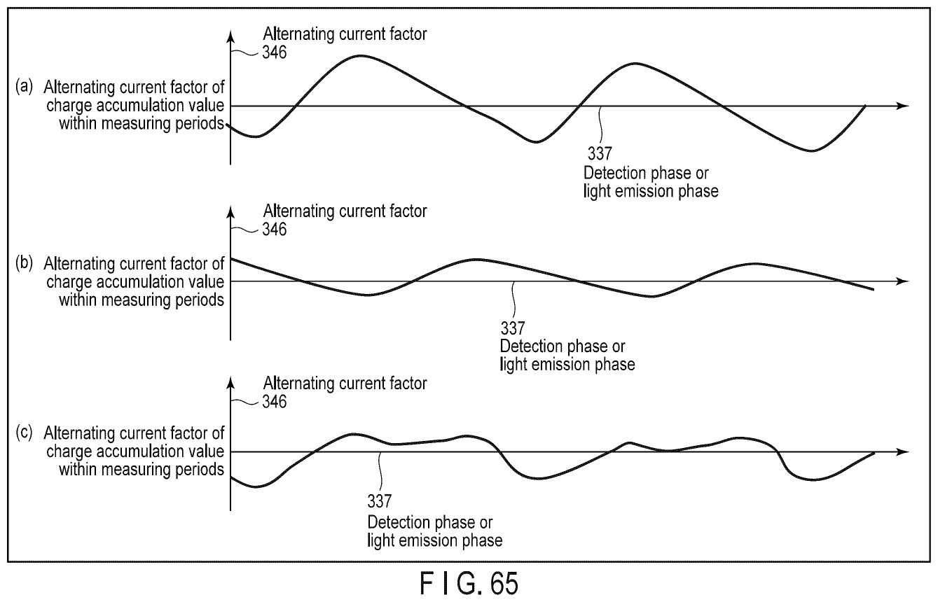

At the stage at which clear image information (in focus) is obtained for all the pixels 271 in the three-dimensional shape calculation pixel area, the 3D coordinate values and the color information related to the corresponding points “A11” to “A33” on the measured object 22 are combined (ST46). Using the information collected from the pixels in the imaging sensor 280 detecting color signals having a higher spatial resolution, the 3D projective reverse transformer 550 may perform 3D coordinate values correction (such as edge processing) in step 47. The processing in step 47 is to be described later with reference to FIGS. 65 to 68. After the processing in step 47 in FIG. 24 is completed, the process returns to step 15 or step 21 in FIG. 20.

FIG. 25 illustrates an example of the three-dimensional shape calculation pixel area setting method corresponding to step 16 in FIG. 24. In a case where the optical device 10 takes the form of the removable data processing device 9, most of the front surface often configures the display 18. In addition, the front surface of the display 18 has a touch panel function, and a location in the display 18 touched by a user can be detected.

The display 18 also includes a plurality of pixels 271. In a case where an imaged screen that is imaged by the measurer 8 is displayed, a detection signal of each pixel 271 in the imaging sensor is individually displayed on a corresponding pixel 271 in the display 18. Therefore, when the user designates a “designated pixel area mark in the display 1870” on the display 18, a corresponding pixel 271 in the imaging sensor 270 relating to a depth (distance) signal can be set.

Further, the user designates the “designated pixel area mark in the display 1870” to correspond to a “three-dimensional shape calculation image area”. As described above, the user can set the “three-dimensional shape calculation image area in the imaging sensor 270 relating to a depth (distance) signal” very easily.

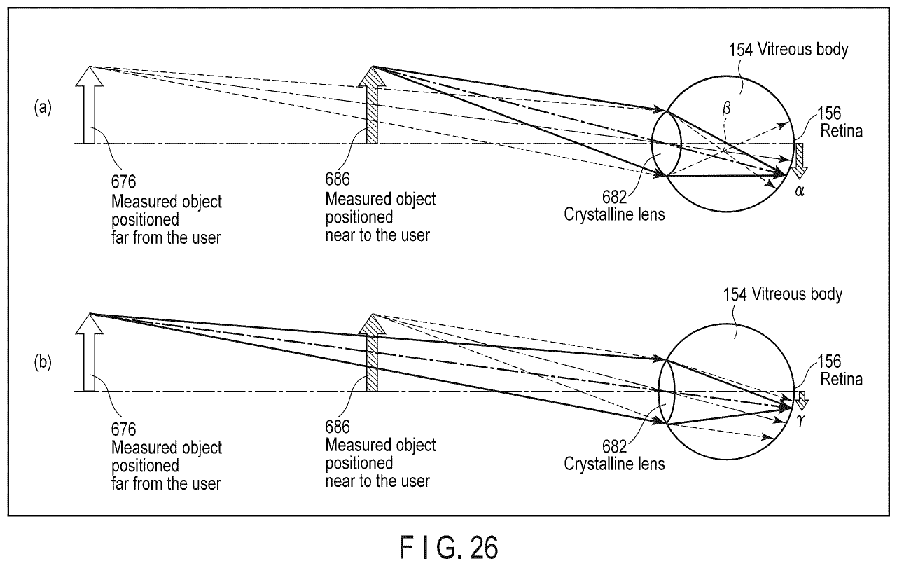

FIG. 26 is an explanatory diagram of a focusing mechanism when human eyes look at a distant object or a near object. FIG. 26 (a) illustrates eye motion when a user views a measured object 686 positioned near to the user. FIG. 26 (b) illustrates eye motion when the user views a measured object 676 such as a picture positioned far from the user. Due to the lens action of the crystalline lens 682, an image pattern of the object to be viewed is formed on the retina 156. Herein, the position of the center point (principal point) of the crystalline lens 682 having the lens action corresponds to the position of the eye.

As shown in FIG. 26 (a), the thickness of the crystalline lens 682 increases when a human looks at the near measured object 686 positioned near to the human (the user). An image pattern of the near measured object 686 positioned near to the human (the user) is formed at the “point α” on the retina 156. In this case, light emitted from one point in the measured object (picture) 676 positioned far from the user converges at the “point β” in the vitreous body 154. The light converging at the “point β” spreads on the surface of the retina 156. As a result, a defocused image of the measured object (picture) 676 positioned far from the user is captured on the retina 156. That is, when a human sees the near measured object 686, a clear image cannot be obtained for the measured object (picture) 676 positioned far from the human (the user).

As shown in FIG. 26 (b), the thickness of the crystalline lens 682 decreases when a human sees the distant measured object (picture) 676 positioned far from the human (the user). An image pattern of the distant measured object (picture) 676 positioned far from the human (the user) is formed at the “point γ” on the retina 156. In this case, light emitted from a point in the measured object 686 positioned near to the human does not converge on the surface of the retina 156 but arrives at the retina 156 in a spread state. As a result, an image in which a focal position of the near measured object 686 positioned near to the human (the user) is shifted is captured on the retina 156. That is, when a human sees the distant measured object (picture) 676 positioned far from the human (the user), a clear image for the near measured object 686 cannot be obtained.

From the above principle, a human cannot simultaneously obtain clear images from different near and distant objects. On the contrary, detailed three-dimensional shape information over the entire area (including both an area positioned far from the human and an area positioned near to the human) can be acquired “beyond human eyes” when the 3D projective reverse transformer 550 makes a “comparison between separately acquired clear images for near and distant objects” with reference to FIG. 24.

FIG. 27 is an explanatory diagram of the principle of focusing in the measurer 8 compared with human eyes. FIG. 27 illustrates an example of a measurement method using the imaging sensors 270 and 280. The image sensing planes 394 of the imaging sensors 270 and 280 correspond to the human retina 156 described above. Furthermore, many pixels 271 are two-dimensionally arranged on the image sensing plane 394. The human crystalline lens 682 corresponds to the image forming lens 388. As described above, the present embodiment example shows the similar structure in the measurer 8 to the structure in human eyes. Therefore, image information obtained from the measurer 8 having the above structure is close to the visual field of human eyes, and congeniality between the structures in the measurer 8 and in the human eyes is good.

The principal point position of the image forming lens 388 corresponds to the position of the crystalline lens 682. In the case where the image forming lens 388 is a thick lens having a large thickness, the image forming lens 388 has two points such as a forward principal point and a backward principal point. In the image forming lens 388, both the forward principal point and the backward principal point exist on the optical axis (imaging view line) 384 of the image forming lens. In the present embodiment example, for convenience of description, the description will be given assuming that the forward principal point and the backward principal point exist at the same location.

According to the present embodiment example, the image forming lens system 388 may be configured with a combination of a plurality of lenses. When a distance between the constituent lenses in the image forming lens system 388 is changed, a focal length of the image forming lens system 388 varies. And the focal length variation in the image forming lens system 388 actually corresponds to the thickness variation of the crystalline lens 682.

However, even if this “focal length variable lens” is used as the image forming lens 388, “simultaneous focusing” on the measured objects 22 disposed at different far and near positions is not possible within a period in which a distance between the plurality of constituent lenses is fixed. In addition, the “focal length variable lens” has lower image definition and spatial resolution than the image resolution of a “fixed focus lens”. Therefore, the following present embodiment example may use a “fixed focus lens” as the image forming lens 388.

The “fixed focus lens” used as the image forming lens 388 may be configured by a combination of a plurality of lenses in which mutual lenses are fixed. However, in order to simplify subsequent illustration as the present embodiment example, the image forming lens 388 may represent a single lens. Here, the focal length of the image forming lens 388 represents “f”.

In focusing in a case where the “fixed focus lens” is used as the image forming lens 388, the image forming lens 388 is movable in a direction along the optical axis (imaging view line) 384 of the image forming lens. In FIG. 27 (a), the position of the image forming lens 388 is shifted backward by “s” with respect to the image sensing planes 394 of the imaging sensors 270 and 280 compared with that in FIG. 27 (b).

FIG. 27 (b) illustrates a state in which an image pattern of the distant measured object 676 such as a picture positioned far from the user is formed at the position of the “point γ” on the image sensing planes 394 of the imaging sensors 270 and 280. Therefore, the image sensing plane 394 (each pixel 271 two-dimensionally arranged thereon) can output a clear image related to the distant measured object 676 such as a picture positioned far from the user. Here, the light from the surface of the near measured object 686 positioned near to the user becomes light spreading on the image sensing plane 394. Therefore, a focal position with respect to the near measured object 686 positioned near to the user is shifted from the image sensing plane 394, and a hazy image pattern with respect to the near measured object 686 positioned near to the user is obtained on the image sensing plane 394.

FIG. 27 (a) illustrates a state in which an image pattern of the near measured object 686 positioned near to the user is formed at the position of the “point α” on the image sensing plane 394 of each of the imaging sensors 270 and 280. Therefore, the image sensing plane 394 (each pixel 271 two-dimensionally arranged thereon) can output a clear image regarding the near measured object 686 positioned near to the user. Furthermore, in this case, light from the surface of the distant measured object 676 such as a picture positioned far from the user converges at the position of the “point β” in the front side area of the image sensing plane 394. The light converging at the “point β” arrives on the image sensing plane 394 as spread light. Therefore, a focal position with respect to the distant measured object 676 positioned far from the user is shifted from the image sensing plane 394, and a hazy image pattern with respect to the distant measured object 676 positioned far from the user is obtained on the image sensing plane 394.

As shown in FIG. 27 (b), a distance between the image pattern forming plane 394 and the principal point (strictly, the backward principal point) of the image forming lens 388 equals to “f” when the distant measured object 676 is disposed at a position far away from the focal length “f” of the image forming lens 388.

According to FIG. 27 (a), the near measured object 686 closer than the distant measured object 676 is disposed at a position closer to the image forming lens 388. Therefore, in order to control light emitted from the near measured object 686 to form an image pattern on the image sensing plane 394, it is necessary to move the image forming lens 388 (the position of the backward principal point) to a position away from the image sensing plane 394 by the distance “s” in the direction of the optical axis 384.

FIG. 28 is an explanatory diagram illustrating an example of a method of calculating a position “f+s” of the image forming lens 388 and each coordinate value of X-axis 1805, Y-axis 1807, and Z-axis 1809 when the image forming lens 388 forms an image pattern of the measured object 676 or 686 on the image sensing plane 394 (when the image forming lens 388 sets a confocal position relation). Note that the 3D projective reverse transformer 550 may achieve this calculation in steps 43 and 20 of FIG. 24.

As described with reference to FIG. 27, in order to form an image pattern on the image sensing planes 394 of the imaging sensors 270 and 280, it is necessary to move the position of the image forming lens 388 in accordance with the position of the measured object 22 (676 or 686). An example of a moving mechanism 540 of an image forming lens 388 may be a general camera lens holder that holds the image forming lens 388, and the general camera lens holder has a structure in which a dial (rotation ring) outside the lens holder is manually rotated. In addition, the position sensor 552 of the image forming lens 388 is often configured such that a rotation angle of the dial (rotation ring) can be checked with a scale.

In addition, the present invention is not limited thereto, and, as the moving mechanism 540 of an image forming lens 388, for example, a mechanism that moves with high accuracy using a stepping motor or the like may be employed. In addition, an optical detection method or an electrical detection method using a change in capacitance may be used for position detection in the position sensor 552 of an image forming lens 388.

As a method of focusing on the measured objects 676 or 686, for example, a location where the definition (or the resolution) of a captured image obtained from the imaging sensors 270 and 280 is maximized may be found while the image forming lens 388 is moved using the moving mechanism 540. In this case, the captured image may be displayed on the display 18, and the user may visually set the optimum position of the image forming lens 388.

The present invention is not limited thereto, and, as another method, a position of the image forming lens 388 when the degree of modulation of a captured image signal is maximized may be found. As an example of use of the captured image signal, a prescribed pixel 271 may be selected from among the plurality of pixels 271 two-dimensionally arranged and configuring the image sensing plane 394 of the imaging sensors 270 and 280, and a location where the degree of modulation of an image signal obtained from an area including neighboring pixels of the prescribed pixel 271 is maximized may be found.

When processing is performed by paying attention to the vicinity of the prescribed pixel 271 as described above, it is possible to focus on a point (for example, the “point A22” shown in FIG. 23) on the measured objects 676 and 686 corresponding to the prescribed pixel (for example, “a22” shown in FIG. 23). When the repetitive processing in steps 44 and 17 in FIG. 24 is performed, different pixels 271 as different prescribed pixels may be set a plurality of times. Among them, the pixel 271 of “a22” disposed on the optical axis (imaging view line) 384 of the image forming lens 144 (388) may be especially set to a “prescribed pixel to be set first”. With this setting, subsequent processing can be simplified.

FIG. 28 (a) illustrates a state in which an image pattern of the near measured object 686 is formed on the image sensing plane 394 (that is, the near measured object 686 positioned near to the user and the image sensing plane 394 have a confocal relation). FIG. 28 (b) illustrates a state in which an image pattern of the distant measured object 676 positioned far from the user is formed on the image sensing plane 394 (that is, the distant 676 positioned far from the user and the image sensing plane 394 have a confocal relation).

The present embodiment describes a method of calculating the distance “f+s” (the state in FIG. 28 (a) corresponds to “f+sa”, and the state in FIG. 28 (b) corresponds to “f+sb”) from the distance “Z” (the state in FIG. 28 (a) corresponds to “Za”, and the state in FIG. 28 (b) corresponds to “Zb”). Here, a focal length of the image forming lens 388 represents “f”. And “f+s” indicates a distance between the image forming lens 388 and the image sensing plane 394, and “Z” indicates a distance between the measured object 676 or 686 and the image sensing plane 394.

In both cases of FIG. 28 (a) and FIG. 28 (b), from the image forming formula of the lens, the following relationship is obtained.

$$[ Equation 1 ]$$

$$\frac{1}{f} = \frac{1}{f + s} + \frac{1}{Z - ( f + s )} = \frac{Z}{( f + s ) ( Z - f - s )} \qquad Equation 1$$

Further, when this Equation 1 is modified,

$$[ Equation 2 ]$$

$$2 s = ( Z - 2 f ) - \sqrt{{( Z - 2 f )}^{2} - 4 {f}^{2}} \qquad Equation 2$$

is obtained.

When the distance “Z” from the measured objects 676 and 686 to the image sensing plane 394 is known as described above, the position “f+s” of the image forming lens can be calculated. Further, when the position “f+s” of the image forming lens 388 calculated using Equation 2 and an output signal from the position sensor 552 of an image forming lens 388 are used, a position of the image forming lens 388 can be calculated with high accuracy.

As illustrated in FIG. 23, the image sensing plane 394 in the imaging sensor 270 relating to a depth (distance) signal has a configuration in which a plurality of pixels 271 are two-dimensionally arranged. Here, FIG. 23 shows that the prescribed pixel 271 of “a22” is disposed on the optical axis (imaging view line) 384 of the image forming lens 388. Therefore, the size of each pixel 271 is entirely uniform. Therefore, a distance “u” from the optical axis (imaging view line) 384 of the image forming lens 388 on the image sensing plane 394 can be known from the number of pixels 271 shifted from the prescribed pixel 271 of “a22”.

Here, in consideration of the influence of different positions of the measured objects 676 and 686, the distance “u” in the state in FIG. 28 (a) corresponds to “ua”. The distance “u” in the state in FIG. 28 (b) corresponds to “ub”. In FIG. 28 (a), the center position of the pixel 271 disposed at a position shifted by the distance “ua” from the optical axis (imaging view line) 384 of the image forming lens 388 on the image sensing plate 394 is designated as a “point α”. Similarly, in FIG. 28 (b), the center position of the pixel 271 disposed at a position shifted by the distance “ub” from the optical axis (imaging view line) 384 of the image forming lens 388 on the image sensing plane 394 is designated as a “point γ”.

The position of the principal point (strictly, the backward principal point) of the center of the image forming lens 388 is represented by a “point ε”. An angle between a “straight line “α” from the “point ε” toward the “point α” and the optical axis (imaging view line) 384 of the image forming lens 388 is set to “θa”. Similarly, an angle between the “straight line εγ” from the “point ε” toward the “point γ” and the optical axis (imaging view line) 384 of the image forming lens 388 is set to “θb”. The angles “θa” and “θb” will be collectively referred to as “θ”. This angle “θ” is expressed by the following relational formula.

$$[ Equation 3 ]$$

$$⊖ = {tan}^{- 1} ( \frac{u}{f + s} ) \qquad Equation 3$$

With respect to the “point α” on the image sensing plane 394 in the imaging sensor 270 relating to a depth (distance) signal, a confocal position via the image forming lens 388 (that is, a starting position of light that converges at the image forming position of the “point α”) is set to a “point ζ”. “Xa” represents a height from the “point σ” on the optical axis (imaging view line) 384 of the image forming lens 388 to the “point ζ”. According to the characteristic of a light beam passing through the image forming lens 388, light that has exited from the “point ζ” and passed through the principal “point ε” in the image forming lens 388 (strictly, the forward principal point) travels straight and arrives at the “point α”. Therefore, a “triangle ζσε” and a “triangle αoε” have a similar relationship with each other.

Similarly, with respect to the “point γ” on the image sensing plane 394, a confocal position via the image forming lens 388 (that is, a starting position of light that converges at the image forming position of the “point γ”) is set to a “point η”. “Xb” represents a height from the “point ρ” on the main axis (imaging view line) 384 of the image forming lens 388 to the “point η”. According to the characteristic of a light beam passing through the image forming lens 388, light that has exited from the “point η” and passed through the principal “point ε” in the image forming lens 388 (strictly, the forward principal point) travels straight and arrives at the “point γ”. Therefore, a “triangle ηρε” and a “triangle γoε” have a similar relationship with each other.

The heights “Xa” and “Xb” from the optical axis (imaging view line) 384 of the image forming lens 388 are collectively referred to as “X”. The following relationship is established from the similar relationship between “X” and “u”.

$$[ Equation 4 ]$$

$$X = \frac{Z - ( f + s )}{f + s} u = \frac{Z}{f + s} u - u \qquad Equation 4$$

A relationship between the location value “Y” on the Y-axis of coordinate 1807 relating to the measured object 22 and a corresponding coordinate value “v” on the image sensing plane 394 also has the same relationship as in Equation 4. That is, “v” is substituted at the position of “u” in Equation 4. When the position of “X” in Equation 4 is replaced with “Y”, a relationship between “Y” and “v” is derived.

For example, when the distances “Z” (“Zb” and “Za”) between the measured objects 676 and 686 and the image sensing plane 394 are measured using an optical distance measurement method that is described later in Chapter 3, a linear distance from the “point η” or the “point ζ” on the measured objects 676 and 686 may be obtained as a measurement result. In this case, the height “X” is calculated from the measurement result. When the linear distances from the “point η” or the “point ζ” in the measured objects 676 and 686 to the corresponding image forming point (confocal position) “point γ” or “point α” on the image sensing plane 394 are collectively represented by “L”, the following relational formula is established.

$$[ Equation 5 ]$$

$$Z = L cos θ \qquad Equation 5$$

Therefore, an embodiment example is assumed in which the measurer 8 measures the linear distance “L” of light reaching the pixel 271 disposed at the position “u” on the image sensing plane 394 in the imaging sensor 270 relating to a depth (distance) signal.

However, even in this case, “L=Z” is satisfied only for the linear distance of the light reaching the prescribed pixel 271 of “a22” disposed on the optical axis (imaging view line) 384 of the image forming lens 388. Therefore, even in a case where an optical distance measurement method that is described later in Chapter 3 is used, if the linear distance “Z” of light passing along the optical axis (imaging view line) 384 of the image forming lens 388 is substituted into Equation 2, the position “s” of the image forming lens 388 can be calculated first.

Next, the linear distance “L” of light arriving at the pixel 271 disposed at a position of “u≠0” is measured. The measurement result and the value of “θ” calculated using Equation 3 are substituted into Equation 5, and a corresponding value of “Z” is calculated. In the present embodiment example, importance is put on the three-dimensional shape measurement of the measured objects 676 and 686. Therefore, as illustrated in FIG. 23, the 3D projective reverse transformer 550 may obtain (calculate) different values of “Z” (location values on the Z-coordinate along the Z-axis of coordinate 1809) corresponding to the different pixels 271 positioned at “u≠0” or “v≠0” on the image sensing plane 394.

When the “Z” value corresponding to each of the different pixels 271 is substituted into Equation 4, an “X” value at a corresponding point on the measured objects 676 and 686 can be calculated. In FIG. 28, for convenience of description, only a “location value on the X-coordinate” corresponding to a “u-axis direction” in the pixels 271 two-dimensionally arranged on the image sensing plane 394 is illustrated. However, the present invention is not limited thereto, and a “location value on the Y-coordinate” corresponding to a “v-axis direction” in the pixel 271 can also be calculated through similar calculation.

The “three-dimensional projective reverse transformation method” in the present embodiment example has already been described with reference to FIG. 23. Here, supplementary description of the exemplified content is made based on the above description content.

(α) On the image sensing plane 394 of the imaging sensor 270 relating to a depth (distance) signal, a plurality of different pixels are two-dimensionally arranged in the u-axis direction and the v-axis direction.

(β) The user optimizes the position of the image forming lens 388 (144) along the optical axis direction 384, so that the prescribed pixel 271 of “a22” and the corresponding point “A22” in the measured object 22 keep a confocal relation (the prescribed pixel 271 of “a22” is an image forming point of the corresponding point “A22”). Herein, the prescribed pixel 271 of “a22” is located at the intersection point between the optical axis 384 of the image forming lens 388 (144) and the image sensing plane 394, and the corresponding point “A22” in the measured object 22 also is located on the optical axis 384 of the image forming lens 388 (144).

(γ) The 3D projective reverse transformer 550 calculates the distance “Z” between the prescribed pixel “a22” and the corresponding point “A22” included in the measured object 676 or 686. And then, using Equation 2, the 3D projective reverse transformer 550 calculates the position “s” of the image forming lens 388.

(δ) The 3D projective reverse transformer 550 calculates the distance “L” (or “Z”) between each of the rest of different pixels “a11 to a33” in the image sensing plane 394 and each of the corresponding points “A11 to A33” included in the measured object 22. Herein, both the rest of different pixels “all to a33” and the corresponding points “A11 to A33” are respectively located out of the optical axis 384 of the image forming lens 388. And the 3D projective reverse transformer 550 may use an optical distance measurement (or calculation) method example described later in Chapter 3.

(ε) Using a “location value on the u-coordinate” and a “location value on the v-coordinate” for each pixel 271 in the image sensing plane 394, the focal length information of the image forming lens 388, the position information “s value” of the image forming lens 388, and distance information obtained from [γ], the 3D projective reverse transformer 550 calculates 3D coordinate values (coordinate values along the X-axis of coordinate 1805, the Y-axis of coordinate 1807, and the Z-axis of coordinate 1809) for each of the corresponding points “A11 to A33” in the measured objects 676 and 686 based on Equations 3 to 5.

(ζ) As described with reference to FIGS. 8 and 24, the color information is combined with the corresponding points in the measured objects 676 and 686 using the correspondence between the “disposition position for each pixel in the imaging sensor 270 relating to a depth (distance) signal” and the “disposition position of each pixel in the imaging sensor 280 detecting color signals”. In addition, the 3D coordinate values of each corresponding point in the measured objects 676 and 686 may be corrected using the distribution characteristics of the color information for each pixel.

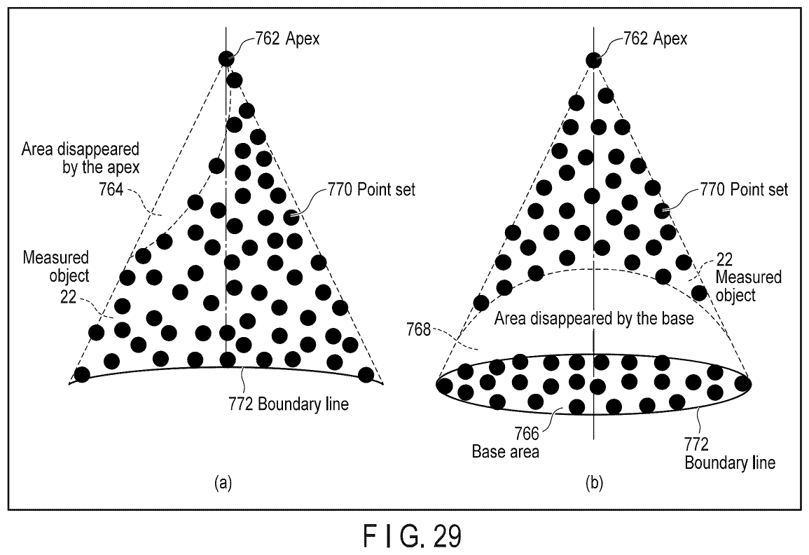

(η) As shown in FIG. 20, using position information (the 3D coordinate values) for each of a plurality of points “A11 to A33”, the 3D shape processing area (3D projective reverse transformation 922 may generate a three-dimensional shape viewed from all directions of the measured object 22. And FIGS. 29 and 30 describe how to generate the three-dimensional shape.

FIG. 29 illustrates a range of three-dimensional shape information that can be acquired from a single view line with respect to the measured object 22 having a three-dimensional shape. The coned measured object 22 is installed as an example of a three-dimensional shape. FIGS. 29 (a) and 29 (b) illustrate a range in which this coned shape can be observed from different view lines.

A “point set 770 having 3D coordinate values and generated by 3D projective reverse transformation from corresponding pixels” illustrated in FIG. 29 represents “a set of respective corresponding points “A11” to “A33” in measured object 22 in FIG. 23″. Note that the corresponding points “A11” to “A33” in the measured object 22 individually and respectively correspond to the pixels “all” to “a33” in the imaging sensor 270 relating to a depth (distance) signal. An area where the “point set 770 having 3D coordinate values and generated by 3D projective reverse transformation from corresponding pixels” exists in the coned measured object 22 indicates a range (imaging possible range) visible from each view line.

An installation position of the image forming lens 388 in the state of FIG. 29 (a) is close to an apex 762 of the measured object (cone) “obliquely upward”. When viewed (imaged) from the image forming lens 388, a base area 766 of the measured object 22 (cone) cannot be seen (cannot be imaged). At the same time, an area 764 disappeared by the apex is concealed by the shadow at the apex 762 of the measured object 22 (cone) and cannot be seen (cannot be imaged).

An installation position of the image forming lens 388 in the state in FIG. 29 (b) is below the base area 766 of the measured object (cone) 22. Therefore, the base area 766 of the measured object (cone) 22 can be seen (can be imaged) from the installation position of the image forming lens 388. An “area 768 disappeared by the base” concealed by the shadow of the base area 766 of the measured object (cone) 22 cannot be seen (cannot be imaged).

As described above, information regarding the “three-dimensional shape viewed from all directions” of the measured object 22 having a three-dimensional shape cannot be collected from the single image forming lens 388 within a short time (only at one timing). Here, in each of the different image forming lenses 388 in FIGS. 29 (a) and 29 (b), there is a “boundary line 772” indicating visible limitation in a visible area. By using a three-dimensional shape of this “boundary line 772 indicating visible limitation”, registration between the “point sets 770 having 3D coordinate values and generated by 3D projective reverse transformation from corresponding pixels” individually collected in FIGS. 29 (a) and 29 (b) can be easily performed. Accordingly, information regarding the “three-dimensional shape viewed from all directions” of the measured object 22 can be collected.

FIG. 30 illustrates an example of a method of registering a plurality of different point sets 770 having 3D coordinate values. Note that the “3D shape processing area (3D projective reverse transformation) 922” may perform the registration between the plurality of different point sets 770 having 3D coordinate values. FIG. 30 illustrates specific processing content examples of “a rotation operation or a translation operation between 3D coordinate values included in first and second point sets having 3D coordinate values (ST21)” and “registration between the first and second point sets having 3D coordinate values obtained as a result of the above operation (ST22)” which have already been outlined with reference to FIG. 20.

Therefore, the processing of “collection of the second point set having 3D coordinate values based on second measurement at a second imaging position (ST15)” in FIG. 20 is followed by “individual extraction of a boundary line indicating visible limitation for each of the first and second point sets having 3D coordinate values (ST23)” in FIG. 30. Furthermore, the processing of “selection of a condition that a total value of distances between points or a total value of distances between points and planes is minimized (ST40)” in FIG. 30 is followed by the processing of “estimation of a position in both eyes of a user (ST31)” in FIG. 20.

As a specific processing example related to the “rotation operation or translation operation between 3D coordinate values included in the first and second point sets having 3D coordinate values (ST21)” in FIG. 20, first, in step 23 in FIG. 30, the boundary line 772 indicating visible limitation is extracted individually for each of the first and second point sets having 3D coordinate values. When the measured object 22 having a three-dimensional shape is viewed (imaged) from the single image forming lens 388, the boundary line 772 indicating visible limitation appears as illustrated in FIG. 29.

In the present embodiment example, registration between the first and second point sets having 3D coordinate values may be performed using the three-dimensional shape characteristics of the boundary line 772 indicating visible limitation. Specifically, a three-dimensional shape around the boundary line 772 indicating visible limitation is predicted individually for each of the first and second point sets having 3D coordinate values (ST24). In step 25, the three-dimensional shape around each boundary line indicating visible limitation is roughly aligned between the different point sets having 3D coordinate values using the prediction result. However, detailed alignment is not performed at this stage. Detailed alignment is performed during the registration between many different point sets having 3D coordinate values obtained as a result of the above operation in step 22.

In the registration (ST22) between the plurality of different point sets having 3D coordinate values obtained as a result of the above operation, first, a position (3D coordinate values) of the first point set having 3D coordinate values is fixed (ST26). In the next step 27, a position (3D coordinate values) of the second point set having 3D coordinate values is slightly translated and rotated a prescribed number of times.

Evaluation of the registration accuracy between the plurality of different point sets having 3D coordinate values in the present embodiment example is performed by minimizing a “total value of distances between points in both point sets” or a “total value of distances between points in one point set and surfaces in the other point set”. That is, in step 28, a distance (inter-point distance) between “each three-dimensional coordinate point in the first point set having 3D coordinate values” and “each three-dimensional coordinate point in the second point set having 3D coordinate values” is calculated.

In parallel with this, after performing “generation of a local plane by connecting the three-dimensional coordinate points (three points or four points) in the second point set having 3D coordinate values” in step 29, “calculation of distances (distances between points and planes) between each local plane and each three-dimensional coordinate point in the first point set having 3D coordinate values (ST30)” is performed. In the first and second point sets having 3D coordinate values, the distance calculation is continuously repeated by the number of points existing in the vicinity of the boundary line 772 indicating visible limitation.

In the subsequent step 40, a condition is selected under which the total value of the distances between points or the total value of the distances between points and planes is minimized. The total number of points configuring the first and second point sets having 3D coordinate values is enormous. When the above processing is performed on all the points, enormous calculation time is required. In contrast, in the present embodiment example, the total distance is calculated only for points existing in the vicinity of the boundary line 772 indicating visible limitation. Therefore, in the present embodiment example, there is an effect that the calculation time can be significantly shortened.

As described above, a repeated operation of registering the plurality of different point sets having 3D coordinate values forms the “perfect three-dimensional shape viewed from all directions” of the measured object 22. Thereafter, the 3D coordinate values and the color information of each point of the measured object 22 obtained for each pixel having the same disposition position in the imaging sensor 270 relating to a depth (distance) signal and the imaging sensor 280 detecting color signals are combined.

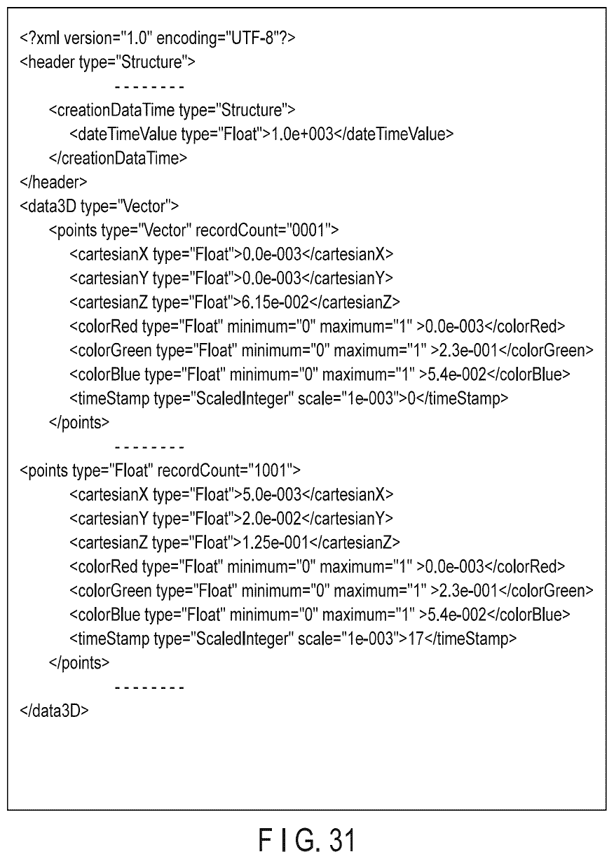

FIG. 31 illustrates an example of a data description format of each point of the measured object 22 after the 3D coordinate values and the color information are combined. In the information regarding the point set illustrated in FIG. 31, “information regarding the perfect three-dimensional shape viewed from all directions of the measured object 22” is written. The information is shared as a common data format inside the 3D shape processing area (3D projective reverse transformation) 922.

In addition, regarding the cooperative operation method between the 3D shape processing area (3D projective reverse transformation) 922 and the other areas 924, 926, 928, and 930, a method of disclosing the interface specification 940 including the API (application information) has been proposed in FIG. 10. This facilitates participation of individuals and small-scale organizations, and promotes technical development for each of the areas 922 to 930.

As described with reference to FIG. 11, an amount of the content processed inside the 3D shape processing area (3D projective reverse transformation) 922 is also enormous. Therefore, in order to provide all the functions described with reference to FIG. 11, a large number of resources are required for the development of the 3D shape processing area (3D projective reverse transformation) 922. As a method of solving the technical problem, a role inside the 3D shape processing area (3D projective reverse transformation) 922 may be subdivided, and an interface specification between the subdivided roles may be disclosed. In this case, an individual or a small-scale organization can easily and spontaneously develop a small-scale program that realizes a subdivided individual role.

Further, a community may be formed to ensure the reliability of the small-scale program. Community participants create innovation through the small-scale program development, and a “trigger” that starts providing new services is generated. Furthermore, the optical device 10 or a part thereof described in the present embodiment example can be used for providing a new service generated here. As part of this subdivided inter-role interface specification, a standardized description format of the point set data illustrated in FIG. 31 may be used.

As this data description format example, FIG. 31 illustrates a description example of three-dimensional coordinate information for each point including color information using an extended markup language (XML) format. In the XML, various types of information can be described in an attribute information writing area (attribute) of a written element. Therefore, when XML is used, there is an advantage that various types of information can be flexibly expressed. However, the present invention is not limited thereto, and data may be described in a binary data description format.

In this XML, data content is described in a text format. Therefore, definition of an encoding method for description in a text format is first required. Therefore, in the beginning in FIG. 31, “<? xml version=“1.0” encoding=“UTF-8”?>” is written, and adoption of “UTF-8 encoding” is clearly stated.

In the embodiment example illustrated in FIG. 31, first, a header portion (within a writing range from “<header type=“Structure”> to “</header>”) is set. Among them, the date and time “<dateTimeValue type=” Float “>1.0e+003</dateTimeValue>” when the three-dimensional shape data was measured can be specified. A display 18 of the optical device 10 (FIG. 1A) may express a combination movie between a recent movie recently obtained and an old movie obtained in the distant past when the system controller 50 in the optical device 10 use the <creationDataTime> elements belonging to different movies. Therefore, the display 18 is able to perform “overtime expression” if the display 18 expresses the combination movie between the recent and old movies. By using the above data, an “amount of time difference between pieces of data before combination” can be easily calculated.

The three-dimensional shape data is described within a range from “<data3D type=“Vector”>” to “</data3D>”. Data regarding a point is described in a range from “<points type=“Vector” recordCount=“0001”>” to “</points>”. Identification information between the different points is described immediately after “recordCount=”.

In particular, time information of “<timeStamp type=“ScaledInteger” scale=“1e-003”>—</timeStamp>” can be provided in this one-point data description field. By writing the content of the description element (time Stamp element), it is possible to write not only a still three-dimensional image but also a three-dimensional movie image. For example, in the National Television Standard Committee (NTSC) standard, an image of 30 frames is displayed per second. Therefore, when the display times written in “<timeStamp type=“ScaledInteger” scale=“1e-003”>” and “</timeStamp>” are written to be shifted for each “ 1/30 seconds”, it is possible to display a three-dimensional movie image conforming to the NTSC standard.

In the embodiment example in FIG. 31, the unit system “MKS (meter, kilogram, second)” is used as the display unit. In order to write a numerical value for each “ 1/30 seconds”, it is more convenient to describe the numerical value in units of “milliseconds”. Therefore, attribute information of “scale=“1e-003”” is given, and description in units of “milliseconds” is enabled.

The three-dimensional coordinates and the color information corresponding to α point are described as follows:

$$“ < cartesianX type = “ Float ” > 0. e - 003 < / cartesianX > ” ;$$

$$“ < cartesianY type = “ Float ” > 0. e - 003 < / cartesianY > ” ;$$

$$“ < cartesianZ type = “ Float ” > 6.15 e - 002 < / cartesianZ > ” ;$$

$$“ < colorRed type = “ Float ” minimum = “ 0 ” maximum = “ 1 ” > 0. e - 003 < / colorRed > ” ;$$

$$“ < colorGreen type = “ Float ” minimum = “ 0 ” maximum = “ 1 ” > 2.3 e - 001 < / colorGreen > ” ;$$

$$“ < colorBlue type = “ Float ” minimum = “ 0 ” maximum = “ 1 ” > 5.4 e - 002 < / colorBlue > ” .$$

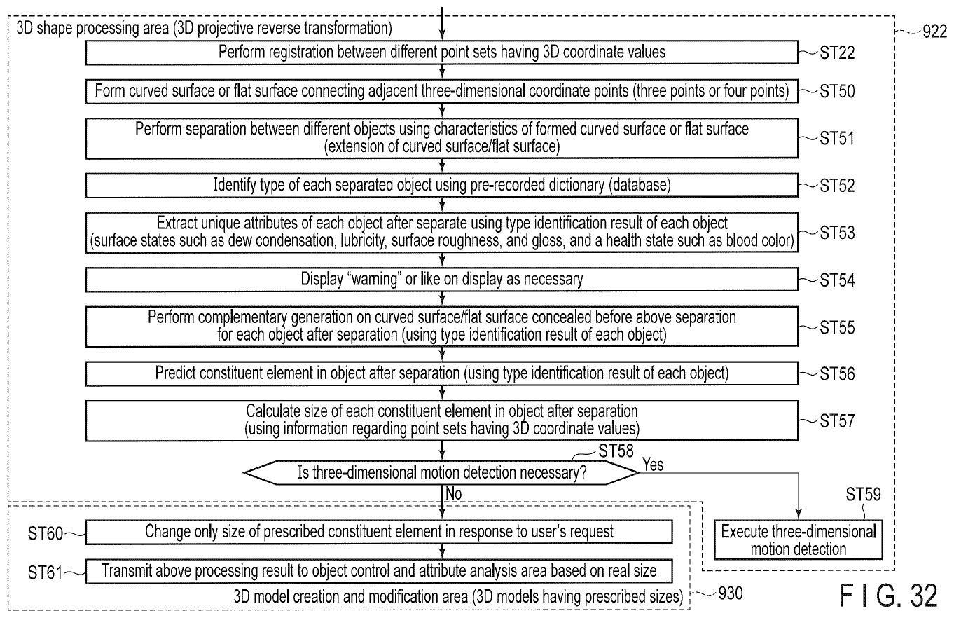

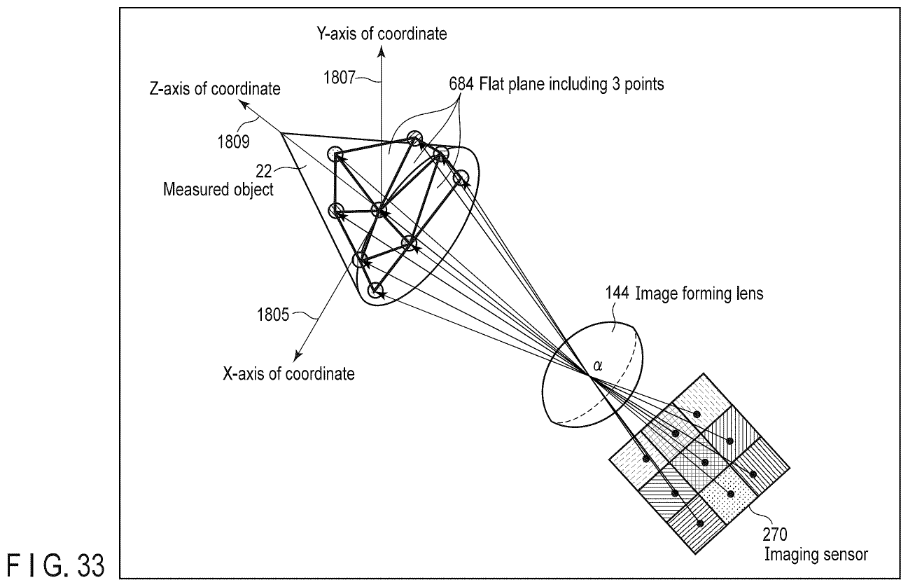

FIG. 32 collectively illustrates an example of processing steps performed by the 3D shape processing area (3D projective reverse transformation) 922 after the point set data indicating the omnidirectional shape of the measured object 22 is created. Here, a large flow of a processing step example is illustrated, and specific content of each step is individually described in FIG. 33 and subsequent drawings. Note that specific content of “registration between different point sets having 3D coordinate values (ST22)” in FIG. 32 indicates the description content in FIG. 30. Therefore, step 22 illustrated in FIG. 32 is performed after step 21 described in FIG. 30.

In step 50 after the point set data indicating the omnidirectional shape of the measured object 22 is created in step 22, a curved surface or a flat surface connecting adjacent three-dimensional coordinate points (three points or four points) is formed. The measured object 22 surrounded by the generated curved surface or flat surface may be imaged in a combination form of a plurality of different objects. In this case, separation (ST51) between different objects using the characteristics of the formed curved surface or flat surface (extension of the curved surface/flat surface) is required.

The type identification (ST52) may be performed for each of the separated objects. In this type identification, a dictionary (database) recorded in advance may be utilized. In step 53, extraction of unique attributes (surface states such as dew condensation, lubricity, surface roughness, and gloss, and a health state such as blood color) for each object after the separation can be performed using the type identification result for each object. For example, when the road surface is frozen, the road surface is slippery and an accident is likely to occur. In this case, it is desirable to display a “warning” or the like on the display as necessary (ST54).

In the case of separation between different objects in step 51, processing of a curved/flat surface 752 concealed before separation remains. With regard to remaining work, in step 55, the complementary generating process is performed on the curved surface/flat surface 752 concealed before the separation for each object after the separation. In this case, the type identification result for each object obtained in step 52 may be used.

As a result of the type identification for each object performed in step 52, in a case where the object is a human, a complicated device, or the like, the inside thereof is divided into a plurality of constituent elements (for example, a “head”, a “hand”, a “torso”, and a “foot”). Therefore, in step 56, a constituent element in the object after the separation is predicted using the result of the type identification for each object performed in step 52. Based on the prediction result, a size of each constituent element in the object after the separation is calculated (ST57). Information regarding α point set having 3D coordinate values is used to calculate the size of each constituent element.

As a result of the type identification of each object performed in step 52, a special case where the object is a human or a complicated device is considered. Humans and complicated devices involve spontaneous motion. In a case where a three-dimensional shape of an object is imaged as a movie, this spontaneous motion detection (that is, three-dimensional motion detection) can be performed. That is, in step 58, the necessity of three-dimensional motion detection is determined. In a case where the three-dimensional motion detection is necessary, the process proceeds to the step of executing the three-dimensional motion detection (ST59).

An example of a handling method in a case where three-dimensional motion detection is unnecessary and the user requests “to change sizes of some constituent elements in the object” is described. In this case, the 3D shape processing area (3D projective reverse transformation) 922 transfers the three-dimensional shape information regarding the specific object separated in step 51 (including the color information) and the information regarding the “sizes of each constituent element in the object” obtained in step 57 to the 3D model creation and modification area (3D models having prescribed sizes) 930.

The 3D model creation and modification area (3D models having prescribed sizes) 930 changes the size of the specific constituent element requested by the user to the size requested by the user (ST60). Thereafter, the “3D model creation and modification area (3D models having prescribed sizes) 930” transfers the three-dimensional shape information (including the color information) regarding the object of which the size has been changed to the “object control and attribute analysis area 924 based on real size”. At the same time, a 3D model independently created in the “3D model creation and modification area (3D models having prescribed sizes) 930” may be transferred to the “object control and attribute analysis area 924 based on a real size”.

A processing content of the “object control and attribute analysis area 924 based on a real size” and a display example based on the processing result are not illustrated. After the “3D model creation and modification area (3D models having prescribed sizes) 930” transfers the information regarding
1. the object three-dimensional shape in the real world in which the sizes of the specific constituent element are changed according to user's request, and
2. the 3D model created independently in the “3D model creation and modification area (3d models having prescribed sizes) 930”, for example, a three-dimensional image (or a three-dimensional movie) generated by the “object control and attribute analysis area 924 based on a real size” as illustrated in FIG. 12 by adding
3. an appropriate background image (or background movie).

Here,

1. The object three-dimensional shape in the real world in which the sizes of the specific constituent element are changed according to user's request corresponds to the measured real object 690 having real sizes having the “height A” illustrated in FIG. 12.

2. The 3D model created independently in the “3D model creation and modification area (3D models having prescribed sizes) 930” corresponds to the 3D model 692 created in the virtual space having the “virtual height a”.

FIG. 12 is not limited to a combination of stationary three-dimensional shapes, and both may be interlocked as a three-dimensional movie. In this case, the “3D model creation and modification area (3D models having prescribed sizes) 930” creates an object three-dimensional shape in the real world and a motion change state of the 3D model. The “object control and attribute analysis area 924 based on a real size” executes combination between three-dimensional shapes and motion expression and generation based on three-dimensional shape information at the time of individual movement created in the “3D model creation and modification area (3D models having prescribed sizes) 930”. When the series of processing described above is executed as described above, as illustrated in FIG. 12, the 3D model (a virtual image in the virtual world) created independently in the “3D model creation and modification area (3D models having prescribed sizes) 930” and the real object 1410 located in the real world can operate in interlocking with high accuracy.

FIG. 33 is an explanatory diagram illustrating a method of generating a curved surface and a flat surface from point set data. FIG. 33 is a specific explanatory diagram for the content of step 50 in FIG. 32. Each point in the point set representing the three-dimensional shape of the measured object 22 is in a confocal relation (image forming relationship) with each pixel 271 in the imaging sensor 270 relating to a depth (distance) signal.

A triangle connecting three adjacent points in each point (“A11” to “A33” illustrated in FIG. 23) forms a local plane. The connection surface between the adjacent triangular planes forms a global curved surface or flat surface. FIG. 33 illustrates an example in which a triangular plane is formed by connecting three adjacent points. However, the present invention is not limited thereto, and a quadrangle may be created between four adjacent points. When the adjacent quadrangles are connected to each other, a global curved surface or flat surface can be formed.

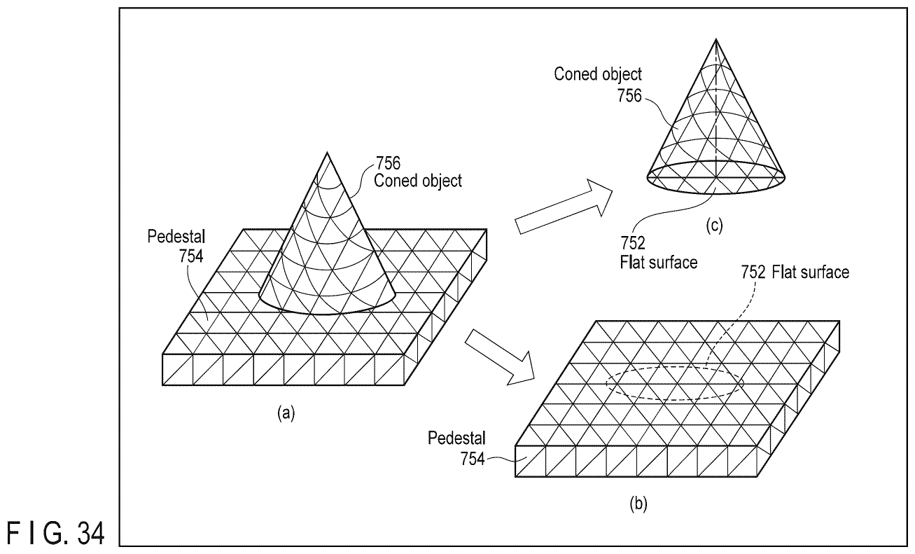

FIG. 34 illustrates an example of a method of separating “a three-dimensional shape configured through combination of a plurality of different objects” into individual objects using the attributes of the curved surface or the flat surface created in FIG. 33. FIG. 34 is a specific explanatory diagram for the content of step 51 in FIG. 32. FIG. 34 (a) illustrates an imaging result in a state in which a coned object 756 is placed on a flat pedestal 754.

A contact area between the coned object 756 and the flat pedestal 754 is not within the visual field at the time of imaging. However, assuming “the surface of the flat pedestal 754 is flat”, this contact area can be expected. That is, a case is considered in which the information that “the top surface of the pedestal 754 outside the coned object 756 is flat” can be extracted as the attribute of the surface created in step 50 in FIG. 32. When this attribute is extended, it can be estimated that “the contact area between the coned object 756 and the top surface of the pedestal 754 is flat”. It is possible to additionally estimate that “with this flat contact area as a boundary, both can be separated from each other”.

Based on this hypothesis, a tentative attempt is made to separate the two in the flat contact area. As a result of this separation, a three-dimensional shape of a flat plate having the thickness in FIG. 34 (b) and a coned three-dimensional shape in FIG. 34 (c) are obtained. The correctness of this separation can be evaluated in step 52 in FIG. 32. That is, the type identification is individually performed on the three-dimensional shape of the flat plate illustrated in FIG. 34 (b) and the coned three-dimensional shape illustrated in FIG. 34 (c). Here, in this type identification, a database (dictionary) recorded in advance is referred to. In the case of a three-dimensional shape of which the type cannot be identified as a result of this reference, it is determined that the separation described above is inappropriate. It is determined that the shape before separation (the shape in FIG. 34 (a)) alone configures the object.

Immediately after the separation, a “curved/flat surface 752 concealed before separation” remains in the three-dimensional shape of the flat plate in FIG. 34 (b). Similarly, the “curved/flat surface 752 concealed before separation” remains in the coned three-dimensional shape in FIG. 34 (c). Here, a case is considered in which it is determined that “both separated objects individually configure independent objects” (that is, the separation is correct) as an evaluation result in step 52 in FIG. 32. In this case, since the objects in both of FIGS. 32 (b) and 32 (c) individually configure independent objects, complementary processing is performed on the “curved/flat surface 752 concealed before separation”. Specifically, an appropriate curved surface or flat surface matching the above described “attribute information of the concealed curved surface or flat surface” is automatically generated in the “curved/flat surface 752 concealed before separation”.

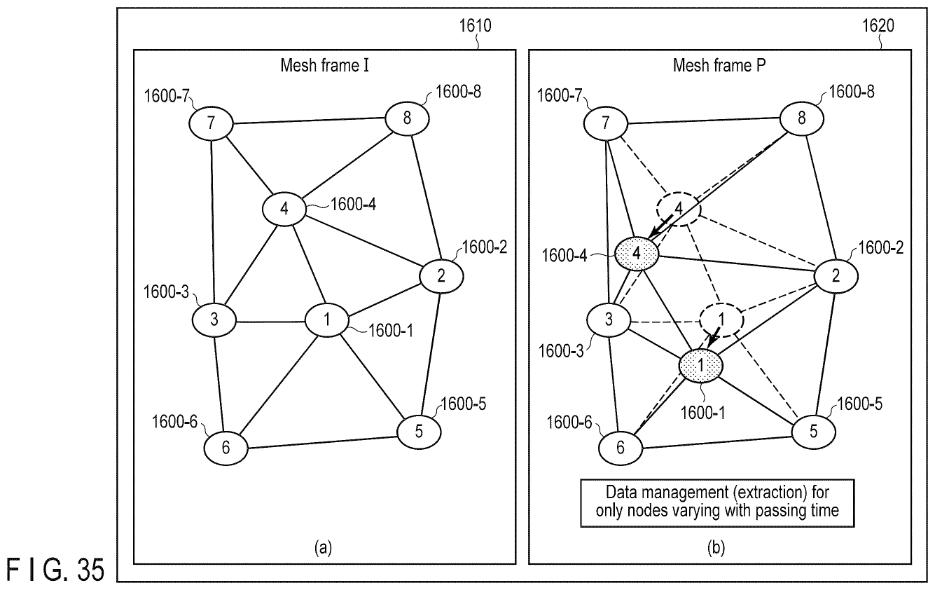

FIG. 35 illustrates an example of a time variation management method of a three-dimensional shape for a three-dimensional movie. As an example of the present embodiment, the method in which the 3D projective reverse transformer 550 can generate position information including a time variation of each point in α point set has been described. The “3D shape processing area (3D projective reverse transformation) 922” may construct a “three-dimensional shape having a surface structure” based on the information.

Even for a time variation of a three-dimensional shape in a three-dimensional movie, it is possible to manage a time variation related to position information of each point in a point set configuring the three-dimensional shape. When only a point that varies with passing time is extracted, and information of only a component varying with passing time of the point can be recorded, an effect that the amount of information for managing a three-dimensional movie can be overwhelmingly reduced is achieved.

The imaging sensor 270 relating to a depth (distance) signal and the imaging sensor 280 detecting color signals collect point set information regarding the four-dimensional coordinates and RGBW intensities (a red intensity, a green intensity, a blue intensity, and a white intensity in color information) of each point on the measured object 22. Each point on the measured object 22 may represent a node 1600. As explained in FIG. 33, using a combination between three (or four) nodes 1600, the “3D shape processing area (3D projective reverse transformation) 922” may form a local plane surface included in the measured object 22. Here, the fine portion of the unevenness on the surface of the measured object 22 is set to narrow the interval between the nodes 1600. Further, the rough portion of the uneven shape is set to widen the interval between the nodes 1600. Further, time information explained in the <timeStamp>element in FIG. 31 and three coordinate axes 1805, 1807, and 1809 in FIG. 33 (or FIG. 23) define each position (four-dimensional coordinate values) of each node. An expression form of the local surface shape of the measured object 22 expressed by the set of nodes 1600 represents a “mesh”.

A surface image of the measured object 22 expressed in the form of a mesh (when the value on the time axis is fixed) at a prescribed time represents a “mesh frame” here. The present embodiment example defines a plurality of mesh frames. That is, in the “mesh frame I (image)” illustrated in FIG. 35 (a), four-dimensional coordinates and the RGBW intensities of all the nodes 1600-1 to 1600-8 are managed. On the other hand, in the “mesh frame P (progress)” illustrated in FIG. 35 (b), information of only the node 1600 having information different from that of the mesh frame I or only difference value information of only the node 1600 having information different from that of the mesh frame I is managed.

For example, FIG. 35 (a) and FIG. 35 (b) illustrate an example in which a positional deviation occurs only in the node 1_1600-1 and the node 4_1600-4. In this case, as the management information of the mesh frame P, information (alternatively, a difference value from the information of the node 1_1600-1 and the node 4_1600-4 in the mesh frame I) of only the node 1_1600-1 and the node 4_1600-4 is managed. As a difference between FIG. 35 (a) and FIG. 35 (b), a change in the positions of the node 1_1600-1 and the node 4_1600-4 is exemplified. However, the present invention is not limited thereto, and, even in a case where only a change in color intensity occurs, information in the mesh frame P is managed. When an amount of the information of the mesh frame P is reduced compared with that of the mesh frame I as described above, there is an effect of greatly reducing management information of a four-dimensional movie according to a time variation.

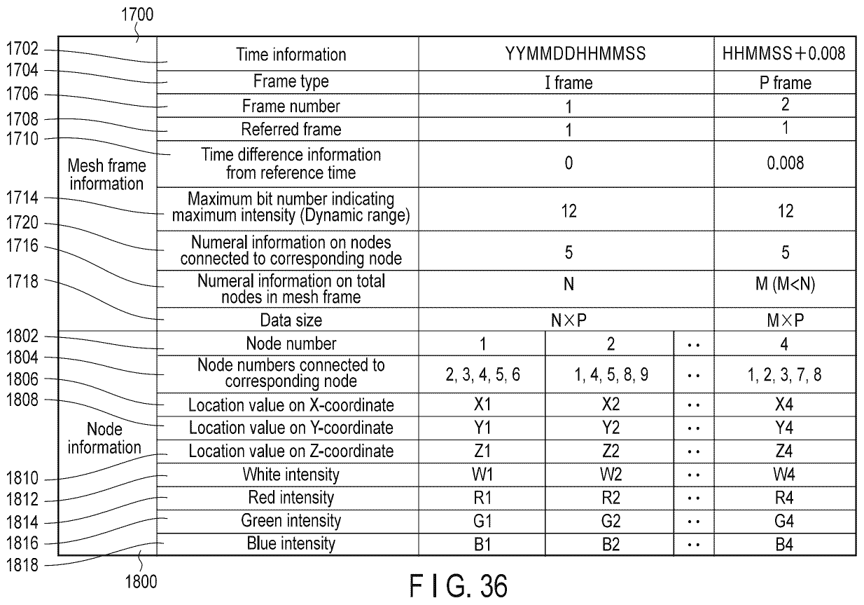

FIG. 36 illustrates an example of management information of the node 1600 defined in units of the mesh frames 1610 and 1620. In addition, FIG. 36 illustrates another embodiment example related to the data description format of each point described in FIG. 31. This management information example is based on a mesh structure of each of the mesh frames 1610 and 1620 illustrated in FIG. 35. The management information includes mesh frame information 1700 managed in units of mesh frames 1610 and 1620 and node information 1800 managed for each node in the same mesh frame.

Time information at which the imaging sensor 270 relating to a depth (distance) signal and the imaging sensor 280 detecting color signals perform imaging is recorded for each of the mesh frames 1610 and 1620 as time relationship information (measurement information or the like) 1702 in the format of “year/month/day/hour/minute/second/decimal place information”. This information may be used for reproduction synchronization with audio information performed at the time of reproduction of four-dimensional image (or movie) data. A presentation time stamp (PTS) is used for synchronization during reproduction of general audio and video (AV) information. When the PTS is displayed in synchronization with defined audio information, the information may be converted into the PTS and synchronized.

The present embodiment example may define a plurality of types of mesh frames. For example, identification information indicating the “I frame” or the “P frame” is recorded in the field of frame type information 1704. For example, in the case of performing fast-forward replay 1546, by using this frame type information 1704, it is possible to acquire the node information 1800 of only the “I frame” (mesh frame I) at a high speed. Accordingly, the frame type information 1704 can provide processing convenience for the fast-forward replay 1546.

In the present embodiment example, frame numbers 1706 for a plurality of types of mesh frames are set. Use of the frame number 1706 improves convenience of temporal access processing to passing time 1498 specified by an end user 1080, such as time search.

A frame number of a mesh frame referred to by a corresponding mesh frame is stored in the field of a referred frame 1708. As this “referred mesh frame”, the mesh frame I_1610 may be designated. As designated in FIG. 35, the node information 1800 in the mesh frame P_1620 has only difference information from the mesh frame I_1610. Therefore, when a corresponding mesh frame is the mesh frame P_1620, all the pieces of node information 1800 can be acquired by combining the node information 1800 corresponding to the corresponding mesh frame with the node information 1800 in the referred frame 1708.

Difference time information 1710 from reference time indicates a difference value between time information 1702 of the corresponding mesh frame and time information 1702 of the mesh frame (mesh frame I_1610) referred to by the corresponding mesh frame.

A maximum bit number indicating maximum intensity (dynamic range) 1714 represents the number of expression bits of the various color information intensities 1812 to 1818 in the node information 1800. When the maximum bit number indicating maximum intensity (dynamic range) 1714 is increased, the various color information intensities 1812 to 1818 can be expressed with fine gradations, but a data size of the management information increases.

Numeral information on nodes connected to corresponding node 1720 represents an expression form state of the mesh structure. As shown in FIG. 33 (b), the three nodes 1600 forms a plane surface called a triangular basic cell. The node 1600-1 of #1 is connected to the five nodes 1600 such as the node 1600-2 of #2, the node 1600-4 of #4, the node 1600-3 of #3, the node 1600-6 of #6, and the node 1600-5 of #5. Therefore, in the expression form state of the mesh structure in FIG. 33 (b), the numeral information on nodes connected to corresponding node 1720 is “5”. However, the present invention is not limited thereto, and, for example, the basic cell may be formed of a quadrangle. The numeral information on nodes connected to corresponding node 1720 in this case takes a different value.

Numeral information on total nodes in mesh frame 1720 indicates the number of nodes 1600 managed in the corresponding mesh frames 1610 and 1620. In addition, a data size 1718 indicates a data size of the node information 1800 regarding the node 1600 managed in the corresponding mesh frames 1610 and 1620. Here, when the data size of the node information 1800 regarding a node 1600 is represented by “P” and the numeral information on total nodes in mesh frame represents “N”, the data size 1718 is given by “N×P”.

Node numbers are set for the nodes 1600 in all the mesh frames 1610 and 1620. Therefore, all the nodes 1600 in the mesh frames 1610 and 1620 are identified and managed by the node number 1802. Therefore, the node number 1802 is disposed at the first position in the node information 1800. In the present embodiment example, in the mesh frame P_1620, only the node 1600 changed from the mesh frame I_1610 is managed. Therefore, the “3D shape processing area (3D projective reverse transformation) 922” can easily find the changed node 1600 compared the mesh frame P_1620 to the mesh frame I_1610 when the “3D shape processing area (3D projective reverse transformation) 922” searches the node number 1802 of the node 1600 managed in the mesh frame P_1620.

In the expression form of the mesh structure in FIG. 35, the node 1600-1 of #1 is connected to the five nodes 1600 such as the node 1600-2 of #2, the node 1600-4 of #4, the node 1600-3 of #3, the node 1600-6 of #6, and the node 1600-5 of #5. This connection relationship is described in node numbers 1804 connected to corresponding node 1600. Using this information makes it easy to analyze the detailed uneven shape of the surface of the measured object 22.

A location value on the X-coordinate 1806, a location value on the Y-coordinate 1808, and a location value on the Z-coordinate 1810 indicate 3D coordinate values of the corresponding node 1600. Each of a white intensity 1812, a red intensity 1814, a green intensity 1816, and a blue intensity 1818 indicates color information of reflected light from the corresponding node 1600.

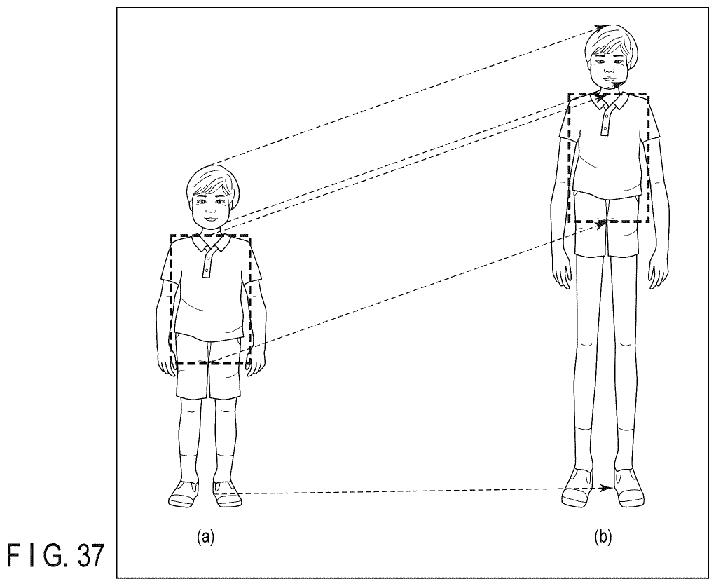

FIG. 37 illustrates a size change example related to some constituent elements in a real object having real sizes. This size change indicates a specific example of “size change of prescribed constituent element” described in step 60 in FIG. 32. For example, the future removable data processing device 9 is expected to be equipped with a “three-dimensional selfie (self-image-sensing) function” capable of capturing an image of a three-dimensional shape of a photographer himself/herself. Before the three-dimensional shape of the photographer who has taken a “three-dimensional selfie (self-image-sensing)” is disclosed on a network, sizes of some constituent elements may be changed. An example of this case also corresponds to FIG. 37.

A display example of the display 16 in FIG. 5 illustrates a meeting scene example in a virtual world on a network. There is a case where a 3D model created by the “3D model creation and modification area (3D models having prescribed sizes) 930” participates in this meeting. Furthermore, the present embodiment is not limited thereto, and, for example, there is a method in which a real person in the real world participates in the meeting with a figure in which a part of a three-dimensional shape of the real person who has taken a “three-dimensional selfie (self-image-sensing)” is changed. As an example, there is also a method in which a child disguises himself/herself as an adult and participates in a meeting.

FIG. 37 (a) illustrates an example of a three-dimensional shape of the entire body of a child who has taken a “three-dimensional selfie (self-image-sensing)”. FIG. 37 (b) illustrates an example in which only the sizes of both hands and both feet are extended from FIG. 37 (a). Here, when FIG. 37 (a) and FIG. 37 (b) are compared with each other, three-dimensional shapes (and sizes thereof) of the torso portion surrounded by the dashed line and the “neck” and the “head” thereon coincide with each other. As can be seen from FIG. 37 (b), when only the sizes of the hands and the feet in the whole-body figure of the child are enlarged, the child looks like an adult. Here, the “3D model creation and modification area (3D models having prescribed sizes) 930” shown in FIGS. 10 and 32 may partially change the part of the three-dimensional shapes (and sizes thereof).

In the present embodiment example, a user may designate a size change portion and set a size change amount only by “movement of two fingers”. The display 18 of the removable data processing device 9 illustrated in FIG. 25 displays a real object having real sizes. For example, a case where it is desired to change a size of a part the real object in this display area is considered. In this case, the user changes a space between the two fingers while placing the two fingers on a size change portion in the display area. There is also a method of automatically changing a partial size in a three-dimensional shape according to a change of a space between the two fingers.

In addition, this operation is not limited to the “planar image” displayed on the display 18 in FIG. 25. For example, for the three-dimensional shape displayed in “three-dimensional display area” in FIGS. 5 and 6, the user may place the fingers or the like (a part of the body) on a size change portion in the displayed three-dimensional shape, and change a space between the fingers to change a size of only a prescribed portion. In the present embodiment example, the above method can change a three-dimensional shape without imposing a burden on a user.

Further, the present embodiment is not limited to a size change of a specific location described above, and any three-dimensional shape may be changed. For example, instead of changing a size of a specific portion in FIG. 37 (a), the entire head may be changed. Alternatively, a part of the body may be changed to another animal.

Furthermore, in addition, not limited to it, the “3D model creation and modification area (3D models having prescribed sizes) 930” (FIG. 10) may achieve “three-dimensional shape complementing” that complements three-dimensional shape information obtained from a measured object 22 existing in the real space. As a result of the “three-dimensional shape complementing”, the display 18 included in the optical device 10 can display a movie of three-dimensionally omnidirectional shape regarding a measured object 22 even if the measurer 8 measures a three-dimensional image of the measured object 22 moving from only one direction (only one view line 384 or 582 of the measurer 8).

The “three-dimensional shape complementing” may comprise a combination between a series of the following processing:
A) imaging obtained from omnidirectional view lines (FIGS. 3 and 4) or expanded imaging obtained from a part of the measured object 22;
B) registration between different point sets (FIG. 30);
C) complementing (adding a complemented point set to) the concealed surface 752 (FIG. 34);
D) Completing a static 3D model (three-dimensionally omnidirectional model) obtained from the real measured object 22;
E) Setting rigs (adding motion mechanism to the static 3D model) (step 09 in FIG. 13);
F) Changing a partial size or a partial shape of the static 3D model (FIG. 37);
G) Measuring the measured object 22 from only one direction (from only one imaging view line);
H) Creating motion of the three-dimensionally omnidirectional model adapting to (G); and
I) Displaying the three-dimensional movie based on the three-dimensional projective transformation method.

Each processing mentioned above is described below in detail.
A) imaging obtained from omnidirectional view lines (FIGS. 3 and 4) or expanded imaging obtained from a part of the measured object 22

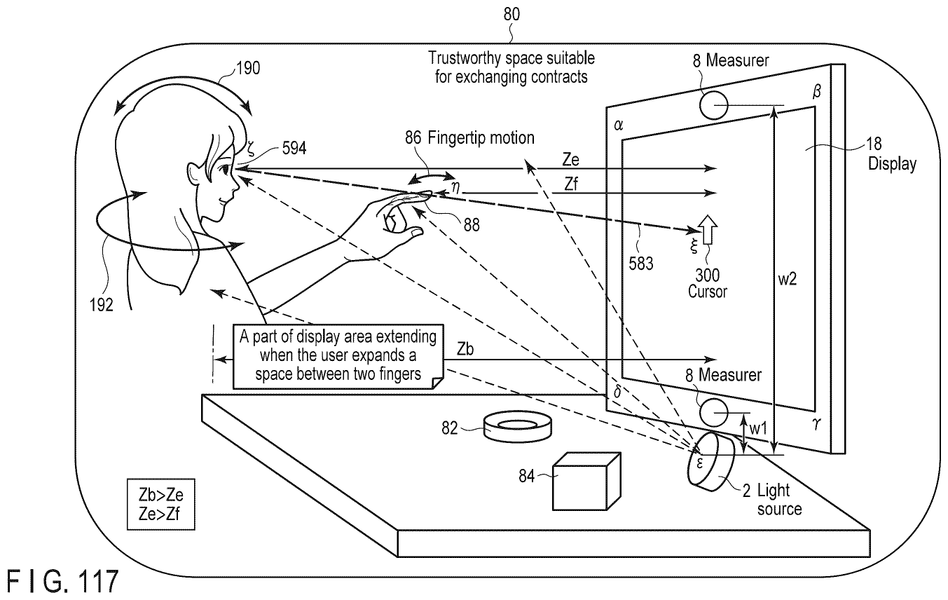

In order to ascertain an entire three-dimensional shape of the measured object 22, it is necessary to observe the three-dimensional shape of the measured object 22 from a plurality of different view lines. And the user moves the same measurer 8 and obtains different image patterns of the measured object 22 viewed from different view lines at different times when the measurer 8 is movable as shown in FIGS. 3 and 4. Meanwhile, as shown in FIGS. 5 and 117, when the measurer 8 is fixed, the measured object 22 may make one full turn in front of the measure 8 in advice. Accordingly, the measured object provides perfectly three-dimensional shape information obtained from omnidirectional view lines.

In addition, not limited to the omnidirectional view lines, the present embodiment may obtain expanded images from a part of the measured object 22 in advance. A spatial resolution of the imaging sensor 280 detecting color signals generally tends to be higher than another spatial resolution of the imaging sensor 270 relating to depth (distance) signal. Therefore, if the user desires a high resolution of the distance (depth) information regarding the measured object 22, the present embodiment example may set the measurement device 12 included in the optical device 10 (FIG. 1A) near to the measured object 22 to obtain the three-dimensionally expanded images from a part of the measured object 22 in advance. Accordingly, the three-dimensionally high resolution point sets can be obtained.

Since a three-dimensionally high resolution point set corresponds to only a part of the measured object 22, the registration of “processing (B)” may combine the different point sets (three-dimensionally high resolution point sets) into a three-dimensionally high resolution point set indicating the three-dimensionally entire measured object 22.
B) registration between different point sets (FIG. 30)

According to “(A) imaging obtained from omnidirectional view lines”, the each measurement from the different imaging view line 384 provides the different “point set”. Therefore, as previously described with reference to FIG. 30, the “3D shape processing area (3D projective reverse transformation) 922” may perform registration between the different point sets. In the present embodiment example, the registration may allow a partial lack of point set obtained from a prescribed imaging view line 384 because the next processing (C) may complement the partial lack to complete the three-dimensionally omnidirectional shape.
C) complementing (adding a complemented point set to) the concealed surface 752

As previously described with reference to step 55 in FIG. 32 and FIG. 34, the “3D shape processing area (3D projective reverse transformation) 922” may complement (add a complemented point set to) the concealed surface 752 to complete the three-dimensionally omnidirectional shape.
D) Completing a static 3D model (three-dimensionally omnidirectional model) According to the “three-dimensional shape complementing” utilized in the present embodiment example, the “3D shape processing area (3D projective reverse transformation) 922” may complete (create) a ‘static’ 3D model (three-dimensionally omnidirectional model) in the virtual space. Here, the three-dimensionally omnidirectional static model is obtained based on a combination between “(A) three-dimensional measurements of the measured object 22 existing in the real space” and “(B) registration”. Moreover, the “3D shape processing area (3D projective reverse transformation) 922” may achieve the complementing the partial lack.
E) Setting rigs (adding motion mechanism to the static 3D model) (step 09 in FIG. 13)

The “three-dimensional shape complementing” may desire that the three-dimensional image pattern obtained from the real measured object 22 can move smoothly and that the smooth motion of the three-dimensional image pattern can be observed from any direction (all of view lines 582 or 584). Therefore, as previously described with reference to step 09 in FIG. 13, the “3D model creation and modification area (3D models having prescribed sizes) 930” shown in FIG. 10 may designate “rigs” into the three-dimensionally omnidirectional static shape created in the “processing (D)” to add moving mechanism to the three-dimensionally omnidirectional static shape. Therefore, the three-dimensional image pattern obtained from the real measured object 22 can move smoothly in the virtual space, and the smooth motion of the three-dimensional image pattern in the virtual space can be observed from any direction (all of view lines 582 or 584).
F) Changing a partial size or a partial shape of the static 3D model (FIG. 37)

Moreover, the “three-dimensional shape complementing” may desire that the three-dimensional image pattern obtained from the real measured object 22 can adjustably move in any virtual environment. Here, for example, a virtual environmental may correspond to a narrow space or a microscopic space which the real measured object 22 never passes through. Therefore, the “3D model creation and modification area (3D models having prescribed sizes) 930” may change a partial size (or all size) or a partial shape of the three-dimensional image pattern created in “processing (E)”. Accordingly, the motion of the remaked three-dimensional image pattern is adapted for any kind of virtual environmental.
G) Measuring the measured object 22 from only one direction (one imaging view line)

After remaking the three-dimensional image pattern in the “processing (F)” (or after Setting rigs in the “processing (E)”), the measurer 8 may measure the real measured object 22 (for example, the user) from only one imaging view line 384 prescribed (from only one prescribed direction). Thereafter, the “3D shape processing area (3D projective reverse transformation) 922” shown in FIG. 10 may extract the real-time user's motion.
H) Creating motion of the three-dimensionally omnidirectional model

The “object control and attribute analysis area 924 based on real size” may control the motion of the remaked three-dimensionally omnidirectional model (image pattern) generated in the “processing (F)” or the motion of the three-dimensionally omnidirectional model (image pattern) having the “rigs” in the “processing (E)” based on the reference motion extracted in the “processing (G)”. According to the “processing (G)”, the three-dimensional image obtained from the user (the measured object 22) does not provide the omnidirectional shape. However, the “processing (E)” or the “processing (F)” provides the three-dimensionally omnidirectional shape.
I) Displaying the three-dimensional movie

Using the “three-dimensional projective transformation” described later in Chapter 2, the user easily looks at the three-dimensional movie generated by the “processing (H)” from any direction (any vies line).

In addition, not limited to the “three-dimensional shape complementing”, the present embodiment example may use at least a part of the processings included in the “three-dimensional shape complementing” to another application occasion (service providing occasion for any user). For example, the present embodiment example may use the three-dimensional image or the three-dimensional movie generated by the “processing (E)” or the “processing (F)” as a presentation, a display, a representing symbol (a three-dimensional icon). Moreover, the three-dimensional movie generated by the “processing (E)” or the “processing (F)” may correspond to a reference movie indicating a standard motion.

And not limited to it, in response to the “processing (H)”, the present embodiment example may guide (teach) a user in appropriate motions or may control a remote robot (or a driving mechanism 15 shown in FIG. 1A). In other words, the present embodiment example may overlay a motion of a three-dimensional image of the user measured by the measurer 8 with another motion of the three-dimensionally omnidirectional model generated by the “processing (H)” on the display 18. Thereafter, the present embodiment example may extract the difference between two motions mentioned above to guide (teach) the user in appropriate motions. Furthermore, the present embodiment example may overlay a motion of a three-dimensional image of the remote robot (or a driving mechanism 15) measured by the measurer 8 with another motion of the three-dimensionally omnidirectional model generated by the “processing (H)” on the display 18. Thereafter, the present embodiment example may extract the difference between two motions mentioned above to control a series of behaviors of the remote robot (or a driving mechanism 15).

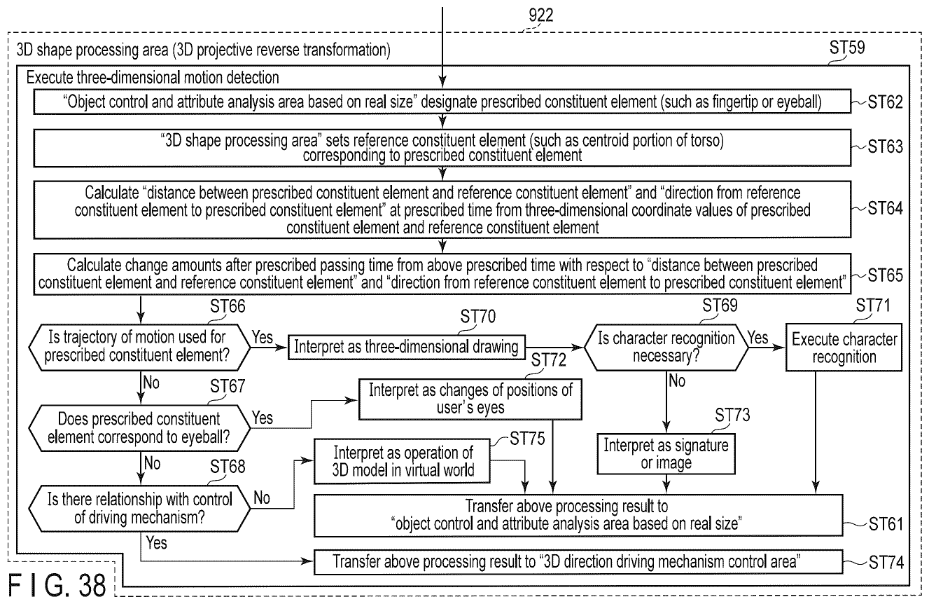

FIG. 38 illustrates a method example of a handling process at the time of three-dimensional motion detection. In step 59 in FIG. 32, “execution of three-dimensional motion detection” has already been described. FIG. 38 illustrates a specific example thereof. Therefore, after step 58 in FIG. 32 in which it is determined that “three-dimensional motion detection is required”, the “3D shape processing area (3D projective reverse transformation) 922” executes step 62 in FIG. 38. Note that the “3D shape processing area (3D projective reverse transformation) 922” may execute all the processes in FIG. 38.

The embodiment example of step 60 in FIG. 32 has been described the method in which the user designates “a size change of a part of the three-dimensional shape” when the user moves a part of the body of the user (the user's fingers etc.) in a displayed area of the three-dimensional shape (the three-dimensional display 18). As described above, in the present embodiment example, three-dimensional motion of the user in the real world (three-dimensional motion detection result) may be used as a “three-dimensional pointer”. In addition, the present invention is not limited thereto, and three-dimensional motion may be used for inputting and controlling multi-functions such as “three-dimensional tracer”, “three-dimensional controller (three-dimensional remote controller)”, a “display control function for a three-dimensional display space (movie)”, a “three-dimensional size adjuster (of a three-dimensional display space size or the like)”, a “control key function in three-dimensional layout”, a “jump instruction function for starting specific processing”, an “input function (or a setting function) of a prescribed concept or a prescribed image (for example, using a sign-language motion)”, a “high-speed input/control function for text literature generation (for example, using a sign-language motion)”, and an “audio information generation function”.

As a method of exhibiting the various functions described above, for example, the three-dimensional shape of a part of the body of the user may be changed at the time of executing the three-dimensional motion of the user, and a corresponding function may be switched. For example, in a case where the user performs three-dimensional motion input (or motion control) using a motion of a hand or a finger, a target function to be input or controlled may be switched by changing a three-dimensional shape of the hand or the finger.

There is a limit to a length of a human hand. An example of the present embodiment example in a case where three-dimensional pointing or three-dimensional tracing is performed at a location beyond an area that the user can reach in a virtual three-dimensional space will be described. As described above as the present embodiment example, the “display control function for three-dimensional display space (movie)” is provided. Therefore, it is possible to provide free movement in a three-dimensional display space. Furthermore, when the three-dimensional projective transformation technique described in the first half of Chapter 2 is used, both-eyes positions of the user in the virtual three-dimensional space can be freely changed.

Therefore, as explained below, the present embodiment may provide a method in which the user can perform the three-dimensional pointing or the three-dimensional tracing at a location beyond an area that the user can reach in the current three-dimensional display space. As shown in FIG. 6 (a), the user may easily move (change the user's position) in the virtual three-dimensional space when the user moves the user's right side forefinger. And then, both-eyes positions of the user may move to a target position of three-dimensional pointing or three-dimensional tracing in the virtual three-dimensional space. By moving to a position where the user can reach by hand (virtually) as described above, the user can easily perform the three-dimensional pointing or the three-dimensional tracing everywhere in the virtual three-dimensional space.

As an application example of the present embodiment, the present embodiment is not limited thereto, and the user may change a display distance size in a specific direction. In the emphasized three-dimensional projective transformation described with reference to FIGS. 22 (c) and 22 (d), the method of enlarging a scale in a depth (front-rear) direction has been described previously. Therefore, the user can reduce a display scale in only a specific direction (for example, a depth (front-rear) direction) in the virtual three-dimensional space. And then, the user can easily reach an object that has not been reached on a three-dimensional space before the scale reduction.

The above-described usage example of the three-dimensional motion detection result may be functionally largely divided into an “input function”, a “selection function”, and a “control function” of some information. As a method of specifically exhibiting this “selection function”, for example, menu selection or next processing selection at a processing execution branch point may be performed. A target (control target) of the last “control function” may correspond to at least one of
a] the driving mechanism 15 (such as a robot) existing in the real world outside the optical device 10 shown in FIG. 1,
b] display content itself displayed on the display 18 (for example, at least a part of a three-dimensional shape or a three-dimensional movie) shown in FIG. 5 or 25, and
c] content of processing executed in the optical device 10 or the service providing system 14 shown in FIG. 1, or the like.

Note that the largely classified functions described above may be combined as a function corresponding to the three-dimensional motion detection result. That is, for example, menu selection (an example of the selection function) is performed through a prescribed three-dimensional motion of the user, and remote control (an example of the control function) for a remote robot is started through a virtual remote control operation (air operation) of the user. Information to be displayed on the display screen (or voice output) of the robot is input (an example of the input function) through a corresponding gesture of the user as necessary. When the three-dimensional motions of the user are combined as described above, complicated composite processing can be easily executed at high speed.

Voice understanding and reading are basically one-dimensional information input means along time series. In comparison, an amount of information included in a two-dimensional image captured in the retina 156 of a human eye (monocular) greatly increases. In a three-dimensional shape extended to three dimensions, an amount of information and a presence feeling (impression) further increase. When a “three-dimensional motion” that moves along the time series is used, an amount of information to be input further increases. Furthermore, since the “three-dimensional motion” does not require a special tool, the convenience of the user is greatly improved.

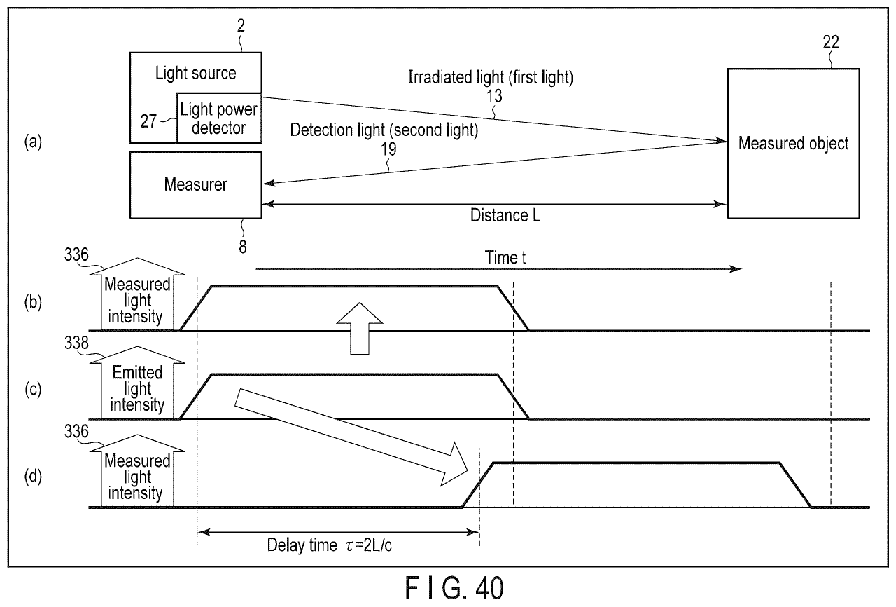

In the present embodiment example, as basically described with reference to FIG. 40, the measured object 22 is irradiated with the irradiated light (first light) 13, and the three-dimensional motion detection is performed using the detection light (second light) 19 obtained from the measured object 22. In the present embodiment example, when the irradiated light (first light) 13 with less optical interference noise that will be described later in Chapter 4 is used, highly accurate three-dimensional motion detection with less influence of optical interference noise can be performed. Further, when a distance measurement method that will be described later in Chapter 3 is used, three-dimensional motion detection with higher accuracy can be performed. In addition, the distance “L” to the measured object 22 (the distance “L” between the measured object 22 and the position having both the light source 2 and the measurer 8) can be freely set compared with the three-dimensional imaging using the conventional stereo method. For example, three-dimensional motion detection can also be performed on the measured object 22 disposed at a distance “L≥10 cm” of 10 cm or more. Moreover, a measuring sensitivity of the measurer 8 requests that the distance “L” is equal to or less than “10 km”. Therefore, the distance “L” to the measured object 22 (the distance “L” between the measured object 22 and the position having both the light source 2 and the measurer 8) may be “10 km≥L≥10 cm” (more than or equal to 10 cm and less than or equal to 10 km).

As described above, when highly accurate three-dimensional motion detection using a novel technique that is described later in Chapters 3 and 4 can be performed, it is possible to measure a time variation of a fine uneven shape, which has been difficult in terms of accuracy in conventional laser measurement, for example. A specific example thereof is described now. As illustrated in FIG. 26, the central part of the human crystalline lens 682 slightly swells with respect to the surroundings (vitreous body 154). In addition, human eyelids are very thin. Therefore, even in a state in which the eyes are closed, a position of the crystalline lens 682 can be ascertained from an unevenness situation distribution on the eyelids. For example, when a finger is placed on the eyelid with the eye closed and the pupil (crystalline lens 682) is moved, the movement of the pupil can be ascertained from the feeling of the finger. For example, a case is assumed in which a user who has been listening to quiet music with eyes closed wants to change the volume. If a motion of the pupil can be detected from above the eyelid through highly accurate three-dimensional motion detection, the user can adjust the volume while closing the eyes.

As another application example using highly accurate three-dimensional motion detection, user's emotion prediction may be performed. A user environment adjustment service according to the user's emotion may be provided. A user's potential emotion is said to appear in facial muscles (facial muscles). Furthermore, a relationship between the type of the user's potential emotion and the contracting expression muscle (which emotion causes which expression muscle to contract) is known to some extent. Animal muscles have the property of bulging upon contraction. Therefore, when the expression muscles of a part of the face contract, the part of the face swells. When a time variation of a swelling amount for each of the different facial expression muscles is detected as described above, it is possible to predict the undulation of the potential emotion of the user that varies from moment to moment to some extent.

For example, in a case where the user is depressed, a service of increasing the luminance of a lighting or switching to music that gives energy may be provided as the user environment adjustment service according to the user's emotion. This can gently encourage the user. On the other hand, in a case where the user is angry, a service for lowering the luminance of the lighting or switching to quiet music may be provided. A service for soothing the user's feeling can be provided.

There has been conventionally known a method of detecting motion of a user “two-dimensionally” using a “planar movie” that forms an image pattern thereof on an image sensing plane in a conventional imaging sensor (without a distance measuring function as in the imaging sensor 270 relating to a depth (distance) signal described in the present embodiment example). However, in the “two-dimensional motion detection” using the conventional imaging sensor, motion of the user in the direction along the optical axis (imaging view line) 384 of the image forming lens cannot be detected. Therefore, in the “two-dimensional motion detection”, only the “lateral motion of the user” can be detected. Therefore, an amount of information that can be collected through the conventional “two-dimensional motion detection” is limited. As a result, there is a large limit to a function that can be provided to the user by using the conventional “two-dimensional motion detection result”. In comparison, a much larger amount of information can be acquired from the “three-dimensional motion” of the user detected using the imaging sensor 270 relating to a depth (distance) signal having the length measuring function in the present embodiment example.

For example, taking “a state in which the user crosses two fingers” as an example, a large difference between a “two-dimensional motion detection result” and a “three-dimensional motion detection result” is described. For example, the user thinks that “he/she wants to associate a three-dimensional shape in which the two fingers come into contact with each other in an overlapping manner” indicating specific information. In the “two-dimensional motion detection” using the conventional imaging sensor, a “difference in position of the two fingers in the front-rear direction” cannot be ascertained. Therefore, “whether the two fingers are in direct contact” or “whether the two fingers separated from each other are accidentally seen crossing each other” cannot be determined. In comparison, in the “three-dimensional motion detection”, “position information of each of the two fingers in the front-rear direction” can be acquired. Therefore, “identification of a three-dimensional shape in which the two fingers come into contact with each other in an overlapping manner” can be accurately performed.

Here, the present embodiment example shows a change of “three-dimensional shape” comprising the two fingers. In addition, not limited to it, another present embodiment example may make a relation between another specific information and a “three-dimensional shape” (or a change of “three-dimensional shape”) expressed by (or comprising) another part of user's body or a three-dimensional structure of a combination between different prescribed objects. Therefore, there is an advantage that the present embodiment examples can provide the various functions described above to the user when the present embodiment examples use the “three-dimensional motion detection result” or the result of “three-dimensional shape change”.

As described with reference to FIG. 32, using the point set data acquired by the measurer 8, the “3D shape processing area (3D projective reverse transformation) 922” performs the separation and extraction (ST51) of a specific object. And then, the “3D shape processing area (3D projective reverse transformation) 922” identifies the inside of the specific object for each constituent element (ST56). Therefore, in the present embodiment example, a target of which “three-dimensional motion” is detected corresponds to “Constituent elements in the separated and extracted specific object”.

As a specific example of this “constituent element”, any location for detecting a motion such as eye movement (a change in a pupil position or motion of the eyelid), a motion of the head (nodding or horizontal shaking of the head), or a motion of a hand or a finger of the user may be set. Furthermore, not only a part of the user's body but also a motion using a specific tool may be utilized. For example, as “utilization of tools” for a user who is not accustomed to input and control using a three-dimensional motion, a motion such as a conventional mouse operation or a motion of a finger of the user on a touch pad disposed on a plane may be detected.

As described above, a method of providing a service to the user by combining the largely classified functions (functions such as input/selection/control) corresponding to the three-dimensional motion detection result will be considered. In order to provide such a composite service, processing of the “object control and attribute analysis area 924 based on a real size” that integrates the areas 922, 926, 928, and 930 in the virtual 4-dimensional (time-space) platform 916 is required.

Therefore, at the beginning of the execution of the three-dimensional motion detection (ST59 in FIG. 32), the “object control and attribute analysis area 924 based on a real size” designates a target portion for three-dimensional motion detection. That is, in step 62 in FIG. 38, the “3D shape processing area (3D projective reverse transformation) 922” may designate which part in the body (a prescribed constituent element in the object) such as a fingertip or an eyeball is to be detected.

For example, “a motion in which the user moves a hand or a finger while walking” may be performed. When motion detection is performed focusing only on the motion of the user's hand or finger, movement information of the user (the user's walking) is superimposed on the motion detection result. As a result, there is a risk of false detection of motion detection (the user's walking behavior influences the motion detection to reduce the detection accuracy).

Therefore, in the present embodiment example, a “three-dimensional relative motion” related to a prescribed constituent element (an eye or a hand) in an object (for example, a human) may be extracted, and the “three-dimensional relative motion” may be detected as a “three-dimensional motion”. Specifically, a difference amount between a “three-dimensional motion of the prescribed constituent element” and a “three-dimensional motion of a reference constituent element” affecting the same is extracted as a “three-dimensional relative motion”. That is, as a method of extracting the “three-dimensional relative motion”, the “3D shape processing area (3D projective reverse transformation) 922” may set a reference constituent element corresponding to the prescribed constituent element (ST63 in FIG. 38).

This paragraph explains an example of a relationship between the “reference constituent element” and the “prescribed constituent element” of which a three-dimensional motion is detected. Here, a motion of the “reference constituent element” affects another motion of the “prescribed constituent element”. For example, a case where “pupil positions” of both eyes of the user or “vertical movement of eyelids” of both eyes correspond to “prescribed constituent elements” will be exemplified. The “head motion” affects the three-dimensional motion of the “pupil positions” or “vertical movement of eyelids”. Therefore, in this case, the head corresponds to the “reference constituent element”. As another example, a case where the “prescribed constituent element” corresponds to the “tip of the finger” of the user will be considered. In this case, “torso motion” and “arm motion” affect the “three-dimensional motion detection of tip of the finger”. Therefore, in this example, the “torso” and the “arm” correspond to the “reference constituent elements”.

As a method of “three-dimensional motion detection” in the present embodiment example, “extraction of a time variant component of an imaged three-dimensional shape” may be performed. Specifically, using three-dimensional coordinate values of the prescribed constituent element and the reference constituent element, the “3D shape processing area (3D projective reverse transformation) 922” may calculate “a distance between the prescribed constituent element and the reference constituent element” and “a direction from the reference constituent element to the prescribed constituent element” at a prescribed time point (ST64).

In the next step 65, the “3D shape processing area (3D projective reverse transformation) 922” may calculate “a distance between the prescribed constituent element and the reference constituent element” and “the direction from the reference constituent element to the prescribed constituent element” again after a prescribed passing time from the prescribed time point. The calculation result at the prescribed time is compared with the calculation result after the prescribed passing time, and a change amount between the two is calculated. An amount of change between the two obtained as a result may be used as a “three-dimensional motion detection result”. The above description is merely an example of a “three-dimensional motion detection” method. Therefore, any method of extracting a time variant component of a three-dimensional shape (including, for example, a positional change of the user's eye) may be used as the “three-dimensional motion detection” method.

As described above, the “function” of connecting the “three-dimensional motion detection results” and the service content provided to the user using the detection result variously change according to “constituent elements that are three-dimensional motion detection targets” and the use purpose.

For example, when “a detection result of three-dimensional motion” is used for a “three-dimensional tracer” or a “text input function”, a “three-dimensional version of mouse drag” or a “three-dimensional version of “a tracing operation” on a touch pad or a touch panel” may be used. In this case, the present embodiment can also be used for applications such as “three-dimensional drawing”, “midair signature”, and “text character input”.

Correspondingly to the above description, in step 66, whether or not a trajectory of motion of the prescribed constituent element used (as a three-dimensional tracer) is performed. In a case of “using the trajectory of motion” as the determination result, it is interpreted as corresponding to three-dimensional drawing (ST70). In the case of being used for three-dimensional drawing, there are various use methods.

Therefore, in step 69, the “3D shape processing area (3D projective reverse transformation) 922” may judge whether or not text character recognition is necessary. Herein, the text character recognition indicates that “the content of handwritten text characters drawn three-dimensionally is recognized” and that “it is determined whether or not it is necessary to convert the text characters into printed text characters”. Here, in a case where text character recognition is necessary, the “3D shape processing area (3D projective reverse transformation) 922” may execute the text character recognition (ST71). On the other hand, in a case where text character recognition is not necessary, the content drawn three-dimensionally is interpreted as a signature or a three-dimensional image (ST73). In either case, the “3D shape processing area (3D projective reverse transformation) 922” may transfer the result to the “object control and attribute analysis area 924 based on a real size” (ST61).

As another example, in a case where a “detection result of three-dimensional motion” is used for a “three-dimensional controller (three-dimensional remote controller) in the real world (with respect to the driving mechanism 15 shown in FIG. 1)”, it is determined that “the detection result of three-dimensional motion is related to control of the driving mechanism 15” in step 68. After it is determined that “the detection result of three-dimensional motion is related to control of the driving mechanism 15”, the “3D shape processing area (3D projective reverse transformation) 922” may continuously transfer “the detection result of three-dimensional motion” to the “3D driving mechanism control area 928” (ST74).

On the other hand, when it is determined in step 68 that “the detection result of three-dimensional motion is not related to control of the driving mechanism 15 present in real world”, this “detection result of three-dimensional motion” is interpreted as “operating or controlling motion of the 3D model in the virtual world” (ST75). The “object control and attribute analysis area 924 based on a real size” may execute the motion control (operation) of the 3D model in the virtual world. Therefore, after it is determined that “the detection result of three-dimensional motion is used for motion control of the 3D model in the virtual world”, the “3D shape processing area (3D projective reverse transformation) 922” may continuously transfer the “detection result of three-dimensional motion” to the “object control and attribute analysis area 924 based on a real size”.

The above description has been described the example of the method of adapting the processing content according to the “function determination result” linking the “three-dimensional motion detection result”. In addition, there is also a method of adapting processing content according to a constituent element (for example, a target part in the user's body) that is a target of three-dimensional motion detection. For example, in a case where the motion of the eye movement (positional change) of the user is detected as a three-dimensional motion, a “display control function of three-dimensional display space (movie)” is overwhelmingly handled in many cases.

As described previously, the three-dimensional projective transformation showed the method of “setting both-eyes positions of a user in the three-dimensionally configured virtual world”. And the description has been made in which “when detecting changes in the both-eyes positions of the user, the both-eyes positions of the user in the virtual world are reset” in combination between step 34 and step 31 in FIG. 20. Here, the “detection of changes in the both-eyes positions of the user” corresponds to “detection of motion (positional change) of eye movement of the user as three-dimensional motion”. The “change of a three-dimensional image (three-dimensional movie) displayed to the user according to changes of both-eyes positions of the user in the virtual world” corresponds to the “display control of a three-dimensional display space (movie)”.

That is, as the determination result in step 67, if “the prescribed constituent element corresponds to the eyeball (or pupil) of the user”, the three-dimensional motion detection result related to a position of the eyeball (pupil) is “interpret as changes in the both-eyes positions of the user” (ST72). And the “3D shape processing area (3D projective reverse transformation) 922” may transfer the three-dimensional motion detection result to the “object control and attribute analysis area 924 based on a real size” (ST61). The “object control and attribute analysis area 924 based on a real size” may set the both-eyes positions of the user in the three-dimensionally constructed virtual world. The “3D image (movie) generation (3D projective transformation) and 3D display control area 926” displays a three-dimensional image (three-dimensional movie) to the user.

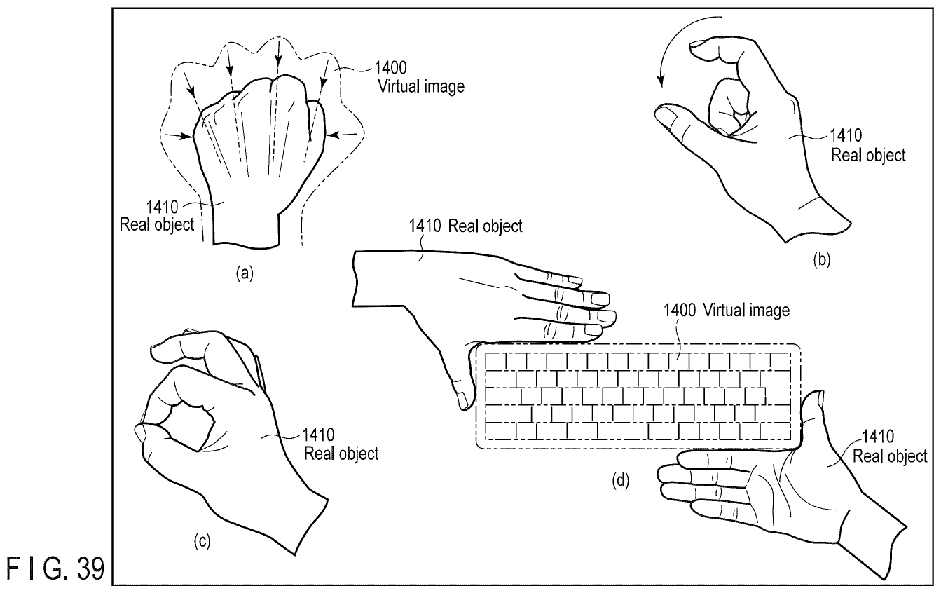

FIG. 39 illustrates a function example using a detection result of a three-dimensional motion of the user's hand or finger. Here, usage examples as the “three-dimensional size adjuster (of a three-dimensional display space size or the like)” and the “control key function in three-dimensional layout” are described. For example, when the three-dimensional shape displayed in FIGS. 5 and 6 can be displayed in “real sizes”, the presence feeling of the user is increased and the work efficiency is improved.

The term “real size” mentioned herein indicates a state in which a size of a displayed three-dimensional shape matches a size of a part (specific part) of the user's body. Specifically, for example, a situation in which a keyboard is three-dimensionally displayed in FIGS. 5 and 6 is assumed. When a size of the keyboard matches a size of the user's hand, the user can easily tap the keyboard.

FIG. 39 (a) illustrate both the real object 1410 located in the real world viewed by the end user 1080 at the time of size adjustment and a virtual image 1400 located in the virtual world (three-dimensional shape displayed on the display 18) in an overlapping manner. Herein, the measurer 8 images the left hand of the end user 1080 in real time. When the display 18 shown in FIG. 5 or 6 has the three-dimensional display function, the display 18 can show the virtual image 1400 (three-dimensional shape) located in the virtual world. And FIG. 39 (a) indicates the imaged left hand of the end user 1080 as the virtual image 1400 (three-dimensional shape) and the real left hand 1410 of the end user 1080. Regarding the left hand of the same end user 1080, FIG. 39 (a) illustrates an example in which the virtual image 1400 located in the virtual world is displayed larger than the real left hand 1410.

FIG. 39 (b) illustrates the right hand of the end user 1080 corresponding to the real object 1410. For example, with respect to a distance between the thumb and the index finger of the right hand, the fingers are moved such that “a speed to reduce the distance is high, and a speed to increase the distance is low”. The measurer 8 in FIG. 39 (a) captures an image of the motion, and the “3D shape processing area (3D projective reverse transformation) 922” interprets the motion as “an instruction to reduce the size of the virtual image 1400 (displayed three-dimensional shape) located in the virtual world”.

In order to change the display size of the virtual image 1400 (displayed three-dimensional shape) located in the virtual world, the user may achieve the following sequential action:
A) defining a moving direction depending on an orientation of the ball of the right index finger (a side opposite to the nail) of the end user 1080; and
B) a difference in stretching speed of the right hand index finger of the end user 1080 (a difference between a speed of bending the finger and a speed of stretching the finger).

Here, according to FIG. 39 (b), the measurer 8 measures a front-rear direction distance to the real object 1410 (the left hand of the end user 1080) in real time. Furthermore, in FIG. 39 (a), the real object 1410 related to the left hand of the same end user 1080 and the virtual image 1400 (displayed three-dimensional shape) located in the virtual world are displayed in an overlapping manner. Therefore, as another embodiment example, a front-rear direction distance of the virtual image 1400 (displayed three-dimensional shape) located in the virtual world may be automatically adjusted to a front-rear direction distance to the real object 1410 (left hand of the end user 1080).

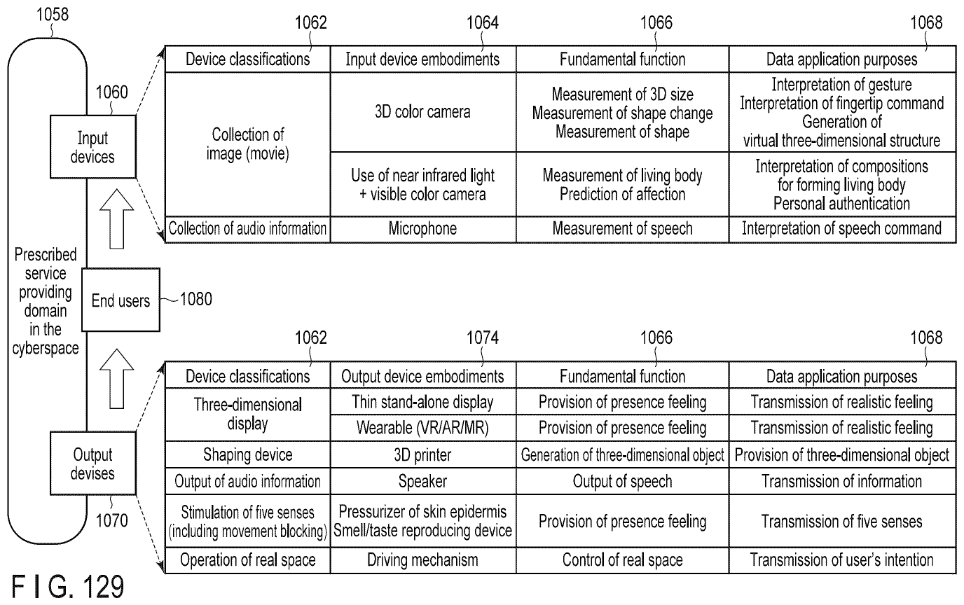

In a case where the size matching between the real object 1410 and the virtual image 1400 (displayed three-dimensional shape) located in the virtual world is completed, an “OK mark” may be displayed with the fingertip on the right hand (real object 1410) of the end user 1080 as illustrated in FIG. 39 (c). This “enter information” may be transferred to a prescribed service providing domain 1058 side in the cyberspace shown later in FIG. 129. The “OK mark” in FIG. 39 (c) corresponds to the above-described use as the “control key function of three-dimensional layout (corresponding to typing of an enter key)”.

Instead of changing a display position and a display size of the virtual image 1400 (displayed three-dimensional shape) located in the virtual world by using the method in FIG. 39 (b), a position and a size of the virtual keyboard may be designated with both hands of the end user 1080 that are the real objects 1410 as illustrated in FIG. 39 (d).

Various functional examples corresponding to the “three-dimensional motion detection result” have been described above. The three-dimensional motion content of the user specifically corresponding to the various functions is exemplified below. For example, a motion of the index finger of the right hand in FIG. 6 (a) may have the “display control function for a three-dimensional display space (movie)” or the “function of a three-dimensional remote controller”. For example, in a case where the user enters a virtual three-dimensional space displayed in a pseudo manner, moving the index finger forward may correspond to “advancing”, and moving the index finger backward may correspond to “retreating”. There may be also a method of changing a visual field in accordance with rotation of the head. Furthermore, in a case of being connected to the driving mechanism 15 (such as a robot) in the real world, the driving mechanism 15 (such as a robot) shown in FIG. 1 may be moved in a direction corresponding to the motion of the finger. Furthermore, the shape of the left hand of the user in FIG. 6 (a) may correspond to an “input/setting function of a prescribed concept or a prescribed image”. As a specific example, information on “fight” in “handgrip” and information on “delight” in “open palm” may be input.

FIG. 6 (b) illustrates a situation in which the user types a virtual keyboard displayed as a three-dimensional shape. This virtual typing operation can be said to use the three-dimensional motion detection for the “control key function in three-dimensional layout” or the “high-speed input/control function for text literature generation”.

In a case where the three-dimensional motion detection result is used for a “three-dimensional pointer”, a “three-dimensional tracer”, a “jump instruction function”, or a “control key function”, a specific finger may be used for a “moment of moving forward” or a “period of continuous forwarding”. In addition, the present embodiment is not limited thereto, and, for example, “contact of two fingers” or “overlapping of two fingers” may be associated with “formation of a unique three-dimensional shape” (a timing of starting the formation or a formation period) with the hand.

FIG. 39 illustrates an example of generating input information with respect to a prescribed service providing domain in the cyberspace (FIG. 129) through a motion of the finger (finger action) of the user. A relationship between a motion of the finger of the user or a shape of the finger and input information is not limited to the above, and another relationship may be freely set. Furthermore, information input with respect to the “3D shape processing area (3D projective reverse transformation) 922” is not limited to a motion of the finger of the user, and another information input may be realized according to any method using the real object 1410. For example, a motion of the eyeball, a shape or a motion (gesture) of the entire body, and a motion or an expression of the face of the user may realize different information input with respect to the “3D shape processing area (3D projective reverse transformation) 922”. For example, when a three-dimensional motion detection result for a “sign-language motion” expressed by a gesture of the user is used, a complicated “literature input function” or “speech generation function” can also be achieved.

FIG. 39 illustrates an example of a relationship between input information and a motion of the finger or a shape of the finger of the user. Here, an embodiment example in which the user pre-registers a relationship between a prescribed shape (or a time variation thereof) of a specific part in the real object 1410 and input information is described. A simple relationship between a three-dimensional motion of the specific part (for example, the finger) of the user and input information may be initially set (default setting). For example, as an initial setting relationship, a cursor position may be set at a position indicated by the fingertip of the user's right hand in FIG. 6 (a). The shape of the finger indicating “OK” as illustrated in FIG. 39 (c) may correspond to the enter processing (registration execution). Alternatively, nodding (inclination in the front-rear direction) of the user's head may correspond to the enter processing (registration execution) as an initial state. Note that the user easily changes the relationship between input information and a prescribed shape (a three-dimensional motion) in the real object 1410 from the initial setting relationship in the middle.

Meanwhile, the present embodiment explains an example of environment for pre-registering the relationship between the three-dimensional motion and the input information. Herein, the present embodiment may presume the pre-registering environment in which the user can view the content displayed on the display 18 illustrated in FIG. 5 or FIG. 6. The user may select an item “pre-registration of relationship between three-dimensional motion and input information” from a menu that is first displayed to the user. In a case where the user wants to set a new relationship between a three-dimensional motion and corresponding input information as a specific method, the user points at the item “pre-registration of relationship between three-dimensional motion and input information”. At a stage at which the item “pre-registration of relationship between three-dimensional motion and input information” is highlighted, the display menu changes to an item selection/execution menu with the nodding of the user.

A “motion detection target part candidate item” may be displayed in the user's body in a menu form as a menu (selection item) of the “pre-registration of relationship between three-dimensional motion and input information”. As the display items corresponding to three-dimensional motion parts, for example, a “right hand”, a “left hand”, a “view line”, an “eyelid motion”, a “mouth”, and a “head” may be displayed. The user points at a corresponding item (candidate of three-dimensional motion part) in the display. At a stage at which the item selected by the user is highlighted, “OK” may be expressed in the form of a finger or a nodding motion. Therefore, the user performs the “selection/execution of motion detection target part”.

Next, a list of input information is displayed on the display 18. In the same manner as described above, the user selects input information and determines the content of the input information to be pre-registered. So a three-dimensional motion (formation of a specific three-dimensional shape or a time variation thereof) of the user corresponding to the input information (a new pre-registration of relationship between three-dimensional motion and input information) is registered. By repeating this series of operations, relationships between a very large amount of input information and three-dimensional motions can be registered in advance. Note that the above-described pre-registration method is merely an example. Therefore, any pre-registration method of pre-registering a relationship between a three-dimensional motion that can be detected using the measurer 8 and input information is included in the present embodiment example.

The present embodiment example has an advantage that a “relationship between a three-dimensional motion and input information” can be customized according to user's preference. Therefore, since an input setting according to the habit (or preference) of the user's individual behavior can be performed, the affinity with the user is increased. In the above-described pre-registration example, the three-dimensional motion indicates a motion of only a specific part of the user (fingers, view lines, a head, or etc.). However, the present embodiment is not limited to the above description, and a combination of motions of a plurality of parts in the user may be preset. For example, when “nodding” and “OK shape of the finger” are simultaneously performed (both are combined), this may correspond to “permanent fixation of determined content (prohibition of subsequent change)”. As described above, the types of the corresponding input information are greatly increased up to the combination of the three-dimensional motions of the plurality of parts. This enables very complicated information input with a simple motion of the user, and greatly improves the user's convenience.

At the end of Chapter 2, a specific example of the effect of three-dimensional motion detection provided in the present embodiment example is described. For example, a case of “proofreading a long manuscript” is taken as an example, and comparison with the related art is performed. In a case where the conventional “partial correction of a long manuscript” is performed using a personal computer, when the user finds a correction portion in a long document, the user is required to perform a plurality of processes including:
1) moving a mouse (or a touch pad) to move a cursor to a correction portion;
2) dragging the mouse to designate a correction area in a long literature;
3) releasing the hand holding the mouse and moving the hand to the keyboard position;
4) typing the “corrected literature” on the keyboard;
5) pressing the enter key to execute document correction;
6) moving the hand from the keyboard position to the mouse position; and
7) scrolling the long literature by operating the mouse to search for the next correction portion.

As can be seen from the above procedure, multiple movements of moving the arms between the mouse (or touch pad) and the keyboard are required. Such complicated work is required.

In comparison, when the three-dimensional motion detection provided in the present embodiment example is used, the user can easily correct a literature at a time without moving the arms. For example, in a case where the literature is corrected with only one hand of the user, the user easily corrects the literature with a series of the following operations:
1) only “moving the fingertip to a correction portion of a long literature displayed three-dimensionally” that corresponds to “moving a mouse” mentioned above;
2) a “slight shape change of the fingertip” indicating “correction area designation” that corresponds to “dragging the mouse to designate a correction area” mentioned above;
3) a “three-dimensional shape change of the hand” that corresponds to “releasing the hand holding the mouse and moving the hand to the keyboard position”;
4) typing the “corrected literature” on a virtual keyboard (air-typing);
5) another “three-dimensional shape change of the hand” indicating “OK” sign (a unique shape indicating “OK”) that corresponds to “pressing the enter key”;
6) another “slight shape change of the fingertip” that corresponds to “moving the hand from the keyboard position to the mouse position”; and
7) moving the fingertip to scroll the long literature.

Furthermore, “interlocking work between the eye movement of the user and the three-dimensional shape change of the finger (or hand)” may be used. For example, the work is divided into “scrolling of a long literature”, “designation of a correction portion”, “inputting of a literature after correction”, “fixation of correction”, and the like. Here, various eye movements such as view line motion, blinking, eye closing, and wink may correspond to the “pointing”, “tracing”, “scrolling”, “fixation”, and the like.

When a motion of the head of the user is added thereto, it is possible to efficiently process complicated work. Specifically, the “nodding of the head” may be used as the “enter key input” corresponding to the “correction fixation”, and the “horizontal shaking of the head” may be used as “job cancellation” or “deletion”.

As described above, when the three-dimensional motion detection provided in the present embodiment example is used, the user does not have to act the “arm motion” compared with the conventional work. As a result, not only the burden on the user can be reduced, but also the working time can be significantly shortened. In addition, the present embodiment is not limited thereto, and, since a three-dimensionally displayed image (or a three-dimensionally displayed movie) is three-dimensionally changed by positional changes of both eyes of the user, the search efficiency of the user is also greatly improved.

In the conventional “two-dimensional motion detection technique” using a “two-dimensional image” captured on the image sensing plane 394, only a two-dimensional motion can be detected. Therefore, there is a limit to an increase in types of information that can be input by the user. In addition, in the method of motion detection using the “stereo method” in which two imaging sensors are combined, an area in the depth direction cannot be made large, and therefore, true “three-dimensional shape input” is difficult. In comparison, when the techniques that will be described later in Chapters 3 and 4 are combined, a measuring area in the depth direction is remarkably increased, and extremely high measurement accuracy can be provided. As a result, the number of types of information that can be input by the user is greatly increased, so that the user's convenience is greatly improved.

Chapter 3 Description of example of optical distance measurement method that can be used for three-dimensional projective reverse transformation as present embodiment

As illustrated in FIG. 23, three-dimensional coordinate values of the points “A11” to “A33” configuring the measured object 22 disposed outside the measurer 8 can be calculated using the three-dimensional projective reverse transformation described in Chapter 2. For the calculation, distance information to corresponding points “A11” to “A33” is required for each of the pixels 271 of “all” to “a33” two-dimensionally arranged in the imaging sensors 270 and 280. In Chapter 3, a new measurement method example related to the distance information is described.

FIG. 40 is a diagram showing a basic principle of distance measurement (length measurement) using the present embodiment. In FIG. 40 (a), a location where the light source 2 having the light power detector 27 and the measurer 8 are arranged is separated from the surface of the measured object 22 by a distance “L”. FIG. 40 (c) shows a temporal change amount along the time “t” of the emitted light intensity 338 of the irradiated light (first light beam) 13 emitted from the light source 2.

FIG. 40 (b) shows a temporal change amount along the time “t” of the measured light intensity 336 measured by the light power detector 27. The light power detector 27 is incorporated in the light source 2. Therefore, the increase/decrease timing of the measured light intensity 336 measured by the light power detector 2112 long the time “t” is matched with the increase/decrease timing related to the emitted light intensity 338 of the irradiated light (first light beam) 13 illustrated in FIG. 40 (c).

FIG. 40 (d) shows a temporal change amount of the measured light intensity 336 measured by one pixel 271 in the imaging sensor 270 relating to depth (distance) signal in the measurer 8. The emitting light (irradiated light (first light beam) 13) from the light source 2 travels to the measured object 22 separated by the distance L. Then, a part of the light irregularly reflected by the surface of the measured object 22 travels toward the measurer 8 as the detection light (second light beam) 19. Here, the irradiated light (first light beam) 13 emitted from the light source 2 passes through the optical path of the distance 2 L until the irradiated light reaches the measurer 8 as the detection light (second light beam) 19. The required time “2 L/c” for reciprocation with respect to the light velocity “c” corresponds to the delay time “τ” until arrival.

Therefore, the increase/decrease timing of the measured light intensity 336 measured by one pixel in the imaging sensor 270 relating to depth (distance) signal in the measurer 8 is delayed by the delay time “τ=2 L/c” from the increase/decrease timing of the emitted light intensity 338 of the irradiated light (first light beam) 13 in FIG. 40 (c). The delay time “τ” is measured to measure the distance “L” to the measured object 22.

Incidentally, the temporal change of the measured light intensity 336 along the time “t” direction draws the same pattern in FIGS. 40 (b) and (d). Therefore, the description in Chapter 3 focuses on a method for calculating the delay time “τ” with high accuracy from the shift in the time “t” direction of the increase/decrease timing of the measured light intensity 336 between FIGS. 40 (b) and (d). The signal processor 42 may calculate the delay time “τ” using the entire increase/decrease pattern of the measured light intensity 336 in the time “t” direction.

That is, FIG. 40 (d) in which the time change of the measured light intensity 336 of the detection light (second light beam) 19 reflected on the surface of the measured object 22 and returned is measured is regarded as a “measured signal”. Then, the temporal change of the measured light intensity 336 in FIG. 40 (b) measured by the light power detector 27 is regarded as a “reference signal”. In addition, a method for performing “pattern matching processing”, “waveform correlation processing”, or lock-in processing may achieve as a calculation combination between the “measured signal” and the “reference signal”.

Alternatively, another measured signal may be used as the “reference signal”. For example, a standard substance having a known light reflection characteristic is set in the measured object 22, and the standard substance is arranged at a location of a distance (standard distance) measured with high accuracy in advance. The characteristic of the measured light intensity 336 obtained from the standard substance arranged at the standard distance may be used as the “reference signal”.

FIG. 41 illustrates a structure of a 3D color imaging sensor 1280 (which can correspond to length measurement). The measurer 8 described in FIG. 8 has the imaging sensor 270 relating to depth (distance) signal and the imaging sensor 280 detecting color signals. Not limited to the structure, The measurer 8 may have the 3D color imaging sensor 1280 which has both a function of the imaging sensor 270 relating to depth (distance) signal and other function of the imaging sensor 280 detecting color signals. The 3D color imaging sensor 1280 has various optical filters 1272 and 1274 arranged on the surface of each of the pixels 1262 and 1264 to be imaged, and the 3D color imaging sensor 1280 has wavelength limitation applied to light that can reach each of the pixels 1262 and 1264 to be imaged.

That is, immediately before pixels 1262-1 and 1262-2 detecting red and near infrared light, optical band pass filters 1272 adjusted to red and near infrared light passing through. In addition, immediately before pixels 1264-1 and 1264-2 detecting green and near infrared light, optical band pass filters 1274 adjusted to green and near infrared light passing through. In addition, immediately before pixels 1266-1 and 1266-2 detecting blue and near infrared light, optical band pass filters adjusted to blue and near infrared light passing through. Similarly, immediately before pixels 1268-1 and 1268-2 detecting white and near infrared light, optical band pass filters adjusted to white and near infrared light passing through. Here, near infrared laser light is used for distance measurement (length measurement) using laser light.

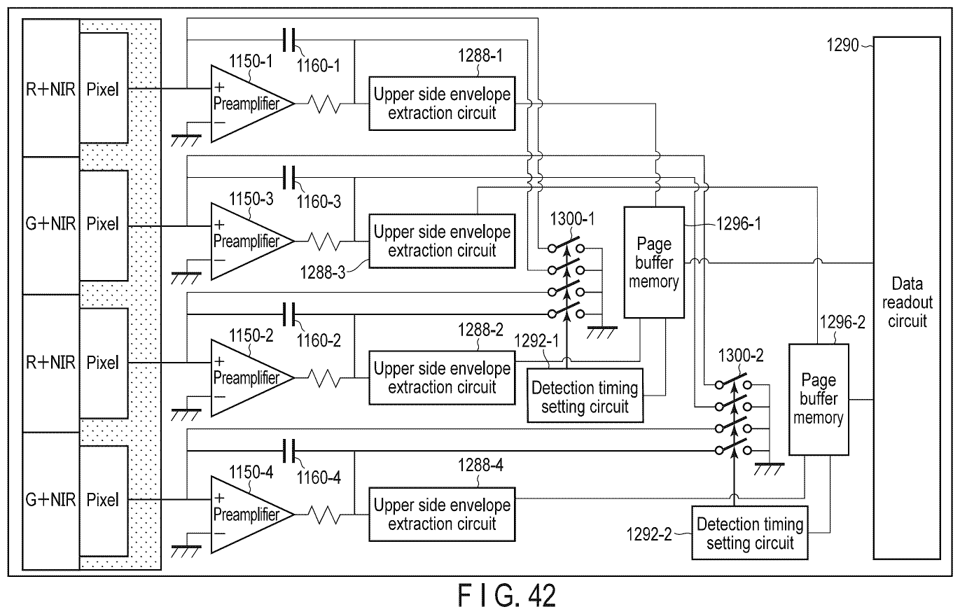

FIG. 42 illustrates (an equivalent circuit of) an electronic circuit in the 3D color imaging sensor 1280. Preamplifiers 1150-1 and 1150-2 are connected to the pixels 1262-1 and 1262-2 detecting red and near infrared light, respectively. Preamplifiers 1150-3 and 1150-4 are connected to the pixels 1264-1 and 1264-2 detecting green and near infrared light, respectively. During an exposure period, charges are accumulated in capacitors 1160-1 to 1160-4 according to detection signals of the preamplifiers 1150-1 to 1150-4.

Interlocking switches 1300-1 and 1300-2 are separately interlocked and turned on/off according to the exposure time and the non-exposure time. The exposure timing setting circuits 1292-1 and 1292-2 control the ON/OFF timings of the interlocking switches 1300-1 and 1300-2. Here, at the time of exposure, the interlocking switches 1300-1 and 1300-2 are separately disconnected, and charges are accumulated in the capacitors 1160-1 to 1160-4 respectively corresponding to the preamplifiers 1150-1 to 1150-4. Further, at the time of non-exposure, the interlocking switches 1300-1 and 1300-2 are separately disconnected, and detection signals from the respective pixels 1262-1 and 1262-2, and 1264-1 and 1264-2 in the 3D color imaging sensor 1280 are emitted toward a ground line. At the same time, the charges accumulated in the capacitors 1160-1 to 1160-4 are discharged.

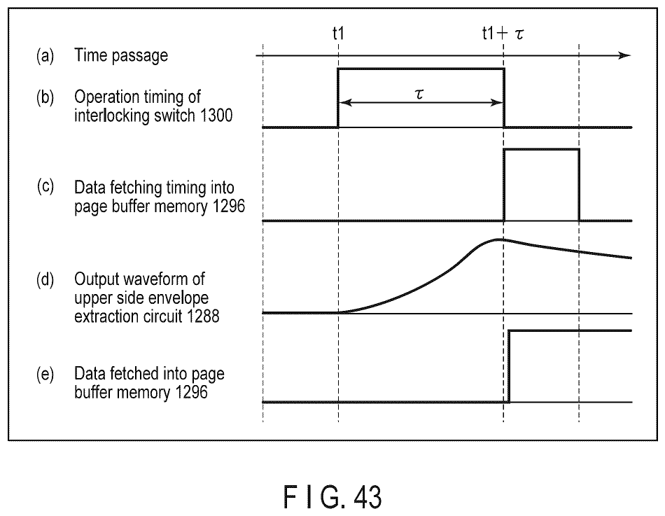

Upper side envelope extraction circuits 1288-1 to 1288-4 are individually connected to the preamplifiers 1150-1 to 1150-4. At the exposure end timing, output voltages of the upper side envelope extraction circuits 1288-1 to 1288-4 are temporarily stored in page buffer memories 1296-1 and 1296-2. In addition, output voltage data temporarily stored in the page buffer memories 1296-1 and 1296-2 periodically moves to the outside via a data readout circuit 1290. FIG. 43 illustrates control timing of the exposure timing setting circuit 1292 in FIG. 42. The exposure period (that is, a period in which the preamplifier 1150 continues to transmit a signal in which the detection signals from the pixels 1262 and 1264 in the 3D color imaging sensor 1280 are stored in the capacitor 1160 to the upper side envelope extraction circuit 1288) in FIG. 42 is defined as “τ”. Then, the connection of the interlocking switch 1300 is cut off only while time elapses from time “t1” to “t1+τ” (FIG. 43 (b)).

FIG. 43 (c) illustrates timing at which the output of the upper side envelope extraction circuit 1288 is fetched into the page buffer memory 1296. In this way, immediately after the end of the exposure period “t”, the output is fetched into the page buffer memory 1296.

FIG. 43 (d) illustrates an output signal waveform of the upper side envelope extraction circuit 1288 before and after the exposure period. Since the charge amount accumulated in the capacitors 1160-1 to 1160-4 before the exposure period is “0”, an output signal of the upper side envelope extraction circuit 1288 is held in a state of “0”. At the exposure period, charges start to be accumulated in the capacitors 1160-1 to 1160-4, so that the output signal of the upper side envelope extraction circuit 1288 starts to increase. Charges in the capacitors 1160-1 to 1160-4 are discharged immediately after the end of the exposure period “τ”, but the upper side envelope extraction circuit 1288 holds the state immediately before the end of the exposure period “τ”.

FIG. 43 (e) illustrates data fetched into the page buffer memory 1296. Data in the page buffer memory 1296 before the exposure period “τ” is “0” as an initial value. Immediately after the end of the exposure period “τ”, a data fetching instruction to the page buffer memory 1296 is output from the exposure timing setting circuit 1292. At the timing of the data fetching instruction, output data of the upper side envelope extraction circuit 1288 is fetched into the page buffer memory 1296. The fetched data is delivered to the data readout circuit 1290 at appropriate timing.

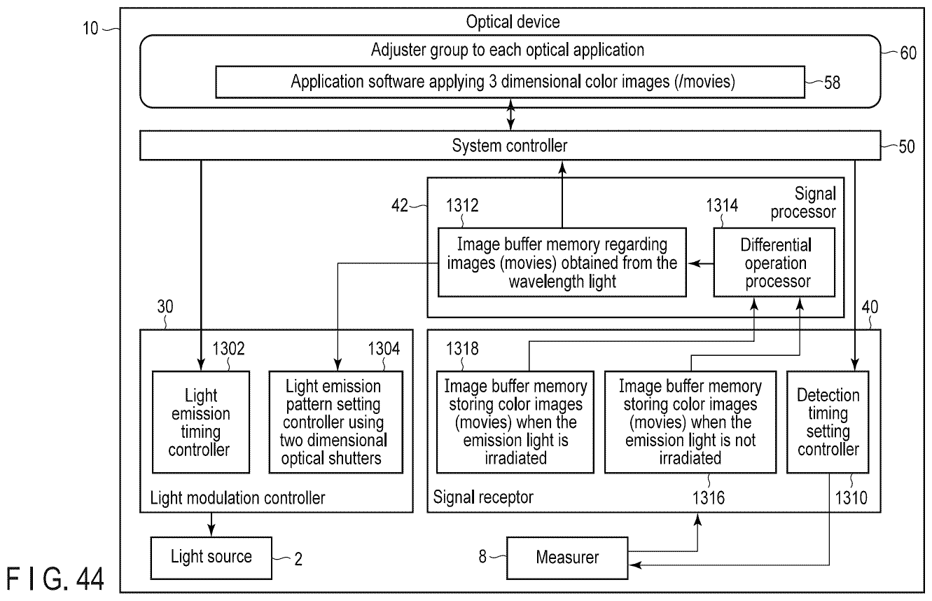

FIG. 44 illustrates a control circuit configuration of a 3D color imaging sensor 1280. By using this control circuit configuration, highly accurate length (distance) measurement for the measured object 22 is realized. A light emission timing controller 1302 in the light modulation controller 30 controls an intensity of near infrared light emitted from the light source 2. An image buffer memory 1316 storing color images (movies) when the emission light is not irradiated in the signal receptor 40 stores a color image (movie) collected by the 3D color imaging sensor 1280 in the measurer 8 at the time of non-light emission of the light source 2.

Next, the light emission timing controller 1302 in the light modulation controller 30 controls a continuous intensity of the emitted near infrared light in the light source 2. At the same time, an image buffer memory 1318 storing color images (movies) when the emission light is irradiated in the signal receptor 40 stores the color image (movie) collected by the 3D color imaging sensor 1280 at this time.

A differential operation processor 1314 in the signal processor 42 extracts a difference between color images (movies) depending on the presence or absence of light emission of the light source 2. The signal processor 42 includes an image buffer memory 1312 regarding images (movies) obtained from the wavelength light. And the image buffer memory 1312 stores the difference result obtained from the differential operation processor 1314. Then, the image buffer memory 1312 transfers the stored content to a light emission pattern setting controller 1304. Here, in the light modulation controller 30, the light emission pattern setting controller 1304 controls two dimensional optical shutters to set the light emission pattern of the light source 2. In other words, the light emission pattern setting controller 1304 controls the transmitted light intensity distribution characteristic in the two-dimensional optical shutters 530.

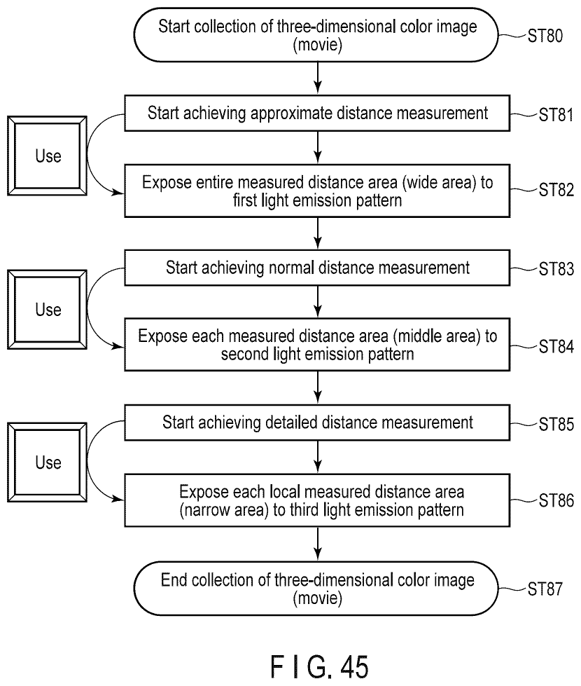

The control circuit in FIG. 44 performs not only the above control but also various types of timing control that are described later with reference to FIG. 45 and subsequent drawings. A detection timing setting controller 1310 in the signal receptor 40 performs various types of timing control that are described later. At the same time, the light emission timing controller 1302 in the light modulation controller 30 controls a light emission timing of the light source 2 in response to a command from the system controller 50.

The present embodiment example is not limited to the structure in which the light source 2 and the measurer 8 coexist in the optical device 10 illustrated in FIG. 44. In the present embodiment example, the light source 2 and the measurer 8 may be disposed at physically separated positions and connected to each other via the Internet. In this case, Internet communication may be performed between the light source 2 and the measurer 8 via a host.

The measurement content obtained by combining the 3D color imaging sensor 1280 and the light source 2 is used in the application software 58 using a 3D color image (movie) in the adjuster group 60 to each optical application (illustrated both in FIGS. 1 and 44). The 3D color image (movie) may be used for any service provision content.

FIG. 45 illustrates a method of performing three-dimensional color image (movie) measurement with high accuracy. Note that, here, for convenience of description, an expression of “three-dimensional color image (movie) measurement” is merely used. Therefore, any charge accumulation type signal receptor 40 and the light source 2 may be combined. In FIG. 45, the light source 2 may change a plurality of light emission patterns (a plurality of light irradiation patterns) to measure the three-dimensional color image (movie) regarding the measured object 22.

In the present embodiment example, for example, it is possible to measure a length in a very wide area such as a “100 m” area and a “1 km” area. It is difficult to measure a length with high accuracy at a time within such a wide measuring area. For example, it takes time to realize highly accurate measurement with a measurement error of 1 mm or less only by one measurement over the entire wide area such as “1 km”. In addition, high measurement accuracy is required only in the vicinity of a location where the measured object 22 exists. On the other hand, in a location where the measured object 22 does not exist, the high-accuracy measurement is not very meaningful.

Therefore, there is also a method of first ascertaining an approximate distance to the measured object 22 in a wide area, and then performing measurement with high accuracy in the vicinity of the measured object 22. When the present embodiment divisionally performs the measurement a plurality of times and stepwise changes a measuring area and a measurement accuracy as described above, the overall measurement efficiency is improved. The optimum light emission pattern may be switched for each measuring area and required accuracy. When the measurement using the plurality of light emission patterns is combined as described above, it is possible to measure a length of the measured object 22 at a distant position with high accuracy.

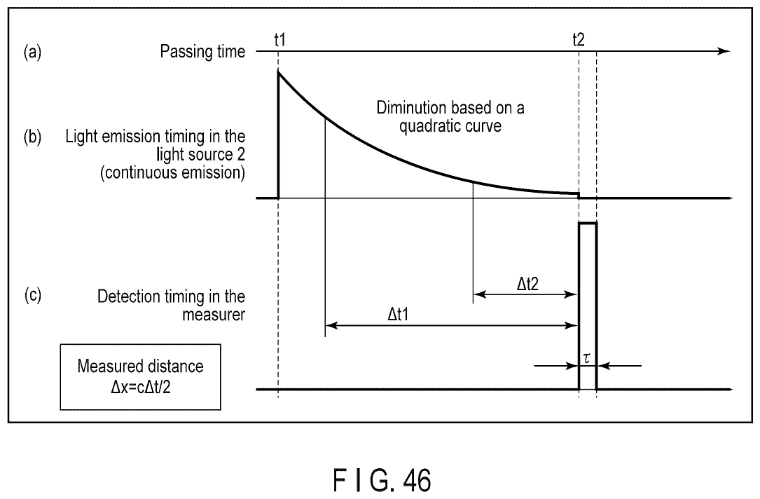

The present embodiment may use three different types of light emission patterns (a plurality of light irradiation patterns with respect to the measured object 22) between the start (ST80) and the end (ST87) for collecting three-dimensional color images (movies). When the present embodiment starts achieving approximate distance measurement in step 81, a light emission pattern described later with reference to FIG. 46 (b) may be used. In step 82, the present embodiment may expose entire measured distance area (wide area) to a first light emission pattern.

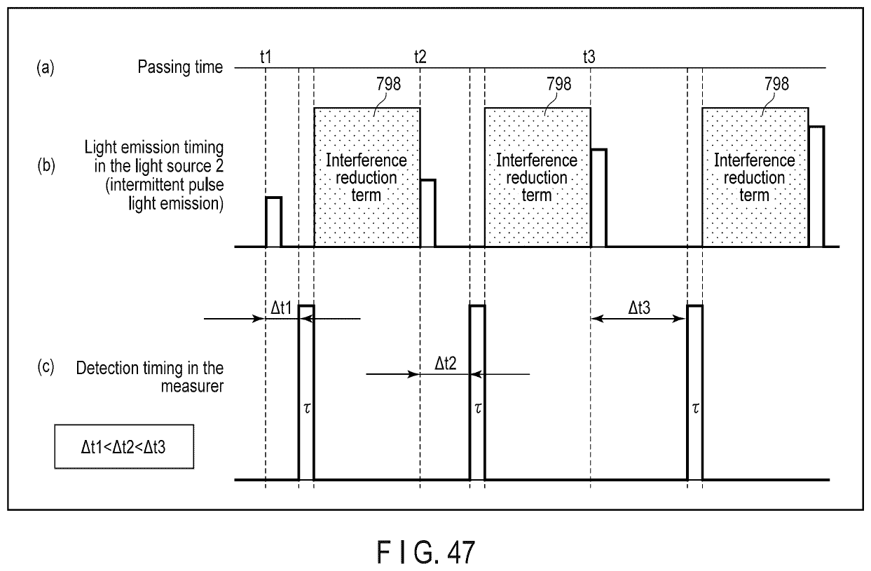

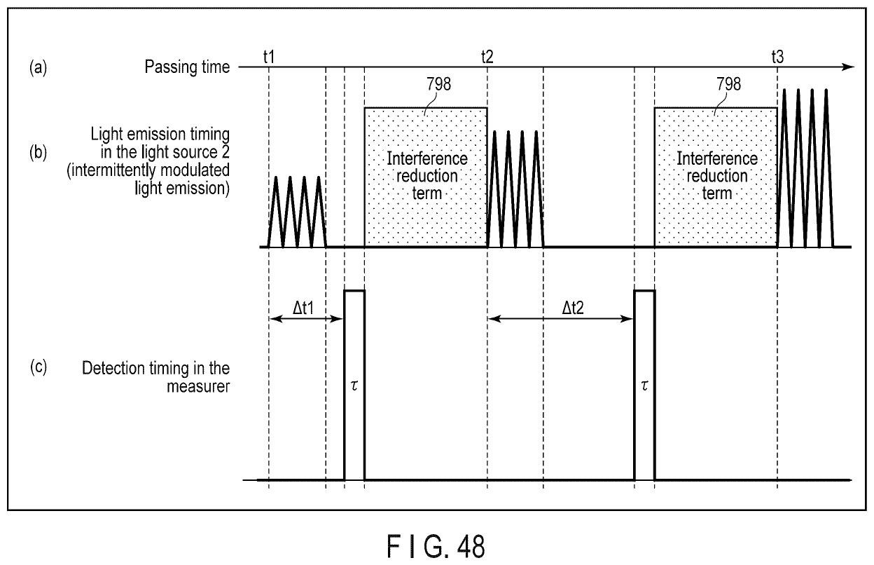

In the two-dimensional color image (movie) collection in the next step 83, the present embodiment may use a light emission pattern described later with reference to FIG. 47 (b). In other words, the present embodiment may start achieving normal distance measurement in the next step 83. In step 84, the present embodiment may expose each measured distance area (middle area) to a second light emission pattern. In the subsequent two-dimensional color image (movie) collection in step 85, a light emission pattern described later with reference to FIG. 48 (b) is used. In other words, the present embodiment may start achieving detail distance measurement in the step 85. In step 86, using a third light emission pattern, the present embodiment may perform measurement of each local measured distance area (narrow area).

FIG. 46 illustrates a method of imaging a reflected light pattern of the light source wavelength light in the entire measured distance area. An intensity of emission light from a light emission point is inversely proportional to the square of the distance from the light emission point. When a distance to the measured object 22 is measured using reflected light from the measured object 22, a distance from the light source 2 to the measurer 8 is twice the distance to the measured object 22. Therefore, the maximum emitted light intensity of the light source 2 is determined depending on a measuring area (the maximum distance from the light source 2 that can be measured). When a position of the measured object 22 is separated, it is necessary to increase the emitted light intensity of the light source 2.

FIG. 46 (b) illustrates a light emission pattern suitable for imaging a totally reflected light pattern over the entire measured distance area. In a light emission period from time point “t1” to time point “t2”, continuous light emission is performed, and an emitted light intensity is reduced along a quadratic curve with passing time. Therefore, uniform light reflection characteristics can be collected in the entire measured distance area.

FIG. 46 (c) illustrates a detection timing in the measurer 8 (3D color imaging sensor 1280). Immediately after the light emission stop time point “t2” of the light source 2, detection is performed for a period “t” (rectangular wave period). During this detection timing t, light beams that have left the light source 2 before “Δt1” or “Δt2” return together. The measured distance Δx has a relationship of “Δx=cΔt/2” (where c: speed of light in air). Therefore, as a measured distance area in this case, measurement is performed up to a distance of “c (t2−t1)/2”.

A totally reflected light pattern over the entire measured distance area can be ascertained from an image acquired at the detection timing in FIG. 46 (c). By comparing the obtained image (totally reflected light pattern over the entire measured distance area) with an image obtained in FIG. 47 that is described later, it is possible to ascertain an approximate distance for each fine area in the totally reflected light pattern over the entire measured distance area.

FIG. 47 illustrates a method of imaging a reflected light pattern at the light source wavelength light for each measured distance area. As illustrated in FIG. 47 (b), the light source 2 emits intermittent pulse light. In this intermittent pulse light emission, pulse light emission is performed at a constant cycle at time points “t1”, “t2”, and “t3”. An interference reduction term 798 corresponding to a prescribed period is provided within a certain cycle, and control is performed such that light emission of the light source 2 does not occur within the interference reduction term 798. When non-light emission control is performed within the interference reduction term 798, erroneous measurement of a distance based on pulse light emission at an erroneous timing can be prevented, and measurement accuracy is improved.

In addition, the emitted light intensity is changed for each light emission timing “t1”, “t2”, and “t3”. The phenomenon that a detection signal amount from the distant measured object 22 decreases has been described above. When the emitted light intensity is changed for each measured distance area desired to be measured as described above, a change in measurement accuracy for each measured distance area is prevented, and stable distance measurement over the entire measured distance area can be performed.

FIG. 47 (b) illustrates a rectangular pulse light emission state. However, the present embodiment is not limited thereto, and light may be emitted with “a modulation signal specific to the light source 2 (ID information signal of the light source 2)” during the pulse light emission period. When an optical system includes a plurality of light emitters 2 disposed at the same location, there is a risk that a light emission state from different light emitters 2 is erroneously detected in (the 3D color imaging sensor 1280 of) the measurer 8. Another photodetector 250 may be disposed in the measurer 8, and another photodetector 250 may simultaneously detect a unique modulation signal (ID information signal of the light source 2) different for each light source 2. When detection of a modulation signal unique to the light source 2 is used in combination with another photodetector 250, it is possible to detect an unnecessary light emission pulse from another light emitter 2 mixed during a detection timing “τ” in the target measurer 8. This significantly reduces the risk of erroneous detection in the optical system including a plurality of light emitters 2 disposed at the same location.

FIG. 47 (c) illustrates a detection timing in the measurer 8 (3D color imaging sensor 1280). The delay times “Δt1”, “Δt2”, and “Δt3” of the detection timings in the measurer 8 (3D color imaging sensor 1280) with respect to the light emission timing in the light source 2 are different for each of the light emission time points “t1”, “t2”, and “t3”. The measured distance area is switched by the change in the delay time. In FIG. 47, “Δt1<Δt2<Δt3”. However, the present embodiment is not limited thereto, and each delay time may be freely set as long as there is a margin of a certain value or more between the delay times “Δt1”, “Δt2”, and “Δt3”. Therefore, “Δt1>Δt2>Δt3” may be set.

Each image acquired in accordance with the same detection timing “τ” at each timing indicates a part in the image acquired in FIG. 46. Therefore, by comparing each image acquired here with the image acquired in FIG. 46, it is possible to ascertain an approximate distance for each area obtained by finely dividing the totally reflected light pattern over the entire measured distance area.

FIG. 48 illustrates a detailed distance measurement method within each measured distance area. The content of setting the interference reduction term 798 in the light emission state of the light source 2 (FIG. 48 (b)) and the content of changing the delay times “Δt1” and “Δt2” of the detection timing “τ” for each of the light emission time points “t1” and “t2” of the light source 2 (FIG. 48 (c)) coincide with those in FIG. 47.

As illustrated in FIG. 48 (b), a portion where the light source 2 intermittently modulates and emits light is different from that in FIG. 47 (b). In the intermittent light intensity modulation period in FIG. 48 (b), “uniform cyclic light emission” is desirable. Furthermore, at the time of light intensity modulation, a “duty ratio is desirably 50%”. As long as conditions of a “uniform cycle” and a “duty ratio of 50%” are satisfied as this light emission state, light may be emitted with any waveform. For example, a sine wave, a rectangular wave, or a triangular wave may be freely set.

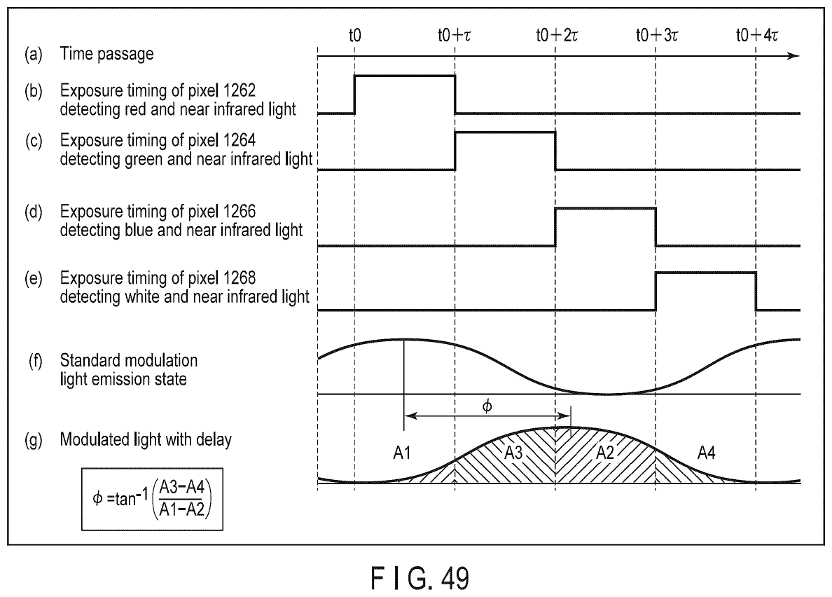

FIG. 49 is an explanatory diagram of a distance measurement (length measurement) method in the present embodiment. The structure in the 3D color imaging sensor 1280 has been described with reference to FIG. 41. Here, for distance measurement (length measurement), a set of four pixels 1262-1, 1264-1, 1266-1, and 1268-1 is used. Then, respective exposure timings are shifted in accordance with an emitted light intensity modulation state ((f) of FIG. 49) of the irradiated light (first light beam) 13 emitted by the light source 2.

FIGS. 49 (b) to 49 (e) illustrate a series of exposure timings regarding the four pixels 1262, 1264, 1266, and 1268, respectively. Here, all of the exposure period “τ” of the four pixels 1262 to 1268 is matched with each other. Then, the exposure timing is shifted by the exposure period “τ”. Here, as illustrated in FIG. 49 (f), a modulation light emission cycle “T” of the light source 2 is set to “4τ”. In a case where the detection light in

FIG. 49 (g) is shifted by a phase “o” with respect to the standard modulation light emission state in FIG. 49 (f), signal amounts input from the four pixels 1262, 1264, 1266, and 1268 to the page buffer memory 1296 (FIG. 42) correspond to area values of “A1”, “A2”, “A3”, and “A4”.

Therefore, a delay phase amount φ of the detection light can be calculated from

$$[ Equation 6 ]$$

$$ϕ = {tan}^{- 1} ( \frac{A 3 - A 4}{A 1 - A 2} ) \qquad Equation 6$$

By using this method, a delay amount of detection light (first light beam) 13 reaching the measurer 8 (3D color imaging sensor 1280 arranged in the measurer 8) can be known with high accuracy.

For example, “1 nS” is assumed as the exposure period “t”. Then, the cycle of the standard modulation light emission in FIG. 49 (f) becomes “4 τ=4 nS”. Assuming that the light velocity in the air is about 3×108 m/S and the reciprocating light with respect to the measured object 22 is detected, the above cycle is “3×108×4×10-9+2=0.6 m”. Therefore, in the exposure period “τ=1 nS”, an anteroposterior position change within a measurement distance range of 60 cm can be measured. The length measurement accuracy in this case is determined by the area accuracy of the “A1” to “A4” areas in FIG. 49 (g). Therefore, the technologies for reducing optical noise are very important.

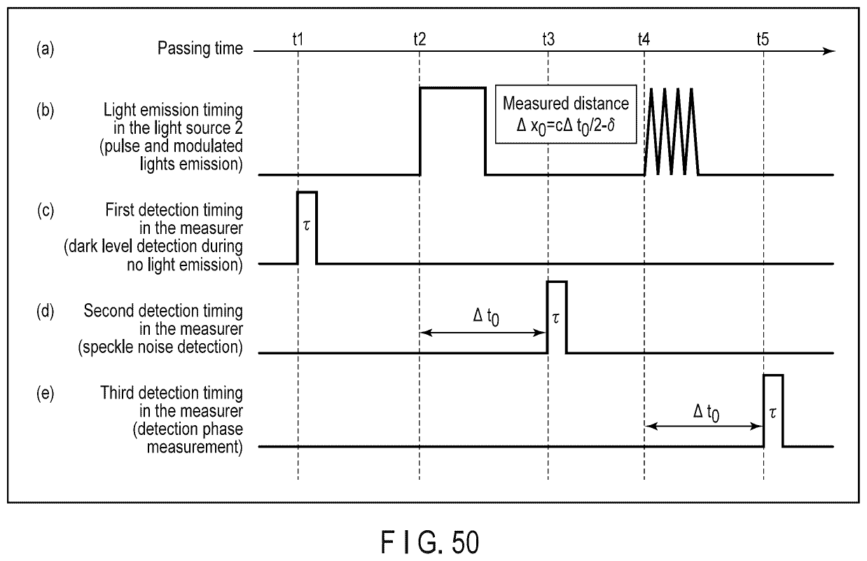

FIG. 50 illustrates a method of further reducing the influence of speckle noise by combining circuit techniques. The speckle noise is described in detail later in Chapter 4. FIG. 50 (b) illustrates a light emission state in the light source 2. The pulse light emission described with reference to FIG. 47 (b) is started from the time point “t2”. However, as described with reference to FIG. 47 (b), light emission modulation may be performed during this pulse light emission period. From the subsequent time point “t4”, the modulated light emission described with respect to FIG. 48 (b) is performed.

As illustrated in FIGS. 49 (b) to 49 (e), detection start time points of different pixels 1262-1 and 1264-1, 1266-1, and 1268-1 in (the 3D color imaging sensor 1280 of) the detection unit 8 are shifted from each other for each detection timing “τ”. However, the detection timings “t” between the different pixels 1262-1 and 1264-1, 1266-1, and 1268-1 all coincide. The signals detected during the detection timings “t” at different timings are separately stored as different signals in a page buffer memory 1296 (FIG. 42). In FIGS. 50 (c) to 50 (e), the detection timing “τ” corresponding to only a pixel 1262 is illustrated for simplification of description.

FIG. 50 (c) illustrates a timing of the first detection timing “τ” in (the 3D color imaging sensor 1280 of) the detection unit 8. The first detection timing “τ” starts from the time point “t1” before the light source 2 emits light. During this first detection timing “τ”, a color image (movie) of only visible light in the non-light emitting state of the light source 2 is captured.

FIG. 50 (d) illustrates the timing of the second detection timing “τ” in (the 3D color imaging sensor 1280 of) the detection unit 8. The second detection timing “τ” starts from the time point “t3” delayed by “Δt0” from the time point “t2” at which the light source 2 starts pulse light emission. During the second detection timing “τ”, an image (movie) is obtained by superimposing a reflected image (movie) obtained from wavelength light emitted from the light source 2 due to the pulse light emission on a color image (movie) obtained from visible light.

After “Δt0” from the timing at which the light source 2 starts pulse light emission, the second detection timing “τ” in (the 3D color imaging sensor 1280 of) the detection unit 8 starts. The time difference of “Δt0” indicates that a reflected image (movie) obtained from the wavelength light emitted from the light source 2 at a position separated by “Δx0=cΔt0/2” is superimposed.

The actual pulse light emission period of the light source 2 is much longer than the second detection timing “τ” in (the 3D color imaging sensor 1280 of) the detection unit 8. Therefore, the reflected image (movie) obtained from the wavelength light emitted from the light source 2 is superimposed on a location where the reflected image (movie) obtained from the wavelength light from the light source 2 is superimposed at a position separated by “Δx0=cΔt0/2-δ” shorter than “Δx0=cΔt0/2” by “δ”.

The important content here is that “speckle noise is mixed in the reflected image (movie) obtained from the wavelength light emitted from the light source 2”. A mixing rate of speckle noise is different among the four pixels 1262, 1264, 1266, and 1268 configuring a set. During the second detection timing “τ”, an image (movie) mixed with speckle noise for each of the pixels 1262 to 1268 is acquired.

Each area of “A1” to “A4” illustrated in FIG. 49 (g) indicates an ideal state without speckle noise. However, actually, an influence rate of speckle noise (a light intensity change rate generated by speckle noise) is different for each of the pixels 1262 to 1268. Therefore, when the influence of the speckle noise is taken into consideration, the levels of “A1” to “A4” in FIG. 49 (g) individually and greatly change due to the influence of the speckle noise.

Here, within a very short time range, the influence rate of speckle noise (a light intensity change rate generated by speckle noise) for each of the pixels 1262 to 1268 is constant regardless of the emitted light intensity in the light emitter 2. That is, it is considered that the influence rate of the speckle noise (a light intensity change rate generated by the speckle noise) for each of the pixels 1262 to 1268 is substantially equal in a case where the light emission pattern in the light emitter 2 has the modulated light emission state as illustrated in FIG. 49 (f) and the emitted light intensity in the light emitter 2 takes a constant value in the time direction.

FIG. 50 (e) illustrates a timing of the third detection timing “τ” in (the 3D color imaging sensor 1280 of) the detection unit 8. The third detection timing “τ” starts from the time point “t5” delayed by “Δt0” from the time point “t4” at which the light source 2 starts modulated light emission. For convenience of description on the paper surface, the interval between the time point “t3” and the time point “t4” in FIG. 50 is narrowed. However, actually, the interval between the time point “t3” and the time point “t4” is sufficiently wide. During the third detection timing “τ”, an image (movie) is obtained by superimposing a reflected image (movie) obtained from the wavelength light emitted from the light source 2 due to the modulated light emission on a color image (movie) obtained from visible light.

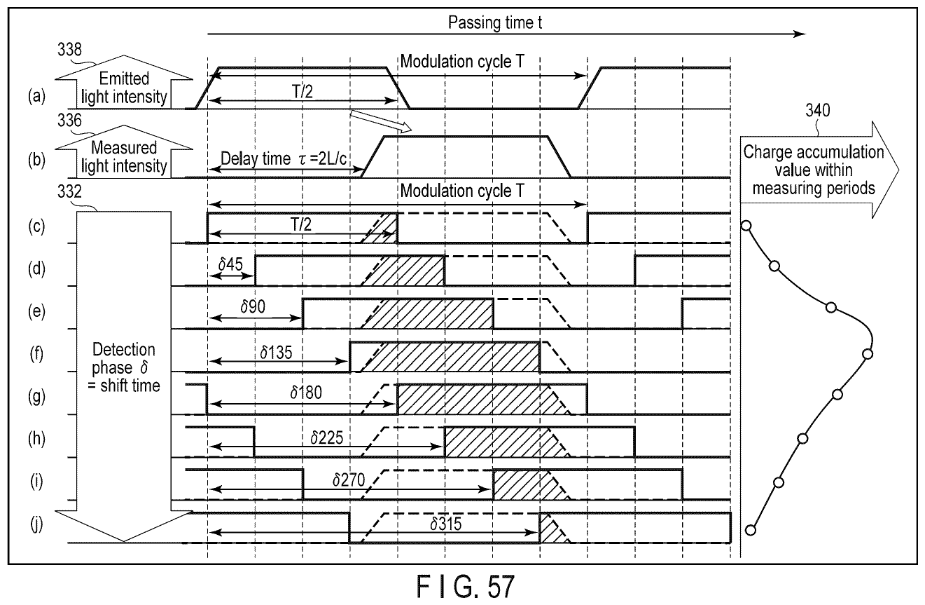

“Detection phase information obtained from the measured object 22” is included in the reflected image (movie) obtained from the wavelength light emitted from the light source 2. “The phase information obtained from the measured object 22” is buried in “the speckle noise of each of the pixels 1262 to 1268”. Therefore, “the influence rate of speckle noise for each of the pixels 1262 to 1268 (a light intensity change rate generated by speckle noise)”, which is first extracted information acquired during the second detection timing “τ”, can be used to extract “phase information obtained from the measured object 22” buried in speckle noise. Note that this phase information (a detection phase 332 or a light emission phase 342) is described later in detail with reference to FIG. 57 and subsequent drawings.

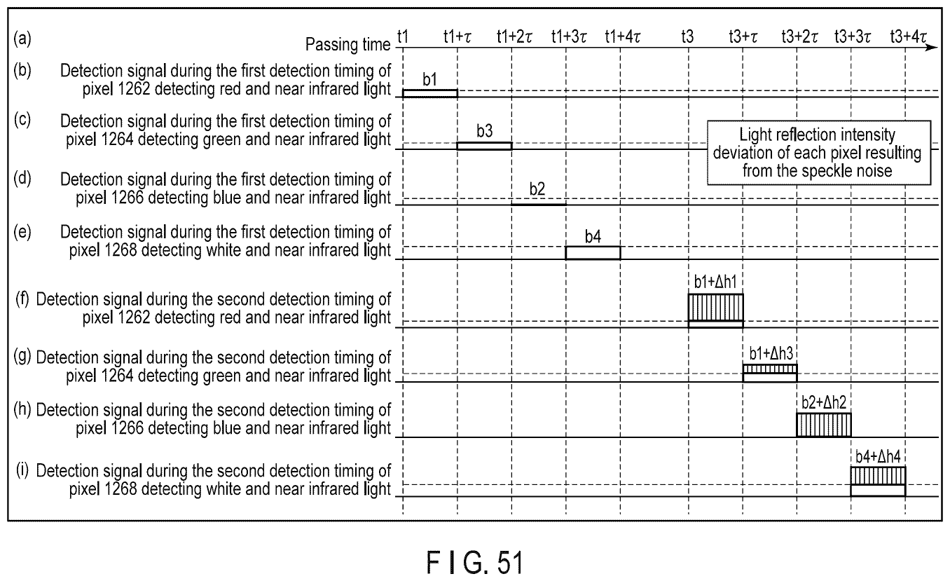

FIG. 51 illustrates detection signals for each pixel obtained during the first detection timing and the second detection timing. FIGS. 51 (b) to 51 (e) illustrate detection signals obtained for four pixels 1262 to 1268 configuring a set during the first detection timing “τ”. A red intensity b1, a blue intensity b2, a green intensity b3, and a white intensity b4 in the color information collected during the first detection timing “τ” are individually obtained. Furthermore, the detection timing “τ” is shifted every “τ” for each of the four pixels 1262 to 1268.

FIGS. 51 (f) to 51 (i) illustrate detection signals obtained for the respective four pixels 1262 to 1268 configuring a set during the second detection timing τ. Here, the detection timing “τ” is also shifted every “τ” for each of the four pixels 1262 to 1268. When there is no speckle noise, a light reflection intensity “Δhi” (1≤i≤4) for the wavelength light emitted from the light source 2, added to each color intensity “bi” (1≤i≤4) in the color information, indicates a substantially equal value. However, in a case where the speckle noise is large, the light reflection intensities “Δh1”, “Δh2”, “Δh3”, and “Δh4” added for every four pixels 1262 to 1268 are greatly different.

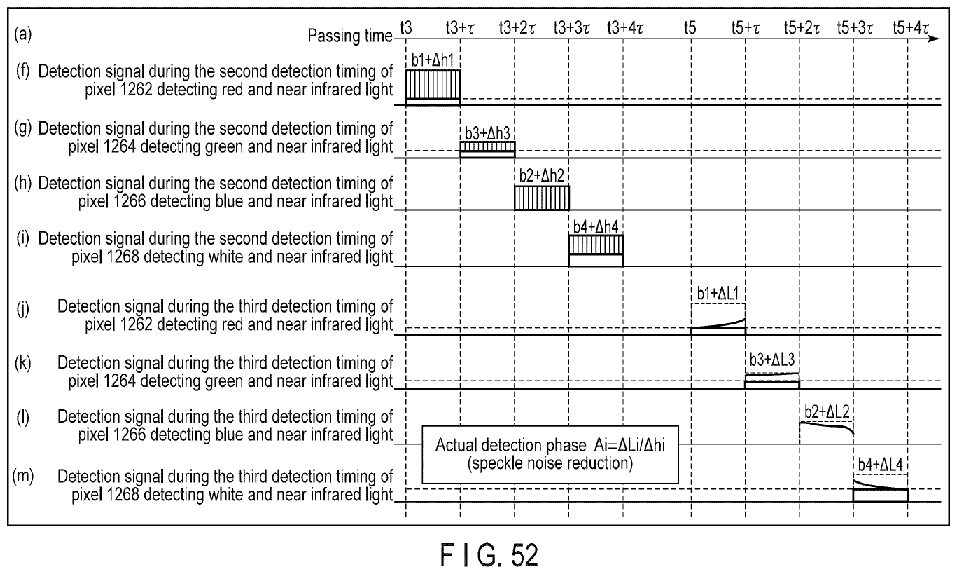

FIG. 52 illustrates detection signals for the respective pixels obtained during the second detection timing and the third detection timing. FIGS. 52 (f) to 52 (i) correspond to FIGS. 51 (f) to 51 (i). FIGS. 52 (j) to 52 (m) illustrate detection signals obtained for the four pixels 1262 to 1268 configuring a set during the third detection timing “τ”. Also in this case, the detection timing “τ” is shifted every “τ” for each of the four pixels 1262 to 1268. Values “ΔL1”, “ΔL2”, “ΔL3”, and “ΔL4” in which the detection phase information obtained from the measured object 22 corresponding to the modulated light emission of the light source 2 is buried in the speckle noise are added to each color intensity “bi” (1≤i≤4) in the color information.

When the time difference “t5−t3” between the start time point “t3” of the second detection timing “τ” and the start time point “t5” of the third detection timing “τ” is sufficiently small, it is considered that “Influence rate of speckle noise for each of the pixels 1262 to 1268 (a light intensity change rate generated by speckle noise)” substantially coincides between “ΔLi” and “Δhi” (1≤i≤4). An actual detection phase “Δi” from which the influence of the speckle noise has been removed can be calculated as “Δi=ΔLi/Δhi” (1≤i≤4). As described above, it is possible to extract the actual detection phase “Δi” mixed in the signal obtained during the third detection timing “τ” by using the influence rate of the speckle noise for each of the pixels 1262 to 1268 (a light intensity change rate generated by speckle noise) obtained during the second detection timing “τ”.

In the present embodiment example described so far, as illustrated in FIG. 41, a 3D color imaging sensor 1280 simultaneously performs “measurement of a distance to each point of the measured object 22” and “collection of color information region each point of the measured object 22”. In the present embodiment example, a distance measurement point and a color information collection point on the measured object 22 are located close to each other. Therefore, there is an advantage that alignment between the distance measurement point and the color information collection point can be easily performed. However, on the contrary, as illustrated in FIG. 41, since the distance measurement and the information collection of four colors (including white) are performed through a combination of the four pixels 1262 and 1264, 1266, and 1268, a spatial resolution with respect to an object decreases.

In another embodiment example described below, the imaging sensor 270 relating to a depth (distance) signal that “measures a distance to each point of the measured object 22” and the imaging sensor 280 detecting color signals that “collects color information regarding each point of the measured object 22” are separately disposed. With such separation, the existing imaging sensor 280 detecting color signals having a high spatial resolution can be used, so that there is an effect of improving the spatial resolution with respect to an object.

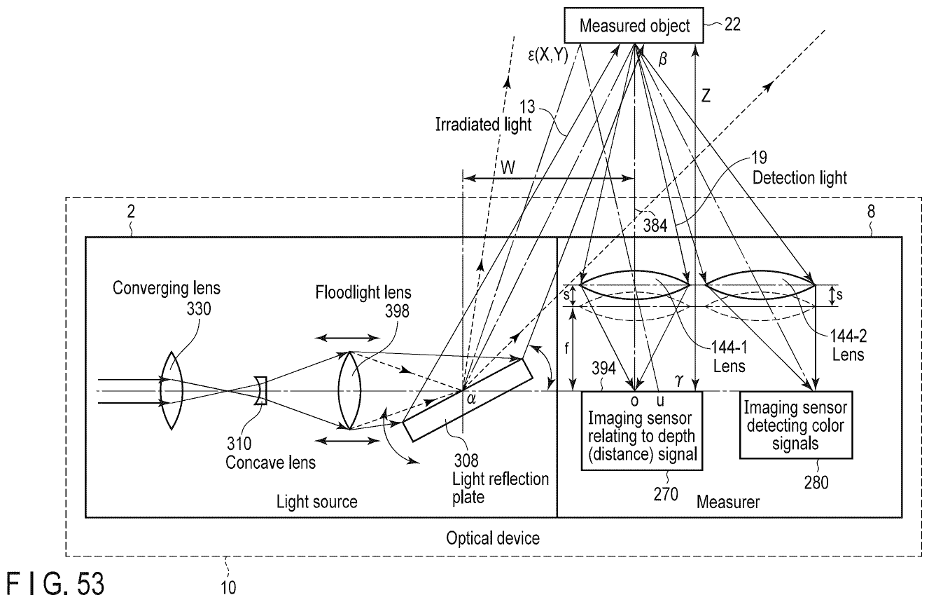

FIG. 53 illustrates an embodiment application example to the 3D color imaging sensor 1280 described in FIG. 41. In the embodiment example illustrated in FIG. 53, an image forming lens 144-1 for forming an image on the imaging sensor 270 relating to depth (distance) signal and an image forming lens 144-2 for forming an image on the imaging sensor 280 detecting color signals are individually arranged. In a case where an effective imaging size (width×height) of the imaging sensors 270 and 280 is determined in advance, the visual field (viewing angle) in which imaging can be performed is changed by changing the focal length “f” of the image forming lens 144. Therefore, the focal length to be set may be changed between the image forming lenses 144-1 and 144-2 according to the number of pixels of each of the imaging sensors 270 and 280. As a result, the resolution of the 3D image and the substantial resolution of the color image can be individually optimized.

Incidentally, a background image may be used to extract the feature image location commonly appearing in both the images. For example, a discrimination mark may be set on a part of a background object. In this case, first, the pixel position of the discrimination mark (or the outline of the discrimination mark) appearing in the 3D image output by the imaging sensor 270 relating to depth (distance) signal is extracted. Next, the pixel position of the discrimination mark (or the outline of the discrimination mark) appearing in the color image output by the imaging sensor 280 detecting color signals is extracted. Thereafter, size adjustment and center position adjustment between the two images are performed so that the pixel positions of the two images are matched with each other.

Due to the difference in focal length between the image forming lenses 144-1 and 144-2, an imaging range displayed in the 3D image may be smaller than an imaging range displayed in one (or one frame) color image. In this case, a plurality of (or a plurality of frames of) 3D images may be captured while the imaging positions of the image forming lens 144-1 and the imaging sensor 270 relating to depth (distance) signal are shifted. Then, one (or one frame) color image and a plurality of (or a plurality of frames of) 3D images may be combined to generate one (or one frame) 3D color image in advance.

When the distance between the optical device 10 and the measured object 22 increases, the emitting light density (irradiated light density) from the light source 2 decreases on the surface of the measured object 22. In the present embodiment example of FIG. 53, the floodlight lens 398 in the light source 2 is configured to be movable along the optical axis. The spot size of the emitting light (irradiated light 13) on the surface of the measured object 22 is variable. That is, the present embodiment may have a spot size changing mechanism located in an optical path of the irradiated light (first light) 13, and the spot size changing mechanism changes a spot size of the irradiated light (first light) 13 on the measured object 22. As a result, since the emitting light density on the surface of the measured object 22 can be changed, sufficient length measurement accuracy can be secured even if the measured object 22 is arranged far away. In addition, not limited to the floodlight lens 398, the present embodiment may another spot size changing mechanism. For example, the present embodiment may use a liquid crystal shutter or a local optical phase converting component as the spot size changing mechanism.

A light reflection plate 308 rotatable in two axial directions is arranged in the light source 2 in FIG. 53. When the light reflection plate 308 is inclined, a traveling direction of emitting light (irradiated light 13) emitted from the light source 2 changes. As a result, an arbitrary position on the surface of the measured object 22 can be irradiated with emitting light (irradiated light 12) having a small spot size. Then, the length measurement accuracy of the specific area in the imaging area of the imaging sensor 270 relating to depth (distance) signal can be improved.

That is, when emitting light having a small spot size is emitted only to the specific area, the irradiated light intensity (light density of the irradiated light (first light beam) 13) in the specific area increases. When the irradiated light intensity in the specific area increases, the measured signal obtained from the measurer 8 increases. As a result, an S/N ratio (signal to noise ratio) of the measured signal is improved, so that the measurement accuracy is improved.

The rotation center (point α) of the light reflection plate 308 is matched in two axial directions. This rotation center point (point α) may be set on an extension surface of the imaging plane of the imaging sensor 270 relating to depth (distance) signal. FIG. 53 shows that the traveling direction of emitting light (irradiated light 13) emitted from the light source 2 changes at the rotation center (point α) of the light reflection plate 308. Therefore, the present embodiment may change the traveling direction of emitting light (irradiated light 13) on the extension surface of the imaging plane of the imaging sensor 270 relating to depth (distance) signal. As shown in Equation 17 (Formula 17) for example, this arrangement facilitates calculation of distance data (measured distance) to the measured object 22.

As described above, an effective imaging size (width×height) of the imaging sensor 270 relating to depth (distance) signal is often determined in advance. In this case, when the focal length “f” of the image forming lens 144-1 is changed, an effective visual field range (effective viewing angle) of the imaging target is changed. In addition, a mount standard in which the imaging plane position of the imaging sensor 270 relating to depth (distance) signal is fixed and the image forming lens 144-1 having a different focal length “f” can be replaced is determined.

Therefore, when the rotation center point of the light reflection plate 308 is set on the extension surface of the imaging plane of the imaging sensor 270 relating to depth (distance) signal as in the present embodiment example, replacement with the image forming lens 144-1 having an arbitrary focal length “f” becomes possible, and it becomes easy to change the effective visual field range (effective viewing angle) of the imaging target.

The irradiated light (first light beam) 13 from the light source 2 is reflected (scattered) by the surface of the measured object 22, and then passes through the image forming lens 144-1. At this time, an optical path length from an “α point” to the imaging plane via a “β point” changes according to the change in distance to the measured object 22. Here, the “xx point” means the rotation center point of the light reflection plate 308. The length measurement target position on the measured object 22 corresponds to the “β point”.

The “γ point” is positioned on the surface of image sensing plane included in the imaging sensor 270 relating to depth (distance) signal. Herein, according to FIG. 53, a height of the image sensing plane 394 included in the imaging sensor 270 relating to depth (distance) signal is equal to a corresponding height of the image sensing plane 394 included in the imaging sensor 280 detecting color signals. In the present embodiment example, a change in an optical path length from the “α point” to the “γ point” is measured to calculate a distance “Lc” to the measured object 22 for each pixel. Not limited to the definition, the distance “Lc” relating to the measured object 22 for each pixel may be defined as an optical path length (distance) between the “β point” and a prescribed point included in the optical device 10.

According to the optical system described in FIG. 28, a distance “Z” represents a distance from the “β point” to “γ point” which corresponds to a position of the image sensing plane 394 included in the imaging sensor 270 relating to depth (distance) signal. And a distance “W” represents a direct distance (of straight line) from the “α point” to “γ point” which corresponds to an intersection point between an optical axis 384 of image forming lens 144-1 and the image sensing plane 394 included in the imaging sensor 270 relating to depth (distance) signal. Therefore, the optical path length passing through the “β point” from the “α point” to the “γ point” is “Lc=Z+(W2+Z2)½”. By using this relational expression, the distance data (measured distance) relating to the measured object 22 can be calculated by the above simple calculation formula.

In many image forming lenses 144, the front side principal plane and the rear side principal plane are separated from each other. Therefore, when the above-described “straight line passing through the optical axis center point position of the image forming lens 144” is strictly expressed, it needs to be described that the “straight line from the ‘B’ point to the center point in the front side principal plane of the image forming lens 144” and the “straight line from the center point in the rear side principal plane of the image forming lens 144 to the ‘γ’ point” are parallel. However, the light beam may be described under a condition that the front side principal plane and the rear side principal plane are virtually matched with each other by simplifying the description.

In FIG. 53, the irradiated light 13 (emitting light) reaching the measured object 22 does not pass through the image forming lens 144-1. However, unlike FIG. 53, an optical system that passes through the image forming lens 144-1 in the middle of the optical path of the irradiated light 13 (emitting light) may be set. In this case, the distance between the image forming lens 144-1 and the measured object 22 is common to the irradiated light 13 (emitting light) and the detection light 19. Therefore, in this case, the distance between the “β point” and the “γ point” may be a measured distance (distance data).

FIG. 54 shows another embodiment example relating to the optical system described in FIG. 53. According to FIG. 54, the detection light (the second light) 19 obtained from the measured object 22 passes through the same image forming lens 144. And a part of the detection light (the second light) 19 passing through the same image forming lens 144 arrives at the imaging sensor 270 relating to depth (distance) signal, and other part of the detection light (the second light) 19 arrives at the imaging sensor 280 detecting color signals.

The imaging sensor 280 detecting color signals can detect visible lights having wavelength range of “400 nm-750 nm”, and the imaging sensor 270 relating to depth (distance) signal is to detect a near-infrared light having wavelength range of “800 nm-2500 nm”. Therefore, utilizing the wavelength difference, a dichroic mirror 350 may divide the detection light (the second light) 19. For example, the near-infrared light may pass through the dichroic mirror 350 and be bound for the imaging sensor 270 relating to depth (distance) signal, and the dichroic mirror 350 may reflect the visible lights toward the imaging sensor 280 detecting color signals. Not limited to the method, the present embodiment may change the reflection and the transmission between the visible light and the near-infrared light.

In FIG. 54, the system controller 50 may include the image pattern adjusting processor 600 between 3D image patterns and color image patterns. The 3D image and the color image are combined for each pixel to generate a 3D color image (color image having information of distance data (measured distance) for each pixel).

In the image pattern adjusting processor between 3D image patterns and color image patterns 600, feature image locations that commonly appear in the 3D image and the color image are extracted. Then, size adjustment and center position adjustment between the two images are performed so that the feature image locations are matched with each other. As a method for performing size adjustment between images, thinning of pixel information (performed at the time of image size reduction), intermediate pixel insertion using pixel complementation (performed at the time of image size enlargement), and the like may be performed.

In a case where the surface shape of the measured object 22 is measured (measured in length) using the imaging sensor 270 relating to depth (distance) signal in FIG. 54, imaging processing at timing synchronized with pulsed light emission of the light emitter 470 is required. Therefore, pulsed light emission timing control from the system controller 50 to the light impulse control circuit 260 may be performed.

The present embodiment may use a surface emission type (multipoint light emitter type) laser diode VCSEL (Vertical Cavity Surface Emitting Laser) as the light emitter 470. High power irradiated light (first light) can be exposed to the measured object 22 because VCSEL can emit high power laser light. Since the light emitter 470 (VCSEL) has multipoint light emitters within a spatially wide light emitting area, an optical characteristic converting components 172 may be arranged in the near-field area 372 or the vicinity thereof in the middle of the optical path of the emitting light from the light emitter 470. Moreover, another optical characteristic converting component 178 may be arranged in the far-field area 378 in the middle of the optical path of the emitting light from the light emitter 470. Chapter 4 is to explain the optical characteristic converting component 172, 178 later.

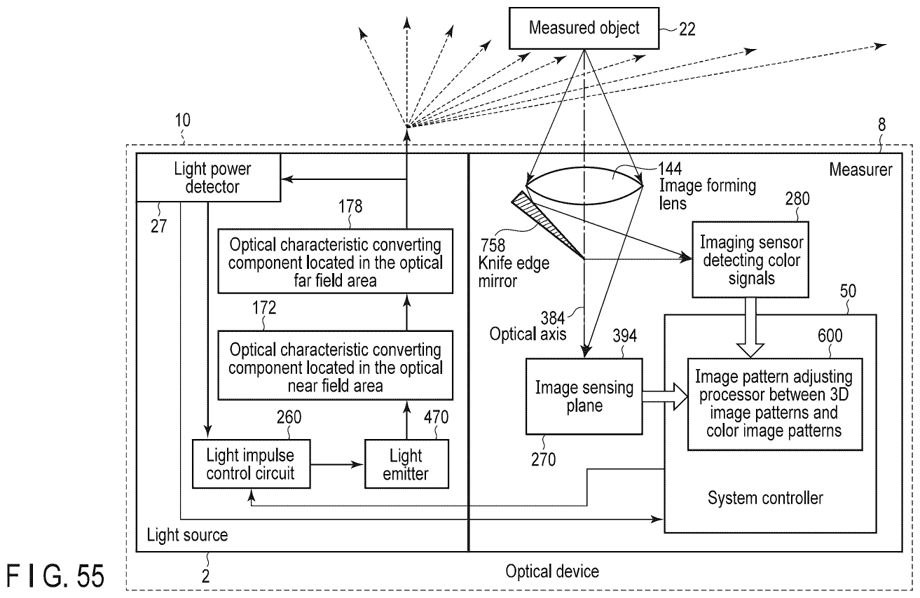

FIG. 55 shows an embodiment application example relating to the optical system described in FIG. 54. According to FIG. 55, the detection light (the second light) 19 obtained from the measured object 22 also passes through the same image forming lens 144. And a part of the detection light (the second light) 19 passing through the same image forming lens 144 also arrives at the imaging sensor 270 relating to depth (distance) signal, and other part of the detection light (the second light) 19 also arrives at the imaging sensor 280 detecting color signals.

FIG. 54 uses “light amplitude division (or light intensity division)” to divide the detection light (the second light) 19. On the other hand, the embodiment application example may use “wave-front division”. The “wave-front division” divides a cross section area included in a vertical (perpendicular) plane to light propagation direction into two or more areas.

The embodiment application example may use a knife-edge mirror 758 as one example to achieve the “wave-front division”. The knife-edge mirror 758 reflects a part of the detection light (the second light) 19 passing through the same image forming lens 144 to deflect toward the imaging sensor 270 relating to depth (distance) signal or the imaging sensor 280 detecting color signals. And other part of the detection light (the second light) 19 passing through the same image forming lens 144 directly propagates out of the knife-edge mirror 758 to arrive at the other imaging sensor 270, 280.

An edge line (boundary line) of the knife-edge mirror 758 may be located near the optical axis 384 of image forming lens (imaging view line). This position can evenly deliver light intensities to both of the imaging sensor 270 relating to depth (distance) signal and the imaging sensor 280 detecting color signals each other.

An edge line direction (boundary line direction) of the knife-edge mirror 758 may be approximately parallel to a gravitational direction. The edge line direction (boundary line direction) of the knife-edge mirror 758 can guarantee accurate 3 dimensional color images since a human stand figure has line symmetry between a right side and a left side.

As compared to a tilted flat plate included in the dichroic mirror 350 of FIG. 54, the “wave-front division” method prevents spherical and coma aberrations generated by the image forming lens 144.

A difference point between FIG. 55 and FIG. 54 merely corresponds to the difference between the dichroic mirror 350 and the knife-edge mirror 758. And the remaining parts of FIG. 55 are the same to FIG. 54. Therefore, the descriptions of the parts common to FIGS. 55 and 54 are omitted because they overlap.

FIG. 54 or 55 exposes a divergent irradiated light (first light) 13 emitted from one point on the optical devise 10 to the measured object 22. Not limited to the optical system, as shown in FIG. 53, FIG. 54 or 55 may have the light reflection plate 308, the floodlight lens 398, and the concave lens 310 positioned just after the concentrated point of the irradiated light (first light) 13.

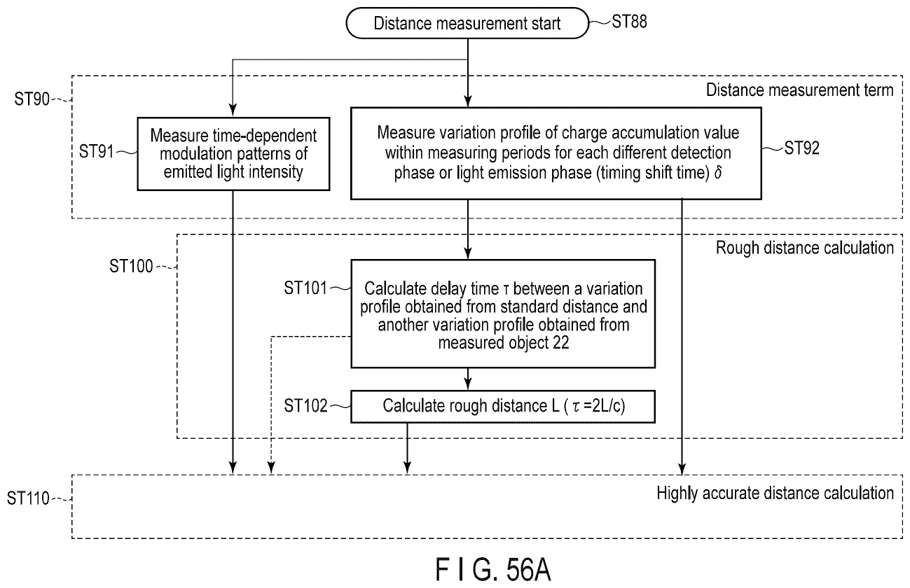

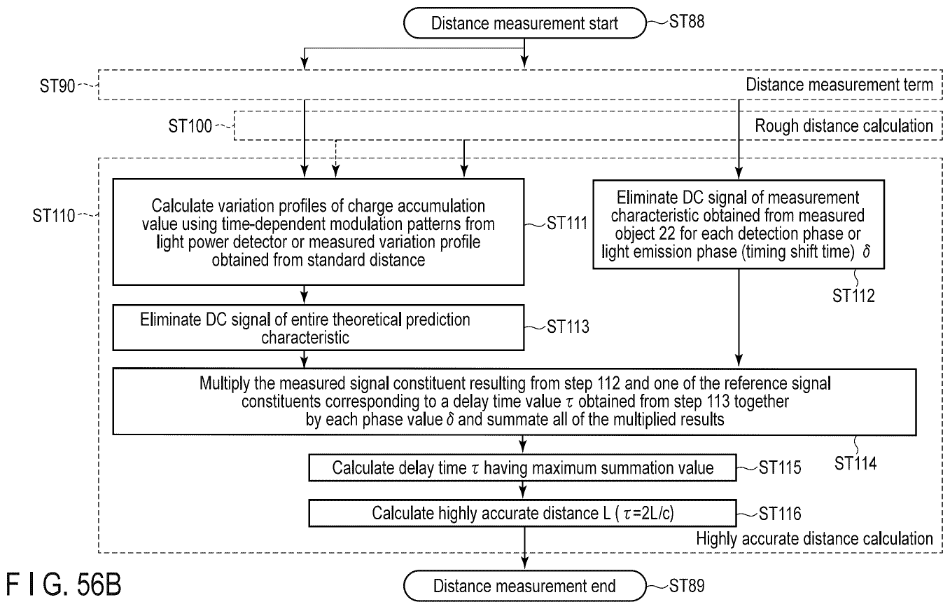

FIGS. 56A and 56B show an embodiment example of a procedure related to signal processing or data analysis using the measured signal performed by the signal processor 42. Here, the measured signal to be subjected to signal processing or data analysis corresponds to the “change characteristic of the charge accumulation amount 340 within the measuring periods when the detection phase or the light emission phase is changed” obtained in FIGS. 57 to 60. A procedure of signal processing or data analysis optimized to the characteristic of the measured signal is described in detail.

As shown in FIG. 56A, the measuring periods of step 90 starts when the user starts the distance measurement (ST88). Detailed description of each operation in the measuring periods (ST90) is made using a relation with each component in FIG. 54 or FIG. 55. In step 92, as the measured signal, the imaging sensor 270 relating to depth (distance) signal measures “a change characteristic of the charge accumulation amount 340 within the measuring periods with respect to the change amount of the detection phase or the light emission phase”. Then, the imaging sensor 270 relating to depth (distance) signal transmits the measured signal collected here to the signal processor 42. Herein, utilizing FIGS. 57 to 60, the detection phase and the light emission phase is described later.

In a case where the detection phase “δ” is controlled in order to measure the change characteristic of “the charge accumulation amount 340 within the measuring periods”, the system controller 50 sequentially transmits the setting value of the detection phase “δ” to the imaging sensor 270 relating to depth (distance) signal in a time-varying manner. On the other hand, when the light emission phase “δ” is controlled, the system controller 50 controls the light impulse control circuit 260 in the light source 2.

As data to be transmitted to the light impulse control circuit 260 by the system controller 50 in this case, the setting value of the light emission phase may be sequentially transmitted in a time-varying manner. Alternatively, the light emission pulse signal according to the setting value of the light emission phase may be directly transmitted.

In processing of step 91 performed simultaneously with step 92, the light power detector 27 in the light source 2 (shown in FIG. 40) measures the temporal change of the emitted light intensity regarding the irradiated light (first light beam) 13. Then, the light power detector 27 appropriately transmits the collected measured signal to the system controller 50.

The system controller 50 may control both the rough distance calculation in step 100 and the highly accurate distance calculation in step 110. Here, in the rough distance calculation (ST100), the delay time “τ” between the measured signal collected from the standard distance (the change characteristic of the charge accumulation amount 340 within the measuring periods with respect to the change amount of the detection phase or the light emission phase) and the similar measured signal obtained from the measured object 22 is calculated (ST101), and a rough distance L is calculated from a relational expression of “τ=2 L/c” (ST102). Then, the rough distance information “L” calculated in step 102 is used in step 111 in the highly accurate distance calculation (ST110).

According to the present embodiment example shown in FIG. 56B, the highly accurate distance calculation in step 110 may consider that the detection light (second light beam) 19 holding “the temporal change characteristic of the emitted light intensity 338 regarding the irradiated light (first light beam) 13” arrives at the measurer 8. And according to step 111, the characteristic of the charge accumulation amount 340 within the measuring periods is theoretically predicted by finely changing the delay time “τ” until the detection light (second light beam) 19 arrives.

To put it concretely, based on the calculation model mentioned above, the system controller 50 may previously perform predictable calculations to prepare a series of reference signals that respectively have a different “change characteristic of the charge accumulation amount 340”. Herein, each of the series of reference signals corresponds to each of different delay times “t”. And the system controller 50 simultaneously collects “measured signal of corresponding pixel” which each of pixels 271 belonging to the imaging sensor 270 relating to depth (distance) signal obtains.

And then, the system controller 50 may estimate pattern-matching rates between each of the series of reference signals and the “measured signal of corresponding pixel”. Here, the value of the pattern-matching rates “PMR” is obtained from Equation 27 (or Equation 25) mentioned later. As results of a series of the pattern-matching estimations, the system controller 50 can extract a corresponding delay time “τ” relating to the reference signal that provides a maximum pattern-matching rate. And the system controller 50 may repeat extracting another delay time “τ” corresponding to another measured signal of designated pixel.

In the above theoretical predicted calculation, calculating “the characteristic of the charge accumulation amount 340 within the measuring periods” over the entire distance range (length measurement range) of the measured object 22 applies a large load to the system controller 50 and requires a long calculation time. Therefore, the delay time “t” may be finely changed only in the vicinity thereof using the calculation result of the rough distance L obtained in step 102. When the result of the rough distance calculation (ST102) is used, the load on the system controller 50 is significantly reduced, and the calculation time can be significantly shortened.

In the description of step 111, reference signal is performed from the measured signal transmitted by the light power detector 27 shown in FIG. 40 (ST91). However, the present embodiment example (ST111) is not limited thereto, and for example, the reference signal may be performed using a measurement characteristic from the standard distance acquired in advance.

That is, a reference sample using a reference material is disposed at the standard distance measured with high accuracy from the optical device 10 incorporating the light source 2 and the measurer 8. And the delay time “τ” until the detection light (second light beam) 19 arrives is finely changed to theoretically predict “the characteristic of the charge accumulation amount 340 within the measuring periods”. Moreover, in the present application embodiment, the system controller 50 may generate another series of reference signals based on an obtained distance between a “prescribed pixel (‘a22’ in FIG. 23) positioned on the optical axis 384 of the image forming lens 144 (388) and included in the imaging sensor 270 relating to depth (distance) signal” and a “corresponding point (‘A22’ in FIG. 23) in the measured object 22 which is located at a confocal position of the prescribed pixel”.

In step 113, DC signal elimination (conversion into only AC signal) in the series of reference signals is performed. And in order to improve the accuracy of the distance measurement (length measurement) to the measured object 22, in step 112, the DC signal of “the characteristic regarding the charge accumulation amount 340 within the measuring periods for each detection phase or light emission phase (timing shift time) 8 obtained from the measured object 22” is eliminated.

In the next step 114, the system controller may multiply the measurement characteristic (measured signal) by the theoretical prediction characteristic (the series of reference signals) after DC signal elimination for each detection phase or light emission phase “δ”. And then, the system controller may summate the multiplication result over the entire detection phase or the entire light emission phase “δ” in step 114. Here, the multiplication and summation operation corresponds to the pattern-matching rate “PRM” estimation explained above between each of the series of reference signals and the “measured signal of corresponding pixel”. The present embodiment may show some kinds of the pattern-matching rate estimation. A kind of the pattern-matching rate estimation includes “Lock-in operation” corresponding to the multiplication and summation operation.

In the next step 115, the system controller 50 may extract a corresponding delay time “t” relating to the reference signal that provides a maximum pattern-matching rate “PMR”. And then, from the delay time “τ” calculated in step 115, the distance “L” to the measured object 22 can be calculated with high accuracy (ST116) using the relational expression “τ=2 L/c”. The imaging sensor 270 relating to depth (distance) signal has a plurality of pixels 271 arranged along two-dimensional directions. Therefore, the system controller 50 has to repeat the same estimation for all of the designated pixels relating to the three-dimensional shape of the measured object 22. After all of the estimation, the system controller 50 finishes the distance measurement (ST89).

FIG. 57 illustrates an imaging method example in which the phase of the modulation signal of the irradiated light (first light beam) 13 is fixed and the exposure timing in the imaging sensor 270 relating to depth (distance) signal is changed. In FIG. 57, the phase of the exposure timing is divided into eight in FIGS. 57 (c) to 57 (j). A horizontal axis in FIG. 57 represents a passing time “t”. FIG. 57 (a) illustrates modulation characteristics of the irradiated light (first light beam) 13 immediately after emission from the light source 2. For simplification of description, the irradiated light (first light beam) 13 has been described as the pulsed light emission example. However, the present embodiment is not limited thereto, and light may be emitted by any modulation method.

In FIG. 57 (a), a vertical axis represents the emitted light intensity 338. The irradiated light (first light beam) 13 repeatedly emits pulsed light in a light exposure allowable term “T/2” on the cycle “T”. In consideration of the rising characteristic and the falling characteristic at the switching timing between the light emission start time and the light blocking start time depending on the response characteristic of the light emitter 470, a trapezoidal waveform is approximated and drawn.

FIG. 57 (b) illustrates a temporal change of the measured light intensity 336 when the detection light (second light beam) 19 from the measured object 22 separated by the distance “L” reaches the measurer 8. From FIG. 57 (a), the timing is shifted by the delay time “τ=2 L/c” in the time “t” direction.

FIGS. 57 (c) to 57 (j) illustrate a relation between an exposure timing change of one pixel 271 in the imaging sensor 270 relating to depth (distance) signal and a charge accumulation amount 340 within the measuring periods. Bold rectangular waves in FIGS. 57 (c) to 57 (j) indicate the exposure timing of one pixel 271, and exposure is performed only in a period “T/2” in which a level is high. Then, a charge amount corresponding to an accumulated light intensity of the detection light (second light beam) 19 received within the exposure period of “T/2” is accumulated. This exposure period is repeatedly set a predetermined number of times at intervals of the cycle “T”.

For example, a relation example at different times “t” between FIG. 57 (b) and FIG. 57 (c) will be described. In FIG. 57 (c), the exposure period is started from an earlier time. However, as illustrated in FIG. 57 (b), a delay time of “τ=2 L/c” occurs when the detection light (second light beam) 19 arrives. Therefore, in an early stage of the exposure period, the detection light (second light beam) 19 does not arrive at the corresponding pixel 271, and no charge is accumulated in the pixel 271. A part of the detection light (second light beam) 19 arrives after the delay time of “τ=2 L/c”, and a charge amount corresponding to an area of a shaded portion is accumulated in the pixel 271. The remaining portion of the detection light (second light beam) 19 arrives thereafter. However, since this time is after the end of the exposure period, no charge is accumulated in the pixel.

Note that the detection light (second light beam) 19 repeatedly arrives at the corresponding pixel 271 a predetermined number of times in a pulsed light state of the cycle “T”. Then, the exposure period is repeated a corresponding predetermined number of times. Therefore, even if the charge accumulation amount in FIG. 57 (c) is small during one exposure period, the charge accumulation is repeated a predetermined number of times, and the amount of the measured signal increases. By repeating the modulated light and the exposure period in this manner, there is an effect of increasing a signal to noise ratio (S/N ratio) of the measured signal.

In FIG. 57 (d), the exposure start time is delayed by “δ 45=T/8” with respect to FIG. 57 (c) without changing the exposure period “T/2”. Time “t” at which a part of the detection light (second light beam) 19 arrives within the exposure period of “T/2” and charge accumulation starts in the pixel is matched between FIG. 57 (c) and FIG. 57 (d). However, the exposure end time in FIG. 57 (d) is delayed from that in FIG. 57 (c) by “δ 45=T/8”. Therefore, the area of the shaded portion in FIG. 57 (d) is wider than that in FIG. 57 (c). As a result, the charge accumulation amount 340 within the measuring periods illustrated on the right side of FIG. 57 (d) increases as compared with FIG. 57 (c).

The delay time “T/8” of the exposure start time of FIG. 57 (d) with respect to FIG. 57 (c) corresponds to a phase delay amount of “45 degrees” with respect to the cycle “T” (=360 degrees). The phase delay amount of the exposure start time displayed in units of “degrees” is referred to as a detection phase “δ” (shift time of exposure start). FIG. 57 (c) to FIG. 57 (j) illustrate characteristic changes of the charge accumulation amount 340 within the measuring periods (exposure periods) when the detection phase “δ” changes.

FIG. 57 (e) illustrates a characteristic when the detection phase “δ90” is set to “90 degrees”. Since the exposure end time in FIG. 57 (e) is further delayed, the area of the shaded portion is further expanded. As a result, the charge accumulation amount 340 in the measuring periods (exposure periods) further increases. In the characteristic example corresponding to the detection phase “δ135” in FIG. 57 (f), the exposure period substantially overlaps with the pulse light exposure allowable term of the detection light (second light beam) 19 in FIG. 57 (b). Therefore, the charge accumulation amount 340 in the measuring periods approaches the maximum value.

In the description example of FIG. 57 (g), when the detection phase “δ180” exceeds “180 degrees”, the pulsed light emission of the detection light (second light beam) 19 ends before the exposure end time. Therefore, after the detection phase “δ225” in FIG. 57 (h), the charge accumulation amount 340 within the measuring periods decreases as the detection phase “δ” increases.

The change characteristic of the charge accumulation amount 340 within the measuring periods with respect to the detection phase “δ” illustrated on the right side of FIG. 57 changes in the vertical direction when the delay time “τ=2 L/c” changes. Therefore, by measuring the position of the entire change characteristic of the charge accumulation amount 340 within the measuring periods with respect to the change amount of the detection phase “δ” with high accuracy, the distance “L” to the measured object 22 is determined with high accuracy.

When a duty ratio representing a ratio of the light exposure allowable term “T/2” to the light exposure allowable term “τ” is set to around (near) “50%”, the distance “L” to the measured object 22 is determined with the highest accuracy. This is because, in the graph illustrated on the right side of FIG. 57, when a location where the gradient of the change amount of the charge accumulation amount 340 within the measuring periods with respect to the change amount of the detection phase “δ” decreases occurs, the length measurement accuracy decreases. Therefore, for the same reason, it is desirable to set the exposure period to around (near) “T/2”. In addition, not limited to it, it is also desirable to set the exposure period more than “T/6” and less than “5T/6”.

A value of the detection phase “δ” of FIG. 57 may be changed between different pixels 271 in the imaging sensor 270 relating to depth (distance) signal at the same time. In FIG. 57 (c) to FIG. 57 (j), the detection phase “δ” is divided into eight at intervals of “45 degrees”. Therefore, eight different types of values of the detection phase “δ” may be set simultaneously among the eight different pixels 271. Alternatively, as illustrated in the embodiment examples of FIGS. 41 and 42, the same value of the detection phase “δ” may be set between discrete pixels 1262-1, 1262-2.

However, the present embodiment is not limited thereto, and for example, the value of the detection phase “δ” may be simultaneously matched among all the pixels 271 constituting the imaging sensor 270 relating to depth (distance) signal. In this case, the exposure timing in the same frame to be imaged is matched (synchronized) among all the pixels. Then, the value (exposure timing) of the detection phase “δ” is sequentially shifted between different frames. For example, when the detection phase “δ” is divided into “N” (the value of the detection phase “δ” is shifted at intervals of “360/N degrees”), one set of frame groups may comprise “N” frames. In this case, when imaging of one set of frame groups is completed, measurement of a 3D image (including distance measurement (length measurement) in the optical axis direction) is completed.

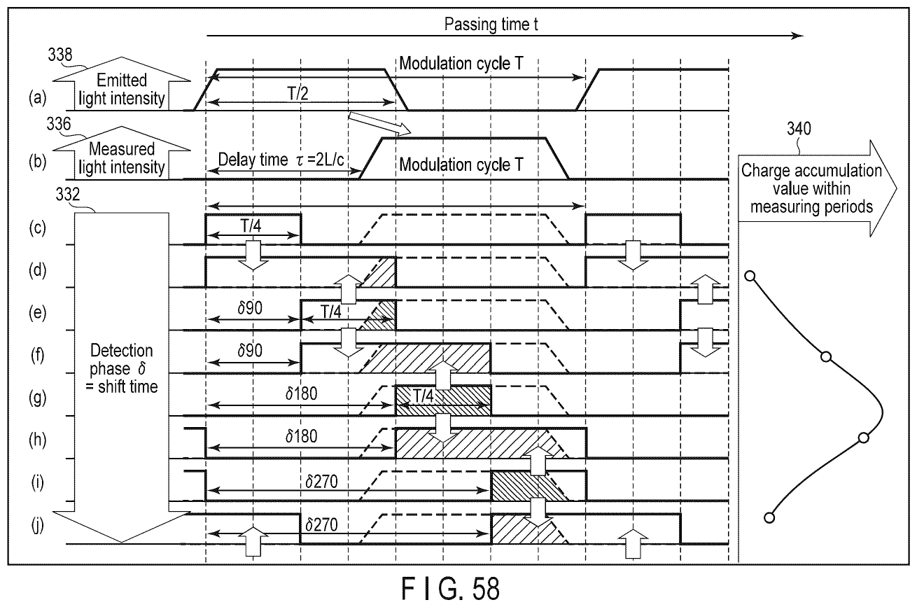

In another embodiment example illustrated in FIG. 58, a method is illustrated in which charges can be accumulated at a plurality of different detection phase values simultaneously in the same pixel 271 of one imaging sensor 270 relating to depth (distance) signal. Here, the modulation cycle “T” of the irradiated light (first light beam) 13 is equally divided into four. Then, the charge accumulation amount generated in the same pixel is sequentially distributed to FIGS. 58 (c), 58 (e), 58 (g), and 58 (i) for each exposure period of “T/4” (measurement timing 334). That is, a value of the detection phase “o” corresponding to the exposure start time is set to “0 degrees” in FIG. 58 (c). Then, a detection phase “δ90” in FIG. 58 (e) is set to “90 degrees”, a detection phase “δ180” in FIG. 58 (g) is set to “180 degrees”, and a detection phase “δ270” in FIG. 58 (j) is set to “270 degrees”.

The contents described in FIGS. 58 (a) and 58 (b) indicate the same contents as those in FIGS. 57 (a) and 57 (b). That is, FIG. 57 (a) and FIG. 58 (a) illustrate a temporal change of the emitted light intensity 338 of the irradiated light (first light beam) 13 immediately after emission from the light source 2. In addition, FIG. 57 (b) and FIG. 58 (b) illustrate a temporal change of the measured light intensity 336 when the detection light (second light beam) 19 reaches the measurer 8.

In the exposure period in FIG. 58 (c), the detection light (second light beam) 19 does not reach the measurer 8. Then, a part of the detection light (second light beam) 19 starts to reach the measurer 8 from the latter half of the exposure period in FIG. 58 (e). Therefore, only a part of the latter half of the exposure period in FIG. 58 (e) becomes the shaded area, and contributes to the charge accumulation amount 340 within the measuring periods. On the other hand, the detection light (second light beam) 19 continues to reach the measurer 8 during the entire exposure period in FIG. 58 (g). Therefore, the charge accumulation amount 340 within the measuring period in FIG. 58 (g) takes a maximum value. Then, the end time in the exposure period in FIG. 58 (i) is after the detection light (second light beam) 19 completely reaches the measurer.

When the transmission destination of the charge accumulation amount into the same pixel of the imaging sensor 270 relating to depth (distance) signal is sequentially switched in a short time, the accumulated charge amount into the same pixel can be distributed in time series to FIGS. 58 (c), 58 (e), 58 (g), and 58 (i). As an implementation method, for example, in FIG. 42, the number of page buffer memories 1296 may be increased to four times, and an interlocking switch 1300 that switches the output of the upper side envelope extraction circuit 1288 between the different page buffer memories 1296 may be added. Then, every “T/4” period corresponding to the exposure period (measurement timing 334), the output of the upper side envelope extraction circuit 1288 is sequentially switched between the different page buffer memories 1296, and the interlocking switch 1300 is operated to appropriately discharge the charge accumulated in the capacitor 1160, so that the above can be realized.

At the stage of outputting as the measured signal from the imaging sensor 270 relating to depth (distance) signal, the sum of FIGS. 58 (c) and 58 (e) is given to FIG. 58 (d), and the value in FIG. 58 (d) is output. Similarly, the sum of FIGS. 58 (e) and 58 (g) is output as the value in FIG. 58 (f). The sum of FIGS. 58 (g) and 58 (i) is output as the value in FIG. 58 (h), and the sum of FIGS. 58 (i) and 58 (c) is output as the value in FIG. 58 (j).

The output values in FIGS. 58 (d), 58 (f), 58 (h), and 58 (j) correspond to the charge accumulation amount 340 within the measuring period in the exposure period of “T/2” (measurement timing 334). Each detection phase value corresponds to “0 degrees” in FIG. 58 (d), corresponds to “90 degrees” in FIG. 58 (f), corresponds to “180 degrees” in FIG. 58 (h), and corresponds to “270 degrees” in FIG. 58 (j).

As described above, when the charge accumulation amount 340 in the measuring period in the same pixel is distributed to and recorded in a plurality of different memories by time division, there is an effect that the charge accumulation amount 340 for each of a plurality of different detection phases “δ” in the same pixel can be collected at high speed. That is, in the above-described example, imaging of “N frames” is required for imaging of a set of frame groups, but in the above-described method, imaging of only “one frame” is required.

Note that FIG. 58 illustrates an example of a method for collecting the charge accumulation amount 340 within the measuring periods at four types of different detection phase values in a short time. And FIG. 57 illustrates an example of a method for collecting the charge accumulation amount 340 within the measuring periods at eight types of different detection phase values in a short time. However, the present embodiments are not limited thereto, and the charge accumulation amount 340 within the measuring periods at an arbitrary number of types of different detection phase values (for example, 8 types, 16 types, 32 types, 64 types, and the like) may be collected from one pixel in a short time.

As a method for finely changing the phase of the exposure timing with respect to the emitted light intensity modulation signal of the irradiated light (first light beam) 13 and performing measurement, regarding the same pixel 271 in the imaging sensor 270 relating to depth (distance) signal, the following methods are considered:

1. A method for fixing the phase with respect to the emitted light intensity modulation signal of the irradiated light (first light beam) 13 without depending on the time passage and changing only the detection phase “δ” according to the time passage;

2. A method for fixing the detection phase without depending on the passing time and changing the phase (light emission phase “δ”) of the emitted light intensity modulation signal of the irradiated light (first light beam) 13 according to the time passage; and

3. A method for changing both the detection phase and the light emission phase according to the time passage.

The above illustrates a classification example in a case where the same detection phase value is set in all the pixels in the imaging sensor 270 relating to depth (distance) signal. Furthermore, as described with reference to FIGS. 41 to 49, the detection phase value may be changed between different pixels 271 in the imaging sensors 270, 280. In this case, any combination between the method for setting the detection phase value between the pixels 271 and the above classification becomes possible. Meanwhile, the embodiment example of FIGS. 57 and 58 corresponds to the above “1”. Next, another embodiment application example corresponding to the above “2” is described.

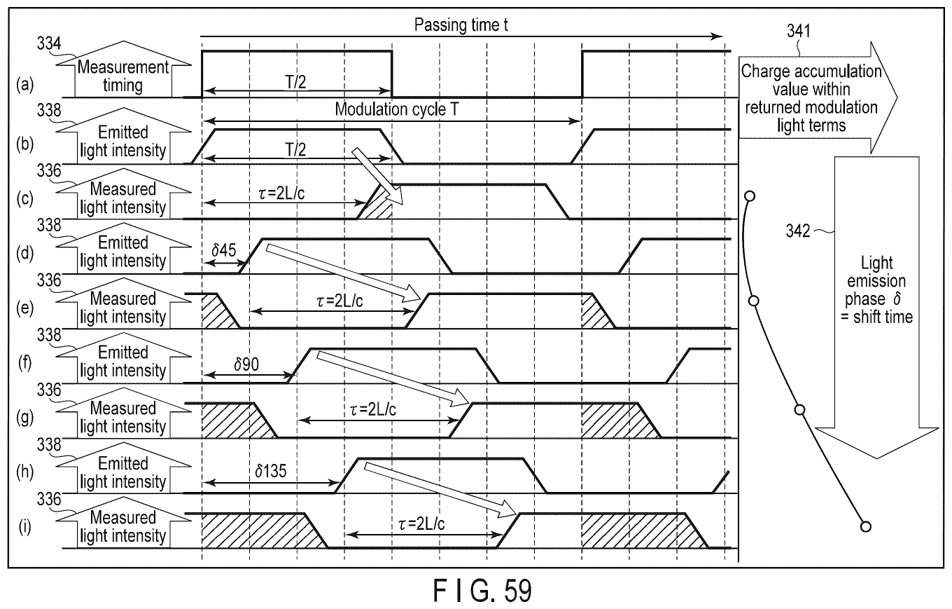

FIG. 59 illustrates another embodiment application example in which the distance measurement (length measurement) is performed by changing the “light emission phase 8” with the period passage. The “light emission phase” used here means a shifting amount of the light emission timing with respect to the emitted light intensity 338 of the irradiated light (first light beam) 13. Here, the emitted light intensity 338 of the irradiated light (first light beam) 13 is assumed to be in a state where the emitted light intensity is modulated with the cycle “T”. The modulation waveform of the emitted light intensity 338 is not limited to a pulse waveform, and may be any modulation waveform such as a sinusoidal waveform or a saw-tooth wave.

The detection light (second light beam) 19 obtained from the measured object 22 reaches the measurer 8 after the delay time “τ=2 L/c”. For this reason, when a predetermined light emission phase amount “δ” shifts the light emission timing, the time of arrival at the measurer 8 also changes. This light emission phase is also expressed by a “unit of degree”. Here, the period of the cycle “T” regarding the emitted light intensity 338 of the irradiated light (first light beam) 13 is set to 360 degrees, and the shifting amount of the light emission timing is represented by a relative value based on the unit of degree.

The charge accumulation amount 340 measured for each pixel 271 in the imaging sensor 270 relating to depth (distance) signal corresponds to the received light intensity of the detection light (second light beam) 19 repeatedly modulated for a period of one frame. As described above, the detection phases may be different between different pixels 271 in the imaging sensor 270 relating to depth (distance) signal. However, in the same pixel 271 in the imaging sensor 270 relating to depth (distance) signal, the detection phase value is fixed in the same frame. Therefore, the change in the charge accumulation amount 340 within the measuring periods when the light emission phase “δ” is changed for each period of frame imaging (for each frame in the frame group) is measured.

FIG. 59 (a) illustrates a measurement timing 334 (exposure period) in one pixel 271 in the imaging sensor 270 relating to depth (distance) signal. The period in which FIG. 59 (a) holds a high level corresponds to the exposure period of the corresponding pixel 271. The charge accumulation amount 340 within the measuring periods is determined according to the integrated light intensity value of the detection light (second light beam) 19 received within the measurement timing 334 (exposure period).

The width of the measurement timing 334 (exposure period) is “T/2” with respect to the emitted light intensity modulation cycle “T” of the irradiated light (first light beam) 13. Then, the measurement timing 334 (exposure period) repeatedly appears every cycle “T”. The distance measurement (length measurement) accuracy is improved when the characteristic of the charge accumulation amount 340 within the measuring periods with respect to the light emission phase “δ” is set such that the change becomes large within the entire light emission phase range.

Therefore, when the width of the measurement timing 334 (exposure period) is set to “T/2”, the distance measurement (length measurement) accuracy is most improved. Therefore, it is also desirable to set the exposure period more than “T/6” and less than “5T/6”. In another embodiment example illustrated in FIG. 59, the detection phase of the measurement timing 334 (exposure period) is fixed without depending on the time passage.

Similarly to FIG. 57 (a), FIG. 59 (b) illustrates a modulation characteristic of the emitted light intensity 338 regarding the irradiated light (first light beam) 13 immediately after emission from the light source 2. The irradiated light (first light beam) 13 repeatedly emits pulsed light with a pulse width of “T/2”. For the same reason as the above, when the pulse width of the irradiated light (first light beam) 13 is set to “T/2”, the distance measurement (length measurement) accuracy is most improved. Therefore, it is also desirable to set the pulse width more than “T/6” and less than “5T/6”. Similarly to FIG. 58 (b), FIG. 59 (c) illustrates a temporal change of the measured light intensity 336 when the detection light (second light beam) 19 reaches the measurer 8. The time delay of “τ=2 L/c” occurs until the detection light reaches the measurer 8 immediately after the radiation of the light source 2.

FIGS. 59 (d), 59 (f), and 59 (h) illustrate modulation characteristics regarding the emitted light intensity 338 of the irradiated light (first light beam) 13 immediately after emission from the light source 2 when the value of the light emission phase “δ” is changed. The light emission phase amount “δ45” in

FIG. 59 (d) with reference to FIG. 59 (b) is “45 degrees”. That is, as compared with the modulation characteristic regarding the emitted light intensity 338 of the irradiated light (first light beam) 13 immediately after emission from the light source 2 illustrated in FIG. 59 (b) the pulsed light emission delay corresponding to “T/8” (360 degrees÷8=45 degrees) occurs in FIG. 59 (d).

In addition, the light emission phase amount “δ90” in FIG. 59 (f) with reference to FIG. 59 (b) is “90 degrees”, and the pulsed light emission delay corresponding to “T/4” (360 degrees÷4=90 degrees) occurs. The light emission phase amount “δ135” in FIG. 59 (h) with reference to FIG. 59 (b) becomes “135 degrees”, and the pulsed light emission delay corresponding to “3T/8” occurs. And FIGS. 59 (c), 59 (e), 59 (g), and 59 (i) illustrate a temporal change regarding the measured light intensity 336 of the detection light (second light beam) 19 and a change state of the charge accumulation amount 340 within the measuring periods. Here, the “temporal change regarding the measured light intensity 336 of the detection light (second light beam) 19” corresponds to light intensity variation of the detection light (second light beam) 19 at the measurer 8 when the value of the light emission phase “δ” is changed.

FIG. 59 (c) illustrates a temporal change regarding the measured light intensity 336 of the detection light (second light beam) 19 in the measurer 8 when the irradiated light (first light beam) 13 is emitted at the light emission phase of “0 degrees”. As compared with the modulation characteristic (temporal change of the emitted light intensity 338) of the irradiated light (first light beam) 13 immediately after emission from the light source 2 in FIG. 59 (b), the temporal change regarding the measured light intensity 336 in FIG. 59 (c) causes the temporal delay of “τ=2 L/c”. In another embodiment application example illustrated in FIG. 59, since the delay amount is large, most of the detection light (second light beam) 19 is to be out of the measurement timing 334 (exposure period). Therefore, the area of the shaded area in FIG. 59 (c) is narrow, and the value of the charge accumulation amount 340 within the measuring periods is small.

In contrast to the characteristic of the emitted light intensity 338 when the irradiated light (first light beam) 13 is emitted with the value of the light emission phase “δ45” of “45 degrees” illustrated in FIG. 59 (d), the detection light (second light beam) 19 reaches the measurer 8 with the time delay of “τ=2 L/c” as illustrated in FIG. 59 (e). As a result, in FIG. 59 (e), only a rear end (shaded area) of the detection light (second light beam) 19 overlaps the measurement timing 334 (exposure period) in FIG. 59 (a). Therefore, the value of the charge accumulation amount 340 within the measuring periods in FIG. 59 (e) also decreases.

As illustrated in FIGS. 59 (g) and 59 (i), when the values of the light emission phases “δ90” and “δ135” increase to “90 degrees” and “135 degrees”, the area of the shaded area overlapping the measurement timing 334 (exposure period) in the detection light (second light beam) 19 reaching the measurer 8 increases. As shown in FIGS. 59 (g) and 59 (i), the charge accumulation amount 340 within the measuring periods also increase.

As illustrated on the right side of FIG. 59, the charge accumulation amount 340 within the measuring periods also changes according to the value change of the light emission phase 342. Therefore, the change characteristic of the charge accumulation amount 340 within the measuring periods when the value of the light emission phase “δ” is changed while the value of the detection phase is fixed can also be used for the measurement (length measurement) of the distance “L” to the measured object 22.

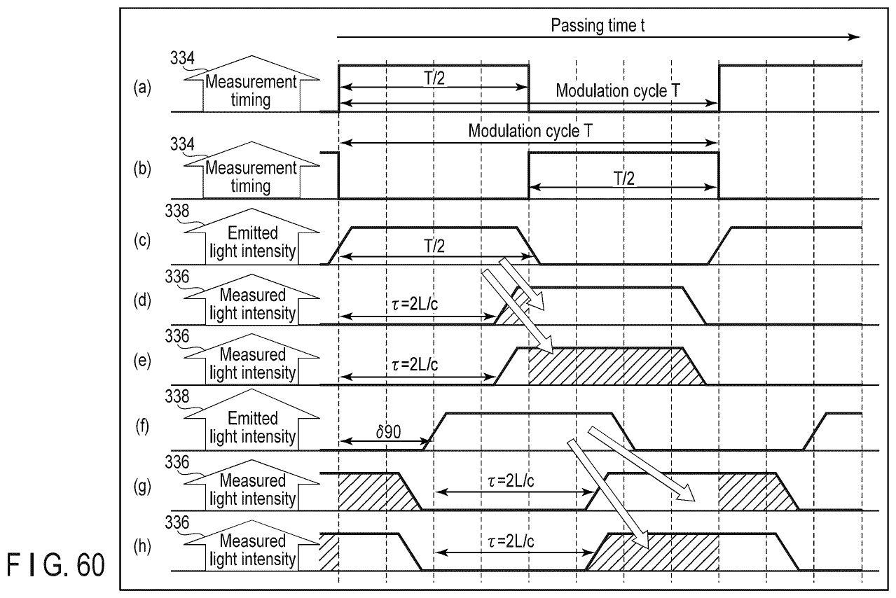

FIG. 60 illustrates another embodiment example in which distance measurement (length measurement) is performed by changing both the detection phase and the light emission phase. This embodiment example corresponds to “3. a method for changing both the detection phase and the light emission phase according to the time passage” described above.

In FIG. 60, by using a method similar to the description of FIG. 58, the imaging sensor 270 relating to depth (distance) signal capable of simultaneously measuring values of two types of charge accumulation amounts 340 within the measuring periods in which detection phase values are shifted from each other by 180 degrees in the same pixel 271 is used. Here, FIG. 60 (a) illustrates measurement timing 334 (exposure time) for acquiring the value of the first type of the charge accumulation amount 340 within the measuring periods. FIG. 60 (b) illustrates measurement timing 334 (exposure time) for acquiring the value of the second type of the charge accumulation amount 340 within the measuring periods. The detection phases in FIGS. 60 (a) and 60 (b) shift from each other by “180 degrees”.

In either case, the period at the high level means the measurement timing 334 (within the exposure period). The width of the measurement timing 334 (exposure period) is “T/2” with respect to the modulation cycle “T” of the emitted light intensity 338 of the irradiated light (first light beam) 13. Then, the measurement timing 334 (exposure period) repeatedly appears every cycle “T”.

FIG. 60 (c) illustrates a temporal change regarding the emitted light intensity 338 of the irradiated light (first light beam) 13 at the light emission phase of “0 degrees”. The irradiated light (first light beam) 13 repeats pulsed light emission with a pulse width “T/2” of the cycle “T”. In addition, FIG. 60 (f) illustrates a temporal change regarding the emitted light intensity 338 of the irradiated light (first light beam) 13 when the light emission phase “δ90” is “90 degrees”.

FIGS. 60 (d) and 60 (e) illustrate a temporal change regarding the measured light intensity 336 of the detection light (second light beam) 19 that has reached the measurer 8 when the irradiated light (first light beam) 13 is emitted at the light emission phase of “0 degrees”. In addition, FIGS. 60 (g) and 60 (h) illustrate a temporal change regarding the measured light intensity 336 of the detection light (second light beam) 19 that has reached the measurer 8 when the irradiated light (first light beam) 13 is emitted at the light emission phase “δ90” of “90 degrees”.

Comparison between FIGS. 60 (d) and 60 (g) shows a difference in the charge accumulation amounts 340 within the measuring periods when the detection phase value is fixed and the light emission phase value is changed. Here, in FIGS. 60 (d) and 60 (g), the detection phase value indicating the measurement timing 334 (exposure period) is fixed to “0 degrees”.

When the timings in FIGS. 60 (a) and 60 (d) are combined, it can be seen that only the tip (the narrow starting area) in the area where the measured light intensity 336 of the detection light (second light beam) 16 is at the high level overlaps with the measurement timing 334 (exposure period). Therefore, in FIG. 60 (d), only the tip (left narrow end area) in the area where the measured light intensity 336 increases is the shaded area.

When the timings in FIGS. 60 (a) and 60 (g) are combined, it can be seen that the latter half (right half) in the area where the measured light intensity 336 of the detection light (second light beam) 19 is at the high level overlaps the measurement timing 334 (exposure period). Therefore, in FIG. 60 (g), the latter half (right side area) in the area where the measured light intensity 336 increases is the shaded area.

Comparison between FIGS. 60 (e) and 60 (h) also represents a difference in the charge accumulation amounts 340 within the measuring periods when the detection phase value is fixed and the light emission phase value is changed. Here, a location where the detection phase value is fixed and the light emission phase value is changed is matched in both the set of FIGS. 60 (e) and 60 (h) and the set of FIGS. 60 (d) and 60 (g). However, while the detection phase value in the set of FIGS. 60 (d) and 60 (g) is set to “0 degrees”, the detection phase value in the set of FIGS. 60 (e) and 60 (h) is set to “180 degrees”.

When the timings in FIGS. 60 (b) and 60 (e) are combined, most of the area where the measured light intensity 336 of the detection light (second light beam) 19 is at the high level overlaps the measurement timing 334 (exposure period). Therefore, in FIG. 60 (e), most of the measured light intensity 336 is the shaded area. Therefore, in this combination, the charge accumulation amount 340 within the measuring periods approaches the maximum value.

On the other hand, when the timings in FIGS. 60 (b) and 60 (h) are combined, the former half (left half) of the area where the measured light intensity 336 of the detection light (second light beam) 19 is at the high level overlaps the measurement timing 334 (exposure period). Therefore, in FIG. 60 (h), the former half (left half) of the measured light intensity 336 is the shaded area.

As described above, the area of the shaded area (the charge accumulation amount 340 within the measuring periods) changes between FIGS. 60 (d), 60 (e), 60 (g), and 60 (h). Therefore, by collecting these measured signals, the distance “L” to the measured object 22 can be measured (length measurement).

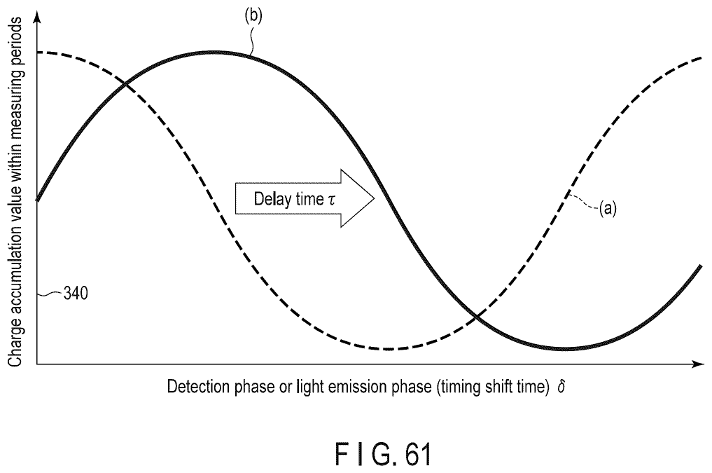

FIG. 61 illustrates an image diagram regarding the “method for calculating the delay time ‘τ’ between the measurement characteristic from the standard distance and the measurement characteristic obtained from the measured object 22” executed in step 101 in FIG. 56A. A horizontal axis in FIG. 61 represents the detection phase or the light emission phase (timing shift time) “δ”. A vertical axis represents the value of the charge accumulation amount 340 within the measuring periods. FIG. 61 corresponds to the graph described on the right side of FIG. 57 or FIG. 59.

A reference sample using a reference material is disposed at the standard distance measured with high accuracy from the optical device 10 incorporating the light source 2 and the measurer 8, and a measurement characteristic acquired by the reference sample is illustrated in FIG. 61 (a). FIG. 61 (b) illustrates a measurement characteristic obtained from the measured object 22. Here, it is desired to measure (measure the length) the distance “L” from the optical device 10 to the measured object 22.

The delay time “τ” until the detection light (second light beam) 19 arrives at the measurer 8 changes according to the distance “L” from the optical device 10 to the measured object 22. According to the delay time “τ”, a shift in the detection phase “o” direction or the light emission phase “δ” direction occurs between FIGS. 61 (a) and 61 (b). Therefore, when the shift amount is read on the graph, the delay time “τ” is expected, and the rough distance “L” can be calculated.

The entire area width on the horizontal axis in FIG. 61 corresponds to the maximum value of “360 degrees” of the detection phase value “δ” (or the light emission phase value “δ”). The detection phase value “δ360” (or the light emission phase value “δ360”) at “360 degrees” corresponds to the maximum distance “Lmax=cT/2” at which the length can be measured. Here, “T” represents a modulation cycle related to the emitted light intensity 338 of the irradiated light (first light beam) 13, and “c” represents the light velocity. There is a relation of “τ=2 L/c” between the distance “L” to the measured object 22 and the delay time “τ” until the detection light (second light beam) 19 arrives at the measurer 8. Therefore, the delay time “τ” can be calculated from the shift amount in the detection phase “δ” direction or the light emission phase “δ” direction between FIGS. 61 (a) and 61 (b), and the rough distance “L” can be calculated.

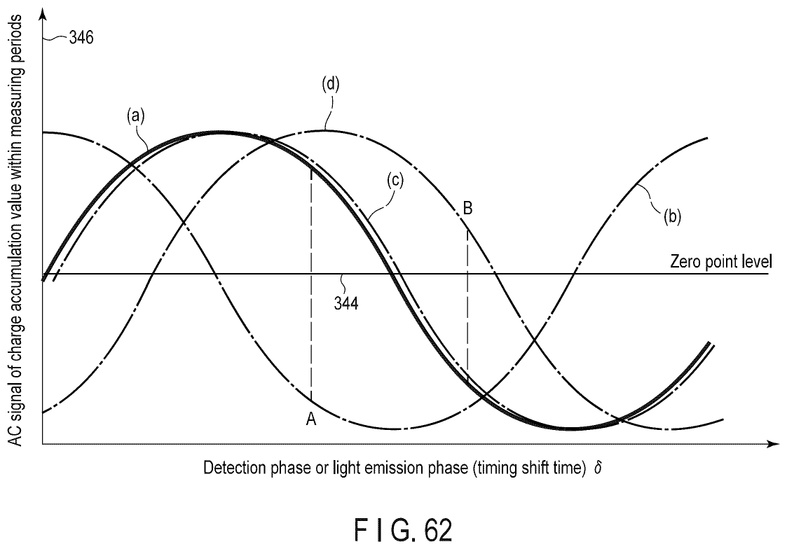

FIG. 62 is an explanatory diagram regarding the processing contents of step 92 and step 111 in FIG. 56B. A horizontal axis in FIG. 62 also indicates the detection phase value “δ” or the light emission phase value “δ” (timing shift time), and a vertical axis indicates the AC signal 346 (characteristic after DC signal elimination) of the charge accumulation amount within the measuring periods. FIG. 62 (a) illustrates a measurement characteristic obtained from the measured object 22.

The characteristics of the AC signal 346 of the charge accumulation amount 340 within the measuring periods theoretically predicted by applying the calculation result described in step 111 of FIG. 56B to FIGS. 57, 58, 59, and 60 are illustrated in FIGS. 62 (b) to 62 (d). FIGS. 62 (b) to 62 (d) illustrate theoretical prediction characteristics calculated for different delay times “τ1” to “τ3”. Herein, the theoretical prediction characteristics calculated for different delay times “τ1” to “τ3” are utilized as reference signals. In the actual processing in step 92 in FIG. 56A and step 111 in FIG. 56B, the delay time “τ” is finely changed, and the theoretical prediction characteristics for all the delay time “τ” are calculated. In FIG. 62, for convenience of description, description is narrowed down to only three values of “τ1” to “τ3” as the delay times.

In addition, the present embodiment application example is not limited to the above, and as the characteristics in FIGS. 62 (b) to 62 (d), for example, theoretical prediction characteristics for different delay times “τ1” to “τ3” may be calculated based on the measurement characteristics acquired from the reference sample. In the reference sample, a reference material is used, and a measurement characteristic at the time of being disposed at a standard distance measured with high accuracy from the optical device 10 incorporating the light source 2 and the measurer 8 is used. In addition, not limited to it, another series of reference signals may be generated based on an obtained distance between a “prescribed pixel (“a22” in FIG. 23) included in the imaging sensor 270 relating to depth (distance) signal” and a “corresponding point (“A22” in FIG. 23) on the measured object 22 which is located on the optical axis 384 of the image forming lens 144 (388) and is located at a confocal position of the prescribed pixel” (“a22” also positioned on the optical axis 384 of the image forming lens 144 (388)).

The present embodiment may show some kinds of the pattern-matching estimation methods between the series of reference signals and the measured signal. FIG. 62 explains “Lock-in operation” which corresponds to one kind of the pattern-matching estimation methods. According to the Lock-in operation, product calculation is performed between the vertical axis values in FIGS. 62 (a) and 62 (b) for each of different detection phase values “δ” (or light emission phase values “δ”). Next, the product calculation result is summated with the entire detection phase value “δ” (or the entire light emission phase value “δ”).

Similarly, for each detection phase value “δ” (or light emission phase value “δ”), product calculation between the vertical axis values in FIGS. 62 (a) and 62 (c) is performed, and the product calculation result is summated with the entire detection phase value “δ” (or the entire light emission phase value “δ”). Further, for each detection phase value “δ” (or light emission phase value “δ”), product calculation between the vertical axis values in FIGS. 62 (a) and 62 (d) is performed, and the product calculation result is summated with the entire detection phase value “δ” (or the entire light emission phase value “δ”).

The meaning of “calculation of the delay time ‘τ’ having the maximum summation value” executed in step 115 of FIG. 56B is described with reference to FIG. 62. A zero point level 344 in the AC signal 346 of the charge accumulation amount within the measuring periods indicating the vertical axis in FIG. 62 is set in the center portion in FIG. 62. In a location where a value of an “A area” is taken as the detection phase value “δ” (or the light emission phase value “δ”), the polarities of the vertical axis values in FIGS. 62 (a) and 62 (b) are inverted. That is, while the vertical axis value in FIG. 62 (a) takes a positive value, the vertical axis value in FIG. 62 (b) takes a negative value. Therefore, in the vicinity of the “A area”, a product calculation result between the vertical axis values in FIGS. 62 (a) and 62 (b) is a negative value.

Therefore, a value obtained by summating the product calculation result between the vertical axis values in FIGS. 62 (a) and 62 (b) with the entire detection phase value “δ” (or the entire light emission phase value “δ”) is not a very large value.

In a location where a value of a “B area” is taken as the detection phase value “δ” (or the light emission phase value “δ”), the polarities of the vertical axis values in FIGS. 62 (a) and 62 (d) are inverted. That is, while the vertical axis value in FIG. 62 (a) takes a negative value, the vertical axis value in FIG. 62 (d) takes a positive value. Therefore, in the vicinity of the “B area”, a product calculation result between the vertical axis values in FIGS. 62 (a) and 62 (d) is a negative value. Therefore, a value obtained by summating the product calculation result between the vertical axis values in FIGS. 62 (a) and 62 (d) with the entire detection phase value “δ” (or the entire light emission phase value “δ”) also does not become a very large value.

On the other hand, a product calculation result between the vertical axis values in FIGS. 62 (a) and 62 (c) is a positive value throughout the detection phase value “δ” (or the light emission phase value “δ”). As a result, a value obtained by summating the product calculation result between the vertical axis values in FIGS. 62 (a) and 62 (c) with the entire detection phase value “δ” (or the entire light emission phase value “δ”) takes a maximum value. In step 116 of FIG. 56B, the distance “L” is calculated from the delay time “τ2” when the summation value takes the maximum value using the method described in FIG. 61.

The AC signal of the theoretical prediction characteristic for each delay time “τ” finely changed as described above is prepared in advance. Between a measurement characteristic FIG. 62 (a) obtained from the measured object 22 and individual theoretical prediction characteristic AC signals FIGS. 62 (b) to 62 (d), product calculation for each detection phase or light emission phase “δ” is performed. Then, a delay time “τ” when a value obtained by the summation of the product calculation result with the entire detection phase (light emission phase) is maximized is searched. In the theoretical prediction characteristic having the delay time “τ” in which the summation value is maximized, the measurement characteristic FIG. 62 (a) obtained from the measured object 22 and the detection phase (light emission phase) “δ” are matched.

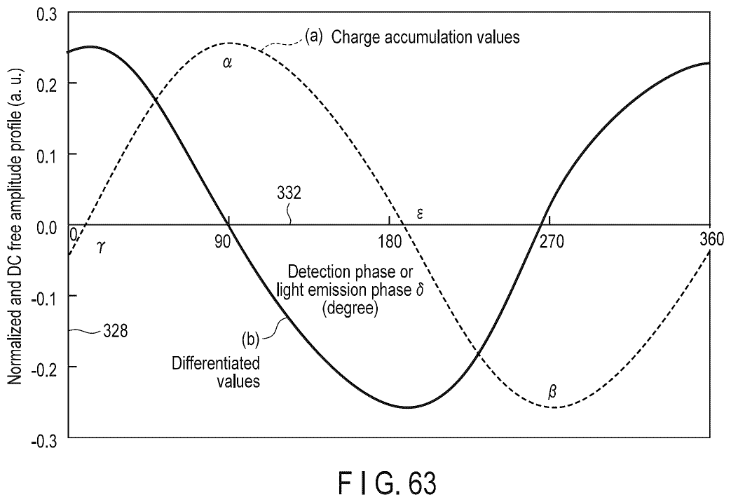

FIG. 63 (a) illustrates examples of a measurement result of a detection phase profile or a light emission phase profile corresponding to charge accumulation values. And FIG. 63 (b) illustrates examples a detection phase profile or a light emission phase profile corresponding to differentiated values of a measurement result in a detection phase direction. In an evaluation experiment, a detection phase profile (or a light emission phase profile) corresponding to a charge accumulation value 340 within measuring periods was measured by changing the detection phase “δ” 332 described with respect to FIG. 57. In other words, the horizontal axis in FIG. 63 indicates detection phase “>” 332. However, the present embodiment is not limited thereto, and for example, a light emission phase or a combination of a detection phase and a light emission phase may be set on the horizontal axis. Here, the detection phase is changed in units of “11.25 degrees” obtained by dividing “360 degrees” into 32. And the vertical axis in FIG. 63 indicates “normalized and DC free amplitudes” regarding charge accumulation values. In this evaluation experiment, the evaluation optical system illustrated in FIG. 53 was used. A 100-yen coin made of nickel was used as the measured object 22, and was disposed at a position 61 cm away from the image sensing plane 394 of the imaging sensor 270 relating to a depth (distance) signal. When a large amount of speckle noise is generally mixed in reflected light from metal such as nickel, the measurement accuracy is to be significantly lowered. On the contrary, this evaluation experiment employed an optical noise reduction technique described later in Chapter 4 to greatly reduce speckle noise.

The profile in FIG. 63 (a) represents a “normalized and DC free amplitude profile” after direct current factor removal performed in step 112 in FIG. 56B. FIG. 63 (b) illustrates a waveform after the profile in FIG. 63 (a) is differentiated in the detection phase “δ” direction. In the present embodiment example, the waveform shown in FIG. 63 (a) or FIG. 63 (b) is used as a measured signal. As previously described with reference to FIG. 8, the “phase-dependent and pixel-dependent accumulated charge receiver 554” included in the signal receptor 40 may form the waveform shown in FIG. 63 (a) or FIG. 63 (b) indicating detection phase profiles or light emission phase profiles.

And then, the “depth (distance) calculator 560 for each pixel (distance between measured object and imaging sensor)” included in the signal processor 42 (FIG. 8) may perform the operational processing relating to the measured signal 5 (the waveform shown in FIG. 63 (a) or FIG. 63 (b)). Here, an example of the operational processing corresponds to the “locking operation” described above. The “locking operation” performs multiplication between the measured signal 5 (the waveform shown in FIG. 63 (a) or FIG. 63 (b)) and a series of reference signals (a plurality of candidates of shift reference signals) prepared in advance. And then, the “locking operation” adds the multiplication result in (along) the detection phase “δ” direction to calculate the pattern matching degree between the measured signal 5 and the series of reference signals (a plurality of candidates of shift reference signals).

Both the waveforms in FIGS. 63 (a) and 63 (b) show that the influence of a subtle change in the measured distance “L” (or the delay time “t”) greatly appears in the “γ area” and the “¿ area”. In the measured signal in FIG. 63 (a), only a “small absolute value of the integration result with product values of the measured signal 5 and each of the reference signals (each of a plurality of candidates of shift reference signals)” must be obtained in the “γ area” and the “E area” though an “absolute value of the integration result with product values of the measured signal 5 and the reference signal” becomes a large value in the “x area” and the “B area”.

On the other hand, in the waveform in FIG. 63 (b) obtained by differentiating the waveform in FIG. 63 (a), the measured signal 5 (the waveform) has big absolute values in the “γ area” and the “¿ area”. And in the “γ area” and the “ε area”, the influence of a subtle change in the measured distance “L” (or the delay time “τ”) appears large. Therefore, a big “integration result with product values of the measured signal 5 and the reference signal” is obtained in the “γ area” and the “ε area”. That is, compared with FIG. 63 (a) illustrating a detection phase profile or a light emission phase profile corresponding to charge accumulation values, the use of the waveform (the measured signal 5) in FIG. 63 (b) obtained by differentiating the profile in the detection phase direction can provide higher distance measurement accuracy. A waveform used as the measured signal 5 in the present embodiment example is not limited to the above, and a waveform obtained by performing some signal processing on a profile corresponding to the charge accumulation value 340 within measuring periods depending on the detection phase “δ” or the light emission phase “δ” may be used as the measured signal.

The rough distance calculation result performed in step 100 in FIG. 56A has a similar degree of distance measurement accuracy to the distance evaluation described with respect to FIG. 49 (g) using Equation 6. For example, in a case where a large noise mixture occurs only in a specific pixel (for example, a pixel 1262 detecting red and near infrared light shown in FIG. 41) at the stage of collecting the waveform in FIG. 49 (g), a large calculation error occurs in Equation 6. Similarly, even in a case where large noise is mixed in a part of the waveform illustrated in FIG. 61 (b), the distance measurement accuracy significantly decreases.

In comparison with the calculation using Equation 6, the distance measurement accuracy is greatly improved when the highly accurate distance calculation performed in step 110 in FIG. 56A is used. The reason is that, according to FIGS. 63 (a) and 63 (b), the measured distance “L” is calculated using the entire waveform (the entire measured signal 5) over the entire phase value. That is, the entire change accumulation profile of the charge accumulation value 340 in the detection phase “δ” or light emission phase “δ” direction (along the phase direction) is used for calculation of the measured distance “L”. In other words, the measured distance “L” is calculated using the result of the profile comparison between the reference signal and the measured signal 5 indicating the change accumulation profile of the charge accumulation value 340 depending on the phase “δ”. Herein, the profile comparison between the reference signal and the measured signal actually belongs to a kind of the operational processing regarding pattern matching. And the operational processing regarding pattern matching achieves between the measured signal 5 and a plurality of candidates of shift reference signals “Rq(p)”.

Therefore, even if noise is mixed in a part of the waveform (the measured signal 5), the influence on the entire waveform is reduced because the influence of the noise is extensively distributed in the entire waveform (the measured signal 5). In addition, the signal processor 42 (FIG. 8) may perform a mechanism for removing a noise component when the signal processor 42 achieves the process of calculating the degree of pattern matching as described later. Therefore, the influence of the mixed noise is further reduced.

In the present embodiment example, in order to accurately acquire the entire waveform (the entire measured signal 5) over all phase values, a shift amount of the detection phase “δ” or the light emission phase “δ” (a value of shifting measured unit along the phase direction) is finely set. That is, a division number “N” for the entire phase range from “0 degrees” to “360 degrees” is increased. In the embodiment example in FIG. 41 or 49 (g), this division number corresponds to “N=4”. In comparison, FIGS. 57 and 58 illustrate an embodiment example of “N=8”. Note that the high-accuracy distance calculation in the present embodiment example is not limited thereto, and may be “N>8” (for example, a value of “N” may be 16, 32, 64, or the like).

On the other hand, when the division number “N” exceeds “1000”, a problem that a measuring period significantly increases occurs. When distance measurement according to Chapter 3 (and three-dimensional shape measurement using the distance measurement as a starting point) is performed, the division number “N” along the direction of the detection phase “δ” or the light emission phase “&” within a measuring period can be easily determined. Therefore, when the division number in the measuring period is “1000 or less” and “more than 4” (desirably more than “8” or “10 or more”), it can be considered that the highly accurate distance measurement (and the three-dimensional shape measurement derived) described in the present embodiment example is performed.

Another viewpoint describes the above description. In FIG. 49 (g) or Equation 6, a phase value “Φ” is calculated using the four arithmetic operations between the four signal values “A1” to “A4”. When noise is mixed in any of the four signal values “A1” to “A4” as described above, the four arithmetic operation results greatly change, and thus the calculation accuracy of the phase value “@” is greatly reduced. In comparison, in FIG. 63, a “waveform profile” indicating a change profile in the charge accumulation values (FIG. 63 (a)) or a change in the differential profile (FIG. 63 (b)) due to a difference in the phase value of a detection phase, a light emission phase, or a mixture of both is collected.

When a difference in a signal processing method or a data analysis method is clarified, there is a basic difference between the idea based on the “four arithmetic operations” between the four signal values “A1” to “A4” using Equation 6 and the idea of using “collection of entire waveform profiles (entire measured signal profiles)” illustrated in FIG. 63 (obtained from the measuring method in response to FIGS. 56A to 64) as a starting point. Only one type of information can be obtained from the result of the “four arithmetic operations”. In comparison, a large amount of information can be obtained from the collected “entire waveform profiles (entire measured signal profiles)”.

In the present embodiment example illustrated in FIGS. 56A to 64, “waveform evaluation” (or waveform analysis) is performed on the collected” waveform profiles (measured signal profiles)”. Regarding the waveform evaluation (or waveform analysis), at least one of “quantification of a waveform deviation values” and “quantification of a waveform distortion values” may be performed. As a method of this waveform evaluation (or waveform analysis), “waveform comparison” between the waveform of the measured signal 5 and the waveform of the reference signal (each of many candidates of shift reference signals) is performed. Therefore, this “waveform comparison” may apply at least one of the “quantification of a waveform deviation values” and the “quantification of a waveform distortion values”.

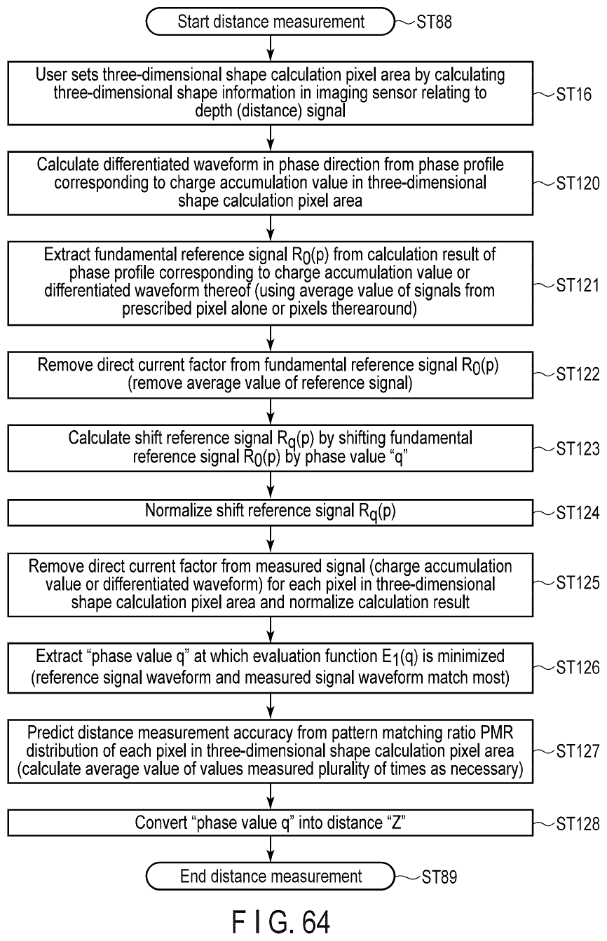

The present embodiment (the “depth (distance) calculator 560 for each pixel (distance between measured object and imaging sensor)” shown in FIG. 8) may use a pattern matching method in pattern matching situations between the two waveforms as means of “waveform comparison” between some waveforms. That is, as illustrated later in FIG. 126, the collected waveform (a characteristic waveform of the charge accumulation value 340 or a differentiated waveform thereof) provides a big deviation from the reference signal along the phase “δ” direction (the detection phase 332 or the light emission phase 342) when the distance to the measured object 22 goes over the measurement range. Therefore, the minimum deviation value along the phase “δ” direction may suggest an appropriate distance to the measured object 22. Using the process illustrated in FIG. 64 and the calculation formulas from Equation 18 to Equation 27, the “waveform comparison” between the waveform of the measured signal 5 and the waveform of the reference signal is described later.

A specific examples of performing “quantification of a waveform distortion value” and performing “waveform evaluation” (or waveform analysis) on the collected “waveform profiles” are described. Prior to the descriptions, a “ghost three-dimensional shape” generated in the calculation result of Equation 6 based on FIG. 49 (g) is described earlier. In the standard modulation light emission state illustrated in FIG. 49 (f), modulation is repeated in a cycle “4t”. Therefore, the calculation result of Equation 6 is equal between the phase value “Φ” and a phase value “Φ+4τ” further deviating by the cycle “4τ”. As a result, in the calculation result of Equation 6 based on FIG. 49 (g), the measured object 22 located far away is erroneously measured as if it exists at a close position. Here, a “three-dimensional shape erroneously measured as if it exists at a close position” is referred to as a “ghost three-dimensional shape”.

Since measured signal amplitude (signal amount or measured light intensity) obtained from the distant measured object 22 is small, the signal processor 42 shown in FIG. 8 may the ghost three-dimensional shape based on the magnitude of the measured signal amplitude. However, it is difficult to determine a difference between “a case where the measured object 22 having a low reflectance is present nearby” and the “ghost three-dimensional shape” when the signal processor 42 achieves only the calculation of Equation 6 based on FIG. 49 (g). In comparison, when a “waveform profile” including more information is collected, it is possible to determine a difference between “a case where the measured object 22 having a low reflectance is present nearby” and the “ghost three-dimensional shape”.

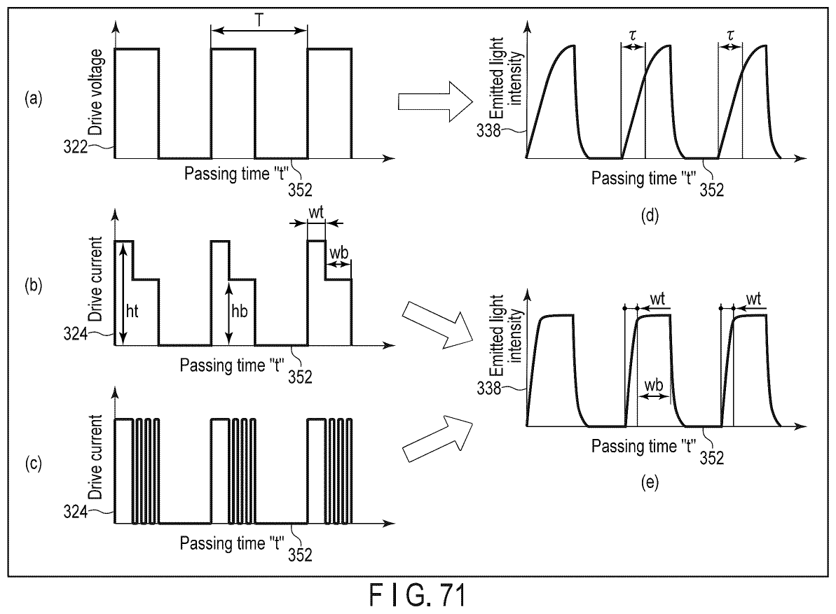

A relationship between an arrival distance to the measured object 22 and a modulation characteristic of the detection light 19 (the detected light waveform) is described. For example, it is assumed that the modulation characteristic (a change in the emitted light intensity along the time direction) of the irradiated light (first light) 13 immediately after emission from the light source 2 is “a rising characteristic and a falling characteristic of the emitted light intensity are both steep” as described later with reference to FIG. 71 (e).

It is known that “a rising characteristic and a falling characteristic of the emitted light intensity deteriorate” as the transmission distance of the irradiated light (first light) 13 increases. That is, when the transmission distance increases, the light modulation characteristic deteriorates from the steep waveform shown in FIG. 71 (e) into the dull waveform shown in FIG. 71 (d). However, the length “2ΔL0” of the wave train described later takes a constant value regardless of the transmission distance. That is, the modulation characteristic (the light intensity waveform) of the measured signal 7 (a profile corresponding to charge accumulation values in the phase direction or a detection phase profile or light emission phase profile corresponding to differentiated values thereof) changes according to a change in the distance to the measured object 22.

Using this characteristic change, the signal processor 42 shown in FIGS. 1 and 8 may perform the determination of the “ghost three-dimensional shape”. Specifically, the reference signal is measured in advance using reflected light from a standard object (reference object) disposed near the optical device 10. Therefore, using Equation 26 and Equation 27 described later, the signal processor 42 may calculate a pattern matching ratio PMR (waveform matching ratio) of a “measured signal S(p)” with respect to a corresponding “shift reference signal Rq(p) serving as a reference”.

When the measured object 22 is disposed near the optical device 10, the pattern matching ratio PMR is high. On the other hand, the pattern matching ratio PMR is low when the measured object 22 is located far away from the optical device 10. Therefore, in a case where the pattern matching ratio PMR is lower than a prescribed value (80%, 60%, or 90%), a “ghost three-dimensional shape” is determined. In a case where a “ghost three-dimensional shape” is determined, the signal processor 42 stops the conversion of the distance “Z” based on Equation 17 (or Equation 9) and stops the conversion to the coordinate values in the X-axis direction and the Y-axis direction based on Equation 4.

That is, calculating the pattern matching ratio PMR, the present embodiment (the signal processor 42) can distinguish between a “three-dimensional shape with a low light reflectance near the optical device 10” and a “ghost three-dimensional shape”. Therefore, without erroneous measurement, the present embodiment (the signal processor 42) accurately calculates the three-dimensional shape and the three-dimensional coordinate value (and a time variation thereof) based on three-dimensional projective reverse transformation. Therefore, the “collection of entire waveform profiles (collection of entire measured signal profiles)” guarantees the accurate measurement of three-dimensional shape.

The present embodiment below explains an example of a specific calculation method using the measured signal 5 illustrated in FIG. 63 (a) or 63 (b). Using FIG. 62, the basic concept of the highly accurate distance calculation method described in step 110 in FIG. 56A has been outlined. Here, a detailed calculation method is described based on a series of specific equations.

A method of measuring the distance “L” to the measured object 22 basically includes irradiating the measured object 22 with the irradiated light (first light) 13 from the light source 2 as illustrated in FIG. 40. The measurer 8 receives the detection light (second light) 19 from the measured object 22. A delay time “τ” until the light returns to the measurer 8 from the light source 2 is measured. In the present embodiment example, the optical path of the irradiated light (first light) 13 and the optical path of the detection light (second light) 19 may coincide with each other, or another optical path may be set.

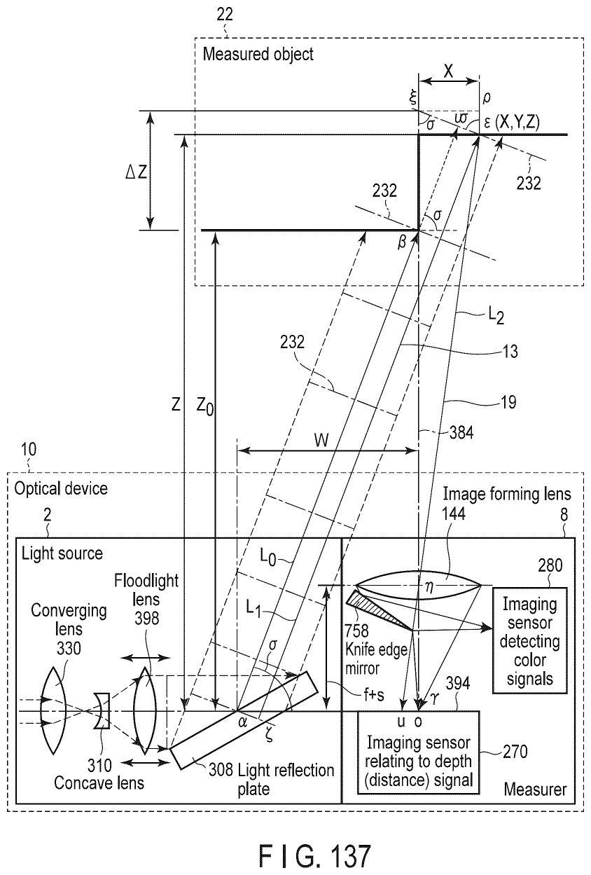

Here, a calculation method in a case where the optical system in FIG. 53 or in FIG. 137 may be used as an example so that calculation can be performed for any optical path described below. The following calculation algorithm is applicable not only to FIG. 53 or FIG. 137 exemplified herein but also to any optical system capable of distance measurement (and three-dimensional coordinate measurement of a target point derived) using the irradiated light (first light) 13 and the detection light (second light) 19 illustrated in FIG. 40.

For example, the following calculation algorithm may also be used for an optical system in which a 3D color imaging sensor 1280 illustrated in FIG. 41 performs distance measurement (measurement of three-dimensional coordinates of a target point) and collection of a color image (movie). Furthermore, the following calculation algorithm may be used for the optical system illustrated in FIGS. 54 and 55. In the optical system illustrated in FIGS. 54 and 55, the measured object 22 is irradiated with divergent light from a point of the optical device 10 as the irradiated light (first light) 13. However, the present embodiment is not limited thereto, and, in the optical system illustrated in FIGS. 54 and 55, a concave lens 310, a floodlight lens 398, and a light reflection plate 308 may be disposed in the middle of the optical path of the irradiated light (first light) 13 as illustrated in FIG. 53.

According to FIG. 53 or FIG. 137, a distance “W” represents a distance between the “axis of rotation (center point ‘α’) of the light reflection plate 308 (intersection point between the optical axis 384 of the image forming lens 144-1 and the measured object 22)” and the “center point of the imaging sensor 270 relating to a depth (distance) signal (intersection point between the optical axis 384 of the image forming lens 144-1 and the image sensing plane 394). Here, a situation of “W=0” corresponds to a state in which “optical paths of the irradiated light (first light) 13 and the detection light (second light) 19 coincide with each other”. Moreover, both FIG. 53 and FIG. 137 locate the axis of rotation (the center point “α”) of the light reflection plate 308 on an extension plane of the image sensing plane 394 of the imaging sensor 270 relating to depth (distance) signal.

According to the optical system shown in FIG. 53 or FIG. 137, the distance “Z” represents a distance from the “image sensing plane 394 (intersection point between the optical axis 384 of the image forming lens 144-1 and the image sensing plane 394 in the imaging sensor 270 relating to a depth (distance) signal)” to “the measured object 22 (an intersection point between the optical axis 384 of the image forming lens 144-1 and the measured object 22). In the above description, the delay time “τ” until the light returns to the measurer 8 from the light source 2 is expressed using the phase value “δ” (corresponding to both the detection phase and the light emission phase). From now on, according to the optical system shown in FIG. 53 or in FIG. 137, the present embodiment defines a new phase variable “q”. In response to a relation between the phase parameters “δ” and “q”, the present embodiment defines “δ=q0” when “Z=0”, and both phase parameters of “δ” and “q” have the same scale.

Therefore, the phase variable “q” at which “Z=0” when “q=0” is set as follows.

$$[ Equation 7 ]$$

$$q ≡ δ - {q}_{0} ( Z = 0 \to δ = {q}_{0} ) \qquad Equation 7$$

According to FIG. 53 or FIG. 137, a relation between the phase variable “q” and the distance “Z” from the “image sensing plane 394 in the imaging sensor 270 relating to a depth (distance) signal” to the measured object 22 is set as follows.

$$[ Equation 8 ]$$

$$cT \frac{q}{360} = Z - W + \sqrt{{Z}^{2} + {W}^{2}} \qquad Equation 8$$

When this Equation 8 is transformed to obtain the distance “Z”,

$$[ Equation 9 ]$$

$$Z = \frac{cTq}{360} ( 1 - \frac{cTq}{2 cTq - 720 W} ) \qquad Equation 9$$

is defined.

In particular, in a case where the distance “W” from the center point of the light reflection plate 308 to the center point of the imaging sensor 270 relating to a depth (distance) signal is relatively small, Equation 9 can be approximated as the following Equation 10.

$$[ Equation 10 ]$$

$$Z ≅ \frac{cTq}{720} ( W ≪ \frac{cTq}{360} ) \qquad Equation 10$$

Incidentally, in a case where an optical system in which the optical path of the irradiated light (first light) 13 and the optical path of the detection light (second light) 19 coincide with each other is employed, Equation 10 is directly applied.

Note that Equation 9 indicates an optical path length of a light beam passing through “α point”, “β point”, and “o point”. Here, according to FIG. 53 or FIG. 137, “α point” corresponds to the rotation center (the axis of rotation) of the light reflection plate 308. And “β point” corresponds to the intersection point between the measured object 22 and the optical axis 384 of the image forming lens 144-1, and “o point” corresponds to the intersection point between the optical axis 384 of the image forming lens 144-1 and the image sensing plane 394 in the imaging sensor 270 relating to a depth (distance) signal. The phase variable “q” and the distance “Z” are directly linked from the relational formula indicated by Equation 9 or 10.

As explained above, Equation 9 indicates an optical path length of a light beam passing through “x point”, “β point”, and “o point”. Here, the optical path passing through “β point” and “o point” equals to the optical axis 384 of the image forming lens 144-1. In other words, the optical path from “β point” to “o point” draws the same line as the optical axis 384 of the image forming lens 144-1. However, on the image sensing plane 394, many pixels are arranged in a two-dimensional direction of the “u-axis” direction and the “v-axis” direction. A position of a prescribed pixel 271 located on the optical axis 384 of the image forming lens 144-1 may be taken as the origin of the “u-axis” and the “v-axis”. In other words, a center position of the prescribed pixel 271 located on the optical axis 384 of the image forming lens 144-1 has coordinate values of “u=0” and “v=0”. Thus, another center position of each of other pixels 271 positioned away from the origin of the coordinate axes has each coordinate value set “(u, v)” respectively.

Both FIG. 53 and FIG. 137 show “E point” that is located on the surface of the measured object 22 and that has a coordinate value set “(X, Y)”. And a center position having corresponding coordinate value set “(u, V)” and included in the corresponding pixel 271 has the confocal relation with the “E (X, Y) point”. As illustrated in FIG. 53 and FIG. 137, the positive direction between the u-axis and the X-axis is reversed, and the positive direction between the v-axis and the Y-axis is also directed in the opposite direction. The optical path started from the “E (X, Y) point” and passing through the principal point (strictly, a forward principal point) of the image forming lens 144-1 travels straight and arrives at the “(u, v) position” in the imaging sensor 270 relating to a depth (distance) signal.

In the following calculation model, a case is assumed in which the measured object 22 is irradiated with divergent light from the “α point” at the rotation center (an axis of rotation) of the light reflection plate 308 illustrated in FIG. 53 as the irradiated light (first light) 13. An equation corresponding to Equation 8 in this case is as follows.

$$[ Equation 11 ]$$

$$cT \frac{q}{360} = {L}_{1} + {L}_{2} - W \qquad Equation 11$$

Here, “L1” in Equation 11 indicates an optical path length from the “α point” to α point “ε (X, Y)” on the surface of the measured object 22. Furthermore, “L2” indicates an optical path length from the point “ε (X, Y)” to the pixel point “(u, v)” on the image sensing plane 394.

The optical path length “L2” from this point “ε (X, Y)” to the pixel point “(u, v)” on the image sensing plane 394 is calculated as follows from FIG. 53.

$$[ Equation 12 ]$$

$${L}_{2} = \sqrt{{( X + u )}^{2} + {( Y + v )}^{2} + {z}^{2}} \qquad Equation 12$$

The optical path length “L2” indicates only a linear distance from the point “ε (X, Y)” to the pixel point “(u, v)” on the image sensing plane 394. From the optical characteristics of the image forming lens 144-1, the optical path length of the light passing through a peripheral portion (a position away from the optical axis 384) in the image forming lens 144-1 also coincides with the above linear distance.

Equation 4 shows only the relationship between the coordinate value “u” and the coordinate value “X”. Although the description of the equation is omitted, the relationship between the coordinate value “v” and the coordinate value “Y” also has the same relational formula as in Equation 4. When Equation 4 is put into Equation 12 and put together as a common term, terms of Equation 13 can be extracted.

$$[ Equation 13 ]$$

$$D ( u , v ) = \sqrt{{( \frac{u}{f + s} )}^{2} + {( \frac{v}{f + s} )}^{2} + 1} \qquad Equation 13$$

When this Equation 13 is substituted into Equation 12, Equation 13 can be simplified as Equation 14.

$$[ Equation 44 ]$$

$${L}_{2} = D Z \qquad [ Equation 44 ]$$

In addition, with respect to the optical path length “L1” from the “α point” to the point “ε (X, Y)” on the surface of the measured object 22, when the relationship between Equation 4, the coordinate value “v”, and the coordinate value “Y” is used,

$$[ Equation 14 ]$$

$$\begin{matrix}{L}_{{1}^{=}} \sqrt{{( W - X )}^{2} + {Y}^{2} + {Z}^{2}} \\ \sqrt{{W}^{2} + 2 uW - \frac{2 ( Wu + {u}^{2} + {v}^{2} )}{f + s} Z + {D}^{2} {Z}^{2}} \\ ( {u}^{2} + {v}^{2} ≪ {D}^{2} {Z}^{2} )\end{matrix} \qquad Equation 15$$

is obtained.

In the formula on the lower right side of Equation 15, “u2+v2” is assumed to be sufficiently smaller than “D2Z2”, and is approximated as “u2+v2≈0”.

On the other hand, if Equation 11 is modified to take the squares of both sides,

$$[ Equation 16 ]$$

$${L}_{1}^{2} = {( \frac{cTq}{360} + W - {L}_{2} )}^{2} = {( \frac{cTq}{360} + W - DZ )}^{2} \qquad Equation 16$$

is defined.

When Equation 15 is substituted into Equation 16, the terms “W2” and “D2Z2” are canceled out. As a result, only a linear expression regarding the following “Z” remains.

$$[ Equation 17 ]$$

$$Z = \frac{{( \frac{cTq}{360} )}^{2} + \frac{cTqW}{180} - 2 Wu}{\frac{cTqD}{180} + 2 DW - \frac{2 ( Wu + {u}^{2} + {v}^{2} )}{f + s}} \qquad Equation 17$$

The distance “Z” to the confocal position corresponding to the position “(u, v)” of any pixel 271 configuring the image sensing plane 394 in the imaging sensor 270 relating to a depth (distance) signal can be calculated by using Equation 17. When the calculated distance “Z” is substituted into Equation 4, an “X coordinate value” of the corresponding point is obtained. Furthermore, as described above, the same relationship as in Equation 4 is established between a “v coordinate value” and a “Y coordinate value”. Therefore, the “Y coordinate value” of the corresponding point is obtained from the “v coordinate value”.

FIG. 137 illustrates an application example of the present embodiment with respect to the calculation model shown in FIG. 53. FIG. 53 illustrates a calculation model in which the measured object 22 is irradiated with divergent light from the “α point”. In comparison, FIG. 137 illustrates a calculation model in a case where the measured object 22 is irradiated with the irradiated light (first light) 13 in a “parallel light” state.

As illustrated in FIG. 137 as an example of a method of irradiating the measured object 22 with “parallel light”, the irradiated light (first light) 13 immediately after passing through the floodlight lens 398 may be set to “parallel light”. The present embodiment is not limited thereto, and the irradiated light (first light) 13 may form an image pattern on the measured object 22. That is, a light converging plane is formed between a converging lens 330 and a concave lens 310 in FIG. 137. The position of the floodlight lens 398 in the optical axis direction may be adjusted such that the measured object 22 comes to the position of the image pattern forming plane (the plane including the confocal) with respect to the light converging plane.

Compared with the divergent light illustrated in FIG. 53, an intensity density of the irradiated light 13 becomes higher when the measured object 22 is irradiated with the “parallel light”. As a result, the distance measurement accuracy to the measured object 22 is improved by using the irradiation method in FIG. 137. When the light source 2 that generates the irradiated light (first light) 13 and the measurer 8 that receives the detection light (second light) 19 are mechanically separated as illustrated in FIG. 137, the irradiated light intensity of the irradiated light (first light) 13 on the measured object 22 can be easily optimized.

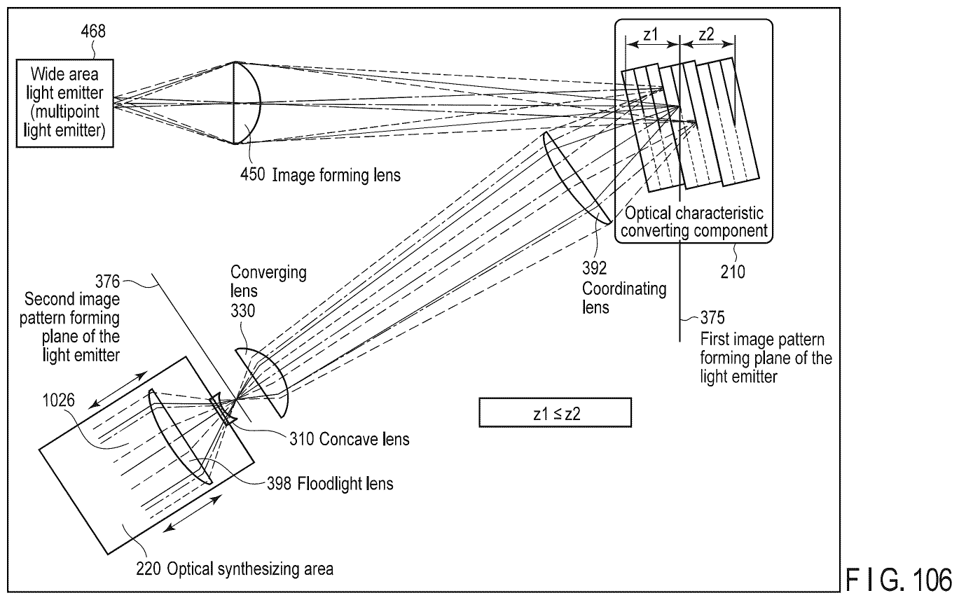

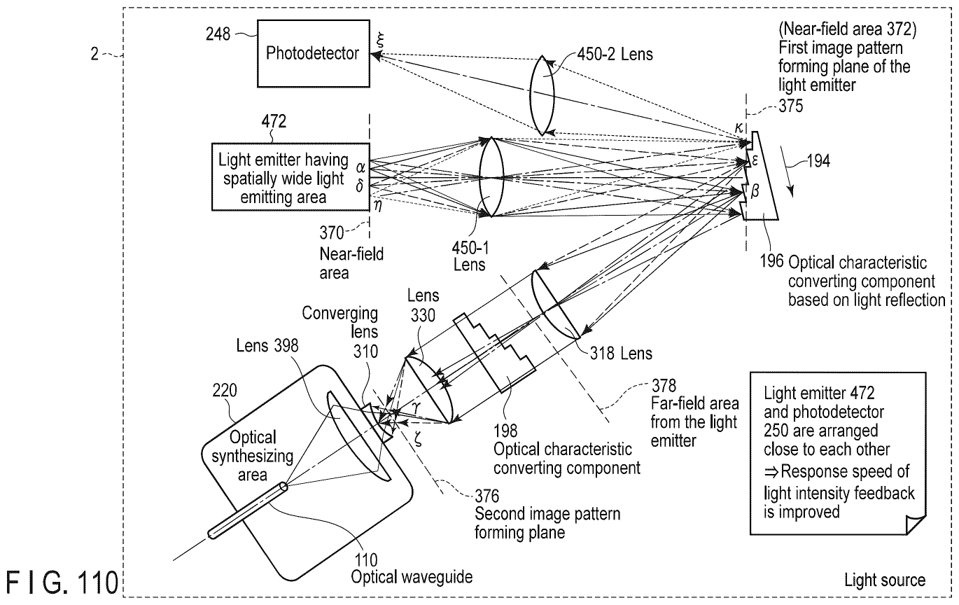

Incidentally, the technique described in Chapter 4 may be used for the optical system from the light emitter 468, 470, or 472 to the light reflection plate 308 in the light source 2 in FIG. 137. For example, the optical system described with reference to FIG. 106 may be used. Alternatively, the outlet of the optical waveguide (optical fiber/light waveguide/optical guide) 110 described with reference to FIG. 110 may be disposed immediately before the floodlight lens 398 (in this case, the disposition of the converging lens 330 and the concave lens 310 in FIG. 137 is omitted).

First, description of each point position illustrated in FIG. 137 is started. The “point α” corresponds to a biaxial rotation center position of the light reflection plate 308. Here, the “point α” is disposed on an extension plane of the image sensing plane γ 394 of the imaging sensor 270 relating to a depth (distance) signal. The “point η” indicates a principal point (backward principal point) position of the image forming lens 144. The “point β” shows an intersection between the surface of the measured object 22 and the optical axis (imaging view line) 384 of the image forming lens 144. The distance from the image sensing plane γ 394 of the imaging sensor 270 relating to a depth (distance) signal to the “point “β” is defined as “Z0”.

In FIG. 137, coordinate axes are defined with reference to the optical axis (imaging view line) 384 of the image forming lens 144. That is, an intersection position between the image sensing plane γ 394 of the imaging sensor 270 relating to a depth (distance) signal and the optical axis (imaging view line) 384 of the image forming lens 144 is defined as a “point o”. The distance between the “point o” and the “point α” is defined as “W”. Furthermore, in a case where the position of the image forming lens 144 is optimized such that the detection light (second light) 19 reflected at the “point β” forms an image pattern (converges) at the “point o” on the image sensing plane γ 394 of the imaging sensor 270 relating to a depth (distance) signal (such that the “point β” and the “point o” have a confocal relation), the distance between the “point η” and the “point o” is “f+s”. Here, the parameter “s” satisfies Equation 2. Furthermore, the coordinates of each pixel on the image sensing plane γ 394 are represented by “(u, v)” when the “point o” is set as the origin of the coordinate axes and has a coordinate value set of “(0, 0)”.

Similarly, coordinates in a plane direction perpendicular to the optical axis (imaging view line) 384 of the image forming lens 144 in the measured object 22 are represented by “(X, Y)”. The coordinate values in the X-axis direction and the Y-axis direction of the “point” are set to “(0, 0)”. In FIG. 137, the u-axis direction and the X-axis direction are parallel, and the positive directions thereof are set to be opposite to each other. That is, the right direction in FIG. 137 is defined as a positive direction on the X-axis, and the left direction in FIG. 137 is defined as a positive direction on the u-axis. Although not illustrated, the v-axis positive direction and the Y-axis positive direction are similarly set in opposite directions.

FIG. 137 illustrates a planar shape example (two planes viewed from the XY plane direction) having “difference levels” in the XZ cross section as a surface shape example of the measured object 22. Here, the distance between the “point α” and the “point β” represents “L0”. The coordinates of the “point ε” where a light beam shifted rightward from the straight line connecting the “point α” and the “point β” in the irradiated light (first light) 13 intersects the surface of measured object 22 are represented by (X, Y, Z). In this case, the distance from the image sensing plane γ 394 of the imaging sensor 270 relating to a depth (distance) signal to the “point ε” is “Z”.

FIG. 137 shows that the position of the floodlight lens 398 is adjusted such that the irradiated light (first light) 13 having passed through the floodlight lens 398 becomes “parallel light” (light in a parallel state). Considering geometrical optics, a uniform phase plane (wavefront) 232 of the irradiated light (first light) 13 is planar everywhere. In the irradiated light (first light) 13 directed to the measured object 22, a distance from the “point ζ” located in the uniform phase plane (wavefront) 232 including the “point α” to the “point ε” is expressed by “L1”. The distance from the “point E” to a position having the coordinate value “u” on the image sensing plane γ 394 of the imaging sensor 270 relating to a depth (distance) signal represents “L2”. Note that Equation 14 indicated this distance “L2” already.

As illustrated in FIG. 137, the uniform phase plane (wavefront) 232 of the irradiated light (first light) 13 in the state of the parallel light has an angle inclined with respect to the straight line connecting the “point α” and the “point o” and extends in a direction perpendicular to the paper surface. Here, an angle between the straight line connecting the “point α” and the “point o” and the straight line connecting the “point α” and the “point β” represents “σ”. Next, an intersection between the uniform phase plane (wavefront) 232 including the “point ε” and the extension line including the “point α” and the “point β” is set to a “point u”. An intersection between the uniform phase plane (wavefront) 232 including the “point ε” and the optical axis (imaging view line) 384 of the image forming lens 144 is set to a “point ξ”. The distance between the “point ξ” and the “point β” along a direction parallel to the optical axis of the image forming lens 144 represents “ΔZ”.

Using the relationship between the triangles connecting the respective points defined above, a calculation formula for calculating the three-dimensional coordinate values “(X, Y, Z)” of any “point ε” in the measured object 22 is derived as follows. When “Z0” is substituted into “Z” in Equation 2,

$$[ Equation 43 ]$$

$$f + s = \frac{{Z}_{0}}{2} \{ 1 - \sqrt{1 - \frac{4 f}{{Z}_{0}}} \} \qquad Equation 43$$

is derived.

In the future equation development, the above Equation 43 is used for “f+s”.

As is clear from FIG. 137, a relationship of the following Equation 44 is satisfied.

$$[ Equation 44 ]$$

$${L}_{0}^{2} = {Z}_{0}^{2} + {W}^{2} \qquad Equation 44$$

From a relationship between the triangle connecting the “point α”, the “point β”, and the “point o” and the triangle connecting the “point β”, the “point ξ”, and the “point u”,

$$[ Equation 45 ]$$

$$sin σ = \frac{{Z}_{0}}{{L}_{0}} = \frac{{L}_{1} - {L}_{0}}{Δ Z} \qquad Equation 45$$

is established.

When Equation 45 is modified and then Equation 44 is substituted,

$$[ Equation 46 ]$$

$$Δ {ZZ}_{0} = {L}_{0} {L}_{1} - {Z}_{0}^{2} - {W}^{2} \qquad Equation 46$$

is derived.

On the other hand, when Equation 4 is substituted into a relationship between the triangle connecting the “point α”, the “point β”, and the “point o”, and the triangle connecting the “point ε”, the “point ξ”, and the “point ρ”,

$$[ Equation 47 ]$$

$$tan σ = \frac{{Z}_{0}}{W} = \frac{X}{{z}_{0} + Δ Z - Z} = \frac{\frac{uZ}{f + s} - u}{{Z}_{0} + Δ Z - Z} \qquad Equation 47$$

is obtained.

Further, when Equation 47 is modified and Equation 46 is substituted,

$$[ Equation 48 ]$$

$$\frac{WuZ}{f + s} = Wu = {L}_{0} {L}_{1} - {Z}_{0} Z - {W}^{2} \qquad Equation 48$$

is derived.

When both sides of Equation 14 are multiplied by “L0” and added to both sides of Equation 48,

$$[ Equation 49 ]$$

$$( \frac{Wu}{f + s} + {Z}_{0} + {L}_{0} D ) Z = {L}_{0} ( {L}_{1} + {L}_{2} ) - {W}^{2} + Wu \qquad Equation 49$$

is obtained.

When Equation 11 is substituted into “L1+L2” in Equation 49,

$$[ Equation 50 ]$$

$$Z = \frac{{cTL}_{0} \frac{q}{360} + W ( {L}_{0} - W + u )}{\frac{Wu}{f + s} + {Z}_{0} + {L}_{0} D ( u , v )} \qquad Equation 50$$

is derived.

Using an evaluation function “E1(q)” or “E2(q)” described later, a “Z coordinate value” of any “point ε” in the measured object 22 can be calculated when the optimum “q value” is substituted into the above Equation 50. By substituting the coordinate values “(u, v)” of the pixel 271 disposed at the position corresponding to the above “point ε” in the image sensing plane γ 394 in the imaging sensor 270 relating to a depth (distance) signal into Equation 4, the three-dimensional coordinate values “(X, Y, Z)” of the above “point α” can be calculated. In Equation 4, only the relationship between the variable “u” and the variable “X” is written. Although not described, a relationship between the variable “v” and the variable “Y” is also established similarly to Equation 4.

A calculation method using Equation 50 is a method of calculating the three-dimensional coordinate values “(X, Y, Z)” of any “point &” in the measured object 22 with reference to the distance “Z0” from the image sensing plane γ 394 of the imaging sensor 270 relating to a depth (distance) signal to the “point β”. That is, in the calculation method described above, first, the first distance “Z0” is measured. Since the “point β” exists on the optical axis (imaging view line) 384 of the image forming lens 144, the first distance “Z0” can be easily measured. Next, another “Z value” (second distance) related to the first distance “Z0” is calculated. In Equation 50 used for this calculation, the already measured first distance “Z0” is used.

As previously described with reference to FIG. 23, the three-dimensional coordinate values “(X, Y, Z)” of any “point ε” in the measured object 22 are based on 3-axis coordinates 1805, 1807, and 1809 defined by the image sensing plane γ 394 in the imaging sensor 270 relating to a depth (distance) signal. That is, a three-dimensional shape and a three-dimensional size of the measured object 22 can be calculated by collecting the three-dimensional coordinate values “(X, Y, Z)” of each point in the measured object 22.

Meanwhile, the three-dimensional coordinate values “(X, Y, Z)” change according to an installation position of the imaging sensor 270 relating to a depth (distance) signal and an imaging direction (an orientation of the image sensing plane 394). However, an absolute coordinate position of the measured object 22 or an orientation of the measured object 22 viewed from the absolute coordinate is not ascertained only from the above information. Therefore, coordinate conversion using information regarding an installation position and an imaging direction (an orientation of the image sensing plane 394) of the imaging sensor 270 relating to a depth (distance) signal in absolute coordinates may be performed to determine an absolute coordinate position of the measured object 22 and an orientation of the measured object 22 viewed from the absolute coordinates.

The basic concept of the three-dimensional projective reverse transformation in the present embodiment example has been described with reference to FIG. 23. That is, the distance “Z” to the corresponding points “A11” to “A33” on the measured object 22 is measured for each of the plurality of pixels 271 of “all” to “a33” two-dimensionally disposed in the “u direction” and the “v direction” on the image sensing plane 394 in the imaging sensor 270 relating to a depth (distance) signal. Specifically, using Equation 17 or the like, the distance “Z” can be calculated from the two-dimensional coordinate values “(u, v)” of each pixel 271 two-dimensionally disposed on the image sensing plane 394 in the imaging sensor 270 relating to a depth (distance) signal. Based on the calculation result of “Z value”, three-dimensional coordinate values of each of the corresponding points “A11” to “A33” on the measured object 22 are calculated. Equation 17 and Equation 4 may be used to calculate the three-dimensional coordinate values of each of the corresponding points “A11” to “A33”. Note that the three-dimensional coordinate

values “(X, Y, Z)” of each of the corresponding points “A11” to “A33” are indicated by three-dimensional coordinates based on the imaging sensor 270 relating to a depth (distance) signal. Further, in the present embodiment example, as previously described with reference to FIG. 40,
1) the measured object 22 is irradiated with irradiated light (first light) 13 emitted from the light source 2,
2) the delay time “τ=2L/c” until the detection light (second light) 19 from the measured object 22 reaches the measurer 8 is measured, and
3) the distance “Z” to each of the corresponding points “A11” to “A33” is calculated.

Note that a relationship between the distance “L” and the distance “Z” is derived from the relationship between Equation 3 and Equation 5 based on the two-dimensional coordinate values “(u, v)” of each pixel 271 in the imaging sensor 270 relating to a depth (distance) signal.

In the present embodiment example, since the plurality of pixels 271 are two-dimensionally disposed on the image sensing plane 394 in the imaging sensor 270 relating to a depth (distance) signal, three-dimensional coordinate values “(X, Y, Z)” of each of the corresponding points “A11” to “A33” can be measured. Therefore, in the three-dimensional projective reverse transformation proposed in the present embodiment example, it is possible to simultaneously measure three-dimensional coordinate values “(X, Y, Z)” in parallel. Therefore, compared with the conventional laser length measurement method, there is a technical merit that high-speed three-dimensional shape measurement can be performed (for example, highly accurate shape measurement in a three-dimensional movie can be supported).

For convenience of description, only Equation 17 and Equation 50 are described here. In a case where another optical path is used for the irradiated light (first light 13), a more complicated calculation formula is required. Although description of a complicated equation is omitted, any calculation formula for calculating the distance “Z” from the phase value “q” is substantially included in the present embodiment example.

In the meantime, the measured signal 5 (or a series of reference signals to be compared therewith), which indicates the profile of a series of the charge accumulation values 340 within measuring periods, forms a function of the phase value “δ” (a detection phase or a light emission phase). A phase variable to be a basis representing characteristics of the measured signal 5 (or a series of reference signals) represents “p”. Here, the phase variable “p” is defined as follows.

$$[ Equation 18 ]$$

$$p ≡ δ - {q}_{0} \qquad Equation 18$$

As described above, the phase variable and the phase value are selectively used in “p” and “q” to avoid theoretical confusion.

In the present embodiment example, individual measured signals 5 are obtained from different pixels 271 in the imaging sensor 270 relating to a depth (distance) signal. For example, in a case where a three-dimensional still image is captured, the measured signal 5 “S(p)” for each pixel 271 is collected. On the other hand, in the case where a three-dimensional movie is captured, it is necessary to collect the measured signal 5 “S(p)” for each frame conforming to the movie standard. For example, in the NTSC standard, since it is necessary to collect 30 frames per second, it is necessary to collect 30 or more measured signals “S(p)” per second.

Here, when a signal (including only an alternating current factor) obtained after removing a direct current factor included in the “phase profile corresponding to the charge accumulation value 340 within measuring periods” directly obtained from each of the pixels 271 in the imaging sensor 270 relating to a depth (distance) signal is used as the measured signal 5 “S(p)”, the measured signal 5 achieves an effect of removing a noise component (details thereof describes later).

In the present embodiment example, a series of reference signals “Rq(p)” to be compared with the waveform of the measured signal 5 “S(p)” has the phase variable “p”, and has different characteristics (shifted in the “p” direction) for each value of different phase values “q”. This series of reference signals “Rq(p)” is referred to herein as “shift reference signal”. As previously described with reference to FIG. 8, the depth (distance) calculator 560 for each pixel 271 included in the signal processor 42 achieves the distance calculation. At the start, the depth (distance) calculator 560 for each pixel 271 may set the “fundamental reference signal R0(p)”. And then, the depth (distance) calculator 560 for each pixel 271 shifts the “fundamental reference signal R0(p)” along a direction of the phase variable “p” (the detection phase “δ” or the light emission phase “o”) to create the series of shift reference signals “Rq(p)”. Here, the phase value “q” indicates the shifted value along the direction of the phase variable “p”.

As a method of acquiring this “fundamental reference signal R0(p)”, the fundamental reference signal R0(p) may be set by using any method such as
A) extracting, by a light power detector 27 in the light source 2 (FIG. 40 (a)), the fundamental reference signal R0(p) from the time variation characteristics (light power variation signal obtained from the light power detector 27) of the emitted light intensity 338 (FIG. 57 (a) to FIG. 60 (c)) of the irradiated light (first light) 13,
B) disposing a reference object (surface material is also defined) at a position away from the optical device 10 (FIG. 1) by a prescribed distance, and extracting the fundamental reference signal R0(p) from the time variation characteristics of the measured light intensity 336 with respect to the detection light (second light) 19 obtained from the reference object, and
C) extracting the fundamental reference signal R0(p) from the time variation characteristics of the measured light intensity 336 detected by a prescribed pixel 271 (for example, a pixel disposed on the optical axis 384 of the image forming lens 144) in the imaging sensor 270 relating to a depth (distance) signal as shown in FIG. 23.

In addition, not limited to it, the present embodiment may set the fundamental reference signal R0(p) by using another appropriate method. Also for this “fundamental reference signal R0(p)”, it is preferable to use a waveform from which the direct current factor in the phase variable “p” direction has been removed (that is, only the alternating current factor is included). Therefore, a noise component mixed in the “measured signal 5 S(p)” can be removed (details thereof are described later).

An example of a method of accurately generating the “shift reference signal Rq(p)” by shifting the “fundamental reference signal R0(p)” along the direction of the phase variable “p” (the detection phase “δ” or the light emission phase “δ”) is described below. It is necessary to generate the “shift reference signal Rq(p)” with high accuracy even for a fine variation of the phase value “q”. Therefore, the “stepwise reference signal Rn(p)” may be defined between the “fundamental reference signal R0(p)” and the highly accurate “shift reference signal Rq(p)”.

As illustrated in FIGS. 57 to 60, a modulation cycle of the irradiated light (first light) 13 represents “τ”, and a speed of light represents “c”. Therefore, a length measuring area in this case is “cT/2”. This “CT” corresponds to the phase value “360 degrees”. In creating the “stepwise reference signal Rn(p)”, this phase value “360 degrees” is “divided into N” (where N is a positive number). When a value of “N” is set large, the accuracy of the “shift reference signal Rq(p)” increases, but a calculation amount (and a calculation time) increases. In consideration of the overall balance, it is desirable to set the range to “4<N<1000”.

The step (step interval) of the phase value obtained by “dividing” “360 degrees into N” is represented by “Δp=360/N”. The depth (distance) calculator 560 for each pixel 271 included in the signal processor 42 (FIG. 8) may shift the “fundamental reference signal R0(p)” for each “Δp” interval along the direction of the phase value “q” (the detection phase “δ” or the light emission phase “δ”) and may set “stepwise reference signal Rn(p)”. That is, a waveform (formula) of the “stepwise reference signal Rn(p)” is given as follows.

$$[ Equation 19 ]$$

$$\begin{matrix}{R}_{n} ( p ) ≡ {R}_{0} ( p - n Δ p ) & ( 0 \leq n \leq N - 1 )\end{matrix} \qquad Equation 19$$

The “shift reference signal Rq(p)” is calculated from the relational formula of the following Equation 20 using the waveform of the “stepwise reference signal Rn(p)”.

$$[ Equation 20 ]$$

$${R}_{q} ( p ) = {R}_{n} ( p ) + \{ {R}_{n + 1} ( p ) - {R}_{n} ( p ) \} \frac{q - n Δ p}{Δ p} \qquad Equation 20$$

$$[ n Δ p \leq q \leq ( n + 1 ) Δ p ]$$

Here, in a case where the value of the phase value “q” is included in the range of “nΔp≤q≥(n+1)Δp” (where 0≤n≤N−1), Equation 20 is used. When the value of the phase value “q” is out of the above range, the “stepwise reference signal Rn(p)” corresponding to the matching “n” is used.

Regarding the above Equation 20, a value of the phase value “q” can be freely set. In the present embodiment example, a plurality of “shift reference signals Rq(p)” are calculated by using Equation 20 while slightly shifting (finely varying) the phase value “q”. The length measurement accuracy with respect to the measured object 22 depends on a shifting interval size of the phase value “q” at the time of calculating the plurality of “shift reference signals Rq(p)”. When the shifting interval size of the phase value “q” is finely set, the calculation volume and the calculation processing time increase instead of improving the length measurement accuracy. Since the phase value “q” can be freely set in Equation 20, there is an effect that the length measurement accuracy and the calculation processing time according to service content provided to a user can be optimized.

Incidentally, when the relational formula of Equation 20 is used, an amplitude value of the “shift reference signal Rq(p)” at “q≠nΔp” slightly decreases compared with an amplitude value of the “stepwise reference signal Rn(p)”. In order to prevent this decrease and obtain high length measurement accuracy, it is desirable to normalize the amplitude value of the “shift reference signal Rq(p)” obtained by using Equation 20 (amplitude value correction). That is, the amplitude value is normalized through calculation using Equation 21 to form a “normalized shift reference signal”.

$$[ Equation 21 ]$$

$$\overline{{R}_{q}} ( p ) = {R}_{q} ( p ) \frac{\sqrt{\int {R}_{0}^{2} ( p ) dp}}{\sqrt{\int {R}_{q}^{2} ( p ) dp}} \qquad Equation 21$$

Similarly, for the measured signal 5 “S(p)”, when normalization using Equation 22 is performed to form a “measured signal normalized”, characteristics of the “measured signal 5 S(p)” can be evaluated as described later.

$$[ Equation 22 ]$$

$$\overline{S} ( p ) = S ( p ) \frac{\sqrt{\int {R}_{0}^{2} ( p ) dp}}{\sqrt{\int {S}^{2} ( p ) dp}} \qquad Equation 22$$

In the present embodiment example, a waveform of the normalized shift reference signal generated by finely varying the phase value “q” is compared with another waveform of the measured signal normalized. An appropriate phase value “q” at the time when the both signals (the normalized shift reference signal and the measured signal normalized) match most (pattern matching is performed) is extracted. In the present embodiment example, a “calculation method of obtaining high distance (length) measurement accuracy” may be freely selected as a method of calculating a distance by comparing waveforms between the normalized shift reference signal and the measured signal normalized.

As a specific calculation method using an evaluation function “E1(q)”, the present embodiment first describes a following calculation method:
1) calculating difference values between the normalized shift reference signals and the measured signals normalized for each of different phase variables “ρ”;
2) squaring the difference values for each of different phase variables “ρ”; and
3) integrating the squared results in the phase variable “p”.

Next, as another method of a “locking operation” using another evaluation function “E2(q)”, the present embodiment describes another following calculation method:
1) multiplying the normalized shift reference signals and the measured signals normalized together for each of different phase variables “ρ”; and
2) integrating the multiplied results in the phase variable “p”.

When the evaluation function “E1(q)” used for comparison between the “normalized shift reference signal” and the “measured signal normalized” is expressed by an equation,

$$[ Equation 23 ]$$

$${E}_{1} ( q ) ≡ \int {\{ {\overline{S}}^{} ( p ) - \overline{{R}_{q}} ( p ) \}}^{2} dp \qquad Equation 23$$

is defined.

Based on the “fundamental reference signal R0(p)”, Equation 23 is calculated for each “normalized shift reference signal” calculated by using Equations 19 to 22. An appropriate phase value “q” is extracted when a calculation result of the evaluation function “E1(q)” takes the minimum value. When the extracted appropriate phase value “q” is substituted into Equation 17 or Equation 50, the distance “Z” to the measured object 22 can be calculated.

Before waveform comparison between the “measured signal S(p)” and the “shift reference signal Rq(p)”, Equation 21 and Equation 22 normalize the amplitudes of both signals. As a result, in a case where the waveform of the “normalized shift reference signal” exactly matches the waveform of the measured signal normalized”, a value of the evaluation function “E1(q)” is “0”.

When the integrated-term of the right side of Equation 23 is expanded and Equation 21 and Equation 22 are substituted for Equation 23, the following modified Equation 24 is obtained.

$$[ Equation 24 ]$$

$$\begin{matrix}{E}_{1} ( q ) = \int \{ {\overline{S}}^{2} ( p ) + {\overline{{R}_{q}}}^{2} ( p ) - 2 \overline{S} ( p ) \overline{{R}_{q}} ( p ) \} dp \\ = 2 \int {R}_{0}^{2} ( p ) dp - 2 \int \overline{S} ( p ) \overline{{R}_{q}} ( p ) dp\end{matrix} \qquad Equation 24$$

Here, since the amplitude of the “shift reference signal Rq(p)” and the amplitude of the “measured signal S(p)” are respectively normalized in Equations 21 and 22, an integration result of the first term of the right side of Equation 24 is a “constant”. Therefore, the following Equation 25 obtained by extracting only the integration area of the second term of the right side of Equation 24 may be used for comparison between the “normalized shift reference signal” and the “measured signal normalized”.

$$[ Equation 25 ]$$

$${E}_{2} ( q ) ≡ \int \overline{S} ( p ) \overline{{R}_{q}} ( p ) dp \qquad Equation 25$$

The use of the evaluation function “E2(q)” illustrated in Equation 25 substantially corresponds to execution of the “lock-in operation”. According to this “lock-in operation”, an appropriate phase value “q” is extracted when the calculation result of the evaluation function “E2(q)” takes the maximum value. And when the extracted appropriate phase value “q” is substituted into Equation 17 or Equation 50, the distance “Z” to the measured object 22 can be calculated.

In the evaluation function “E1(q)” expressed by Equation 23 or the evaluation function “E2(q)” expressed by Equation 25, the present embodiment may use functions after normalization and direct current factor removing with respect to the “measured signal S(p)” and the “shift reference signal Rq(p)”. In the description example so far, the “measured signal S(p)” and the “shift reference signals Rq(p)” are used as the charge accumulation profile (see FIG. 63 (a)) or the differentiated profile thereof (see FIG. 63 (b)). However, an application example of the present embodiment is not limited to the above, and any characteristic function may be used. For example, a function obtained by combining the characteristics or a function after performing some arithmetic processing using the characteristics may be used in the evaluation function “E1(q)” or the evaluation function “E2(q)”.

In the above description, in a case where the waveform of the “normalized shift reference signal” exactly matches the waveform of the “measured signal normalized”, a value of the evaluation function “E1(q)” is “0”. From the relationship between Equation 24 and Equation 25, the present embodiment may evaluate the degree of waveform distortion of the “measured signal S(p)” with respect to the “fundamental reference signal R0(p)”. That is, the present embodiment may define a phase value “q” dependent function

$$[ Equation 26 ]$$

$$P ( q ) ≡ 100 \frac{\int \overline{S} ( p ) \overline{{R}_{q}} ( p ) dp}{\int {R}_{0}^{2} ( p ) dp} \qquad Equation 26$$

and the following maximum value is extracted.

$$[ Equation 27 ]$$

$$PMR ≡ max \{ P ( q ) \} \qquad Equation 27$$

This pattern matching ratio (PMR) basically represents a waveform matching ratio of the “measured signal S(p)” with respect to the “fundamental reference signal R0(p)”. That is, at the appropriate phase value “q” at which the waveform of “normalized shift reference signal” exactly matches the waveform of the “measured signal normalized”, a value of the PMR is “100%”.

Calculation of this PMR value may be used for
(α) investigating a cause of decrease in distance (length) measurement accuracy with respect to the measured object 22, and
(β) detecting mixed state including a few types of distance information in each of pixels 271 in the imaging sensor 270 relating to a depth (distance) signal.

Regarding (x), for example, when being affected by optical interference noise such as speckle noise or electrical noise, the waveform of the “measured signal S(p)” is distorted. This waveform distortion causes deterioration in distance (length) measurement accuracy. Therefore, the RMR value is calculated in a case where the distance (length) measurement accuracy deteriorates, and the calculated RMR value is used to investigate a cause thereof. An outline of (B) is described now. There is a case where a pixel 271 in the imaging sensor 270 relating to a depth (distance) signal simultaneously receives the detection light (second light) 19 from a few points disposed at different distances. In this case, the RMR value may be calculated to improve the distance (length) measurement accuracy. Details thereof are described later.

In the above description of the embodiment example, an example of Equation 23 or Equation 25 is presented as the evaluation function. However, the present embodiment is not limited thereto, and any calculation processing (arithmetic processing) used for comparing waveforms of a prescribed waveform (“reference signal R0(p) or Rq(p)”) and the “measured signal S(p)” and extracting an appropriate phase value “q”. In addition, an operation of extracting a prescribed waveform as a premise of the processing is also included in the scope of the present embodiment example. As the prescribed waveform extraction method, a part of the measured signal may be used as described in the above (C). In addition, a prescribed waveform may be extracted by using any method other than the above (A) to (C).

In the present embodiment example, at least one of the “fundamental reference signal R0(p)” and the “measured signal S(p)” uses a waveform in a state of not including a direct current factor (only an alternating current factor is included). In addition, the present embodiment is not limited thereto, and either the “stepwise reference signal Rn(p)” or the “shift reference signal Rq(p)” may use a waveform in a state of not including a direct current factor (only an alternating current factor is included). In the present embodiment example, the normalization using Equation 21 or Equation 22 is performed, but either the direct current factor removal or the normalization may be performed first.

When the above direct current factor removal is performed, a mixed noise component can be removed through the integration using Equation 24 or Equation 25. This noise component removal improves the distance (length) measurement accuracy with respect to the measured object 22. A mechanism of this noise component removal is described below. First, a direct current factor included in the “fundamental reference signal R0(p)” is removed. And then, using Fourier expansion expression, the “normalized shift reference signal” forms the following complex function.

$$[ Equation 28 ]$$

$$\overline{{R}_{q}} ( p ) = \int \overline{r} ( {k}_{r} ) exp ( {ik}_{r} p + i {ε}_{k r} ) {dk}_{r} \qquad Equation 28$$

Here, since the direct current factor of the “normalized shift reference signal” has been removed, a relationship of the following Equation 29 is established.

$$[ Equation 29 ]$$

$$\overline{r} ( 0 ) = 0 \qquad Equation 29$$

Presuming that a noise component is included in the “normalized measured signal”, so that

$$[ Equation 30 ]$$

$$\overline{S} ( p ) = {\overline{S}}_{t} ( p ) + \overline{N} ( p ) \qquad Equation 30$$

is defined.

The first term of the right side of Equation 30 represents a true measured signal component. The second term of the right side of Equation 30 represents a mixed noise component. When this noise component is expressed by also Fourier expansion, the noise component shows the following formula based on a complex function format.

$$[ Equation 31 ]$$

$$\overline{N} ( p ) = \int \overline{h} ( {k}_{n} ) exp ( {ik}_{n} p + i {ε}_{k n} ) {dk}_{n} \qquad Equation 31$$

Here, since the direct current factor in the “normalized measured signal” has been removed in advance, Equation 31 does not include a direct current factor. That is, the mixed noise component includes only an alternating current factor.

A product (multiplication) of the noise component included in the measured signal and the “normalized shift reference signal” is obtained and integrated in the entire range (within 360 degrees) of the phase variable “p”. From each of Equations 28, 29, and 31, a relationship of the following Equation 32 is obtained.

$$[ Equation 32 ]$$

$$Equation 32$$

$$\int \overline{N} ( p ) \overline{{R}_{q}} ( p ) dp = \int \int \overline{r} ( {k}_{r} ) \overline{h} ( {k}_{n} ) exp \{ i ( {ε}_{kr} + {ε}_{kn} ) \} \times \int exp \{ i ( {k}_{r} + {k}_{n} ) p \} {dpdk}_{r} {dk}_{n} = 0$$

When this Equation 32 is substituted into Equation 25,

$$[ Equation 33 ]$$

$$\int \overline{S} ( p ) \overline{{R}_{q}} ( p ) dp = \int \overline{{S}_{t}} ( p ) \overline{{R}_{q}} ( p ) dp \qquad Equation 33$$

is derived.

As expressed by Equation 30, a noise component is included in the left side of Equation 33. In comparison, the right side of Equation 33 does not include a noise component. That is, when the direct current factor in the “shift reference signal” calculated using Equation 20 is completely removed, “a noise component included in the measured signal 5 is removed” as a result of the arithmetic processing on the left side of Equation 33. That is, Equation 33 indicates a status in which “a noise component mixed in the measured signal 5 is removed for both the evaluation function “E1(q)” of Equation 23 and the evaluation function “E2(q)” defined by Equation 25″.

In the above description, the function of removing a noise component mixed in the measured signal 5 has been described. The present embodiment is not limited thereto, and a noise component mixed in the shift reference signal can be similarly removed. The above description results are summarized. That is, when a direct current factor is removed from any of the “measured signal S(p)” and the reference signals “R0(p)”, “Rq(p)”, and “Rn(p)”, a noise component is removed in the process of the integration of the evaluation function “E1(q)” or “E2(q)”. Therefore, when a product is taken between two types of waveforms of which characteristics are compared with each other and integration is performed in the phase variable “p”, the distance (length) measurement accuracy with respect to the measured object 22 is improved.

In the above description, the arithmetic processing in an “integration form” has been described for convenience. However, the present embodiment example is not limited thereto, and addition processing for each discrete phase variable “p” may be performed corresponding to the evaluation functions “E1(q)” and “E2(q)”. For example, in the measurement method described with reference to FIGS. 57 and 58, a signal based on the charge accumulation value 340 within measuring periods for each of eight types of different phase values “δ” is collected. In this case, eight types of product (multiplication) results may be added.

FIG. 64 is an explanatory diagram illustrating the calculation process described above in a flowchart. FIG. 64 illustrates a process of calculating the distance “L” to each point in the measured object 22 corresponding to each pixel 271. And FIG. 64 uses the “measured signal S(p)” obtained from each pixel 271 two-dimensionally arranged in the imaging sensor 270 relating to a depth (distance) signal. An example of a series of calculation processes from the start of distance measurement (ST88) to the end of distance measurement (ST89) has already been described with reference to FIGS. 56A and 56B. Therefore, FIG. 64 illustrates an application embodiment example of the calculation method previously described in FIGS. 56A and 56B. In order to enhance the understanding of FIG. 64, differences from the calculation method previously described in FIGS. 56A and 56B are first summarized.

### [Difference in Reference Signal Extraction Method]

In the present embodiment example, a waveform of the “measured signal S(p)” and a waveform of a prescribed waveform (“reference signal R0(p) or Rq(p)”) for each pixel 271 in the imaging sensor 270 relating to a depth (distance) signal are compared, and the phase value “q” is extracted from the “measured signal S(p)”. The prescribed waveform used here may be acquired by using any method such as, not limited to,
(A) extracting the prescribed waveform from time variation characteristics of the emitted light intensity 338 of the irradiated light (first light) 13,
(B) extracting the prescribed waveform from phase change characteristics of the measured light intensity 336 of the detection light (second light) 19 of a reference object installed at prescribed position, and
(C) extracting the prescribed waveform from phase change characteristics of the measured light intensity 336 from the prescribed pixel 271 in the imaging sensor 270.

In FIGS. 56A and 56B, (A) or (B) is employed as a reference signal extraction method. In FIG. 64, for example, (C) is employed.

### [Difference in Calculated Variable]

In FIGS. 56A and 56B, the delay time “t” is used as a variable used to calculate the distance “L” to the measured object 22. As previously described in step 116 (FIG. 56B), a value of the distance “L” is calculated from the relational formula of “τ=2L/c”. On the other hand, in FIG. 64, the value of the distance “Z” is calculated using the phase value “q” and Equation 17 (or Equation 50). Note that the distance “L” and the distance “Z” have the relationship expressed by Equation 5. Here, using the relationship between Equation 5 and Equation 10, a relationship of “q/360≈(τ/T) cos θ” is approximately obtained.

### [Difference in Evaluation Function to be Used]

The “lock-in operation” in “E2(q)” of Equation 25 is used for the evaluation function used in FIGS. 56A and 56B. In this “lock-in operation”, as illustrated in step 115 (FIG. 56B), the phase value “q” is extracted when the value of the evaluation function “E2(q)” takes the maximum value. On the other hand, in FIG. 64, the “subtraction (differential) square sum operation” in “E1(q)” of Equation 23 is used. Here, the phase value “q” is extracted when the value of the evaluation function “E1(q)” takes the minimum value (ST126 in FIG. 64). Note that, as indicated by the relational formula of the right side of Equation 24, the same calculation result can be obtained by using either of the evaluation functions “E1(q)” and “E2(q)” after the normalization of Equation 21 and Equation 22 is performed.

### [Difference in Calculation Method of Evaluation Function]

In FIG. 64, the evaluation function “E1(q)” using integration is used. Both the evaluation function “E1(q)” expressed by Equation 23 and the evaluation function “E2(q)” expressed by Equation 25 use an expression of integration with the phase variable “p”. However, unlike a case where a prescribed continuous function is subjected to equation modification, in a case where an integration operation is performed by digital signal processing, an integration target value for each of different phase variables “ρ” is added. Therefore, “adding” in steps 114 and 115 in FIG. 56B indicates integration in Equation 25.

[Calculation of Distance Divided into Two Stages]

In FIG. 56A, first, rough distance calculation (ST100) is performed, and highly accurate distance calculation (ST110) using the result is performed. A series of calculation illustrated in FIG. 64 indicates an example of calculation in the highly accurate distance calculation (ST110). However, the present embodiment is not limited thereto, and a series of calculation illustrated in FIG. 64 may be started from the beginning by omitting rough distance calculation (ST100).

It should be noted that FIG. 64 is merely an application embodiment example. Therefore, the present embodiment is not limited to the above description, and the method in FIGS. 56A and 56B may be partially used. Conversely, the calculation method used in FIG. 64 may be used in a part of the calculation method in FIGS. 56A and 56B.

When the distance measurement is started in FIG. 64 (ST88), first, setting of a three-dimensional shape calculation pixel area for calculating three-dimensional shape information (ST16) is executed. This coincides with the content executed already in step 16 in FIG. 24. Note that, as in the example illustrated in FIG. 25, the user may set a designated pixel area mark 1870 on the display 18. As a result, it is possible to set an area of a three-dimensional shape calculation pixel 271 for calculating three-dimensional shape information in the imaging sensor 270 relating to a depth (distance) signal.

FIG. 63 (a) illustrates a phase profile corresponding to the charge accumulation value 340 obtained from a pixel 271 existing in a three-dimensional shape calculation pixel area of the imaging sensor 270 relating to a depth (distance) signal. A differentiated waveform of the waveform in FIG. 63 (a) in the phase “δ” direction corresponds to that in FIG. 63 (b). The calculation of the differentiated waveform from the phase profile corresponding to the charge accumulation value 340 illustrated in FIG. 63 (a) corresponds to step 120 in FIG. 64. In the present embodiment example, either the phase profile corresponding to the charge accumulation value 340 in FIG. 63 (a) or the differentiated waveform in FIG. 63 (b) may be used for the “measured signal S(p)”. Furthermore, the present embodiment is not limited thereto, and any detection signal obtained from a pixel 271 in the imaging sensor 270 relating to a depth (distance) signal may be used as the “measured signal S(p)”.

In the application embodiment example in FIG. 64, as a reference signal extraction method, a case of performing” (C) extraction from phase change characteristics of the measured light intensity 336 from the prescribed pixel 271 in the imaging sensor 270″ is described. Therefore, in step 121 in FIG. 64, the “fundamental reference signal R0(p)” is extracted from the calculation result of the phase profile corresponding to the charge accumulation value or the differentiated waveform thereof. Note that extraction of the “fundamental reference signal R0(p)” is not limited to the use of only the measured signal obtained from a prescribed pixel 271 in the imaging sensor 270. For example, an average value of measured signals acquired from a plurality of pixels 271 disposed in the vicinity of a prescribed pixel 271 in the imaging sensor 270 may be used. Here, the order of “averaging of a plurality of measured signals obtained from a plurality of pixels 271”, a “differential operation in a phase direction of a charge accumulation value”, “direct current factor removal”, and “waveform amplitude normalization” may be freely interchanged.

In the next step 122, the direct current factor is removed from the “fundamental reference signal R0(p)”. In this specific method, an average value of the “fundamental reference signal R0(p)” in the entire range (for example, the entire range from “p=0 degrees” to “p=360 degrees”) that can be taken by all the phase variables “ρ” is calculated, and the calculated average value may be subtracted from the “fundamental reference signal R0(p)” in the entire phase range.

The “stepwise reference signal Rn(p)” is generated according to Equation 19, and then the “shift reference signal Rq(p)” is calculated from the generated “stepwise reference signal Rn(p)” using Equation 20. The calculation process of generating the “shift reference signal Rq(p)” from the “fundamental reference signal R0(p)” corresponds to step 123.

In the subsequent step 124, the “shift reference signal Rq(p)” is normalized using Equation 21. A direct current factor in the “measured signal S(p)” (a charge accumulation value or a differentiated waveform) obtained for each pixel 271 in the three-dimensional shape calculation pixel area is removed, and normalization using Equation 22 is performed (ST125). According to step 126, the phase value “q” is extracted when the value of the evaluation function “E1(q)” expressed by Equation 23 is minimum (in a case where the reference signal waveform and the detection signal waveform match most).

Theoretical development from Equation 28 to Equation 33 shows that the evaluation functions “E1(q)” and “E2(q)” using Equation 23 or Equation 25 are hardly affected by disturbance noise. Even if a calculation algorithm that is hardly affected by disturbance noise is developed, high distance (length) measurement accuracy is to be guaranteed.

In order to ensure high distance (length) measurement accuracy in the present embodiment example, the pattern matching ratio PMR of the “measured signal S(p)” with respect to the “fundamental reference signal R0(p)” may be calculated using Equation 26 and Equation 27. According to the experimental data, when the pattern matching ratio PMR decreases to “60% or less”, the distance (length) measurement accuracy significantly decreases. Therefore, according to the present embodiment example shown in FIG. 23, the respective distances “L” to the corresponding points “A11” to “A33” in the measured object 22 with respect to the pixels 271 of “a11” to “a33” in the imaging sensor 270 relating to a depth (distance) signal (having a confocal positional relationship with the respective pixels 271) may be included in a length measuring area, and the pattern matching ratio PMR may be calculated for all the pixels 271 in the three-dimensional shape calculation pixel area.

In the present embodiment example, a service is provided to a user using the measurement result (and the time variation thereof) related to the three-dimensional shape of the measured object 22. The present embodiment may predict (calculate) the three-dimensional shape of the measured object 22 based on the three-dimensional coordinate values of the corresponding points “A11” to “A33” in the measured object 22. Here, according to the service content provided to a user, the required distance (length) measurement accuracy varies for each of the pixels 271 of “a11” to “a33” in the imaging sensor 270 relating to a depth (distance) signal.

Even for the service content to be provided to any user, the pattern matching ratio PMR needs to exceed “40%” with respect to all the target pixels 271. Further, “80% or more” (desirably, “90% or more” or “95% or more”) is required depending on the service content.

As described above, in the present embodiment example, the distance measurement accuracy is predicted from a distribution of the pattern matching ratio PRM for each of the pixels 271 in the three-dimensional shape calculation pixel area (ST127 in FIG. 64). When high distance (length) measurement accuracy is required according to the service content provided to the user, processing of enhancing the distance (length) measurement accuracy such as calculating an average value of values measured a plurality of times may be performed.

When the calculated pattern matching ratio RMR for the target pixel 271 satisfies the above condition, the phase value “q” when a value of “P(q)” is maximized is extracted based on Equations 26 and 27, and a value of the distance “Z” is calculated using Equation 17 or Equation 50 (or a calculation formula based on Equation 17 or Equation 50). Thereafter, the distance “Z” is obtained using Equation 5 (ST128). When the series of calculation is completed, the distance measurement is ended (ST89).

In the three-dimensional projective reverse transformation described in the present embodiment example, as illustrated in FIG. 23, three-dimensional coordinate values of each of the points “A11” to “A33” in the measured object 22 can be predicted (calculated) for each of the pixels “a11” to “a33” two-dimensionally disposed on the image sensing plane 394 in the imaging sensor 270 relating to a depth (distance) signal. By performing the above series of calculation, the respective distances “Z” from ‘the image sensing plane 394 in the imaging sensor 270 relating to a depth (distance) signal’ to the ‘points “A11” to “A33” on the measured object 22’ are obtained.

When the distance “Z” to each of the points “A11” to “A33” in the measured object 22 is obtained, the corresponding coordinate value “X” with respect to the coordinate “u” of each corresponding pixel 271 on the image sensing plane 394 can be calculated from Equation 4. When the above calculation is repeatedly performed on all the target pixels “all” to “a33” on the image sensing plane 394, the three-dimensional coordinate values of all the corresponding points “A11” to “A33” on the measured object 22 can be measured.

Thereafter, by performing a series of processing described with reference to FIG. 32, it is possible to collect information regarding a three-dimensional shape (and time variation thereof) of the measured object 22 and to detect a three-dimensional motion (ST59). Furthermore, the present embodiment is not limited thereto, and a wide variety of services in cooperation with each of the areas 922 to 930 illustrated in FIG. 10 can be provided to a user. For example, when the three-dimensional projective transformation described in the present embodiment example is used, a three-dimensional shape can be observed from an angle at which a user views the three-dimensional shape. In addition, processing of changing some sizes in the imaged measured object 22, a cooperative operation with a 3D model or the external driving mechanism 15, or the like can also be performed.

As illustrated in FIG. 23, the three-dimensional projective reverse transformation uses a calculation model in which corresponding points “A11” to “A33” in the measured object 22 exist at confocal positions with the positions of the pixels 271 of “a11” to “a33” in the imaging sensor 270 relating to a depth (distance) signal via the image forming lens 144.

For example, a case where a location of a specific corresponding point “A33” in the measured object 22 has a “large difference level” is considered. That is, the case locates the specific point “A33” on a big boundary line between a high-level plane and another low-level plane. In this case, both a detection light (second light) 19 obtained from an “upper portion (a part of the high-level plane) of the difference level” and another detection light (second light) 19 obtained from the “lower portion (another part of the low-level plane) of the difference level” return into the same corresponding pixel “a33”. In the same corresponding pixel 271 of “a33” in the imaging sensor 270 relating to a depth (distance) signal, distance information regarding a few distances including a “distance to the upper portion in the point A33” and a “distance to the lower portion in the point A33” is measured.

FIG. 65 illustrates a detection signal waveform (measured signal 5 profile) example in a case where the same pixel 271 in the imaging sensor 270 relating to a depth (distance) signal is used for simultaneously measuring a few pieces of distance information. That is, for example, the same pixel 271 of “a33” in the imaging sensor 270 relating to a depth (distance) signal generates the measured signal 5 obtained from both the upper portion and lower portion in the point A33. FIG. 65 (a) illustrates a first part of phase (a detection phase or a light emission phase 337) dependent profile (a first part of the measured signal 5 profile) regarding an alternating current factor 346 of the charge accumulation value 340 within measuring periods based on the detection light (second light) 19 reflected at the only “upper portion in the point A33”.

FIG. 65 (b) illustrates a second part of phase (a detection phase or a light emission phase 337) dependent profile (a second part of the measured signal 5 profile) regarding the alternating current factor 346 of the charge accumulation value 340 within measuring periods based on the detection light (second light) 19 reflected at the only “lower portion in the point A33”.

In FIGS. 65 (a) and 65 (b), phases are shifted from each other (shift in the detection phase or the light emission phase 337 direction). In addition, an amplitude value of the first part of phase dependent profile (the first part of the measured signal 5 profile) is different from another amplitude value of the second part of phase dependent profile (the second part of the measured signal 5 profile).

In a case where a laser light source 2 is used for the light emitter 470 of the irradiated light (first light) 13 and the upper and lower difference levels are smaller than the coherence length “ΔL0” expressed by Equation 36, interference noise occurs and the length measurement accuracy greatly deteriorates. This optical interference noise is generated not only by a “point emission type laser light source” from an end surface of a laser chip but also by the “surface emitting laser element VCSEL 128” having a wide emission surface (multiple light emission points).

However, when the present embodiment uses an optical interference noise reduction method described later in Chapter 4 as a countermeasure technique for this phenomenon, the distance (length) measurement accuracy is greatly improved. Furthermore, in a case where the above-described proposed technique is used, a simple addition amount of “a light intensity of the detection light (second light) 19 from the upper portion in the point A33” and a “light intensity of the detection light (second light) 19 from the lower portion in the point A33” falls within the corresponding pixel 271 of “a33” in the imaging sensor 270 relating to a depth (distance) signal.

Therefore, in a case where the optical interference noise reduction method described later in Chapter 4 is used, the waveform in FIG. 65 (c) obtained by simply adding the waveform in FIG. 65 (a) and the waveform in FIG. 65 (b) is obtained as the “measured signal S(p)” of the corresponding pixel 271 of “a33”.

Therefore, the “measured signal S(p)” includes a few pieces of distance information and is thus greatly different from the waveform shown in FIG. 63 (a) including the only first part of the measured signal 5 obtained from the only “upper portion in the point A33”.

As a result, a value of the pattern matching ratio PMR calculated using Equation 26 and Equation 27 becomes small when the measured signal 5 includes complicated distance information. And the present embodiment example may use this phenomenon conversely. That is, in a case where a value of the pattern matching ratio PMR is small (for example, “PMR<95%”) although a sufficient measured signal amount is obtained from the corresponding pixel 271 of “a33”, it is determined that a plurality of pieces of distance information are included in the corresponding pixel 271 of “a33”. Arithmetic processing between waveforms is performed to individually extract a plurality of pieces of distance information included in the corresponding pixel 271 of “a33”.

A specific example of the “method of individually extracting a plurality of pieces of distance information” is described. It is assumed that the “measured signal S(p)” from the inside of the corresponding pixel 271 of “a33” has the waveform in FIG. 65 (c) and it is determined that a plurality of pieces of distance information is included in the waveform. Using a pattern matching technique between waveforms (for example, using the evaluation functions “E1(q)” and “E2(q)” of Equation 23 or Equation 25), an “ideal waveform component” having the pattern matching ratio PMR of “100%” (a waveform similar to that in FIG. 65 (a)) is extracted from the waveform in FIG. 65 (c).

The ideal waveform component having the pattern matching ratio PMR of “100%” (a waveform similar to that in FIG. 65 (a)) is subtracted from the waveform in FIG. 65 (c). And then, the waveform shown in FIG. 65 (b) can be extracted as a subtraction result. After distance information corresponding to the waveform shown in FIG. 65 (b) is extracted according to the calculation algorithm described above, the pattern matching ratio PMR is calculated again based on the distance information extracted here. It is determined whether or not further another distance information is included from the value of the obtained pattern matching ratio PMR. By repeating the above processing, it is possible to separately extract a plurality of pieces of distance information included in the “measured signal S(p)” obtained from the corresponding pixel 271 of “a33”.

Note that the method of “separately extracting a plurality of distance information” is merely an example. In the present embodiment example, any separation and extraction method of “separately extracting different pieces of distance information” for a plurality of pieces of distance information included in the “measured signal S(p)” is included in the present embodiment example.

The above “separate extraction of a plurality of pieces of distance information” is limited to a case where the waveform shown in FIG. 65 (c) is measured by simply adding the waveform shown in FIG. 65 (a) and the waveform shown in FIG. 65 (b). As described above, when the “optical interference between the detection light (second light) 19 from different distances” occurs, the “separate extraction of a plurality of pieces of distance information” cannot be performed.

Therefore, the distance (length) measurement accuracy and the three-dimensional shape extraction accuracy with respect to the measured object 22 in Chapter 3 are greatly affected by the optical interference noise reduction method described later in Chapter 4. That is, on the premise of reducing the optical interference noise described later in Chapter 4, the high distance (length) measurement accuracy and the high three-dimensional shape extraction accuracy with respect to the measured object 22 can be secured in Chapter 3. Only after highly accurate distance measurement and three-dimensional coordinate value prediction in Chapter 3 can be guaranteed, stable three-dimensional projective reverse transformation can be performed. Furthermore, it is possible to perform accurate three-dimensional projective transformation display on the basis of the stable three-dimensional projective reverse transformation result. Since the three-dimensional projective reverse transformation and the three-dimensional projective transformation with high accuracy can be guaranteed, various services can be provided to a user in Chapter 5.

In the 3D projective reverse transformer 550 in FIG. 8, there is an adjuster 578 of 3D coordinate data utilizing color information (adjusting edge figure of the measured object). Thereafter, the “adjuster 578 of 3D coordinate data utilizing color information (adjusting edge figure of the measured object)” may execute “correction of three-dimensional coordinate values using color information (edge processing or the like)” previously described in step 47 in FIG. 24. According to the three-dimensional coordinate value correction (ST47 in FIG. 24), the “adjuster 578 of 3D coordinate data utilizing color information (adjusting edge figure of the measured object)” may use the “separate extraction of a plurality of pieces of distance information” described above in advance. Herein, a specific embodiment example of the three-dimensional coordinate value correction (ST47 in FIG. 24) using the “separate extraction of a plurality of pieces of distance information” is described below.

FIG. 66 illustrates the same image pattern formed on the image sensing planes 394 having different pixel sizes in the imaging sensor 270 relating to a depth (distance) signal (FIG. 66 (a)) and the imaging sensor 280 detecting color signals (FIG. 66 (b)). More specifically, FIG. 66 (a) shows an image pattern formed on an image sensing planes 394 in the imaging sensor 270 relating to a depth (distance) signal, and FIG. 66 (b) shows the same image pattern formed on another image sensing planes 394 in the imaging sensor 280 detecting color signals. And a pixel size included in the imaging sensor 270 relating to a depth (distance) signal is different from another pixel size included in the imaging sensor 280 detecting color signals.

In a case where the detection optical system illustrated in FIGS. 53 to 55 is used, the pixels 271 two-dimensionally arranged in the imaging sensor 270 relating to a depth (distance) signal and the pixels 271 two-dimensionally arranged in the imaging sensor 280 detecting color signals are disposed at different positions. Incidentally, in both FIGS. 54 and 55, the optical axis 384 of the image forming lens 144 passes through the central portion of the image sensing plane 394 in the imaging sensor 270 relating to a depth (distance) signal and the central portion of the image sensing plane 394 in the imaging sensor 280 detecting color signals. And FIG. 66 shows a diagram in which the passing points of the optical axis 384 of the image forming lens 144 match and the image sensing plane 394 in the imaging sensor 270 relating to a depth (distance) signal and the image sensing plane 394 in the imaging sensor 280 detecting color signals are displayed in an overlapping manner.

A square indicating the entire part of FIG. 66 (a) represents a pixel 271 in the imaging sensor 270 relating to a depth (distance) signal. According to FIG. 66 (b), each square obtained by dividing a square into 49 represents a pixel 271 in the imaging sensor 280 detecting color signals. FIG. 66 (b) shows the imaging sensor 280 detecting color signals that corresponds to a conventional “imaging sensor detecting color signals” capturing a two-dimensional color image (or a movie).

Currently, an “imaging sensor detecting color signals” in which a pixel 271 has a sufficiently small size is commercially available. In comparison, a size of a pixel 271 in the currently available imaging sensor 270 relating to a depth (distance) signal is relatively large. FIG. 66 (b) merely symbolizes the pixel size comparison between the imaging sensor 270 relating to a depth (distance) signal and the imaging sensor 280 detecting color signals. Therefore, the size of a pixel 271 in all the imaging sensors 270 relating to a depth (distance) signal is not limited to 7 times the size of the imaging sensor 280 detecting color signals. For convenience of description, the description continues assuming that the size of a pixel 271 in the imaging sensor 270 relating to a depth (distance) signal is an integral multiple of the size of the imaging sensor 280 detecting color signals.

FIG. 66 (a) illustrates an image pattern formed on a pixel 271 included in the imaging sensor 270 relating to a depth (distance) signal. It is considered that a corresponding point in the measured object 22 having a confocal positional relationship with the pixel 271 is located at the end (specific boundary position) of the measured object 22. In the description example of FIG. 66 (a), the “area α” and the “area β” are included in a part of the measured object 22. And the “area γ” corresponds to the outside of the measured object 22. That is, the “area γ” in FIG. 66 (a) corresponds to a “background image area” or an “area outside the distance (length) measuring area”.

In a case where there is a large difference level between the “area α” and the “area β” in the measured object 22, the measured signal “S(p)” obtained from the corresponding pixel includes a plurality of pieces of distance information. That is, according to FIG. 66 (a), the detection light (second light) 19 reflected at the “area x” includes, for example, a measured signal component in FIG. 65 (a). In addition, the detection light (second light) 19 reflected at the “area β” includes, for example, a measured signal component in FIG. 65 (b). In case of FIG. 66 (a), the waveform in FIG. 65 (c) obtained as a result of adding the waveform component in FIG. 65 (a) and the waveform component in FIG. 65 (b) forms the measured signal “S(p)”.

In many cases, a color differs between the “area α” and the “area β” in the measured object 22. In the imaging sensor 280 detecting color signals in which the size of a pixel 271 is small (high resolution), as illustrated in FIG. 66 (b), fine area division between the “area α ” and the “area β” using this color difference can be performed. Meanwhile, distance information from the adjacent pixel 271 in the imaging sensor 270 relating to a depth (distance) signal and color information from the corresponding pixel in the imaging sensor 280 detecting color signals can be acquired. Therefore, in consideration of the distance information and the color information obtained from the adjacent pixel 271, a combination of the distance information and the color information for each of “area α” and “area β” can be predicted (determined) in only one pixel 271 of the imaging sensor 270 relating to a depth (distance) signal (in FIG. 66 (a)).

FIG. 67 illustrates an example of a distance separation method between the “area α” and the “area β” using a combination of distance information and color information. The horizontal axis in FIG. 67 indicates the X-axis of coordinate 1805 within the measured object 22 with reference to the imaging sensor 270 relating to a depth (distance) signal. Furthermore, the vertical axis in FIG. 67 indicates the Z-axis of coordinate 1809 within the measured object 22 with reference to the imaging sensor 270 relating to a depth (distance) signal. Here, the distance information calculated from the measured signal “S(p)” of the imaging sensor 270 relating to a depth (distance) signal appears in the direction of the Z-axis of coordinate 1809.

In FIG. 67 (a), the three-dimensional coordinate values of the corresponding point on the measured object 22 are indicated by a “black circular mark”. The three-dimensional coordinate values indicate an example of a result calculated based on only the measured signal “S(p)” obtained from a pixel 271 in the imaging sensor 270 relating to a depth (distance) signal. A location value on the Z-coordinate of the “black circular mark” illustrated here is obtained by substituting the optimum phase value “q” calculated using Equation 23 or Equation 25 into Equation 17 or Equation 50.

FIG. 67 (b) illustrates three-dimensional coordinate values in which color information from the pixels 271 in the imaging sensor 280 detecting color signals is also taken into consideration. As a location value on the Z-coordinate at the stage of FIG. 67 (b), the same value as that in FIG. 67 (a) is used. Since the pixel size in the imaging sensor 280 detecting color signals is relatively small, a “location value on the u-coordinate” in Equation 4 can be finely set. That is, each location value on the X-coordinate obtained by substituting the center coordinate value “u” of each pixel 271 in the imaging sensor 280 detecting color signals into Equation 4 is plotted in FIG. 67 (b).

Color information corresponding to each plot point in FIG. 67 (b) is identified by an “outlined circular mark” and an “outlined triangular mark”. Compared with the color identification marks illustrated in FIG. 66, the area indicated by the “outlined circular mark” indicates the “area α”. Similarly, the area indicated by the “outlined triangular mark” corresponds to the “area β” in FIG. 66.

As described with reference to FIG. 66, a “large difference level” occurs between the “area α” and the “area β”. Using the method example described with reference to FIG. 66, a plurality of pieces of distance information included in the measured signal “S(p)” from the corresponding pixel 271 in the imaging sensor 270 relating to a depth (distance) signal may be separately extracted. And then, a plurality of location values on the Z-coordinate can be set from the separately extracted distance information.

As described with reference to FIG. 66, a combination of the distance information and the color information obtained from the peripheral pixels 271 is referred to. As a result, a “location value on the Z-coordinate of the corresponding point having specific color information” can be predicted. FIG. 67 (c) illustrates a three-dimensional coordinate point distribution predicted from the color information of each corresponding point in the measured object 22 based on Equation 4. Compared with FIG. 67 (a), a spatial resolution of the location value on the Z-coordinate is obviously improved.

When the size of a pixel 271 in the imaging sensor 270 relating to a depth (distance) signal is large, a spatial resolution related to the distance distribution characteristics based on the distance (length) measurement result is low. However, by combining the “separate extraction of a plurality of pieces of distance information” described in FIG. 65 with the color distribution information from the imaging sensor 280 detecting color signals having a relatively high spatial resolution, it is possible to improve the spatial resolution related to the distance distribution characteristics.

The present embodiment example is not limited to the above, and the spatial resolution related to the distance distribution characteristics may be improved without using the “separate extraction of a plurality of pieces of distance information”. In this case, the distance distribution characteristics in a specific pixel may be predicted using a combination of distance information and color information obtained from the specific pixel 271 and its peripheral pixels. As described above, in the present embodiment example, a spatial resolution related to the distance distribution characteristics may be improved by using any method.

A limit value of a spatial resolution of three-dimensional coordinate values calculated only from a pixel 271 in the imaging sensor 270 relating to a depth (distance) signal can be easily calculated from a pixel size in the imaging sensor 270 relating to a depth (distance) signal and a value of the focal length “f” of the image forming lens 144. Specifically, by substituting the “discrete pixel coordinate value u” indicating the center position of each pixel in the imaging sensor 270 relating to a depth (distance) signal and the focal length “f” of the image forming lens 144 into Equation 4, a limit value of the spatial resolution of the calculated three-dimensional coordinate values is easily obtained. Therefore, when the spatial resolution related to the three-dimensional coordinate value distribution is improved beyond this limit value in response to the imaging sensor 270 relating to a depth (distance) signal, it can be said that the present embodiment example is used.

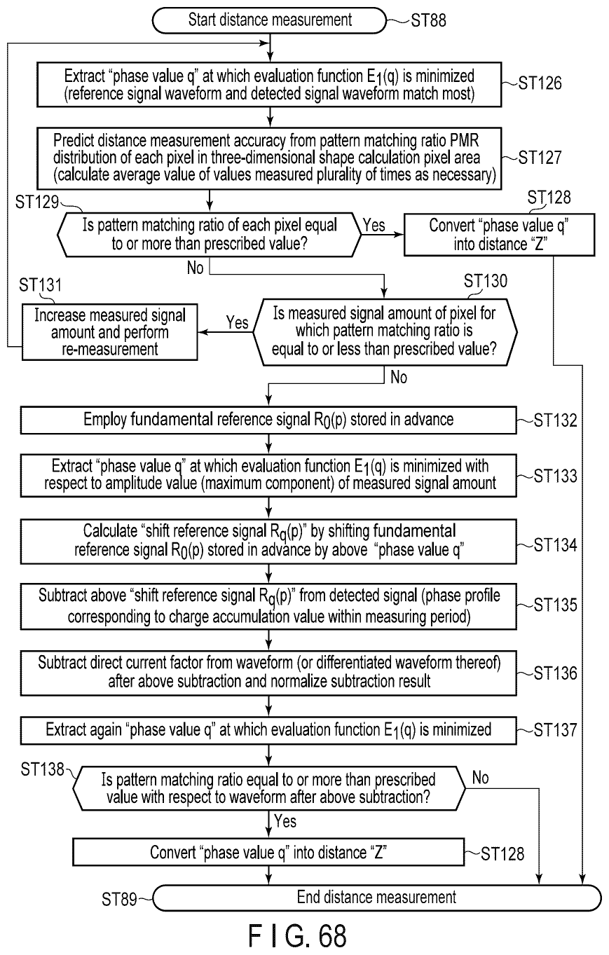

FIG. 68 illustrates an example of a calculation algorithm for separately extracting individual distance information in a case where a plurality of pieces of distance information are included in the measured signal “S(p)” from a pixel 271 in the imaging sensor 270 relating to a depth (distance) signal. Note that FIG. 68 illustrates an embodiment example of the calculation algorithm example described in FIG. 64 from the start of distance measurement (ST88) to the end of distance measurement (ST89).

When the distance measurement is started in step 88 in FIG. 68, in the step 126, the phase value “q” is extracted when a value of the evaluation function “E1(q)” of Equation 23 is minimized (the reference signal waveform and the detection signal waveform match most) or when a value of the evaluation function “E2(q)” of Equation 25 is maximized. In FIG. 68, the evaluation function “E1(q)” of Equation 23 is used for convenience. However, the present embodiment is not limited thereto, and the evaluation function “E2(q)” of Equation 25 or any evaluation function may be used. Herein, the detailed procedure within the step 88 to the step 126 in FIG. 68 corresponds to each calculation step (ST16 to ST125) described in FIG. 64.

In FIG. 68, similarly to FIG. 64, step 127 is performed immediately after step 126. That is, the step 126 executes the prediction of distance measurement accuracy from a distribution of the pattern matching ratio PMR (Equation 27) for each pixel 271 in the three-dimensional shape calculation pixel area. Moreover, the step 126 may execute the calculation of an average value of measurement values a plurality of times as the need arises. Next, in step 129, it is determined whether or not the pattern matching ratio PMR for each pixel 271 is equal to or more than a prescribed value. In a case where the determination result is equal to or more than the prescribed value (at least 60%, possibly 80%, and desirably 90%), as in FIG. 64, the process reaches the end of distance measurement in step 89 via step 128. Here, the step 128 executes the conversion from the shift phase value “q” to the distances “Z” and “L” using Equation 5 and Equation 17 (or Equation 50).

On the other hand, a condition that the determination result is less than the prescribed value (ST129) is established under two phenomena such as
(α) a case where a signal amount of the measured signal “S(p)” is too small to obtain a sufficient waveform amplitude, and
(β) detecting mixing of a plurality types of distance information regarding the measured object in a pixel 271 in the imaging sensor 270 relating to a depth (distance) signal.

Therefore, in step 130, it is determined whether or not an amount (an amplitude value of the waveform) of the “measured signal “S(p)” from the target pixel 271 is equal to or less than a prescribed value”, so that the factor of (α) may be eliminated.

If it is ascertained that a “signal amount of the measured signal “S(p)” is too small” as a determination result, a measured signal amount is increased and re-measurement (ST131) is performed. The process returns to step 126 (strictly, step 120 and subsequent steps in FIG. 64) using a re-measurement result. Here, as the “method of increasing a measured signal amount” in the present embodiment example, the signal gain controller 558 shown in FIG. 8 may perform the adjustment of a detection signal gain as referred to the step 41 in FIG. 24.

On the other hand, in a case where the signal amount of the measured signal “S(p)” is sufficiently large as the determination result in step 130, it is determined that the factor of (B) is satisfied (that is, the measured signal “S(p)” from a pixel 271 includes a plurality of pieces of distance information). In this case, “separate extraction of a plurality of pieces of distance information included in the measured signal “S(p)”” after step 132 and the subsequent steps is started.

In the calculation algorithm in FIG. 68, similarly to FIG. 64, the “fundamental reference signal R0(p)” may be set by using any method. However, in the calculation algorithm in FIG. 68, it is necessary to store the “fundamental reference signal R0(p)” in advance (ST132). An amplitude value of the “fundamental reference signal R0(p)” used here is desired to match an amplitude value of the measured signal “S(p)” including a plurality of pieces of distance information.

In a case where only a piece of distance information is included in the measured signal “S(p)”, as described with reference to FIG. 64, “normalization of the measured signal” using Equation 22 is performed. On the other hand, the waveform of the measured signal “S(p)” including the plurality of pieces of distance information indicates the characteristics exemplified in FIG. 65 (c). That is, the waveform exemplified in FIG. 65 (c) is different from the waveform of the “fundamental reference signal R0(p)”.

In the calculation algorithm in step 132 and the subsequent steps in FIG. 68, the reference signal is normalized in accordance with the waveform of the measured signal “S(p)” including the plurality of pieces of distance information. That is, the “fundamental reference signal R0(p)” is normalized using a calculation formula in which “fundamental reference signal R0(p)” and the measured signal “S(p)” in Equation 22 are exchanged. In other words, instead of the denominator in Equation 21, substituting the denominator of Equation 22 for the denominator of Equation 21, the present embodiment may create a normalization formula. And using the newly created normalization formula, the present embodiment may normalize the “fundamental reference signal R0(p)”.

After the “fundamental reference signal R0(p)” is normalized in accordance with the waveform of the measured signal “S(p)” including the plurality of pieces of distance information, the “shift reference signal Rq(p)” is generated using Equation 19 and Equation 20 similarly to step 123 in FIG. 64. Thereafter, Equation 21 can be used without any change to normalize “shift reference signal Rq(p)” (step 124 in FIG. 64).

According to step 133 in FIG. 68, the appropriate phase value “q” is extracted when a calculation result of the evaluation function “E1(q)” expressed by Equation 23 is minimized (alternatively, another calculation result of the evaluation function “E2(q)” of Equation 25 is maximized, or any evaluation function may be used). By substituting the extracted phase value “q” into Equation 17 (or Equation 50), a piece of distance information “Z” can be calculated. That is, when the phase value “q” is extracted using the waveform of the measured signal “S(p)”, a piece of distance information “Z” is calculated from a plurality of pieces of distance information included in the measured signal “S(p)”.

Next, the appropriate phase value “q” extracted in step 133 is substituted into Equation 19 and Equation 20, so that the present embodiment example may obtain the “normalized shift reference signal” (ST134). The “normalized shift reference signal” calculated in step 134 corresponds to a waveform in which the “fundamental reference signal” after normalization using the measured signal “S(p)” is shifted by the appropriate phase value “q”.

In step 135, the “normalized shift reference signal” calculated in step 134 is subtracted from the measured signal “S(p)” including the plurality of pieces of distance information. This subtraction corresponds to, for example, subtracting the “measured signal component including only a piece of distance information” illustrated in FIG. 65 (a) from the “measured signal “S(p)” including the plurality of pieces of distance information” illustrated in FIG. 65 (c). Thereafter, the waveform remaining after the subtraction corresponds to the “measured signal including other distance information” illustrated in FIG. 65 (b). Incidentally, as the measured signal “S(p)” to be subjected to the subtraction in step 135, the “phase profile corresponding to the charge accumulation value 340 within measuring periods” illustrated in FIG. 63 (a) is used instead of the differentiated waveform in FIG. 63 (b).

In the calculation in next step 136 and the subsequent steps, it is determined whether or not
A] “other distance information” is included in the signal after subtraction in step 135, and
B] “a plurality of pieces of distance information” are further included in the signal after the subtraction in step 135, and corresponding processing is performed.

That is, in step 136, a direct current factor is removed from the waveform after the subtraction in step 135. The “fundamental reference signal R0(p)” is normalized again in accordance with the waveform after the removal of the direct current factor.

In the next step 137, the evaluation function “E1(q)” expressed by Equation 23 (alternatively, the evaluation function “E2(q)” of Equation 25 or any evaluation function may be used) is calculated again, and the next appropriate phase value “q” is extracted when the value of the evaluation function “E1(q)” is minimized (or the value of the evaluation function “E2(q)” is maximized). Thereafter, in step 138, the pattern matching ratio PMR (Equation 26 and Equation 27) is calculated using the next appropriate phase value “q”. In a case where the pattern matching ratio PMR is smaller than a prescribed value, it is determined that
A] “other distance information” is not included in the signal after the subtraction in step 135, and then, the distance measurement is ended (ST89).

On the other hand, in a case where the pattern matching ratio PMR is more than the prescribed value (ST138), it is determined that
A] “other distance information” is included in the signal after the subtraction in step 135.

The present embodiment example may substitute the next appropriate phase value “q” extracted in step 137 into Equation 17 (or Equation 50), and the present embodiment example may extract next distance information “Z” different from that in step 133.

Further, among a plurality of pieces of distance information included in the measured signal “S(p)”, there is also possibility that
B] “a plurality of pieces of distance information” are further included in the signal after the subtraction in step 135.

Therefore, in a case where there is the above possibility, although not illustrated, the process returns to step 134 again, and additional calculation may be repeated.

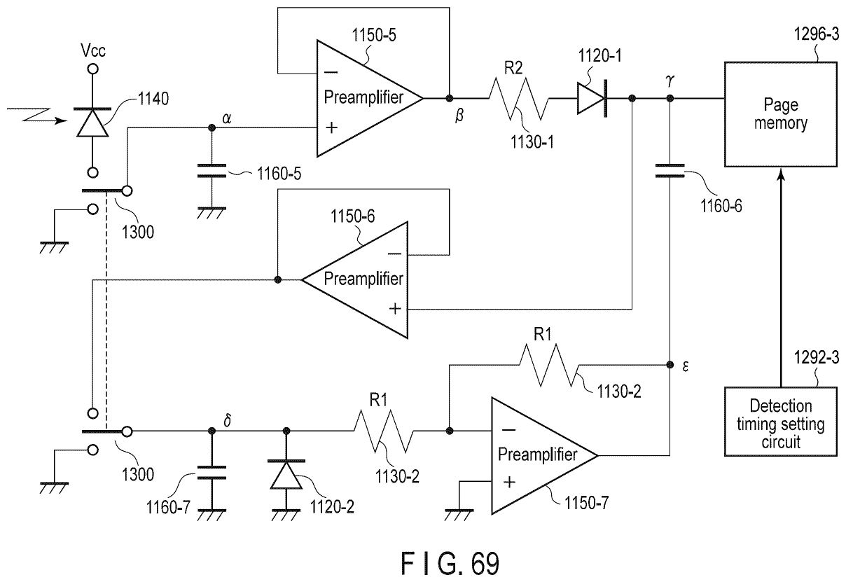

FIG. 69 illustrates a circuit configuration suitable for repeatedly accumulating charge within a measuring period. In the present embodiment example, as illustrated in FIGS. 57 to 60, a charge accumulation value is accumulated within a half period “T/2” of a modulation cycle “T” of the irradiated light (first light) 13. The charge accumulation is repeated every time within a measuring period to increase a signal amount of the measured signal “S(p)”. Furthermore, by repeating the charge accumulation, noise components mixed for each charge accumulation are averaged (consequently reduced).

In a measuring period, the measured signal “S(p)” corresponding to a phase value “δ=p+q0” (a detection phase or a light emission phase) may be collected. For the purpose of repeated charge accumulation, in the present embodiment example, the number of repetitions of charge accumulation within measuring periods may be set to “10 times” or more (desirably, “100 times” or more). On the other hand, in order to collect the measured signals “S(p)” corresponding to all the discrete phase values “δ=p+q0” within the range of “360 degrees”, a plurality of corresponding measuring periods are required.

Therefore, when the number of repetitions of charge accumulation in a measuring period is too large, it takes time to collect the measured signals “S(p)” corresponding to all discrete phase values “δ=p+q0”. Therefore, the number of repetitions of charge accumulation within measuring periods may be set to “1 million times” or less (desirably, “10,000 times” or less).

In FIG. 69, a charge accumulation value accumulated within the period “T/2” is accumulated in a capacitor 1160-5. A cumulative charge amount repeatedly accumulated within measuring periods is accumulated in a capacitor 1160-6. Since the charge accumulation value 340 is accumulated in the capacitors 1160-5 and 1160-6 as described above, the entire circuit configuration is simplified.

A linkage switch 1300 in FIG. 69 is connected to an upper terminal corresponding to a period in which the measured light intensity 336 in FIGS. 57 to 60 has a high level. The charge accumulation value 340 corresponding to each “area of a shaded area” in FIGS. 57 to 60 is accumulated on the “α point” side of the capacitor 1160-5. At the same time, a charge amount obtained by multiplying the charge amount corresponding to the charge accumulation value 340 by “−1” is accumulated on the “α point” side of the capacitor 1160-6. Also during a period in which the linkage switch 1300 in FIG. 69 is connected to the upper terminal, the “γ point” side of the capacitor 1160-6 is maintained at “0 V”.

During a period in which the measured light intensity 336 in FIGS. 57 to 60 has a low level, the linkage switch 1300 in FIG. 69 switches to the ground side. In this period, a voltage on the “α point” side of the capacitor 1160-5 is “0 V”. At the same time, a voltage on the “δ point” side of the capacitor 1160-7 is also “0 V”. In interlocking with this, a voltage on the “ε point” side of the capacitor 1160-6 is also “0 V”. However, since charge is accumulated in the capacitor 1160-6, the voltage on the “γ point” side of the capacitor 1160-6 increases during this period. During this period, the voltage on the “γ point” side is maintained.

When the measured light intensity 336 in FIGS. 57 to 60 has a high level again, the voltage on the “γ point” side returns to “0 V”. The voltage on the “ε point” side further decreases (toward the negative voltage side) in accordance with the increase in the charge accumulation values in the capacitor 1160-6. In FIG. 69, a potential of the “ε point” of the capacitor 1160-6 is controlled for each charge accumulation in the period “T/2” so that charge can be accurately accumulated in the capacitor 1160-6 within measuring periods. The capacitor 1160-7 is turned on to prevent chattering that occurs when the linkage switch 1300 switches.

When the measuring period ends, the linkage switch 1300 is connected to the ground side. A page buffer memory 1296-3 reads the voltage of the “γ point” at this timing, and uses the voltage as a value of the charge accumulation value 340 within the measuring period for a specific phase value “δ”. In the present embodiment, a measuring period is individually set for each of different phase values “δ”. The characteristic of the charge accumulation value 340 for each of all the phase values “δ=p+q0” is used as the measured signal “S(p)”.

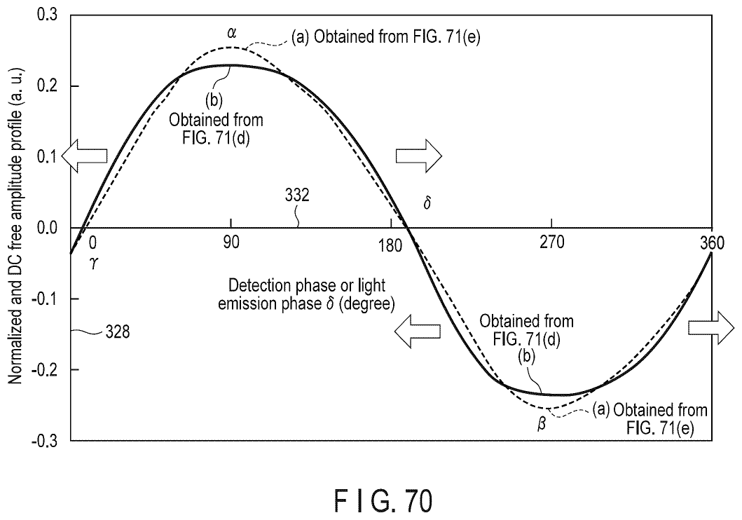

FIG. 70 is an explanatory diagram illustrating the influence of the modulation characteristic of the irradiated light (first light) 13 on the measured signal “S(p)”. FIG. 70 illustrates a measured signal “S(p)” obtained by collecting the charge accumulation value 340 of a signal subjected to photoelectric conversion from a pixel 271 in the imaging sensor 270 relating to a depth (distance) signal with the detection circuit shown in FIG. 69 and removing a direct current factor from the collected signal. Therefore, a waveform in FIG. 70 (a) coincides with the waveform in FIG. 63 (a).

As illustrated in FIG. 70 (a), the distance (length) measurement accuracy is improved when the inclined area becomes wider. On the other hand, when an area around the maximum value (a area) and an area around the minimum value (β area) in the measured signal “S(p)” are widened as illustrated in FIG. 70 (b), the distance (length) measurement accuracy decreases. When the modulation characteristic of the irradiated light (first light) 13 changes, the characteristic changes from the characteristic shown in FIG. 70 (a) to the characteristic shown in FIG. 70 (b).

FIG. 71 illustrates an example of a relationship between a drive current 324 for the light emitter 470 and the emitted light intensity 338. As shown in FIG. 71, the modulation characteristic of the irradiated light (first light) 13 affects the time-dependent characteristic of the emitted light intensity 338. In an experiment performed in accordance with the present embodiment example, the VCSEL 128 (a multipoint light emitting laser element or a surface emitting laser element having a wide light emitting surface) was used as the light source 470.

Since the VCSEL 128 is a multipoint light emitting laser element, the number of light emission points is large. In addition, in order to increase an intensity of light emitted from the VCSEL 128, the VCSEL 128 is driven with a large current. As a result, the number of lead wires in the element increases, and a floating capacitance “C” in the element increases. Due to the influence of the floating capacitance “C” in the element, the rising characteristic when the light emission of the VCSEL 128 is switched at high speed deteriorates.

FIG. 71 (a) illustrates an example of characteristics of a drive voltage 322 applied to the VCSEL 128. A rectangular voltage with a cycle “T” is applied in a direction of passing time “t” 352. And FIG. 71 (d) illustrates a time variation (the time-dependent characteristic) of the emitted light intensity 338 from the VCSEL 128 when the drive voltage 322 illustrated in FIG. 71 (a) is applied to the VCSEL 128. FIG. 71 (d) shows rising characteristics delayed by a time constant “τ”.

The floating capacitance in the VCSEL 128 represents “C”, and input impedance (virtually added series resistance value) represents “R”. The time variation of the drive current “I” immediately after the voltage applied to the VCSEL 128 is changed from “0 V” to “V” in a stepwise manner is approximately given as in Equation 34.

$$[ Equation 34 ]$$

$$I = \frac{V}{R} \{ 1 - exp ( - t / τ ) \} = \frac{V}{R} \{ 1 - exp ( - t / CR ) \} \qquad Equation 34$$

The above Equation 34 shows the rising characteristics (the time-dependent characteristic) of the emitted light intensity 338 described in FIG. 71 (d). Here, the time constant “τ=CR” included in Equation 34 corresponds to a “delay time t of rising” described in FIG. 71 (d).

The experiment performed in the present embodiment example used WL-VCSEL3535 (emission wavelength: 850 nm) manufactured by Wuerth as the light source 470. The stepwise drive voltage in this experiment was “V=2.1 volts”, and “T=25 nS” was set as the modulation cycle. In addition, since a duty ratio of modulation is set to “50%”, a pulse width is “12.5 nS”. A peak value of the emitted light intensity 338 in this case was “2.1 W”.

As a result of the experiment under the above conditions, a time constant “t=3.84 nS” was obtained. The time constant is relatively larger in comparison with a pulse width “12.5 nS”. The floating capacitance in this case is calculated to be about “0.01 μF”. The measured signal characteristic “S(p)” is to form an ideal waveform shown in FIG. 70 (a) when the time-dependent characteristic of the emitted light intensity 338 obtained from the VCSEL 128 has the rectangular characteristic (of sharp shape) shown in FIG. 71 (a). On the other hand, in a case where the emitted light intensity 338 of the VCSEL 128 has the rising delay characteristic having the time constant “τ=3.84 nS” as shown in FIG. 71 (d), the characteristic of the measured signal “S(p)” is distorted around the maximum value (α area) and around the minimum value (β area) as illustrated in FIG. 70 (b).

Therefore, the distance (length) measurement accuracy changes based on a variation of the time-dependent characteristic of the emitted light intensity 338 obtained from the VCSEL 128 in the direction of the passing time “t”. And the distance (length) measurement accuracy is improved when the present embodiment example selects a time-dependent characteristic of the emitted light intensity 338 shown in FIG. 71 (a) and abandons another time-dependent characteristic shown in FIG. 71 (d). In order to improve the distance (length) measurement accuracy, as the present embodiment example, the rising delay characteristic shown in FIG. 71 (b) may be improved to realize the characteristic of the emitted light intensity 338 close to the rectangular waveform illustrated in FIG. 71 (e). In other words, the measured signal characteristic “S(p)” can form an ideal waveform shown in FIG. 70 (a) when the time-dependent characteristic of the emitted light intensity 338 obtained from the VCSEL 128 has a sharp shape shown in FIG. 71 (e).

According to FIG. 71 (e), the rising time of the emitted light intensity 338 (that is, the time until reaching the saturated emitted light intensity) represents “Wt”. And based on the floating capacitance “C” inside the light emitter 470, a value of the time constant “τ” indicating the rising characteristic of the emitted light intensity 338 from the light emitter 470 can be measured as a characteristic of each of the light emitters 470. In the present embodiment example, the drive current 324 or the drive voltage 322 for the light emitter 470 is controlled, and “Wt<τ” is realized with respect to the rising time of the emitted light intensity 338 (that is, the time until reaching the saturated emitted light intensity) “Wt”. That is, any method of improving the characteristic of the emitted light intensity 338 to “Wt<τ” (desirably, “Wt<τ/2”) with respect to the time constant “τ” representing the characteristic of the light emitter 470 is included in the present embodiment example.

As a method of improving the characteristic of the emitted light intensity 338 to “Wt<τ”, in the present embodiment example, any of “control of the drive voltage 322 for the light emitter 470”, “control of the drive current 324 for the light emitter 470”, and “combination control of the drive voltage 322 and the drive current 324 for the light emitter 470” may be performed.

The “control of the drive voltage 322” requires a large power supply voltage for a driving circuit of the light emitter 470. In comparison, the “control of the drive current 324” is suitable for miniaturization and power saving of the driving circuit because a large power supply voltage is unnecessary. As a method of improving the characteristic of the emitted light intensity 338 to “Wt<τ” in the “control of the drive current 324”, the drive current 324 may be increased only for the rising period “Wt” of the emitted light intensity 338 as illustrated in FIG. 71 (b). The present embodiment is not limited thereto, and, as illustrated in FIG. 71 (c), the drive current 324 may be continuously supplied during the rising period of the emitted light intensity 338, and pulse driving may be performed during a period “Wb” in which the emitted light intensity 338 is saturated.

As the present embodiment example, a specific example in a case where the drive current 324 is controlled according to the method in FIG. 71 (b) is described below. In Equation 34, the drive current 324 represents “hb” when the passing time “t” is sufficiently large. And the drive current 324 in the rising period “Wt” of the emitted light intensity 338 represents “ht”. A relationship of “ht/hb≈t/Wt” is approximately established between “hb” and “ht”. Therefore, the drive current 324 in the rising period “Wt” may be set as “ht≈hb·t/Wt”.

As a specific example of the present embodiment, a ratio “Wt/(Wt+Wb)” of “Wt” to a pulse width “Wt+Wb” may be “20%” or less (desirably, “10%” or less). In the experiment performed in accordance with the present embodiment example, since a pulse width “Wt+Wb” is “12.5 nS”, a width of “Wt” may be provisionally set to “InS”. In the WL-VCSEL3535 manufactured by Wuerth, the drive current 324 required for the emitted light intensity 338 of “2.1 W” is “3A”. Therefore, when the VCSEL 128 is used, “hb=3A” is obtained. In this case, “ht≈3×3.84÷1=11.5 A” is obtained from the above equation.

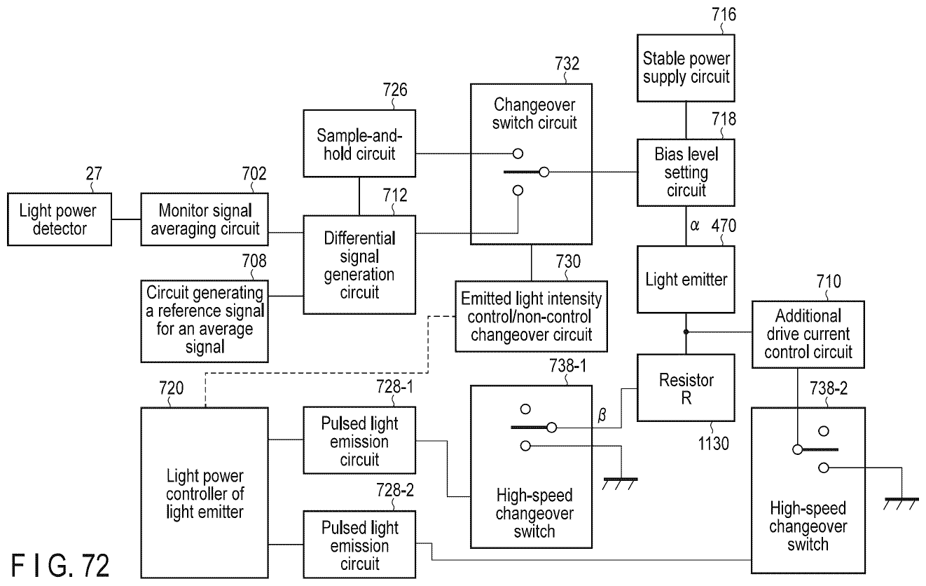

FIG. 72 illustrates a circuit configuration example in the light impulse control circuit 260 of FIG. 54 or FIG. 55. And FIG. 72 also illustrates a circuit configuration example that may provide the drive current 322 shown in FIG. 71 (b). The pulsed light emission timing signal transmitted from the system controller 50 is input to a light power controller of light emitter 720. Then, the pulsed light emission circuits 728-1 and 728-2 control high-speed changeover switches 738-1 and 738-2 respectively in accordance with a signal from the light power controller of light emitter 720. Here, the high-speed changeover switch 738-2 is in “active state” during the rising up term “Wt”. And an additional drive current control circuit 710 controls the differential drive current “ht-hb”.

The light emitter 470 is directly connected to the high-speed changeover switches 738-1, 738-2. When a lower end of the light emitter 470 is connected to the ground, a current flows through both ends of the light emitter 470, and pulsed light (pulsed irradiated light (first light beam) 13) is emitted. A bias level setting circuit 718 adjusts the bias level “hb” of the emitted light intensity at this time. That is, the bias level setting circuit 718 controls a current value supplied from a stable power supply circuit 716, and the controlled current flows through the light emitter 470.

A voltage value for controlling the bias level setting circuit 718 is switched between the output of a differential signal generation circuit 712 and the output of a sample-and-hold circuit 726. That is, the bias level setting circuit 718 is connected to the differential signal generation circuit 712 during a period in which the light emitter 470 repeats pulsed light emission. On the other hand, when the light emitter 470 does not emit the irradiated light (first light beam) 12 over a long period, the bias level setting circuit 718 is connected to the sample-and-hold circuit 726.

The sample-and-hold circuit 726 is connected to the differential signal generation circuit 712, and holds an output voltage of the differential signal generation circuit 712 immediately before the light emitter 470 ends the pulsed light emission for a long period. The sample-and-hold circuit 726 holds the voltage immediately before the end of the pulsed light emission, so that the light emitter 470 can secure a stable bias current level “hb” even immediately after the restart of the pulsed light emission.

An emitted light intensity control/non-control changeover circuit 730 performs the control of a changeover switch circuit 732. In addition, switching timing between a continuous pulse light exposure allowable term and a long-term light exposure stopped term is received from the light power controller of light emitter 720.

The light power detector 27 measures the light intensity of the irradiated light (first light beam) 12 emitted from the light emitter 470 in real time. A monitor signal averaging circuit 702 averages the time-varying signal of the emitted light intensity 338 from the light power detector 27. The differential signal generation circuit 712 outputs a difference value between the output of a circuit generating a reference signal for an average signal 708 and the output of the monitor signal averaging circuit 702.

In averaging processing in the monitor signal averaging circuit 702, the band limitation may be applied to the time-varying signal of the emitted light intensity 338 from the light power detector 27. When a high-speed noise component is mixed in the time-varying signal of the emitted light intensity 338 from the light power detector 2112 temporal variation of the light emission pulse peak value. Therefore, the averaging processing with respect to the emitted light intensity 338 in the monitor signal averaging circuit 702 has an effect of stabilizing the temporal variation of the light emission pulse peak value.

On the other hand, when the light emission ratio (duty ratio) in the light emission pattern changes, there is a side effect that the average value of the time-varying signal of the emitted light intensity 338 from the light power detector 27 changes. Therefore, in the present embodiment example, the light emission ratio (duty ratio) in the pulsed light emission pattern of the light emitter 470 is made uniform to stabilize the temporal variation of the light emission pulse peak value.

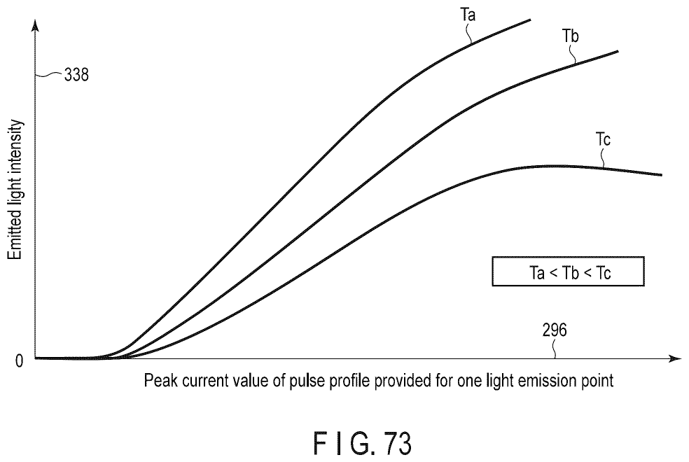

FIG. 73 illustrates the temperature dependency in the active area 480 regarding the profile of the emitted light intensity 338 with respect to the peak current value 296 of pulse profile for each light emission point (light passing window 490) in the VCSEL 128. In the low-temperature state “Ta”, the emitted light intensity 338 increases as the peak current value 296 of pulse profile increases. However, when the temperature rises to “Tb”, the gradient of the emitted light intensity 338 becomes gentle. When the temperature further rises to “Tc”, the emitted light intensity 338 with respect to the peak current value 296 of pulse profile is saturated.

As described above, in the VCSEL 128, a thermal saturation phenomenon occurs even at a relatively low temperature (for example, about 90° C.). Therefore, it is very important that the VCSEL 128 requires a special method to prevent high temperature within the active area 480.

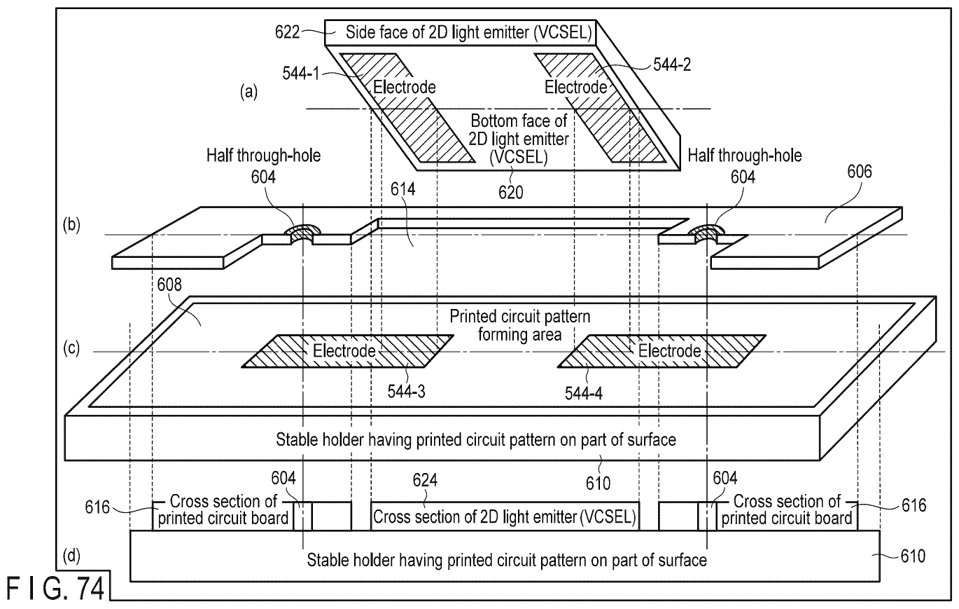

FIG. 74 illustrates the present embodiment example related to a method for fixing the light emitter 470 and a method for connecting the light emitter 470 to a printed circuit board for driving the light emitter. As explained above, the VCSEL 128 requires a special method to prevent high temperature when an optical system uses the VCSEL 128 as a light emitter 470. Therefore, the present embodiment example may fix the VCSEL 128 on a metal base printed electric circuit (an electric circuit printed on a metal board) that has high thermal conductivity. Herein, the metal base printed electric circuit may comprise a printed electric circuit on an aluminum plate or on a copper plate.

Moreover, the present embodiment example may form the electric circuit on a prescribed substrate that guarantees a high speed signal processing and that may be “glass-epoxy substrate” since the present embodiment example achieves the high speed signal processing. And a half through-hole 604 may the prescribed substrate guaranteeing the high speed signal processing to the metal base printed electric circuit. Furthermore, the metal base printed electric circuit may directly attach to a radiator (a fin to radiate heat energy).

In recent years, with the miniaturization of the printed circuit board, the miniaturization of a package of the light emitter 470 has progressed. As an example of a package structure of the miniaturized light emitter 470, FIG. 74 (a) illustrates a package of a VCSEL (wide area light emitter, multipoint light emitter, or 2D light emitter) as viewed from below. In FIG. 74 (a), emitting light 462 from the VCSEL (wide area light emitter or multipoint light emitter) is emitted toward the backward side of the paper plane.

An example of dimensions of a bottom face 620 of the 2D light emitter (VCSEL 128) as viewed from below is as very small as 3 mm in width x 2.7 mm in depth. Therefore, only two electrodes 544-1 and 544-2 are arranged on the bottom face 620 of the 2D light emitter (VCSEL 128). Such miniaturization makes it difficult to mechanically fix the package of the light emitter 470. Therefore, it is necessary to improve the mechanical strength, moisture absorption resistance, and temperature characteristics of joint portions (to which the electrodes 544-1 and 544-2 are soldered) with respect to the two electrodes 544-1 and 544-2.

In a “glass-epoxy substrate” generally used as a material of a printed circuit board, temperature deformation is large (thermal expansion coefficient is high), and swelling due to moisture absorption easily occurs. Furthermore, since the “glass-epoxy substrate” has low thermal conductivity, the heat dissipation effect on the light emitter 470 is low. In addition, in a case where the VCSEL (wide area light emitter, multipoint light emitter, or 2D light emitter) 128 is used as the light emitter 470, as illustrated in FIG. 73, the emitted light intensity 338 is significantly reduced with a slight temperature rise (exceeding “Tc”). Therefore, it is important to take a heat dissipation method for the VCSEL (wide area light emitter, multipoint light emitter, or 2D light emitter) 128.

In the present embodiment example illustrated in FIG. 74 (a), a printed circuit pattern 608 is formed directly on a surface of a stable holder 610 with respect to the light emitter 470. The present embodiment example may choice a prescribed material of the stable holder 610 that improve the high mechanical strength, high thermal conductivity, a low coefficient of thermal expansion, and moisture absorption resistance. Therefore, it is desirable that the stable holder 610 includes metallic material, and the metallic material may include aluminum atoms or copper atoms.

Then, electrodes 544-3 and 544-4 are formed in a part in the printed circuit pattern 608 on the surface of the stable holder. The soldering electrically joins “the electrodes 544-1 and 544-2 in the bottom face 620 of the 2D light emitter (VCSEL 128)” to “the electrodes 544-3 and 544-4 in the printed circuit pattern forming area 608”. In addition, the 2D light emitter (VCSEL 128) is fixed to the stable holder 610 in which the printed circuit pattern 608 is formed on a part of the surface by mechanical bonding between “the electrodes 544-1 and 544-2” and “the electrodes 544-3 and 544-4” using soldering.

For the light emission of the light emitter 470 (for example, the wide area light emitter, the multipoint light emitter, or the 2D light emitter such as the VCSEL 128), for example, a drive circuit described above using FIG. 72 is required. As one of the present embodiment examples, the printed circuit pattern for the drive circuit may be formed on the printed circuit pattern 608 on the surface of the stable holder 610.

In addition, as the present embodiment application example, the above-described drive circuit may be formed on the printed circuit board 606 having a partially lacking area such as the partially lacking area 614 of printed circuit board 606. Then, the package of the miniaturized light emitter 470 (for example, the wide area light emitter, the multipoint light emitter, or the 2D light emitter such as the VCSEL 128) may be arranged in the partially lacking area 614 of printed circuit board 606. That is, the light emitter 470 (the VCSEL 128) directly attaches to the printed circuit pattern forming area 608 on the stable holder 610.

In the printed circuit pattern 608 on the surface of the stable holder 610 in FIG. 74 (c), there are many “single-layer structure” of the circuit 608. If this is changed to a “multilayer structure”, an expensive manufacturing cost is required. However, if the “multilayer structure” can be adopted, a drive frequency of the light emitter 470 (for example, the wide area light emitter, the multipoint light emitter, or the 2D light emitter such as the VCSEL) can be increased. In addition, since the printed circuit pattern 608 on the surface of the stable holder 610 in FIG. 74 (c) has high thermal conductivity, it takes time and effort to replace a chip resistor and a chip capacitor mounted thereon.

Therefore, if a “mixed material of glass-epoxy resin” is used as the material of the printed circuit board 606 having a partially lacking area such as the lacking area 614 of the printed circuit board 606 as in the present embodiment application example, and a circuit configuration of a “multilayer structure” can be achieved, the drive frequency of the light emitter 470 (for example, the wide area light emitter, the multipoint light emitter, or the 2D light emitter such as the VCSEL 128) becomes high. Furthermore, since the “mixed material of glass-epoxy resin” has low thermal conductivity, an effect of facilitating replacement of a chip resistor and a chip capacitor mounted by soldering is also produced.

In the present embodiment application example, electrical connection is required between the printed circuit board 606 lacking a portion and the electrodes 544-1 and 544-2 in the bottom face 620 of the 2D light emitter (VCSEL 128). As an electrical connection method, in FIG. 74, the electrodes 544-1 and 544-2 are interposed. And a half through-hole 604 electrically connects in the printed circuit board 606 lacking a portion to the printed circuit pattern forming area 608 on the stable holder 610.

The half through-hole 604 has a unique shape including a part of a usual through-hole shape, and another part of the half through-hole 604 is bared out of the printed circuit board 608 lacking a portion. A user can pour a melted solder into the half through-hole 604 through the bared part of the half through-hole 604 to electrically connect the upper surface on the printed circuit board 608 lacking a portion to the lower surface. Therefore, the half through-hole 604 increases the soldering efficiency.

A series of FIGS. 74 (a) to (c) illustrates a stacking procedure between components. And FIG. 74 (d) is a cross-sectional view of the respective components assembled. The printed circuit pattern forming area 608 on the stable holder 610 includes electrodes 544-3 and 544-4. As illustrated in FIG. 74 (a), the bottom face 620 of the 2D light emitter (VCSEL 128) has electrodes 544-1 and 544-2. Then, the electrode 544-1 is electrically connected to the electrode 544-3 by soldering. Similarly, the electrode 544-2 is electrically connected to the electrode 544-4 by soldering.

By this soldering, the bottom face 620 of the 2D light emitter (VCSEL 128) is mechanically fixed to the stable holder 610 in which the printed circuit pattern is formed on a part of the surface. When the 2D light emitter (VCSEL 128) emits the emitting light 462, the 2D light emitter (VCSEL 128) has a high temperature. The heat generated at this time is dissipated through the stable holder 610 having a high heat dissipation effect. Since the temperature rise of the 2D light emitter (VCSEL 128) is suppressed, the large emitted light intensity 338 (see FIG. 73) can be continuously secured.

The cross section 616 of the printed circuit board 606 lacking a portion in FIG. 74 (d) is arranged outside the cross section 624 of the 2D light emitter (VCSEL 128). Moreover, since the cross section 616 of the printed circuit board 606 lacking a portion is close to the cross section 624 of the 2D light emitter (VCSEL 128), the drive frequency of the 2D light emitter (VCSEL 128) increases. In order to avoid physical interference (collision) between the 2D light emitter (VCSEL 128) and the printed circuit board 606 lacking a portion, the printed circuit board 606 has the lacking area 614. In the assembled stage, the 2D light emitter (VCSEL) enters the lacking area 614 of the printed circuit board. In the present embodiment application example, the printed circuit board 606 is not limited to the structure having the lacking area 641 and any method for avoiding physical interference (collision) may be used. For example, a partially hollow area may be provided in a part of the inside of the printed circuit board 606, and the 2D light emitter (VCSEL) may enter the partially hollow area.

Chapter 4 Description of optical noise generated due to interference phenomenon of light and proposal of method of reducing optical noise

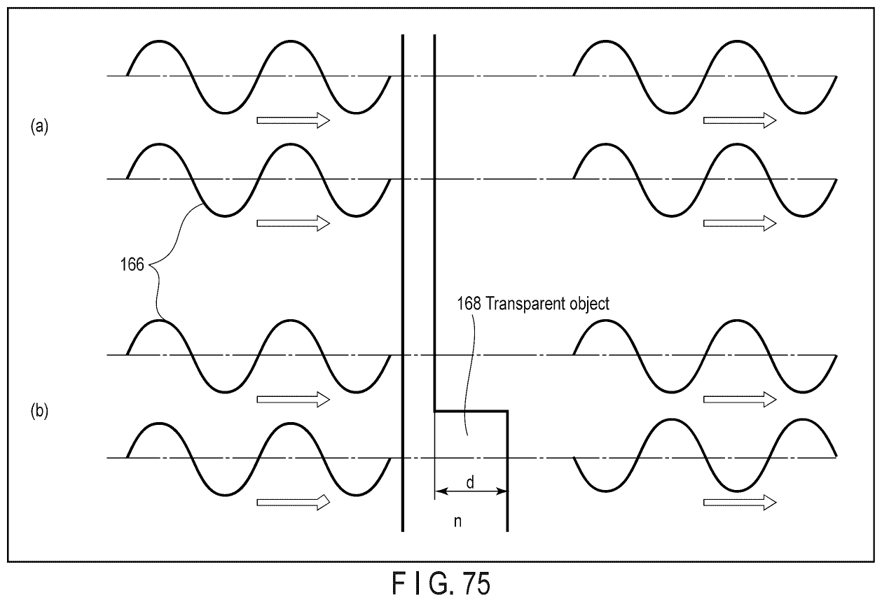

FIG. 75 is an explanatory diagram of a “spatial” interference phenomenon of light. As a “spatial” interference phenomenon of light, optical interference noise often appears in an optical image pattern. And the spatial interference noise is known as speckle noise. Speckle noise occurs in both reflected light and transmitted light. For convenience of description, FIG. 75 illustrates a case of light transmitted through a transparent object.

In a case where a surface of the transparent object is optically flat as illustrated in FIG. 75 (a), there is no loss of a transmitted light intensity. On the other hand, when light passes through a transparent object 168 having a difference in microscopic level on one side as illustrated in FIG. 75 (b), positions of peaks and valleys are shifted by upper and lower transmitted lights. This positional shift between the peak and the valley between the upper and lower transmitted lights causes an effect of canceling out transmitted light intensities. In the worst case where the positions of the peaks and the valleys are reversed between the upper and lower transmitted lights, the upper and lower transmitted light intensities greatly decrease. As compared FIG. 75 (b) with FIG. 75 (a), even if a uniform intensity light is made incident, a light intensity of straight light changes depending on a transmission location in the transparent object. Therefore, a rough surface of the transparent object (or the light reflection object) causes this light intensity variation as speckle noise.

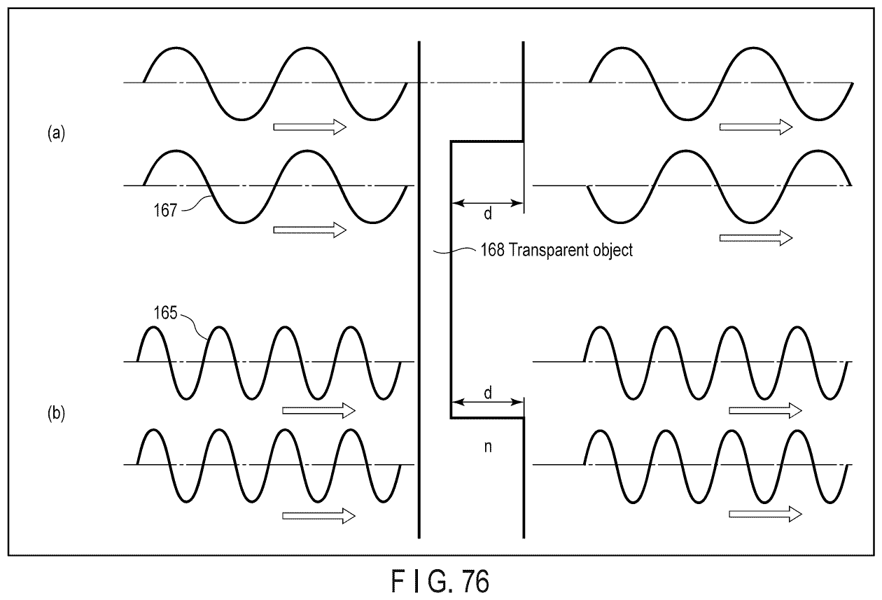

FIG. 76 is an explanatory diagram of a “temporal” interference phenomenon of light. Similarly to FIG. 75 (b), it is presumed that a difference “δ” in microscopic level is generated on one side of the transparent object. In the “temporal” interference phenomenon of light, even with the same difference level “δ”, the influence on the “temporal” interference phenomenon varies depending on a wavelength of transmitted light. For example, as illustrated in FIG. 76 (a), in a case where positions of the peaks and the valleys are vertically inverted in the transmitted light having a long wavelength, a canceling effect occurs between the upper and lower transmitted lights, and a straight light intensity greatly decreases.

On the other hand, as illustrated in FIG. 76 (b), in a case where the positions of the peaks and the valleys coincide with each other on the upper and lower sides in the transmitted light having a short wavelength, a combination between the upper and lower transmitted lights generates a synergistic effect, so that a straight light intensity does not decrease. As described above, the straight light intensity change generated due to a difference in the wavelength of the transmitted light becomes optical interference noise affecting a spectral profile.

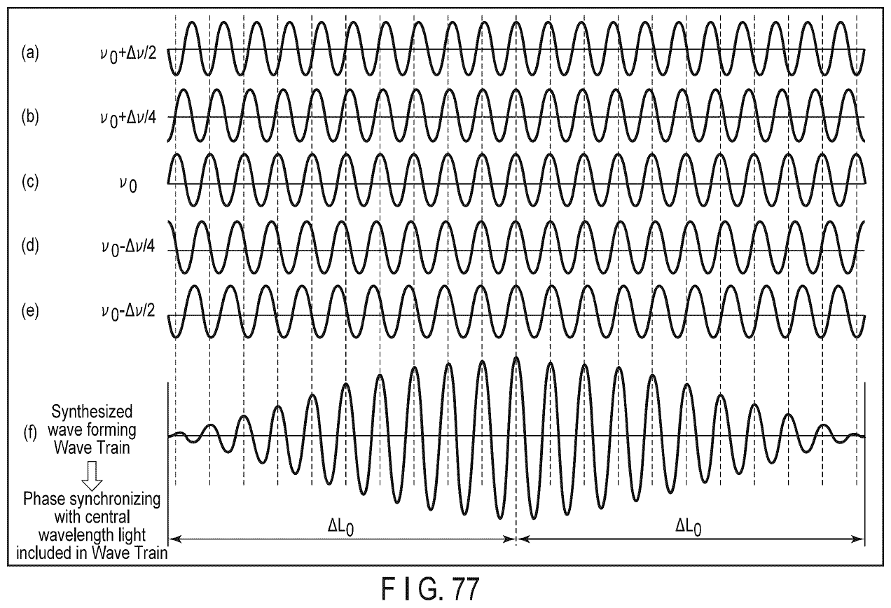

FIG. 77 illustrates the profile of light (synthesized wave) formed by collecting plural different wavelengths included in the range of a wavelength width “Δλ” (or a frequency width “Δ [symbol] ”). Here, FIG. 3 (c) illustrates the traveling of the light having the central wavelength “λ0” (the frequency “ [symbol] ” corresponding to the central wavelength “λ0”) (amplitude distribution profile of the electric field at a prescribed time). FIGS. 77 (a) and 77 (e) illustrate the traveling of the light having a wavelength corresponding to the frequencies “ [symbol] 0+Δ [symbol] /2” and “ [symbol] 0−Δ [symbol] /2” (amplitude distribution profile of the electric field at a prescribed time). FIGS. 77 (b) and 77 (d) illustrate the traveling of the light having a wavelength corresponding to the frequencies “ [symbol] 0+Δ [symbol] /4” and “ [symbol] 0−Δ [symbol] /4” (amplitude distribution profile of the electric field at a prescribed time).

FIG. 77 (f) illustrates the result of amplitude summation (synthesizing) of all wavelengths. Here, the amplitude summation means arithmetic processing of summating the total amplitude distribution of the electric field along the traveling direction of each light at a prescribed time within the wavelength width (spectral bandwidth) “Δλ” (or the frequency width “Δ [symbol] ”). This arithmetic processing is not merely mathematical arithmetic processing, and the light subjected to amplitude summation (synthesizing) physically constitutes a kind of synthesized wave.

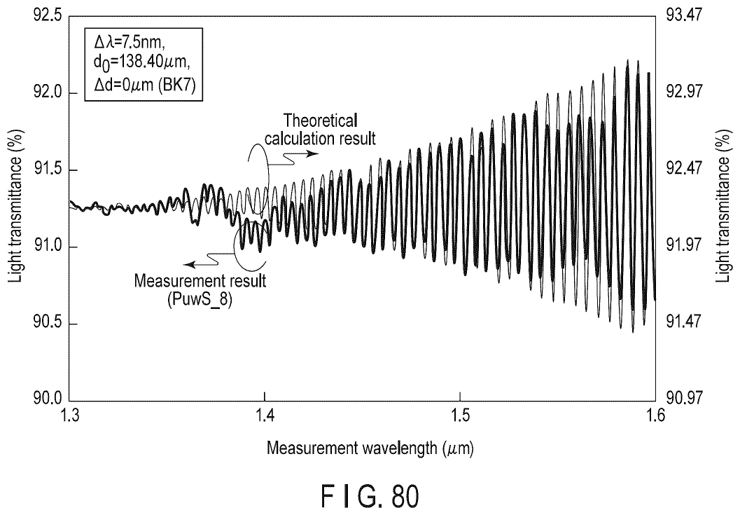

As illustrated in FIG. 77 (f), a large amplitude undulation occurs in the synthesized wave. And this one cluster of undulations with amplitude is called Wave Train. This Wave Train is not merely a mathematical description (logical model). FIG. 80 to be described later illustrates a physical existence of a “Wave Train having an amplitude undulation”.

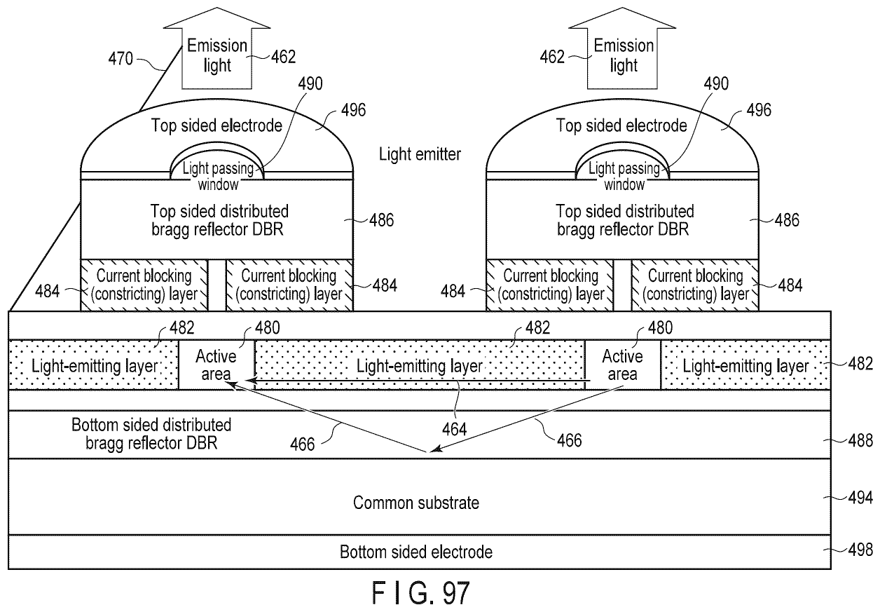

In FIG. 77, in a case where the positions (phases) of the peaks of all the wavelengths coincide with each other at the center position, in FIG. 77 (f) in which the amplitudes are added (synthesized), the maximum amplitude (peak height) is formed at the center position. It is not a mere coincidence that the positions (phases) of the peaks of all wavelengths coincide with each other at the center position. There is a possibility that a physical “induced emission phenomenon/stimulated emission phenomenon” described later with reference to FIG. 97 generates the “Wave Train having an amplitude undulation”.

When the near field of the center position of this wave train is mathematically decomposed into different wavelengths, it appears that “phases are synchronized between the different wavelengths”. That is, in FIGS. 77 (a) to 77 (e), it is difficult to consider that the positions (phases) of the peaks of all wavelengths coincidentally coincide at the center position. It is conceivable that the emitting light 462 emitted from the light emitter 470 intermittently emits a wave train having “undulation of amplitude distribution (maximum value of envelope)”. When this one wave train is decomposed into different wavelengths (mathematical decomposition on amplitude distribution profile), the profiles in FIGS. 77 (a) to 77 (e) are obtained.

The phase shifts between different wavelengths as it moves from the center position to the right and left in FIG. 77. Then, at both left and right ends in FIG. 77, phases between different wavelengths are completely random. As described above, since the phase shift occurs between different wavelengths at the peripheral positions (both left and right ends) in FIGS. 77 (a) to 77 (e), the maximum value (amplitude value of the envelope) of the amplitude profile of the entire Wave Train (FIG. 77 (f)) obtained by amplitude summation (synthesizing) of these amplitudes decreases.

With respect to the Wave Train profile illustrated in FIG. 77 (f), the spatial distance from the center maximum amplitude position to the position where the maximum value of the amplitude becomes “0” is represented by “ΔL0”. As described with reference to FIG. 3, the value of “ΔL0” changes depending on the value of wavelength width (spectral bandwidth) “Δλ” (or frequency width “Δ [symbol] ”) subjected to amplitude summation.

As indicated by the position of the broken line in the vertical direction connecting FIGS. 77 (c) and 77 (f), the phase in the wave train coincides with the phase of the wavelength having the central wavelength “λ0” (the frequency “ [symbol] 0” corresponding to the central wavelength “λ0”). As described above, the wave train profile greatly changes depending on the values of the wavelength width “Δλ” (or the frequency width “Δ [symbol] ”) and the central wavelength “λ0”.

The characteristics of a wave train illustrated in FIG. 77 (f) are described below in a mathematical manner. As illustrated in FIGS. 77 (a) to 77 (e), when a plane wave is integrated with a frequency range “Av” around a center frequency “v”,

$$[ Equation 35 ]$$

$$Equation 35$$

$${φ}_{R} ( {ν}_{0} ) ≡ {\int }_{{ν}_{0} - Δ ν / 2}^{{ν}_{0} + Δ ν / 2} exp \{ - i 2 πν ( t - r / c - {τ}_{j} ) \} d ν = Δν sin c \{ πΔν ( t - r / c - {τ}_{j} ) \} {e}^{- i 2 {πν}_{0} ( t - r / c - {τ}_{j} )}$$

is obtained.

That is, Equation 35 expresses the characteristics of the wave train illustrated in FIG. 77 (f).

Here,

$$[ Equation 36 ]$$

$$Δ {L}_{0} = {λ}_{0}^{2} / Δλ \qquad Equation 36$$

is defined.

“ΔL0” expressed by Equation 36 is called a coherence length. Using Equation 36, the frequency range Δ [symbol] is expressed as follows.

$$[ Equation 37 ]$$

$$Δν = ( Δλ / {λ}_{0} ) {ν}_{0} = c / Δ {L}_{0} \qquad Equation 37$$

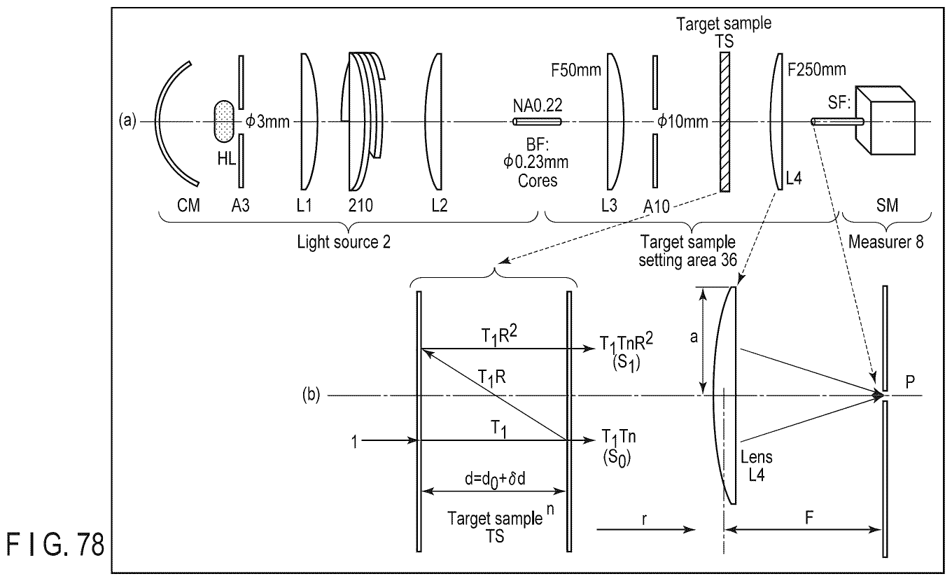

FIG. 78 (a) illustrates an optical system used in the experiment. This optical system schematically includes a light source 2, a target sample setting area 36, and a measurer 8, and light beams are transmitted between the respective units via an optical fiber. A tungsten halogen lamp HL was used for the light emitter 470 in the light source 2. A concave mirror CM was arranged on the opposite side of the optical path traveling in the right direction in FIG. 78 (a), and the utilization efficiency of the emitting light beams from the halogen lamp HL was increased. That is, the concave mirror CM reflects the emitting light beams toward the rear of the halogen lamps HL (the left side of FIG. 78 (a)) and returns the emitting light beams to the inside of the halogen lamp HL again. Then, the light beams passing through the inside of the halogen lamp HL travel toward the front of the halogen lamp HL (right side of FIG. 78 (a)).

A lens L1 having a focal length of “25.4 mm” converts the emitting light beams from the halogen lamp HL into parallel light beams. Thereafter, the parallel light beams are converged on the entrance surface of an optical bundle fiber BF by a lens L2 having a focal length of “25.4 mm”. The core diameter per optical bundle fiber BF is “230 μm”, and “320” optical fibers having an “NA 0.22” are bundled. An optical characteristic converting component 210 is arranged in the middle of the parallel optical path between the two lenses L1 and L2.

The filament that emits light in the halogen lamp HL has a size of “width 2 mm×length 4 mm×depth 1.5 mm”. Therefore, the emitting light from the outermost side in the filament generates off-axis aberration (coma aberration) in the imaging optical system including the two lenses L1 and L2. In order to remove the influence of coma aberration, an aperture A3 having a diameter of “3 mm” is arranged immediately after the halogen lamp HL.

In the target sample setting area 36, a lens L3 having a focal length of “50 mm” converts the outgoing light beam from the optical bundle fiber BF into parallel light. Then, the sample TS is irradiated with the parallel light flux. Here, an aperture A10 having a diameter of “10 mm” was arranged immediately before the sample to improve the accuracy and reproducibility of the obtained spectral profile data. In the experimental optical system

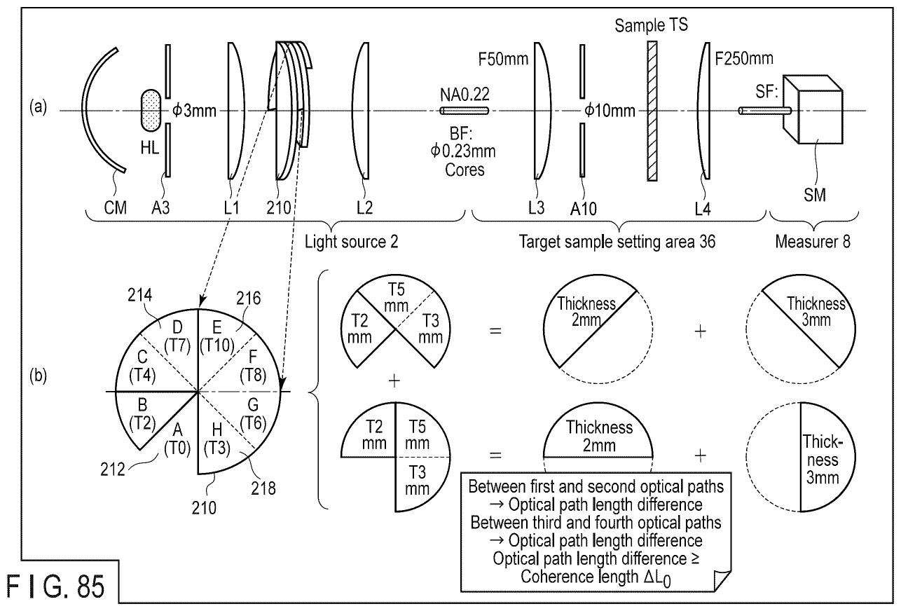

illustrated in FIG. 78 (a), spectral profile data is acquired using the transmitted light beam of the sample TS. A lens L4 having a focal length of “250 mm” converges the transmitted light beams of the sample TS on the incident surface (core diameter: “600 μm”) of a single core fiber SF. As a spectrometer SM, a near-infrared spectrometer (C11482 GA manufactured by Hamamatsu Photonics K.K.) having a wavelength resolution of “7.5 nm” was used. The structure example of the optical characteristic converting component 210 will be described later with reference to FIG. 85 (b).

Since the spectral component 320 is arranged in the near-infrared spectrometer, the wavelength resolution of “7.5 nm” corresponds to the value of the wavelength width (spectral bandwidth) “AA”. Then, the profile of the Wave Train corresponding to the wavelength width (spectral bandwidth) “AA” is measured in the near-infrared spectrometer.

The structure of the sample TS used in the experiment is illustrated in FIG. 78 (b). That is, a transparent glass flat plate having a refractive index of “n” and a mechanical thickness of “d=d0+δd” was arranged at the position of the sample TS in the target sample setting area 36 (where “od” represents the thickness deviation of the transparent glass flat plate for each optical path of light beams passing through the aperture A10 having a diameter of “10 mm”). Then, the lens L4 converges the light beams passing through the transparent glass flat plate onto the entrance surface of the single core fiber SF. The inside of the core area on the entrance surface of the single core fiber SF corresponds to the “point P” in FIG. 78 (b).

Since the front and back surfaces of the transparent glass flat plate are in an uncoated state, about “4%” of the light intensity passing through the front and back surfaces of the transparent glass flat plate is reflected by the front and back surfaces. Therefore, Wave Train “S0” traveling straight on the transparent glass flat plate and Wave Train “S1” that is reflected twice on the front and back surfaces and then travels toward the lens L4 interfere at the “point P”.

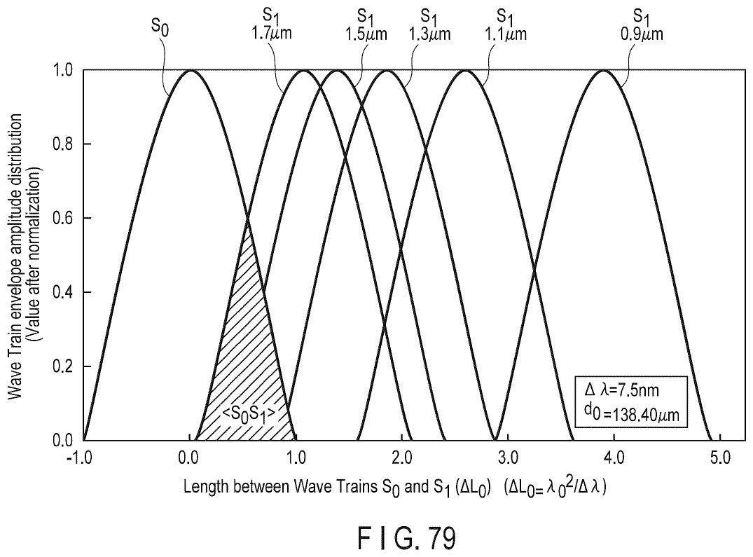

FIG. 79 illustrates the interference status between the straight Wave Train “S0” and the Wave Train “S1” after being reflected twice. The position of the envelope profile “S0” of the Wave Train traveling straight in the transparent glass flat plate was fixed at the standard position. The function “S1” representing the envelope profile of the Wave Train after two reflections is described as a relative position change when the central wavelength “λ0” was changed from “0.9 μm” to “1.7 μm”.

In the horizontal axis in FIG. 79, the coherence length “ΔL0” expressed by Equation 36 is expressed as a reference unit. Since the mechanical average thickness “d0” between the front and back surfaces of the transparent glass flat plate is a fixed value, the mechanical interval between the center position of the Wave Train “S0” traveling straight in the transparent glass plate and the center position of the Wave Train “S1” after being reflected twice is kept constant. Here, a case where the mechanical constant distance is converted in a reference unit of the coherence length “ΔL0” will be considered. As indicated by Equation 36, the coherence length “ΔL0” changes in proportion to the square of the central wavelength “λ0”. Therefore, the relative position between the two Wave Trains in FIG. 79 seems to change according to the value of the central wavelength “λ0”.

The area of the overlapping area (shaded area in FIG. 79) “<SOS1>” between both Wave Trains corresponds to the size of the optical interference fringe generated between the two Wave Trains. In particular, when the central wavelength “λ0” is “1.7 μm” or “1.5 μm”, two Wave Trains overlap as illustrated in FIG. 79. However, when the central wavelength “λ0” is “1.1 μm” or less, the overlapping area between the two Wave Trains becomes “0”, and the interference fringes are not generated.

It is known that an optical interference phenomenon occurs in one Wave Train having the profile in FIG. 77 (f). Then, the amplitude value of the interference fringe is determined by the overlapping area “<SOS1>” value between the same Wave Train “S0” and “S1” whose center positions are shifted from each other after passing through the transparent glass flat plate (https://doi.org/10.1364/OE.441562).

Two types of interference phenomena of light are known: an interference phenomenon caused by spatial coherence of light; and an interference phenomenon caused by temporal coherence of light. In the interference phenomenon based on the temporal coherence, the “overlapping area “<SOS1>” between the same Wave Train “S0” and “S1” in which the center positions are shifted from each other sets the amplitude value of the interference fringe.

FIG. 80 shows experimental results obtained using the experimental optical system in FIG. 78. The bold curve in FIG. 80 shows the measurement data. In addition, the theoretical calculation result calculated according to the description in FIG. 79 is indicated by a thin curve in FIG. 80. The value of the wavelength range “Δλ” as a condition for this theoretical calculation coincides with “7.5 nm” of the wavelength resolution “Δλ” of the spectrometer SM. Here, when the thickness “d0” of the transparent glass flat plate is calculated to be “138.40 μm”, the measurement data and the theoretical calculation result based on the existing theory substantially coincide with each other. There is a limit to the measurement accuracy of the micrometer, but the measurement value of the micrometer close to the above is obtained with respect to the thickness “d0” of the transparent glass flat plate.

A deviation between the local measurement data and the theoretical calculation result is observed in the vicinity of the measurement wavelength of “1.39 μm” in FIG. 80. This deviation is expected to be the result of appearance of the light absorption phenomenon of hydroxyl groups in the transparent glass plate, which is irrelevant to the wave train profile.

The size (amplitude value) of the interference fringes in FIG. 80 takes substantially the same value as the measurement data and the theoretical calculation result. From this result, it is considered that “degree of spatial coherence in the experimental result is close to “100%”. That is, the change in amplitude of the interference fringes appearing in FIG. 80 is considered to be a phenomenon caused almost by temporal coherence. In addition, the reproducibility of the experimental data is good no matter how many times the measurement is performed. Therefore, in FIG. 80, a part of the wave train profile in FIG. 3 (f) appears very stably and reproducibly.

In addition, the measurement data and theoretical calculation result for the phase in the interference fringes in FIG. 80 are in agreement everywhere. This experimental result also suggests ‘the phase value (“τj” value in Equation 35) is kept constant everywhere in the same Wave Train’. The experimental result in FIG. 80 indicates “Wave Train having the profile in FIG. 77 (f) is not a mathematical imaginary model but is physically present”.

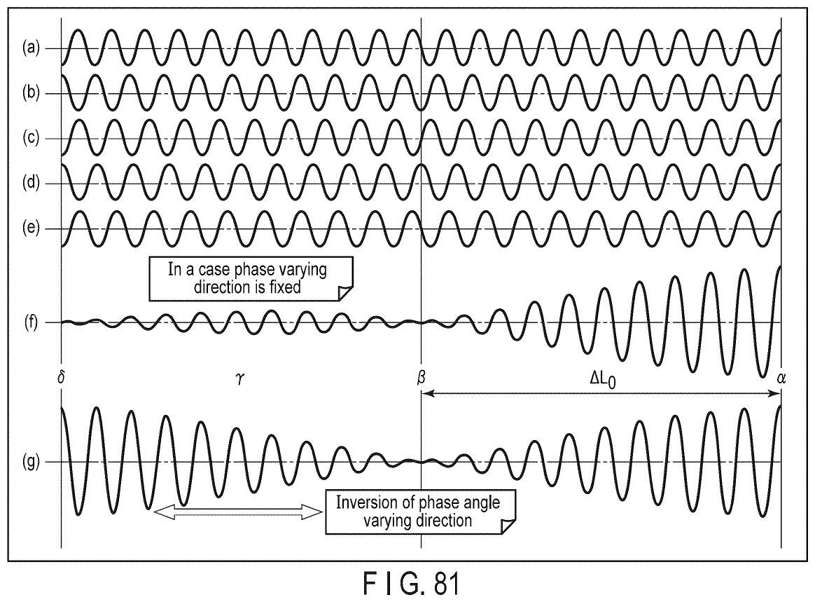

A related characteristic between different Wave Trains will be described with reference to FIG. 81. FIG. 81 illustrates a state in which the center position in FIG. 77 describing the characteristic within one Wave Train is shifted to the right end. That is, the center position in FIG. 77 is shifted to the “position α” at the right end in FIG. 81. The left end position in FIG. 77 corresponds to the “position β” in the center portion in FIG. 81. The change in amplitude from the “position α” to the “position β” in FIG. 81 (f) corresponds to the experimental result in FIG. 80.

Here, substituting “t=τj=0” and the variable “r=ΔL0” based on Equation 36 for Equation 35, the right side profile of Equation 35 indicates the “position β” in FIG. 81 (f). Further, when “|r|≥ΔL0”, the sinc function value in the right side of Equation 35 takes a negative value. This area corresponds to the “γ region” in FIG. 81 (f). Therefore, according to the right side profile in Equation 35, the following profiles should appear for the “γ area”:
a] Wave Train amplitude is also observed in the “γ area” outside (left side) of the left end “B position” of Wave Train; and
b] the phase is inverted in the “area between α and β” in Wave Train and the area outside the left end (“γ area” on the left side).

However, in the experimental result illustrated in FIG. 80, neither of the characteristics [a] and [b] could be observed. That is, contrary to the theoretical expectation of Equation 35, the experimental result shows that one Wave Train completely disappears at the value of Equation 36. However, even when one Wave Train disappears, the light emission from the light emitter 470 (halogen lamp HL) continues. Therefore, after one Wave Train disappears, the light emitter 470 (halogen lamp HL) needs to emit the next Wave Train.

One Wave Train in FIG. 81 (f) is divided into plural different wavelength lights (FIGS. 81 (a) to 81 (e)). It is necessary to generate next Wave Train while maintaining continuity for each of the plural divided different wavelength lights. In addition, in the center portion in one Wave Train, the phases of the plural divided different wavelengths coincide with each other. That is, in the process of generating the next Wave Train after one Wave Train disappears, it is necessary to match phases between different wavelengths toward the center portion of the next Wave Train while maintaining continuity for each of the plural divided different wavelengths (FIGS. 81 (a) to 81 (e)). As a physical model that can satisfy all the conditions required above, a hypothesis of a ‘mechanism of simultaneously inverting the phase angle varying direction’ at the “β position” is considered.

The reversal hypothesis of the phase angle varying direction at the “(position” will be described in detail below. Substituting Equation 37 for Equation 35, Equation 38 shows the following approximation profile of the envelope of Wave Train near the “β position” in FIG. 81 (f):

$$[ Equation 38 ]$$

$$sin c \{ π ( ct - r ) / Δ {L}_{0} \} \approx \frac{sin \{ π ( ct - r ) / Δ {L}_{0} \}}{π} \qquad Equation 38$$

Further, in terms of a sine function from the viewpoint of complex function theory, the following relationship is established:

$$[ Equation 39 ]$$

$$sin θ = \frac{{e}^{i θ} - {e}^{- i θ}}{2 i} \qquad Equation 39$$

And substituting Equations 38 and 39 for Equation 35, the following equation is obtained:

$$[ Equation 40 ]$$

$$Equation 40$$

$$Ψ ( {ν}_{0} ) \approx \frac{sin \{ π ( ct - r ) / Δ {L}_{0} \}}{π} exp \{ - i 2 {πν}_{0} ( t - r / c ) \} = \frac{sin \{ π ( ct - r ) / Δ {L}_{0} \}}{π} exp \{ + i 2 {πν}_{0} ( t - r / c ) \} - i 2 \frac{sin \{ π ( ct - r ) / Δ {L}_{0} \}}{π} sin \{ 2 {πν}_{0} ( t - r / c ) \}$$

Where the following conditions of Equation 41 are satisfied:

$$[ Equation 41 ]$$

$$sin \{ π ( ct - r ) / Δ {L}_{0} \} sin \{ 2 {πν}_{0} ( t - r / c ) \} \approx 0 \qquad Equation 41$$

the following relationship is established:

$$[ Equation 42 ]$$

$$Equation 42$$

$$ψ ( {ν}_{0} ) \approx \frac{sin \{ π ( ct - r ) / Δ {L}_{0} \}}{π} exp \{ - i 2 {πν}_{0} ( t - r / c ) \} = \frac{sin \{ π ( ct - r ) / Δ {L}_{0} \}}{π} exp \{ + i 2 {πν}_{0} ( t - r / c ) \}$$

The right side on the upper side of Equation 42 represents the near field of the terminal portion of the “preceding (previously generated) Wave Train” in the near field of the “β position”. In addition, the lower expression in Equation 42 represents the near field of the starting end of the “following (later generated) Wave Train”. A particularly notable point is that “inversion of phase angle varying direction” occurs between the upper right-hand side expression and the lower expression of Equation 42. As described above, when the “inversion of phase angle varying direction” occurs in the near field of the termination portion of the “preceding Wave Train” (in the near field of the “β position” in FIG. 81 (g)), optical phase synchronization is started between all the constituent wavelengths of light immediately after that. As a result, a “succeeding Wave Train” is generated.

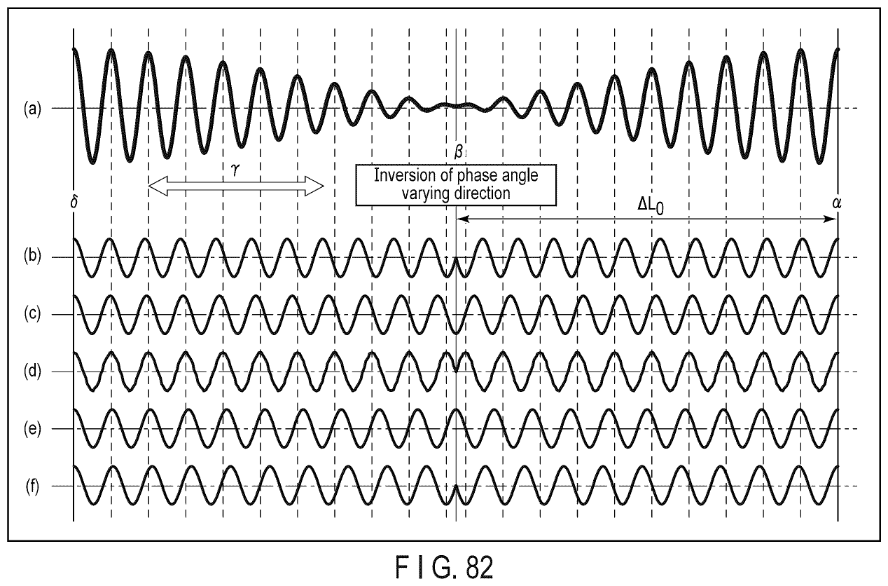

FIG. 82 shows predicted behavior of plural different wavelength lights that form a combination between “preceding Wave Train” and “succeeding Wave Train”. FIG. 82 (a) illustrates the same profile as FIG. 81 (g). According to Equation 35, plural different wavelength lights form Wave Train. Therefore, the combination between “preceding Wave Train” and “succeeding Wave Train” may be divided into plural different wavelength lights (FIGS. 82 (b) to 82 (f)).

According to the hypothesis regarding mechanism of generating the succeeding Wave Train after preceding Wave Train disappearance, FIG. 82 (b) to FIG. 82 (f) show that all of plural different wavelength lights simultaneously inverts the phase angle varying direction at the “β position”. The reversal hypothesis of the phase angle varying direction of plural different wavelength lights can maintain continuity for each of the plural divided different wavelength lights at the “β position”.

As a precondition for generating the “succeeding Wave Train” expressed by Equation 42, Equation 41 must hold. The precondition for Equation 41 to hold is that “generation of a succeeding Wave Train in the middle of a preceding Wave Train is prohibited”. That is, when the envelope amplitude of the “preceding Wave Train” is big (when Equation 41 does not hold), the start of the generation of the “succeeding Wave Train” (when Equation 42 holds) does not start.

It is considered that the physical phenomenon that is the basis for this “continuous repetition of the generation and disappearance of Wave Train occurring continuously along time series” relates to the induced emission phenomenon or stimulated emission phenomenon. FIG. 97 will describe the induced emission phenomenon or stimulated emission phenomenon later. That is, even when the emission of the emitting light 462 is stopped (disappearance of the preceding wave train) in the photon life corresponding to the coherence time “At”, the supply of the carrier is continued. Therefore, when the carrier accumulation amount in the active area 480 increases, emission of the emitting light 462 is started (generation of a subsequent wave train is started).

The range of the position “r” satisfying Equation 41 is very long as compared with the length of the central wavelength “λ0” of Wave Train. Therefore, the timing at which the phase angle varying direction is reversed in the near field of the terminal portion (in the near field of the “β position”) of “preceding Wave Train” is not uniquely determined by the length accuracy of the central wavelength “λ0” of Wave Train. As a result, the phase of “succeeding Wave Train” becomes discontinuous with respect to the phase of “preceding Wave Train”. The phenomenon in which the start timing of Wave Train is uncertain within the range satisfying Equation 41 has already been described. The phase discontinuity between the preceding and succeeding Wave Trains also relates to the phenomenon described above.

That is, the approximate Equation 42 under the conditions of Equation 41 leads to the following characteristics:
c] succeeding Wave Train is continuously generated at the “β position” in the near field of the terminal end of preceding Wave Train (continuous Wave Train generation); and
d] phase discontinuity between preceding and succeeding Wave Trains (unsynchronized optical phase 402) occurs because the timing at which succeeding Wave Train is generated is uncertain.

A case where preceding Wave Train is shifted and overlapped with succeeding Wave Train is considered. If there is phase continuity (phase continuity or optical phase synchronization) between preceding and succeeding Wave Trains, the phase of the synthesized light in which preceding Wave Train and succeeding Wave Train are superimposed is always uniquely determined. However, from the above feature [d], the phase shift amount preceding and succeeding Wave Trains always changes. Therefore, in the case of observation for a prescribed period (macroscopically viewed along time direction), it is not possible to observe a state in which interference occurs between preceding and succeeding Wave Trains. This state is referred to as “incoherence between preceding and succeeding Wave Trains” when looking at time from a macroscopic view.

The intensity of the synthesized light of preceding and succeeding Wave Trains in the prescribed period is equal to the value obtained by summating the average intensity of preceding Wave Train and the average intensity of succeeding Wave Train. This situation is referred to as “intensity summation” in the present embodiment.

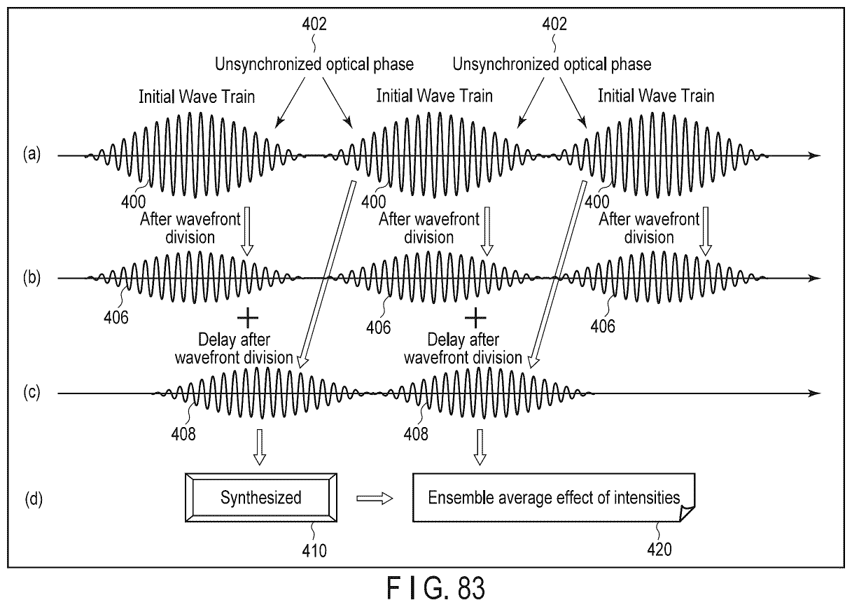

FIG. 83 illustrates a basic operation principle related to the method for reducing optical interference noise common in various embodiments described in Chapter 4. As already described, the initial Wave Trains 400 generated before and after each other have an unsynchronized optical phase relation 402.

The connection of the initial Wave Trains 400 illustrated in FIG. 83 (a) is divided by the optical characteristic converting component 210 described later. The method for dividing the initial light 200 may be any of wavefront division, amplitude division/intensity division, and a combination of both. FIGS. 83 (b) and 83 (c) illustrate the spatial propagation state of each Wave Train (state of divided Wave Trains 406 and 408) divided for each area in the optical characteristic converting component 210. The amplitude of each of the divided Wave Trains 406 and 408 is smaller than the amplitude of the initial Wave Train 400.

Further, when an optical path length difference occurs in the middle of the optical paths of the respective Wave Trains 406 and 408 after wavefront division, only Wave Train 408 delay after wavefront division is delayed in the light traveling direction. Therefore, the position of the Wave Train delayed after wavefront division 408 in FIG. 83 (c) is shifted in position in the light traveling direction compared with Wave Train after wavefront division 406 in FIG. 83 (b).

Thereafter, synthesizing 410 is performed on each of the Wave Trains 406 and 408 in the optical synthesizing area 220 (FIG. 83 (d)). One Wave Train size (distance from the start end to the terminal end) is given by “2ΔL0”. Therefore, when the optical path length difference between the Wave Train after wavefront division 406 and the Wave Train delayed after wavefront division 408 is set to “2ΔL0” or more, there is no place where the phases of the two are synchronized with each other after synthesis. Even if the optical path length difference between the two is “ΔL0”, the temporal coherence between the Wave Train after wavefront division 406 and the Wave Train delayed after wavefront division 408 is low. Therefore, the optical path length difference between them may be set to “ΔL0” or more.

Since the Wave Train after wavefront division 406 and the Wave Train delayed after wavefront division 408 are in unsynchronized optical phase relation 402, the synthesized light obtained as a result of the optical synthesizing 410 creates an ensemble average effect of intensities rather than an amplitude summation effect. When optical measurement (or imaging or optical detection) is performed using only the initial Wave Train 400, optical interference noise is generated due to the influence of optical characteristics (for example, occurrence of partial phase disturbance) in the optical path through which the initial Wave Train 400 passes. By the way, since the optical paths through which the Wave Train after wavefront division 406 and the Wave Train delayed after wavefront division 408 pass are slightly different, the optical interference noise characteristics generated between the two Wave Trains are slightly different.

When the light intensities of both are summated, their intensity profiles are averaged 420. In the process of the ensemble average effect of intensities 420, interference noise profiles different from each other are also averaged (smoothed). Then, mutually different profile portions in the optical interference noise characteristic are canceled out. That is, the intensity averaging 420 (smoothing or canceling) is also performed between the optical interference noise generated in the Wave Train after wavefront division 406 and the optical interference noise having a different profile in the Wave Train delayed after wavefront division 408. As a whole, the optical interference noise is reduced.

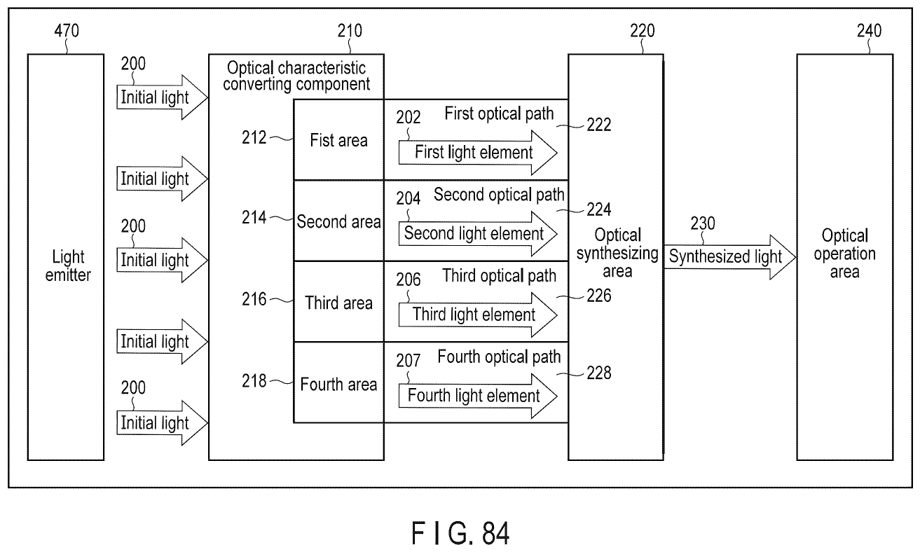

FIG. 84 illustrates an optical arrangement example that realizes the basic operation described with reference to FIG. 83. In the embodiment in FIG. 84, the optical characteristic converting component 210 is used as an optical operation unit for performing “intensity summation” at the time of generating the synthesized light 230 in the optical synthesizing area 220. That is, the optical characteristic converting component 210 divides the initial light 200 emitted by the light emitter 470 into plural light elements 202 to 207.

Here, the first optical path 222 in the optical characteristic converting component 210 forms the first light element 202 having the first optical characteristics, and the second optical path 224 forms the second light element 204 having the second optical characteristics. Similarly, the third optical path 226 in the optical characteristic converting component 210 forms the third light element 206 having the third optical characteristics, and the fourth optical path 226 forms the fourth light element 207 having the fourth optical characteristics. Thereafter, the optical synthesizing area 220 synthesizes the first light element 202 and the second light element 204 or the third light element 206 and the fourth light element 207 to form the synthesized light 230.

Meanwhile, at least a part between the first optical path 222 and the second optical path 224 is arranged at different spatial locations. At least a part between the third optical path 226 and the fourth optical path 228 is also arranged in different spatial locations. Furthermore, the first optical characteristics of the first light element 202 and the second optical characteristic of the second light element 204 are different from each other. Similarly, the third optical characteristics of the third light element 206 and the fourth optical characteristic of the fourth light element 207 are also different from each other.

Here, as an example of the method for arranging at least a part between the first optical path 222 and the second optical path 224 or at least a part between the third optical path 226 and the fourth optical path 228 in different spatial locations (division method), wavefront division for the initial light 200 can be used. In this wavefront division, the areas 212 to 218 are arranged at different locations on the optical cross section of the incident initial light 200 (the plane obtained by cutting a light flux formed by the initial light 200 along a plane perpendicular to the traveling direction of the initial light 200) or on the wavefront of the initial light 200, and each light element 202 to 207 are individually extracted. In addition, not limited to the wavefront division, the present embodiment may use amplitude division or intensity division to divide the initial light 200 into plural light elements 202 to 207.

Then, in a case where the difference (optical path length) between the optical path length of the first optical path 222 and the optical path length of the second optical path 224 is greater than or equal to the coherence length “ΔL0” (or twice the coherence length “ΔL0”), “phase discontinuity (unsynchronized optical phase characteristic 402)” (optical characteristics different from each other) occurs between the first light element 202 and the second light element 204. Similarly, even when the optical path length difference between the third optical path 226 and the fourth optical path 228 is equal to or larger than the coherence length “ΔL0” (or twice the coherence length “ΔL0”), “phase discontinuity (unsynchronized optical phase characteristic 402)” (optical characteristics different from each other) occurs between the third light element 206 and the fourth light element 207.

And the optical synthesizing area 220 synthesizes each of light elements 202 to 207 to form the synthesized light 220. Here, when each propagation direction of each light element 202 to 207 added the optical path length difference is parallel with each other in the optical synthesizing area 220, the synthesized light 220 decreases its optical coherence to prevent generating the optical interference noise.

According to the present embodiments, all of the optical application fields 100 described in FIG. 2 may includes the optical operation area 240 utilizing the synthesized light 230. For example, as explained in Chapters 2 and 3, the optical operation area 240 may correspond to the three-dimensional projective reverse transformation measuring the three dimensional shape (figure) of the measured object 22. That is, the optical system described in FIG. 40 or FIG. 53 may use the synthesized light 23 as the irradiated light (first light) 13.

The basic operation principle has been described with reference to FIG. 83, and the basic optical arrangement (structure of the optical system) for realizing it has been described with reference to FIG. 84. To summarize this technical content, the initial light 200 emitted by the light emitter 470 is separated into plural light beams 202 to 207, the optical path lengths thereof are changed, and then intensity summation (optical synthesizing) is performed. Preferably, each propagation direction of each optical element 202 to 207 is parallel with each other in case of the intensity summation (optical synthesizing). When the optical path length difference is set to be equal to or more than the coherence length “ΔL0” (preferably twice the coherence length “ΔL0”), the temporal coherence between the divided light beams 202 to 207 decreases.

FIG. 85 (b) illustrates an example of the structure of the optical characteristic converting component 210. Here, the optical arrangement in FIG. 85 (a) coincides with that in FIG. 78 (a) described above. In the optical system in FIG. 85 (a), the optical characteristic converting component 210 is arranged at the position of the parallel light (in the far field area 378) between the two lenses L1 and L2.

In the optical characteristic converting component 210 in FIG. 85 (b), semi-transparent plates having a thickness of “2 mm” and “3 mm” are bonded to each other in a form of being rotated by “90 degrees” to form a pair. Next, each pair is rotated by “45 degrees” and bonded together to complete an optical characteristic converting component that is divided into “8 sections” in the angular direction. Here, the thicknesses of the transparent plates in the “8 divided areas” are different from each other by 1 mm or more.

In the lower left area A in the optical characteristic converting component 210, the thickness of the optical characteristic converting component 210 is “0 mm”. Therefore, the light passing through the “area A” passes without passing through the area where the transparent plate (transparent medium) does not exist in the optical characteristic converting component. Starting from the “area A”, as the light proceeds in a clockwise direction to the “area β”, the “area C”, and subsequent areas, the glass thickness sequentially changes to “2 mm”, “4 mm”, “7 mm”, “10 mm”, “8 mm”, “6 mm”, and “3 mm”.

Light has a characteristic of slowing down when it passes through glass. Therefore, when light passes through the same mechanical distance, the optical distance (optical path length) changes between the vacuum and the glass. Therefore, the optical path length of the light beams after passing through the optical characteristic converting component 210 varies depending on which area it passed through from the “area A” to the “area H”. In the present embodiment, each light beam that has passed through each area is referred to as an “element”. That is, different elements have profiles in which optical distances (optical path lengths) after passing through the optical characteristic converting component 210 are different from each other.

The lens L2 and the optical bundle fiber BF in FIG. 85 (a) constitute the optical synthesizing area 220. That is, by the action of the lens L2 in FIG. 85 (a), all the elements after passing through the optical characteristic converting component 210 are synthesized in the optical bundle fiber BF. Here, in a case where the optical path length difference between the elements is larger than the coherence length “ΔL0” (or larger than twice the coherence length “ΔL0”), plural elements which are in a phase discontinuous/unsynchronized optical phase relation 402 with other (in which the temporal coherence of each other is lowered) are mixed in the optical bundle fiber BF.

BK7 was used as a material of the optical characteristic converting component 210 (glass), and an antireflection coating was formed on an interface (front and back surfaces) where light enters/exists. The refractive index of BK7 is represented by “n”, and the glass thickness in each area in FIG. 85 (b) is represented by “δ”. Then, the optical path length in each area can be calculated by “d (n−1)”, and the glass thickness between the areas in FIG. 85 (b) is different by 1 mm or more. The glass thickness difference between the areas is larger than the coherence length “ΔL0” (or twice the coherence length “ΔL0”).

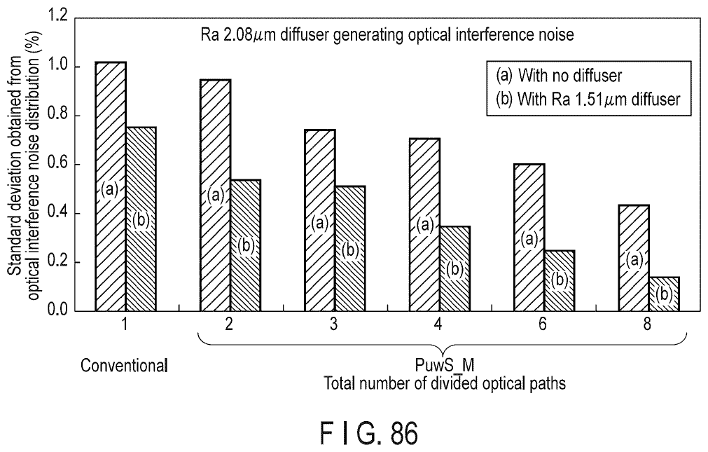

FIG. 86 (a) illustrates experimental data regarding the optical noise reduction effect in the case of using an optical characteristic converting component 210. In the experiment, the optical system in FIG. 85 was used, and a diffuser having an averaged roughness Ra of 2.08 μm was disposed as a sample TS. A difference level in microscopic order on the surface of the diffuser generates optical noise. A spectral intensity profile (measurement wavelength dependency) of a relative intensity ([linearly passing light intensity at the time of disposing the diffuser]=[linearly passing light intensity before disposing the diffuser]) obtained from a spectrometer SM includes the above-described optical noise.

The vertical axis in FIG. 86 represents a standard deviation of a value ([variation amount]=[average value]) obtained by normalizing the variation amount (an intensity difference amount from the spectral intensity average value in a wavelength direction) of a spectral intensity derived from the optical noise generated in the diffuser with the average value. Furthermore, the horizontal axis in FIG. 86 represents a total number of divided optical paths (a total number of derived areas) in the optical characteristic converting component 210. Here, a condition of the “total number of divided optical paths=1” represents a conventional technique before insertion of the optical characteristic converting component 210.

As the total number of divided optical paths (the total number of divided area) increases, an amount of optical noise (standard deviation) obviously decreases. Each element passing through each divided area in the optical characteristic converting component 210 generates optical noise when passing through the diffuser. However, an optical path to reach the spectrometer SM slightly changes for each element. Therefore, the optical noise characteristics appearing in each element slightly change from each other. When the intensities of all the elements having different optical noise characteristics are added, ensemble average effect of intensities 420 (FIG. 83 (d)) is obtained between the different optical noise characteristics. As a result, smoothing of optical noise characteristics (reduction of an amount of optical noise based on averaging) occurs.

FIG. 86 (b) illustrates an effect of reducing an amount of optical noise when a diffuser having the averaged roughness Ra of 1.51 μm is inserted into the light source 2 (between the optical characteristic converting component 210 and the converging lens L2) in FIG. 85 (a). It was confirmed that the optical noise was further reduced by the synergistic effect of the optical characteristic converting component 210 and the diffuser corresponding to an optical phase profile transforming member of a wavefront.

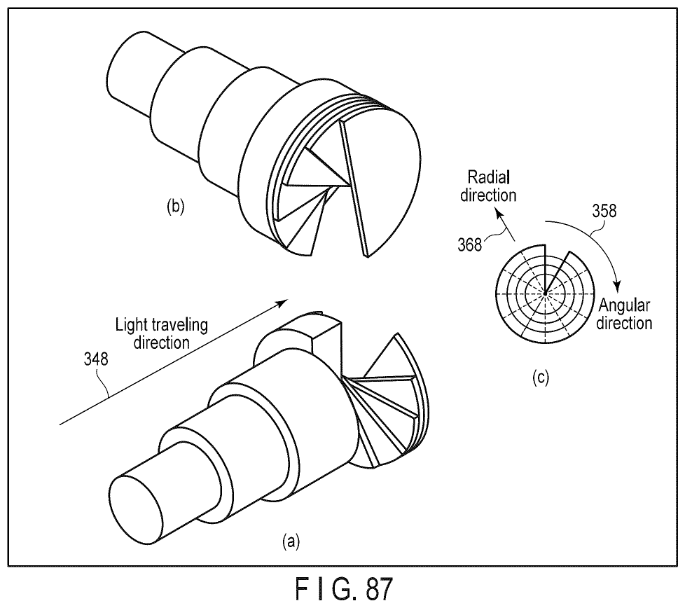

FIG. 87 illustrates another embodiment example related to the embodiment of the structure of the optical characteristic converting component 210. A semicircular glass having a thickness of “1 mm” is rotated by “30 degrees” for bonding, and a semicircular glass having a thickness of “6 mm” is further bonded. Then, when viewed from a light traveling direction 348, “12 divisions” are made at equal intervals in an angular direction 358.

In the present embodiment, the division method of performing wavefront division of a wavefront cross-section of light in the angular direction 358 with respect to the optical axis in the light traveling direction 348 is referred to as “angle division”. Specifically, it means area division (division of a wavefront) by a broken line in FIG. 87 (c). In the embodiment in FIG. 87, 12 equally spaced divisions (12 angular divisions) are made in the angular direction. As a result, a difference in glass thickness of “1 mm” or more occurs between the angularly divided areas.

In FIG. 87, the structure further includes cylindrical glasses having different diameters stacked and bonded together. In the present embodiment, a division method of performing division of a wavefront in a radial direction 368 of the wavefront cross-section of the light with reference to the optical axis in the light traveling direction 348 is referred to as “radius division”. Specifically, it means area division (division of a wavefront) by a solid line in FIG. 87 (c), and area division is performed for each circumference having different radii. In the embodiment of FIG. 87, it is divided into “4 sections” in the radial direction 368 (four radial divisions). In the structure of the optical characteristic converting component 210 illustrated in FIG. 87, it is divided into “12 sections” in the angular direction 358 and into “4 sections” in the radial direction 368. Therefore, the number of divided areas is “48 (12×4)”. Not limited to that, the number of divisions may be arbitrarily set.

In the embodiment illustrated in FIG. 87, the diameter of the boundary line of the radius division is set such that the area of each radially divided area is equal. Not limited to that, the diameter of each cylindrical glass may be set at an arbitrary interval. Further, the dividing method may be changed according to the intensity profile of the light passing (or reflected) through the optical characteristic converting component 210. Here, a case where light having a non-uniform intensity distribution (for example, Gaussian distribution) uses the optical characteristic converting component 210 is considered. This light has high center intensity and may have an intensity distribution in which the intensity of the surroundings decreases. In this case, the boundary diameter of the radius division may be set such that the strength of each element passing through each divided area becomes substantially equal.

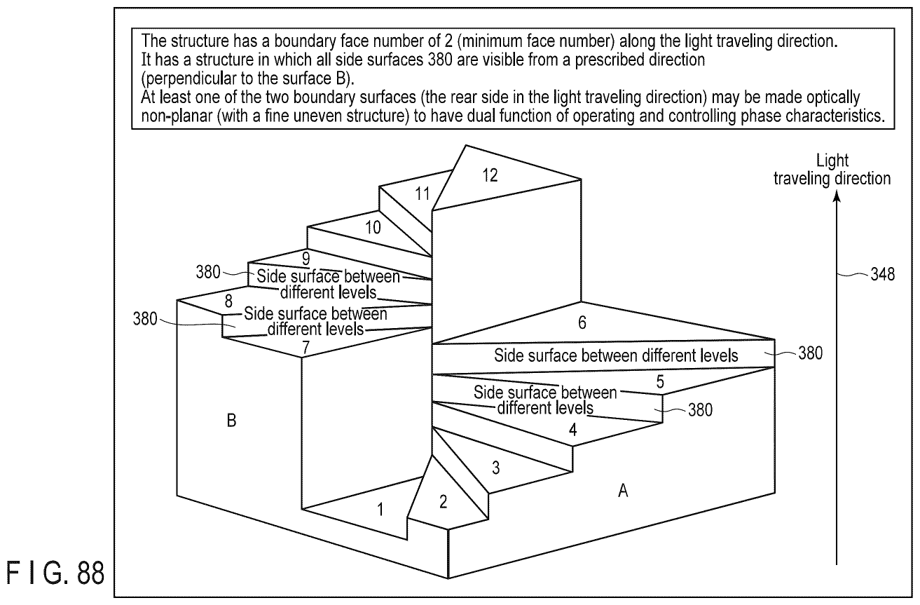

FIG. 88 illustrates an application example related to the structure of the optical characteristic converting component 210. In FIG. 88, as in FIGS. 85 (b) and 87, the component is formed of a transparent medium (transparent glass, quartz glass, transparent plastic, and the like), and the initial light 200 passes through the transparent medium. The structure is then divided into “12 sections” in the angular direction 358 with respect to the cross section of light flux of the initial light 200 that passes through. When viewed in the light traveling direction 348 of the initial light 200, the thickness changes from “1 mm” to “12 mm” in increments of “1 mm”.

In the structure in FIG. 88, the number of boundary surfaces (incident surface and outgoing surface) arranged along the light traveling direction 348 of the initial light 200 passing therethrough is devised so as to be a minimum of “two planes each”. That is, in the structure in FIG. 88, while the initial light 200 passes through the optical characteristic converting component 210, it passes through only one surface as the incident surface and one surface as the outgoing surface.

When the plane accuracy of the boundary surface existing at the interface between the transparent medium area and the air area constituting the optical characteristic converting component 210 is low, the wavefront accuracy of the light after passing through the boundary surface is deteriorated. Therefore, when the number of boundary surfaces is set to the minimum number of planes, deterioration in wavefront accuracy of light after passing through the optical characteristic converting component 210 can be reduced.

Furthermore, in the structure in FIG. 88, the side surface 380 between different levels between the respective areas in the optical characteristic converting component 210 (that is, the side surface of the boundary line where the thickness changes in the optical characteristic converting component 210) is visible from the specific direction (direction perpendicular to the surface B). With this structure, the manufacturability of the optical characteristic converting component 210 is improved, and the cost of the optical characteristic converting component 210 can be reduced.

Although FIG. 88 illustrates the structure of the optical characteristic converting component 210, which may also serve the function of operating/controlling the phase profile (wavefront profile) of the light after passing through the optical characteristic converting component 210. That is, at least one of the boundary surfaces (the incident surface and the outgoing surface) arranged in the direction perpendicular to the light traveling direction 348 of the initial light 200 is not formed into an optical plane but has a fine uneven structure.

Examples of this fine uneven structure include the structure of a diffuser (optical phase profile transforming component) 460 and a grating/hologram structure. As a result, the boundary surface (incident surface or outgoing surface) has a function of operating/controlling the phase profile (wavefront profile). As a result, a single optical component can combine the division of the initial light 200 (generation of optical path length difference) and the operation (control) of the phase profile (wavefront profile), so that the optical noise reduction effect and the coherence reduction effect are improved. Furthermore, simplification and cost reduction of the entire optical system can be achieved. Note that the combination of the division of the initial light 200 (generation of optical path length difference) and operation (control) of the phase profile (wavefront profile) is not limited to the structure in FIG. 88, and may be performed in the structures in FIGS. 85 (b), 87, and 89.

By the way, when parallel light traveling in the same direction passes through the optical characteristic converting component 210, it is possible to efficiently divide the initial light 200 and generate an optical path length difference between divided light beams (elements). Therefore, the optical characteristic converting component 210 having the structure of FIGS. 85 (b) to 89 is arranged in the far-field area 378 with respect to the light emitting area of the light emitter 470.

On the other hand, light immediately after passing through a boundary surface (incident surface or outgoing surface) having a fine uneven structure becomes diffused light, and the traveling direction tends to spread (that is, when the parallel light passes through the boundary surface (incident surface or outgoing plane) having a fine uneven structure, the parallel light easily changes to divergent light). Therefore, it is desirable to provide a fine uneven structure on the surface of the boundary surface (outgoing surface) located on the rear side in the light traveling direction 348 among the boundary surfaces existing on the two surfaces in the optical characteristic converting component 210.

As an effective range of the size of the irregularity structure in the case of providing the boundary surface with a fine irregularity structure as described above, a value of “50 nm or more and 8 mm or less” can be defined as a setting range of the maximum amplitude value of the different levels. On the other hand, when expressed by the average value “Ra” of the surface roughness, when “50 nm≤Ra≤8 mm” (desirably “13 nm≤Ra≤2 mm”) can be achieved, the effect of reducing the optical interference noise can be achieved.

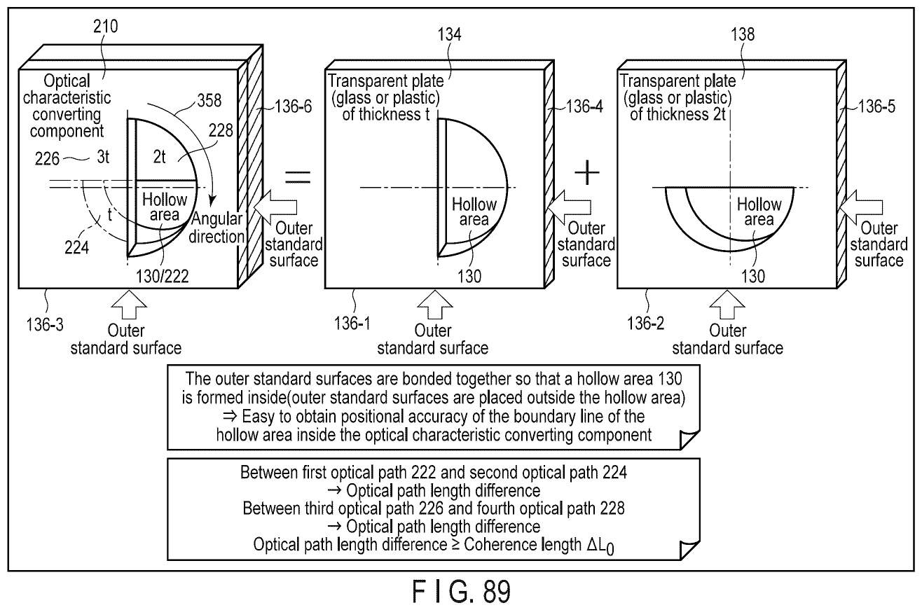

FIG. 89 illustrates a further application example related to the embodiment example of the optical characteristic converting component 210. In the embodiment example of FIGS. 85 (b) and 87, a transparent medium (transparent glass, quartz glass, transparent plastic, and the like) forms a part of the optical path of the light (such as the initial light 200) that converts the optical characteristics. Then, there is no transparent medium at a place away to the outside of the optical path. On the contrary, in the embodiment example illustrated in FIG. 89, a hollow area 130 is provided inside the optical characteristic converting component 210.

In the hollow area 130, there is no transparent medium, and the transparent medium is in a hollow state (empty state). Light (such as the initial light 200) also passes through the hollow area 130. Further, the optical characteristic converting component 210 made of a transparent medium is also present at a place away to the outside of the optical path. As the transparent medium, any material such as glass, quartz glass, or transparent plastic may be used.

In the optical characteristic converting component 210 illustrated on the left side of FIG. 89, as in FIG. 88, the total number of boundary surfaces (incident surface and outgoing surface) between the hollow area and the transparent medium area along the light traveling direction 348 is “2”. That is, only one incident surface and one outgoing surface are provided along the light traveling direction 348. Therefore, the wavefront accuracy of the passing light derived from the flatness of the boundary surface is prevented from being lowered.

In the embodiment example of the optical characteristic converting component 210 illustrated in FIG. 89, the outer standard surface 136 is provided outside the hollow area 130 (a part of the optical characteristic converting component 210). Then, assembly and bonding are performed with reference to the outer standard surface 136 (by aligning the outer standard surfaces 136 with each other). Here, the light to be subjected to the optical characteristic conversion (such as the initial light 200) passes through the inside of the hollow area 130. An outer standard surface 136 is formed outside the optical path of the passing light (such as the initial light 200).

A method of producing the optical characteristic converting component 210 illustrated in FIG. 89 will be described in comparison with the embodiment example in FIG. 85 (b). In FIG. 85 (b), semicircular transparent flat plates (transparent media) having thicknesses of “2 mm” and “3 mm” are combined to form the optical characteristic converting component 210. In comparison, here, a transparent flat plate (transparent medium) 134 having a semicircular hollow area 130 inside and having a thickness of “t” and a transparent flat plate (transparent medium) 138 having a thickness of “2t” are prepared. The semicircular shape between FIGS. 85 (b) and 89 has a negative and positive relationship. Note that, for ease of description in comparison with FIG. 85 (b), the shape of the hollow area 130 is merely a semicircular shape. Therefore, the shape of the hollow area 130 may be arbitrarily set.

In FIG. 85 (b), two semicircular transparent flat plates are bonded in an area having a total thickness of “5 mm”. On the other hand, in FIG. 89, the entire surfaces of two transparent flat plates 134 and 138 except for the hollow area 130 are bonded. When the bonding area is narrow, the inclination amount between the two semicircular transparent flat plates after bonding tends to be large. In comparison, when the two transparent flat plates 134 and 138 are bonded to each other over the entire surface, the bonding area increases, so that the effect of reducing the inclination amount between the two transparent flat plates 134 and 138 after bonding is created.

In addition, at the time of bonding in FIG. 85 (b), accuracy of angle and position in a linear portion in a semicircle is increased using a special jig. In contrast, here, the lower outer standard surfaces 136-1 and 136-2 are aligned with each other on the outer standard surface 136-3 after bonding. Further, the right outer standard surfaces 136-4 and 136-5 are aligned with each other on the outer standard surface 136-6 after bonding.

When this method is used, the jig used at the time of bonding can be simplified, and high positional accuracy and high angular accuracy of the boundary straight line (between the transparent medium and air) in each hollow area 130 can be easily obtained. Further, since the outer standard surface 136 is formed outside the optical path of the light whose optical characteristics are to be converted (such as the initial light 200), there is also an effect that the shape of the outer standard surface 136 can be arbitrarily set.

After bonding the two transparent flat plates (transparent media) 134 and 138, the thickness of the transparent medium in the optical path of the light (such as the initial light 200) is a hollow area 130, “t”, “3t”, and “2t” for each area along the angular direction 358. The optical characteristic converting component 210 formed here takes a form of being angularly divided into four areas along the angular direction 358.

Then, it is considered that the hollow area 130 in the optical characteristic converting component 210 corresponds to the first area 212 and forms the first optical path 222 within this area 212. Then, it is considered that the area where the thickness of the transparent medium is “t” corresponds to the second area 214 and forms the second optical path 224 within this area 214. Similarly, it is considered that the third area 218 corresponding to the area of “3t” thickness of the transparent medium forms the third optical path 226 and the fourth area 218 corresponding to the area of “2t” thickness of the transparent medium forms the fourth optical path 228.

The refractive index of the transparent medium constituting the optical characteristic converting component 210 is “n”. The optical path length in the air at the thickness “t” is “t”, whereas the optical path length in the transparent medium increases to “nt”. Therefore, an optical path length difference of “(n−1)t” occurs between the light passing through the air (in the hollow area 130) and the light passing through the transparent medium. When this value is set to be equal to or larger than the coherence length “ΔL0” (desirably twice the coherence length “ΔL0”), the temporal coherence between the elements (the first to fourth light 202 to 207) passing through the different areas 212 to 218 decreases. Thereafter, when the intensity is summated between the elements (the first to fourth light 202 to 207), the optical interference noise generated for respective elements (the first to fourth light 202 to 207) is averaged 420, and the amount of optical interference noise is smoothed or reduced.

If the optical path length difference between the optical paths 222 to 228 satisfies the above condition, the unit “t” of the thickness difference can be set to an arbitrary value. However, it is preferable to set the value of “t” to “100 m” or less (desirably “1 m” or less or “1 cm” or less) due to the restriction of the dimensions of the optical system on which the optical characteristic converting component 210 is mounted. This upper limit value means that the minimum unit of the optical path length difference is set to “50 m” or less (desirably “50 cm” or less or “5 mm” or less).

As described above, when the hollow area 130 is provided inside as an embodiment example of the optical characteristic converting component 210, an effect of improving manufacturability at the time of creation and position accuracy and angle accuracy of a boundary straight line is created. Furthermore, when a standard surface 136 is set on a part (outer side) of the optical characteristic converting component 210, manufacturability at the time of creation and position accuracy and angle accuracy of the boundary straight line are further improved.

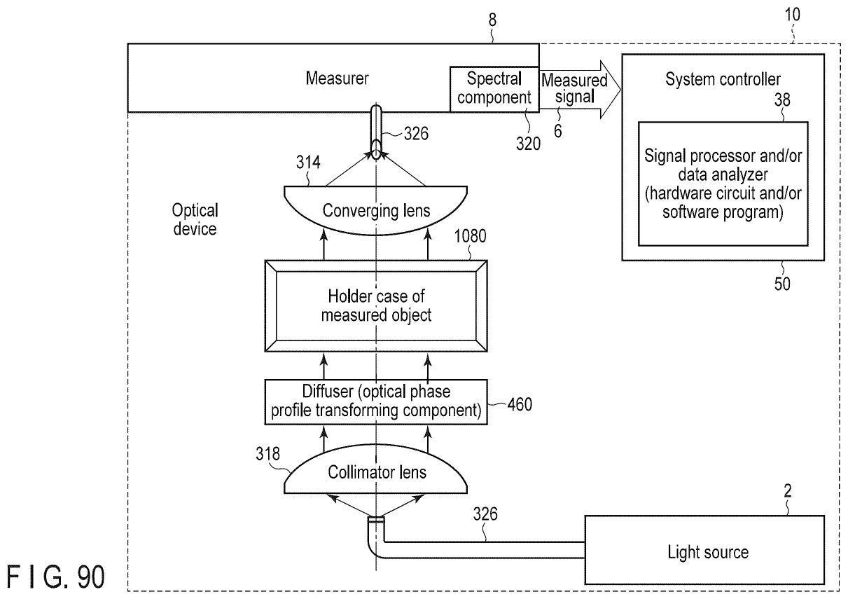

FIG. 90 illustrates an embodiment example of the system outline described in FIG. 1A. The irradiated light (first light beam) 13 generated in the light source 2 propagates along the inside of the optical fiber 326. The collimator lens converts the irradiated light (first light beam) 13 in the divergent light state emitted from the outlet of the optical fiber 326 into parallel light. The detection light (second light beam) 19 after passing through the diffuser (optical phase profile transforming component) 460 and a holder case 1080 of the measured object is converged on the incident surface of the optical fiber 326 by the converging lens 314.

Then, the detection light (second light beam) 19 propagates through the optical fiber 326 and enters the measurer 8. The measured signal 5 is generated by the function of a spectral component 320 installed in the measurer 8, and is subjected to signal processing or data analysis by a signal processor and/or data analyzer of the system controller. In FIG. 90, the entirety including all the components described above is installed in the optical device 10. However, the present invention is not limited thereto, and a part of the above-described components may be installed in the optical device 10 and the entirety of FIG. 90 may constitute the system.

In the light source 2, emitting light emitted from the same light emitter 470 is divided into a plurality of elements (first to fourth light elements 202 to 207), and temporal coherence between different elements (first to fourth light elements 202 to 207) is reduced. At the time of measuring the spectral profile of the detection light (second light beam) 19, the diffuser (optical phase profile transforming component) 460 may be arranged in the middle of the optical path of the irradiated light (first light beam) 13 to lower the spatial coherence in the same element (first to fourth light elements 202 to 207).

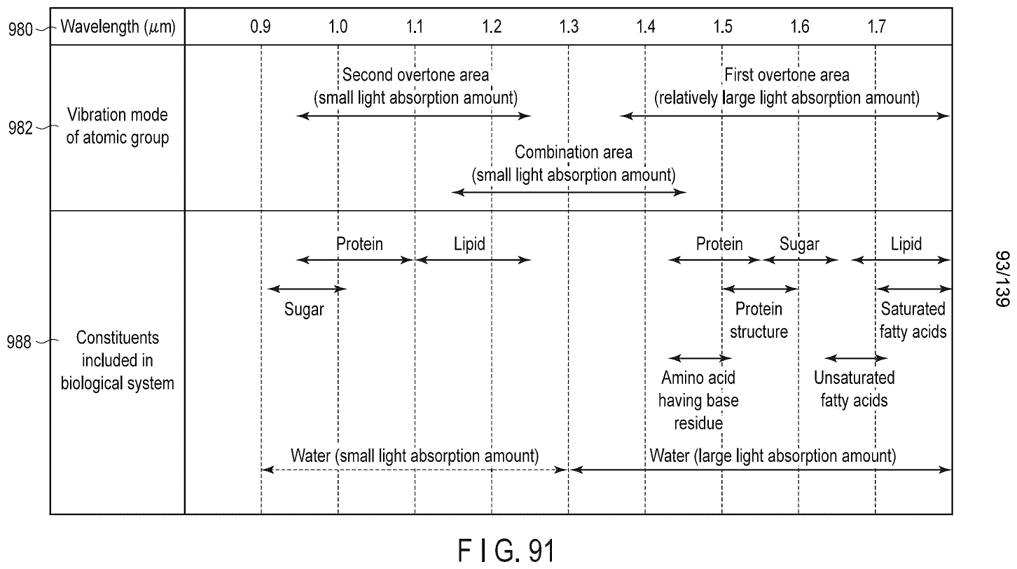

As illustrated in FIG. 91, a wavelength range of “1.35 μm” to “1.80” μm is called a first overtone area, and has a relatively large light absorption amount. Within this wavelength range, protein, sugar, and lipid absorb light relatively large in this order from the short wavelength side. Within a wavelength range mainly absorbed by the lipid, an absorption wavelength value of saturated fatty acids is larger than an absorption wavelength value of unsaturated fatty acids.

In addition, in a wavelength range mainly absorbed by the protein, amino acid having base residue (amino acid containing lysine residues, histidine residues, and arginine residues) absorbs light in a wavelength range of “1.45 μm” to “1.53 μm”. In addition, a peptide bond portion in the protein or a secondary structure of a protein called x-helix or B-sheet appears in an absorption band within a wavelength range of “1.48 μm” to “1.57 μm”.

A wavelength range of “0.90 μm” to “1.25 μm” is called a second overtone area, and the light absorption amount is relatively small. The absorption wavelengths of the respective constituents 988 included in the biological system within this wavelength range are arranged in the order of sugar, protein, and lipid from the short wavelength side.

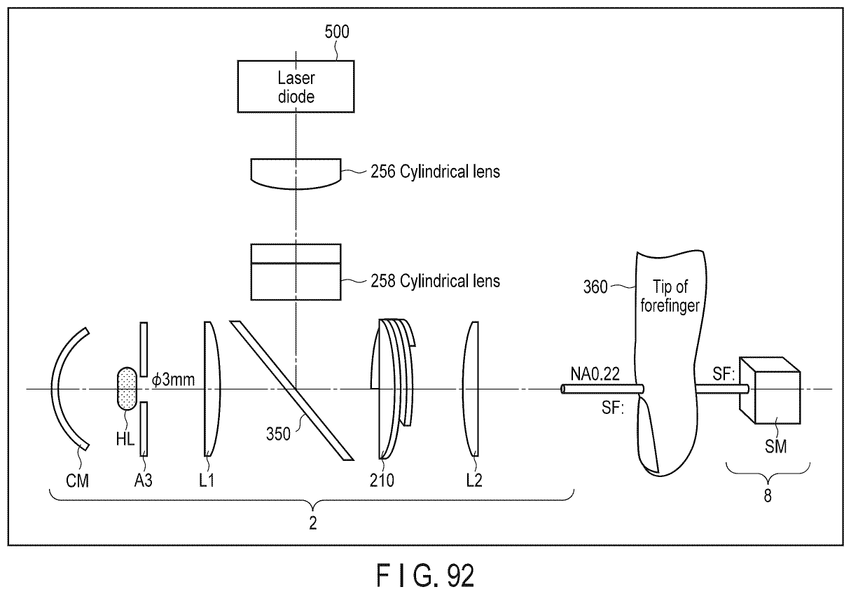

FIG. 92 illustrates the entire measurement system (or the inside of the optical device 10) including the optical arrangement in the light source 2 used for measurement, the measured object 22, and the measurer 8. A laser optical system was synthesized with the optical system described with reference to FIG. 85 using a dichroic mirror 350. Here, α point emission type single mode laser having an emission wavelength of “1330 nm” was used for the laser diode 500.

A cylindrical lens effective against major axis 256 and a cylindrical lens effective against minor axis 258 were used for elliptical correction of the emitting light cross section of the laser diode 500. In addition, since the optical characteristic converting component 210 divided by eight angles is arranged in the middle of the optical path of the laser optical system, the optical interference noise generated in the laser light also reduces.

An SI-type multimode single fiber SF having a core diameter of “0.6 mm” guides the synthesized light to a tip of forefinger 360. Another SI-type multimode single fiber SF having a core diameter of “0.6 mm” guides light (scattered light in the tip of forefinger 360) having passing through the tip of forefinger 360 to a spectrometer SM in the measurer 8. As described above, the tip of forefinger 360 is sandwiched between the two SI-type multimode single core fibers SF in a detachable manner. In this way, measurement was performed in a non-invasive manner.

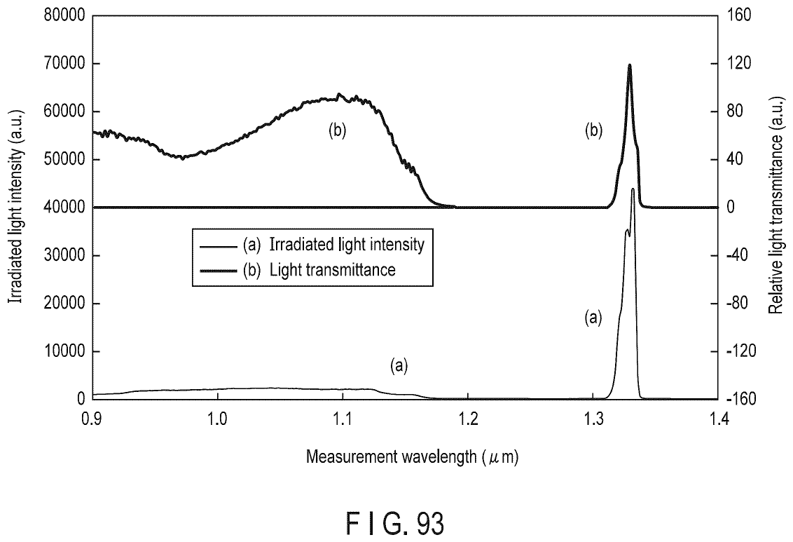

FIG. 93 (a) illustrates a spectral profile of the irradiated light (first light beam) 13 to the tip of forefinger 360. The emitted light intensity 338 of laser light at an emission wavelength (“1330 nm”) is predominantly large. The pulsation of the blood flow flowing through the artery in the tip of forefinger 360 is detected using the laser light having the large emitted light intensity 338. Note that the dichroic mirror 350 shields long-wavelength lights emitted from a halogen lamp HL.

FIG. 93 (b) illustrates a spectral profile of the light transmittance of the transmitted light (light emitted from the opposite side of the tip of forefinger 360 after repeated light scattering inside the tip of forefinger 360) transmitted through the tip of forefinger 360 corresponding to the detection light (second light beam) 19 obtained from the measured object 22. The spectral profile of the light transmittance indicates the spectral profile after the spectral profile of the transmitted light transmitted through the tip of forefinger 360 is normalized (divided) by the spectral profile of the irradiated light (first light beam) 13.

The pulsation of the blood flow accounts for a periodical variation of the blood amount in the tip of forefinger 360. Here, the laser light transmittance having the wavelength “1330 nm” slightly reduces when the blood amount increases. Therefore, an experiment with the optical system described in FIG. 92 used the periodical time-dependent variation of light transmittance regarding wavelength “1330 nm” as a reference signal “R(t)”. And the optical experiment achieved “Lock-in operation” to obtain a spectral profile of light absorption rate in the blood when the optical experiment used the periodical time-dependent variation of light transmittance of each wavelength light as a measured signal “Swl(t)”.

The optical experiment used Formula 25 as the “Lock-in operation”. Here, the optical experiment achieved integration along time “t” though Formula 25 uses the phase value for integration. Moreover, the optical experiment used only one reference signal “R(t)” and plural measured signals “Swl(t)” based on different measured wavelengths though Formula 25 uses only one measured signal and plural reference signals having different phase values.

One optical experiment continued during “16 seconds”. Both of the reference signal and the measured signals comprise plural measured points regarding the periodical time-dependent variation of light transmittance. A time interval between two measured neighbor points was “0.1 second”. The “Lock-in operation” beforehand eliminated each of direct current components from both of the reference signal and the measured signals. The direct current component corresponded to an average value of 11 measured points since the experimental subject had approximate “1 second” of the pulsation cycle of the blood flow.

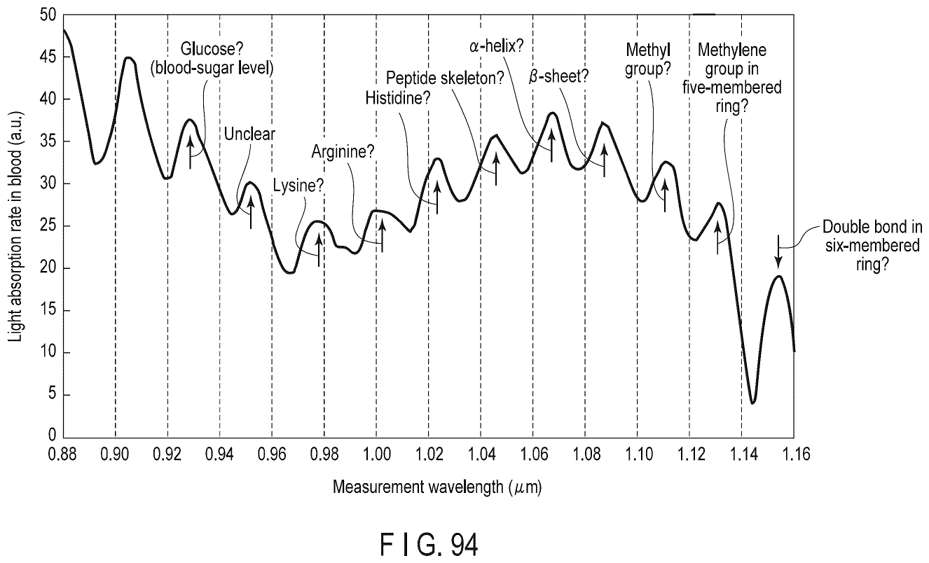

FIG. 94 shows an experimental result obtained from the optical experimental system described in FIG. 92. A horizontal axis in FIG. 94 indicates a measured wavelength value. In addition, a vertical axis in FIG. 94 represents a light absorption rate in the blood at the linear scale. Here, as the vertical axis value increases, the light absorption amount increases. The waveform in FIG. 94 has an uneven shape in the measurement wavelength direction, and each peak corresponds to the center wavelength for each individual absorption band. It can be seen that the constituents 988 in the blood are wavelength-separated as absorption bands different from each other.

It is expected that an absorption band assigned to amino acid having base residue appears within a measurement wavelength range of “0.97 μm” to “1.03 μm”. Here, the center wavelength of the absorption band decreases in the descending order of the number of hydrogen atoms bonded to the nitrogen atom present at the center in the atomic group. That is, the number of hydrogen atoms bonded to the nitrogen atom is “3” for lysine, “2” for arginine, and “1” for histidine. In addition, during the in vivo reaction (chemical reaction between biological substances), the amino acid having base residue and an anion such as a γ-phosphate group may be hydrogen-bonded. At this time, the center wavelength value of the absorption band shifts to the long wavelength side. Therefore, when the center wavelength change (shift to the long wavelength side) of the absorption band assigned to the amino acid having base residue is observed, the in vivo reaction can be analyzed.

Similarly to the case where the center atom is the nitrogen atom, the center wavelength of the absorption band decreases in the descending order of the number of hydrogen atoms bonded to the carbon atom present at the center in the atomic group. An atomic group having three hydrogen atoms bonded to a nitrogen atom is referred to as a methyl group, and an atomic group having two hydrogen atoms is referred to as a methylene group. In FIG. 94, the center wavelength of the absorption band assigned to the methyl group appears in the vicinity of a measurement wavelength of “1.11 μm”. Although not illustrated, other experimental results show that the center wavelength of the absorption band assigned to the methylene group appears in the vicinity of a measurement wavelength of “1.20 μm”.

In addition, it is expected that a secondary structure of protein is observed within a measurement wavelength range of “1.03 μm” to “1.10 μm”. In the secondary structure of the protein, a hydrogen bond occurs between a “hydrogen atom bonded to a nitrogen atom” and an “oxygen atom double-bonded to a carbon atom”. A peptide skeleton portion in which this hydrogen bond does not occur has the shortest center wavelength of the absorption band. On the other hand, the hydrogen bond distance between the hydrogen atom and the oxygen atom becomes shorter as the B-sheet structure is taken from the x-helix structure as the secondary structure. As a result, the center wavelength of the absorption band becomes longer as the B-sheet structure is taken from the x-helix structure.

As described above, the absorbance profiles within the measurement wavelength range of “0.97 μm” to “1.10 μm” may be measured to identify the amino acid having base residue and the protein structure in the measured object 22 or observe the biological reactions. For reference, as illustrated in FIG. 91, in the measurement wavelength range of “1.45 μm” to “1.58 μm”, an absorption band related to the amino acid having base residue and the protein structure in the first overtone area is observed. Therefore, identification of the amino acid having base residue and the protein structure or observation of the biological reactions may be performed using the absorbance profiles observed within the wavelength range.

An absorption band based on atomic group vibration in which a carbon atom is arranged at the center is observed in a wavelength range of “1.1 μm” to “1.25 μm” in the second overtone area and in a wavelength range of “1.65 μm” to “1.8 μm” in the first overtone area. The center wavelength of the absorption band assigned to the methyl group appears in the vicinity of “1.11 μm” in the second overtone area and in the vicinity of “1.63 μm” in the first overtone area. For reference, the center wavelength of the absorption band in the first overtone area assigned to the methylene group appears in the vicinity of “1.72 μm”.

In the absorbance value of the absorption band within the range of “0.97 μm” to “1.12 μm” assigned to the atomic group described above, individual differences and time variations among users are relatively small. In comparison with this, a blood-sugar level corresponding to the content of glucose contained in the blood has large individual differences and time variations. In addition, the content of cortisol in the blood also changes according to the stress state of the user.

Therefore, the individual difference or the temporal change amount of the difference value up to the maximum value of the absorption band related to glucose or cortisol may be measured with reference to the absorbance profile (or the upper envelope of absorbance) in the wavelength range (for example, a linear change area including a range of “0.94 μm” to “1.12 μm”, desirably a range of “0.96 μm” to “1.10 μm”, or a range of “0.98 μm” to “1.07 μm”) corresponding to the in vivo constituent 988 having relatively small individual difference or temporal variation among users. As a result, the individual difference of the blood-sugar level and the temporal change of the user stress may be measured to provide a service for the user.

As a form of service provision to the user, insulin administration may be urged to a user or a doctor in charge when the blood-sugar level abnormally increases, or a food providing service for a hungry user, a decrease in the intensity of illumination light for a high-stress user, or provision of music for calming the mind may be performed.

During the experiment related to FIG. 94, the temporal change of the light absorption amount was observed in the vicinity of “1.13 μm” and the vicinity of “1.15 μm”. It is estimated that the center wavelength of the absorption band assigned to a methylene group in a five-membered ring contained in cortisol appears in the vicinity of “1.13 μm”. In addition, it is estimated that a vibration mode of the hydrogen atom bonded to a double bond carbon atom in a six-membered ring contained in cortisol appears in the vicinity of “1.15 μm”.

Therefore, there is a possibility that the cortisol content in the blood can be predicted by measuring the temporal change of the light absorption amount (or the upper envelope of absorbance) in the wavelength range of “1.10 μm” to “1.20 μm” with reference to the light absorption amount in the wavelength range corresponding to the in-vivo constituent 988 having relatively small individual differences and temporal variation among users. As a result, a stress state (or an excitement state or a concentration state) of the user in real time may be estimated, and an appropriate service may be provided.

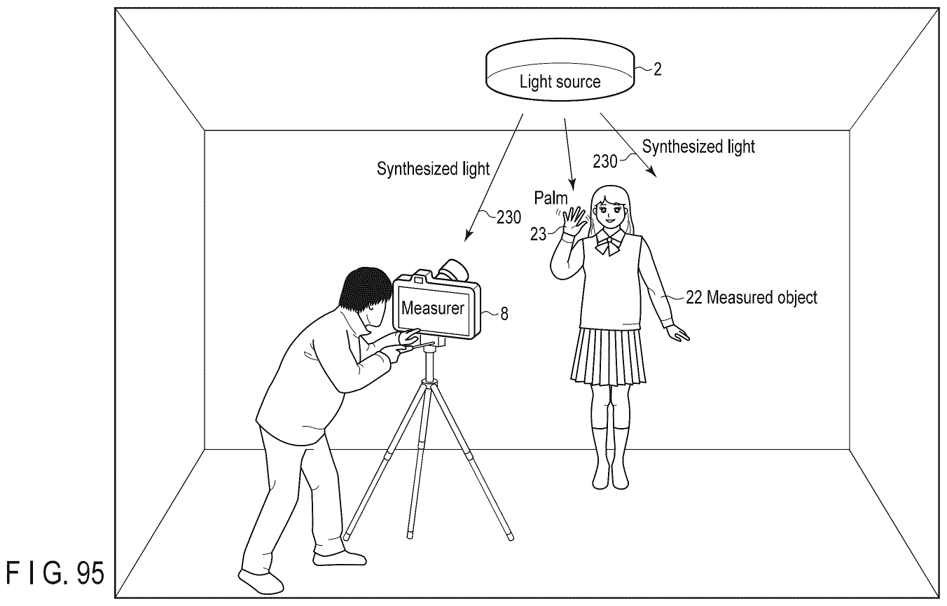

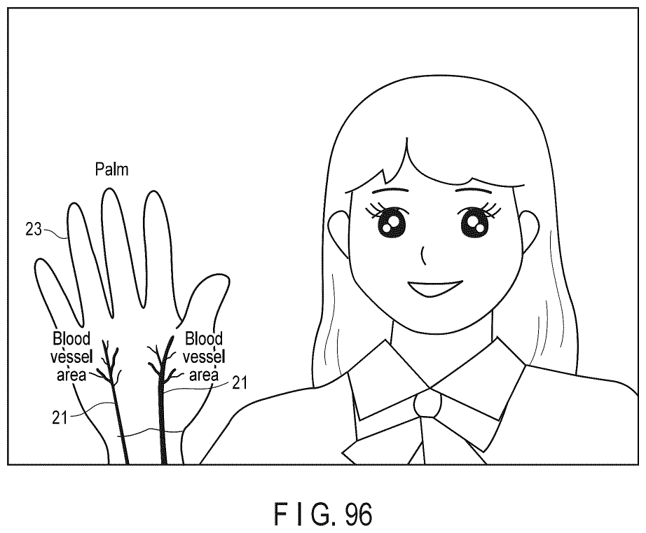

FIGS. 95 and 96 illustrate examples of usage in a case where near infrared light is used for the input device 1060 (as shown later in FIG. 129). FIG. 95 illustrates an example of a usage environment of the input device 1060 using near infrared light. The synthesized light 230 emitted from the light source 2 includes near infrared light. The measurer 8 measures reflected light from the measured object 22.

FIG. 96 is an enlarged view of the usage environment example illustrated in FIG. 95. As illustrated in FIG. 91, the moisture in the living body largely absorbs the wavelength light exceeding “1.3 μm”. Therefore, when the palm 23 is irradiated with the wavelength light exceeding “1.3 μm”, the blood vessel area 21 is easily observed. There is an individual difference in the pattern of the blood vessel area 21, and thus the difference in the pattern of the blood vessel area 21 can be used for personal authentication.

FIG. 97 illustrates a part of a cross-sectional structure example of the VCSEL 128. In the VCSEL 128 structure example illustrated in FIG. 97, the emitting light 462 pass through the light passing window 490 and out. Since FIG. 97 is an excerpt of a part of the overall structure, only two light passing windows 490 are illustrated. However, in many cases, plural light passing windows 490 are regularly arranged in the two-dimensional direction (in a matrix).

In many cases, the diameter of one “light passing window” 490 is less than “30 μm” (“300 μm” or less at the maximum). Therefore, the emitting light 462 having passed through one “light passing window” 490 can be regarded approximately as the emitting light 462 emitted from one “light emission point”. Since the VCSEL 128 structure example illustrated in FIG. 97 includes plural light passing windows 490, the light emitter 470 having the structure in FIG. 97 may be interpreted as a “multipoint light emitter” when viewed microscopically.

In FIG. 97, the top-sided electrode 496 surrounds the outer peripheral portion of the “light passing window” 490. In addition, a bottom sided electrode 498 exists at the bottom of a common substrate 494 and a current flows between the bottom sided electrode 498 and the top sided electrode 496. Then, a current constricting layer 484 efficiently controls the flow of the current passing through the inside of the VCSEL 128 (light emitter 470). That is, since the current does not flow inside the current constricting layer 484, the current intensively flows through the gap between the current constricting layers 484.

When the concentrated current passes through the active area 480, the active area 480 emits laser light. The active area 480 basically has the same composition and the same structure as those of the peripheral light emitting layer 482. That is, in the same light emitting layer 482, the portion where a concentrated current passes and emits laser light serves as the active area 480. When the light emitting layer 482 has a quantum well structure, a multipoint light emitter having a small threshold current value for laser emission and high light emission efficiency can be formed.

Inside the VCSEL 128 illustrated in FIG. 97, similarly to an existing gas laser or the like, “stimulated emission” and “light resonance based on light reflection” occur. The laser light generated in the active area 480 is repeatedly reflected between a top-sided distributed Bragg reflector (DBR) 486 and a bottom sided distributed Bragg reflector (DBR) 488. Here, it is said that the light reflectance of each of the DBRS 486 and 488 needs to be “99%” or more. In order to ensure this high light reflectance, the inside of each of the DBRS 486 and 488 has a multilayer film structure. Specifically, two types of different refractive index materials are alternately stacked to form a multilayer film structure. The thickness of each refractive index material at this time is devised so as to generate an optical path length difference of “1/4” (“λ0/4”) of the central wavelength “λ0” of the emitting light beams (laser light) 462.

In the example VCSEL 128 structure illustrated in FIG. 97, it is expected that a stimulated emission phenomenon can occur between adjacent active areas 480. For example, a case is considered in which the laser light emission current simultaneously flows through the left and right top-sided electrodes 496. Here, it is assumed that only the active area 480 on the right side of FIG. 97 emits emitting light beams (laser light) first. A part of the emitting light beams is transmitted through the light emitting layer 482 to reach the left active area 480. Then, the light transmitted through the light emitting layer 482 serves as stimulation light 464 toward neighbor active areas.

Similarly, a part of the emitting light beams emitted by the active area 480 on the right side is reflected in the bottom sided DBR 488 to reach the active area 480 on the left side. Then, a part of the emitting light beams reflected in the bottom sided DBR 488 acts as stimulation light 466 toward neighbor active areas.

As a result, the stimulation light 464 or 466 toward neighbor active areas acts on the left active area 480 to guide emission of emitting light beams (laser light) from the left active area 480. Thereafter, as a result of mutual influence of the emitted light from the left and right active areas 480, phases of the beams of the emitting light 462 emitted from the left and right “light passing windows” 490 may coincide (optical phase synchronizing).

The VCSEL light is generated by electron orbital transition (or electron-hole coupling) of carriers in the active area 480. VCSEL light emission is often controlled by pulse driving due to the influence of thermal saturation characteristics (decrease in light emission efficiency at high temperature). When a technique of incorporating a current drive circuit in the VCSEL 128 component (light emitter 470) is used, the rising/falling period of light emission can be shortened to about “1 nS”. In this order of macroscopic time range, it appears possible to continuously emit the emitting light 462 according to the continuous drive current (within one pulse) to the active area 480.

The above-described light emission control within one pulse is examined in a microscopic time range corresponding to the order of the coherence time “Δt=ΔL0/c”. Prior to emitting the emitting light 462, there are no carriers within the active area 480. When the rising of the pulse drive current starts and a prescribed amount or more of carriers are accumulated in the active area 480, laser light is generated in one active area 480. When the stimulation light 464 reaches the peripheral active area 480, there is a possibility that the beams of the emitting light 462 are simultaneously emitted from the plural active areas 480.

A certain number of carriers are continuously supplied into the active area 480. However, in a case where the carrier supply does not catch up with the generation of the emitting light beams 402 in a microscopic time range, the laser light generation amount in the active area 480 can decrease. When the accumulated carriers in the active area 480 increase due to the decrease in the laser light generation amount in the active area 480, it is assumed that the increase in the emitting light 462 is repeated again by the stimulated emission phenomenon. This repetition of the increase and decrease of the emitting light 462 may contribute to the Wave Train profile in FIG. 77 (f).

For example, a case where a wavelength width “Δλ” of VCSEL 128 having a central wavelength “λ0” of “0.85 μm” (wavelength width/spectral bandwidth) is “2 nm” is considered. The value of the coherence length “ΔL0” in this case is “0.36 mm” from Equation 36. Therefore, the coherence time “Δτ” is “1.2 picoseconds”. Incidentally, the photon life of a semiconductor laser is generally said to be on the order of about “1 picosecond”. Therefore, the coherence time “Δτ” corresponds to the photon lifetime.

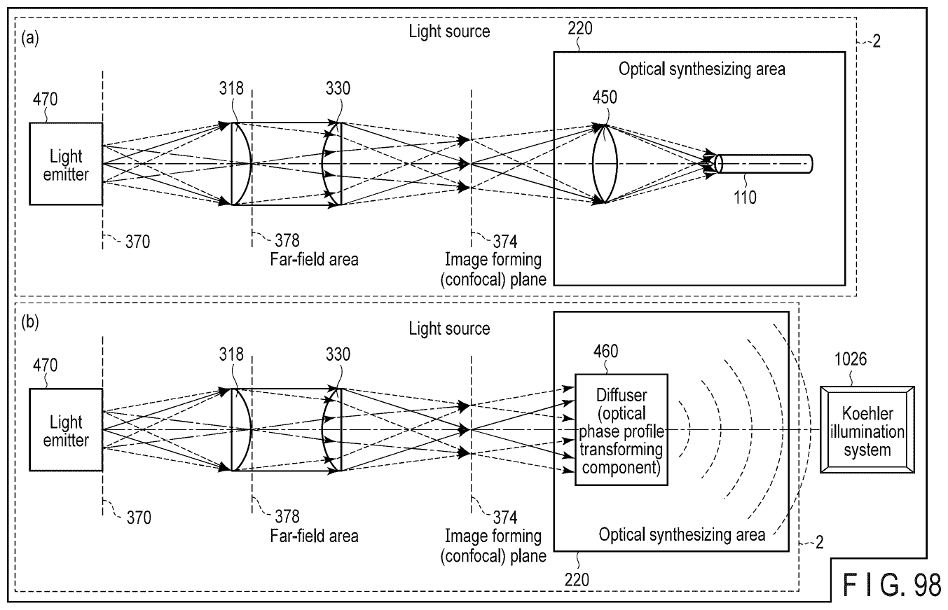

FIG. 98 illustrates a specific form example of the optical system from the light emitter 470 to the optical synthesizing area 220 in the light source 2. In FIG. 98 (a), as a specific embodiment example in the optical synthesizing area 220, light beams having different optical characteristics are synthesized (intensity summation) in the optical wave guide (optical fiber or optical waveguide, optical guide, etc.) 110. In this case, the first light element 202 and the second light element 204, or the third light element 206 and the fourth light element 207 are simultaneously converged inside the optical wave guide (optical fiber or optical waveguide, optical guide, etc.) 110 by the image forming lens 450. Although not illustrated in FIG. 98 (a), the measured object 22 may be irradiated with light emitted from the optical wave guide 110 by a Koehler illumination system 1026.

In FIG. 98 (b), the diffuser plate (optical phase profile transforming component) 460 is used as another embodiment example (another method of optical synthesizing 410) in the optical synthesizing area 220. The light having passed through or surface-reflected by the diffuser (optical phase profile transforming component) 460 is diffused and travels in a wide angular direction. Using the light traveling at this wide angle, light beams having different optical characteristics are synthesized (intensity summation). In this case, the first light element 202 and the second light element 204, or the third light element 206 and the fourth light element 207 simultaneously pass through the diffuser (optical phase profile transforming component) 460. The synthesized light 230 generated by the synthesizing (intensity summation) is used in Koehler illumination system 1026.

When light having different optical characteristics is diffusely emitted at a wide divergence angle on the light emitting plane 370 on the light emitter, the image forming plane 374 of the light emitter, or the far-field area 378 with respect to the light emitter, some light beams having different optical characteristics from each other spatially overlap in the middle of diffuse emission. Therefore, as another embodiment example of the optical synthesizing area 220, the above diffuser (optical phase profile transforming component) 460 may not be used, but light beams having different optical characteristics from each other may be synthesized (intensity summation) using the spatial overlap between diffused emitting light beams.

The area immediately behind a spatially wide light emitting area (light emitting plane 370 on the light emitter) in the light emitter 470 and the area in the near field thereof are referred to as a near-field area 372 with respect to the light emitting area. In the embodiment example of the optical system illustrated in FIG. 98, the combination of a collimator lens 318 and the converging lens 330 constitutes an imaging optical system with respect to the light emitting plane 370 on the light emitter (the light emitting area of the light emitter 470). The image forming plane 374 of the light emitter and its near field also correspond to the near-field area 372 with respect to the light emitting area.

The emitting light beams from an arbitrary light emission point in the light emitting plane 370 on the light emitter (light emitting area of the light emitter 470) become parallel light immediately after passing through a collimator lens 318. The area immediately after the light has passed through the collimator lens 318, where the light has become parallel light, is referred to as a far-field area 378 from the light emitter.

The optical pattern obtained in the far-field area 378 from the light emitter in a Fourier transformation relation with the image (optical pattern) of the light emitting plane 370 on the light emitter (light emitting area of the light emitter 470). Therefore, the function of the optical characteristic converting component 210 is greatly different between the case where the optical characteristic converting component 210 is arranged in the far-field area 378 from the light emitter or in the near-field area 372.

According FIG. 84 and the corresponding explanation, it has been described that the optical interference noise is reduced when the optical path length difference is given between the first light element 202 and the second light element 204 or between the third light element 206 and the fourth light element 207 divided by the optical characteristic converting component 210. Therefore, two types of optical characteristic converting components 210 may be used, with one arranged in the near-field area 372, and the other in the far-field area 378 from the light emitter.

As a specific embodiment example, one optical characteristic converting component 210 may be arranged in the near-field area 372, the initial light 200 emitted from the light emitter 470 may be divided into the first light element and the second light element, and the optical path length difference between the first light and the second light may be made larger than the coherence length “ΔL0”. Then, the other optical characteristic converting component 210 may be arranged in the far-field area 378 from the light emitter, and both the first light element and the second light element may be divided into the third light element 206 and the fourth light element 207.

Then, an optical path length difference larger than the coherence length “ΔL0” may be given between the further divided third light element 206 and fourth light element 207. When the division and the generation of the change in the optical path length are performed in both the near-field area 372 and the far-field area 378 in this manner, the effect of further reducing the optical interference noise is created.

A specific structure example of the optical characteristic converting component 210 suitable for the arrangement in the far-field area 378 from the light emitter will be described below. As illustrated in FIG. 98, the light flux diameter in the far-field area 378 from the light emitter is relatively large. Therefore, for division of the initial light 200 in this area, wavefront division is more suitable than amplitude division or intensity division.

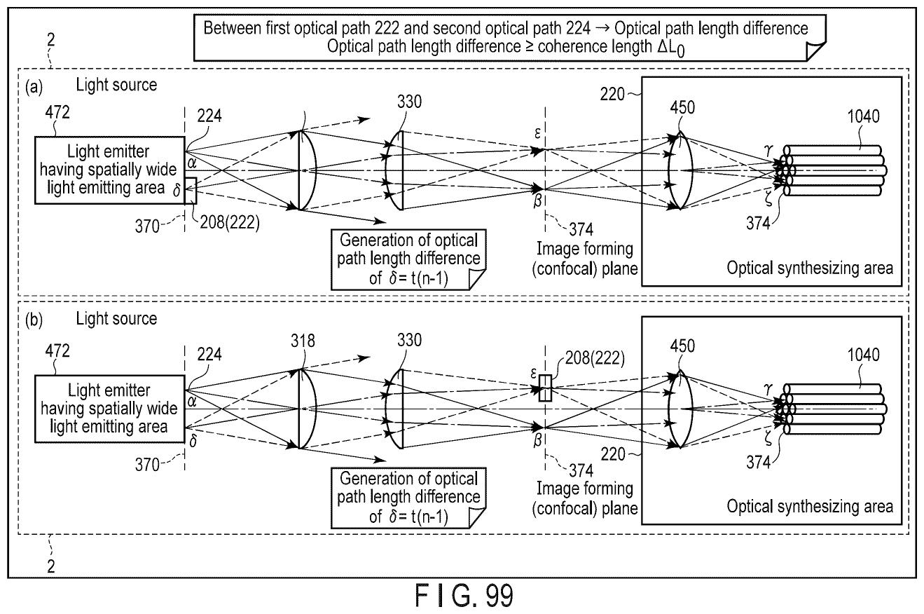

With reference to FIG. 99, the location of the near-field area 372 with respect to the light emitting area of the light emitter 472 having a spatially wide light emitting area will be described. The collimator lens 318 in FIG. 99 converts emitting light emitted from one point (“α point” or “δ point”) in the light emitting area of the light emitter 472 having a spatially wide light emitting area into parallel light. Then, the converging lens 330 converges the parallel light on the image forming plane 374. Therefore, an image forming optical system is configured by a combination of the collimator lens 318 and the converging lens 330.

Then, the image forming lens 450 constitutes an image forming optical system again, and converges the converged light on the image forming plane 374 on an incident surface of an optical bundle fiber 1040 again. Here, a combination of the image forming lens 450 and the optical bundle fiber 1040 constitutes the optical synthesizing area 220. Although not illustrated, the outgoing light beam from the optical bundle fiber 1040 may be used as the irradiated light (first light beam) 13 and emitted to the measured object 22 through an illumination system such as the Koehler illumination system 1026. Alternatively, the collimator lens 318 may be arranged in the middle of the optical path of the outgoing light beam from the optical bundle fiber 1040, and the measured object 22 may be irradiated with the irradiated light (first light beam) 12 in a substantially parallel light state.

In the optical system of FIG. 99, there are three near-field areas 372 for the light emitter 472 having a spatially wide light emitting area. First, the light emitting plane 370 (light emitting area) on the light emitter 472 having a spatially wide light emitting area corresponds to the first near-field area 372. Next, the image forming plane 374 of the light emitter set by the combination of the collimator lens 318 and the converging lens 330 corresponds to the second near-field area 372. Further, the image forming lens 450 constitutes an image forming optical system. The image forming lens 450 generates the image forming plane 374 of the light emitter on the incident surface (on the inlet surface) of the optical bundle fiber 1040. The image forming plane 374 of the light emitter corresponds to the third near-field area 372.

In an embodiment example of this chapter, the emitting light (initial light 200) that passes (or reflects) through or near any of the near-field area 372 is divided. Then, an optical path length between the divided light beams (the first light element 202 and the second light element 204) is changed.

As a method for changing the optical path length, in the embodiment example illustrated in FIG. 99, a difference in light passing through and out of a transparent medium (glass, quartz glass, transparent plastic, and the like) having a refractive index “n” and a thickness (step) “t” is used. When this transparent medium is used, an optical path length difference of “δ=t (n−1)” occurs in the light passing through and out of the transparent medium. The optical path length difference “δ” is set to be equal to or larger than the coherence length “ΔL0” (desirably a double value thereof).

In FIGS. 99 (a) and (b), emitting light from an “α point” in the light emitting plane 370 (light emitting area) on the light emitter 472 having a spatially wide light emitting area is converged at a “β point” and then converged again at a “γ point”. In addition, emitting light from a “δ point” in the light emitting plane 370 (light emitting area) on the light emitter 472 having a spatially wide light emitting area is converged at a ε point and then converged again at a “ζ point”. In order to simplify the description, one of the divided first optical path 222 and second optical path 224 is defined as an optical path passing through the “α point”, the “β point”, and the “γ point”, and the other is defined as an optical path passing through the “δ point”, the “ε point”, and the “ε point”.

In FIG. 99 (a), the division of the emitting light (initial light 200) and the setting of the optical path length difference between the divided lights (the first light element 202 and the second light element 204) are performed on or near the light emitting plane 370 (light emitting area) on the light emitter. That is, a transmissive optical characteristic converting component 208 having a thickness (step) “t” is arranged only in the vicinity of the “δ point” in the middle of the first optical path 222. As a result, the optical path length of the first optical path 222 is larger than the optical path length of the second optical path 224 passing through the “α point”, the “β point”, and the “γ point”.

In FIG. 99 (b), the division of the emitting light (initial light 200) and the setting of the optical path length difference between the divided lights (the first light element 202 and the second light element 204) are performed on or near the image forming plane 374 of the light emitter. That is, the transmissive optical characteristic converting component 208 having the thickness (step) “t” is arranged only in the vicinity of the “¿ point” in the middle of the first optical path 222. As a result, the optical path length of the first optical path 222 is larger than the optical path length of the second optical path 224 passing through the “α point”, the “β point”, and the “γ point”.

When attempting division of a wavefront with a large number of divisions in or near the near-field area 372 with respect to the emitting light (initial light 200) from the light emitter 470, a relatively wide area for division of the wavefront is required. In a case of where division of the wavefront is performed in the light emitting area (the light emitting plane 370 on the light emitter) in the light emitter 472 having a spatially wide light emitting area or immediately after the light emitting area, if the area is small, the upper limit of the number of divisions of the wavefront is restricted for reasons of spatial arrangement.

When the image forming optical system is configured in the middle of the optical path as illustrated in FIG. 99 (b), an arbitrary image forming magnification can be set on the image forming plane 374 of the light emitter. When the image forming magnification (enlargement magnification) with respect to the light emitting area (the light emitting plane 370 on the light emitter) in the light emitter 472 having a spatially wide light emitting area is increased, the number of divisions of the wavefront is easily increased. Therefore, when division of the emitting light (the initial light 200) and optical path length difference formation between the divided lights are performed on the image forming plane 374 of the light emitter, the effect of reducing the optical interference noise is improved.

A part of optical system included in the light source 2 shown in FIG. 54 or FIG. 55 may correspond to the optical system described in FIG. 98 or FIG. 99. In this case, the optical characteristic converting component 172 located in the optical near field area in FIG. 54 or FIG. 55 may be located in the near-field area 372 in FIG. 98 or FIG. 99. Moreover, the optical characteristic converting component 178 located in the optical far field area shown in FIG. 54 or FIG. 55 may be located in the far-field area 378 from the light emitter described in FIG. 98.

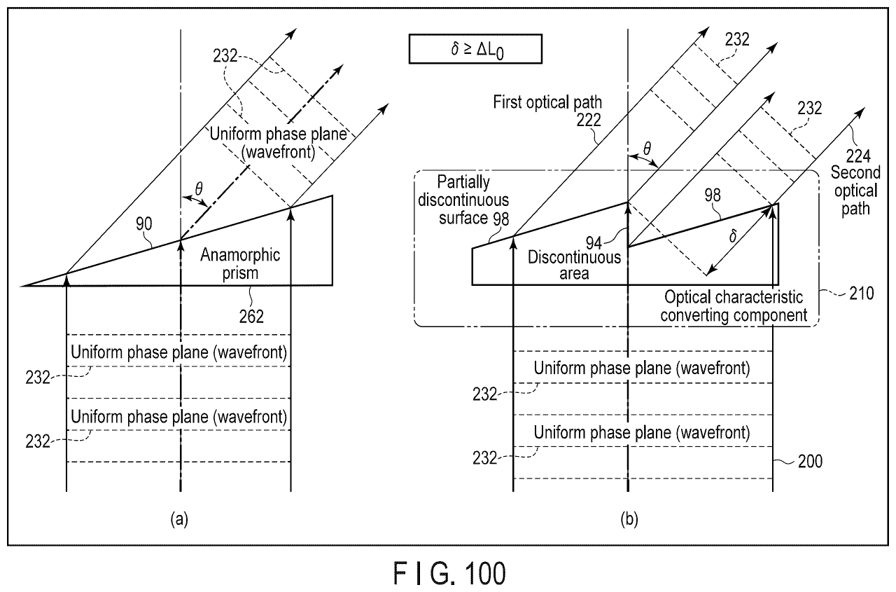

FIG. 100 illustrates an embodiment example of the optical characteristic converting component 210. As described with reference to FIG. 84, the optical characteristic converting component 210 is required to have a function of dividing the initial light 200 into plural light beams 202 to 207 having different optical paths. Any of the following methods may be used as the method for dividing the initial light 200 performed by the optical characteristic converting component 210:
(1) when the wide area light emitter (or multipoint light emitter) emits the initial light 200, the area is divided on the emitted wide light emitting area (or multipoint light emitting area) or on its image forming plane;
(2) wavefront division is performed in the middle of the optical path of the initial light 200; and
(3) amplitude division is performed in the middle of the optical path of the initial light 200.

As described above, at the time of intensity summation, when the number of light beams (different Wave Trains) to be synthesized (intensity summation) increases, the maximum value of the degree of coherence “|μAB|” decreases. Therefore, it is desirable that the number of divisions of light using the optical characteristic converting component 210 is large.

In the amplitude division for dividing the initial light 200 into the transmitted light and reflected light beams, it is difficult to increase the number of divisions while maintaining an even light intensity. Therefore, in the present embodiment, it is desirable to use one of the following methods that can increase the number of divisions relatively easily:
(1) area division on the wide light emitting area (on the multipoint light emitting area) or on its image forming plane; or
(2) wavefront division in the middle of the optical path of the initial light 200.

The wavefront division mentioned above means “spatial area division within the optical cross-section of the initial light 200”. Here, the optical cross-section of the initial light 200 indicates a two-dimensional intensity distribution profile that appears when the optical path of the initial light 200 is cut along a plane perpendicular to the traveling direction of the initial light 200.

The method of dividing the initial light 200 by the above method (1) or (2) in the present embodiment example will be described below. As illustrated in FIG. 100 (b), a discontinuous area 94 is formed on the plane in the optical characteristic converting component 210. Here, the plane forming the discontinuous area 94 may be either a plane or curved surface (or a mixture thereof).

Then, when the optical characteristic converting component 210 is arranged in the middle of the optical path of the initial light 200, the optical characteristic converting component is divided into the first optical path 222 and the second optical path 224 with the discontinuous area 94 as a boundary line. FIG. 100 (b) illustrates the method in which the initial light 200 passes through the partially discontinuous surface (curved or plane surface) 98 according to light transmission. Not limited to that, the initial light 200 may be reflected by the partially discontinuous surface (curved or plane surface) 98.

The unique optical effect of the discontinuous area 94 in the partially discontinuous surface (curved or plane surface) 98 will be described using a comparison between FIGS. 100 (a) and (b). In both FIGS. 100 (a) and (b), an even uniform phase plane (wavefront) exists in the initial light 200 in the initial state. FIG. 100 (a) illustrates a case where an anamorphic prism 250 is arranged in the middle of the optical path of the initial light 200. On the surface of anamorphic prism 250, a continuous plane 90 is formed on both the incident surface and the outgoing surface. Therefore, even after passing through the anamorphic prism 250, an even uniform phase plane (wavefront) is held in the initial light 200.

On the other hand, as illustrated in FIG. 100 (b), obtained from (light transmission or light reflection) the partially discontinuous surface (curved or plane surface) 98 in the optical characteristic converting component 210, the uniform phase plane (wavefront) in the initial light 200 is divided. Therefore, in the present embodiment example, the initial light 200 is divided using the “dividing action of the uniform phase plane (wavefront)” generated in the initial light 200.

Based on the light operation of the optical characteristic converting component 210, the principle of “intensity summation” of the divided light 202 to 207 at the optical synthesizing area 220 will be described. As illustrated in FIG. 77 (f), “the phase is fixed everywhere” in the same Wave Train. That is, the frequency (wavelength) inside the Wave Train obtained by “amplitude summation” (optical synthesizing based on it) of different wavelengths in FIGS. 77 (a) to 77 (e) coincides with the center frequency “ [symbol] 0” (central wavelength “λ0”). Then, the reference phase value “τj” (Equation 35) is fixed within the same Wave Train. Therefore, when the divided light in the same Wave Train is synthesized in the optical synthesizing area 220, “amplitude summation” (photosynthesis based on it) occurs.

As described with reference to FIG. 82, the phase shift amount “Δτ(t)” between different Wave Trains generated before and after each other in time series is always changing. In the measurer 8, a time-integrated light intensity for each prescribed time (for example, on the order of millisecond) is acquired as the measured signals 5. Therefore, “intensity summation” can be performed only after optical synthesizing is performed between “different Wave Trains generated before and after each other in time series”. That is, in order to perform “intensity summation” on the split light beams to be synthesized in the optical synthesizing area 220 (light elements 202 to 207 obtained from the different optical paths 222 to 228), it is desirable that “different Wave Trains generated before and after each other in time series” be individually included in the split light beams to be synthesized (the light elements 202 to 207 obtained from the different optical paths 222 to 228).

As a method of providing each of the light elements 202 to 207 obtained from the different optical paths 222 to 228 with “different Wave Trains generated before and after each other in time series”, in the present embodiment, the optical path length is changed by at least the coherence length “ΔL0” (desirably, twice the coherence length “ΔL0”) or more between the different optical paths 222 to 228.

As a method of changing the optical path length between the different optical paths 222 to 228, in the present embodiment, either of the following may be selected using the optical characteristic converting component 210:
[A] the optical characteristic converting component 210 changes the optical path length without changing the traveling direction of the initial light 200; or
[B] the optical characteristic converting component 210 changes the traveling direction of the initial light 200 to change the optical path length.

The method of [A] was described before with reference to FIGS. 85 to 89. In the method [A], it is desirable to use the optical characteristic converting component 210 of light transmission type. On the other hand, the optical characteristic converting component 210 used in the above [B] may be either the light transmission type or the light reflective type, and thus the selection range is widened. Here, description will be made focusing on the embodiment example of the above [B].

A perpendicular line in a plane (curved or plane surface) other than the discontinuous area 94 in the partially discontinuous surface (curved or plane surface) 98 in FIG. 100 (b) has a prescribed inclination amount with respect to the traveling direction of the initial light 200. As a result, the traveling direction of the light elements 202 to 207 obtained from the partially discontinuous surface (curved or plane surface) 98 is inclined in the direction of “0” with respect to the traveling direction of the initial light 200. As a result, an optical path length difference “δ” is generated between the first optical path 222 and the second optical path 224.

Then, the optical path length difference d is set to be larger than or equal to the coherence length “ΔL0” (or twice or more the coherence length “ΔL0”). Then, coherence between the first light element 202 passing through the first optical path 222 and the second light element 204 passing through the second optical path 224 is greatly reduced.

When the inclination angle “O” in the traveling direction of the light elements 202 to 207 obtained from the partially discontinuous surface (curved or plane surface) 98 is increased with respect to the traveling direction of the initial light 200, the optical path length difference “δ” increases between the first optical path 222 and the second optical path 224. Therefore, when the method of [B] of changing the traveling direction of the initial light 200 using the optical characteristic converting component 210 is applied, a large optical path length difference “o” can be efficiently acquired. That is, in the embodiment example using the method [B], the effect of downsizing the entire optical system is created.

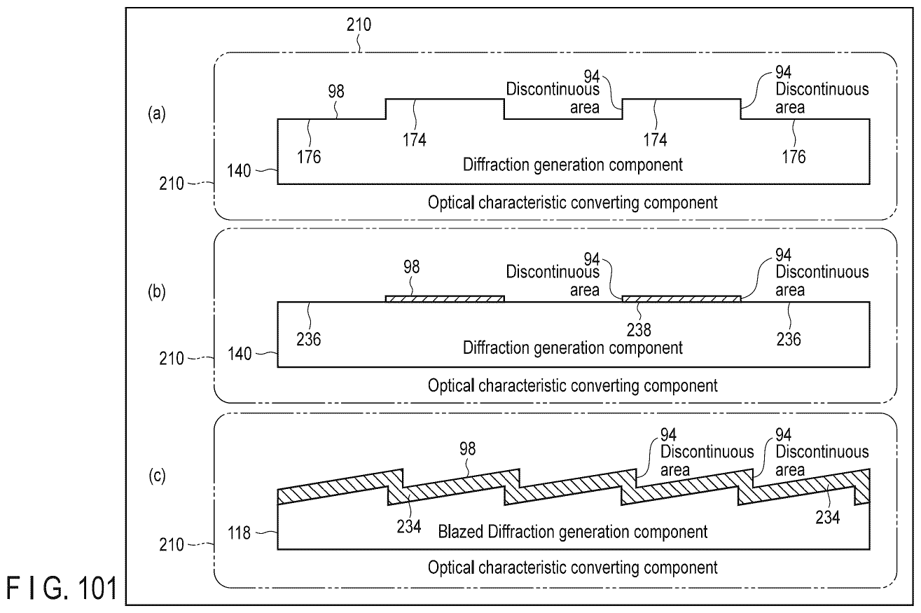

FIG. 101 illustrates another form of the partially discontinuous surface (curved or plane surface) 98 used in the optical characteristic converting component 210. Similarly to FIG. 100 (b), the embodiment example in FIG. 101 also changes the traveling direction of the initial light 200 to divide the initial light 200. That is, in the embodiment example of FIG. 101, the diffracted light (1st ordered diffracted light) traveling in a direction at an angle (diffraction angle) inclined with respect to the traveling direction (0th ordered diffracted light) of the incident light beam (initial light 200) is generated to generate the optical path length difference “δ”. Therefore, similarly to FIG. 100 (b), the optical system shown in FIG. 101 can be downsized.

As described in FIG. 100 (b), either of the following may be used for the place where the light is divided:
(1) Area division on the wide light emitting area (multipoint light emitting area) or on its image forming plane; and
(2) wavefront division in the middle of the optical path of the initial light 200.

There is a difference in a utilization method of the discontinuous area 94 between FIG. 100 (b) and FIG. 101. In FIG. 100 (b), the discontinuous area 94 is a boundary line dividing the initial light 200. In comparison of FIG. 101 to FIG. 100 (b), the initial light 200 is divided using the difference in the arrangement form of the discontinuous area 94 (difference in the cycle of the diffracted portion).

In FIG. 101, basically, the optical characteristic converting component 210 is configured using the diffraction generation component 140. Here, “an optical component that changes the traveling direction of diffracted light (1st ordered diffracted light) from the traveling direction of the incident light beam (0th ordered diffracted light) by utilizing diffraction of light” is generally referred to as a diffraction generation component 140. Specific forms of the diffraction generation component 140 include a grating and a holography component. Not limited to that, any optical component conforming to the above definition may be referred to as a diffraction generation component 140.

As physical form examples of the diffraction generation component 140 used in the present embodiment, the phase type (FIG. 101 (a)) and the light intensity change form (FIG. 101 (b)) are illustrated. FIG. 101 (c) illustrates a physical form example of a blazed diffraction generation component 118 in which the perpendicular line of a surface (curved or plane surface) other than the discontinuous area 94 in the partially discontinuous surface (curved or plane surface) 98 is inclined to the traveling direction of the incident light beam (initial light 200). In addition, FIG. 101 (c) illustrates an example of the reflective type in which the surface is a light reflection face 234. But not limited to that, a transmission type may be adopted. Here, in the case of the transmission type, the light reflection face 234 on the surface does not exist.

The diffraction generation component 140 used in the present embodiment example has the discontinuous area 94 in the partially discontinuous surface (curved or plane surface) 98 in any of FIGS. 101 (a) to 101 (c). In the case of the phase type diffraction generation component 140 illustrated in FIG. 101 (a), the boundary between a top face 174 and a bottom face 176 is referred to as the discontinuous area 94. If there is an inclined surface (curved or plane surface) at the boundary between the top face 174 and the bottom face 176, the boundary area between the top face 174 and the bottom face 176 is referred to as the discontinuous area 94.

In the case of the phase type diffraction generation component 140 illustrated in FIG. 101 (a), when the pitch (cycle) between the top faces 174 (or between the bottom faces 176) adjacent to each other is changed, the diffraction angle (bending angle of the 1st ordered diffracted light with respect to the 0th ordered diffracted light) changes. Therefore, by changing this pitch (cycle) depending on the difference in location in the partially discontinuous surface (curved or plane surface) 98, it is possible to divide the light (division in which the traveling direction is changed between the first light element 202 and the second light element 204).

In the embodiment example illustrated in FIG. 101 (a), the incident light beam (initial light 200) is transmitted through the phase type diffraction generation component 140 to cause diffraction. Not limited to that, diffraction may be generated using surface reflection of the phase type diffraction generation component 140. In this case, as in FIG. 101 (c), light reflection faces 234 are formed on both the top face 174 and the bottom face 176.

The light intensity changed diffraction generation component 140 illustrated in FIG. 101 (b) has a structure in which a mirror face or light shield face 238 is locally provided on a transparent face 236. Diffraction occurs using the difference in light transmittance or a difference in light reflectance between the transparent face 236 and the mirror face or light shield face 238. Therefore, in this case, the boundary area between the transparent face 236 and the mirror face or light shield face 238 is referred to as the discontinuous area 94. The light intensity changed diffraction generation component 140 also performs light division (division in which the traveling direction is changed between the first light element 202 and the second light element 204) by changing the pitch (cycle) between the transparent faces 236 adjacent to each other (or between the mirror face or light shield face 238).

A blazed diffraction generation component 118 illustrated in FIG. 101 (c) has a structure for enhancing the diffraction efficiency of the 1st ordered diffracted light. In this case, the different level area between the adjacent inclined surfaces (light reflection face 234) corresponds to the discontinuous area 94. In addition, the pitch (cycle) between the adjacent inclined surfaces (light reflection faces 234) is changed to perform light division (division in which the traveling direction is changed between the first light element 202 and the second light element 204).

A reflective Fresnel component 119 may be used instead of the blazed diffraction generation component 118 illustrated in FIG. 101 (c). The reflective Fresnel component 119 includes the discontinuous area 94 and the inclined surface in common with the blazed diffraction generation component 118. However, since a pitch (cycle) between adjacent inclined surfaces in the reflective Fresnel component 119 is relatively wide, a diffraction phenomenon hardly occurs. Since this inclined surface corresponds to a part of the curved reflection surface (or the reflection plane surface), it is similar to a state in which the embodiment illustrated in FIG. 100 (b) is deformed into a reflective type.

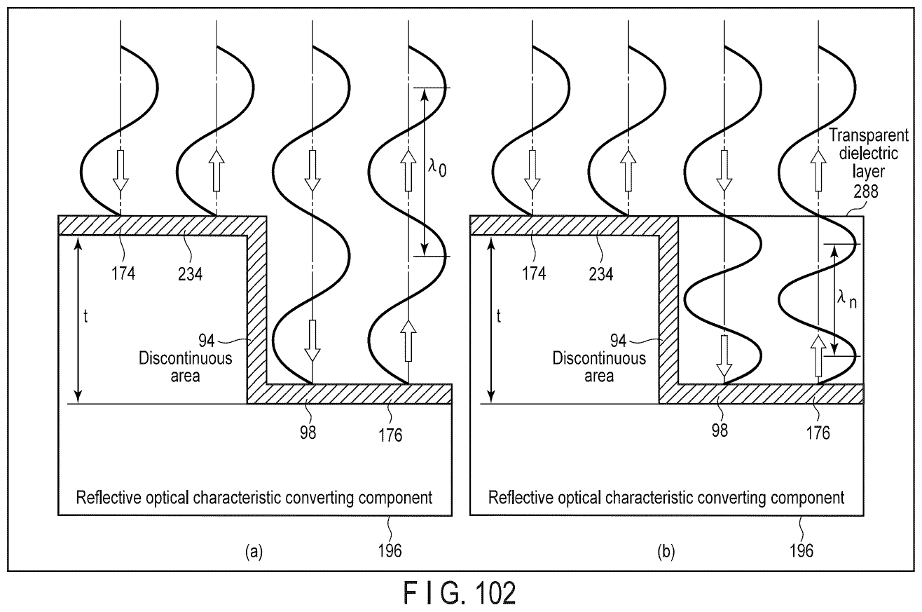

FIG. 102 illustrates a basic principle related to the present embodiment application example related to the reflective optical characteristic converting component 196. In FIGS. 102 (a) and (b), similarly to FIG. 101 (c), a light reflection face 234 exists on a partially discontinuous surface (curved or plane surface) 98. In the partially discontinuous surface (curved or plane surface) 98, a discontinuous area 94 forms a boundary between a top face 174 and a bottom face 176. Here, the amount of a mechanical step between the top face 174 and the bottom face 176 is defined as “t”. The wavelength of the light reflected by the light reflection face 234 in the air (or in vacuum) represents “λ0”.

A portion immediately before the light reflection face 234 on the bottom face 176 in FIG. 102 (a) is directly exposed to the air. Therefore, the wavelength of the light reflected by the light reflection face 234 on the bottom face 176 in FIG. 102 (a) remains “λ0”. And the optical path length difference “δ” between the reflected light beam from the top face 174 and the reflected light beam from the bottom face 176 in FIG. 102 (a) satisfies the relation of “>=2t”. With respect to the mechanical step amount “t” between the top face 174 and the bottom face 176, it is desirable to satisfy a condition of “t=δ/2≥ΔL0/2=λ02/2Δλ” or “t≥ΔL0=λ02/Δλ”.

In comparison with this, a portion immediately before the light reflection face 234 provided on the bottom face 176 in FIG. 102 (b) is covered with a transparent dielectric layer 288. The refractive index of the transparent dielectric layer 288 represents “n”. A value of the wavelength “An” of light passing through the transparent dielectric layer 288 is as short as “λn=λ0/n”. Similarly a value of the wavelength width (spectral bandwidth) “Δλn” of light passing through the transparent dielectric layer 288 is as short as “Δλη=Δλ/η”. Therefore, a required condition for the mechanical step amount “t” between the top face 174 and the bottom face 176 in FIG. 102 (b) is “t=δ/2≥Δ Ln/2=λn2/2Δλn=λ02/2nΔλ” or “t≥Δ Ln=λ02/nΔλ”. That is, when the portion immediately before the light reflection face 234 is covered with the transparent dielectric layer 288 having a refractive index “n”, the allowable lower limit of the mechanical step amount “t” decreases by “1/n”. In other words, the transparent dielectric layer 288 has the refractive index more than “1” and includes a material through which the light of wavelength “λ0” can passes.

The step height “t” in the reflective optical characteristic converting component 196 provides a half of the necessary set optical path length difference “δ”. Therefore, the effect of miniaturizing the optical system by using the reflective optical characteristic converting component 196 has already been described. Further, as described above, the transparent dielectric layer 288 having the refractive index “n” (n>1) is arranged in the middle of the optical path to the light reflection face 234 (or immediately before the light reflection face 234). Then, since the allowable lower limit of the mechanical step height “t” decreases, an effect of further reducing the thickness of the entire reflective optical characteristic converting component 196 is produced. As a result, when the transparent dielectric layer 288 is arranged immediately before the light reflection face 234 in the reflective optical characteristic converting component 196, the optical system can be further miniaturized.

Here, arrangement conditions of the transparent dielectric layer 288 are summarized as follows. In the present embodiment example, the light reflection face 234 in the partially discontinuous surface (curved or plane surface) 98 optically reflects the initial light 200 emitted by the light emitter 470. The position of the discontinuous area 94 in the partially discontinuous surface (curved or plane surface) 98 is used (for the boundary area) to spatially divide the initial light 200. The optical path length difference between the individual optical paths (the first optical path 222 to the fourth optical path 228) through which the divided light elements (the first light element 202 to the fourth light element 207) pass is equal to or larger than the coherence length “ΔL0” (or a double value thereof). As a result, the temporal coherence between the individual light elements (the first light element 202 to the fourth light element 207) decreases.

Here, the initial light 200 passes through the transparent dielectric layer 288 in the middle of the optical path in which the initial light 200 is reflected. The transparent dielectric layer 288 may be formed on at least a “light reflection face 234 on the top face 174” and another “light reflection face 234 on the bottom face 176”. Here, the discontinuous area 94 in the partially discontinuous surface (curved or plane surface) 94 forms a boundary between the “light reflection face 234 on the top face 174” and the “light reflection face 234 on the bottom face 176”. The optical synthesizing area 220 performs intensity summation (light synthesis) of the light elements 202 to 207 having passed through the optical paths 222 to 228 having different optical path lengths.

The transparent dielectric layer 288 is desirably arranged at least:
(1) on the wide area light emitting area (or on the multipoint light emitting area) 370 or on the image forming plane 374 thereof (and the near-field area 372 thereof), in a case where the wide area light emitter (or the multipoint light emitter) emits the initial light 200, and
(2) at a location capable of wavefront division in the middle of optical path of the initial light 200.

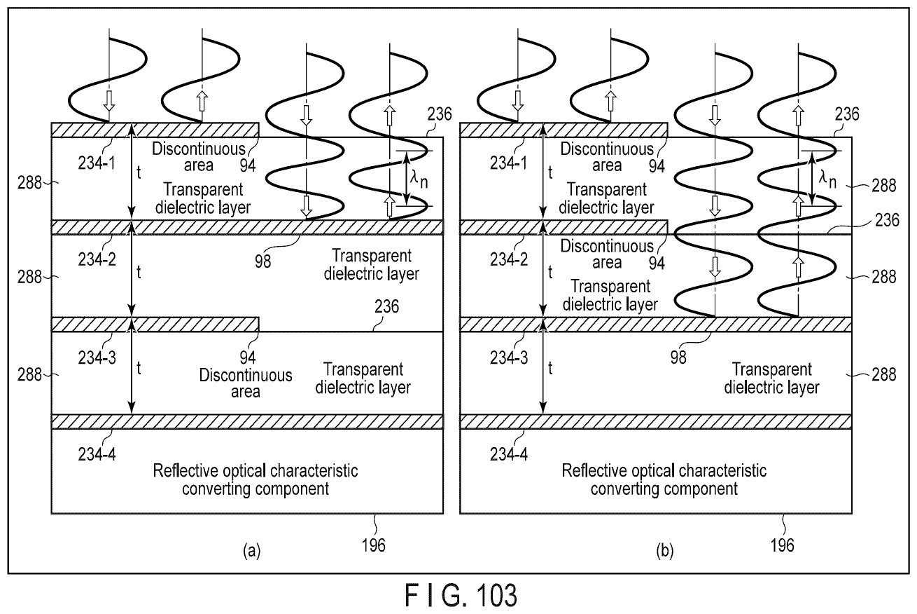

FIG. 103 illustrates an embodiment example of the reflective optical characteristic converting component 196 using the transparent dielectric layer 288. FIGS. 103 (a) and (b) illustrate a cross-sectional shape of the reflective optical characteristic converting component 196. FIG. 103 (b) illustrates a cross-sectional shape when the section is rotated by “90 degrees” with respect to the section of the reflective optical characteristic converting component 196 illustrated in FIG. 103 (a).

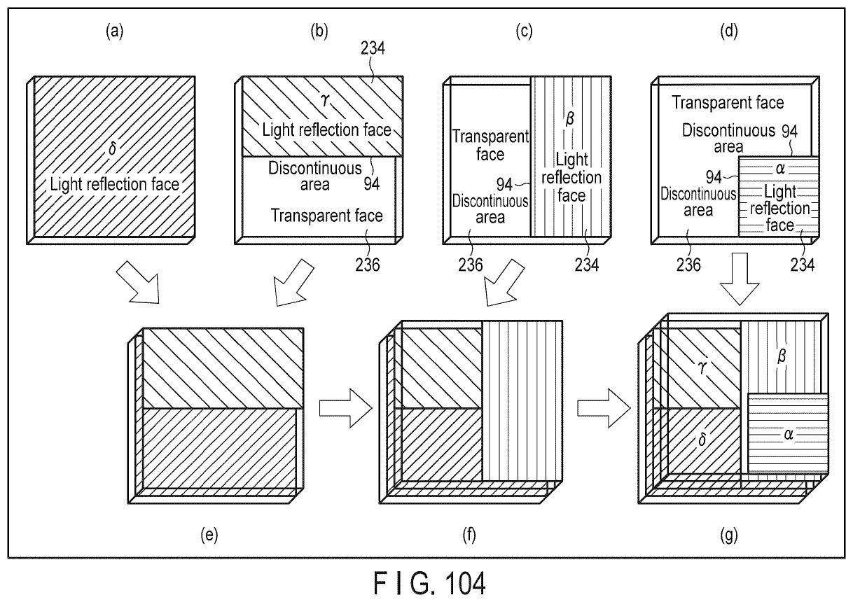

FIG. 104 (g) illustrates a shape of the reflective optical characteristic converting component 196 in FIG. 103 as viewed from the incident side of the initial light 200. The reflective optical characteristic converting component 196 divides the initial light 200 into four areas. That is, a “x area” of the light reflection face 234 corresponds to the first area 212. Similarly, a “β area”, a “γ area”, and a “δ area” of the light reflection face 234 correspond to the second, third, and fourth areas 214 to 218, respectively. The first optical path 222 to the fourth optical path 228 different from each other are formed using the optical path length difference until the light returns after being reflected by the light reflection face 234 positioned in each area.

Therefore, the mechanical thickness (or height) “t” between the transparent dielectric layers 288 is set such that the optical path length difference between the optical paths 222 to 228 exceeds the coherence length “Δ Ln” (or a double value thereof). The value of the coherence length “Δ Ln” can be calculated by substituting the values of the wavelength “λn”’ and the ‘wavelength width “Δλn” of the initial light 200 passing through the transparent dielectric layer 288’ into the corresponding parts in Equation 36.

Depending on the optical characteristics of the initial light 200, the range of the mechanical thickness (or height) “t” between the transparent dielectric layers 288 is generally “0.05 mm” or more and “10 mm” or less in many cases. As the transparent dielectric layer 288 suitable for this thickness range, a transparent dielectric plate may be used instead of the coating layer. As an example of a material used for the transparent dielectric plate, for example, a transparent inorganic material such as an optical glass plate or a quartz glass plate may be used. Alternatively, a transparent organic material such as an acrylic plate or a polycarbonate plate may be used.

A light reflection face 234-4 (corresponding to the light reflection face “δ” in FIG. 104) arranged on the lowermost side in the reflective optical characteristic converting component 196 illustrated in FIG. 103 exists on the entire surface in the cross section. However, a transparent face 236 always exists in a plane where the other light reflection faces 234-1 to 234-3 (corresponding to the light reflection faces “α” to “γ” in FIG. 104) exist. That is, the light reflection face 234 and the transparent face 236 are always mixed on one surface of the transparent dielectric layer 288 formed on the transparent dielectric plate.

As a method for forming the light reflection face 234 and the transparent face 236 in a mixed manner on one surface of the transparent dielectric plate, the light reflection face 234 may be locally formed (using masking or the like) on one surface of the transparent dielectric plate. In the local formation of the light reflection face 234, dimensional accuracy of the discontinuous area 94 (boundary area between the light reflection face 234 and the transparent face 236) is important.

Incidentally, as can be seen from a situation in which ‘masking technology is used for highly accurate semiconductor manufacturing’, the positional accuracy of the masking is very high. Therefore, in the present embodiment example in which the reflective optical characteristic converting component 196 is produced, high dimensional accuracy of the discontinuous area 94 (boundary area between the light reflection face 234 and the transparent face 236) can be obtained.

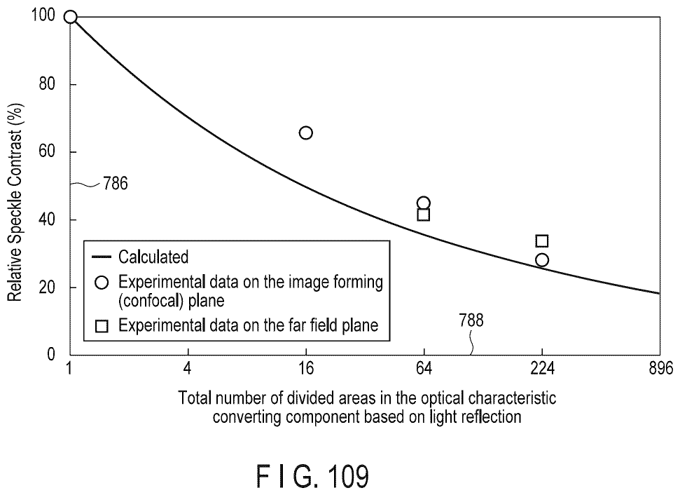

As a result, the number of divisions of each of the areas 212 to 218 in the reflective optical characteristic converting component 196 can be significantly increased (as compared with the four divisions illustrated in FIGS. 103 and 104). As shown by the data of FIG. 109, speckle noise can be greatly reduced by increasing the number of divisions. Therefore, when the structure of the reflective optical characteristic converting component 196 illustrated in the present embodiment example is used, the number of divisions can be significantly increased, so that an effect of significantly reducing speckle noise is produced.

When a metal material is used as the material of the light reflection face 234, aluminum may be used, or a stacked structure of a gold layer with a chromium layer as a base may be used. Alternatively, an inorganic dielectric such as titanium oxide or silicon oxide may be used as the material of the light reflection face 234. As a method for forming the light reflection face 234, any method such as vacuum deposition, a sputtering method, or an ion plating method may be used.

FIG. 103 illustrates a structure comprising plural transparent dielectric plates (transparent dielectric layers 288) in which the light reflection face 234 and the transparent face 236 are formed on the one surface in a mixed manner are stacked. The stacked transparent dielectric plates (transparent dielectric layers 288) are bonded to each other and integrated. For this bonding, a photo curable adhesive resin or the like may be used.

FIG. 104 illustrates an example of a method for producing the reflective optical characteristic converting component 196 illustrated in FIG. 103. First, a transparent dielectric plate having a thickness “t” is prepared as the transparent dielectric layer 288. In FIG. 104 (a), the light reflection face 234 is formed on one front surface of the transparent dielectric plate. A part of the “d area” in the light reflection face 234 is used as the fourth area 218.

On the other hand, in FIG. 104 (b), the light reflection face 234 exists in a partial area in one surface of the transparent dielectric plate. Here, the discontinuous area 94 corresponding to the boundary area between the light reflection face 234 and the transparent face 236 is arranged in a laterally straight line. A part in the light reflection face 234 constitutes the third area 216 as the “γ area”. Further, in FIG. 104 (c), the light reflection face 234 exists in a partial area in one surface of the transparent dielectric plate.

Here, the discontinuous area 94 corresponding to the boundary area between the light reflection face 234 and the transparent face 236 is arranged in a longitudinally straight line. A part in the light reflection face 234 constitutes the second area 241 as the “β area”. In FIG. 104 (d), the light reflection face 234 exists only in a quarter area in one surface of the transparent dielectric plate. The entire light reflection face 234 constitutes the first area 212 as the “α area”.

FIG. 104 (e) illustrates a state in which the plate in FIG. 104 (b) is stacked on the light reflection face 234 in FIG. 104 (a) and both are bonded. Further, the plate in FIG. 104 (c) is stacked thereon and bonded to form the structure of FIG. 103. Further, the plate in FIG. 104 (d) is stacked thereon and bonded to complete the structure of FIG. 104.

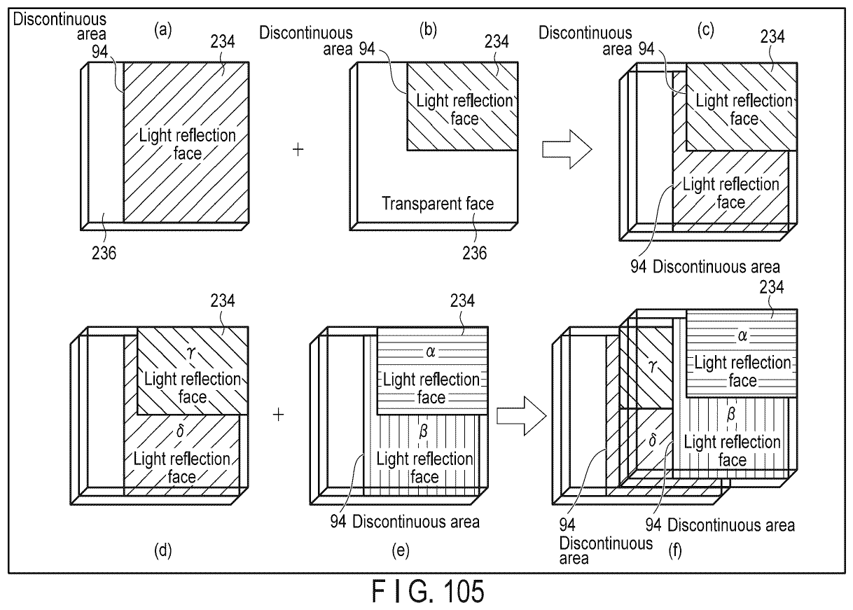

FIG. 105 illustrates the present embodiment application example related to the structure of the reflective optical characteristic converting component 196. In the embodiment example of FIG. 104, three types of mask patterns are required to form the light reflection face 234. In comparison with this, in the structure of the present embodiment application example illustrated in FIG. 105, the type of mask pattern necessary for forming the light reflection face 234 can be reduced, and the number of divisions can be easily increased. Therefore, when the structure of the present embodiment application example illustrated in FIG. 105 is adopted, there is an effect that the reflective optical characteristic converting component 196 can be produced relatively inexpensively.

In the structure of the present embodiment application example illustrated in FIG. 105, the transparent face 236 is arranged on one surface of all the transparent dielectric plates (transparent dielectric layers 288). And FIG. 105 forms the light reflection face 234 and the transparent face 236 on the opposite surface of all the transparent dielectric plates (transparent dielectric layers 288). Here, the discontinuous area 94 corresponds to the boundary between the light reflection face 234 and the transparent face 236. And the discontinuous area 94 forms a boundary straight line or a curved boundary line between the light reflection face 234 and the transparent face 236, and the boundary straight line or the curved boundary line expands to a longitudinal direction or a lateral direction.

For example, in the mask pattern forming FIG. 105 (a), the discontinuous area 94 is arranged in the boundary straight line in the longitudinal direction. In the mask pattern forming FIG. 105 (b), the discontinuous area 94 is arranged in the longitudinal direction and the lateral direction. And each part of the discontinuous area 94 on each transparent dielectric plate (transparent dielectric layer 288) is arranged to be parallel with each other. According to the present embodiment application example shown in FIG. 105 (f), all of the straight lines in the longitudinal direction is arranged to be parallel with each other in the reflective optical characteristic converting component 196.

FIG. 105 (c) illustrates a structure after a plate having the structure in FIG. 105 (b) is stacked on a plate having the structure in FIG. 105 (a) and the plates are bonded to each other. A structure illustrated in FIG. 105 (c) is referred to as a “block”, and blocks are stacked/bonded while being shifted from each other to constitute the reflective optical characteristic converting component 196. When the number of blocks constituting the reflective optical characteristic converting component 196 is increased, the number of divisions of the areas 212 to 218 as the reflective optical characteristic converting component 196 can be arbitrarily increased. When the number of divisions increases, speckle noise (optical interference noise amount) decreases.

FIGS. 105 (d) and 105 (e) each forms a “block” similar to FIG. 105 (c). FIG. 105 (f) illustrates a structure obtained by laminating/bonding FIGS. 105 (d) and (e) to be shifted in the direction in which the transparent face 236 exists (direction perpendicular to the direction in which the discontinuous areas 94 commonly existing in the block are connected). The third light element 206 and the fourth light element 207 in the initial light 200 pass through the front transparent face 236 and are reflected by the “γ area” and the “δ area” in the light reflection face 234.

In the embodiment examples of FIG. 104 (g) and FIG. 105 (f), the area is divided into the four divided areas 212 to 218 of “α” to “δ”. However, the present invention is not limited thereto, and the number of divisions of each of the areas 212 to 218 may be arbitrarily increased. As described in FIG. 109, when the number of divisions of each of the areas 212 to 218 increases, an effect of reducing the amount of optical interference noise is produced.

FIG. 106 illustrates an embodiment example of an optical system in the light source 2. The VCSEL (2D light emitter) 128 included in the wide area light emitter (multipoint light emitter) 488 is used for the light source 2 in FIG. 106. Therefore, the method described with reference to FIG. 74 may be used for fixing the wide area light emitter (multipoint light emitter) 488 in FIG. 106.

Further, as the optical characteristic converting component 210 in FIG. 106, the reflective optical characteristic converting component 196 illustrated in FIGS. 102 to 105 may be used. A portion indicated by a thick solid line on the upper side in the optical characteristic converting component 210 in FIG. 106 indicates the light reflection face 234. A portion indicated by a thin broken line on the lower side indicates the transparent face 236.

In FIG. 105 (c), two transparent dielectric plates partially provided with the light reflection face 234 on one surface were stacked to form a “block”. On the other hand, in FIG. 106, three transparent dielectric plates partially provided with the light reflection face 234 formed on one surface are stacked and bonded to form a “block”. In FIG. 106, three blocks are shifted, stacked, and bonded. Here, the three blocks have a structure shifted in a direction perpendicular to the paper plane.

As a result, the optical characteristic converting component 210 in FIG. 106 has a structure in which the initial light 200 is divided into nine. When the light beams reaching all nine areas are illustrated in the drawing, the drawing becomes complicated and difficult to understand. Therefore, the description is simplified, and only light beams reaching three areas (within one block) in the nine areas are illustrated in FIG. 106.

As illustrated in FIG. 97, the VCSEL (2D light emitter) 128 illustrated as an example of the wide area light emitter (multi-point light emitter) 468 has a structure in which a large number of “light passing windows” 490 (light emission points) corresponding to emitting ports of the emitting light 462 are arranged. In FIG. 106, for simplification of the drawing, only the optical path of the emitting light 462 emitted by the three “light passing windows” 490 (light emission points) is illustrated.

A light emitting area in the wide area light emitter (multipoint light emitter) 488 (VCSEL 128) has a predetermined width (and a predetermined height). Therefore, the image forming lens 450 forms a magnified image pattern of the “light passing window” 490 (light emission point) in the VCSEL (2D light emitter) 128 (wide area light emitter (multipoint light emitter) 488) on the first image forming plane 384 (near-field area 372) for the light emitter 468. Then, the optical characteristic converting component 210 is arranged at a position of the first image forming plane 384 (near-field area 372) with respect to the light emitter 468.

The emission light 462 from the wide area light emitter (multipoint light emitter) 468 (VCSEL 128) has a divergence characteristic (the emission light 462 is divergent light). Therefore, the light reflected by the light reflection face 234 in the optical characteristic converting component 210 also has a divergence characteristic (divergent light). A coordinating lens 392 converts a divergent reflected light into convergent light or parallel light and deflects the convergent light or parallel light toward the converging lens 330.

The converging lens 330 forms an image (converges) of the light reflected by the optical characteristic converting component 210 again at a position of the second image forming plane 376 (near-field area 372) with respect to the light emitter 468.

As a result, an array pattern of the “light passing windows” 490 (light emission points) in the VCSEL (2D light emitter) 128 (wide area light emitter (multipoint light emitter) 488) is formed on the second image forming plane 376 (near-field area 372) for the light emitter.

As explained in FIG. 97, the induced emission phenomenon (the stimulated emission phenomenon) occurring in the light emitting layer 482 may account for the optical phase synchronizing phenomenon between different emission lights 462 emitted from different “light pasting windows” 490 included in the VCSEL (2D light emitter) 128 (wide area light emitter (multipoint light emitter) 468). In response to the optical phase synchronizing phenomenon, the optical phase synchronizing characteristic between the different light emission points (“light passing windows” 490) may disappear on the second image forming plane 376 (or the near-field area 372 thereof) if the present embodiment arranges the optical characteristic converting component 210 on the first image forming plane 384 (or the near-field area 372 thereof). That is, a relation of the unsynchronized optical phase is established on the second image forming plane 376 (or the near-field area 372 thereof).

Not limited to the multipoint light emitter such as the VCSEL 128, even when the wide area light emitter (or the 2D light emitter) 468 having the optical phase synchronizing characteristic in the wide area light emitting area is used, the optical phase synchronizing characteristic between the different light emitting areas disappears on the second image forming plane 376 (or the near-field area 372 thereof) with respect to the light emitter 468. That is, a relation of the unsynchronized optical phase is established.

On the second image forming plane 376 (or the near-field area 372 thereof) for the light emitter, for example, an array pattern between multiple light emission points (light passing windows 490) in the VCSEL 128 is formed. Then, after the second image forming plane 376 (or the near-field area 372 thereof) for the light emitter 468, the light from the multiple light emission points (the light passing windows 490) in the second image forming plane 376 becomes divergent light.

With respect to the relation between FIG. 84 and FIG. 105, the reflected light from the “x area” corresponds to the first light element 202, and the reflected light from the “B area” corresponds to the second light element 204. And the reflected lights from the “γ area” and the “d area” correspond to the third and fourth light elements 206, 207 according to FIG. 84, the present embodiment requires the optical synthesizing area 220 to generate the synthesized light 230. In other words, the optical interference noise reduction effect reduces when a lack of the optical synthesizing effect between the light elements 202 to 207 reflected from the optical characteristic converting component 210 occurs.

Here, depending on the combination characteristics of the image forming lens 450, the coordinating lens 392, and the converging lens 330, it may be possible that the lack of the optical synthesizing effect between the light elements 202 to 207 occurs in the second image forming plane 376. Therefore, according to FIG. 106, the optical synthesizing area 220 comprises the converging lens 330, the concave lens 310, and the floodlight lens 398.

In the second image forming plane 376 shown in FIG. 106, the optical system forms an image pattern of the wide area light emitter (multipoint light emitter) 468. And the image pattern includes plural corresponding small image patterns of plural “light passing windows” 490 when the optical system uses VCSEL 128 as the wide area light emitter (multipoint light emitter) 468. As explained in FIG. 97, each emission light 462 immediately after each “light passing window” 490 has the optical phase synchronizing characteristic with each other. However, in the second image forming plane 376, each light element 202 to 207 has the optical phase unsynchronizing characteristic with each other because the optical system positions the second image forming plane 376 after the optical characteristic converting component 210.

In the present embodiment example, a concave lens 310 is arranged behind the second image forming plane 376 (or the near-field area 372 thereof) with respect to the light emitter 468. The concave lens 310 increases each divergence angle of each emitting light 462 from each of the small image patterns of the multiple light emission points (each of the light passing window 490). As a result, the synthesized light 230 passes through the floodlight lens 398.

The synthesized light 230 after passing through the floodlight lens 398 is suitable for the high accurate distance measurement (length measurement) explained in Chapter 3 and is suitable for the optical system shown in FIG. 40 or FIGS. 53 to 55 since the synthesized light 230 prevents the optical interference noise. Moreover, the synthesized light 230 is suitable for measuring the three-dimensional shape of the measured object 22.

The light after passing through the floodlight lens 398 becomes irradiated light (first light beam) 13 shown in FIG. 40 or FIG. 53, and irradiates the measured object 22. The form of the irradiated light (first light beam) 13 irradiating the measured object 22 may form the Koehler illumination system 1026 in a broad sense. Here, the floodlight lens 398 has a mechanism movable in the optical axis direction. When the floodlight lens 398 is moved in the optical axis direction as described above, the spot size with which the measured object 22 is irradiated is arbitrarily changed.

In a case where the reflective optical characteristic converting component 196 described in FIG. 105 (or FIG. 104) is used as the optical characteristic converting component 210, the optical characteristic converting component has a thickness “Z1+Z2” in a direction along the optical axis. Here, the total thickness in front of the reflective optical characteristic converting component 196 is set to “Z1” with reference to the position of the first image forming plane 384 with respect to the light emitter. Similarly, the total thickness behind the reflective optical characteristic converting component 196 is set to “Z2”. In the present embodiment example, the reflective optical characteristic converting component 196 (optical characteristic converting component 210) may be arranged such that “Z1≤Z2” is satisfied.

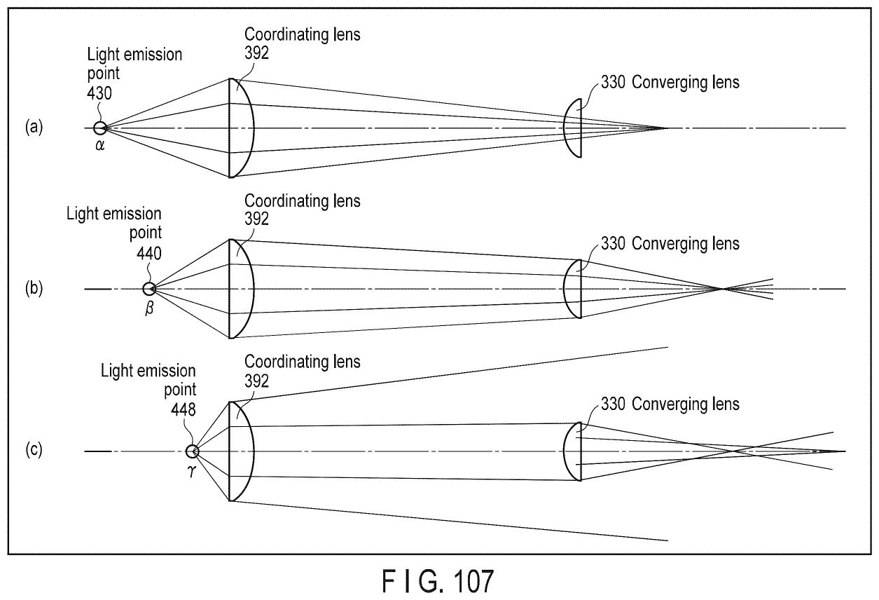

FIG. 107 is a diagram illustrating a difference in optical path after passing through the coordinating lens 392 and the converging lens 330 shown in FIG. 106. As illustrated in FIG. 106, when the position of the light reflection face 234 in the optical characteristic converting component 210 (reflective optical characteristic converting component 196) changes, the position of the image formation point viewed from the coordinating lens 392 is shifted.

In FIG. 107 a position of the image forming point shifts according to the position change of the light reflection face 234. In a pseudo manner, the image forming points represent the “light emission point α” 430 to the “light emission point γ” 448. The “light emission point β440” in FIG. 107 (b) is used as a reference. In the case of FIG. 107 (a) in which the “light emission point α” 430 is arranged behind the “light emission point β” 440, all light beams having passed through the coordinating lens 392 pass through the converging lens 330. In this case, the aberration in the converging spot by the converging lens 330 is relatively small.

In the case of FIG. 107 (c) in which the “light emission point γ” 448 is arranged in front of the “light emission point β” 440, a part of the light having passed through the coordinating lens 392 is emitted to the outside of the converging lens 330. In this case, the aberration in the converging spot by the converging lens 330 becomes large. Therefore, when the situation in FIG. 107 (a) is generated more than the situation in FIG. 107 (c) (the probability in FIG. 107 (a) is greater than the probability in FIG. 107 (c)), good optical characteristics can be obtained as a whole.

For the reason described with reference to FIG. 107, the arrangement of the optical characteristic converting component 210 (reflective optical characteristic converting component 196) is devised so as to satisfy the condition of “Z1≤Z2” in FIG. 106. As a result, the utilization efficiency of light in FIG. 106 is improved. In other word, the condition of “Z1≤Z2” minimalizes the light power loss in the optical system. Moreover, the condition of “Z1≤Z2” prevents the aberration characteristic of the converging spot in the second image forming plane 376 (the near-field area 372 thereof).

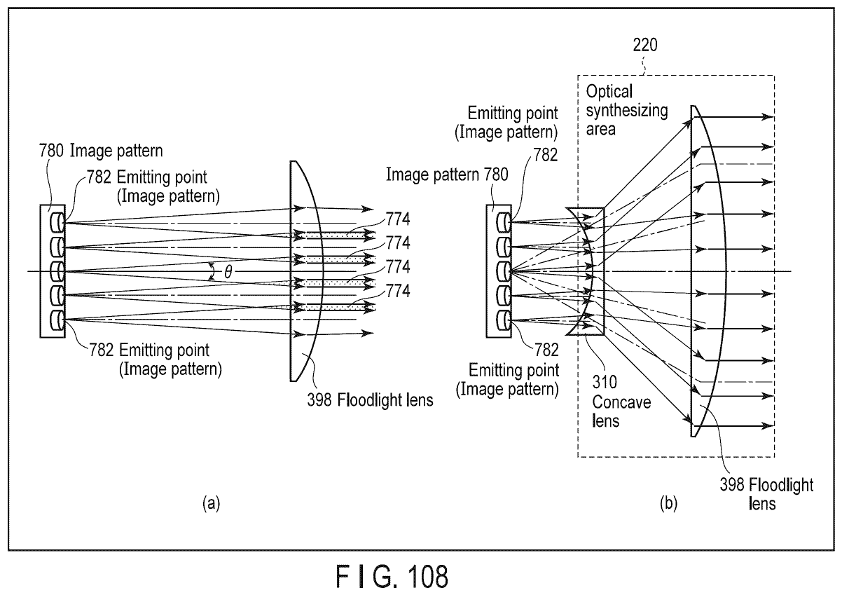

FIG. 108 is a functional explanatory diagram of the concave lens 310 disposed in FIG. 106. An image pattern 780 of the wide area light emitter (multipoint light emitter) 468 is formed on a second image pattern forming plane 376 of the light emitter 468 in FIG. 106. In addition, in the structure of the VCSEL 128 illustrated in FIG. 97, each light passing window 490 corresponds to multiple light emission points. Therefore, in a case where the VCSEL 128 is used as the wide area light emitter (multipoint light emitter) 468, an infinite number of image patterns 782 of a light emission point in the multipoint light emitter (VCSEL) appear in the image pattern 780 of the multipoint light emitter (VCSEL) appearing on the second image pattern forming plane 376 of the light emitter 468.

In the conventional end surface emitting type semiconductor laser, since a thickness of the active area 480 is very small, the spread angle “e” of a laser beam emitted from the conventional end surface emitting type semiconductor laser is sufficiently large. On the other hand, in the VCSEL 128, the size of one light passing window 490 is relatively large (for example, a diameter of 5 to 50 μm). Therefore, the spread angle “O” of the laser light emitted from one light passing window 490 is very small.

Therefore, as illustrated in FIG. 108 (a), the light overlapping area 774 between emission lights 462 for each image pattern 782 of the adjacent light emission points in the multipoint light emitter (VCSEL) becomes very narrow. In the optical system illustrated in FIG. 105, the optical characteristic converting component 210 is disposed in the middle of the optical path of the emission light 462 from the VCSEL 128 (wide area light emitter (multipoint light emitter) 468) to reduce the optical interference between the light elements 202 to 207. However, if the light overlapping area 774 is narrow, synthesis (overlapping) between the light elements 202 to 207 is insufficient. As a result, the effect of reducing the optical interference noise cannot be sufficiently exhibited.

This situation is described below in detail. In the optical system illustrated in FIG. 106, the optical characteristic converting component 210 (optical characteristic converting component 196 based on light reflection) is disposed on the first image pattern forming plane 375 of the wide area light emitter (multipoint light emitter) 468. Therefore, an infinite number of image patterns 782 of light emission points in the multipoint light emitter (VCSEL) also appear on the first image pattern forming plane 375 of the wide area light emitter (multipoint light emitter) 468.

The image forming lateral magnification “M” with respect to the first image pattern forming plane 375 of the wide area light emitter (multipoint light emitter) 468 in the present embodiment example is set to twice or more. Here, the image forming longitudinal magnification is proportional to the square “M2” of the imaging lateral magnification. In this case, the image forming longitudinal magnification is four times or more. The entire optical characteristic converting component 210 (optical characteristic converting component 196 based on light reflection) has a thickness of “Z1+Z2”. When the image forming lateral magnification value “M” is set to be large, a focal depth of the image pattern becomes larger than “Z1+Z2”. As a result, the image pattern 782 of each light emission point in the multipoint light emitter (VCSEL) is formed on each light reflection face in the optical characteristic converting component 210 (optical characteristic converting component 196 based on light reflection).

When the function of the optical characteristic converting component 210 (optical characteristic converting component 196 based on light reflection) described above is used, there is an optical non-interference characteristic between the image patterns 782 of the respective light emission points in the multipoint light emitter (VCSEL) on the second image pattern forming plane 376 of the multipoint light emitter 468. That is, optical interference does not occur between the emission lights 462 from image patterns having different light emission points formed on the second image pattern forming plane 376. Note that the image forming lateral magnification with respect to the second image pattern forming plane 376 with respect to the first image pattern forming plane 375 shown in FIG. 106 is greatly reduced (“½” or less).

As illustrated in FIG. 108 (b), in the present embodiment example, the concave lens 310 may be disposed immediately after the second image pattern forming plane 376 of the multipoint light emitter 468. Due to the action of the concave lens 310, the spread angle “θ” of the emission light 462 from each image pattern 782 of the each light emission point in the multipoint light emitter (VCSEL) is greatly increased. As a result, the light overlapping area 774 is greatly enlarged, and the synthesized light 230 that greatly reduces the optical interference noise is formed. Note that a method of greatly enlarging the light overlapping area 774 is not limited to the concave lens 310 described above, and for example, a diffuser, a diffraction grating, a Fresnel lens, or the like may be disposed immediately after the second image pattern forming plane 376 of the multipoint light emitter 468 or immediately before the second image pattern forming plane 376.

According to FIG. 108 (b) compared with FIG. 108 (a), the spread angle “θ” of the incident light immediately before the floodlight lens 398 is greatly increased. If the cross-sectional area (spot size) of the incident light immediately before the floodlight lens 398 is bigger than the pupil diameter of the floodlight lens 398, total intensity of light passing through the floodlight lens 398 (light power efficiency) is reduced. However, as long as the general VCSEL 128 is used, a significant reduction of light power efficiency does not occur. This is because, as illustrated in FIG. 108 (a), the spread angle “θ” of the emission light 462 from the image pattern 782 of each light emission point formed on the second image pattern forming plane 376 is sufficiently small. Therefore, even when the concave lens 310 having a small absolute value of focal length is used, a significant reduction in light power efficiency does not occur.

Incidentally, the concave lens 310 has not only an effect of enlarging the light overlapping area 774 but also an effect of forming a virtual image having a small image pattern size. FIG. 108 (b) shows that the concave lens 310 forms a virtual image when the concave lens 310 is viewed from the floodlight lens 398. Moreover, a virtual image pattern size formed by the concave lens 310 is very small.

In an image forming optical system formed by a large light emitting area in the wide area light emitter (multipoint light emitter) 468 such as the VCSEL 128, there is a limit to reduction of an image pattern size. Therefore, a virtual image having a very small image pattern size can be formed when the concave lens 310 is further disposed immediately after a reduced image pattern formed in the image forming optical system. Accordingly, when the virtual image size is reduced using the concave lens 310, the synthesized light 230 with less optical interference noise can be generated efficiently. The reason is described below.

As the principle of reducing the optical interference phenomenon has been previously described with reference to FIG. 84, in the present embodiment example, it is desirable to synthesize the plurality of light elements 202 to 207 in which the optical path length difference with each other exceeds the coherence length (or twice thereof). In this synthesis of the light elements 202 to 207, the propagation directions of the light elements 202 to 207 are desirably parallel to each other.

Incidentally, when the individual light emission point patterns 782 formed on the second image pattern forming plane 376 are separated as illustrated in FIG. 108 (a), the propagation directions of the respective emission lights 462 after passing through the floodlight lens 398 are inclined to each other. According to FIG. 108 (b) in comparison to FIG. 108 (a), since the virtual image size is sufficiently small, the propagation directions of the respective emission lights 462 after passing through the floodlight lens 398 are substantially parallel to each other. As a result, the optical interference characteristic in the synthesized light 230 generated by passing through the floodlight lens 398 is greatly reduced. Accordingly, the occurrence of optical interference noise is greatly reduced when the synthesized light 230 is used. Means for generating the virtual image is not limited to the concave lens 310 having a spherical surface on one side. That is, in the present embodiment example, any virtual image generation means may be used. For example, a Fresnel-shaped concave lens, a hologram element, or the like may be used as the virtual image generation means.

There is an advantage that the reduced virtual image can be optically used as a quasi-point emission source. Using this quasi-point light emission source (reduced virtual image), a very small focused spot can be created. The present embodiment example may use the synthesized light 230 generated in FIG. 108 (b) as the irradiated light (first light) 13 in FIG. 53 (or FIG. 137). When the position of the floodlight lens 398 is optimized, the irradiated light (first light) 13 can be made to converge on the surface of the measured object 22. The spot size on the surface of the measured object 22 is determined by the image forming magnification of the floodlight lens 398. Here, when a size of the virtual image formed by the concave lens 310 is sufficiently small, an effect of reducing the image forming spot size on the surface of the measured object 22 is achieved.

When a position of the floodlight lens 398 is changed, the spot size on the surface of the measured object 22 can be freely enlarged. Therefore, when a lower limit value of the spot size on the surface of the measured object 22 can be reduced, the degree of freedom of an adjustment range of the spot size on the surface of the measured object 22 is improved. An application example of the quasi-point light emission source (reduced virtual image) is not limited thereto. For example, as described later with reference to FIG. 110, when a small focused spot can be created on the incident surface of the optical waveguide (optical fiber/light waveguide/optical guide) 110, an effect of improving light power efficiency of light passing through the optical waveguide (optical fiber/light waveguide/light guide) 110 is also achieved.

FIG. 109 illustrates verification experiment data regarding the effect of the optical characteristic converting component 210 (optical characteristic converting component 196 based on light reflection) used in FIG. 106. In this verification experiment, the WL-VCSEL3535 manufactured by Wuerth was used as the VCSEL 128. In the WL-VCSEL3535 immediately after purchase, a diffuser is normally built into an emission port for the emission light 462. On the other hand, a verification experiment was performed in advance in a state in which a built-in diffuser was removed. Note that a pulse light emission condition for the VCSEL 128 matches the condition described with reference to FIG. 71.

The horizontal axis in FIG. 109 expresses the total number of divided areas 788 in the optical characteristic converting component 210 (optical characteristic converting component 196 based on light reflection). In addition, as a standard sample generating the optical interference noise, a surface of an aluminum plate with the “Ra (averaged roughness) value” of “0.142 μm” was used and light is reflected in a direction of 90 degrees on the surface. A “relative speckle contrast 786” regarding speckle noise indicating the magnitude of speckle noise is expressed on the vertical axis in FIG. 109.

Note that “[standard deviation value of variation in light reflection intensity]/[average value of light reflection intensity]” is defined as a “Cs (speckle contrast) value”. And the present embodiment example define a value of the “relative speckle contrast 786” as “100%” when the verification experimental system removes the optical characteristic converting component 210 (optical characteristic converting component 196 based on light reflection).

In the optical system (the verification experimental system) shown in FIG. 106, since the floodlight lens 398 moves, the surface of the aluminum plate can be irradiated with light in any spot size. The experimental data of “relative speckle contrast 786” represent “outlined circular marks” in FIG. 109 when light converges on the surface of the aluminum plate (the surface of the aluminum plate has a confocal relation to the virtual image formed by the concave lens 310 and an enlarged imaging pattern from the virtual image is formed on the surface of the aluminum plate). And the experimental data of “relative speckle contrast 786” represent “outlined square marks” in FIG. 109 when the surface of the aluminum plate is irradiated by the divergent light forming a far field pattern.

The verification experimental data shown in FIG. 109 confirms the speck noise reduction effect of the optical characteristic converting component 210 (optical characteristic converting component 196 based on light reflection). Note that theoretically, the “relative speckle contrast 786” decreases in proportion to the “−¼ power” of the total number of divided areas of the optical characteristic converting component 210 (optical characteristic converting component 196 based on light reflection). Both the experimental data on the image forming (confocal) plane (outlined circular mark) and the experimental data on the far field plane (outlined square mark) show data almost similar to theoretical curves.

In the present embodiment application example illustrated in FIG. 110, two optical characteristic converting components 210 (an optical characteristic converting component based on light reflection 196 and an optical characteristic converting component based on light transmission 198) are positioned in both the far-field area 378 and the near-field area 372 of the light emitter 472. Therefore, both the far-field area 378 and the near-field area 372 of the light emitter 472 perform the “divisions of emission light 462 (the initial light 200) and generations of an optical path length difference between divided light elements 202 to 207”. The emission light 462 from the “light emission point α” in the light emitting area (light emitting plane 370) of the light emitter 472 having a spatially wide light emitting area reaches the “γ point” via the “β point”. The emitting light 462 from the “light emission point δ” reaches the “ζ point” via the “ε point”. Further, the emitting light 462 from the “light emission point η” reaches the “ξ point” in a photodetector 250 via the “κ point” in the reflective optical characteristic converting component 196.

The image forming lens 450-1 constitutes an image forming optical system, and generates the first image forming plane 375 (near-field area 372) with respect to a light emitting area (light emitting plane 370) of the light emitter 472 having a spatially wide light emitting area. Then, the reflection plane of the reflective optical characteristic converting component 196 is arranged in this area or the vicinity thereof.

An optical path passing through the “ε point” on the surface of the reflective optical characteristic converting component 196 corresponds to the first optical path 222, and an optical path passing through the “β point” corresponds to the second optical path 224. The “α point” and the “β point” are arranged on mutually different reflection planes constituting the step on the surface of the reflective optical characteristic converting component 196. As a result, an optical path length difference is generated between the first optical path 222 and the second optical path 224 in or near the near-field area 372.

And the present embodiment application example may arrange the optical characteristic converting component 198 based on light transmission between the surface of the optical characteristic converting component based 196 on light reflection and the second image pattern forming plane of the light emitter 472 (the near-field area 372). The optical characteristic converting component 198 based on light transmission is not limited to the structure described with reference to FIGS. 85 (b) to 89, and may have any shape/structure having functions of light division and optical path length difference generation.

In addition, the optical characteristic converting component 198 based on light transmission is arranged in the far-field area 378 of the light emitter 472, and forms the third optical path 226 and the fourth optical path 228. The third optical path 226 and the fourth optical path 228 have different thicknesses inside the optical characteristic converting component 198 based on light transmission.

As a result, an optical path length difference (the coherence length “ΔL0” or twice or more thereof) occurs between the third optical path 226 and the fourth optical path 228.

The optical patterns observed in the near-field area 372 and in the far-field area 378 are in a relation of Fourier transform with each other. Therefore, the light reflected at each of the “ε point” and the “β point” in the near-field area 372 spreads and overlaps each other on the far-field area 378 immediately after the collimator lens 318. Therefore, when the optical characteristic converting component 198 based on light transmission is arranged on the far-field area 378 and division of the wavefront is performed, the light spreading and overlapping each other is divided.

That is, a part of the light reflected at the “ε point” and a part of the light reflected at the “β point” in the near-field area 372 (on the first image pattern forming plane 375 of the light emitter 472) pass through the third optical path 226 in the optical characteristic converting component 198 (optical characteristic converting component 210) based on light transmission arranged on the far-field area 378 at the same time. Similarly, another part of the light reflected at the “α point” and another part of the light reflected at the “β point” in the near-field area 372 also pass through the fourth optical path 228 in the optical characteristic converting component 198 based on light transmission (optical characteristic converting component 210) at the same time.

In addition, not limited to the arrangement situation of the optical characteristic converting components 210 shown in FIG. 110, the present embodiment application may select the optical characteristic converting component based on light reflection 196 or the optical characteristic converting component based on light transmission 198 as an optical characteristic converting components 210 located in the in far-field area 378 from the light emitter 472. Moreover, the present embodiment application may also select the optical characteristic converting component based on light reflection 196 or the optical characteristic converting component based on light transmission 198 as an optical characteristic converting components 210 located in the first image pattern forming plane 375 of the light emitter 472 (near-field area 372).

The present embodiment application example may have two different length units “Un” and “Uf”. Here, the first optical characteristic converting components 210 located in the first image pattern forming plane 375 of the light emitter 472 (near-field area 372) provides a first optical path length difference between the first light element 202 and the second light element 204, and the first optical path length difference equals to a multiple number of the first length unit “Un”. And the second optical characteristic converting components 210 located in the far-field area 378 provides a second optical path length difference between the third light element 206 and the fourth light element 207 and the second optical path length difference equals to a multiple number of the second length unit “Uf”.

For example, in case of VCSEL 128 having the central wavelength of “λ0=850 nm” and the wavelength width of “Δλ=2 nm”, Equation 36 (Formula 36) teaches us that the coherence length value equals to “ΔL0=0.36 nm”. Therefore, the present embodiment application example may set “0.72 mm” as a value of the second length unit “Uf”. In the meantime, one step distance (mechanical length or thicknesses different) “tt” between different areas 216 and 218 in the optical characteristic converting component 198 based on light transmission having a refractive index “n” satisfies a relation of “Uf=(n−1) tt” when the present embodiment application example locates the optical characteristic converting component 198 based on light transmission in the far-field area 378, and “tt=1.4 mm”.

The present embodiment application example may divide the optical characteristic converting component 198 based on light transmission into four areas. And then the present embodiment application example may set a value of the first length unit “Un” as “Un=4Uf, so that “Un=2.9 mm”. Moreover, the present embodiment application example may locate the optical characteristic converting component 196 based on light reflection having the structure described in FIGS. 102 and 103 in the near-field area 372 (the first image pattern forming plane 375 of the light emitter 472). When “n” represents a refractive index of the transparent dielectric layer 288 and “tr” represents one step distance (mechanical length) between neighboring light reflection faces 234, Equation “Un=2 ntr” is established, so that “tr=1 mm”.

As described above, the division number of the product of the wavefront division number of a first optical characteristic converting component 210 (the optical characteristic converting component 196 based on light reflection) arranged in the first image pattern forming plane 375 of the light emitter 472 (the near-field area 372) and the wavefront division number of a second optical characteristic converting component 210 (the optical characteristic converting component 198 based on light transmission) arranged in the far-field area 378 is generated in the optical system.

As shown in FIG. 109, the effect of reducing the optical interference noise is further improved as the number of divisions of the emitting light (initial light 200) of the light emitter 472 increases. Therefore, when division of emitting light and generation of an optical path length difference between divided light elements are performed in both the far-field area 378 and the near-field area 372 of the light emitter 472 as illustrated in FIG. 110, an effect of further improving the effect of reducing the optical interference noise is produced.

A converging lens 330 condenses the light passing through the optical characteristic converting component 198 based on light transmission. And as described in the explanation regarding FIG. 108 (b), a combination between the concave lens 310 and the floodlight lens 398 forms the synthesized light 230. Moreover, the floodlight lens 398 forms a third image pattern of the virtual image generated by the concave lens 310. And then a small spot size of the third image pattern can be formed on the inside surface of an optical waveguide (optical fiber/optical path/optical guide) 110.

In the present embodiment application example of FIG. 110, the inclination angle of the reflection plane including the “K point” in the reflective optical characteristic converting component 196 (the optical characteristic converting component based 196 on light reflection) is set to a value different from the inclination angle of the reflection plane including the other “¿ point” and “β point”. As a result, the traveling direction of the emitting light reflected by the reflection plane including the “κ point” changes with respect to the traveling direction of the emitting light reflected by the other reflection plane. Then, the image forming lens 450-2 converges the emitting light on the “ξ point” in the photodetector 250.

As illustrated in the present embodiment application example of FIG. 110, when the monitor light is extracted using the light reflection on a part of the reflection plane in the reflective optical characteristic converting component 196 (the optical characteristic converting component based 196 on light reflection), the light emitter 472 and the photodetector 250 can be arranged in a close location. When both can be arranged close to each other, a wire rod connecting both can be shortened. As a result, an effect of improving the response speed of the light intensity feedback is produced.

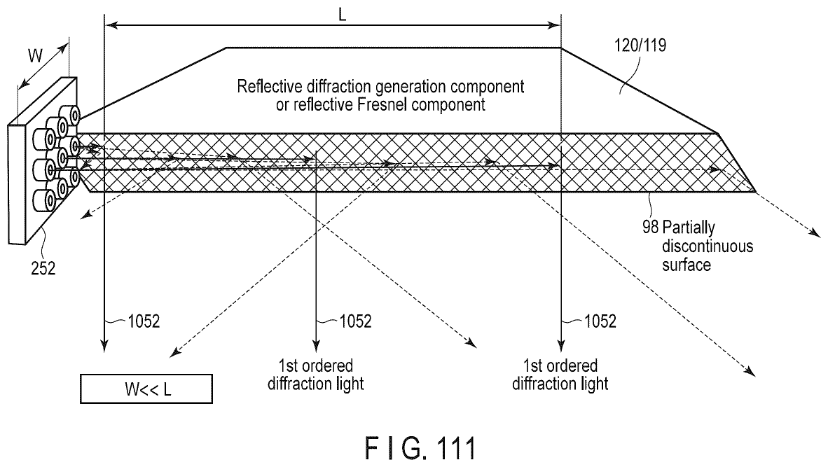

FIG. 111 illustrates an embodiment example in which the partially discontinuous surface (curved or plane surface) 98 is arranged in the middle of the optical path of the emitting light 462 from the wide area light emitter (or multipoint light emitter). FIG. 111 illustrates an example in which a phase synchronizing type multipoint light emitter (surface light source/VCSEL 128) 252 is used as the wide area light emitter. In the phase synchronizing type multipoint light emitter (surface light source/VCSEL 128) 252, the beams of the emitting light 462 from different light emission points (light passing windows 490) arranged in the multipoint light emitting area have a coherence profile. It has been described above that when the partially discontinuous surface (curved or plane surface) 98 is arranged in the middle of the optical path of the emitting light 462 (initial light 200), this coherence profile is reduced.

In the embodiment example of FIG. 111, the reflective diffraction generation component 120 or the reflective Fresnel component 119 is used as the optical component having the partially discontinuous surface (curved or plane surface) 98. The partially discontinuous surface (curved or plane surface) 98 in the reflective diffraction generation component 120 or the reflective Fresnel component 119 is arranged at an oblique position with respect to the traveling direction of the emitting light 462.

When the reflective diffraction generation component 120 is blazed in use, the diffraction efficiency of the first ordered diffracted light 1052 is improved. When the reflective Fresnel component 119 is used, the inclination angle is optimized. In this way, many light elements of the emitting light 462 reflected by the partially discontinuous surface (curved or plane surface) 98 are devised to travel downward in FIG. 111. That is, when a fine shape in the partially discontinuous surface (curved or plane surface) 98 is manipulated, the traveling direction of the emitting light 462 can be efficiently controlled.

In the embodiment example in FIG. 111, the divergence (large divergence angle) in the traveling direction of the emitting light 462 from the multipoint light emitter 252 such as VCSEL is effectively used, and the emitting light 462 is devised to travel in the wide divergence direction after being reflected by the partially.

The partially discontinuous surface (curved or plane surface) 98 is arranged at an oblique position with respect to the traveling direction of the emitting light 462 to widen the light reflection area in the partially discontinuous surface (curved or plane surface) 98. That is, a structure in which the width “L” of the light reflection area in the partially discontinuous surface (curved or plane surface) 98 is sufficiently widened (W<<L) as compared with the width “W” of the wide light emitting area (that is, the multipoint light emitting area of VCSEL) in the light emitter 470 is provided.

When light that is simultaneously emitted by all the light emission points within the wide light emitting area (i.e., the multipoint light emitting area of the VCSEL 128) enters the user's eye, there is a risk of damaging the retina 156. By sufficiently widening the width “L” of the light reflection area as described above, the burden on the user's eyes can be greatly reduced. In consideration of the burden on the user's eyes, the light reflection area width “L” is desirably “1 mm” or more (desirably “3 mm” or more). In addition, the light reflection area width “L” is desirably “1 m” or less (desirably “100 m” or less) due to physical restrictions in implementation.

FIG. 112 illustrates a basic principle of occurrence of speckle noise, which is a type of optical interference noise. In FIG. 112 (a), two light reflection areas 1046 separated by an interval “P” are arranged. FIG. 112 (a) illustrates an incident light beam 1042 is perpendicularly incident on the light reflection area 1046 and a reflection intensity characteristic of a reflected light beam 1048 reflected in a “θ0” direction. According to the interference theory of light, the reflection intensity at that time is proportional to “cos 2(πPθ0/λ)”. What is important here is that the reflection intensity periodically changes in the reflection direction “θ0” of the reflected light beam 1048. This periodic change in reflection intensity is related to the speckle noise.

In FIG. 112 (a), only two light reflection areas 1046 separated by the interval “P” are illustrated. This will be further expanded, and a case where a very large number of (three or more) light reflection areas 1046 are regularly arranged with an interval “P” will be considered. Then, a state in which the light reflection areas 1046 are periodically arranged over a wide area is assumed.

In a case where a position of the user's eye observing the reflected light beam 1048 is fixed, the reflection direction “θ0” entering the user's eye changes for each reflection location in the light reflection areas 1046. Therefore, there are a location where the reflection amplitudes from the adjacent light reflection areas 1046 intensify each other and look bright, and a location where the reflection amplitudes cancel each other and look dark. Such appearance appears as a speckle noise pattern.

FIG. 112 (b) illustrates the reflection intensity of the reflected light beam 1048 reflected in the “θ0” direction when an incident angle of the incident light beam 1042 on the two light reflection areas 1046 changes to “θi”. According to the interference theory of light, the reflection intensity at that time changes to “cos 2{πP(θ0−θi)/A}”.

Since there is no optical interference (or mutual temporal coherence is low) between the different divided Wave Trains 406 and 408 shown in FIG. 83, optical synthesis between the different divided Wave Trains 406 and 408 results in intensity summation (synthesis of light intensity values).

For example, as illustrated in FIGS. 112 (a) and 84, the first light element 202 corresponding to at least one Wave Train 406 after wavefront division is caused to be perpendicularly incident on the two light reflection areas 1046. At the same time, the “second light element 204 corresponding to the delay Wave Train 408 after wavefront division having low temporal coherence” is caused to be incident at the incident angle “θi” as illustrated in FIG. 112 (b).

Then, the light intensity of the synthesized light 230 (intensity-summated light) reflected in the “θ0” direction is given by “cos 2(πPθ0/λ)+cos 2{πP(θ0−θi)/λ}”. For example, when the value of “θi” is optimized such that the light intensity of the second term is minimized at the maximum light intensity of the first term of the previous Equation, the maximum and minimum light intensities are cancelled (averaged or smoothed). As a result, the speckle noise (optical noise) is greatly reduced.

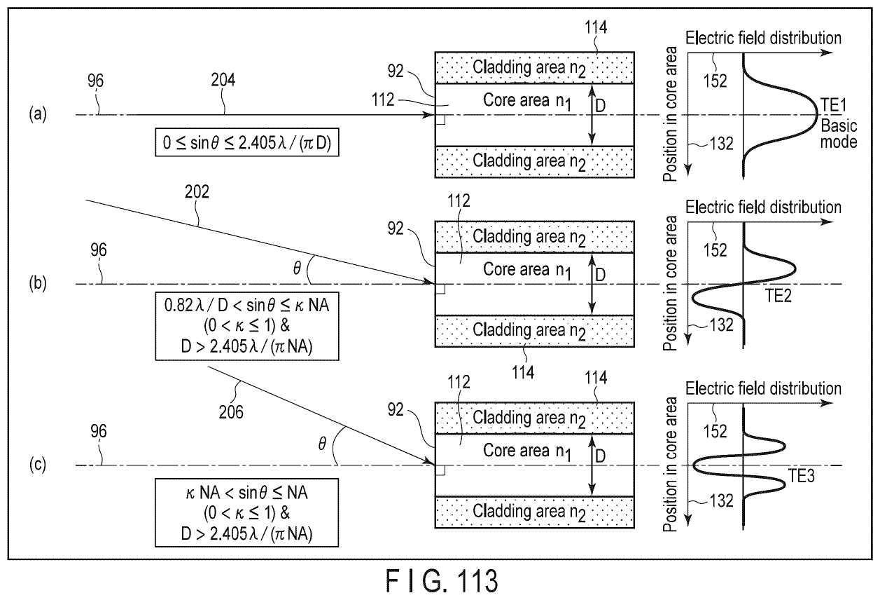

A method for controlling the light traveling direction (irradiation angle) after being emitted from the waveguide component using the optical path change of the light passing through the waveguide component (optical fibers, optical guides, optical waveguide, and the like) 110 in the present embodiment example will be described with reference to FIGS. 113 to 115.

FIG. 113 illustrates a relation between the incident angle “θ” on the waveguide component 110 and the light propagation mode (electric field distribution 152) in the core area 112. Here, as an example, a light propagation mode in an optical fiber that is a type of the waveguide component 110 will be described. With reference to a perpendicular line of the incident surface 92 of the optical fiber (predetermined optical member), an angle with light incident on the incident surface 92 is defined as an incident angle “θ”.

The optical fiber used in FIG. 113 is assumed to be a multimode fiber. As the multimode fiber used in the present embodiment example, either a step-index (SI) type or a graded index (GI) type may be used.

FIG. 113 (a) illustrates a state in which the second light element 204 is incident on the core area 112 in the optical fiber. The second light element 204 is incident on the core area 112 from a direction substantially parallel to the incident surface side perpendicular line 96. At this time, a case where the second light element 204 is incident on a substantially center portion in the core area 112 is considered. Then, a state in which the electric field distribution 152 of the second light element 204 in the core area 112 forms a basic mode (transverse electric (TE) 1) is assumed. From the light propagation mode theory in the optical fiber, a range of the incident angle “0” at which this state occurs satisfies a condition of “0≤sin θ≤2.405λ/(HD)”. Here, a variable “D” indicates a diameter value in the core area 112. In addition, a variable “λ” indicates a wavelength of light propagating in the core area 112.

FIG. 113 (b) illustrates a state in which the first light element 202 is incident on the core area 112. In the present embodiment, the incident angle “θ” of the first light element 202 is set to be larger than the incident angle “θ” of the second light element, and an electric field distribution mode (higher order mode) different from the second light element is formed in the core area 112. In a “TE2 mode” among the higher order modes, as illustrated on the right side in FIG. 113 (b), an electric field value becomes “θ” at a center portion of a cross section position 132 in the core area 112. Then, the polarity of the electric field is inverted in a direction in which the cross section position 132 in the core area 112 is shifted.

A condition of the incident angle “θ” for generating the “TE2 mode” in the core area 112 needs to simultaneously satisfy both a condition of “0.82λ/D<sin θ≤κNA” and a condition of “D>2.405λ/(πNA)” when calculated using the light propagation mode theory in the optical fiber. Here, a variable “NA” indicates an NA value of the optical fiber. That is, a maximum incident angle “θmax” at which light can propagate in the core area 112 of the optical fiber is defined as “NA=sin θ max”. Here, a value of a variable “κ” is considered to be appropriate at “¾” (desirably “½”). Furthermore, when “κ=¼” is set, the probability of taking the “TE2 mode” increases.

A difference between the basic mode (TE1 mode) and the “TE2 mode” (higher order mode) in the core area 112 appears in a difference in intensity distribution characteristics of the outgoing light beam from the optical fiber. For example, in a case where the second light element 204 is propagated in the basic mode (TE1 mode) in the core area 112, the light cross section intensity distribution (far field pattern) at a location away from the emission location from the optical fiber is ‘Intensity distribution in which the center is bright and the periphery is dark’. On the other hand, in a case where the first light element 202 is propagated in the “TE2 mode” in the core area 112, a ‘doughnut-shaped intensity distribution in which a center portion is relatively dark and an area slightly deviated from the center portion is bright’ is indicated. Therefore, by observing the intensity distribution of the outgoing light beam from the optical fiber, a difference in the mode of the light propagated through the core area 112 can be predicted.

FIG. 113 (c) illustrates a state in which the incident angle “θ” (angle between the traveling direction of the third light element 206 immediately before being incident on the incident surface 92 of prescribed optical component and the perpendicular line 96 to incident surface) of the third light element 206 is set to be larger than that of the first light element 202. The condition of the incident angle “e” at this time needs to simultaneously satisfy both conditions of “κNA<sin θ≤NA” and “D>2.405λ/(πNA)” as a result of calculation using the light propagation mode theory in the optical fiber.

The light propagation mode in the optical fiber in a case where the incident angle “θ” satisfies the above conditions is an electric field distribution 152 of a “TE3” mode illustrated in a right diagram in FIG. 113 (c). In this case, a value of the electric field takes a negative value at the center portion of the core area 112.

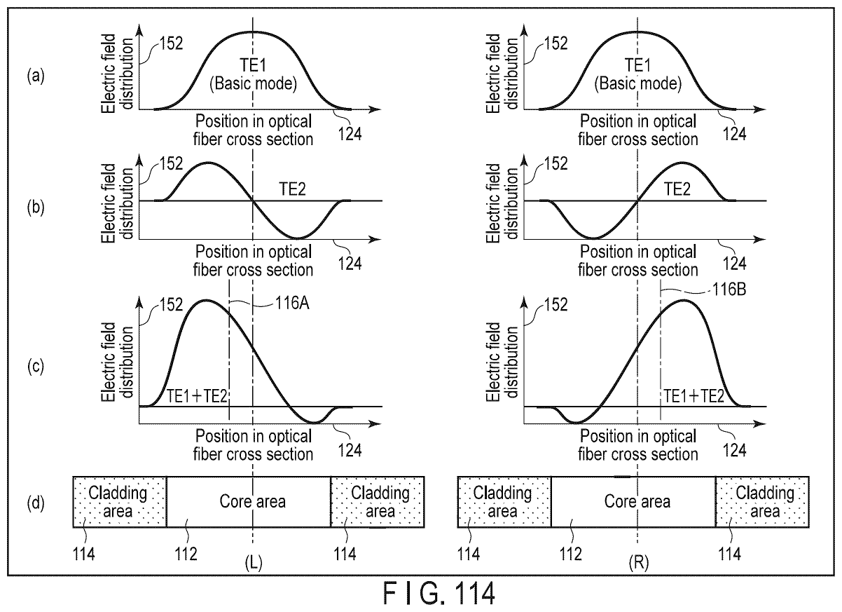

FIG. 114 illustrates a combination state of the symmetric mode forming light and the asymmetric mode forming light with respect to the center position in the core area 112. FIG. 114 (a) illustrates an electric field distribution 152 of the symmetric basic mode (TE1 mode) forming light. FIG. 114 (b) illustrates an electric field distribution 152 of the asymmetric “TE2 mode” forming light. FIG. 114 (c) illustrates an electric field distribution 152 obtained by combining the two electric field distributions.

In the “TE2 mode” illustrated in FIG. 114 (b), there are two cases where the position 124 indicating a large electric field value is on the left side (L) and the right side (R). Therefore, the gravity center position when the intensity distribution of the synthesized light (FIG. 114 (c)) is taken is shifted between the left diagram (L) and the right diagram (R). That is, in the left side (L) in FIG. 114 (c), a gravity center position 116A is shifted to the left side from the center position in the core area 112. In addition, in the right side (R) in FIG. 114 (c), a gravity center position 116B is shifted to the right side from the center position in the core area 112.

The gravity center position shift is not limited to the light forming the “TE2 mode”. For example, when arbitrary light, such as “TE4” or “TE6”, in which the electric field distribution 152 exhibits asymmetric characteristics is synthesized, a gravity center position shift occurs. In the above description, the SI type optical fiber has been mainly described. However, the present invention is not limited thereto, and the above description is similarly applied to a GI type optical fiber.

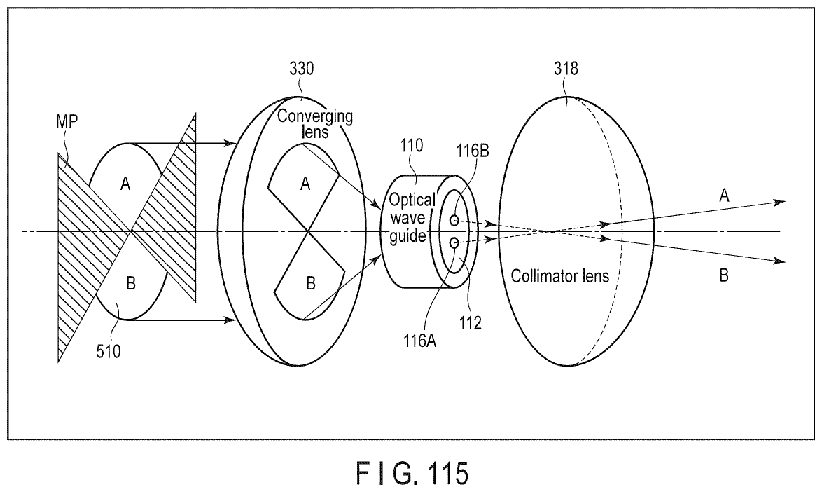

FIG. 115 illustrates an embodiment example in which the speckle noise is reduced using the gravity center position shift. A mask pattern MP is arranged in the optical path of the parallel light, and only an upper sector area “A” in a cross-sectional profile of laser light 510 is extracted. The converging lens 330 converges the extracted light into the core area 112 of the waveguide component (optical fiber/optical waveguide/optical guide) 110. Then, at the outlet of the waveguide component (optical fiber/optical waveguide/optical guide) 110, a gravity center position 116A of the intensity distribution is generated at a position shifted from the center position of the core area 112. The collimator lens 318 converts the outgoing light beam from the waveguide component (optical fiber/optical waveguide/optical guide) 110 into parallel light.

Then, in a case where only a lower sector area “B” in the cross-sectional profile of laser light 510 is extracted, a gravity center position 116B of the intensity distribution is generated in the exit surface of the waveguide component (optical fiber/optical waveguide/optical guide) 110. The gravity center position 116B appears at a position opposite to the gravity center position 116A with respect to the center position of the core area 112.

The traveling directions of the parallel light after passing through the collimator lens 353re slightly shifted from each other at “A” and “B”. A case where the temporal coherence between the “light element A” extracted in the “upper sector area A” and the “light element B” extracted in the “lower sector area β” is low (unsynchronized optical phase 402 is established) will be considered. When the measured object 22 is simultaneously irradiated with the light elements of “A” and “B” having different traveling directions using the Koehler illumination system 1026, the speckle noise amount is reduced.

FIG. 115 illustrates a speckle noise amount reduction method in the case of using two types of light beams having low temporal coherence (having a relation of the unsynchronized optical phase 402) and having passed through only the “A area” and the “B area” in the cross-sectional profile of laser light 510.

Next, a case where the optical characteristic converting component 210 divided into eight (divided into eight angles) in the angular direction 358 illustrated in FIG. 85 (b) is used will be described. The light elements (the first to fourth light elements 202 to 207) having passed through the respective areas have an optical path length difference equal to or larger than the coherence length “ΔL0” (a double value thereof). Then, eight gravity center positions 116 having mutually different intensity distributions are formed in the exit surface of the waveguide component (optical fiber/optical waveguide/optical guide) 110.

When the outgoing light elements from the waveguide component (optical fiber/optical waveguide/optical guide) 110 are converted into parallel light by the collimator lens 318, traveling directions of the respective elements (first to fourth light elements 202 to 207) passing through the collimator lens 318 from the different gravity center positions 116 are shifted from each other. That is, when the cross-sectional profile of laser light 510 is angularly divided as a method for dividing the initial light 200 using the optical characteristic converting component 210, an asymmetric electric field mode (TE2 or the like) is easily formed in the core area 112. This produces an effect of improving the effect of reducing the speckle noise.

In FIG. 115, the converging lens 330 converges light onto the incident surface 92 in the core area 112. A phenomenon in which the effect of reducing the speckle noise is weakened when a spot size incident on the incident surface 92 in the core area 112 is increased was confirmed by an experiment. It is considered that the effect of reducing the speckle noise is weakened since a big phase shift of the light passing in the core area 112 occurs due to total reflection at the interface between the core area 112 and the cladding area 114.

When a ratio of the spot size (diameter) on the incident surface 92 in the core area 112 to the diameter “D” in the core area 112 is set to “1” or less, the effect of reducing the speckle noise amount increases. The ratio is preferably “¾” or less or “½” or less.

Note that any light emitter 470 can be used for the optical system described in Chapter 4. For example, optical interference noise can also be reduced for white light such as sunlight or emission light 462 from a thermal light source such as a halogen lamp or a mercury lamp as panchromatic light. The exemplified FIG. 86 illustrates an optical interference noise reduction effect for the emission light 462 from a halogen lamp.

Furthermore, as monochromatic light (light having a narrow wavelength width Δλ), for example, the same effect can be obtained for the emission light 462 from the end surface emitting type semiconductor laser or the multipoint emission type VCSEL 128. For example, FIG. 109 illustrates an optical interference noise reduction effect for emission light 462 from the VCSEL 128.

Chapter 5 Service provision application example using three-dimensional projective reverse transformation technique

Chapter 5 describes application embodiment examples of services provided for users by the optical device 10 (or a part thereof) described in Chapter 1. Note that the optical system described in Chapter 4 may be used, and services may be provided for users using the three-dimensional projective reverse transformation or the three-dimensional projective transformation (previously described in Chapter 2) using the distance information regarding the measured object 22 (previously described in Chapter 3).

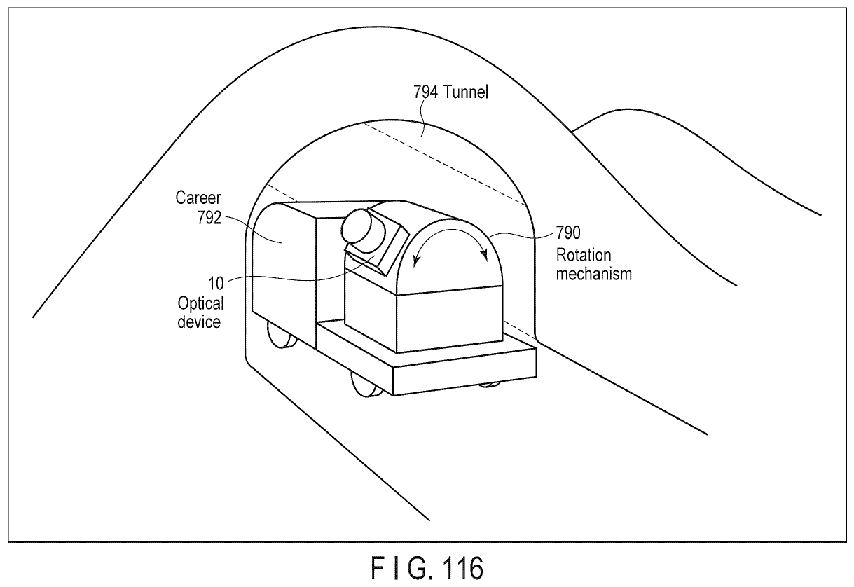

FIG. 116 illustrates an application embodiment example of using the three-dimensional projective reverse transformation and the three-dimensional projective transformation for degradation detection inside public facilities in an infrastructure health field. For example, when an inner wall of the tunnel 794 deteriorates, there is a risk that a part of the inner wall may be peeled off. At an initial stage of inner wall deterioration, a phenomenon occurs in which a gap is generated inside the inner wall and a part of the inner wall swells.

As previously explained in Chapter 2, a three-dimensional shape of the inner wall inside the tunnel 794 can be easily measured using the three-dimensional projective reverse transformation and using the imaging sensor 270 relating to a depth (distance) signal. The swelling portion of a part of the inner wall detected as a result can be enlarged through three-dimensional projective transformation and be displayed to a user. Accordingly, the user can easily find the deteriorating portion at a high speed.

As a specific measurement form, as illustrated in FIG. 116, the optical device 10 is placed and moved on an optical device career 792. The view line direction of the optical device 10 is inclined using the rotation mechanism 790 while the optical device career 792 moves the optical device 10 in the linear direction.

As a deterioration detection example of a public facility in the infrastructure health field, a three-dimensional shape measurement example of the inner wall inside the tunnel 794 has been described above. However, the present embodiment is not limited thereto, and may be used for state change or detailed state measurement of any public facilities or construction facilities.

FIG. 117 illustrates another application embodiment example relating to FIG. 5. So far, in a business environment and a learning environment using a personal computer, a “two-dimensional interface” has been mainly used. For example, literatures (a list of texts) in a two-dimensional area displayed on the display 18 are often read as data output forms. In addition, as an input form, there are many cases where a numerical value or text content displayed in a two-dimensional area (display 18) is confirmed by keyboard input. In comparison, in a business environment and a learning environment illustrated in FIG. 117, a “three-dimensional interface” is desirable to be mainly used.

FIG. 117, similarly to FIG. 5, shows the display 18 that enables three-dimensional display with the naked eye is provided. The measurer 8 detects three-dimensional positions of the right side eye and the left side eye of the user. With respect to the three-dimensional display viewed by naked eyes, a two-dimensional image (or a two-dimensional movie) viewed by the right side eye propagates toward the right side eye position, and another two-dimensional image (or a two-dimensional movie) viewed by the left side eye propagates toward the left side eye position. A convergence angle between the left and right view lines provides a three-dimensional effect to the user. Note that, as described with reference to FIG. 24, images (or movies) focused on near and distant objects can be simultaneously displayed. Therefore, according to the present embodiment previously explained in Chapter 2, adjustment of the crystalline lens 682 (see FIG. 26) is unnecessary when viewing both near and distant display areas (or movies) included in three-dimensional display, and the user's convenience is improved.

In FIG. 117, similarly to FIG. 5, the light sources 2 are disposed at positions of distances “W1” and “W2” away from the measurers 8. When the divergent light is emitted from the light source 2, the distance “Z” to the measured object 22 can be calculated using Equation 17. As described in step 56 in FIG. 32, a three-dimensional shape, three-dimensional coordinate values, or a time variation thereof may be extracted for each constituent element in the measured object 22 (or the imaging pattern of user shown on the display 18).

For example, a time variation in the head position of the user may be extracted (motion of the user's head may be detected) as a constituent element in the user (measured object 22). A user's head nod 190 indicating agreement may be interpreted as an affirmative opinion. Accordingly, the user's head nod 190 may be used for “an interface corresponding to a determination function” (typing (key-in action) of the “enter key” on the conventional keyboard). Furthermore, a user's headshake 192 indicating denial may be interpreted as a negative opinion. Accordingly, the user's headshake 192 may be used for “an interface corresponding to cancel (or delete) function” (typing (key-in action) of the “delete key” on the conventional keyboard).

In addition, a time variation of the position in both eyes 594 of the user may be extracted (motion detection of both eyes of the user) as a constituent element in the user (measured object 22). The display 18 in FIG. 117 performs three-dimensional display. As previously illustrated in FIG. 16, “the light shield object 666 positioned near to the user” conceals a part of “the measured object 676 positioned far from the user”. Therefore, the position in both eyes 598 of the user may change when the user want to look at the part of “the measured object 676 positioned far from the user”. Based on the time variation of the position in both eyes 594 of the user (motion detection of both eyes of the user), the three-dimensional projective transformation display described in Chapter 2 performs in real time.

The above description shows the three-dimensional display 18 based on the detection result of the time variation regarding the position in both eyes 594 of the user. As the present embodiment application example, a detection result of the time variation regarding the position in both eyes 594 of the user may be used for the purpose of “protecting the user's eyes”.

FIG. 117 shows that the irradiated light (first light) 13 is emitted from the light source 2 as “divergent light”. Therefore, the closer to the emission port of the light source 2, the higher the light intensity density of the irradiated light (first light) 13. Therefore, as a method of “protecting the user's eyes” when the position in both eyes 594 of the user approaches the emission port of the light source 2, the present embodiment application example may performs the following countermeasures.
[a] Emission of the irradiated light (first light) 13 is stopped.
[b] The maximum light intensity of the intensity-modulated irradiated light (first light) 13 is reduced.
[c] An effective emission period of the intensity-modulated irradiated light (first light) 13 is reduced.
[d] “A notification of danger is provided to the user” on the display 18.
[e] “A notification of danger is provided to the user” using sound output.
[f] A notification of “danger” is provided to relevant parties using network communication means.

The distance from the position in both eyes 594 of the user to the emission port of the light source 2 in the embodiment example in FIG. 117 is estimated as “10 cm or more and 2 m or less” in a standard state (in an allowable range). When the distance from the position of both eyes 594 of the user to the emission port of the light source 2 decreases to half of the standard state, the light intensity density of the irradiated light (first light) 13 increases to “4 times”. Therefore, in the present embodiment application example, at least one of the above [a] to [f] may be executed in a case where the distance from the position in both eyes 594 of the user to the emission port of the light source 2 decreases to a root value of the standard state or half or less (at the minimum, “⅓” or less) of the standard state.

Furthermore, as described with reference to FIGS. 95 and 96, a 3D fine structure 88 of venous in user's finger may be measured (motion detection of both eyes of the user) as a constituent element in the user (measured object 22). Accordingly, personal authentication of each user can be performed with high accuracy. In the embodiment example illustrated in FIG. 117, a plurality of measurers 8 may be disposed. Therefore, the measurer 8 disposed on the lower side (the measurer 8 disposed at a position away from the light source 2 by the distance “W1”) may efficiently measure the 3D fine structure 88 of venous in user's finger. On the other hand, the measurer 8 disposed on the upper side (the measurer 8 disposed at a position away from the light source 2 by the distance “W2”) may efficiently measure the position of the head or both eyes 594 of the user.

Meanwhile, a distance “Zb” to the torso of the user may be measured as a constituent element in the user (measured object 22). The distance “Zb” to the torso of the user may be defined as a distance from the measurer 8 to any position in the torso of the user. In addition, the distance is not limited thereto, and may be a distance from the measurer 8 to a location corresponding to the navel position of the user, a distance to the neck of the user, or a distance to the chest of the user.

When the user performs work (business execution) or learning while viewing the display 18 of a personal computer, the position in both eyes 594 is closer to the display 18 (the measurer 8 in FIG. 117) than the torso of the user in many cases. Furthermore, in many cases, a location 86 of the hand or fingertip is closer to the display 18 (the measurer 8 in FIG. 117) than the position in both eyes 594 of the user.

Here, a plane including the light emission point position of the light source 2 disposed on the image sensing plane 394 of the measurer 8 or the extension of the image sensing plane 394 of the measurer 8 is set as a reference plane. The distance from the reference plane to the torso of the user is defined as “Zb”. Furthermore, the distance from the reference plane to the position in both sides 594 of the user at the time of work (business) execution or learning is defined as “Ze”, and the distance to the fingertip (at the time of motion) is defined as “Zf”. In many cases, a relationship of “Zb>Ze>Zf” is established.

Therefore, the distance “Zb” from the reference plane to the torso of the user is measured in advance, and a time variation of a three-dimensional shape and three-dimensional coordinates of only a location closer to the reference plane than the distance “Zb” is measured, whereby the position of both eyes 594 of the user, a position of the hand of the user, a position of the fingertip (three-dimensional coordinate values), and a time variation thereof can be ascertained. Similarly, a position of the hand or a position of the fingertip of the user (three-dimensional coordinate values) and a time variation thereof can be ascertained only by measuring a three-dimensional shape or a time variation of three-dimensional coordinates of only a location closer to the reference plane than the distance “Ze”.

As illustrated in FIGS. 57 to 60 or Equation 10, a distance measuring area is determined by the modulation cycle “T” of the irradiated light (first light) 13. Therefore, when the modulation cycle “T” of the irradiated light (first light) 13 is shortened, the distance measuring area is reduced. However, the modulation cycle “T” of the irradiated light (first light) 13 is not shortened due to the influence of the internal floating capacitance in the VCSEL 128 described with reference to FIG. 71 (d). Therefore, when a three-dimensional measuring area is set narrower in a relatively wide distance measuring area determined by the modulation cycle “T”, an effect of shortening the measurement time is achieved.

The same effect as described above is achieved also in the embodiment example illustrated in FIG. 6. In both the cases of FIGS. 6 (a) and 6 (b), the fingertip cannot be disposed at a position equal to or longer than the distance by which both hands are extended. Therefore, also in the embodiment example illustrated in FIG. 6, three-dimensional shape measurement (or measurement of three-dimensional coordinate values) may be performed within a “distance area in which both hands are extended”.

Methods of achieving the above effects in both the embodiment example illustrated in FIGS. 5 and 117 and the embodiment example illustrated in FIG. 6 are summarized below. That is, a first prescribed distance (“Zb” or “Ze”) is set in advance. In the setting of the first prescribed distance, a measured value obtained in the first measurement of the three-dimensional shape measurement (or three-dimensional coordinate value measurement) may be used. In addition, the present embodiment is not limited thereto, and when a value of the first prescribed distance is known in advance, this known value may be used.

Here, the first prescribed distance is a distance measured from the image sensing plane 394 in the measurer 8. Here, as previously described with reference to FIG. 53, a plane including the light emission point position of the light source 2 may be disposed on the extension of the image sensing plane 394 of the measurer 8. The measured distance may indicate a calculation result using a prescribed conversion formula such as Equation 9 or Equation 17. Here, in the embodiment example illustrated in FIGS. 5 and 117, the measured distance may correspond to the distance “Zb” to the torso of the user or the distance “Ze” to the eyes of the user. Furthermore, in the embodiment example illustrated in FIG. 6, the measured distance may correspond to a “distance to the fingertip when the user stretches to maximum extent”.

In the present embodiment example, three-dimensional shape measurement (or calculation of three-dimensional coordinate values or measurement of a time variation thereof) using the three-dimensional projective reverse transformation is performed in relation to the first prescribed distance. The optical device 10 in the present embodiment example includes the light source 2 and the measurer 18. Furthermore, the measurer 18 includes the imaging sensor 270 relating to a depth (distance) signal, and a plurality of pixels 271 are two-dimensionally disposed on the image sensing plane 394 of the imaging sensor 270 relating to a depth (distance) signal.

The measured object 22 is irradiated with the irradiated light (first light) 13 from the light source 2, and the plurality of pixels 271 receives the detection light (second light) 19 from the measured object 22. In the three-dimensional projective reverse transformation, an imaging sensor includes a plurality of pixels, an image forming lens 388 is disposed between the measured object 22 having a three-dimensional shape and the plurality of pixels, and a second distance between a prescribed pixel in the imaging sensor and a corresponding point of the measured object 22 is measured. Three-dimensional position information of the corresponding point of the object is generated using the measured second distance. Here, the information regarding the second distance relates to the first prescribed distance.

Here, the phrase “the second distance information relates to the first prescribed distance” indicates that a three-dimensional shape (or three-dimensional coordinate values or a time variation thereof) is measured only for the second distance included in an area defined by the first prescribed distance. Here, the phrase “within the area defined by the first prescribed distance” in the embodiment example illustrated in FIGS. 5 and 117 indicates that only a three-dimensional shape may be measured within an area shorter than the distance “Zb” to the torso of the user or the distance “Ze” to the eyes of the user. In addition, the phrase “within the area defined by the first prescribed distance” in the embodiment example illustrated in FIG. 6 indicates that only a three-dimensional shape may be measured within an area closer than fingertips when the user stretches both hands.

However, the present embodiment is not limited to the above, and the phrase “within the area defined by a first prescribed distance” may indicate that only a three-dimensional shape may be measured within a prescribed distance area centered on the first prescribed distance. For example, the “distance between the measurement point (corresponding point) “A22” on the measured object 22 corresponding to the prescribed pixel “a22” and the prescribed pixel “a22”” calculated in step 42 in FIG. 24 may be set to the first prescribed distance. That is only a three-dimensional shape may be measured within a prescribed distance area centered on the prescribed distance.

Not limited to it, in addition, a prescribed distance area that is a target of a three-dimensional shape measurement may be set based on a type identification result of the measured object 22. For example, in step 52 in FIG. 32, the type identification is performed for each separated object (measured object 22). For example, when an object of which the type is identified (measured object 22) is a human, “within a radius of 2 m” includes all parts in the body with the first prescribed distance as the center position. Therefore, an area “within a radius of 2 m” may be set as a prescribed distance area in this case.

An example of a method of measuring a three-dimensional shape (or three-dimensional coordinate values or a time variation thereof) only for the second distance included in an area defined by the first prescribed distance is described. In the example of the optical distance measurement method described in Chapter 3, a plurality of “shift reference signals Rq(p)” expressed by Equation 20 are generated. In this case, the present embodiment example (the depth (distance) calculator 560 for each pixel 271 included in the signal processor 42 previously described with reference to FIG. 8) may generate (calculate) the “shift reference signal Rq(p)” only within an area of the phase value “q” corresponding to the area defined by the first prescribed distance. Using only the “shift reference signal Rq(p)” within this area, PMR calculation of Equation 27 is performed with the measured signals “S(p)” obtained from all the measurement target pixels 271.

Thereafter, all the measured signals “S(p)” in which the pattern matching ratio PMR is lower than a prescribed value (for example, “80%”) may be discarded. As a result, only the corresponding measured signal “S(p)” is extracted when the pattern matching ratio PMR is more than the prescribed value. By substituting this phase value “q” into, for example, Equation 17, the second distance “Z” included in the above area can be calculated. And by substituting the second distance “Z” obtained here into Equation 4, corresponding location value on the X-coordinate and location value on the Y-coordinate can be calculated.

That is, as an example of a method of measuring a three-dimensional shape (or three-dimensional coordinate values or a time variation thereof) only for the second distance included in the area defined by the first prescribed distance, only the “shift reference signal Rq(p)” of the phase value “q” included in the area defined by the first prescribed distance is generated in advance. A series of arithmetic processing may be performed on all the pixels 271 within an area designated by a user in step 16 in FIG. 24, and an inappropriate measured signal “S(p)” may be discarded.

In both the embodiment example illustrated in FIG. 117 or 5 and the embodiment example illustrated in FIG. 6, a direction defining the distance “Z” from the measurer 8 has a relationship of being substantially parallel to the user's view line direction. Furthermore, similarly, in the embodiment example illustrated in FIGS. 117, 5, and 6, the vertical and horizontal directions as viewed from the user also have a relationship of being substantially parallel to the measurer 8 (the vertical and horizontal disposition directions of the respective pixels 271 on the inner image sensing plane 394).

The areas defined by the first prescribed distance in the longitudinal direction and the lateral direction in which a three-dimensional shape or three-dimensional coordinate values of each point (and a time variation thereof) are measured are described below. In both the longitudinal direction and the lateral direction, a three-dimensional shape or three-dimensional coordinate values of each point (and a time variation thereof) can be measured within
A) an area at which the irradiated light (first light) 13 from the light source 2 arrives and
B) an area in which an image can be captured in the measurer 8.

In the present embodiment example, information (three-dimensional coordinate values, three-dimensional sizes, and time variations thereof) regarding the three-dimensional shape existing in the above-described three-dimensional area is collected using the three-dimensional projective reverse transformation described in Chapter 2.

Next, a three-dimensional displayed area is described. Here, using the three-dimensional projective transformation described in Chapter 2, the three-dimensional display (and a time variation thereof) can be performed in the three-dimensional displayed area. The three-dimensional displayed areas in the vertical and horizontal directions in the embodiment example illustrated in FIG. 6 are basically the entire visual field area of the user. Also in the embodiment example illustrated in FIG. 6, a function of detecting a motion of the view line of the user (the position of the crystalline lens 682) is incorporated. Therefore, using three-dimensional projective transformation, it is possible to perform three-dimensional display over the entire visual field area of the user in accordance with the motion of the view line of the user (the position of the crystalline lens 682).

In the embodiment example illustrated in FIGS. 117 and 5, the measurer 8 detects the position in both eyes 594 of the user. On the display 18, an image (or a movie) viewed with the right side eye propagates toward the right side eye position 588. At the same time, an image (or a movie) viewed with the left side eye propagates toward the left side eye position 586. Therefore, the three-dimensional displayed area in the embodiment example illustrated in FIGS. 117 and 5 is limited to the display 18 from the position in both eyes 594 of the user.

A (virtual) display position of a three-dimensional shape (a three-dimensional image or a three-dimensional movie) in the depth direction (a direction parallel to the user's view line) viewed from the user can be set by controlling the convergence angle 446 at the viewpoint position where the right side eye view line and the left side eye view line intersect. Furthermore, in the three-dimensional projective transformation described in the present embodiment example, the position in both eyes 594 of the user can be moved to any position in the three-dimensionally displayed virtual space. Even if the user wants to see any position, the user who wants to see “100 km” beyond the current visual field is considered to be rare. Therefore, the depth direction in the present embodiment example may be assumed to be closer than the “100 km”.

A display position in the depth direction viewed from the user is displayed by the convergence angle 446. Therefore, in the display at a close distance of the user, since the user “crosses his/her eyes”, fatigue is likely to be accumulated. A display distance at which the user is not tired even when watching for a long time may be set to “1 cm” or more (desirably 10 cm). That is, there is also a method of setting the display distance in the depth direction as viewed from the user to a “range from 1 cm to 100 km” (desirably, a “range from 10 cm to 100 km”).

In Chapter 2 (in the description with reference to FIGS. 38 and 39), the method of using a shape and a motion of a part of the body of the user for a “three-dimensional pointer” and a “three-dimensional tracer” has been described. This usage method is specifically described. In the present embodiment example, a shape of a part of the body of the user in the real space and three-dimensional coordinate values are measured using the three-dimensional projective reverse transformation. Here, three-dimensional coordinate axes are based on (the image sensing plane 394 in) the measurer 8. In other words, the measured three-dimensional coordinate values easily vary based on both a location and a direction of the measurer 8 including the image sensing plane 394.

In a case where a shape or a motion of a part of the body of the user is used for a “three-dimensional pointer” or a “three-dimensional tracer”, a virtual space is set to be superimposed on the real space in which the user is present. Three-dimensional coordinate axes set in the virtual space may also coincide with the three-dimensional coordinate axes based on (the image sensing plane 394 in) the measurer 8 described above. Therefore, a direction and a size in the virtual space in this case exactly match those in the real space in which the user is present.

Since the distances “W1” and “W2” from the light source 2 to the measurer 8 and the size of the display 18 are determined in advance, three-dimensional coordinate values of the four corners “α point”, “β point”, “γ point”, and “δ point” of the display 18 in the virtual space are determined. Based on the three-dimensional coordinate values of the four corners of the display 18 in the virtual space, a three-dimensional shape desired to be displayed to the user and a time variation thereof are virtually constructed in the virtual space. In other words, the present embodiment example may set three-dimensional (or four-dimensional) coordinate values of at least one point (position) included the three-dimensional shape (or the time variation thereof) located in the virtual space to display the three-dimensional shape to the user, and the three-dimensional (or four-dimensional) coordinate values relate to the user's position or sizes of the display 18 fixed in the real space.

Similarly, three-dimensional coordinate values of the position in both eyes 594 of the user in the real space are measured using the three-dimensional projective reverse transformation. In accordance with the three-dimensional coordinate values of the position in both eyes 594, the three-dimensional shape can be disposed at three-dimensional coordinate positions in the virtual space. In the three-dimensional projective transformation previously described in Chapter 2, the display 18 displays the three-dimensional shape (or a time variation thereof) constructed in the virtual space that has a left side projected image (or movie) viewed from the user's left side eye position 586 and a right side projected image (or movie) viewed from the user's right side eye position 588. Here, the display 18 expressing the three-dimensional shape is located at the fixed position in the real space.

As a display example based on a “three-dimensional pointer” or a “three-dimensional tracer”, a three-dimensional display example of the three-dimensional positioned cursor 300 that is moved three-dimensionally in response to the tip motion 86 of the user's finger is described below. First, three-dimensional coordinate values of the user's fingertip in the real space are measured using the three-dimensional projective reverse transformation. And then, the present embodiment example puts the measured position of the use's fingertip in the virtual space. Here, “three-dimensional coordinate values defined in the virtual space” coincides with “three-dimensional coordinate values defined in the real space”.

Next, the three-dimensional positioned cursor 300 is placed at a three-dimensional coordinate position in the virtual space in accordance with the three-dimensional coordinate values of the user's fingertip. That is, the present embodiment example sets (puts) a three-dimensional shape of the cursor 300 to be superimposed on (near) another three-dimensional shape already set in the virtual space. Thereafter, using the three-dimensional projective transformation, the present embodiment example may display the cursor 300 (the three-dimensional shape set) to the user.

FIG. 117 illustrates an example in which the cursor 300 is disposed on the conventional display 18 that performs two-dimensional display (planar display) so that the above concept can be easily visually understood. FIG. 117 illustrates a state in which the fingertip is disposed between the “position in both eyes 594 of the user” and the “position of the cursor 300 disposed on the display 18”. The position in both eyes 594 of the user represents “ζ0 point” shown in FIG. 117. The position of the user's fingertip 86 represents “η point”. Herein, the position of the user's fingertip 86 moves usually. From the above description, the three-dimensional coordinate values of the position in both eyes 594 of the user in the virtual space and the three-dimensional coordinate values of the user's finger in the virtual space are determined. Therefore, the cursor 300 may just be placed at the “ξ point” located on the extension of the straight line from the “(point” toward the “η point” in the virtual space.

As described above, since the three-dimensional coordinate values of the four corners “xx point”, “β point”, “γ point”, and “δ point” of the display 18 in the virtual space are set in advance, a relative position of the cursor 300 is determined based on the three-dimensional positions of “α point”, “β point”, “γ point”, and the “δ point”.

Accordingly, the present embodiment example may propose a new user interface method using the three-dimensional shape or the three-dimensional coordinate values regarding the part of the user's body. For example, the fingertip motion 86 of the user's finger or a prescribed shape of the fingertip may be used for a “three-dimensional tracer”. Alternatively, the fingertip motion 86 may change a display size of the three-dimensional shape displayed when the user expands a space between user's two fingers.

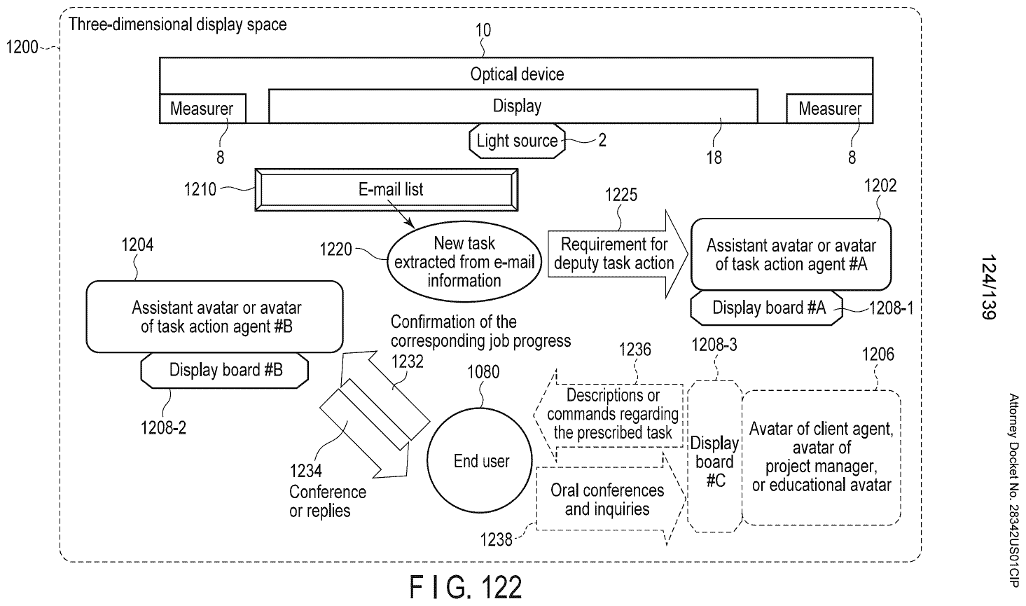

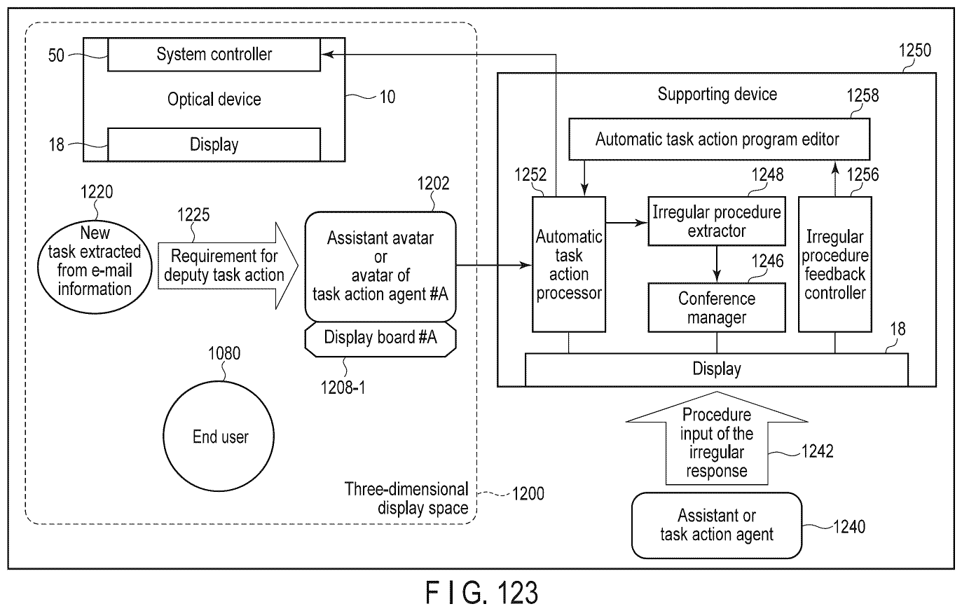

When a wavelength of the irradiated light (first light) 13 is set to about “1.35 μm”, the detailed 3D fine structure 88 of venous in the user's finger can be easily imaged. Therefore, the detailed 3D fine structure 88 of venous in user's finger can be used for personal authentication. Accordingly, the user environment shown in FIG. 117 may be used as a “highly trustworthy space 80”. As described later with reference to FIG. 122 or FIG. 123, there is a case where a third party (including AI) is desired for user's deputy (agent business) for a part of the user's work or business. When personal information or confidential information is included in the deputy work or the deputy business (agent business), there are many situations where contracts need to be exchanged in advance. Therefore, the reliability of the written exchange of contracts is significantly improved when, in the real space, a guarantee stamp 84 indicating trustworthy contracts and expressing the contract date is sealed on the written exchange of contracts.

As a method of preventing an illegal copy of a signature or a seal using the AI technology, in the present embodiment example, the contract or the deputy business (agent business) requirement form (deputy work requirement form) may be printed on paper in the real space, and physical reliable processing may be performed. Incidentally, invisible light (for example, having a wavelength of “700 nm or more and 2.5 μm or less”) is often used as the detection light (second light) 19 used for measurement by the imaging sensor 270 relating to a depth (distance) signal.

For example, “phthalocyanine dye system” or “pigments containing neodymium or ytterbium” may be used as a material of ink of a vermilion inkpad (stamp ink holder) of special ink. These pigments have characteristics of being invisible to visible light and visible to the detection light (second light) 19 described above. Therefore, higher reliability can be secured by using the pigments for the vermilion inkpad (stamp ink holder) of the special ink used in the above-described guarantee stamp 84 indicating trustworthy contracts.

As illustrated in FIG. 117 as an example of the present service providing embodiment example, the trustworthy space 80 (which can also be used for exchanging contracts) may be provided to the user. In such a highly trustworthy space 80, the user can present an identification card or the like with security. The user only needs to show (hold) the identification card or the like toward the display 18. The measurer 8 reads the content of the identification card by itself. The content (for example, the user's name, the date of birth, and the current address) of the read identification card may be automatically transcribed into the contract or the deputy business requirement form (deputy work requirement form or agent business contract). When the service of automatically transcribing written content into necessary documents is performed, the user's convenience is greatly improved.

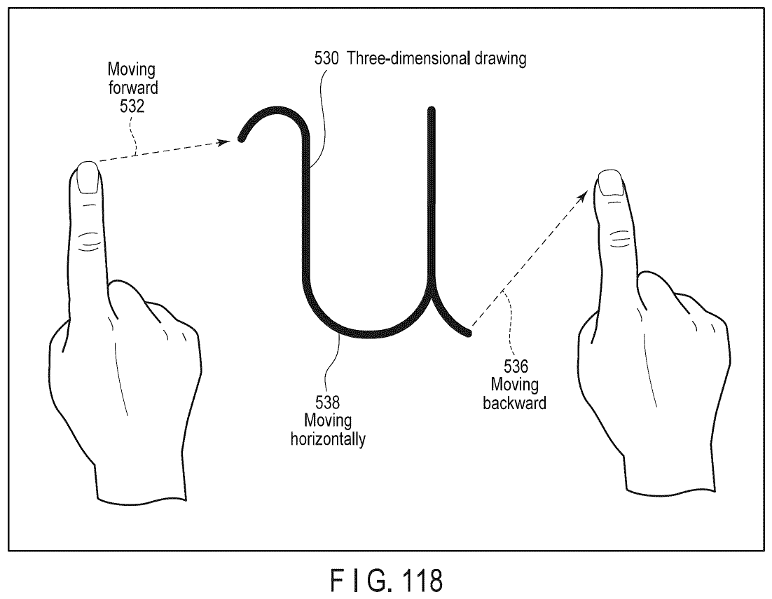

FIG. 118 illustrates an example of a usage form as a “three-dimensional tracer”. A contract or a deputy business requirement form (deputy work requirement form or agent business contract) created in the above provided trustworthy space 80 (which can also be used for exchanging contracts or the like) desires a signature written by the user. A usage form example as the “three-dimensional tracer” may be used for a signature. A format of the contract or the deputy business requirement form (deputy work requirement form or agent business contract) is developed two-dimensionally. When viewed from the user, the vertically placed paper appears to float in the three-dimensional space. Note that, in a case where the contract or the deputy business requirement form (deputy work requirement form or agent business contract) extends over many sheets, a bundle of documents (paper) appears to float in the three-dimensional space while being shifted for each page.

In the example of the usage form as the “three-dimensional tracer” illustrated in FIG. 118, a part of the user's body (for example, the fingertip) moves to the vicinity of a location where the signature is written in the contract or the deputy business requirement form (deputy work requirement form or agent business contract) floating in the three-dimensional virtual space. When the user slightly moves the hand forward 532, a midair signature (three-dimensional drawing) 530 is started. A drawing curve is automatically drawn in the three-dimensional space when the user moves the finger 538. Furthermore, when the user slightly moves his/her hand backward, the midair signature (three-dimensional drawing) 530 is stopped.

According to the description mentioned above with reference to FIG. 118, the forward and backward movements of the user's hand (finger) indicate the start and end of the “three-dimensional tracing”. However, the present embodiment example is not limited thereto, and any user's action method controls the “three-dimensional tracing”. For example, a prescribed shape of a hand (or fingers) may be used. As a specific example, the “three-dimensional tracing” (midair signature (three-dimensional drawing) 530) may be performed using a period in which two normally separated fingers are overlapped (or are contacted together).

FIG. 118 illustrates an example of the midair signature 530. However, the present embodiment example is not limited thereto, and for example, drawing and shaping of a three-dimensional picture (creation of a three-dimensional shape in a virtual space) may be performed. In addition, in a calligraphy brush using a vermilion-ink in Japan, a thickness of characters written on Japanese paper is easily changed. Because a slight distance variation between the calligraphy brush and Japanese paper controls the thickness of the characters written on Japanese paper. Similarly, in the “three-dimensional tracing” (midair signature (three-dimensional drawing) 530), the slight front-rear position of the user's finger may change the thickness of a three-dimensional line drawn on the midair virtual plane.

Furthermore, the present embodiment example is not limited thereto, and any method may change a thickness or a color tone (gradation of a line color) of a line drawn three-dimensionally. For example, other parts in the user's body that are not used for “three-dimensional tracing” may be used. As a specific method thereof, the line may be gradually thickened when a finger of the hand opposite to the hand (or the finger) used in the “three-dimensional tracing” is directed upward, and the line may be gradually thinned when the finger of the hand opposite to the hand is directed downward. The color (color tone) of the line may be changed when the finger of the other hand is directed sideways.

Note that the forms in FIGS. 117 and 5 have been exemplified as the work environment example (business environment example) of the three-dimensional drawing (midair signature) 530 described with reference to FIG. 118. However, the present embodiment example is not limited thereto, and may be applied to, for example, the work environment example (business environment example) illustrated in FIG. 6.

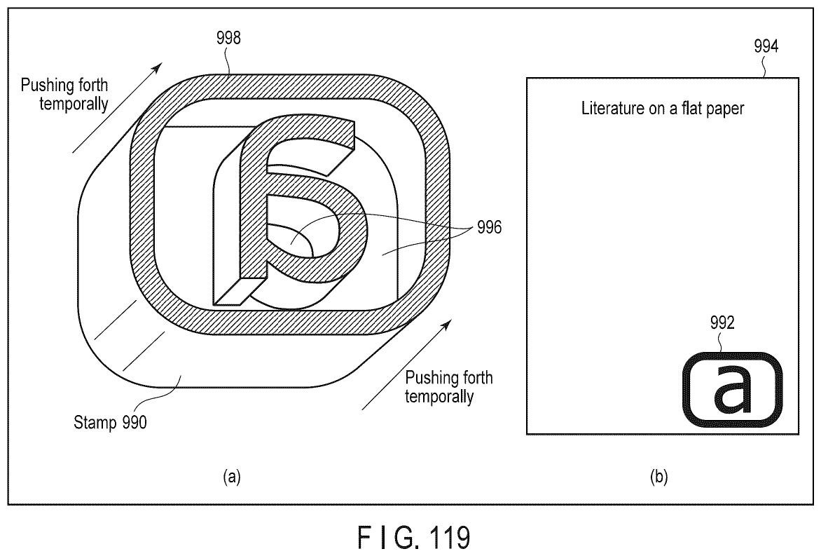

FIG. 119 illustrates an application example in which a three-dimensional shape of a prescribed object other than a living thing or a time variation of three-dimensional coordinate values is used. In the three-dimensional motion detection example described with reference to FIG. 117, a three-dimensional shape of a part of the user (living thing) and a time variation of the three-dimensional coordinate values are detected. However, the present embodiment example is not limited thereto, and three-dimensional motion detection may be performed on a three-dimensional shape of a prescribed object other than a living thing or a time variation of three-dimensional coordinate values.

FIG. 119 illustrates a three-dimensional motion detection example for a stamp 990 as a prescribed object other than a living thing. In Japan, there still remain some habits of sealing important documents. Note that FIG. 117 illustrates an example in which the guarantee stamp 84 indicating trustworthy contracts in which the date of the seal is specified is sealed in the real space on paper printed in the real space. Contrary to this, FIG. 119 illustrates an example of performing sealing in the virtual space.

As described above with reference to FIG. 117, the user can see a virtual flat paper floating in the three-dimensional virtual space. And on the virtual flat paper, a series of written literature 994 extends two-dimensionally. And then, in the real space, the user can temporarily push the stamp 990 forth toward a stamping area 992 in the virtual flat paper seen to float in the three-dimensional virtual space. A pattern of only a top surface 998 of the stamp 990 is automatically engraved (displayed) in the stamping area 992 in the literature 994 on the virtual flat paper.

At the time of three-dimensional projective reverse transformation for the stamp 990 here, a difference in distance between the top surface 998 and a bottom surface 996 in the stamp 990 is identified. Specifically, according to step 52 in FIG. 32, the “3D shape processing area (3D projective reverse transformation) 922” identifies the measured object 22 the “stamp 990”. Therefore, in step 53, a unique attribute of the stamp 990 is extracted. The extracted unique attribute of the stamp 990 includes a feature that “the stamp 990 has the top surface 998 and the bottom surface 996”. Therefore, a difference in distance between the top surface 998 and the bottom surface 996 in the stamp 990 is automatically identified. From the difference in distance, the pattern of only the top surface 998 in the stamp 990 is automatically extracted and is displayed on the virtual flat paper.

FIG. 120 illustrates a method example of complicated concept in the present embodiment understanding using a three-dimensional shape and a three-dimensional layout example. In a method of understanding a complicated concept and detailed content up to now, FIG. 120 (a), for example, shows literatures (a list of texts) arranged two-dimensionally to be read. However, this method takes a lot of labor and time to read and understand the literatures (a list of texts).

As illustrated in FIG. 120 (a), many of literatures (a list of texts) used in the business world have the following features.
α] One or a plurality of description contents (description contents #A 1002-1 and description contents #B 1002-2) are included in the literature 994 on a flat paper.
β] In the individual description contents 1002-1 and 1002-2, description locations are divided into a “description location of a substance 1003”, a “description location of a purpose 1004”, a “description location of an achieving method 1005”, a “description location of an example 1006”, a “description location of another application example 1007”, and the like.

In two-dimensionally arranged literatures (a list of texts), a user is desired to “read the entire literature 994 on the flat paper”. However, a busy person needs to know only the “substance 1003”. If there is an interest, only necessary portions may be read and understood. Also with regard to this “substance 1003”, user's convenience greatly increases if the user can obtain the following instantaneous understanding before the user reads the text (the literatures) in detail.
[a] Is the topic interesting to the user? Is the topic of no interest?
[b] Is there a merit for the user? No merit?
[c] What is preferred by user? What is not preferred?

“Three-dimensional shape display” is suitable for fast determination of [a] to [c]. By analyzing content of E-mail that the user usually uses and a screen of a web that the user views, the following content can be automatically generated.
a] What fields are interesting to the user?->Three-dimensional shape indicating the field of interest may be extracted (or represented).
b] What is the merit for the user?->Three-dimensional shape that gives the merit may be extracted (or represented).
c] What is preferred by the user?->Three-dimensional shape of an object preferred by the user may be generated (or represented).

That is, with respect to the understanding levels of [a] to [c] described above, “generation of a three-dimensional shape” tailored to each user can be automatically performed.

For a more advanced concept and a more complicated content, a sign-language motion may be referred to. For example, from a “posture (three-dimensional shape) in which both hands are put together to give apologies”, “apology content” can be assumed. FIG. 120 (b) illustrates a state in which the content converted into a literature in the related art is represented as a “three-dimensional shape” and three-dimensionally disposed around the user's position 1010. The content desired for the user to rapidly understand (for example, the substance 1003 or the like for each description content) is three-dimensionally disposed near the user's position 1010 in the virtual space. Note that the individual three-dimensional shapes illustrated in FIG. 120 (b) may include text described in a “word level”.

Among the three-dimensional shapes disposed three-dimensionally in the virtual space as illustrated in FIG. 120 (b), the user can approach an interested three-dimensional shape and can perform “designation of a specific (interested) three-dimensional shape” through a user's motion such as “holding with hand”. And then, the user can understand the detailed content with a literature (text) when the “designated three-dimensional shape” shows (or changes to) a literature expressing description texts. And the three-dimensional layout illustrated in FIG. 120 (b) is automatically disposed based on a prescribed layout reference (or a user's preference). For example, the three-dimensional shapes may be disposed according to information necessary for a specific job with which the user is currently involved, or may be disposed according to the user's current hobby content. Therefore, when the user's view line or the like changes, the layout reference may change based on the changed user's view line. Here, the user can easily change the user's position 1010 in the virtual space.

FIG. 121 illustrates an example of a literature creation method using a three-dimensional shape and a three-dimensional layout in the present embodiment example. An example of a method of expressing a complicated concept and detailed contents currently considered by the user is described below. When a certain keyword is input to the current generative artificial information (AI), a three-dimensional shape representing a concept related to the keyword appears around the user's position 1010 in the virtual space (FIG. 121 (a)). When the user sequentially designates (points at) the three-dimensional shapes, literatures corresponding thereto are displayed as illustrated in FIG. 121 (b). Here, in the literature on a flat paper 994 shown in the virtual space, an arrangement order of a series of sentences (literatures) may correspond to the user's designation order (the user's pointing order) of the series of the three-dimensional shapes.

For example, when the user first designates a “3D shape 1100 representing a conception #A” in FIG. 121 (a) (by pointing in the virtual space or the like), a “literature 1110 expressing the conception #A” appears in the literature 994 on a flat paper as illustrated in FIG. 121 (b). Next, when the user designates “3D shape 1102 representing a conception #C”, a “literature 1112 expressing the conception #C” appears under the “literature 1110 expressing the conception #A”.

The “literature 1110 expressing the conception #A” and the “literature 1112 expressing the conception #C” were originally separate and independent literatures. However, the literatures are automatically changed to be unified literatures according to the above layout order.

Next, when the user sequentially designates a “3D shape 1104 representing a conception #E” and a “3D shape 1106 representing a conception #G”, literatures corresponding thereto are completed provisionally. After provisionally completing the literatures, the user reads the provisionally completed literature draft and performs literature proofreading. Conventional literature proofreading has been text-based rearrangement or change. However, in the present embodiment example, the user may proofread the literature draft based on a rearrangement between three-dimensional shapes. That is, the user may rearrange the three-dimensional shapes in FIGS. 121 (a) and 121 (b) at the same time. In addition, not limited to it, the user may grasp a block of the specific literatures 1110 to 1116 on the flat paper in the virtual space to replace the specific 3D shapes 1100 to 1106.

Furthermore, the present embodiment example is not limited to the above, and for example, document proofreading may be performed orally such as “Please change the expression to a softer expression”. FIG. 121 illustrates a literature creation example. However, the present invention is not limited to literature creation, and may be used in any field of art such as shaping of a three-dimensional shape, creation of a planar image, and composition or arrangement of music.

Note that the forms in FIGS. 117 and 5 have been exemplified as work environment examples (business environment examples) for understanding or expressing a complicated concept or detailed contents using the three-dimensional shape or three-dimensional layout described in FIG. 119 or FIG. 120 (writing to literatures). However, the present embodiment example is not limited thereto, and may be applied to, for example, the work environment example (business environment example) illustrated in FIG. 6.

FIG. 122 illustrates an example of a work environment in a three-dimensional display space according to the present embodiment. For example, the display contents three-dimensionally displayed in FIG. 117 or FIG. 5 appear to be raised (to float up) for the end user 1080 to the front side of the display 18. FIG. 122 illustrates a situation in which the virtual three-dimensional layout that appears to be raised (to float up) is viewed from the end user 1080. However, the present embodiment example is not limited thereto, and for example, the present embodiment example may be applied to an example of a virtual three-dimensional layout that the end user 108 can see by wearing glasses as illustrated in FIG. 6.

When viewed from the end user 1080, FIG. 122 illustrates a situation example in which assistant avatars 1202 and 1204 that perform a part of the work (business) of the end user 1080 are always on standby in front of the display 18 in the optical device 10. When described in comparison with the current work environment, this corresponds to a state in which many work (work) assistants are always on standby around the end user 1080. In addition, each assistant avatar has expertise and performs work (business) according to a verbal instruction from the end user 1080.

The achievement of the work (business) for which the instruction has been given by the end user 1080 is appropriately presented to the end user 1080, and the end user 1080 may give a correction instruction to the corresponding assistant avatars 1202 and 1204 as necessary. An assistant avatar 1202 or 1204 corresponding to an assistant of work (business) in the current work environment may be referred to as an assistant avatar, which means an avatar of the current assistant. Alternatively, it may be referred to as a task action agent avatar in the meaning of an avatar that performs an action (processing of work) of a task given from the end user 1080 as an agent.

In the current work environment, an assistant avatar 1202 or 1204 looks like a human. However, in the embodiment example illustrated in FIG. 122, the assistant avatars 1202 and 1204 have any three-dimensional shapes and can freely move around the end user 1080. For example, a miniature form of an animal, a pet, an automobile, or a building may be employed as a three-dimensional shape of the avatars 1202 and 1204.

Incidentally, when viewed from the end user 1080, an E-mail list 1210 may be displayed to float up in the three-dimensional virtual space in front of the display 18 in the optical device 10. When the end user designates a mail that the end user 1080 wants to view (read) in the list displayed to float up in the three-dimensional virtual space, the corresponding mail content is displayed. Here, the corresponding mail in the E-mail list 1210 may be designated by pointing at the corresponding portion or designating the view lines of the left and right side eyes (matching a viewpoint corresponding to the intersection of the view lines of both eyes with a position of the corresponding portion). In addition, a display method of the corresponding mail content may be either the conventional literature display (text display) or the “three-dimensional shape display illustrated in FIG. 120 (b).

In the present embodiment example, an example of a method of handling by the end user 1080 is described below when the content of the email requests the end user 1080 to perform a prescribed work. It is performed that the end user 1080 wants to entrust the entire requested work content to an “assistant avatar or an avatar of task action agent” #A 1202 having expertise (request of agent (deputy) business). In this case, the end user 1080 may perform “three-dimensional drag & three-dimensional drop” or “three-dimensional copy & three-dimensional paste” corresponding to “drag & drop” or “copy & paste” on the existing two-dimensional plane.

In other words, when the end user 1080 grasps the requested work content in the E-mail list 1210 with his/her hand, the work content is converted into a “three-dimensional shape” having a size that can be put in one hand. And then, the end user 1080 may move the “three-dimensional shape” indicating the work content to the position of the “assistant avatar or avatar of task action agent” #A 1202 while grasping the “three-dimensional shape” with his/her hand. This “movement of the three-dimensional layout” may correspond to requirement for deputy (agent) task action 1225.

The “assistant avatars or avatars of task action agent” 1202 and 1204 may have a display board 1208 directed towards the end user 1080. The display board 1208 may illustrate a list of the deputy (agent) business contents (requested work contents) and the progress thereof. Therefore, the end user 1080 can recognize a progress status of each piece of deputy (agent) business (each piece of requested work) simply by viewing the display content of the display board 1208.

Here, in a case where the end user 1080 desires to ascertain the progress status in more detail, confirmation 1232 of the corresponding job progress can be performed orally. And then, the “assistant avatar or avatar of task action agent” 1204 may reply or discuss (conference or replies 1234) in a form in which the detailed contents are displayed in a three-dimensional shape on the display board #B 1208-2. If necessary, the “assistant avatar or avatar of task action agent” 1204 may display a literature (text form) on the display board #B 1208-2.

On the other hand, in a case where the “assistant avatar or avatar of task action agent” 1204 has a problem in performing the deputy (agent) work (requested work), the “assistant avatar or avatar of task action agent” 1204 may display a three-dimensional shape (or a literature) regarding the problem on the display board #B 1208-2. And then, the end user 1080 may be in conference (conference or replies) 1234 with the “assistant avatar or avatar of task action agent” 1204. In a case where a “regular procedure” is sufficient as the reply to the conference, the end user 1080 may select the three-dimensional shape corresponding to the “regular procedure” from a “regular procedure list”, and the end user 1080 may give the selected three-dimensional shape to the position of the “assistant avatar or avatar of task action agent” 1204. In this case, although not illustrated, the “regular procedure list” may be displayed in a three-dimensional manner, and the user may take an action of grasping (selecting) the three-dimensional shape (three-dimensional icon) corresponding to the processing content included in the “regular procedure list”.

A client, a project manager, or an educational staff who requests the end user 1080 to perform work appears in a three-dimensional space as “an avatar of a client agent, an avatar of a project manager, or an educational avatar” 1206 as necessary. “The avatar of a client agent, the avatar of a project manager, or the educational avatar” 1206 also has a display board #C 1208-3. By utilizing the display board #C 1208-3, descriptions or commands 1236 regarding a new task to be requested are given to the end user 1080. In response to this, the end user 1080 may perform oral conference and inquiries 1238.

When a task processing content of the requirement 1225 for deputy task action to the “assistant avatar or avatar of task action agent” 1202 and 1204 is a “regular procedure”, automatic processing is performed without human intervention. On the other hand, in a case where an “irregular procedure” is included, a human having specialized knowledge intervenes to cope with the situation.

FIG. 123 illustrates an example of how to proceed with the requirement for deputy task action 1225 in the “assistant avatar or avatar of task action agent” 1202 or 1204. The left side of FIG. 123 is a portion obtained by extracting a part of FIG. 122. The “assistant avatar or avatar of task action agent” 1202 is network-connected to a supporting device 1250.

When the task content of the requirement for deputy task action 1225 to the “assistant avatar or avatar of task action agent” 1202 is a “regular procedure”, an automatic task action processor 1252 performs automatic processing. An automatic processing result is passed to the system controller 50 in the optical device 10, and fed back to the three-dimensional display content on the display 18. In such a case of the “regular procedure”, the human assistant or the task action agent 1240 is not directly involved.

On the other hand, in a case where the task content of the requirement for deputy task action 1225 to the “assistant avatar or avatar of task action agent” 1202 includes an “irregular procedure”, an irregular procedure extractor 1248 extracts an “irregular procedure content”. A conference manager 1246 generates an inquiry content according to the “irregular procedure content” extracted by the irregular procedure extractor 1248. Thereafter, the assistant or the task action agent 1240 views the inquiry content shown on the display 18.

When the assistant or the task action agent 1240 inputs a procedure input of irregular response 1242, an irregular procedure feedback controller 1256 learns the content thereof. An automatic task action program editor 1258 automatically updates a task action program content according to the learning content. By using this learning function, the occurrence ratio of an “irregular procedure” is reduced. Finally, the task action is automatically executed almost without bothering the assistant or the task action agent 1240.

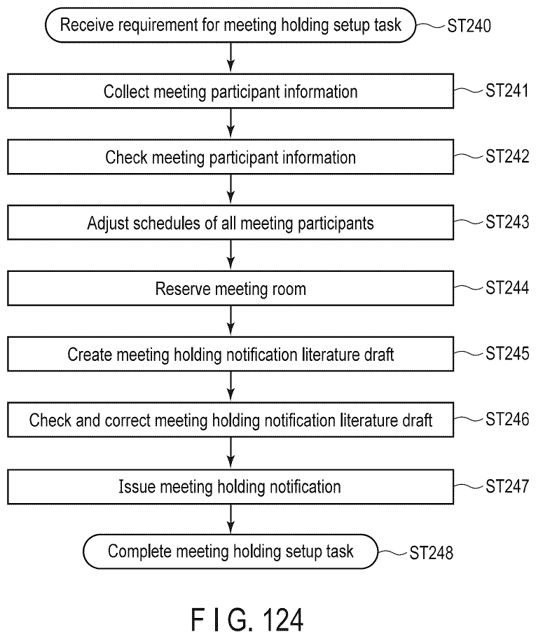

FIG. 124 illustrates an example of the “regular procedure” described above. When a plurality of people form a project and achieve a specific job, there are many opportunities to set a meeting. It often takes a lot of time to set up the meeting in advance. Therefore, if the setting in advance of the meeting is performed on behalf of the end user 1080, the work efficiency of the end user 1080 is improved.

In a series of processing procedures from reception of requirement for a meeting holding setup task started in step 240 to completion of the meeting holding setup task in step 248, a proportion of a regular procedure is high following collection of meeting participant member information (ST241), checking of the meeting participant member information (ST242), schedule adjustment of all the meeting participants (ST243), meeting room reservation (ST244), creation of a meeting holding notification literature draft (ST245), checking of the meeting holding notification literature draft to the end user 1080 and reception of correction from the end user 1080 (ST246), and issuance of meeting holding notification (ST247). Among them, the schedule adjustment of all the meeting participants (ST243) includes an irregular procedure content.

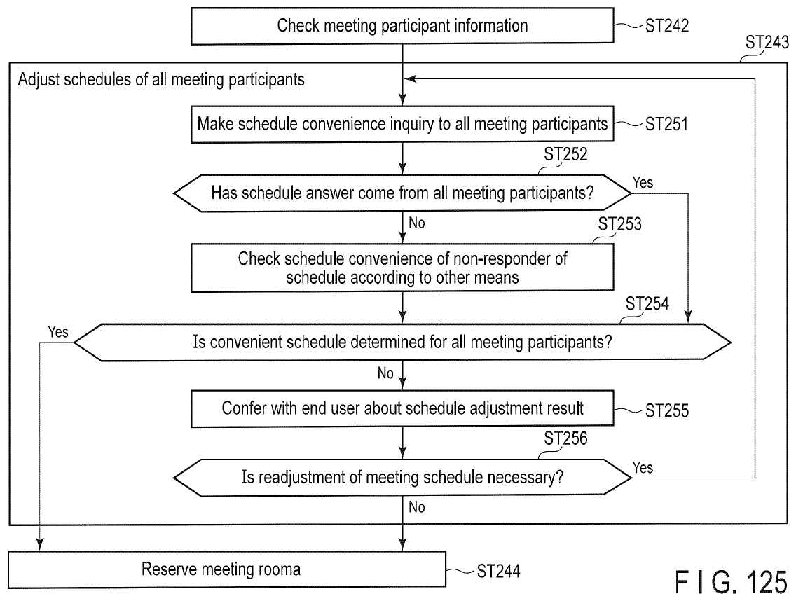

FIG. 125 illustrates a flow of processing in the schedule adjustment of all the meeting participants (ST243). Specifically, in step 251, a schedule convenience inquiry is made to all the meeting participants. A case where irregular elements are included corresponds to a case where no schedule answer is received from a meeting participant. That is, in a case where a schedule answer has come from all the meeting participants in step 252, the process can directly proceed to “is a convenient schedule determined for all the meeting participants?” (ST254).

On the other hand, in step 252, in a case where no schedule answer has been received from all the meeting participants, a reminder E-mail may be sent. If there is still no answer, it is necessary to perform convenience checking of non-responders by other means (ST253). As a specific method, a third party may check a schedule of a relevant person. Alternatively, the assistant may directly ask the schedule of the relevant person. This processing corresponds to an irregular procedure. However, if the irregular procedure feedback controller 1256 learns a schedule checking method for a specific target person, an inquiry from the next time can be automatically made.

In a case where a schedule convenient for all the meeting participants is determined in step 254, the meeting room reservation (ST244) can be followed. Conversely, in a case where a convenient schedule for all the meeting participants is not determined (ST254), conference with the end user 1080 about the schedule adjustment result (ST255) is required. In a case where it is necessary to readjust the meeting schedule as a result of the conference (ST256), it is necessary to return to the inquiry about the schedule convenience to all the meeting participants (ST251).

When the regular task (regular procedure) illustrated in FIGS. 124 and 125 proceeds smoothly, the automatic task action processor 1252 in FIG. 123 automatically performs all series of regular procedures. Even in the middle of a series of automatic regular procedures, the irregular procedure extractor 1248 always monitors a progress status of the regular procedures.

In the middle of the above processing, for example, in a case where it is difficult to check the schedule convenience even if other means is used for the schedule non-responders in step 253, an irregular response is required. Furthermore, for example, even in a case where there is information that a participant cannot attend due to an urgent business immediately before issuing a meeting holding notification in step 247 in FIG. 124, an irregular procedure is required. When the irregular procedure extractor 1248 in FIG. 123 finds this situation, the situation is displayed on the display 18 via the conference manager 1246.

The assistant or the task action agent 1240 decodes the content shown on the display 18. The assistant or the task action agent 1240 performs procedure input of the irregular response 1242. Next, the irregular procedure feedback controller 1256 in FIG. 123 decodes the procedure of the irregular response. In addition, the irregular procedure feedback controller 1256 determines a method of changing the program content executed by the automatic task action processor 1252 based on the decoded content.

The automatic task action program editor 1258 changes the processing program according to the changed content of the program. Based on the subsequent program, the automatic task action processor 1252 executes an irregular procedure. At this stage, the content of the regular procedure so far is changed to a future content of the regular procedure.

FIG. 126 illustrates an example of a method of measuring a distance to the measured object 22 existing in a limited measuring area. In the embodiment example described with reference to FIG. 117, a length is measured only within the area of the distance “Zb” from (the image sensing plane 394 of) the measurer 8 to the torso of the user or the distance “Ze” from (the image sensing plane 394 of) the measurer 8 to the position in both eyes 594 of the user. An example of a method of measuring a length within a specific area is described below.

In the present embodiment example, either the phase profile corresponding to the charge accumulation values illustrated in FIG. 63 (a) or the detection phase profile or light emission phase profile corresponding to differentiated values thereof illustrated in FIG. 63 (b) may be used for distance calculation. Here, as an example, a distance calculation method using the phase profile corresponding to the charge accumulation values is described below. The horizontal axis in FIG. 126 is set to the detection phase “δ”. However, the present embodiment is not limited thereto, and for example, the horizontal axis expresses a light emission phase or a combination of a detection phase and a light emission phase. In the optical layout illustrated in FIG. 53, a case is presumed in which the irradiated light (first light) 13 spreads (becomes divergent light) from a point on a plane including the image sensing plane 394 of the imaging sensor 270 relating to a depth (distance) signal.

As expressed by Equation 7, a phase value equals to “q0” when the distance from (the image sensing plane 394 of) the measurer 8 is “Z=0”. FIG. 126 illustrates phase profiles corresponding to charge accumulation values obtained from the measured object 22 disposed at this position. Here, Equation 17 (or Equation 9) forms a relationship between the distance “Z” from (the image sensing plane 394 of) the measurer 8 and the phase value “q”. Using Equation 17 (or Equation 9), “qb” represents a phase value corresponding to the distance “Zb” from (the image sensing plane 394 of) the measurer 8 to the torso of the user. Similarly, “qe” represents a phase value corresponding to the distance “Ze” from (the image sensing plane 394 of) the measurer 8 to the position of both eyes 594 of the user.

Phase profiles corresponding to charge accumulation values corresponding to the above phase values “qb” and “qe” are also illustrated in FIG. 126. An area from the phase profile corresponding to the charge accumulation values corresponding to the phase value “q0” to the phase profile corresponding to the charge accumulation values corresponding to the phase value “qb” (or “qe”) illustrated in FIG. 126 corresponds to a measuring area 1880 of three-dimensional shapes. In the present embodiment example, waveform pattern comparison for the measured signal “S(p)” obtained from the pixel 271 is performed only within the measuring area 1880 regarding three-dimensional shapes.

A specific calculation content example relating to the above explanation is described below. Waveform pattern comparison between the measured signal “S(p)” and the “shift reference signal Rq(p)” obtained for each pixel 271 in the imaging sensor 270 relating to a depth (distance) signal is performed, and the phase value “q” corresponding to the “shift reference signal Rq(p)” when the waveform patterns match most is extracted. Here, the “shift reference signal Rq(p)” is calculated using Equation 19 and Equation 20. At the stage of calculation (presetting) of the “shift reference signal Rq(p)”, the “shift reference signal Rq(p)” of only the phase value “q” included in the range of the “q0≤q≤qb” or the “q0≤q≤qe” is calculated.

When the measuring area 1880 regarding three-dimensional shapes is not defined as illustrated in FIG. 126, it is basically necessary to calculate the “shift reference signal Rq(p)” over the entire range of the “0≤q≤360”. In comparison, as illustrated in FIG. 126, the “shift reference signal Rq(p)” may be calculated only within the narrow measuring area 1880 of three-dimensional shapes, and the evaluation function of Equation 23 or Equation 25 (or other equations) may be calculated. Therefore, if the measuring area 1880 of three-dimensional shapes is set, a calculation amount related to distance calculation is greatly reduced, and an effect of enabling fast calculation is achieved.

In the embodiment illustrated in FIG. 126, a range of “q0≤q≤qb” or “q0≤q≤qe” is used as a calculation range. However, the present embodiment is not limited thereto, and a prescribed range (for example, a range of “qe−dq≤q≤qe+δq”) centered on a prescribed distance may be set.

An example of a method of measuring a three-dimensional shape (or three-dimensional coordinate values or a time variation thereof) only for a second distance included in an area defined by the first prescribed distance in the present embodiment example is described below. Also for the measured signal “S(p)” from the measured object 22 located at a distance outside the area defined by the first prescribed distance, the pattern matching ratio PMR with respect to the “shift reference signal Rq(p)” set in advance is calculated using Equation 27. That is, in a case where the preset area of the “shift reference signal Rq(p)” is within the above-described narrow area, for example, in a case where the measured signal “S(p)” from a position outside the range of “q0≤q≤qb” or “q0≤q≤qe” is obtained, only a low value (for example, 60% or less) can be obtained as a value of the pattern matching ratio PMR calculated by using Equation 27.

Therefore, the pattern matching ratio PMR is calculated for the measured signals “S(p)” obtained from all the pixels 271 that are distance measurement targets in the imaging sensor 270 relating to a depth (distance) signal. When the value of the obtained pattern matching ratio PMR is lower than a prescribed reference value, it is regarded that a distance to the target point of the measured object 22 corresponding to the pixel 271 is out of the area defined by the first prescribed distance, and the measured signal “S(p)” is discarded.

The distance “Z” is calculated using, for example, Equation 17 only for the measured signal “S(p)” in which the value of the pattern matching ratio PMR exceeds the prescribed reference value, and then coordinate values in the X-axis direction and the Y-axis direction are calculated using Equation 4. As previously described above, the series of processing described with reference to FIG. 32 is performed based on three-dimensional coordinate values of the measurement points (point sets) within the measurement target area to construct the three-dimensional shape (and the time variation thereof).

FIG. 127 illustrates an example of a three-dimensional shape (and a time variation thereof) included within an area defined by the first prescribed distance. A white wall illustrated in FIG. 127 (a) represents a boundary surface set by the distance “Zb” to the torso of the user or the distance “Ze” to the position in both eyes 594 as viewed from the measurer 8. In a state in which the user's both hands are placed behind the body, nothing is measured in front of the white wall.

FIG. 127 (b) illustrates an example of a three-dimensional shape measured in a case where only the user's fingertip is placed in front of the user's torso or the position in both eyes 594. Furthermore, when the user moves the hand slightly forward, only the tip of the wrist is measured as a three-dimensional shape as illustrated in FIG. 127 (c). When the user stretches the hand, a three-dimensional shape from the elbow to the tip is measured as illustrated in FIG. 127 (d).

In particular, when three-dimensional motion detection is performed, there is a risk that three-dimensional motion detection accuracy deteriorates due to the influence of disturbance noise from a three-dimensional shape other than a target of three-dimensional motion detection. As illustrated in FIG. 127, when limited to measurement of only a three-dimensional shape included in an area defined by the first prescribed distance, limited extraction of a three-dimensional shape that is a target of three-dimensional motion detection can be performed. As a result, an effect of improving the accuracy of three-dimensional motion detection is achieved.

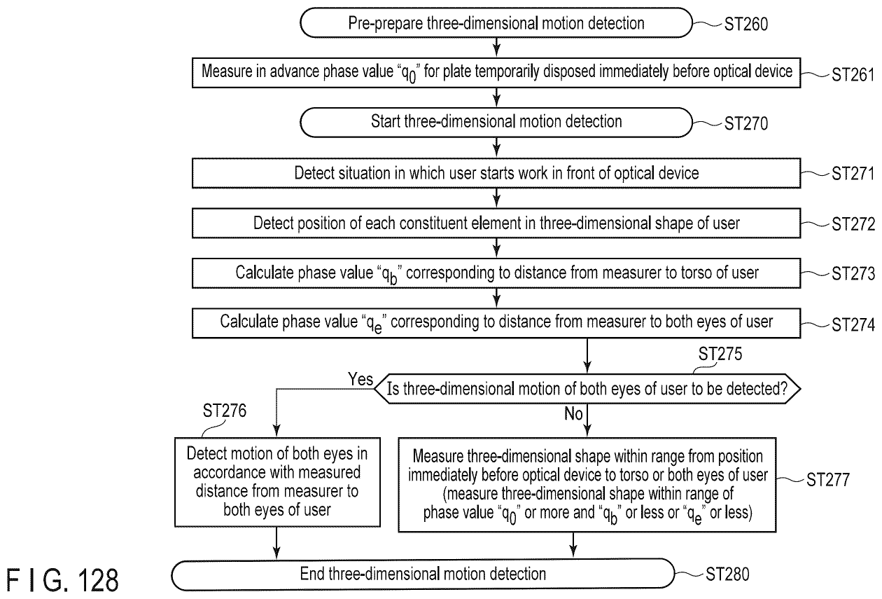

FIG. 128 summarizes a processing method related to the three-dimensional shape measurement within a specific area described with reference to FIG. 126. As pre-preparation for three-dimensional motion detection (ST260), pre-measurement of the phase value “q0” is performed in step 261. Specifically, for example, in the case of the optical layout illustrated in FIG. 117, a plate is temporarily disposed immediately before the light source 2 and the measurer 8. A phase value corresponding to a distance to the plate is set to “q0”.

During the period from the start of the three-dimensional motion detection in step 270 to the end of the three-dimensional motion detection in step 280, first, a situation where the user has started work in front of the optical device 10 is detected (ST271). When the situation in which the user has started the work is detected, position detection (ST272) is performed for each constituent element in a three-dimensional shape of the measured object 22 (that is, the user) that is a target of measurement performed by the measurer 8. When identification of each constituent element can be performed, the phase value “qb” corresponding to a distance from the measurer 8 to the torso of the user is calculated in step 273. At the same time, the phase value “qe” corresponding to a distance from the measurer 8 to the position in both eyes 594 of the user is calculated (ST274).

Here, in a case where a three-dimensional motion of both eyes of the user is to be detected (ST275), the motion of the position in both eyes 594 is detected in accordance with the distance measurement from the measurer to both eyes of the user in step 276. In a case where the three-dimensional motion of both eyes of the user is not to be detected (ST275), as described in step 277, the three-dimensional shape measurement within a range from the position immediately before the optical device 10 to the torso or position in both eyes 594 of the user (three-dimensional shape measurement within a range of the phase value “q0” or more and “qb” or less or “qe” or less) is performed.

FIG. 129 is an explanatory diagram of an example of an input device 1060 and an example of an output device 1070 necessary for the end uses 1080 of a prescribed service providing domain in the present embodiment example. As an embodiment example of a service providing method for an end use 1080 or a service providing system for an end user 1080, there is a method of constructing a prescribed service providing domain 1058 in the cyberspace and allowing an end use 1080 to use the service providing domain.

In order for the end user 1080 to use the prescribed service providing domain 1058 in the cyberspace, the end user 1080 needs the input device 1060 and the output device 1070 necessary for using the prescribed service providing domain 1058 in the cyberspace.

In a personal computer, a keyboard and a mouse are mainly used as the input device 1060. In a smart phone, a touch screen corresponds to the input device 1060. The touch screen has more excellent diversity of functions than a keyboard. In the present embodiment example, an automatic image (movie) input technique or an automatic speech input technique may be used as an input method with more improved variety of functions, operability, and convenience than the touch screen on the smart phone.

That is, an image (movie) collection function and an audio information collection function are used as the device classifications 1062 related to the input device 1080 in the present embodiment example. There is a microphone as input device embodiments 1064 that collect audio information. Furthermore, as the input device embodiments 1064 having an image (movie) collection function, it is possible to use the imaging sensor 270 relating to a depth (distance) signal and a visible color camera capable of simultaneously measuring near infrared spectral profiles.

A motion of the user's body can be used (three-dimensional motion detection) as an information input method in a case where the imaging sensor 270 relating to a depth (distance) signal or the visible color camera capable of simultaneously measuring near infrared spectral profiles is used as the input device 1080. For example, a gesture of the user or a finger action may be used instead of an existing mouse. In this case, the input device 1060 or the host 50 connected to the input device 1060 may have a gesture interpretation function, a fingertip command interpretation function, and a virtual three-dimensional function.

In information input in a case where the visible color camera capable of simultaneously measuring near infrared spectral profiles is used for the input device 1060, analysis of compositions for forming a living body appearing in the near infrared spectral profiles can be performed. Therefore, personal authentication using biometric information such as vein authentication may be used. Furthermore, the biological activity can be automatically detected from a time variation of the near infrared spectral profiles.

For example, an emotion or an affection of the end user 1080 can be automatically recognized in the host 50 from a contraction state of the facial expression muscles of the end user 1080. As described above, analysis of compositions in the blood of the end user 1080 may be performed from the outside in a non-invasive or non-contact manner. For example, a physical condition of the user can be automatically input using a blood glucose level measurement result. Furthermore, an excitation state of the end user 1080 can be input in real time from the adrenaline content in the blood.

When the output device classifications 1062 are performed according to functions that can be realized by the output device 1070, the output device 1070 may have a three-dimensional display function, a shaping function, an audio information output function, a tactile stimulation device function, and the like. A movement blocking function of the end user 1080 may be included as a part of the tactile stimulation function. For example, when the end user 1080 carries heavy luggage in the real-world, the degree of freedom of movement is restricted. This restriction of the freedom of movement imposed on the end user 1080 entering the prescribed service providing domain 1058 in the cyberspace may be implemented by a part of the tactile stimulation device function.

Furthermore, the output device 1070 is not limited to the above, and for example, the driving mechanism 15 (FIG. 1A) in the real space may be directly operated from the inside of the prescribed service providing domain 1058 in the cyberspace. As a specific form example of the driving mechanism 15, a remotely controllable robot may be associated. For example, this robot is disposed in a tourist spot, and the robot moves in the tourist spot according to the user's intention. A three-dimensional shape imaged by a camera built into the robot is three-dimensionally displayed as follows. The robot movement in the tourist spot corresponds to the control of the driving mechanism in the real space. Furthermore, the present invention is not limited thereto, and remote care using a remote operation of a robot may be performed.

As the output device embodiments 1074 that realize the three-dimensional display function, a thin stand-alone display or a removable display device such as a virtual reality (VR) device or an augmented reality (AR) device may be used. Furthermore, a 3D printer may be used as the output device having the shaping function. A speaker may be used to output the audio information, and a pressure device of the skin epidermis has the tactile stimulation function.

FIGS. 6, 5, and 117 illustrate an input device 1060 and an output device 1070 used in the present embodiment example. In FIGS. 5 and 117, a thin stand-alone display (a three-dimensional display of a computer system or wall hanging) 900 is used as an embodiment example of the output device 1070 used as the display 18. In addition, a light source 2 and a plurality of measurers 8 are disposed in a part of the thin stand-alone display 900 or a part of the outside thereof (an outer frame of a three-dimensional display of a computer system or wall hanging) 902.

A set of a light source 2 and a plurality of measurers 8 correspond to the input device 1060. FIGS. 5 and 117 use the embodiment examples of the light source 2 and the measurer 8 described so far. In particular, by disposing the plurality of measurers 8 at different positions, three-dimensional images (three-dimensional movies) can be collected in a polygonal manner.

Lenticular lenses (fine cylindrical lenses) are arranged in the lateral direction on the surface of the thin stand-alone display (a three-dimensional display of a computer system or wall hanging) 900. The measurer 8 measures a three-dimensional position of the eyeball of the end user 1080 in real time. In accordance with the eyeball position of the end user 1080 (through eye tracking), a right side eye image and a left side eye image of the end user 1080 are created individually for each pixel in the thin stand-alone display (a three-dimensional display of a computer system or wall hanging) 900.

In addition, the lenticular lens controls directions in which the right side eye image and the left side eye image are directed to the right side eye and the left side eye of the end user 1080. A virtual three-dimensional image is displayed to the end user 1080 using a difference in convergence angle for each image having different virtual positions in the front-rear direction, captured by the right side eye and the left side eye.

The virtual keyboard seen on the foremost side in FIG. 5 indicates a display example in the above method. In addition, three-dimensional measurement can be performed by a combination operation of the light source 2 and the measurer 8. Therefore, a three-dimensional position of each of ten fingertips of the end user 1080 can be measured in real time. For example, when the end user 1080 places both hands on the three-dimensionally displayed virtual keyboard and moves ten fingers, a virtual typing operation can be performed.

FIG. 6 illustrates another embodiment example relating to the input device 1060 and the output device 1070. As an embodiment example of the output device 1070 corresponding to the display 18, AR glasses 820 and 830 for three-dimensional display are used. The AR glasses 820 and 830 separately display a right side eye image (movie) and a left side eye image (movie), and three-dimensionally display the images using the difference in the convergence angle described above. Note that VR glasses may be used instead of the AR glasses 820 and 830.

FIG. 6 (b) illustrates an example in which a virtual keyboard disposed at a position away from the end user 1080 by a prescribed distance is displayed as a three-dimensional display space (movie). The end user 1080 sees this virtual keyboard and types the virtual keyboard while moving the ten fingers. The broach 810 including the imaging sensor 270 relating to a depth (distance) signal fixed to a breast pocket of the end user 1080 has the light source 2 and the measurer 8, and the light emitted from the light source 2 is reflected by the fingertips of the end user 1080. The measurer 8 uses the reflected light from the fingertip to measure a 3D color image (movie) including three-dimensional positions of the ten fingertips in real time.

The end user 1080 carries the knapsack 850 including a power supplier, the system controller 50, and a network communicator for the outside. The knapsack 850 supplies power to the AR glasses 830 (display 18) via the connection cable 866. The knapsack 850 also generates a right side eye image (movie) and a left side eye image (movie), and transmits the images to the AR glasses 830 via the connection cable 866.

At the same time, the knapsack 850 supplies power to the broach 810 including the 3D color imaging sensor via the connection cable 866. Further, the measurer 8 transmits the three-dimensional images (three-dimensional movies) collected by the measurer 8 to the knapsack 850 via the connection cable 876. The signal processor 42 in the knapsack 850 analyzes the three-dimensional images (three-dimensional movies) to estimate tip motions of the ten fingers of the end user 1080.

A position in the virtual keyboard typed by the end user 1080 is determined using the estimation result. As described above, when the three-dimensional measurement using the imaging sensor 270 relating to a depth (distance) signal can be performed in real time, various types of information can be input to the prescribed service providing domain 1058 in the cyberspace using the motions of the end user 1080. Furthermore, since information can be input simply by a finger action, the burden on the end user 1080 is greatly reduced. When the input device 1060 has the three-dimensional measurement function as described above, an effect of greatly improving the convenience for the end user 1080 is achieved.

In the embodiment example in FIG. 6 (b), the knapsack 850 including the system controller 50 having the connection cables 866 and 876, the broach 810 (including the light source 2 and the measurer 8) including the imaging sensor 270 relating to a depth (distance) signal, and the entire AR glasses 830 corresponding to the display 18 configure the optical device 10 (FIG. 1).

Furthermore, in the embodiment example in FIG. 6 (a), the shoulder bag 840 including the system controller 50 having the connection cables 860 and 870, the pendant or the necklace 800 (including the light source 2 and the measurer 8) including the imaging sensor 270 relating to a depth (distance) signal, and the entire AR glasses 820 corresponding to the display 18 configure the optical device 10 (FIG. 1A). A function of each device and data content transferred between the devices in FIG. 6 (a) are consistent with those in FIG. 6 (b). In FIG. 6 (a), the light source 2 and the measurer 8 are included in the pendant or the necklace 800 including the imaging sensor 270 relating to a depth (distance) signal, and have the function of the measurer 8.

The virtual image 1400 located in the virtual space such as a virtual keyboard displayed as being disposed at a position away from the end user 1080 by a prescribed distance is defined in the prescribed service providing domain 1058 in the cyberspace. The virtual image 1400 located in the virtual space has a three-dimensional structure, and its position and shape change with passing time (that is, it has a virtual four-dimensional structure). In the present embodiment example, the virtual image 1400 located in the virtual space defined in the prescribed service providing domain 1058 in the cyberspace and displayed to the end user 1080 and the real object 1410 in the real world such as the finger of the end user 1080 operate in interlocking with each other with high accuracy. The present embodiment example may use at least one processing in the “three-dimensional shape complementing” previously mentioned to perform the interlocking operation between the virtual image in the virtual space and the real object in the real world with high accuracy.

In order to realize the highly accurate interlocking operation, it is desirable to align the virtual image 1400 located in the virtual space and the real object 1410 in the real world in the three-dimensional direction. As a specific method of the alignment, for example, a method of “adjusting a position of the virtual image 1400 located in the virtual space to a position in the real world in the three-dimensional direction with reference to the real world real object 1410” may be performed.

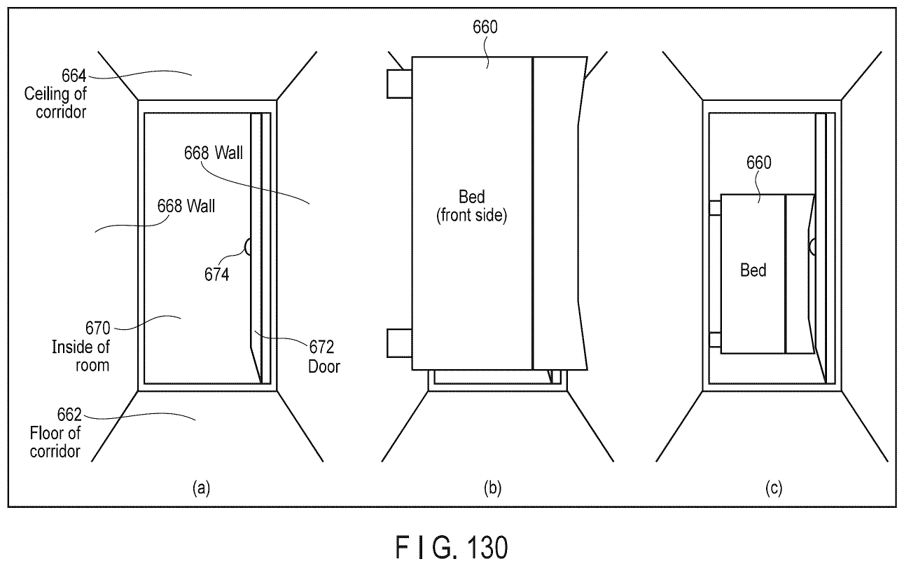

FIG. 130 illustrates a screen example of the actual size configuration processing result displayed in the display 18. In particular, “Virtual arrangement (configuration) among a plurality of measured objects 22 based on actual dimensions and two-dimensional display of projection drawing utilization”.

In the description example of FIG. 130 (a), the door 672 is at the tip of the floor 662 of the corridor. When the door 672 is opened, the inside 670 of the room can be seen. FIG. 130 (b) illustrates an image in the middle of putting the bed 660 into the room 670 through the corridor. FIG. 130 (c) illustrates a state in which the bed 660 passes through the opened door 672.

A long distance measurement characteristic between pixels in the imaging sensor 270 relating to depth (distance) signal is considered. Between pixels 271 projected from the floor 662 of the corridor, the ceiling 664 of the corridor, or the wall 668 in FIG. 130 (a). Continuous distance measurement characteristics are obtained. On the other hand, a discontinuous distance measurement characteristic is generated at a boundary line between the floor 662 of the corridor or the ceiling 664 of the corridor and the inside 670 of the room.

That is, the discontinuity area in the long distance measuring characteristic is concentrated in the peripheral portion of the image in which the inside 670 of the room is visible. Therefore, when the discontinuity areas in the distance measurement characteristics are connected, the 3D structure and the dimensions (actual dimensions) of the inlet of the door 672 can be predicted. Here, the 3D structure of the inlet of the door 672 corresponds to the contour line of the measured object 22 described above.

The dimensions (actual dimensions) of the bed 660 to be placed in the room 670 are measured in advance using the imaging sensor 270 relating to depth (distance) signal (optical device 10). By comparing this measurement value with the dimension (actual dimension) of the inlet of the door 672, it can be seen on the virtual space whether or not the bed 660 enters the room 670. Furthermore, it is possible to simulate, on the virtual space, an optimal way (arrangement angle) to put the bed 660 when the user enters the room 670.

Specifically, the arrangement location orientation setter for each measured object 644 changes the arrangement angle of the bed 660 to simulate whether or not the measured object 660 (22) enters the room 670. The simulation results are shown in FIG. 130 (c). Here, a location where the physical interference state (collision location) extractor between measured objects 646 collides with the bed 660 may be found in advance and specified on the display screen. In this way, if the collision location is known every time the arrangement angle (insertion method) of the bed 660 is changed, the convenience of the user is remarkably improved.

Before putting the bed 660 into the room 670, the bed 660 passes through the corridor. The bed 660 at this time is located on the front side of the door 672 at the inlet of the room. When the bed 660 is displayed based on the projection drawing, the apparent size of the bed 660 increases as illustrated in FIG. 130 (b). The apparent size of the bed 660 decreases when the user shifts the position of the bed 660 to the far side. Here, the display screen size calculator for each arrangement location corresponding to projection drawing 6499 appropriately calculates the apparent size of the bed 660. As described above, when the display based on the projection drawing is performed in the present embodiment example, the stereoscopic effect is improved and the user can have a more realistic feeling.

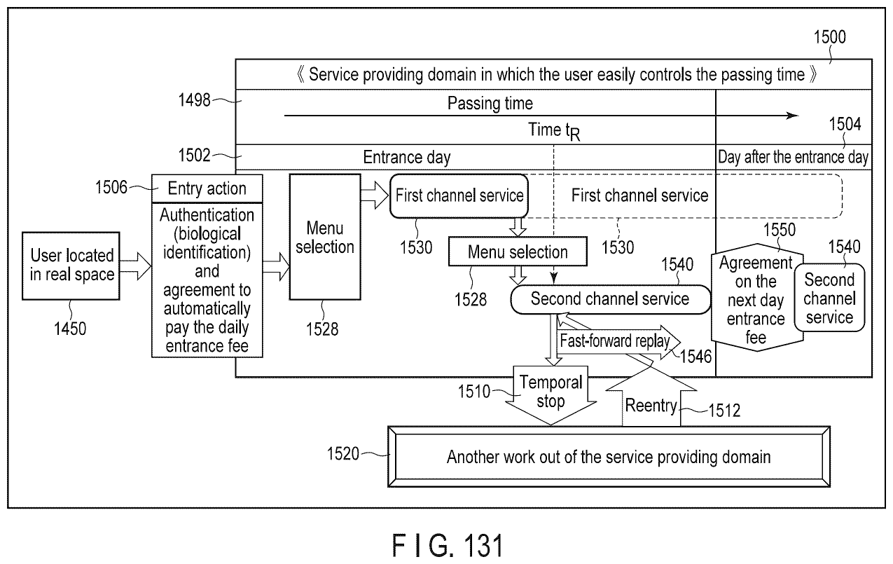

FIG. 131 illustrates an embodiment example of a service providing method for the end user 1080 using a service providing domain 1500 in which the user easily controls the passing time. The service providing domain 1500 in which the user easily controls the passing time is located in a part of the prescribed service providing domain 1058 in the cyberspace described above. In addition, in a case where the service providing domain 1500 in which the user easily controls the passing time is used, daily billing may be performed.

In a case where the service providing domain 1500 in which the user easily controls the passing time across days is used, it is necessary to charge for the next day at the time point across days. In order to enter the cyberspace 1058 with the input device 1060 and the output device 1070, an Internet communication fee is required. The Internet communication fee may be added with the daily use cost of the service providing domain 1500 in which the user easily controls the passing time.

The user 1450 (end user 1080) in the real space performs an entry action 1506 before entering the service providing domain 1500 in which the user easily controls the passing time. At the beginning of this specific entry action 1506, personal authentication using biological identification described with reference to FIGS. 95 and 96 is performed. Next, an inquiry as to whether or not the daily entrance fee is automatically paid is made to the user 1450 (end user 1080) in the real space. When the user 1450 (end user 1080) in the real space agrees to automatically pay the daily entrance fee, entry into the service providing domain 1500 in which the user easily controls the passing time is permitted. The user who has entered the service providing domain 1500 in which the user easily controls the passing time changes from the user 1450 located in the real space to the user in the cyberspace. Here, the user in the cyberspace is referred to as an end user 1080.

At the entrance of the service providing domain 1500 in which the user easily controls the passing time, a use menu in the service providing domain 1500 in which the user easily controls the passing time is displayed. The user 1450 (end user 1080) in the real space performs desired menu selection 1528. A first channel service 1530 starts with passing time.

The end user 1080 in the service providing domain 1500 in which the user easily controls the passing time can transition to a second channel service 1540 through the menu selection 1528. Here, the inside of the display 18 may be divided into a plurality of areas. Due to the plurality of divided areas, the first channel service 1530 and the second channel service 1540 can be simultaneously displayed. When this multiple-area simultaneous display function is used, there is an effect that the end user 1080 can effectively act in the service providing domain 1500 in which the user easily controls the passing time.

Since the body of the user 1450 located in the real space is only one, a plurality of experiences cannot be performed at the same time. However, in the service providing method described in the present embodiment example, the end user 1080 in the cyberspace can simultaneously receive a plurality of experiences. With this multiple-area simultaneous display function, it is possible to provide a service that the end user 1080 cannot receive in the real space.

When the daily billing method is employed, the end user 1080 can enter and leave the service providing domain 1500 in which the user easily controls the passing time many times on the same day. When an urgent business occurs in the user 1450 located in the real space and the user temporarily stops 1510 the service providing domain 1500 in which the user easily controls the passing time, the end user 1080 returns to the user 1450 located in the real space. Here, a case where the end user 1080 temporarily stops 1510 the service providing domain 1500 in which the user easily controls the passing time when the passing time 1498 is “R” will be considered.

When the user 1450 located in the real space finishes another work 1520 out of the service providing domain and enters again 1512 the service providing domain, the passing time 1498 progresses in the service providing domain 1500 in which the user easily controls the passing time, and the user enters again 1512 the service providing domain 1500 in which the user easily controls the passing time at the time 1498 which is significantly later than the time “tR”.

In the present embodiment example, at the time of reentry 1512, the time may return to the time “tR” in the service providing domain 1500 in which the user easily controls the passing time. By using the function of the fast-forward replay 1546, the end user 1080 can additionally recognize an event occurring in the service providing domain 1500 in which the user easily controls the passing time during the period of another work 1520 out of the service providing domain. As described above, in the service providing domain 1500 in which the user easily controls the passing time described in the present embodiment example, it is possible to provide the “service beyond time and space” to the end user 1080.

In particular, the input device 1060 used in the present embodiment example can perform distance measurement (measurement of a difference in microscopic level on a surface) with high accuracy with respect to the measured object 22 sufficiently far, for example, “100 m” ahead or “1 km” ahead. Therefore, by using the zoom function of the display area, it is possible to display the measured object 22 as if instantaneously approaching the periphery of the measured object 22 ahead “1 km”. When such a zoom display function is used, it is possible to provide the end user 1080 with an experience of “instantaneous movement” as a “service beyond space”.

The input device 1060 described in the present embodiment example can be reduced in size and weight. Therefore, for example, as illustrated in FIG. 4, the input device 1060 that is reduced in size and weight may be built into a drone. As a result, an image (movie) captured from the sky can be input. By using the image (movie) captured from the sky, it is also possible to provide a “service beyond gravity” to the end user 1080. That is, the service providing domain 1500 in which the user easily controls the passing time may provide the end user 1080 with an experience of flying in the air or an experience of floating in the air.

The service providing domain 1500 in which the user easily controls the passing time may additionally charge an entrance fee at the timing of switching from an entrance day 1502 to a day after the entrance day 1504. The service providing domain 1500 in which the user easily controls the passing time at this switching timing displays an “inquiry about next day entrance fee payment” to the end user 1080. When the end user 1080 performs “agreement on the next day entrance fee 1550”, the service in the service providing domain 1500 in which the user easily controls the passing time is continued.

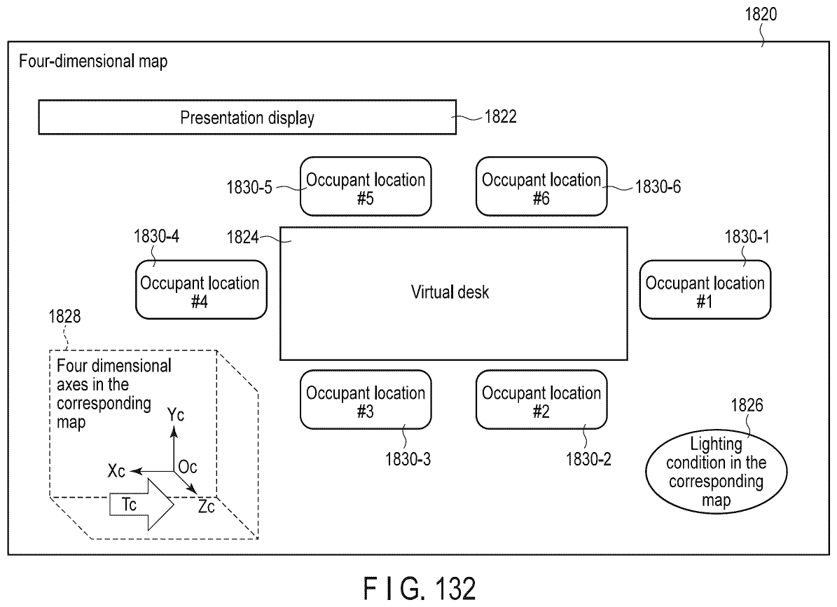

For example, as an embodiment example, a case where a plurality of end users 1080 hold a meeting in the virtual space of the service providing domain 1500 in which the user easily controls the passing time will be considered. It is assumed that a meeting room in the virtual space of the service providing domain 1500 in which the user easily controls the passing time allows six people to attend the meeting with a virtual desk in the center. In the meeting room in the virtual space, as described in the embodiment example in FIG. 132, four-dimensional axes 1828 in the corresponding map are set in advance. An “Xc-axis” and an “Yc-axis” in the four-dimensional axes 1828 are aligned with angular directions of the virtual desk. In addition, a “Zc-axis” is directed above the meeting room in the virtual space. In addition, the meeting time is defined according to a “time axis Tc”. In addition, a presentation display 1822 is disposed in the meeting room, and an illumination light (lighting condition 1826 in the corresponding map) is disposed at the lower right of FIG. 132.

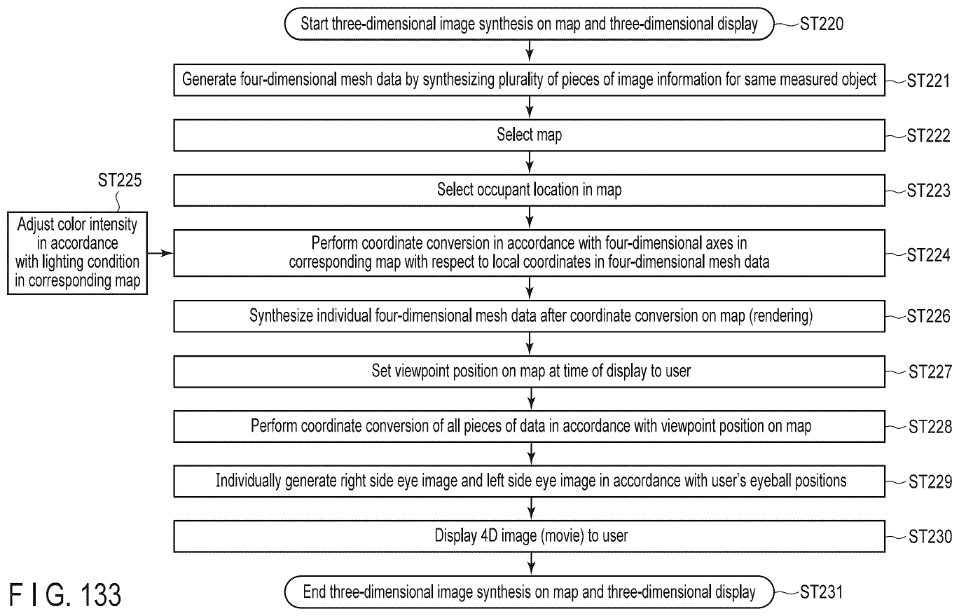

FIG. 133 illustrates a processing step reaching generation of a right side eye image (movie) and a left side eye image (movie) to be displayed on the output device 1070 using a four-dimensional map in the service providing domain 1500 in which the user easily controls the passing time. From the start (ST220) to the end (ST231) of the processing in FIG. 133, processing from synthesis of the three-dimensional image (movie) on the map to display of the three-dimensional image (movie) to the end user 1080 is performed. Note that, as illustrated in FIG. 35, a management unit for each frame (an image in a movie) is referred to as a mesh frame, and a generic term for mesh frames across a plurality of frames will be referred to as four-dimensional mesh data in FIG. 133 and subsequent drawings.

According to FIG. 132, it is presumed that the meeting room in the virtual space has only six measurer 8 to six attending people and each of measurer 8 measures each of attending peoples. And each of measurer 8 measures only a part of the corresponding people from only one imaging view line 384 (only one direction). Therefore, a sense of presence regarding the virtual meeting falls down because an attending people see only a part of another attending people.

In the meantime, the “three-dimensional shape complementing” previously explained can provide three-dimensionally omnidirectional shape moving though the measure 8 measures the attending people from only one imaging view line 384 (only one direction). As a result of the “three-dimensional shape complementing”, an attending people can see another attending people from any direction. Accordingly, the “three-dimensional shape complementing” technology increases the sense of presence regarding the virtual meeting. At least one processing included in the “three-dimensional shape complementing” technology is useful for the meeting in the virtual space shown in FIG. 132.

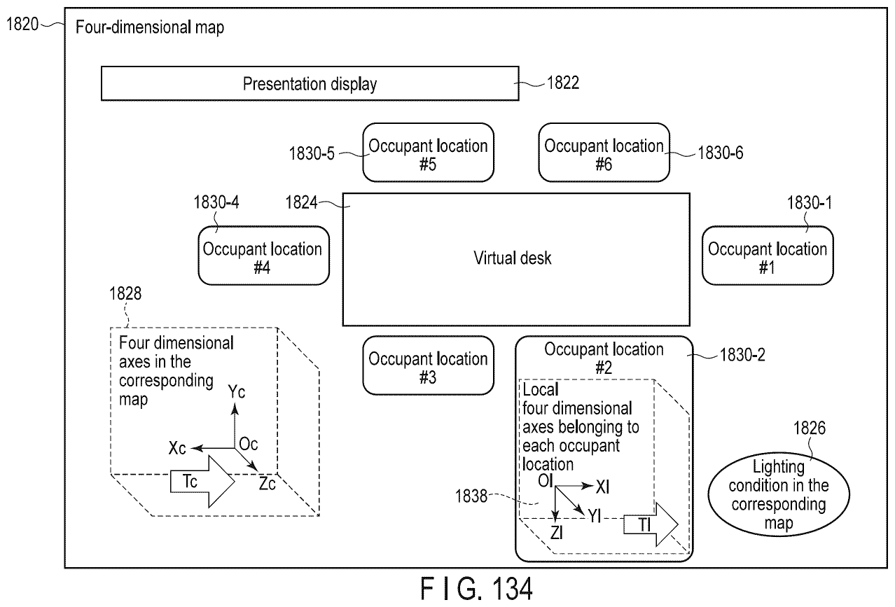

First, a flow of a series of processing is outlined using FIG. 133. Thereafter, specific processing contents are described below with reference to FIGS. 134 to 136. Since this series of processing contents is complicated, it may be difficult to understand the contents only by the description of FIG. 133. It is easy to intuitively understand the contents by using FIGS. 134 to 136 that are described later.

In imaging using only an imaging sensor 270 relating to a depth (distance) signal, imaging can be performed only from one direction (one imaging view line 384) of the measured object 22 to be imaged. However, for example, when a plurality of measurers 8 disposed at different positions as illustrated in FIGS. 3 and 4 are simultaneously used, polygonal imaging of the measured object 22 can be performed.

In a case where the same measured object 22 is imaged from a polygonal direction as described above, a plurality of pieces of image (movie) information obtained as described in step 221 can be synthesized to create four-dimensional mesh data for the same measured object 22. In addition, not limited to it, at least one processing included in the “three-dimensional shape complementing” technology may be used to create four-dimensional mesh data.

Next, the end user 1080 selects a map to be used in the service providing domain 1500 in which the user easily controls the passing time (ST222). This map selection is selection of a meeting room to be used. However, the map selection step (ST222) is not limited to meeting room selection, and includes any map selection to be used in the service providing domain 1500 in which the user easily controls the passing time. For example, when a tourist trip in the service providing domain 1500 in which the user easily controls the passing time is selected, four-dimensional map information of a tourist spot may be selected. Further, this map selection (ST222) also includes designation of a location (occupant location 1830) that the end user 1080 desires to occupy in the selected map.

Four-dimensional axes 1828 in the corresponding map are defined for each map selected by the end user 1080. Furthermore, the unique coordinate axes described in FIG. 132 are defined in the imaging sensor 270 relating to a depth (distance) signal that has imaged the end user 1080. Therefore, in step 224, coordinate conversion from coordinate axes unique to the imaging sensor 270 relating to a depth (distance) signal to the four-dimensional axes 1828 in the corresponding map is performed in accordance with the occupant location 1830 designated by the end user 1080. In step 225 immediately after this, color intensity adjustment is performed in accordance with the lighting condition 1826 in the corresponding map.

When the coordinate conversion (ST224) and the color intensity adjustment (ST225) for each end user 1080 are completed, synthesizing the four-dimensional mesh data of each end user 1080 on the map is performed as rendering (ST226). Through this rendering on the map, a plurality of different end users 1080 can gather at a specific location in the service providing domain 1500 in which the user easily controls the passing time.

In subsequent step 227, a position in both eyes when displayed to each of the end users 1080 on the map is set. All pieces of mesh data rendered on the map are coordinate-converted again in accordance with the position in both eyes and the view line direction (ST228). Using all pieces of mesh data after the coordinate conversion, in step 229, images (movies) for the right side eye and the left side eye matching the eyeball positions of the user are generated.

The images (movie) for the right side eye and the left side eye generated in step 229 are displayed on the output device 1070, and a 4D image (movie) is displayed to the end user 1080. Note that a series of processing from the above step 227 to the above step 230 corresponds to the processing of the “three-dimensional projective transformation” already described in Chapter 2.

FIG. 134 is an explanatory diagram of a coordinate conversion step from local four-dimensional axes 1838 belonging to each occupant location aligned with the four-dimensional axes in the corresponding map. This step corresponds to a diagram illustrating the processing in step 224 in FIG. 133 in detail. FIG. 134 illustrates an example of a state in which a specific end user 1080 sits on a seat of the occupant location #2_1830-2 in the virtual meeting room while facing forward. It is necessary to perform image processing (rendering) such that another meeting participant (another end user 1080) can see the appearance of the specific end user 1080 facing forward and seated.

As an environment in which an image of the specific end user 1080 is captured, a case is considered in which the image is captured by the three-dimensional color imaging sensor 1280 (or a combination of the imaging sensor 270 relating to a depth (distance) signal and the imaging sensor 280 detecting color signals) installed facing the specific end user 1080 as illustrated in FIGS. 5 and 117. In a local “Z1 axis” preset in the three-dimensional color imaging sensor 1280 (or a combination of the imaging sensor 270 relating to a depth (distance) signal and the imaging sensor 280 detecting color signals), as illustrated in FIG. 134, an orientation opposite to the face direction of the specific end user 1080 is a “positive” orientation. (That is, a direction in which the face of the specific end user 1080 faces is a “negative direction” of the local “axis Z1” unique to the end user 1080.)

As illustrated in FIG. 134, the “negative direction” of the local “axis Z1” unique to the end user 1080 coincides with the Yc direction in the four-dimensional axes in the corresponding map. Therefore, coordinate axes of the four-dimensional mesh data obtained by imaging the specific end user 1080 need to be coordinate-converted in accordance with the four-dimensional axes in the corresponding map. Similarly, directions of local “axes X1”, “Y1”, and “Z1” when the end user 1080 seated in the occupant location #4_1830-4 is imaged by the three-dimensional color imaging sensor 1280 (or a combination of the imaging sensor 270 relating to a depth (distance) signal and the imaging sensor 280 detecting color signals) are different from directions of the four-dimensional axes “Xc”, “Yc”, and “Zc” in the corresponding map.

As described above, for each occupant location 1830 selected by the end user 1080 in the same map, directions of the local “axes X1”, “Y1”, and “Z1” in the four-dimensional mesh data collected by imaging the end user 1080 are different. Therefore, coordinate conversion is performed according to a position of the occupant location 1830 selected by the end user 1080. As a result, the coordinate axes serving as the reference of the four-dimensional mesh data collected by imaging all the end users 1080 are unified to the four-dimensional axes “Xc”, “Yc”, and “Zc” in the corresponding map. Only after coordinate axes serving as a reference of the four-dimensional mesh data are unified to the four-dimensional axes “Xc”, “Yc”, and “Zc” in the corresponding map, rendering of synthesizing the four-dimensional mesh data of all members participating in the meeting can be performed.

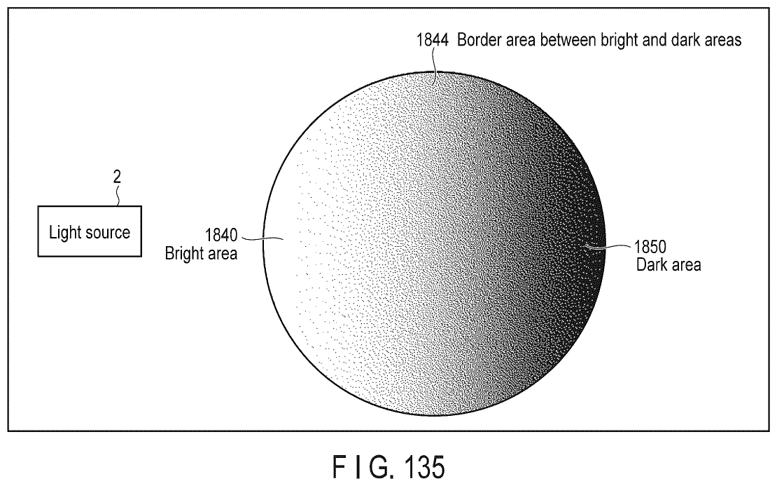

FIG. 135 is an explanatory diagram of a color intensity adjustment method performed in step 225 in FIG. 133. For example, a case where the light emitter 2 is disposed on the left side of a sphere is considered now. The left side close to the light emitter 2 in the sphere is illuminated with emission light of the light emitter 2 and becomes bright. On the other hand, the right side that becomes a shadow of the light emitter 2 in the sphere becomes dark. In the brightly illuminated node 1600, the intensity of each color increases and approaches the color of the emission light of the light emitter 2. The intensity of each color of the node 1600 in a dark shadow portion decreases. When the color intensity of the node 1600 in the four-dimensional mesh data is adjusted in accordance with the lighting condition 1826 in the corresponding map (that is, ambient light or a position of a light and an emission color of the light), an effect of increasing the reality of the image (movie) displayed to the end user 1080 is achieved.

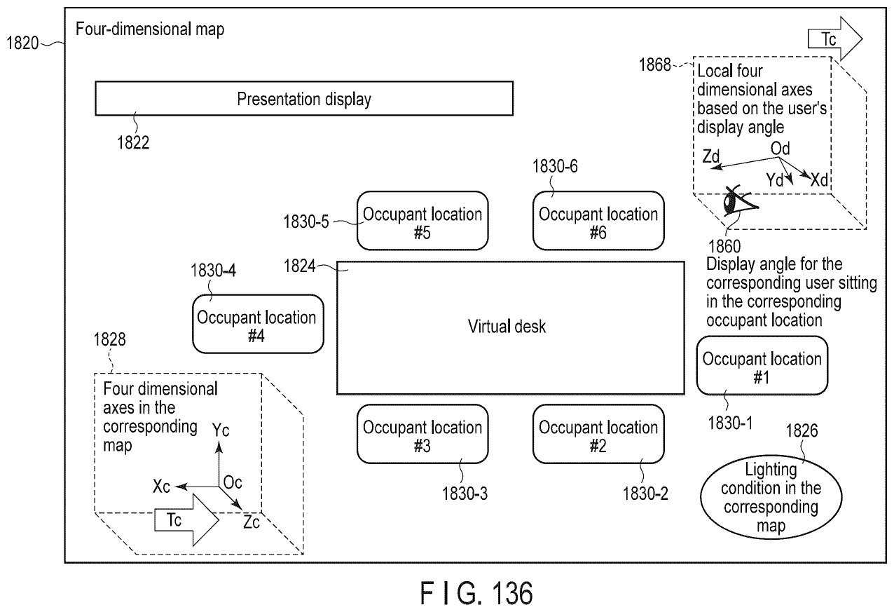

FIG. 136 illustrates a detailed explanatory diagram related to setting of a position in both eyes on the map described in step 27 in FIG. 133. When a wearable display (VR/AR/MR) for three-dimensional display is used as the output device 1070 for the end user 1080, front-rear direction position information for each display object is very important. Therefore, a front-rear position direction of the three-dimensional display space changes depending on a display angle 1860 for the corresponding user sitting in the corresponding occupant location in the four-dimensional map.

In the present embodiment example, the display angle 1860 for the corresponding user sitting in the corresponding occupant location and a direction in which the view line of the user is directed can be set at any position in the service providing domain 1500 in which the user easily controls the passing time. When this function is provided, an effect of dramatically improving the presence feeling of an image (movie) to be provided to the end user 1080 is achieved.

For example, it is possible to virtually run around together with a soccer team member while watching a soccer game or to watch the progress of the game at the viewpoint of a referee of the soccer game. Especially, while watching a sport game, a watching user strongly wants to look at a prescribed (favorite) athlete from polygonal directions in detail.

Accordingly, at least one processing included in the “three-dimensional shape complementing” technology previously described may be used to three-dimensionally display the motions of the athletes.

As illustrated in FIG. 136, in the present embodiment example, the display angle 1860 for the corresponding user sitting in the corresponding occupant location and the local four-dimensional axes 1868 based on the user's display angle in accordance with the view line direction are defined. Here, a depth direction (front-rear direction) three-dimensionally displayed to the end user 1080 is set to a Zd-axis. Further, the lateral direction viewed from the end user 1080 is set to an Xd direction.

In step 228 in FIG. 133, all pieces of the four-dimensional mesh data constructed on the four-dimensional axes in the corresponding map are coordinate-converted to become four-dimensional mesh data on the local four-dimensional axes 1868 based on the user's display angle. Thereafter, the generated three-dimensional images (movies) (ST 229 in FIG. 133) are displayed to the end user 1080 (ST 230 in FIG. 133). In this case, the end user 1080 may request an enlargement (zoom) function for the displayed three-dimensional images (movies). When the coordinate conversion is performed in advance to the four-dimensional mesh data on the local four-dimensional axes 1868 based on the display angle for the corresponding user sitting in the corresponding occupant location as described above, there is an effect in which it is easy to quickly respond to the enlargement (zoom) request from the user.

Although the embodiment of the invention has been described above, this embodiment is presented as an example, and is not intended to limit the scope of the invention. This novel embodiment can be implemented in various other forms, and various omissions, substitutions, and changes can be made without departing from the gist of the invention. These embodiments and modifications thereof are included in the scope and gist of the invention, and are included in the invention described in the claims and the equivalent scope thereof.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A three-dimensional projective transformation method comprising:
generating a three-dimensional shape to be transformed;
measuring relative positions of a user's right eye and a user's left eye based on a position of the three-dimensional shape;
forming at least one of a first projective image and a first projective movie which the user's right eye looks at; and
forming at least one of a second projective image and a second projective movie which the user's left eye looks at.

2. A three-dimensional projective reverse transformation method comprising:
obtaining a series of measured signals from a series of pixels included in an imaging sensor;
estimating each of distances between measured points included in a measured object and corresponding pixels included in the series of pixels based on the series of measured signals; and
forming three-dimensional position information of each of the measured points based on each of the distances.

3. An optical device comprising a light source, an image forming lens, an imaging sensor including plural pixels, and a processor, wherein
the light source emits an irradiated light with which a measured object is irradiated,
a detection light obtained from the measured object passes through the image forming lens, the plural pixels receive the detection light and generate measured signals,
the processor estimates first distance between a first pixel in the plural pixels and a first measured point included in the measured object,
the processor estimates second distance between a second pixel in the plural pixels and a second measured point included in the measured object,
the second distance relates to the first distance, and
the processor forms three-dimensional position information on the second measured point.

4. A service providing method comprising:
obtaining a series of measured signals from a series of pixels included in an imaging sensor;
estimating each of distances between measured points included in a measured object and corresponding pixels included in the series of pixels based on the series of measured signals; and
forming three-dimensional position information of each of the measured points based on each of the distances; and
providing service for a user based on the three-dimensional position information.
